SEQUENCE LISTING (2 sequences)

SEQ ID NO: 1 - DNA, 12 bp, Artificial Sequence
  Description of Artificial Sequence Synthetic oligonucleotide
actgactgactg

SEQ ID NO: 2 - protein, 4 aa, Artificial Sequence
  Description of Artificial Sequence Synthetic peptide
FLQD

(19) United States
(12) Patent Application Publication
(10) Pub. No.: US 2010/0082306 A1
(43) Pub. Date: Apr. 1, 2010

(54) System and method of computing the nature of atoms and molecules using classical physical laws

(76) Inventor: Randell L. Mills, Princeton, NJ (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/318,627

(22) Filed: Jan. 2, 2009

Related U.S. Application Data
(60) Provisional application No. 61/018,595, filed on Jan. 2, 2008.
(60) Provisional application No. 61/027,977, filed on Feb. 12, 2008.
(60) Provisional application No. 61/029,712, filed on Feb. 19, 2008.
(60) Provisional application No. 61/082,701, filed on Jul. 22, 2008.

(51) Int. Cl. G06F 17/11; G06F 17/10

(52) U.S. Cl. 703/2

(57) ABSTRACT

There is disclosed a method and system of physically solving the charge, mass, and current density functions of amino acids and peptide bonds with charged functional groups for proteins of any size and complexity by addition of the units, bases, 2-deoxyribose, ribose, phosphate backbone with charged functional groups for DNA of any size and complexity by addition of the units, organic ions, halobenzenes, phosphines, phosphates, phosphine oxides, phosphates, organogermanium and digermanium, organolead, organoarsenic, organoantimony, organobismuth, or any portion of these species using Maxwell's equations and computing and rendering the physical nature of the chemical bond using the solutions. The results can be displayed on visual or graphical media. The display can be static or dynamic such that electron motion and specie's vibrational, rotational, and translational motion can be displayed in an embodiment. The displayed information is useful to anticipate reactivity and physical properties. The insight into the nature of the chemical bond of at least one species can permit the solution and display of those of other species to provide utility to anticipate their reactivity and physical properties.

This application claims priority to U.S. Application Nos.: 61/018,595, filed 2 Jan. 2008; 61/027,977, filed 12 Feb. 2008; 61/029,712 filed 19 Feb. 2008; and 61/082,701 filed 22 Jul. 2008, the complete disclosures of which are incorporated herein by reference.

This invention relates to a system and method of physically solving the charge, mass, and current density functions of polyatomic molecules, polyatomic molecular ions, diatomic molecules, molecular radicals, molecular ions, or any portion of these species in solution and undergoing reaction, and computing and rendering the nature of these species using the solutions. The results can be displayed on visual or graphical media. The displayed information provides insight into the nature of these species and is useful to anticipate their reactivity, physical properties, and spectral absorption and emission, and permits the solution and display of other compositions of matter.

Rather than using postulated unverifiable theories that treat atomic particles as if they were not real, physical laws are now applied to atoms and ions. In an attempt to provide some physical insight into atomic problems and starting with the same essential physics as Bohr of the e⁻ moving in the Coulombic field of the proton, a classical solution to the bound electron is derived which yields a model that is remarkably accurate and provides insight into physics on the atomic level. The proverbial view deeply seated in the wave-particle duality notion that there is no large-scale physical counterpart to the nature of the electron is shown not to be correct. Physical laws and intuition may be restored when dealing with the wave equation and quantum atomic problems.

Specifically, a theory of classical physics (CP) was derived from first principles as reported previously [reference Nos. 1-13] that successfully applies physical laws to the solution of atomic problems that has its basis in a breakthrough in the understanding of the stability of the bound electron to radiation. Rather than using the postulated Schrödinger boundary condition: “ψ→0 as r→∞, which leads to a purely mathematical model of the electron, the constraint is based on experimental observation. Using Maxwell's equations, the structure of the electron is derived as a boundary-value problem wherein the electron comprises the source current of time-varying electromagnetic fields during transitions with the constraint that the bound n=1 state electron cannot radiate energy. Although it is well known that an accelerated point particle radiates, an extended distribution modeled as a superposition of accelerating charges does not have to radiate. A simple invariant physical model arises naturally wherein the predicted results are extremely straightforward and internally consistent requiring minimal math, as in the case of the most famous equations of Newton and Maxwell on which the model is based. No new physics is needed; only the known physical laws based on direct observation are used.

Applicant's previously filed WO2005/067678 discloses a method and system of physically solving the charge, mass, and current density functions of atoms and atomic ions and computing and rendering the nature of these species using the solutions. The complete disclosure of this published PCT application is incorporated herein by reference.

Applicant's previously filed WO2005/116630 discloses a method and system of physically solving the charge, mass, and current density functions of excited states of atoms and atomic ions and computing and rendering the nature of these species using the solutions. The complete disclosure of this published PCT application is incorporated herein by reference.

Applicant's previously filed applications (see, e.g., WO/2008/085804—solving and rendering the function of various groups), and U.S. Published Patent Application No. 20050209788A1 (method and system of physically solving the charge, mass, and current density functions of hydrogen-type molecules and molecular ions and computing and rendering the nature of the chemical bond using the solutions) are incorporated herein by reference.

Applicant's previously filed WO2007/051078 discloses a method and system of physically solving the charge, mass, and current density functions of polyatomic molecules and polyatomic molecular ions and computing and rendering the nature of these species using the solutions. The complete disclosure of this published PCT application is incorporated herein by reference. This incorporated application discloses complete flow charts and written description of a computer program and systems that can be modified using the novel equations and description below to physically solve the charge, mass, and current density functions of the specific groups of molecules and molecular ions disclosed herein and computing and rendering the nature of the specific groups of molecules and molecular ions disclosed herein.

The old view that the electron is a zero or one-dimensional point in an all-space probability wave function ψ(x) is not taken for granted. Rather, atomic and molecular physics theory, derived from first principles, must successfully and consistently apply physical laws on all scales [1-13]. Stability to radiation was ignored by all past atomic models, but in this case, it is the basis of the solutions wherein the structure of the electron is first solved and the result determines the nature of the atomic and molecular electrons involved in chemical bonds.

Historically, the point at which quantum mechanics broke with classical laws can be traced to the issue of nonradiation of the one electron atom. Bohr just postulated orbits stable to radiation with the further postulate that the bound electron of the hydrogen atom does not obey Maxwell's equations—rather it obeys different physics [1-13]. Later physics was replaced by “pure mathematics” based on the notion of the inexplicable wave-particle duality nature of electrons which lead to the Schrödinger equation wherein the consequences of radiation predicted by Maxwell's equations were ignored. Ironically, Bohr, Schrödinger, and Dirac used the Coulomb potential, and Dirac used the vector potential of Maxwell's equations. But, all ignored electrodynamics and the corresponding radiative consequences. Dirac originally attempted to solve the bound electron physically with stability with respect to radiation according to Maxwell's equations with the further constraints that it was relativistically invariant and gave rise to electron spin [14]. He and many founders of QM such as Sommerfeld, Bohm, and Weinstein wrongly pursued a planetary model, were unsuccessful, and resorted to the current mathematical-probability-wave model that has many problems [1-18]. Consequently, Feynman for example, attempted to use first principles including Maxwell's equations to discover new physics to replace quantum mechanics [19].

Starting with the same essential physics as Bohr, Schrödinger, and Dirac of e⁻ moving in the Coulombic field of the proton and an electromagnetic wave equation and matching electron source current rather than an energy diffusion equation originally sought by Schrödinger, advancements in the understanding of the stability of the bound electron to radiation are applied to solve for the exact nature of the electron. Rather than using the postulated Schrödinger boundary condition: “ψ=0 as r→∞”, which leads to a purely mathematical model of the electron, the constraint is based on experimental observation. Using Maxwell's equations, the structure of the electron is derived as a boundary-value problem wherein the electron comprises the source current of time-varying electromagnetic fields during transitions with the constraint that the bound n=1 state electron cannot radiate energy. Although it is well known that an accelerated point particle radiates, an extended distribution modeled as a superposition of accelerating charges does not have to radiate. The physical boundary condition of nonradiation of that was imposed on the bound electron follows from a derivation by Haus [20]. The function that describes the motion of the electron must not possess spacetime Fourier components that are synchronous with waves traveling at the speed of light. Similarly, nonradiation is demonstrated based on the electron's electromagnetic fields and the Poynting power vector. A simple invariant physical model arises naturally wherein the results are extremely straightforward, internally consistent, and predictive of conjugate parameters for the first time, requiring minimal math as in the case of the most famous exact equations (no uncertainty) of Newton and Maxwell on which the model is based. No new physics is needed; only the known physical laws based on direct observation are used.

The structure of the bound atomic electron was solved by first considering one-electron atoms [1-13]. Since the hydrogen atom is stable and nonradiative, the electron has constant energy. Furthermore, it is time dynamic with a corresponding current that serves as a source of electromagnetic radiation during transitions. The wave equation solutions of the radiation fields permit the source currents to be determined as a boundary-value problem. These source currents match the field solutions of the wave equation for two dimensions plus time when the nonradiation condition is applied. Then, the mechanics of the electron can be solved from the two-dimensional wave equation plus time in the form of an energy equation wherein it provides for conservation of energy and angular momentum as given in the Electron Mechanics and the Corresponding Classical Wave Equation for the Derivation of the Rotational Parameters of the Electron section of Ref. [1]. Once the nature of the electron is solved, all problems involving electrons can be solved in principle. Thus, in the case of one-electron atoms, the electron radius, binding energy, and other parameters are solved after solving for the nature of the bound electron.

For time-varying spherical electromagnetic fields, Jackson [21] gives a generalized expansion in vector spherical waves that are convenient for electromagnetic boundary-value problems possessing spherical symmetry properties and for analyzing multipole radiation from a localized source distribution. The Green function G (x′, x) which is appropriate to the equation

(∇²+k²)G(x′,x)=−δ(x′−x)

in the infinite domain with the spherical wave expansion for the outgoing wave Green function is

$$\begin{matrix}G ( {x}^{′} , x ) = \frac{{e}^{- i k \vert x - {x}^{′} \vert}}{\vert x - {x}^{′} \vert} \\ = ik {\sum }_{l = 0}^{∞} {j}_{l} ( {kr}_{<} ) {h}_{l}^{( 1 )} ( {kr}_{>} ) \\ {\sum }_{m = - l}^{l} {Y}_{l , m}^{*} ( {θ}^{′} , {φ}^{′} ) {Y}_{l , m} ( θ , φ )\end{matrix} \qquad ( 2 )$$

Jackson [21] further gives the general multipole field solution to Maxwell's equations in a source-free region of empty space with the assumption of a time dependence e^{iω}^{t}:

$$B = {\sum }_{l , m} [ \begin{matrix}{a}_{E} ( l , m ) {f}_{l} ( kr ) {X}_{l , m} - \\ \frac{i}{k} {a}_{M} ( l , m ) ∇ \times {g}_{l} ( kr ) {X}_{l , m}\end{matrix} ] \\ E = {\sum }_{l , m} [ \begin{matrix}\frac{i}{k} {a}_{E} ( l , m ) ∇ \times {f}_{l} ( kr ) {X}_{l , m} + \\ {a}_{M} ( l , m ) {g}_{l} ( kr ) {X}_{l , m}\end{matrix} ] \qquad ( 3 )$$

where the cgs units used by Jackson are retained in this section. The radial functions ƒₗ(kr) and gₗ(kr) are of the form:

gₗ(kr)=Aₗ⁽¹⁾hₗ⁽¹⁾+Aₗ⁽²⁾hₗ⁽²⁾ (4)

X_{l,m} is the vector spherical harmonic defined by

$$\begin{matrix}{X}_{l , m} ( θ , φ ) = \frac{1}{\sqrt{l ( l + 1 )}} {LY}_{l , m} ( θ , φ ) \\ where & ( 5 ) \\ L = \frac{1}{i} ( r \times ∇ ) & ( 6 )\end{matrix}$$

The coefficients a_{E}(l, m) and aₘ(l, m) of Eq. (3) specify the amounts of electric (l, m) multipole and magnetic (l, m) multipole fields, and are determined by sources and boundary conditions as are the relative proportions in Eq. (4). Jackson gives the result of the electric and magnetic coefficients from the sources as

$$\begin{matrix}{a}_{E} ( l , m ) = \frac{4 π {k}^{2}}{i \sqrt{l ( l + 1 )}} \int {Y}_{l}^{m *} \{ \begin{matrix}ρ \frac{\partial }{\partial r} [ r {j}_{l} ( kr ) ] + \\ \frac{ik}{c} ( r \cdot J ) {j}_{l} ( kr ) - \\ ik ∇ \cdot ( r \times M ) {j}_{l} ( kr )\end{matrix} \} {d}^{3} x \\ and & ( 7 ) \\ {a}_{M} ( l , m ) = \frac{- 4 π {k}^{2}}{\sqrt{l ( l + 1 )}} \int {j}_{l} ( kr ) {Y}_{l}^{m *} L \cdot ( \frac{J}{c} + ∇ \times M ) {d}^{3} x & ( 8 )\end{matrix}$$

respectively, where the distribution of charge ρ(x,t), current J(x,t), and intrinsic magnetization M(x,t) are harmonically varying sources: ρ(x)e^{-ω}^{ₙ}^{t}, J(x)e^{-ω}^{ₙ}^{t}, and M(x)e^{-ω}^{ₙ}^{t}.

The electron current-density function can be solved as a boundary value problem regarding the time varying corresponding source current J(x)e^{-ω}^{ₙ}^{t} that gives rise to the time-varying spherical electromagnetic fields during transitions between states with the further constraint that the electron is nonradiative in a state defined as the n=1 state. The potential energy, V(r), is an inverse-radius-squared relationship given by given by Gauss' law which for a point charge or a two-dimensional spherical shell at a distance r from the nucleus the potential is

$$V ( r ) = - \frac{{e}^{2}}{4 {πɛ}_{0} r} \qquad ( 9 )$$

Thus, consideration of conservation of energy would require that the electron radius must be fixed. Addition constraints requiring a two-dimensional source current of fixed radius are matching the delta function of Eq. (1) with no singularity, no time dependence and consequently no radiation, absence of self-interaction (See Appendix III of Ref. [1]), and exact electroneutrality of the hydrogen atom wherein the electric field is given by

$$n \cdot ( {E}_{1} - {E}_{2} ) = \frac{{σ}_{s}}{{ɛ}_{0}} \qquad ( 10 )$$

where n is the normal unit vector, E₁ and E₂ are the electric field vectors that are discontinuous at the opposite surfaces, σₛ is the discontinuous two-dimensional surface charge density, and E₂=0. Then, the solution for the radial electron function, which satisfies the boundary conditions is a delta function in spherical coordinates—a spherical shell [22]

$$f ( r ) = \frac{1}{{r}^{2}} δ ( r - {r}_{n} ) \qquad ( 11 )$$

where rₙ is an allowed radius. This function defines the charge density on a spherical shell of a fixed radius (See FIG. 1), not yet determined, with the charge motion confined to the two-dimensional spherical surface. The integer subscript n is determined during photon absorption as given in the Excited States of the One-Electron Atom (Quantization) section of Ref. [1]. It is shown in this section that the force balance between the electric fields of the electron and proton plus any resonantly absorbed photons gives the result that rₙ=nr₁ wherein n is an integer in an excited state.

FIG. 1. A bound electron is a constant two-dimensional spherical surface of charge (zero thickness, total charge=θ=π, and total mass=mₑ), called an electron orbitsphere. The corresponding uniform current-density function having angular momentum components of

$${L}_{xy} = \frac{ℏ}{4} and {L}_{z} = \frac{ℏ}{2}$$

give rise to the phenomenon of electron spin.

Given time harmonic motion and a radial delta function, the relationship between an allowed radius and the electron wavelength is given by

2πrₙ=λₙ (12)

Based on conservation of the electron's angular momentum of , the magnitude of the velocity and the angular frequency for every point on the surface of the bound electron are

$$\begin{matrix}{v}_{n} = \frac{h}{{m}_{e} {λ}_{n}} = \frac{h}{{m}_{e} 2 π {r}_{n}} = \frac{ℏ}{{m}_{e} {r}_{n}} & ( 13 ) \\ {ω}_{n} = \frac{ℏ}{{m}_{e} {r}_{n}^{2}} & ( 14 )\end{matrix}$$

To further match the required multipole electromagnetic fields between transitions of states, the trial nonradiative source current functions are time and spherical harmonics, each having an exact radius and an exact energy. Then, each allowed electron charge-density (mass-density) function is the product of a radial delta function

$$( f ( r ) = \frac{1}{{r}^{2}} δ ( r - {r}_{n} ) ) ,$$

two angular functions (spherical harmonic functions Yₗ^{m}(θ,φ)=Pₗ^{m}(cos θ)e^{imφ}), and a time-harmonic function e^{iω}^{ₙ}^{t}. The spherical harmonic Y₀⁰(θ,φ)=1 is also an allowed solution that is in fact required in order for the electron charge and mass densities to be positive definite and to give rise to the phenomena of electron spin. The real parts of the spherical harmonics vary between −1 and 1. But the mass of the electron cannot be negative; and the charge cannot be positive. Thus, to insure that the function is positive definite, the form of the angular solution must be a superposition:

Y₀⁰(θ,φ)+Yₗ^{m}(θ,φ) (15)

The current is constant at every point on the surface for the s orbital corresponding to Y₀⁰(θ,φ). The quantum numbers of the spherical harmonic currents can be related to the observed electron orbital angular momentum states. The currents corresponding to s, p, d, f, etc. orbitals are

$$\begin{matrix}l = 0 \\ ρ ( r , θ , φ , t ) = \frac{e}{8 π {r}^{2}} [ δ ( r - {r}_{n} ) ] [ {Y}_{0}^{0} ( θ , φ ) + {Y}_{l}^{m} ( θ , φ ) ] & ( 16 ) \\ l \neq 0 \\ ρ ( r , θ , φ , t ) = \frac{e}{4 π {r}^{2}} [ δ ( r - {r}_{n} ) ] [ {Y}_{0}^{0} ( θ , φ ) + Re \{ {Y}_{l}^{m} ( θ , φ ) {e}^{{iω}_{n} t} \} ] & ( 17 )\end{matrix}$$

where Yₗ^{m}(θ,φ) are the spherical harmonic functions that spin about the z-axis with angular frequency ωₙ with Y₀⁰ (θ,φ) the constant function.
Re{Yₗ^{m}(θ,φ)e^{iω}^{ₙ}^{t}}=Pₗ^{m}(cos θ)cos(mφ+ωₙt) and to keep the form of the spherical harmonic as a traveling wave about the z-axis, ωₙ=mωₙ.

The Fourier transform of the electron charge-density function is a solution of the four-dimensional wave equation in frequency space (k, ω-space). Then the corresponding Fourier transform of the current-density function K (s, Θ, Φ, ω) is given by multiplying by the constant angular frequency.

$$K ( s , Θ , Φ , ω ) = 4 π {ω}_{n} \frac{sin ( 2 {s}_{n} {r}_{n} )}{2 {s}_{n} {r}_{n}} ⊗ 2 π {\sum }_{υ = 1}^{∞} \frac{{( - 1 )}^{υ - 1} {( π sin Θ )}^{2 ( υ - 1 )}}{( υ - 1 ) ! ( υ - 1 ) !} \frac{Γ ( \frac{1}{2} ) Γ ( υ + \frac{1}{2} )}{{( π cos Θ )}^{2 υ + 1} {2}^{υ + 1}} \frac{2 υ !}{( υ - 1 ) !} {s}^{- 2 υ} ⊗ 2 π {\sum }_{υ = 1}^{∞} \frac{{( - 1 )}^{υ - 1} {( πsin Φ )}^{2 ( υ - 1 )}}{( υ - 1 ) ! ( υ - 1 ) !} \frac{Γ ( \frac{1}{2} ) Γ ( υ + \frac{1}{2} )}{{( π cos Φ )}^{2 υ + 1} {2}^{υ + 1}} \frac{2 υ !}{( υ - 1 ) !} {s}^{- 2 υ} \frac{1}{4 π} [ δ ( ω - {ω}_{n} ) + δ ( ω + {ω}_{n} ) ] \qquad ( 18 )$$

The motion on the orbitsphere is angular; however, a radial correction exists due to special relativistic effects. Consider the radial wave vector of the sinc function. When the radial projection of the velocity is c

sₙ·vₙ=sₙ·c=ωₙ (19)

the relativistically corrected wavelength is (Eq. (1.247) of Ref. [1])

rₙ=λₙ (20)

Substitution of Eq. (20) into the sinc function results in the vanishing of the entire Fourier transform of the current-density function. Thus, spacetime harmonics of

$$\frac{{ω}_{n}}{c} = k$$

or

$$\frac{{ω}_{n}}{c} \sqrt{\frac{ɛ}{{ɛ}_{o}}} = k$$

for which the Fourier transform of the current-density function is nonzero do not exist. Radiation due to charge motion does not occur in any medium when this boundary condition is met. There is acceleration without radiation. (Also see Abbott and Griffiths and Goedecke [23-24]). Nonradiation is also shown directly using Maxwell's equations directly in Appendix I of Ref. [1]. However, in the case that such a state arises as an excited state by photon absorption, it is radiative due to a radial dipole term in its current-density function since it possesses spacetime Fourier transform components synchronous with waves traveling at the speed of light as shown in the Instability of Excited States section of Ref. [1]. The radiation emitted or absorbed during electron transitions is the multipole radiation given by Eq. (2) as given in the Excited States of the One-Electron Atom (Quantization) section and the Equation of the Photon section of Ref. [1] wherein Eqs. (4.18-4.23) give a macro-spherical wave in the far-field.

The corresponding uniform current density function Y₀⁰(θ,φ) corresponding to Eqs. (16-17) that gives rise to the spin of the electron is generated from a basis set current-vector field defined as the orbitsphere current-vector field (“orbitsphere-cvf”). The orbitsphere-cvf comprises a continuum of correlated orthogonal great circle current-density elements (one dimensional “current loops”). The current pattern comprising two components is generated over the surface by two sets (Steps One and Two) of rotations of two orthogonal great circle current loops that serve as basis elements about each of the (iₓ, i_{y},0i_{z}) and

$$( - \frac{1}{\sqrt{2}} {i}_{x} , \frac{1}{\sqrt{2}} {i}_{y} , {i}_{z} ) - axes ,$$

respectively, by π radians. In Appendix II of Ref. [1], the continuous uniform electron current density function Y₀⁰(θ,φ) having the angular momentum components of

$${L}_{xy} = \frac{ℏ}{4} and {L}_{z} = \frac{ℏ}{2}$$

is then exactly generated from this orbitsphere-cvf as a basis element by a convolution operator comprising an autocorrelation-type function. The positive Cartesian quadrant view of a representation of the total current pattern of the uniform current pattern of the Y₀⁰(θ,φ) orbitsphere comprising the superposition of 144 current elements each of STEP ONE and STEP TWO is shown in FIG. 2A, and this representation with 144 vectors overlaid for each of STEP ONE and STEP TWO giving the direction of the current of each great circle element is shown in FIG. 2B. As the number of great circles goes to infinity the current distribution becomes exactly continuous and uniform. A representation of the positive Cartesian quadrant view of the total uniform current-density pattern of STEP ONE and STEP TWO of the Y₀⁰(θ,φ) orbitsphere with 144 vectors per STEP overlaid on the continuous bound-electron current density giving the direction of the current of each great circle element is shown in FIG. 2C. This superconducting current pattern is confined to two spatial dimensions.

FIGS. 2A-C. The bound electron exists as a spherical two-dimensional supercurrent (electron orbitsphere), an extended distribution of charge and current completely surrounding the nucleus. Unlike a spinning sphere, there is a complex pattern of motion on its surface (indicated by vectors) that give rise to two orthogonal components of angular momentum (FIG. 1) that give rise to the phenomenon of electron spin. (A) A great-circle representation of the positive Cartesian quadrant view of the total uniform current-density pattern of the Y₀⁰(θ,φ) orbitsphere comprising the superposition of the representations of STEP ONE and STEP TWO, each with 144 great circle current elements. (B) A great-circle representation of the positive Cartesian quadrant view of the total uniform current-density pattern of the Y₀⁰(θ,φ) orbitsphere comprising the superposition of representations of STEP ONE and STEP TWO, each with 144 vectors overlaid giving the direction of the current of each great circle element. (C) A representation of the positive Cartesian quadrant view of the total uniform current-density pattern of STEP ONE and STEP TWO of the Y₀⁰(θ,φ) orbitsphere with 144 vectors per STEP overlaid on the continuous bound-electron current density giving the direction of the current of each great circle element (nucleus not to scale).

Thus, a bound electron is a constant two-dimensional spherical surface of charge (zero thickness and total charge=−e), called an electron orbitsphere that can exist in a bound state at only specified distances from the nucleus determined by an energy minimum for the n=1 state and integer multiples of this radius due to the action of resonant photons as shown in the Determination of Orbitsphere Radii section and Excited States of the One-Electron Atom (Quantization) section of Ref. [1], respectively. The bound electron is not a point, but it is point-like (behaves like a point at the origin). The free electron is continuous with the bound electron as it is ionized and is also point-like as shown in the Electron in Free Space section of Ref. [1]. The total function that describes the spinning motion of each electron orbitsphere is composed of two functions. One function, the spin function (see FIG. 1 for the charge function and FIG. 2 for the current function), is spatially uniform over the orbitsphere, where each point moves on the surface with the same quantized angular and linear velocity, and gives rise to spin angular momentum. It corresponds to the nonradiative n=1, l=0 state of atomic hydrogen which is well known as an s state or orbital. The other function, the modulation function, can be spatially uniform—in which case there is no orbital angular momentum and the magnetic moment of the electron orbitsphere is one Bohr magneton—or not spatially uniform—in which case there is orbital angular momentum. The modulation function rotates with a quantized angular velocity about a specific (by convention) z-axis. The constant spin function that is modulated by a time and spherical harmonic function as given by Eq. (17) is shown in FIG. 3 for several l values. The modulation or traveling charge-density wave that corresponds to an orbital angular momentum in addition to a spin angular momentum are typically referred to as p, d, f, etc. orbitals and correspond to an l quantum number not equal to zero.

FIG. 3. The orbital function modulates the constant (spin) function, (shown for t=0; three-dimensional view).

It was shown previously [1-13] that classical physics gives closed form solutions for the atom including the stability of the n=1 state and the instability of the excited states, the equation of the photon and electron in excited states, the equation of the free electron, and photon which predict the wave particle duality behavior of particles and light. The current and charge density functions of the electron may be directly physically interpreted. For example, spin angular momentum results from the motion of negatively charged mass moving systematically, and the equation for angular momentum, r×p, can be applied directly to the wavefunction (a current density function) that describes the electron. The magnetic moment of a Bohr magneton, Stern Gerlach experiment, g factor, Lamb shift, resonant line width and shape, selection rules, correspondence principle, wave-particle duality, excited states, reduced mass, rotational energies, and momenta, orbital and spin splitting, spin-orbital coupling, Knight shift, and spin-nuclear coupling, and elastic electron scattering from helium atoms, are derived in closed form equations based on Maxwell's equations. The agreement between observations and predictions based on closed-form equations with fundamental constants only matches to the limit permitted by the error in the measured fundamental constants.

In contrast to the failure of the Bohr theory and the nonphysical, unpredictive, adjustable-parameter approach of quantum mechanics, multielectron atoms [1, 5] and the nature of the chemical bond [1, 6] are given by exact closed-form solutions containing fundamental constants only. Using the nonradiative electron current-density functions, the radii are determined from the force balance of the electric, magnetic, and centrifugal forces that correspond to the minimum of energy of the atomic or ionic system. The ionization energies are then given by the electric and magnetic energies at these radii. The spreadsheets to calculate the energies from exact solutions of one through twenty-electron atoms are available from the internet [25]. For 400 atoms and ions the agreement between the predicted and experimental results are remarkable [5]. Here I extend these results to the nature of the chemical bond. In this regard, quantum mechanics has historically sought the lowest energy of the molecular system, but this is trivially the case of the electrons inside the nuclei. Obviously, the electrons must obey additional physical laws since matter does not exist in a state with the electrons collapsed into the nuclei. Specifically, molecular bonding is due to the physics of Newton's and Maxwell's laws together with achieving an energy minimum.

The structure of the bound molecular electron was solved by first considering the one-electron molecule H₂⁺ and then the simplest molecule H₂[1, 6]. The nature of the chemical bond was solved in the same fashion as that of the bound atomic electron. First principles including stability to radiation requires that the electron charge of the molecular orbital is a prolate spheroid, a solution of the Laplacian as an equipotential minimum energy surface in the natural ellipsoidal coordinates compared to spheroidal in the atomic case, and the current is time harmonic and obeys Newton's laws of mechanics in the central field of the nuclei at the foci of the spheroid. There is no a priori reason why the electron position must be a solution of the three-dimensional wave equation plus time and cannot comprise source currents of electromagnetic waves that are solutions of the three-dimensional wave equation plus time. Then, the special case of nonradiation determines that the current functions are confined to two-spatial dimensions plus time and match the electromagnetic wave-equation solutions for these dimensions.

In addition to the important result of stability to radiation, several more very important physical results are subsequently realized: (i) The charge is distributed on a two-dimension surface; thus, there are no infinities in the corresponding fields (Eq. (10)). Infinite fields are simply renormalized in the case of the point-particles of quantum mechanics, but it is physically gratifying that none arise in this case since infinite fields have never been measured or realized in the laboratory. (ii) The hydrogen molecular ion or molecule has finite dimensions rather than extending over all space. From measurements of the resistivity of hydrogen as a function of pressure, the finite dimensions of the hydrogen molecule are evident in the plateau of the resistivity versus pressure curve of metallic hydrogen [26]. This is in contradiction to the predictions of quantum probability functions such as an exponential radial distribution in space. Furthermore, despite the predictions of quantum mechanics that preclude the imaging of a molecule orbital, the full three-dimensional structure of the outer molecular orbital of N₂ has been recently tomographically reconstructed [27]. The charge-density surface observed is similar to that shown in FIG. 4 for H₂ which is direct evidence that MO's electrons are not point-particle probability waves that have no form until they are “collapsed to a point” by measurement. Rather they are physical, two-dimensional equipotential charge density functions as derived herein. (iii) Consistent with experiments, neutral scattering is predicted without violation of special relativity and causality wherein a point must be everywhere at once as required in the QM case. (iv) There is no electron self-interaction. The continuous charge-density function is a two-dimensional equipotential energy surface with an electric field that is strictly normal for the elliptic parameter ξ>0 according to Gauss' law and Faraday's law. The relationship between the electric field equation and the electron source charge-density function is given by Maxwell's equation in two dimensions [28,29] (Eq. (10)). This relation shows that only a two-dimensional geometry meets the criterion for a fundamental particle. This is the nonsingularity geometry that is no longer divisible. It is the dimension from which it is not possible to lower dimensionality. In this case, there is no electrostatic self-interaction since the corresponding potential is continuous across the surface according to Faraday's law in the electrostatic limit, and the field is discontinuous, normal to the charge according to Gauss' law [28-30]. (v) The instability of electron-electron repulsion of molecular hydrogen is eliminated since the central field of the hydrogen molecular ion relative to a second electron at ξ>0 which binds to form the hydrogen molecule is that of a single charge at the foci. (vi) The ellipsoidal MOs allow exact spin pairing over all time that is consistent with experimental observation. This aspect is not possible in the QM model.

FIGS. 4A-B. Prolate spheroidal H₂ MO, an equipotential minimum energy two-dimensional surface of charge and current that is stable to radiation. (A) External surface showing the charge density that is proportional to the distance from the origin to the tangent to the surface with the maximum density of the MO closest to the nuclei, an energy minimum. (B) Prolate spheroid parameters of molecules and molecular ions where a is the semimajor axis, 2a is the total length of the molecule or molecular ion along the principal axis, b=c is the semiminor axis, 2b=2c is the total width of the molecule or molecular ion along the minor axis, c′ is the distance from the origin to a focus (nucleus), 2c′ is the internuclear distance, and the protons are at the foci.

Current algorithms to solve molecules are based on nonphysical models based on the concept that the electron is a zero or one-dimensional point in an all-space probability wave function ψ(x) that permits the electron to be over all space simultaneously and give output based on trial and error or direct empirical adjustment of parameters. These models ultimately cannot be the actual description of a physical electron in that they inherently violate physical laws. They suffer from the same shortcomings that plague atomic quantum theory, infinities, instability with respect to radiation according to Maxwell's equations, violation of conservation of linear and angular momentum, lack of physical relativistic invariance, and the electron is unbounded such that the edge of molecules does not exist. There is no uniqueness, as exemplified by the average of 150 internally inconsistent programs per molecule for each of the 788 molecules posted on the NIST website [31].

Furthermore, from a physical perspective, the implication for the basis of the chemical bond according to quantum mechanics being the exchange integral and the requirement of zero-point vibration, “strictly quantum mechanical phenomena,” is that the theory cannot be a correct description of reality as described for even the simple bond of molecular hydrogen as reported previous [1, 6]. Even the premise that “electron overlap” is responsible for bonding is opposite to the physical reality that negative charges repel each other with an inverse-distance-squared force dependence that becomes infinite. A proposed solution based on physical laws and fully compliant with Maxwell's equations solves the parameters of molecules even to infinite length and complexity in closed form equations with fundamental constants only.

For the first time in history, the key building blocks of organic chemistry have been solved from two basic equations. Now, the true physical structure and parameters of an infinite number of organic molecules up to infinite length and complexity can be obtained to permit the engineering of new pharmaceuticals and materials at the molecular level. The solutions of the basic functional groups of organic chemistry were obtained by using generalized forms of a geometrical and an energy equation for the nature of the H—H bond. The geometrical parameters and total bond energies of about 800 exemplary organic molecules were calculated using the functional group composition. The results obtained essentially instantaneously match the experimental values typically to the limit of measurement [1]. The solved function groups are given in Table 1.

TABLE 1
Partial List of Organic Functional Groups Solved by Classical Physics.

| | | |
|---|---|---|
| Continuous-Chain Alkanes | N-alkyl Amides | Phenol |
| Branched Alkanes | N,N-dialkyl Amides | Aniline |
| Alkenes | Urea | Aryl Nitro Compounds |
| Branched Alkenes | Carboxylic Acid Halides | Benzoic Acid Compounds |
| Alkynes | Carboxylic Acid Anhydrides | Anisole |
| Alkyl Fluorides | Nitriles | Pyrrole |
| Alkyl Chlorides | Thiols | Furan |
| Alkyl Bromides | Sulfides | Thiophene |
| Alkyl Iodides | Disulfides | Imidizole |
| Alkenyl Halides | Sulfoxides | Pyridine |
| Aryl Halides | Sulfones | Pyrimidine |
| Alcohols | Sulfites | Pyrazine |
| Ethers | Sulfates | Quinoline |
| Primary Amines | Nitroalkanes | Isoquinoline |
| Secondary Amines | Alkyl Nitrates | Indole |
| Tertiary Amines | Alkyl Nitrites | Adenine |
| Aldehydes | Conjugated Alkenes | Fullerene (C₆₀) |
| Ketones | Conjugated Polyenes | Graphite |
| Carboxylic Acids | Aromatics | Phosphines |
| Carboxylic Acid Esters | Napthalene | Phosphine Oxides |
| Amides | Toluene | Phosphites |
| | Chlorobenzene | Phosphates |

The two basic equations that solves organic molecules, one for geometrical parameters and the other for energy parameters, were applied to bulk forms of matter containing trillions of trillions of electrons. For example, using the same alkane- and alkene-bond solutions as elements in an infinite network, the nature of the solid molecular bond for all known allotropes of carbon (graphite, diamond, C₆₀, and their combinations) were solved. By further extension of this modular approach, the solid molecular bond of silicon and the nature of semiconductor bond were solved. The nature of other fundamental forms of matter such as the nature of the ionic bond, the metallic bond, and additional major fields of chemistry such as that of silicon, organometallics, and boron were solved exactly such that the position and energy of each and every electron is precisely specified. The implication of these results is that it is possible using physical laws to solve the structure of all types of matter. Some of the solved forms of matter of infinite extent as well as additional major fields of chemistry are given in Table 2. In all cases, the agreement with experiment is remarkable [1].

TABLE 2
Partial List of Additional Molecules and Compositions of Matter Solved
by Classical Physics.

```
Solid Molecular Bond of the Three Allotropes
of Carbon
    Diamond
    Graphite
    Fullerene (C₆₀)
Solid Ionic Bond of Alkali-Hydrides
    Alkali-Hydride Crystal Structures
        Lithium Hydride
        Sodium Hydride
        Potassium Hydride
        Rubidium & Cesium Hydride
        Potassium Hydrino Hydride
Solid Metallic Bond of Alkali Metals
    Alkali Metal Crystal Structures
        Lithium Metal
        Sodium Metal
        Potassium Metal
        Rubidium & Cesium Metals
Alkyl Aluminum Hydrides
Silicon Groups and Molecules
    Silanes
    Alkyl Silanes and Disilanes
Solid Semiconductor Bond of Silicon
    Insulator-Type Semiconductor Bond
    Conductor-Type Semiconductor Bond
Boron Molecules
    Boranes
        Bridging Bonds of Boranes
    Alkoxy Boranes
    Alkyl Boranes
    Alkyl Borinic Acids
    Tertiary Aminoboranes
    Quaternary Aminoboranes
    Borane Amines
Halido Boranes Organometallic Molecular
Functional Groups and Molecules
    Alkyl Aluminum Hydrides
        Bridging Bonds of
        Organoaluminum Hydrides
    Organogermanium and Digermanium
    Organolead
    Organoarsenic
    Organoantimony
    Organobismuth
Organic Ions
    1° Amino
    2° Amino
    Carboxylate
    Phosphate
    Nitrate
    Sulfate
    Silicate
Proteins
    Amino Acids
    Peptide Bonds
DNA
    Bases
    2-deoxyribose
    Ribose
    Phosphate Backbone
```

The background theory of classical physics (CP) for the physical solutions of atoms and atomic ions is disclosed in Mills journal publications [1-13], R. Mills, The Grand Unified Theory of Classical Quantum Mechanics, January 2000 Edition, BlackLight Power, Inc., Cranbury, N.J., (“'00 Mills GUT”), provided by BlackLight Power, Inc., 493 Old Trenton Road, Cranbury, N.J., 08512; R. Mills, The Grand Unified Theory of Classical Quantum Mechanics, September 2001 Edition, BlackLight Power, Inc., Cranbury, N.J., Distributed by Amazon.com (“'01 Mills GUT”), provided by BlackLight Power, Inc., 493 Old Trenton Road, Cranbury, N.J., 08512; R. Mills, The Grand Unified Theory of Classical Quantum Mechanics, July 2004 Edition, BlackLight Power, Inc., Cranbury, N.J., (“'04 Mills GUT”), provided by BlackLight Power, Inc., 493 Old Trenton Road, Cranbury, N.J., 08512; R. Mills, The Grand Unified Theory of Classical Quantum Mechanics, January 2005 Edition, BlackLight Power, Inc., Cranbury, N.J., (“'05 Mills GUT”), provided by BlackLight Power, Inc., 493 Old Trenton Road, Cranbury, N.J., 08512; R. L. Mills, “The Grand Unified Theory of Classical Quantum Mechanics”, June 2006 Edition, Cadmus Professional Communications-Science Press Division, Ephrata, Pa., ISBN 0963517171, Library of Congress Control Number 2005936834, (“'06 Mills GUT”), provided by BlackLight Power, Inc., 493 Old Trenton Road, Cranbury, N.J., 08512; ; R. Mills, The Grand Unified Theory of Classical Quantum Mechanics, October 2007 Edition, BlackLight Power, Inc., Cranbury, N.J., (“'07 Mills GUT”), provided by BlackLight Power, Inc., 493 Old Trenton Road, Cranbury, N.J., 08512; R. Mills, The Grand Unified Theory of Classical Physics, June 2008 Edition, BlackLight Power, Inc., Cranbury, N.J., (“'08 Mills GUT-CP”); in prior published PCT applications WO05/067678; WO2005/116630; WO2007/051078; WO2007/053486; and WO2008/085,804, and U.S. Pat. No. 7,188,033; U.S. Application Nos.: 60/878,055, filed 3 Jan. 2007; 60/880,061, filed 12 Jan. 2007; 60/898,415, filed 31 Jan. 2007; 60/904,164, filed 1 Mar. 2007; 60/907,433, filed 2 Apr. 2007; 60/907,722, filed 13 Apr. 2007; 60/913,556, filed 24 Apr. 2007; 60/986,675, filed 9 Nov. 2007; 60/988,537, filed 16 Nov. 2007; 61/018,595, filed 2 Jan. 2008; 61/027,977, filed 12 Feb. 2008; 61/029,712, filed 19 Feb. 2008; and 61/082,701, filed 22 Jul. 22 2008, the entire disclosures of which are all incorporated herein by reference (hereinafter “Mills Prior Publications”).

The present disclosure, an exemplary embodiment of which is also referred to as Millsian software and systems, stems from a new fundamental insight into the nature of the atom. Applicant's theory of Classical Physics (CP) reveals the nature of atoms and molecules using classical physical laws for the first time. As discussed above, traditional quantum mechanics can solve neither multi-electron atoms nor molecules exactly. By contrast, CP produces exact, closed-form solutions containing physical constants only for even the most complex atoms and molecules.

The present invention is the first and only molecular modeling program ever built on the CP framework. All the major functional groups that make up most organic molecules and the most common classes of molecules have been solved exactly in closed-form solutions with CP. By using these functional groups as building blocks, or independent units, a potentially infinite number of organic molecules can be solved. As a result, the present invention can be used to visualize the exact 3D structure and calculate the heats of formation of an infinite number of molecules, and these solutions can be used in modeling applications.

For the first time, the significant building-block molecules of chemistry have been successfully solved using classical physical laws in exact closed-form equations having fundamental constants only. The major functional groups have been solved from which molecules of infinite length can be solved almost instantly with a computer program. The predictions are accurate within experimental error for over 800 exemplary molecules, typically a factor of 1000 times more accuracy then those given by the current Hartree-Fock algorithm based on QM [2].

The present invention's advantages over other models includes: Rendering true molecular structures; Providing precisely all characteristics, spatial and temporal charge distributions and energies of every electron in every bond, and of every bonding atom; Facilitating the identification of biologically active sites in drugs; and facilitating drug design.

An objective of the present invention is to solve the charge (mass) and current-density functions of specific groups of molecules and molecular ions disclosed herein or any portion of these species from first principles. In an embodiment, the solution for the molecules and molecular ions, or any portion of these species is derived from Maxwell's equations invoking the constraint that the bound electron before excitation does not radiate even though it undergoes acceleration.

Another objective of the present invention is to generate a readout, display, or image of the solutions so that the nature of the molecules and molecular ions, or any portion of these species be better understood and potentially applied to predict reactivity and physical and optical properties.

Another objective of the present invention is to apply the methods and systems of solving the nature of the atoms, molecules, and molecular ions, or any portion of these species and their rendering to numerical or graphical form to apply to further functional groups such as amino acids and peptide bonds with charged functional groups for proteins of any size and complexity by addition of the units, bases, 2-deoxyribose, ribose, phosphate backbone with charged functional groups for DNA of any size and complexity by addition of the units, organic ions, halobenzenes, phosphines, phosphates, phosphine oxides, phosphates, organogermanium and digermanium, organolead, organoarsenic, organoantimony, organobismuth, or any portion of these species.

These objectives and other objectives are obtained by a system of computing and rendering the nature of at least one specie selected from the groups of molecules and polyatomic molecules disclosed herein, comprising physical, Maxwellian solutions of charge, mass, and current density functions of said specie, said system comprising processing means for processing physical, Maxwellian equations representing charge, mass, and current density functions of said specie; and an output device in communication with the processing means for displaying said physical, Maxwellian solutions of charge, mass, and current density functions of said specie.

Also provided is a composition of matter comprising a plurality of atoms having a novel property or use discovered by calculation of at least one of (i) a bond distance between two of the atoms, (ii) a bond angle between three of the atoms, (iii) a bond energy between two of the atoms, (iv) orbital intercept distances and angles, (v) charge-density functions of atomic, hybridized, and molecular orbitals, (vi) orientations distances, and energies of species in different physical states such as solid, liquid, and gas, and (vii) reaction parameters with other species.

The parameters such as bond distance, bond angle, bond energy, species orientations and reactions being calculated from physical solutions of the charge, mass, and current density functions of atoms and atomic ions, which solutions are derived from Maxwell's equations using a constraint that a bound electron(s) does not radiate under acceleration.

The presented exact physical solutions for known species of the groups of molecules and molecular ions disclosed herein can be applied to other unknown species. These solutions can be used to predict the properties of presently unknown species and engineer compositions of matter in a manner that is not possible using past quantum mechanical techniques. The molecular solutions can be used to design synthetic pathways and predict product yields based on equilibrium constants calculated from the heats of formation. Not only can new stable compositions of matter be predicted, but now the structures of combinatorial chemistry reactions can be predicted.

Pharmaceutical applications include the ability to graphically or computationally render the structures of drugs in solution that permit the identification of the biologically active parts of the specie to be identified from the common spatial charge-density functions of a series of active species. Novel drugs can now be designed according to geometrical parameters and bonding interactions with the data of the structure of the active site of the drug.

The system can be used to calculate conformations, folding, and physical properties, and the exact solutions of the charge distributions in any given specie are used to calculate the fields. From the fields, the interactions between groups of the same specie or between groups on different species are calculated wherein the interactions are distance and relative orientation dependent. The fields and interactions can be determined using a finite-element-analysis approach of Maxwell's equations. The approach can be applied to solid, liquid, and gases phases of a species or a species present in a mixture or solution.

Embodiments of the system for performing computing and rendering of the nature of the groups of molecules and molecular ions, or any portion of these species using the physical solutions and their phases or structures in different media may comprise a general purpose computer. Such a general purpose computer may have any number of basic configurations. For example, such a general purpose computer may comprise a central processing unit (CPU), one or more specialized processors, system memory, a mass storage device such as a magnetic disk, an optical disk, or other storage device, an input means, such as a keyboard or mouse, a display device, and a printer or other output device. A system implementing the present invention can also comprise a special purpose computer or other hardware system and all should be included within its scope. A complete description of how a computer can be used is disclosed in Applicant's prior incorporated WO2007/051078 application.

Although not preferred, any of the calculated and measured values and constants recited in the equations herein can be adjusted, for example, up to ±10%, if desired.

### BRIEF DESCRIPTION OF THE DRAWINGS

FIG. 1. Is a drawing of a bound electron with a constant two-dimensional spherical surface of charge (zero thickness, total charge=θ=π, and total mass=mₑ), called an electron orbitsphere.

FIGS. 2A-C. An electron orbitsphere of a great-circle representation of the positive Cartesian quadrant view of the total uniform current-density pattern of the Y₀⁰(θ,φ) orbitsphere, wherein (A) is shown with 144 great circle current elements; (B) is shown with 144 vectors overlaid giving the direction of the current of each great circle element; and (C) is shown with 144 vectors per step overlaid on the continuous bound-electron current density giving the direction of the current of each great circle element (nucleus not to scale).

FIG. 3. The orbital function modulates the constant (spin) function, (shown for t=0; three-dimensional view).

FIGS. 4A-B. Prolate spheroidal H₂ MO, with (A) External surface showing the charge density that is proportional to the distance from the origin to the tangent to the surface; and (B) Prolate spheroid parameters of molecules and molecular ions where a is the semimajor axis, 2a is the total length of the molecule or molecular ion along the principal axis, b=c is the semiminor axis, 2b=2c is the total width of the molecule or molecular ion along the minor axis, c′ is the distance from the origin to a focus (nucleus), 2c′ is the internuclear distance, and the protons are at the foci.

FIG. 5. Color scale, translucent view of the charge-density of chlorobenzene showing the orbitals of the atoms at their radii, the ellipsoidal surface of each H or H₂-type ellipsoidal MO that transitions to the corresponding outer shell of the atom(s) participating in each bond, and the hydrogen nuclei (red, not to scale).

FIG. 6. Adenine.

FIG. 7. Color scale, charge-density of adenine showing the orbitals of the atoms at their radii, the ellipsoidal surface of each H or H₂-type ellipsoidal MO that transitions to the corresponding outer shell of the atom(s) participating in each bond, and the hydrogen nuclei.

FIG. 8. Thymine.

FIG. 9. Color scale, charge-density of thymine showing the orbitals of the atoms at their radii, the ellipsoidal surface of each H or H₂-type ellipsoidal MO that transitions to the corresponding outer shell of the atom(s) participating in each bond, and the hydrogen nuclei.

FIG. 10. Guanine.

FIG. 11. Color scale, charge-density of guanine showing the orbitals of the atoms at their radii, the ellipsoidal surface of each H or H₂-type ellipsoidal MO that transitions to the corresponding outer shell of the atom(s) participating in each bond, and the hydrogen nuclei.

FIG. 12. Cytosine.

FIG. 13. Color scale, charge-density of cytosine showing the orbitals of the atoms at their radii, the ellipsoidal surface of each H or H₂-type ellipsoidal MO that transitions to the corresponding outer shell of the atom(s) participating in each bond, and the hydrogen nuclei.

FIG. 14. Color scale, charge-density of triphenylphosphine showing the orbitals of the atoms at their radii, the ellipsoidal surface of each H or H₂-type ellipsoidal MO that transitions to the corresponding outer shell of the atom(s) participating in each bond, and the hydrogen nuclei.

FIG. 15. Color scale, charge-density of tri-isopropyl phosphite showing the orbitals of the atoms at their radii, the ellipsoidal surface of each H or H₂-type ellipsoidal MO that transitions to the corresponding outer shell of the atom(s) participating in each bond, and the hydrogen nuclei.

FIG. 16. Color scale, charge-density of trimethylphosphine oxide showing the orbitals of the atoms at their radii, the ellipsoidal surface of each H or H₂-type ellipsoidal MO that transitions to the corresponding outer shell of the atom(s) participating in each bond, and the hydrogen nuclei.

FIG. 17. Color scale, charge-density of tri-isopropyl phosphate showing the orbitals of the atoms at their radii, the ellipsoidal surface of each H or H₂-type ellipsoidal MO that transitions to the corresponding outer shell of the atom(s) participating in each bond, and the hydrogen nuclei.

FIG. 18. Color scale, charge-density of protonated lysine ion showing the orbitals of the atoms at their radii, the ellipsoidal surface of each H or H₂-type ellipsoidal MO that transitions to the corresponding outer shell of the atom(s) participating in each bond, and the hydrogen nuclei.

FIG. 19. Color scale, charge-density of 2-deoxy-D-ribose showing the orbitals of the atoms at their radii, the ellipsoidal surface of each H or H₂-type ellipsoidal MO that transitions to the corresponding outer shell of the atom(s) participating in each bond, and the hydrogen nuclei.

FIG. 20. Color scale, charge-density of D-ribose showing the orbitals of the atoms at their radii, the ellipsoidal surface of each H or H₂-type ellipsoidal MO that transitions to the corresponding outer shell of the atom(s) participating in each bond, and the hydrogen nuclei.

FIG. 21. Color scale, charge-density of alpha-2-deoxy-D-ribose showing the orbitals of the atoms at their radii, the ellipsoidal surface of each H or H₂-type ellipsoidal MO that transitions to the corresponding outer shell of the atom(s) participating in each bond, and the hydrogen nuclei.

FIG. 22. Color scale, charge-density of alpha-D-ribose showing the orbitals of the atoms at their radii, the ellipsoidal surface of each H or H₂-type ellipsoidal MO that transitions to the corresponding outer shell of the atom(s) participating in each bond, and the hydrogen nuclei.

FIG. 23. Designation of the atoms of the nucleotide bond. Oligonucleotide disclosed as SEQ ID NO: 1.

FIG. 24. The color scale rendering of the charge-density of the exemplary tetra-nucleotide, (deoxy)adenosine monophosphate—(deoxy)thymidine monophosphate—(deoxy)guanosine monophosphate—(deoxy)cytidine monophosphate (ATGC) showing the orbitals of the atoms at their radii and the ellipsoidal surface of each H or H₂-type ellipsoidal MO that transitions to the corresponding outer shell of the atom(s) participating in each bond.

FIG. 25. Color scale rendering of the charge-density of the DNA fragment

| | |
|---|---|
| ACTGACTGACTG | (SEQ ID NO: 1) |
| TGACTGACTGAC | |

showing the orbitals of the atoms at their radii and the ellipsoidal surface of each H or H₂-type ellipsoidal MO that transitions to the corresponding outer shell of the atom(s) participating in each bond.

FIG. 26. Aspartic acid.

FIG. 27. Color scale, charge-density of aspartic acid showing the orbitals of the atoms at their radii, the ellipsoidal surface of each H or H₂-type ellipsoidal MO that transitions to the corresponding outer shell of the atom(s) participating in each bond, and the hydrogen nuclei.

FIG. 28. Glutamic acid.

FIG. 29. Color scale, charge-density of glutamic acid showing the orbitals of the atoms at their radii, the ellipsoidal surface of each H or H₂-type ellipsoidal MO that transitions to the corresponding outer shell of the atom(s) participating in each bond, and the hydrogen nuclei.

FIG. 30. Cysteine.

FIG. 31. Color scale, charge-density of cysteine showing the orbitals of the atoms at their radii, the ellipsoidal surface of each H or H₂-type ellipsoidal MO that transitions to the corresponding outer shell of the atom(s) participating in each bond, and the hydrogen nuclei.

FIG. 32. Lysine.

FIG. 33. Color scale, charge-density of lysine showing the orbitals of the atoms at their radii, the ellipsoidal surface of each H or H₂-type ellipsoidal MO that transitions to the corresponding outer shell of the atom(s) participating in each bond, and the hydrogen nuclei.

FIG. 34. Arginine.

FIG. 35. Color scale, charge-density of arginine showing the orbitals of the atoms at their radii, the ellipsoidal surface of each H or H₂-type ellipsoidal MO that transitions to the corresponding outer shell of the atom(s) participating in each bond, and the hydrogen nuclei.

FIG. 36. Histidine.

FIG. 37. Color scale, charge-density of histidine showing the orbitals of the atoms at their radii, the ellipsoidal surface of each H or H₂-type ellipsoidal MO that transitions to the corresponding outer shell of the atom(s) participating in each bond, and the hydrogen nuclei.

FIG. 38. Asparagine.

FIG. 39. Color scale, charge-density of asparagine showing the orbitals of the atoms at their radii, the ellipsoidal surface of each H or H₂-type ellipsoidal MO that transitions to the corresponding outer shell of the atom(s) participating in each bond, and the hydrogen nuclei.

FIG. 40. Glutamine.

FIG. 41. Color scale, charge-density of glutamine showing the orbitals of the atoms at their radii, the ellipsoidal surface of each H or H₂-type ellipsoidal MO that transitions to the corresponding outer shell of the atom(s) participating in each bond, and the hydrogen nuclei.

FIG. 42. Threonine.

FIG. 43. Color scale, charge-density of threonine showing the orbitals of the atoms at their radii, the ellipsoidal surface of each H or H₂-type ellipsoidal MO that transitions to the corresponding outer shell of the atom(s) participating in each bond, and the hydrogen nuclei.

FIG. 44. Tyrosine.

FIG. 45. Color scale, charge-density of tyrosine showing the orbitals of the atoms at their radii, the ellipsoidal surface of each H or H₂-type ellipsoidal MO that transitions to the corresponding outer shell of the atom(s) participating in each bond, and the hydrogen nuclei.

FIG. 46. Serine.

FIG. 47. Color scale, charge-density of serine showing the orbitals of the atoms at their radii, the ellipsoidal surface of each H or H₂-type ellipsoidal MO that transitions to the corresponding outer shell of the atom(s) participating in each bond, and the hydrogen nuclei.

FIG. 48. Tryptophan.

FIG. 49. Color scale, charge-density of tryptophan showing the orbitals of the atoms at their radii, the ellipsoidal surface of each H or H₂-type ellipsoidal MO that transitions to the corresponding outer shell of the atom(s) participating in each bond, and the hydrogen nuclei.

FIG. 50. Phenylalanine.

FIG. 51. Color scale, charge-density of phenylalanine showing the orbitals of the atoms at their radii, the ellipsoidal surface of each H or H₂-type ellipsoidal MO that transitions to the corresponding outer shell of the atom(s) participating in each bond, and the hydrogen nuclei.

FIG. 52. Proline.

FIG. 53. Color scale, charge-density of proline showing the orbitals of the atoms at their radii, the ellipsoidal surface of each H or H₂-type ellipsoidal MO that transitions to the corresponding outer shell of the atom(s) participating in each bond, and the hydrogen nuclei.

FIG. 54. Methionine.

FIG. 55. Color scale, charge-density of methionine showing the orbitals of the atoms at their radii, the ellipsoidal surface of each H or H₂-type ellipsoidal MO that transitions to the corresponding outer shell of the atom(s) participating in each bond, and the hydrogen nuclei.

FIG. 56. Leucine.

FIG. 57. Color scale, charge-density of leucine showing the orbitals of the atoms at their radii, the ellipsoidal surface of each H or H₂-type ellipsoidal MO that transitions to the corresponding outer shell of the atom(s) participating in each bond, and the hydrogen nuclei.

FIG. 58. Isoleucine.

FIG. 59. Color scale, charge-density of isoleucine showing the orbitals of the atoms at their radii, the ellipsoidal surface of each H or H₂-type ellipsoidal MO that transitions to the corresponding outer shell of the atom(s) participating in each bond, and the hydrogen nuclei.

FIG. 60. Valine.

FIG. 61. Color scale, charge-density of valine showing the orbitals of the atoms at their radii, the ellipsoidal surface of each H or H₂-type ellipsoidal MO that transitions to the corresponding outer shell of the atom(s) participating in each bond, and the hydrogen nuclei.

FIG. 62. Alanine.

FIG. 63. Color scale, charge-density of alanine showing the orbitals of the atoms at their radii, the ellipsoidal surface of each H or H₂-type ellipsoidal MO that transitions to the corresponding outer shell of the atom(s) participating in each bond, and the hydrogen nuclei.

FIG. 64. Glycine.

FIG. 65. Color scale, charge-density of glycine showing the orbitals of the atoms at their radii, the ellipsoidal surface of each H or H₂-type ellipsoidal MO that transitions to the corresponding outer shell of the atom(s) participating in each bond, and the hydrogen nuclei.

FIG. 66. Color scale, charge-density of the polypeptide phenylalanine-leucine-glutamine-aspartic acid (phe-leu-gln-asp) (SEQ ID NO: 2) showing the orbitals of the atoms at their radii and the ellipsoidal surface of each H or H₂-type ellipsoidal MO that transitions to the corresponding outer shell of the atom(s) participating in each bond.

FIG. 67. Color scale, charge-density of Ge(CH₂CH₃)₄ showing the orbitals of the Ge and C atoms at their radii, the ellipsoidal surface of each H or H₂-type ellipsoidal MO that transitions to the corresponding outer shell of the atoms participating in each bond, and the hydrogen nuclei.

FIG. 68. Color scale, charge-density of (C₂H₅)₃ GeGe(C₂H₅)₃ showing the orbitals of the Ge and C atoms at their radii, the ellipsoidal surface of each H or H₂-type ellipsoidal MO that transitions to the corresponding outer shell of the atoms participating in each bond, and the hydrogen nuclei.

FIG. 69. Tin Tetrachloride. Color scale, translucent view of the charge-density of SnCl₄ showing the orbitals of the Sn and Cl atoms at their radii, the ellipsoidal surface of each H₂-type ellipsoidal MO that transitions to the corresponding outer shell of the atoms participating in each bond, and the nuclei (red, not to scale).

FIGS. 70A and B. Hexaphenyldistannane. Color scale, opaque view of the charge-density of (C₆H₅)₃SnSn(C₆H₅)₃ showing the orbitals of the Sn and C atoms at their radii and the ellipsoidal surface of each H or H₂-type ellipsoidal MO that transitions to the corresponding outer shell of the atoms participating in each bond.

FIG. 71. Color scale, charge-density of Pb(CH₂CH₃)₄ showing the orbitals of the Pb and C atoms at their radii, the ellipsoidal surface of each H or H₂-type ellipsoidal MO that transitions to the corresponding outer shell of the atoms participating in each bond, and the hydrogen nuclei.

FIG. 72. Color scale, charge-density of triphenylarsine showing the orbitals of the atoms at their radii, the ellipsoidal surface of each H or H₂-type ellipsoidal MO that transitions to the corresponding outer shell of the atom(s) participating in each bond, and the hydrogen nuclei.

FIG. 73. Color scale, charge-density of triphenylstibine showing the orbitals of the atoms at their radii, the ellipsoidal surface of each H or H₂-type ellipsoidal MO that transitions to the corresponding outer shell of the atom(s) participating in each bond, and the hydrogen nuclei.

FIG. 74. Color scale, charge-density of triphenylbismuth showing the orbitals of the atoms at their radii, the ellipsoidal surface of each H or H₂-type ellipsoidal MO that transitions to the corresponding outer shell of the atom(s) participating in each bond, and the hydrogen nuclei.

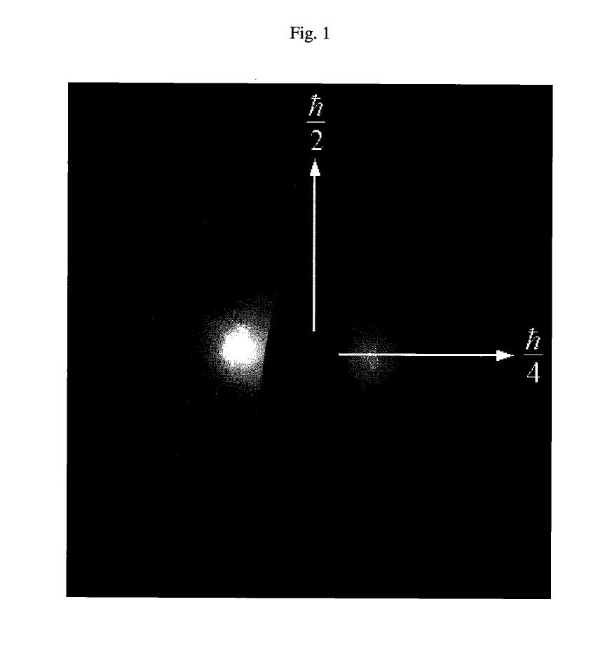

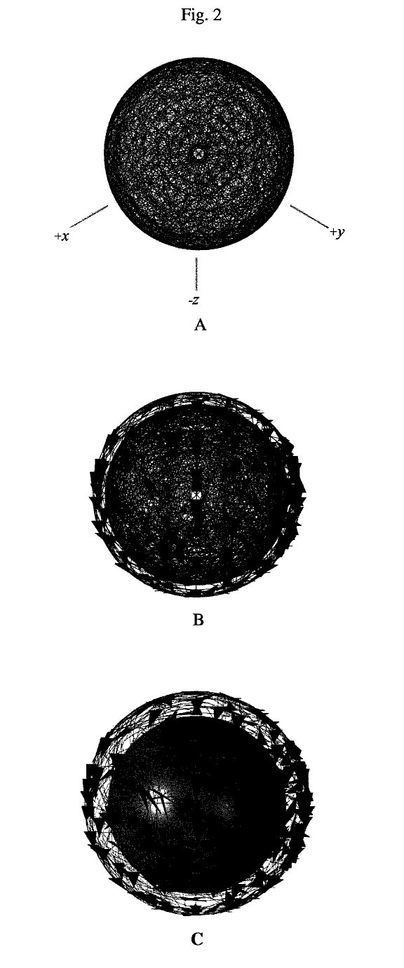

### DESCRIPTION OF THE INVENTION

The present disclosure comprises molecular modeling methods and systems for solving atomic and molecular structures based on applying the classical laws of physics, (Newton's and Maxwell's Laws) to the atomic scale. The functional groups such as amino acids and peptide bonds with charged functional groups, bases, 2-deoxyribose, ribose, phosphate backbone with charged functional groups, organic ions, halobenzenes, phosphines, phosphates, phosphine oxides, phosphates, organogermanium and digermanium, organolead, organoarsenic, organoantimony, and organobismuth have been solved in analytical equations. By using these functional groups as building blocks, or independent units, a potentially infinite number of molecules can be solved. As a result, the method and systems of the present Invention can visualize the exact three-dimensional structure and calculate physical characteristics of many molecules, up to arbitrary length and complexity. Even complex proteins and DNA (the molecules that encode genetic information) may be solved in real-time interactively on a personal computer. By contrast, previous software based on traditional quantum methods must resort to approximations and run on powerful computers for even the simplest systems.

### II. Methodological Outline

### A. The Nature of the Chemical Bond of Hydrogen

The nature of the chemical bond of functional groups is solved by first solving the simplest molecule, molecular hydrogen as given in the Nature of the Chemical Bond of Hydrogen-Type Molecules section of Ref. [1]. The hydrogen molecule charge and current density functions, bond distance, and energies are solved from the Laplacian in ellipsoidal coordinates with the constraint of nonradiation [1, 6].

$$( η - ζ ) {R}_{ξ} \frac{\partial }{\partial ξ} ( {R}_{ξ} \frac{\partial φ}{\partial ξ} ) + ( ζ - ξ ) {R}_{η} \frac{\partial }{\partial η} ( {R}_{η} \frac{\partial φ}{\partial η} ) + ( ξ - η ) {R}_{ζ} \frac{\partial }{\partial ζ} ( {R}_{ζ} \frac{\partial φ}{\partial ζ} ) = 0 \qquad ( 21 )$$

a. The Geometrical Parameters of the Hydrogen Molecule

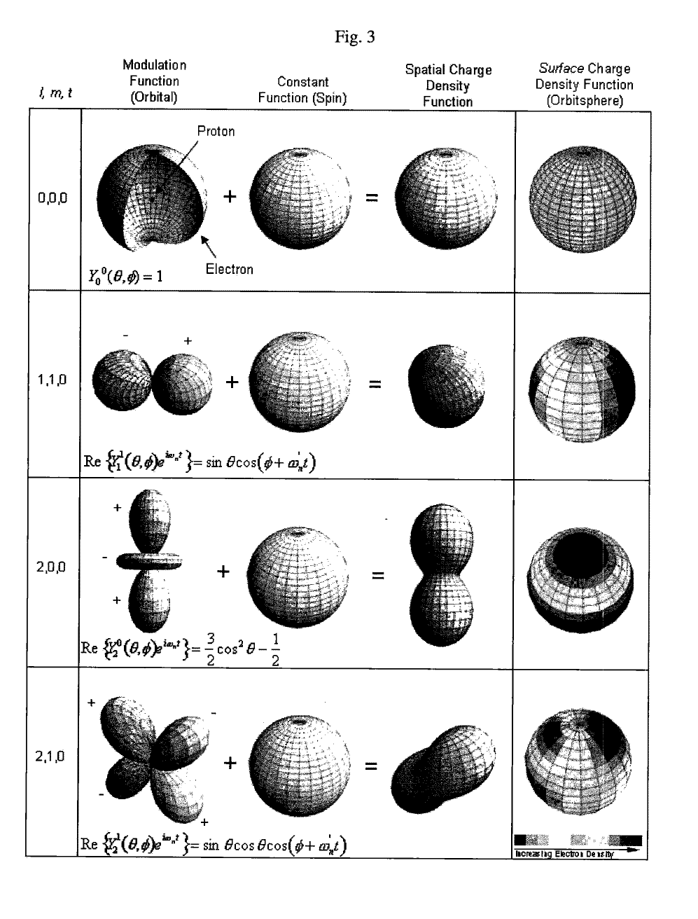

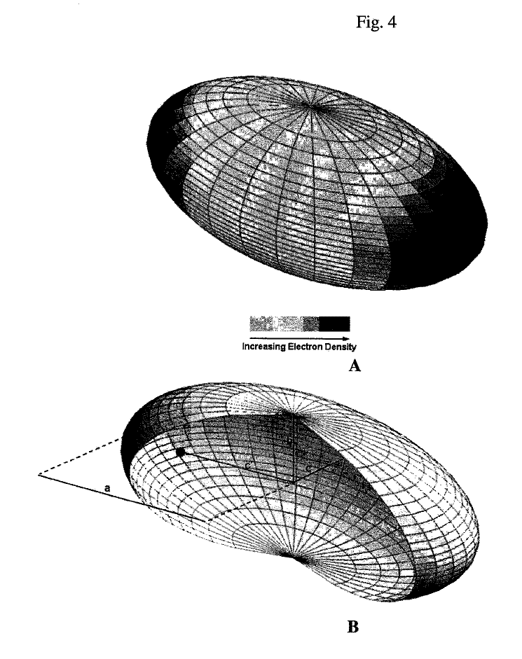

As shown in FIG. 4, the nuclei are at the foci of the electrons comprising a two-dimensional, equipotential-energy, charge- and current-density surface that obeys Maxwell's equations including stability to radiation and Newton's laws of motion. The force balance equation for the hydrogen molecule is

$$\frac{{ℏ}^{2}}{{m}_{e} {a}^{2} {b}^{2}} D = \frac{{e}^{2}}{8 π {ɛ}_{o} {ab}^{2}} D + \frac{{ℏ}^{2}}{2 {m}_{e} {a}^{2} {b}^{2}} D \qquad ( 22 )$$

where

D=r(t)·i_{ξ} (23)

is the time dependent distance from the origin to the tangent plane at a point on the ellipsoidal MO. Eq. (22) has the parametric solution

r(t)=ia cos ωt+jb sin ωt (24)

when the semimajor axis, a, is

a=a₀ (25)

The internuclear distance, 2c′, which is the distance between the foci is

2c′=\sqrt{2}a₀ (26)

The experimental internuclear distance is \sqrt{2}a₀. The semiminor axis is

$$b = \frac{1}{\sqrt{2}} {a}_{o} \qquad ( 27 )$$

The eccentricity, e, is

$$e = \frac{1}{\sqrt{2}} \qquad ( 28 )$$

b. The Energies of the Hydrogen Molecule

The potential energy of the two electrons in the central field of the protons at the foci is

$${V}_{e} = \frac{- 2 {e}^{2}}{8 {πɛ}_{o} \sqrt{{a}^{2} - {b}^{2}}} ln \frac{a + \sqrt{{a}^{2} - {b}^{2}}}{a - \sqrt{{a}^{2} - {b}^{2}}} = - 67.836 eV \qquad ( 29 )$$

The potential energy of the two protons is

$${V}_{p} = \frac{{e}^{2}}{8 {πɛ}_{o} \sqrt{{a}^{2} - {b}^{2}}} = 19.242 eV \qquad ( 30 )$$

The kinetic energy of the electrons is

$$T = \frac{{ℏ}^{2}}{4 {m}_{e} a \sqrt{{a}^{2} - {b}^{2}}} ln \frac{a + \sqrt{{a}^{2} - {b}^{2}}}{a - \sqrt{{a}^{2} - {b}^{2}}} = - 33.918 eV \qquad ( 31 )$$

The energy, Vₘ, of the magnetic force between the electrons is

$${V}_{m} = \frac{- {ℏ}^{2}}{4 {m}_{e} a \sqrt{{a}^{2} - {b}^{2 }}} ln \frac{a + \sqrt{{a}^{2} - {b}^{2}}}{a - \sqrt{{a}^{2} - {b}^{2}}} = - 16.959 eV \qquad ( 32 )$$

During bond formation, the electrons undergo a reentrant oscillatory orbit with vibration of the protons. The corresponding energy \sqrt{E}_{osc} is the difference between the Doppler and average vibrational kinetic energies:

$${\overline{E}}_{osc} = {\overline{E}}_{D} + {\overline{E}}_{Kvib} = ( {V}_{e } + T + {V}_{m} + {V}_{p} ) \sqrt{\frac{2 {\overline{E}}_{K}}{M {c}^{2}}} + \frac{1}{2} ℏ \sqrt{\frac{k}{μ}} \qquad ( 33 )$$

The total energy is

$$\begin{matrix}{E}_{T} = {V}_{e} + T + {V}_{m} + {V}_{p} + {\overline{E}}_{osc} & ( 34 ) \\ \begin{matrix}{E}_{T} = - \frac{{e}^{2}}{8 π {ɛ}_{o} {a}_{0}} [ \begin{matrix}( 2 \sqrt{2} - \sqrt{2} + \frac{\sqrt{2}}{2} ) \\ ln \frac{\sqrt{2} + 1}{\sqrt{2} - 1} - \sqrt{2}\end{matrix} ] \\ [ 1 + \sqrt{\frac{2 ℏ \frac{\frac{{e}^{2}}{4 {πɛ}_{o} {a}_{0}^{3}}}{{m}_{e}}}{{m}_{e} {c}^{2}}} ] - \frac{1}{2} ℏ \sqrt{\frac{k}{μ}} \\ = - 31.689 eV\end{matrix} & ( 35 )\end{matrix}$$

The energy of two hydrogen atoms is

E(2H[a_{H}])=−27.21 eV (36)

The bond dissociation energy, E_{D}, is the difference between the total energy of the corresponding hydrogen atoms (Eq. (36)) and E_{T} (Eq. (35)).

E_{D}=E(2H[a_{H}])−E_{T}=4.478 eV (37)

The experimental energy is E_{D}=4.478 eV. The calculated and experimental parameters of H₂, D₂, H₂⁺, and D₂⁺ from Ref. [6] and Chp. 11 of Ref. [1] are given in Table 3.

TABLE 3
The Maxwellian closed-form calculated and experimental
parameters of H₂, D₂, H₂⁺ and D₂⁺.

| Parameter | Calculated | Experimental |
|---|---|---|
| H₂ Bond Energy | 4.478 eV | 4.478 eV |
| D₂ Bond Energy | 4.556 eV | 4.556 eV |
| H₂⁺ Bond Energy | 2.654 eV | 2.651 eV |
| D₂⁺ Bond Energy | 2.696 eV | 2.691 eV |
| H₂ Total Energy | 31.677 eV | 31.675 eV |
| D₂ Total Energy | 31.760 eV | 31.760 eV |
| H₂ Ionization Energy | 15.425 eV | 15.426 eV |
| D₂ Ionization Energy | 15.463 eV | 15.466 eV |
| H₂⁺ Ionization Energy | 16.253 eV | 16.250 eV |
| D₂⁺ Ionization Energy | 16.299 eV | 16.294 eV |
| H₂⁺ Magnetic Moment | 9.274 × 10⁻²⁴ JT⁻¹ (μ_{B}) | 9.274 × 10⁻²⁴ |
| | | JT⁻¹ (μ_{B}) |
| Absolute H₂ Gas-Phase | −28.0 ppm | −28.0 ppm |
| NMR Shift | | |
| H₂ Internuclear Distance^{a} | 0.748 Å | 0.741 Å |
| | \sqrt{2}aₒ | |
| D₂ Internuclear Distance^{a} | 0.748 Å | 0.741 Å |
| | \sqrt{2}aₒ | |
| H₂⁺ Internuclear Distance | 1.058 Å | 1.06 Å |
| | 2aₒ | |
| D₂⁺ Internuclear Distance^{a} | 1.058 Å | 1.0559 Å |
| | 2aₒ | |
| H₂ Vibrational Energy | 0.517 eV | 0.516 eV |
| D₂ Vibrational Energy | 0.371 eV | 0.371 eV |
| H₂ ωₑχₑ | 120.4 cm⁻¹ | 121.33 cm⁻¹ |
| D₂ ωₑχₑ | 60.93 cm⁻¹ | 61.82 cm⁻¹ |
| H₂⁺ Vibrational Energy | 0.270 eV | 0.271 eV |
| D₂⁺ Vibrational Energy | 0.193 eV | 0.196 eV |
| H₂ J = 1 to J = 0 Rotational | 0.0148 eV | 0.01509 eV |
| Energy^{a} | | |
| D₂ J = 1 to J = 0 Rotational | 0.00741 eV | 0.00755 eV |
| Energy^{a} | | |
| H₂⁺ J = 1 to J = 0 Rotational | 0.00740 eV | 0.00739 eV |
| Energy | | |
| D₂⁺ J = 1 to J = 0 Rotational | 0.00370 eV | 0.003723 eV |
| Energy^{a} | | |

^{a}Not corrected for the slight reduction in internuclear distance due to Ē_{osc}.

### B. Derivation of the General Geometrical and Energy Equations of Organic Chemistry

Organic molecules comprising an arbitrary number of atoms can be solved using similar principles and procedures as those used to solve alkanes of arbitrary length. Alkanes can be considered to be comprised of the functional groups of CH₃, CH₂, and C—C. These groups with the corresponding geometrical parameters and energies can be added as a linear sum to give the solution of any straight chain alkane as shown in the Continuous-Chain Alkanes section of Ref. [1]. Similarly, the geometrical parameters and energies of all functional groups such as those given in Table 1 can be solved. The functional-group solutions can be made into a linear superposition and sum, respectively, to give the solution of any organic molecule. The solutions of the functional groups can be conveniently obtained by using generalized forms of the geometrical and energy equations. The derivation of the dimensional parameters and energies of the function groups are given in the Nature of the Chemical Bond of Hydrogen-Type Molecules, Polyatomic Molecular Ions and Molecules, More Polyatomic Molecules and Hydrocarbons, and Organic Molecular Functional Groups and Molecules sections of Ref. [1]. (Reference to equations of the form Eq. (15.number), Eq. (11.number), Eq. (13.number), and Eq. (14.number) will refer to the corresponding equations of Ref [1].) Additional derivations for other non-organic function groups given in Table 2 are derived in the following sections of Ref. [1]: Applications: Pharmaceuticals, Specialty Molecular Functional Groups and Molecules, Dipoles and Interactions, Nature of the Solid Molecular Bond of the Three Allotropes of Carbon, Silicon Molecular Functional Groups and Molecules, Nature of the Solid Semiconductor Bond of Silicon, Boron Molecues, and Organometallic Molecular Functional Groups and Molecules sections.

Consider the case wherein at least two atomic orbital hybridize as a linear combination of electrons at the same energy in order to achieve a bond at an energy minimum, and the sharing of electrons between two or more such orbitals to form a MO permits the participating hybridized orbitals to decrease in energy through a decrease in the radius of one or more of the participating orbitals. The force-generalized constant k′ of a H₂-type ellipsoidal MO due to the equivalent of two point charges of at the foci is given by:

$${k}^{′} = \frac{{C}_{1} {C}_{2} 2 {e}^{2}}{4 {πɛ}_{0}} \qquad ( 38 )$$

where C₁ is the fraction of the H₂-type ellipsoidal MO basis function of a chemical bond of the molecule or molecular ion which is 0.75 (Eq. (13.59)) in the case of H bonding to a central atom and 0.5 (Eq. (14.152)) otherwise, and C₂ is the factor that results in an equipotential energy match of the participating at least two molecular or atomic orbitals of the chemical bond. From Eqs. (13.58-13.63), the distance from the origin of the MO to each focus c′ is given by:

$${c}^{′} = a \sqrt{\frac{{ℏ}^{2} 4 {πɛ}_{0}}{{m}_{e} {e}^{2} 2 {C}_{1} {C}_{2} a}} = \sqrt{\frac{{aa}_{0}}{2 {C}_{1} {C}_{2}}} \qquad ( 39 )$$

The internuclear distance is

$$2 {c}^{′} = 2 \sqrt{\frac{{aa}_{0}}{2 {C}_{1} {C}_{2}}} \qquad ( 40 )$$

The length of the semiminor axis of the prolate spheroidal MO b=c is given by

b=\sqrt{a²−c^{′2}} (41)

And, the eccentricity, e, is

$$e = \frac{{c}^{′}}{a} \qquad ( 42 )$$

From Eqs. (11.207-11.212), the potential energy of the two electrons in the central field of the nuclei at the foci is

$${V}_{e} = {n}_{1} {c}_{1} {c}_{2} \frac{- 2 {e}^{2}}{8 {πɛ}_{o} \sqrt{{a}^{2} - {b}^{2}}} ln \frac{a + \sqrt{{a}^{2} - {b}^{2}}}{a - \sqrt{{a}^{2} - {b}^{2}}} \qquad ( 43 )$$

The potential energy of the two nuclei is

$${V}_{p} = {n}_{1} \frac{{e}^{2}}{8 {πɛ}_{o} \sqrt{{a}^{2} - {b}^{2}}} \qquad ( 44 )$$

The kinetic energy of the electrons is

$$T = {n}_{1} {c}_{1} {c}_{2} \frac{{ℏ}^{2}}{2 {m}_{e} a \sqrt{{a}^{2} - {b}^{2}}} ln \frac{a + \sqrt{{a}^{2} - {b}^{2}}}{a - \sqrt{{a}^{2} - {b}^{2}}} \qquad ( 45 )$$

And, the energy, Vₘ, of the magnetic force between the electrons is

$${V}_{m} = {n}_{1} {c}_{1} {c}_{2} \frac{- {ℏ}^{2}}{4 {m}_{e} a \sqrt{{a}^{2} - {b}^{2}}} ln \frac{a + \sqrt{{a}^{2} - {b}^{2}}}{a - \sqrt{{a}^{2} - {b}^{2}}} \qquad ( 46 )$$

The total energy of the H₂-type prolate spheroidal MO, E_{T}(H₂MO), is given by the sum of the energy terms:

$$\begin{matrix}{E}_{{T}^{( {H}_{2} MO )}} = {V}_{e} + T + {V}_{m} + {V}_{p} & ( 47 ) \\ \begin{matrix}{E}_{{T}^{( {H}_{2} MO )}} = - \frac{{n}_{1} {e}^{2}}{8 π {ɛ}_{o} \sqrt{{a}^{2} - {b}^{2}}} [ \begin{matrix}{c}_{1} {c}_{2} ( 2 - \frac{{a}_{0}}{a} ) \\ ln \frac{a + \sqrt{{a}^{2} - {b}^{2}}}{a - \sqrt{{a}^{2} - {b}^{2}}} - 1\end{matrix} ] \\ = - \frac{{n}_{1} {e}^{2}}{8 {πɛ}_{0} {c}^{′}} [ {c}_{1} {c}_{2} ( 2 - \frac{{a}_{0}}{a} ) ln \frac{a + {c}^{′}}{a - {c}^{′}} - 1 ]\end{matrix} & ( 48 )\end{matrix}$$

where n₁ is the number of equivalent bonds of the MO. c₁ is the fraction of the H₂-type ellipsoidal MO basis function of an MO which is 0.75 (Eqs. (13.67-13.73)) in the case of H bonding to an unhybridized central atom and 1 otherwise, and c₂ is the factor that results in an equipotential energy match of the participating the MO and the at least two atomic orbitals of the chemical bond. Specifically, to meet the equipotential condition and energy matching conditions for the union of the H₂-type-ellipsoidal-MO and the HOs or AOs of the bonding atoms, the factor c₂ of a H₂-type ellipsoidal MO may given by (i) one, (ii) the ratio of the Coulombic or valence energy of the AO or HO of at least one atom of the bond and 13.605804 eV, the Coulombic energy between the electron and proton of H, (iii) the ratio of the valence energy of the AO or HO of one atom and the Coulombic energy of another, (iv) the ratio of the valence energies of the AOs or HOs of two atoms, (v) the ratio of two c₂ factors corresponding to any of cases (ii)-(iv), and (vi) the product of two different c₂ factors corresponding to any of the cases (i)-(v). Specific examples of the factor c₂ of a H₂-type ellipsoidal MO given in previously [19 are
0.936127, the ratio of the ionization energy of N 14.53414 eV and 13.605804 eV, the Coulombic energy between the electron and proton of H;
0.91771, the ratio of 14.82575 eV, −E_{Coulomb}(C,2sp³), and 13.605804 eV;
0.87495, the ratio of 15.55033 eV, −E_{Coulomb}(Cₑₜₕₐₙₑ,2sp³), and 13.605804 eV;
0.85252, the ratio of 15.95955 eV, −E_{Coulomb}(C_{ethylene},2sp³), and 13.605804 eV;
0.85252, the ratio of 15.95955 eV, −E_{Coulomb}(C_{benzene},2sp³), and 13.605804 eV, and
0.86359, the ratio of 15.55033 eV, −E_{Coulomb}(Cₐₗₖₐₙₑ,2sp³), and 11605804 eV.

In the generalization of the hybridization of at least two atomic-orbital shells to form a shell of hybrid orbitals, the hybridized shell comprises a linear combination of the electrons of the atomic-orbital shells. The radius of the hybridized shell is calculated from the total Coulombic energy equation by considering that the central field decreases by an integer for each successive electron of the shell and that the total energy of the shell is equal to the total Coulombic energy of the initial AO electrons. The total energy E_{T}(atom,msp³) (m is the integer of the valence shell) of the AO electrons and the hybridized shell is given by the sum of energies of successive ions of the atom over the n electrons comprising total electrons of the at least one AO shell.

$${E}_{T} ( atom , {msp}^{3} ) = - {\sum }_{m = 1}^{n} {IP}_{m} \qquad ( 49 )$$

where IPₘ is the m th ionization energy (positive) of the atom. The radius rₘₛₚ_{³} of the hybridized shell is given by:

$${r}_{{msp}^{3}} = {\sum }_{q = Z - n }^{Z - 1} \frac{- ( Z - q ) {e}^{2}}{8 {πɛ}_{0} {E}_{T} ( atom , {msp}^{3} )} \qquad ( 50 )$$

Then, the Coulombic energy E_{Coulomb} (atom, msp³) of the outer electron of the atom msp³ shell is given by

$${E}_{Coulomb} ( atom , {msp}^{3} ) = \frac{- {e}^{2 }}{8 π {ɛ}_{0} {r}_{{msp}^{3}}} \qquad ( 51 )$$

In the case that during hybridization at least one of the spin-paired AO electrons is unpaired in the hybridized orbital (HO), the energy change for the promotion to the unpaired state is the magnetic energy E(magnetic) at the initial radius r of the AO electron:

$$E ( magnetic ) = \frac{2 {πμ}_{0} {e}^{2} {ℏ}^{2}}{{m}_{e}^{2} {r}^{3}} = \frac{8 {πμ}_{o} {μ}_{B}^{2}}{{r}^{3}} \qquad ( 52 )$$

Then, the energy E(atom,msp³) of the outer electron of the atom msp³ shell is given by the sum of E_{Coulomb}(atom, msp³) and E(magnetic):

$$E ( atom , {msp}^{3} ) = \frac{- {e}^{2}}{8 {πɛ}_{0} {r}_{{msp}^{3}}} + \frac{2 {πμ}_{0} {e}^{2} {ℏ}^{2}}{{m}_{e}^{2} {r}^{3}} \qquad ( 53 )$$

Consider next that the at least two atomic orbitals hybridize as a linear combination of electrons at the same energy in order to achieve a bond at an energy minimum with another atomic orbital or hybridized orbital. As a further generalization of the basis of the stability of the MO, the sharing of electrons between two or more such hybridized orbitals to form a MO permits the participating hybridized orbitals to decrease in energy through a decrease in the radius of one or more of the participating orbitals. In this case, the total energy of the hybridized orbitals is given by the sum of E(atom,msp³) and the next energies of successive ions of the atom over the n electrons comprising the total electrons of the at least two initial AO shells. Here, E(atom,msp³) is the sum of the first ionization energy of the atom and the hybridization energy. An example of E(atom,msp³) for E(C,2sp³) is given in Eq. (14.503) where the sum of the negative of the first ionization energy of C, −11.27671 eV, plus the hybridization energy to form the C2sp³ shell given by Eq. (14.146) is

E(C,2sp³)=−14.63489 eV.

Thus, the sharing of electrons between two atom msp³ HOs to form an atom-atom-bond MO permits each participating hybridized orbital to decrease in radius and energy. In order to further satisfy the potential, kinetic, and orbital energy relationships, each atom msp³ HO donates an excess of 25% per bond of its electron density to the atom-atom-bond MO to form an energy minimum wherein the atom-atom bond comprises one of a single, double, or triple bond. In each case, the radius of the hybridized shell is calculated from the Coulombic energy equation by considering that the central field decreases by an integer for each successive electron of the shell and the total energy of the shell is equal to the total Coulombic energy of the initial AO electrons plus the hybridization energy. The total energy E_{T}(mol.atom,msp³) (m is the integer of the valence shell) of the HO electrons is given by the sum of energies of successive ions of the atom over the n electrons comprising total electrons of the at least one initial AO shell and the hybridization energy:

$${E}_{T} ( mol . atom , {msp}^{3} ) = E ( atom , {msp}^{3} ) - {\sum }_{m = 2}^{n} {IP}_{m} \qquad ( 54 )$$

where IPₘ is the m th ionization energy (positive) of the atom and the sum of −IP₁ plus the hybridization energy is E(atom,msp³). Thus, the radius rₘₛₚ_{³} of the hybridized shell due to its donation of a total charge −Qe to the corresponding MO is given by is given by:

$$\begin{matrix}{r}_{{msp}^{3}} = ( {\sum }_{q = Z - n}^{Z - 1} ( Z - q ) - Q ) \frac{- {e}^{2}}{8 {πɛ}_{0} {E}_{T} ( mol . atom , {msp}^{3} )} \\ = ( {\sum }_{q = Z - n}^{Z - 1} ( Z - q ) - s ( 0.25 ) ) \frac{- {e}^{2}}{8 {πɛ}_{0} {E}_{T} ( mol . atom , {msp}^{3} )}\end{matrix} \qquad ( 55 )$$

where −e is the fundamental electron charge and s=1,2,3 for a single, double, and triple bond, respectively. The Coulombic energy E_{Coulomb}(mol.atom,msp³) of the outer electron of the atom msp³ shell is given by

$${E}_{Coulomb} ( mol . atom , {msp}^{3} ) = \frac{- {e}^{2}}{8 {πɛ}_{0} {r}_{{msp}^{3}}} \qquad ( 56 )$$

In the case that during hybridization at least one of the spin-paired AO electrons is unpaired in the hybridized orbital (HO), the energy change for the promotion to the unpaired state is the magnetic energy E(magnetic) at the initial radius r of the AO electron given by Eq. (52). Then, the energy E (mol.atom,msp³) of the outer electron of the atom msp³ shell is given by the sum of E_{Coulomb} (mol.atom,msp³) and E(magnetic):

$$E ( mol . atom , {msp}^{3} ) = \frac{- {e}^{2}}{8 {πɛ}_{0} {r}_{{msp}^{3}}} + \frac{2 {πμ}_{0} {e}^{2} {ℏ}^{2}}{{m}_{e}^{2} {r}^{3}} \qquad ( 57 )$$

E_{T} (atom-atom, msp³), the energy change of each atom msp³ shell with the formation of the atom-atom-bond MO is given by the difference between E(mol.atom,msp³) and E (atom,msp³):

E_{T}(atom-atom, msp³)=E(mol.atom,msp³)−E(atom,msp³) (58)

In the case of the C2sp³ HO, the initial parameters (Eqs. (14.142-14.146)) are

$$\begin{matrix}\begin{matrix}{r}_{2 {sp}^{3}} = {\sum }_{n = 2}^{5} \frac{( Z - n ) {e}^{2}}{8 {πɛ}_{0} ( e 148.25751 eV )} \\ = \frac{10 {e}^{2}}{8 {πɛ}_{0} ( e 148.25751 eV )} \\ = 0.91771 {a}_{0}\end{matrix} & ( 59 ) \\ \begin{matrix}{E}_{Coulomb} ( C , 2 {sp}^{3} ) = \frac{- {e}^{2}}{8 {πɛ}_{0} {r}_{2 {sp}^{3}}} \\ = \frac{- {e}^{2}}{8 {πɛ}_{0} 0.91771 {a}_{0}} \\ = - 14.82575 eV\end{matrix} & ( 60 ) \\ \begin{matrix}E ( magnetic ) = \frac{2 {πμ}_{0} {e}^{2} {ℏ}^{2}}{{{m}_{e}^{2} ( {r}_{3} )}^{3}} \\ = \frac{8 {πμ}_{o} {μ}_{B}^{2}}{{( 0.84317 {a}_{0} )}^{3}} \\ = 0.19086 eV\end{matrix} & ( 61 ) \\ \begin{matrix}E ( C , 2 {sp}^{3} ) = \frac{- {e}^{2}}{8 {πɛ}_{0} {r}_{2 {sp}^{3}}} + \frac{2 {πμ}_{0} {e}^{2} {ℏ}^{2}}{{{m}_{e}^{2} ( {r}_{3} )}^{3}} \\ = - 14.82575 eV + 0.19086 eV \\ = - 14.63489 eV\end{matrix} & ( 62 ) \\ In Eq . ( 55 ) , & \\ {\sum }_{q = Z - n}^{Z - 1} ( Z - q ) = 10 & ( 63 ) \\ Eqs . ( 14.147 ) and ( 54 ) give & \\ {E}_{T} ( mol . atom , {msp}^{3} ) = {E}_{T} ( {C}_{ethane} , 2 {sp}^{3} ) = - 151.61569 eV & ( 64 )\end{matrix}$$

Using Eqs. (55-65), the final values of r_{C2sp}_{³}, E_{Coulomb}(C2sp³), and E(C2sp³), and the resulting E_{T}(C^{BO}—C,C2sp³) of the MO due to charge donation from the HO to the MO where C^{BO}—C refers to the bond order of the carbon-carbon bond for different values of the parameter s are given in Table 4.

TABLE 4
The final values of r_{C2sp}³, E_{Coulomb}(C2sp³), and E(C2sp³) and the resulting
E_{T}(C^{BO}—C,C2sp³) of the MO due to charge donation from the HO to the
MO where C^{BO}—C refers to the bond order of the carbon-carbon bond.

| MO | | | | | | |
|---|---|---|---|---|---|---|
| Bond | | | | E_{Coulomb}(C2sp³) | E(C2sp³) | |
| Order | | | r_{C2sp}³(a₀) | (eV) | (eV) | E_{T}(C^{BO}—C,C2sp³) |
| (BO) | s₁ | s₂ | Final | Final | Final | (eV) |
| I | 1 | 0 | 0.87495 | −15.55033 | −15.35946 | −0.72457 |
| II | 2 | 0 | 0.85252 | −15.95955 | −15.76868 | −1.13379 |
| III | 3 | 0 | 0.83008 | −16.39089 | −16.20002 | −1.56513 |
| IV | 4 | 0 | 0.80765 | −16.84619 | −16.65532 | −2.02043 |

In another generalized case of the basis of forming a minimum-energy bond with the constraint that it must meet the energy matching condition for all MOs at all HOs or AOs, the energy E(mol.atom,msp³) of the outer electron of the atom msp³ shell of each bonding atom must be the average of E(mol.atom,msp³) for two different values of s:

$$E ( mol . atom , {msp}^{3} ) = \frac{\begin{matrix}E ( mol . atom ( {s}_{1} ) , {msp}^{3} ) + \\ E ( mol . atom ( {s}_{2} ) , {msp}^{3} )\end{matrix}}{2} \qquad ( 65 )$$

In this case, E_{T}(atom-atom,msp³), the energy change of each atom msp³ shell with the formation of each atom-atom-bond MO, is average for two different values of s:

$${E}_{T} ( atom - atom , {msp}^{3} ) = \frac{\begin{matrix}{E}_{T} ( atom - atom ( {s}_{1} ) , {msp}^{3} ) + \\ {E}_{T} ( atom - atom ( {s}_{2} ) , {msp}^{3} )\end{matrix}}{2} \qquad ( 66 )$$

Consider an aromatic molecule such as benzene given in the Benzene Molecule section of Ref. [1]. Each C═C double bond comprises a linear combination of a factor of 0.75 of four paired electrons (three electrons) from two sets of two C2sp³ HOs of the participating carbon atoms. Each C—H bond of CH having two spin-paired electrons, one from an initially unpaired electron of the carbon atom and the other from the hydrogen atom, comprises the linear combination of 75% H₂-type ellipsoidal MO and 25% C2sp³ HO as given by Eq. (13.439). However, E_{T}(atom-atom, msp³) of the C—H-bond MO is given by 0.5E_{T}(C═C,2sp³) (Eq. (14.247)) corresponding to one half of a double bond that matches the condition for a single-bond order for C—H that is lowered in energy due to the aromatic character of the bond.

A further general possibility is that a minimum-energy bond is achieved with satisfaction of the potential, kinetic, and orbital energy relationships by the formation of an MO comprising an allowed multiple of a linear combination of H₂-type ellipsoidal MOs and corresponding HOs or AOs that contribute a corresponding allowed multiple (e.g. 0.5, 0.75, 1) of the bond order given in Table 4. For example, the alkane MO given in the Continuous-Chain Alkanes section of Ref. [1] comprises a linear combination of factors of 0.5 of a single bond and 0.5 of a double bond.

Consider a first MO and its HOs comprising a linear combination of bond orders and a second MO that shares a HO with the first. In addition to the mutual HO, the second MO comprises another AO or HO having a single bond order or a mixed bond order. Then, in order for the two MOs to be energy matched, the bond order of the second MO and its HOs or its HO and AO is a linear combination of the terms corresponding to the bond order of the mutual HO and the bond order of the independent HO or AO. Then, in general, E_{T}(atom-atom,msp³), the energy change of each atom msp³ shell with the formation of each atom-atom-bond MO, is a weighted linear sum for different values of s that matches the energy of the bonded MOs, HOs, and AOs:

$${E}_{T} ( atom - atom , {msp}^{3} ) = {\sum }_{n = 1}^{N} {c}_{{s}_{n}} {E}_{T} ( atom - atom ( {s}_{n} ) , {msp}^{3} ) \qquad ( 67 )$$

where cₛ_{ₙ} is the multiple of the BO of sₙ. The radius rₘₛₚ_{³} of the atom msp³ shell of each bonding atom is given by the Coulombic energy using the initial energy E_{Coulomb} (atom,msp³) and E_{T}(atom-atom,msp³), the energy change of each atom msp³ shell with the formation of each atom-atom-bond MO:

$${r}_{{msp}^{3}} = \frac{- {e}^{2}}{8 {πɛ}_{0} {a}_{0} ( \begin{matrix}( {E}_{Coulonb} atom , {msp}^{3} ) + \\ {E}_{T} ( atom - atom , {msp}^{3} )\end{matrix} )} \qquad ( 68 )$$

where E_{Coulomb}(C2sp³)=−14.825751 eV. The Coulombic energy E_{Coulomb}(mol.atom,msp³) of the outer electron of the atom msp³ shell is given by Eq. (56). In the case that during hybridization, at least one of the spin-paired AO electrons is unpaired in the hybridized orbital (HO), the energy change for the promotion to the unpaired state is the magnetic energy E(magnetic) (Eq. (52)) at the initial radius r of the AO electron. Then, the energy E(mol.atom,msp³) of the outer electron of the atom msp³ shell is given by the sum of E_{Coulomb}(mol.atom,msp³) and E(magnetic) (Eq. (57)). E_{T}(atom-atom,msp³), the energy change of each atom msp³ shell with the formation of the atom-atom-bond MO is given by the difference between E(mol.atom,msp³) and E(atom,msp³) given by Eq. (58). Using Eq. (60) for E_{Coulomb}(C,2sp³) in Eq. (68), the single bond order energies given by Eqs. (55-64) and shown in Table 4, and the linear combination energies (Eqs. (65-67)), the parameters of linear combinations of bond orders and linear combinations of mixed bond orders are given in Table 5.

Table 5. The final values of r_{C2sp}_{³}, E_{Coulomb}(C2sp³), and E(C2sp³) and the resulting E_{T}(C^{BO}—C, C2sp³) of the MO comprising a linear combination of H₂-type ellipsoidal MOs and corresponding HOs of single or mixed bond order where cₛ_{ₙ} is the multiple of the bond order parameter E_{T}(atom-atom(sₙ),msp³) given in Table 4.

TABLE 5
The final value of r_{C2sp}_{³}, E_{Coulomb}(C2sp³), and E(C2sp³) and the
resulting E_{T}(C^{BO}—C,C2sp³) of the MO comprising a linear combination of
H₂-type ellipsoidal MOs and corresponding HOs of single or mixed bond under where cₛ_{ₙ} is the
multiple bond order parameter E_{T}(atom - atom(sₙ), msp³) given in Table 4.

| MO | | | | | | | | E_{Coulomb}(C2sp³) | E(C2sp³) | |
|---|---|---|---|---|---|---|---|---|---|---|
| Bond Order | | | | | | | r_{C2sp}_{³}(a₀) | (eV) | (eV) | E_{T}(C^{BO}—C,C2sp³) |
| (BO) | s₁ | cₛ_{₁} | s₂ | cₛ_{₂} | s₃ | cₛ_{₃} | Final | Final | Final | (eV) |
| 1/2I | 1 | 0.5 | 0 | 0 | 0 | 0 | 0.89582 | −15.18804 | −14.99717 | −0.36228 |
| 1/2II | 2 | 0.5 | 0 | 0 | 0 | 0 | 0.88392 | −15.39265 | −15.20178 | −0.56689 |
| 1/2I + 1/4II | 1 | 0.5 | 2 | 0.25 | 0 | 0 | 0.87941 | −15.47149 | −15.28062 | −0.64573 |
| 1/4II + 1/4(I + | 2 | 0.25 | 1 | 0.25 | 2 | 0.25 | 0.87363 | −15.57379 | −15.38293 | −0.74804 |
| II) | | | | | | | | | | |
| 3/4II | 2 | 0.75 | 0 | 0 | 0 | 0 | 0.86793 | −15.67610 | −15.48523 | −0.85034 |
| 1/2I + 1/2II | 1 | 0.5 | 2 | 0.5 | 0 | 0 | 0.86359 | −15.75493 | −15.56407 | −0.92918 |
| 1/2I + 1/2III | 1 | 0.5 | 3 | 0.5 | 0 | 0 | 0.85193 | −15.97060 | −15.77974 | −1.14485 |
| 1/2I + 1/2IV | 1 | 0.5 | 4 | 0.5 | 0 | 0 | 0.83995 | −16.19826 | −16.00739 | −1.37250 |
| 1/2II + 1/2III | 2 | 0.5 | 3 | 0.5 | 0 | 0 | 0.84115 | −16.17521 | −15.98435 | −1.34946 |
| 1/2II + 1/2IV | 2 | 0.5 | 4 | 0.5 | 0 | 0 | 0.82948 | −16.40286 | −16.21200 | −1.57711 |
| I + 1/2(I + II) | 1 | 1 | 1 | 0.5 | 2 | 0.5 | 0.82562 | −16.47951 | −16.28865 | −1.65376 |
| 1/2III + 1/2IV | 3 | 0.5 | 4 | 0.5 | 0 | 0 | 0.81871 | −16.61853 | −16.42767 | −1.79278 |
| 1/2IV + 1/2IV | 4 | 0.5 | 4 | 0.5 | 0 | 0 | 0.80765 | −16.84619 | −16.65532 | −2.02043 |
| 1/2(I + II) + II | 1 | 0.5 | 2 | 0.5 | 2 | 1 | 0.80561 | −16.88873 | −16.69786 | −2.06297 |

Consider next the radius of the AO or HO due to the contribution of charge to more than one bond. The energy contribution due to the charge donation at each atom such as carbon superimposes linearly. In general, the radius rₘₒₗ₂ₛₚ_{³} of the C2sp³ HO of a carbon atom of a given molecule is calculated using Eq. (14.514) by considering ΣE_{T}_{ₘₒₗ}(MO,2sp³), the total energy donation to all bonds with which it participates in bonding. The general equation for the radius is given by

$$\begin{matrix}{r}_{mo l 2 {sp}^{3}} = \frac{- {e}^{2}}{8 {πɛ}_{0} ( {E}_{Coulomb} ( C , 2 {sp}^{3} ) + \sum {E}_{{T}_{mo l}} ( MO , 2 {sp}^{3} ) )} \\ = \frac{{e}^{2}}{8 {πɛ}_{0} ( e 14.825751 eV + \sum \vert {E}_{{T}_{mo l}} ( MO , 2 {sp}^{3} ) \vert )}\end{matrix} \qquad ( 69 )$$

The Coulombic energy E_{Coulomb}(mol.atom,msp³) of the outer electron of the atom msp³ shell is given by Eq. (56). In the case that during hybridization, at least one of the spin-paired AO electrons is unpaired in the hybridized orbital (HO), the energy change for the promotion to the unpaired state is the magnetic energy E(magnetic) (Eq. (52)) at the initial radius r of the AO electron. Then, the energy E(mol.atom,msp³) of the outer electron of the atom msp³ shell is given by the sum of E_{Coulomb}(mol.atom,msp³) and E(magnetic) (Eq. (57)).

For example, the C2sp³ HO of each methyl group of an alkane contributes −0.92918 eV (Eq. (14.513)) to the corresponding single C—C bond; thus, the corresponding C2sp³ HO radius is given by Eq. (14.514). The C2sp³ HO of each methylene group of CₙH₂ₙ₊₂ contributes −0.92918 eV to each of the two corresponding C—C bond MOs. Thus, the radius (Eq. (69)), the Coulombic energy (Eq. (56)), and the energy (Eq. (57)) of each alkane methylene group are

$$\begin{matrix}\begin{matrix}{r}_{{alkaneC}_{methylene} 2 {sp}^{3}} = \frac{- {e}^{2}}{8 {πɛ}_{0} ( \begin{matrix}{E}_{Coulomb} ( C , 2 {sp}^{3} ) + \\ \sum {E}_{{T}_{alkane}} ( \begin{matrix}methylene C - C , \\ 2 {sp}^{3}\end{matrix} )\end{matrix} )} \\ = \frac{{e}^{2}}{8 {πɛ}_{0} ( \begin{matrix}\begin{matrix}e 14.825751 eV + \\ e 0.92918 eV +\end{matrix} \\ e 0.92918 eV\end{matrix} )} \\ = 0.81549 {a}_{0}\end{matrix} & ( 70 ) \\ \begin{matrix}{E}_{Coulomb} ( {C}_{methylene} 2 {sp}^{3} ) = \frac{- {e}^{2}}{8 {πɛ}_{0} ( 0.81549 {a}_{0} )} \\ = - 16.68412 eV\end{matrix} & ( 71 ) \\ \begin{matrix}E ( {C}_{methylene} 2 {sp}^{3} ) = \frac{- {e}^{2}}{8 {πɛ}_{0} ( 0.81549 {a}_{0} )} + \frac{2 {πμ}_{0} {e}^{2} {ℏ}^{2}}{{{m}_{e}^{2} ( 0.84317 {a}_{0} )}^{3}} \\ = - 16.49325 eV\end{matrix} & ( 72 )\end{matrix}$$

In the determination of the parameters of functional groups, heteroatoms bonding to C2sp³ HOs to form MOs are energy matched to the C2sp³ HOs. Thus, the radius and the energy parameters of a bonding heteroatom are given by the same equations as those for C2sp³ HOs. Using Eqs. (52), (56-57), (61), and (69) in a generalized fashion, the final values of the radius of the HO or AO, r_{Atom,HO,AO}, E_{Coulomb}(mol.atom,msp3), and E(Cₘₒₗ2sp³) are calculated using ΣE_{T}_{_{group}}(MO,2sp³), the total energy donation to each bond with which an atom participates in bonding corresponding to the values of E_{T}(C^{BO}—C,C2sp³) of the MO due to charge donation from the AO or HO to the MO given in Tables 4 and 5.

The energy of the MO is matched to each of the participating outermost atomic or hybridized orbitals of the bonding atoms wherein the energy match includes the energy contribution due to the AO or HO's donation of charge to the MO. The force constant k′ (Eq. (38)) is used to determine the ellipsoidal parameter c′ (Eq. (39)) of the each H₂-type-ellipsoidal-MO in terms of the central force of the foci. Then, c′ is substituted into the energy equation (from Eq. (48))) which is set equal to n₁ times the total energy of H₂ where n₁ is the number of equivalent bonds of the MO and the energy of H₂, −31.63536831 eV, Eq. (11.212) is the minimum energy possible for a prolate spheroidal MO. From the energy equation and the relationship between the axes, the dimensions of the MO are solved. The energy equation has the semimajor axis a as it only parameter. The solution of the semimajor axis a then allows for the solution of the other axes of each prolate spheroid and eccentricity of each MO (Eqs. (40-42)). The parameter solutions then allow for the component and total energies of the MO to be determined.

The total energy, E_{T}(H₂MO), is given by the sum of the energy terms (Eqs. (43-48)) plus E_{T}(AO/HO):

$$\begin{matrix}{E}_{{T}^{( {H}_{2} MO )}} = {V}_{e} + T + {V}_{m} + {V}_{p} + {E}_{T} ( AO / HO ) & ( 73 ) \\ \begin{matrix}{E}_{{T}^{( {H}_{2} MO )}} = - \frac{{n}_{1} {e}^{2}}{8 {πɛ}_{o} \sqrt{{a}^{2} - {b}^{2}}} [ \begin{matrix}{c}_{1} {c}_{2} ( 2 - \frac{{a}_{0}}{a} ) \\ ln \frac{ a + \sqrt{{a}^{2} - {b}^{2}}}{a - \sqrt{{a}^{2} - {b}^{2}}} - 1\end{matrix} ] + \\ {E}_{T} ( AO / HO ) \\ = - \frac{{n}_{1} {e}^{2}}{8 {πɛ}_{0} {c}^{′}} [ {c}_{1} {c}_{2} ( 2 - \frac{{a}_{0}}{a} ) ln \frac{a + {c}^{′}}{a - {c}^{′}} - 1 ] + \\ {E}_{T} ( AO / HO )\end{matrix} & ( 74 )\end{matrix}$$

where n₁ is the number of equivalent bonds of the MO, c₁ is the fraction of the H₂-type ellipsoidal MO basis function of a chemical bond of the group, c₂ is the factor that results in an equipotential energy match of the participating at least two atomic orbitals of each chemical bond, and E_{T}(AO/HO) is the total energy comprising the difference of the energy E(AO/HO) of at least one atomic or hybrid orbital to which the MO is energy matched and any energy component ΔE_{H}_{₂}_{MO}(AO/HO) due to the AO or HO's charge donation to the MO.

E_{T}(AO/HO)=E(AO/HO)−ΔE_{H}_{₂}_{MO}(AO/HO) (75)

To solve the bond parameters and energies,

$${c}^{′} = a \sqrt{\frac{{ℏ}^{2} 4 {πɛ}_{0}}{{m}_{e} {e}^{2} 2 {C}_{1} {C}_{2} a}} = \sqrt{\frac{{aa}_{0}}{2 {C}_{1} {C}_{2}}} \qquad ( Eq . ( 39 ) )$$

is substituted into E_{T} (H₂MO) to give

$$\begin{matrix}{E}_{{T}^{( {H}_{2} MO )}} = - \frac{{n}_{1} {e}^{2}}{8 {πɛ}_{o} \sqrt{{a}^{2} - {b}^{2}}} [ \begin{matrix}{c}_{1} {c}_{2} ( 2 - \frac{{a}_{0}}{a} ) \\ ln \frac{a + \sqrt{{a}^{2} - {b}^{2}}}{a - \sqrt{{a}^{2} - {b}^{2}}} - 1\end{matrix} ] + \\ {E}_{T} ( AO / HO ) \\ = - \frac{{n}_{1} {e}^{2}}{8 {πɛ}_{0} {c}^{′}} [ \begin{matrix}{c}_{1} {c}_{2} ( 2 - \frac{{a}_{0}}{a} ) \\ ln \frac{a + {c}^{′}}{a - {c}^{′}} - 1\end{matrix} ] + {E}_{T} ( AO / HO ) \\ = - \frac{{n}_{1} {e}^{2}}{8 {πɛ}_{0} \sqrt{\frac{{aa}_{0}}{2 {C}_{1} {C}_{2}}}} [ \begin{matrix}{c}_{1} {c}_{2} ( 2 - \frac{{a}_{0}}{a} ) \\ ln \frac{a + \sqrt{\frac{{aa}_{0}}{2 {C}_{1} {C}_{2}}}}{a - \sqrt{\frac{{aa}_{0}}{2 {C}_{1} {C}_{2}}}} - 1\end{matrix} ] + \\ {E}_{T} ( AO / HO )\end{matrix} \qquad ( 76 )$$

The total energy is set equal to E (basis energies) which in the most general case is given by the sum of a first integer n₁ times the total energy of H₂ minus a second integer n₂ times the total energy of H, minus a third integer n₃ times the valence energy of E(AO) (e.g. E(N)=−14.53414 eV) where the first integer can be 1, 2, 3 . . . , and each of the second and third integers can be 0,1,2,3.

E(basis energies)=n₁(−31.63536831 eV)−n₂ (−13.605804 eV)−n₃E(AO) (77)

In the case that the MO bonds two atoms other than hydrogen, E(basis energies) is n₁ times the total energy of H₂ where n₁ is the number of equivalent bonds of the MO and the energy of H₂, −31.63536831 eV, Eq. (11.212) is the minimum energy possible for a prolate spheroidal MO:

E(basis energies)=n₁(−31.63536831 eV) (78)

E_{T}(H₂MO), is set equal to E(basis energies), and the semimajor axis a is solved. Thus, the semimajor axis a is solved from the equation of the form:

$$- \frac{{n}_{1} {e}^{2}}{8 {πɛ}_{0} \sqrt{\frac{{aa}_{0}}{2 {C}_{1} {C}_{2}}}} [ {c}_{1} {c}_{2} ( 2 - \frac{{a}_{0}}{a} ) ln \frac{a + \sqrt{\frac{{aa}_{0}}{2 {C}_{ 1} {C}_{2}}}}{a - \sqrt{\frac{{aa}_{0}}{2 {C}_{1} {C}_{2}}}} - 1 ] + {E}_{T} ( AO / HO ) = E ( basis energies ) \qquad ( 79 )$$

The distance from the origin of the H₂-type-ellipsoidal-MO to each focus c′, the internuclear distance 2c′, and the length of the semiminor axis of the prolate spheroidal H₂-type MO b=c are solved from the semimajor axis a using Eqs. (39-41). Then, the component energies are given by Eqs. (43-46) and (76).

The total energy of the MO of the functional group, E_{T}(MO), is the sum of the total energy of the components comprising the energy contribution of the MO formed between the participating atoms and E_{T}(atom-atom,msp³.AO), the change in the energy of the AOs or HOs upon forming the bond. From Eqs. (76-77), E_{T}(MO) is

E_{T}(MO)=E(basis energies)+E_{T}(atom-atom,msp³.AO) (80)

During bond formation, the electrons undergo a reentrant oscillatory orbit with vibration of the nuclei, and the corresponding energy Ē_{osc} is the sum of the Doppler, Ē_{D}, and average vibrational kinetic energies, Ē_{Kvib}:

$${\overline{E}}_{osc} = {n}_{1} ( {\overline{E}}_{D} + {\overline{E}}_{Kvib} ) = {n}_{1} ( {E}_{hv} \sqrt{\frac{2 {\overline{E}}_{K}}{{m}_{e} {c}^{2}}} + \frac{1}{2} ℏ \sqrt{\frac{k}{μ}} ) \qquad ( 81 )$$

where n₁ is the number of equivalent bonds of the MO, k is the spring constant of the equivalent harmonic oscillator, and μ is the reduced mass. The angular frequency of the reentrant oscillation in the transition state corresponding to Ē_{D} is determined by the force between the central field and the electrons in the transition state. The force and its derivative are given by

$$\begin{matrix}f ( R ) = - \frac{{C}_{1 o} {C}_{2 o} {e}^{2}}{4 {πɛ}_{0} {R}^{3}} \\ and & ( 82 ) \\ {f}^{′} ( a ) = 2 \frac{{C}_{1 o} {C}_{2 o} {e}^{2}}{4 {πɛ}_{0} {R}^{3}} & ( 83 )\end{matrix}$$

such that the angular frequency of the oscillation in the transition state is given by

$$ω = \sqrt{\frac{[ \frac{- 3}{a} f ( a ) - {f}^{′} ( a ) ]}{{m}_{e}}} = \sqrt{\frac{k}{{m}_{e}}} = \sqrt{\frac{\frac{{C}_{1 o} {C}_{2 o} {e}^{2}}{4 {πɛ}_{0} {R}^{3}}}{{m}_{e}}} \qquad ( 84 )$$

where R is the semimajor axis a or the semiminor axis b depending on the eccentricity of the bond that is most representative of the oscillation in the transition state. C₁ₒ is the fraction of the H₂-type ellipsoidal MO basis function of the oscillatory transition state of a chemical bond of the group, and C₂ₒ is the factor that results in an equipotential energy match of the participating at least two atomic orbitals of the transition state of the chemical bond. Typically, C₁ₒ=C₁ and C₂ₒ=C₂. The kinetic energy, E_{K}, corresponding to Ē_{D} is given by Planck's equation for functional groups:

$${\overline{E}}_{K} = ℏω = ℏ \sqrt{\frac{\frac{{C}_{1 o} {C}_{2 o} {e}^{2}}{4 {πɛ}_{0} {R}^{3}}}{{m}_{e}}} \qquad ( 85 )$$

The Doppler energy of the electrons of the reentrant orbit is

$${\overline{E}}_{D} ≅ {E}_{hv} \sqrt{\frac{2 {\overline{E}}_{K}}{{m}_{e} {c}^{2} }} = {E}_{hv} \sqrt{\frac{2 ℏ \sqrt{\frac{\frac{{C}_{1 o} {C}_{2 o} {e}^{2}}{4 {πɛ}_{0} {R}^{3}}}{{m}_{e}}}}{{m}_{e} {c}^{2}}} \qquad ( 86 )$$

Ē_{osc} given by the sum of Ē_{D} and Ē_{Kvib} is

$${\overline{E}}_{{osc}^{( group )}} = {n}_{1} ( {\overline{E}}_{D} + {\overline{E}}_{Kvib} ) = {n}_{1} ( {E}_{hv} \sqrt{\frac{2 ℏ \sqrt{\frac{\frac{{C}_{1 o} {C}_{2 o} {e}^{2}}{4 {πɛ}_{0} {R}^{3}}}{{m}_{e}}}}{{m}_{e} {c}^{2}}} + {E}_{vib} ) \qquad ( 87 )$$

Eₕᵥ of a group having n, bonds is given by E_{T}(MO)/n₁ such that

$${\overline{E}}_{osc} = {n}_{1} ( {\overline{E}}_{D} + {\overline{E}}_{Kvib} ) = {n}_{1} ( {E}_{{T}^{( MO )}} / {n}_{1} \sqrt{\frac{2 {\overline{E}}_{K}}{M {c}^{2}}} + \frac{1}{2} ℏ \sqrt{\frac{k}{μ}} ) \qquad ( 88 )$$

E_{T+osc}(Group) is given by the sum of E_{T}(MO) (Eq. (79)) and Ē_{osc} (Eq. (88)):

$$\begin{matrix}{E}_{T + {osc}^{( Group )}} = {E}_{{T}^{( MO )}} + {\overline{E}}_{osc} \\ = ( \begin{matrix}( \begin{matrix}\begin{matrix}- \frac{{n}_{1} {e}^{2}}{8 {πɛ}_{0} \sqrt{\frac{{aa}_{0}}{2 {C}_{1} {C}_{2}}}} \\ [ {c}_{1} {c}_{2} ( 2 - \frac{{a}_{0}}{a} ) ln \frac{a + \sqrt{\frac{{aa}_{0}}{2 {C}_{1} {C}_{2}}}}{a - \sqrt{\frac{{aa}_{0}}{2 {C}_{1} {C}_{2}}}} - 1 ] +\end{matrix} \\ {E}_{T} ( AO \text{/} HO ) + {E}_{T} ( atom - atom , {msp}^{3} . AO )\end{matrix} ) \\ [ 1 + \sqrt{\frac{2 ℏ \sqrt{\frac{\frac{{C}_{1 o} {C}_{2 o} {e}^{2}}{4 {πɛ}_{o} {R}^{3}}}{{m}_{e}}}}{{m}_{e} {c}^{2}}} ] + {n}_{1} \frac{1}{2} ℏ \sqrt{\frac{k}{μ}}\end{matrix} ) \\ = ( E ( basis energies ) + {E}_{T} ( atom - atom , {msp}^{3} . AO ) ) \\ [ 1 + \sqrt{\frac{2 ℏ \sqrt{\frac{\frac{{C}_{1 o} {C}_{2 o} {e}^{2}}{4 {πɛ}_{o} {R}^{3}}}{{m}_{e}}}}{{m}_{e} {c}^{2}}} ] + {n}_{1} \frac{1}{2} ℏ \sqrt{\frac{k}{μ}}\end{matrix} \qquad ( 89 )$$

The total energy of the functional group E_{T}(group) is the sum of the total energy of the components comprising the energy contribution of the MO formed between the participating atoms, E(basis energies), the change in the energy of the AOs or HOs upon forming the bond (E_{T}(atom-atom,msp³.AO)), the energy of oscillation in the transition state, and the change in magnetic energy with bond formation, E_{mag}. From Eq. (89), the total energy of the group

$${E}_{{T}^{( Group )}} is \\ {E}_{{T}^{( Group )}} = ( \begin{matrix}( \begin{matrix}E ( basis energies ) + \\ {E}_{T} ( atom - atom , {msp}^{3} . AO )\end{matrix} ) \\ [ 1 + \sqrt{\frac{2 ℏ \sqrt{\frac{\frac{{C}_{1 o} {C}_{2 o} {e}^{2}}{4 {πɛ}_{o} {R}^{3}}}{{m}_{e}}}}{{m}_{e} {c}^{2}}} ] + \\ {n}_{1} {\overline{E}}_{Kvib} + {E}_{mag}\end{matrix} ) \qquad ( 90 )$$

The change in magnetic energy E_{mag} which arises due to the formation of unpaired electrons in the corresponding fragments relative to the bonded group is given by

$${E}_{mag} = {c}_{3} \frac{2 {πμ}_{0} {e}^{2} {ℏ}^{2}}{{m}_{e}^{2} {r}^{3}} = {c}_{3} \frac{8 {πμ}_{o} {μ}_{B}^{2}}{{r}^{3}} \qquad ( 91 )$$

where r³ is the radius of the atom that reacts to form the bond and c₃ is the number of electron pairs.

$${E}_{{T}^{( Group )}} = ( \begin{matrix}( \begin{matrix}E ( basis energies ) + \\ {E}_{T} ( atom - atom , {msp}^{3} . AO )\end{matrix} ) \\ [ 1 + \sqrt{\frac{2 ℏ \sqrt{\frac{\frac{{C}_{1 o} {C}_{2 o} {e}^{2}}{4 {πɛ}_{o} {R}^{3}}}{{m}_{e}}}}{{m}_{e} {c}^{2}}} ] + \\ {n}_{1} {\overline{E}}_{Kvib} + {c}_{3} \frac{8 {πμ}_{o} {μ}_{B}^{2}}{{r}^{3}}\end{matrix} ) \qquad ( 92 )$$

The total bond energy of the group E_{D}(Group) is the negative difference of the total energy of the group (Eq. (92)) and the total energy of the starting species given by the sum of c₄Eᵢₙᵢₜᵢₐₗ (c₄ AO/HO) and c₅Eᵢₙᵢₜᵢₐ(c₅ AO/HO):

$${E}_{{D}^{( Group )}} = - ( \begin{matrix}( \begin{matrix}E ( basis energies ) + \\ {E}_{T} ( atom - atom , {msp}^{3} . AO )\end{matrix} ) \\ [ 1 + \sqrt{\frac{2 ℏ \frac{\frac{{C}_{1 o} {C}_{2 o} {e}^{2}}{4 {πɛ}_{o} {R}^{3}}}{{m}_{e}}}{{m}_{e} {c}^{2}}} ] + \\ {n}_{1} {\overline{E}}_{Kvib} + {c}_{3} \frac{8 {πμ}_{o} {μ}_{B}^{2}}{{r}_{n}^{3}} - \\ ( \begin{matrix}{c}_{4} {E}_{initial} ( AO \text{/} HO ) + \\ {c}_{5} {E}_{initial} ( {c}_{5} AO \text{/} HO )\end{matrix} )\end{matrix} ) \qquad ( 93 )$$

In the case of organic molecules, the atoms of the functional groups are energy matched to the C2sp³ HO such that

E(AO/HO)=−14.63489 eV (94)

For example, of E_{mag} of the C2sp³ HO is:

$$\begin{matrix}{E}_{mag} ( C 2 {sp}^{3} ) = {c}_{3} \frac{8 {πμ}_{o} {μ}_{B}^{2}}{{r}^{3}} \\ = {c}_{3} \frac{8 {πμ}_{o} {μ}_{B}^{2}}{{( 0.91771 {a}_{0} )}^{3}} \\ = {c}_{3} 0.14803 eV\end{matrix} \qquad ( 95 )$$

Each molecule, independently of its complexity and size, is comprised of functional groups wherein each present occurs an integer number of times in the molecule. The total bond energy of the molecule is then given by the integer-weighted sum of the energies of the functions groups corresponding to the composition of the molecule. Thus, integer formulas can be constructed easily for molecules for a given class such as straight-chain hydrocarbons considered as an example infra. The results demonstrate how simply and instantaneously molecules are solved using the classical exact solutions. In contrast, quantum mechanics requires that wavefunction are nonlinear, and any sum must be squared. The results of Millsian disprove quantum mechanics in this regard, and the linearity and superposition properties of Millsian represent a breakthrough with orders of magnitude reduction in complexity in solving molecules as well as being accurate physical representations rather than pure mathematical curve-fits devoid of a connection to reality.

### C. Total Energy of Continuous-Chain Alkanes

E_{D}(CₙH₂ₙ₊₂), the total bond dissociation energy of CₙH₂ₙ₊₂, is given as the sum of the energy components due to the two methyl groups, n-2 methylene groups, and n-1 C—C bonds where each energy component is given by Eqs. (14.590), (14.625), and (14.641), respectively. Thus, the total bond dissociation energy of CₙH₂ₙ₊₂ is

$$\begin{matrix}{E}_{D} ( {C}_{n} {H}_{2 n + 2} ) = {{E}_{D} ( C - C )}_{n - 1} + 2 {{E}_{D}}_{alkane} ( {}_{}^{12}{CH}{}_{3}^{ } ) + \\ ( n - 2 ) {E}_{{D}_{alkane}} ( {}_{}^{12}{CH}{}_{2}^{} ) \\ = ( n - 1 ) ( 4.32754 eV ) + 2 ( 12.49186 eV ) + \\ ( n - 2 ) ( 7.83016 eV )\end{matrix} \qquad ( 96 )$$

The experimental total bond dissociation energy of CₙH₂ₙ₊₂, E_{D}_{ₑₓₚ}(CₙH₂ₙ₊₂), is given by the negative difference between the enthalpy of its formation (ΔH_{f}(CₙH₂ₙ₊₂(gas))) and the sum of the enthalpy of the formation of the reactant gaseous carbons (ΔH_{f}(C(gas))) and hydrogen (ΔH_{f}(H (gas))) atoms:

$$\begin{matrix}{E}_{{D}_{ex p}} ( {C}_{n} {H}_{2 n + 2} ) = - \{ \begin{matrix}Δ {H}_{f} ( {C}_{n} {H}_{2 n + 2} ( gas ) ) - \\ [ \begin{matrix}n Δ {H}_{f} ( C ( gas ) ) + \\ ( 2 n + 2 ) Δ {H}_{f} ( H ( gas ) )\end{matrix} ]\end{matrix} \} \\ = - \{ \begin{matrix}Δ {H}_{f} ( {C}_{n} {H}_{2 n + 2} ( gas ) ) - \\ [ \begin{matrix}n 7.42774 eV + \\ ( 2 n + 2 ) 2.259353 eV\end{matrix} ]\end{matrix} \}\end{matrix} \qquad ( 97 )$$

where the heats of formation atomic carbon and hydrogen gas are given by [32-33]

ΔH_{f}(C(gas))=716.68 kJ/mole (7.42774 eV/molecule) (98)

ΔH_{f}(H(gas))=217.998 kJ/mole (2.259353 eV/molecule) (99)

The comparison of the results predicted by Eq. (96) and the experimental values given by using Eqs. (97-99) with the data from Refs. [32-33] is given in Table 6.

TABLE 6
Summary results of n-alkanes.

| | | Calculated | Experimental | |
|---|---|---|---|---|
| | | Total Bond | Total Bond | Relative |
| Formula | Name | Energy (eV) | Energy (eV) | Error |
| C₃H₈ | Propane | 41.46896 | 41.434 | −0.00085 |
| C₄H₁₀ | Butane | 53.62666 | 53.61 | −0.00036 |
| C₅H₁₂ | Pentane | 65.78436 | 65.77 | −0.00017 |
| C₆H₁₄ | Hexane | 77.94206 | 77.93 | −0.00019 |
| C₇H₁₆ | Heptane | 90.09976 | 90.09 | −0.00013 |
| C₈H₁₈ | Octane | 102.25746 | 102.25 | −0.00006 |
| C₉H₂₀ | Nonane | 114.41516 | 114.40 | −0.00012 |
| C₁₀H₂₂ | Decane | 126.57286 | 126.57 | −0.00003 |
| C₁₁H₂₄ | Undecane | 138.73056 | 138.736 | 0.00004 |
| C₁₂H₂₆ | Dodecane | 150.88826 | 150.88 | −0.00008 |
| C₁₈H₃₈ | Octadecane | 223.83446 | 223.85 | 0.00008 |

The following list of references, which are also incorporated herein by reference in their entirety, are referred to in the above sections using [brackets]:

### REFERENCES

1. R. Mills, The Grand Unified Theory of Classical Physics; June 2008 Edition, posted at http://www.blacklightpower.com/theory/bookdownload.shtml.
2. R. L. Mills, B. Holverstott, B. Good, N. Hogle, A. Makwana, J. Paulus, “Total Bond Energies of Exact Classical Solutions of Molecules Generated by Millsian 1.0 Compared to Those Computed Using Modern 3-21G and 6-31G* Basis Sets”, submitted.
3. R. L. Mills, “Classical Quantum Mechanics”, Physics Essays, Vol. 16, No. 4, December, (2003), pp. 433-498.
4. R. Mills, “Physical Solutions of the Nature of the Atom, Photon, and Their Interactions to Form Excited and Predicted Hydrino States”, in press.
5. R. L. Mills, “Exact Classical Quantum Mechanical Solutions for One- Through Twenty-Electron Atoms”, Physics Essays, Vol. 18, (2005), pp. 321-361.
6. R. L. Mills, “The Nature of the Chemical Bond Revisited and an Alternative Maxwellian Approach”, Physics Essays, Vol. 17, (2004), pp. 342-389.
7. R. L. Mills, “Maxwell's Equations and QED: Which is Fact and Which is Fiction”, Vol. 19, (2006), pp. 225-262.
8. R. L. Mills, “Exact Classical Quantum Mechanical Solution for Atomic Helium Which Predicts Conjugate Parameters from a Unique Solution for the First Time”, in press.
9. R. L. Mills, “The Fallacy of Feynman's Argument on the Stability of the Hydrogen Atom According to Quantum Mechanics,” Annales de la Fondation Louis de Broglie, Vol. 30, No. 2, (2005), pp. 129-151.
10. R. Mills, “The Grand Unified Theory of Classical Quantum Mechanics”, Int. J. Hydrogen Energy, Vol. 27, No. 5, (2002), pp. 565-590.
11. R. Mills, The Nature of Free Electrons in Superfluid Helium—a Test of Quantum Mechanics and a Basis to Review its Foundations and Make a Comparison to Classical Theory, Int. J. Hydrogen Energy, Vol. 26, No. 10, (2001), pp. 1059-1096.
12. R. Mills, “The Hydrogen Atom Revisited”, Int. J. of Hydrogen Energy, Vol. 25, Issue 12, December, (2000), pp. 1171-1183.
13. R. Mills, “The Grand Unified Theory of Classical Quantum Mechanics”, Global Foundation, Inc. Orbis Scientiae entitled The Role of Attractive and Repulsive Gravitational Forces in Cosmic Acceleration of Particles The Origin of the Cosmic Gamma Ray Bursts, (29th Conference on High Energy Physics and Cosmology Since 1964) Dr. Behram N. Kursunoglu, Chairman, Dec. 14-17, 2000, Lago Mar Resort, Fort Lauderdale, Fla., Kluwer Academic/Plenum Publishers, New York, pp. 243-258.
14. P. Pearle, Foundations of Physics, “Absence of radiationless motions of relativistically rigid classical electron”, Vol. 7, Nos. 11/12, (1977), pp. 931-945.
15. V. F. Weisskopf, Reviews of Modern Physics, Vol. 21, No. 2, (1949), pp. 305-315.
16. A. Einstein, B. Podolsky, N. Rosen, Phys. Rev., Vol. 47, (1935), p. 777.
17. H. Wergeland, “The Klein Paradox Revisited”, Old and New Questions in Physics, Cosmology, Philosophy, and Theoretical Biology, A. van der Merwe, Editor, Plenum Press, New York, (1983), pp. 503-515.
18. F. Laloë, Do we really understand quantum mechanics? Strange correlations, paradoxes, and theorems, Am. J. Phys. 69 (6), June 2001, 655-701.
19. F. Dyson, “Feynman's proof of Maxwell equations”, Am. J. Phys., Vol. 58, (1990), pp. 209-211.
20. H. A. Haus, “On the radiation from point charges”, American Journal of Physics, Vol. 54, (1986), 1126-1129.
21. J. D. Jackson, Classical Electrodynamics, Second Edition, John Wiley & Sons, New York, (1975), pp. 739-779.
22. J. D. Jackson, Classical Electrodynamics, Second Edition, John Wiley & Sons, New York, (1975), p. 111.
23. T. A. Abbott and D. J. Griffiths, Am. J. Phys., Vol. 153, No. 12, (1985), pp. 1203-1211.
24. G. Goedecke, Phys. Rev 135B, (1964), p. 281.
25. http://www.blacklightpower.com/theory/theory.shtml.
26. W. J. Nellis, “Making Metallic Hydrogen,” Scientific American, May, (2000), pp. 84-90.
27. J. Itatani, J. Levesque, D. Zeidler, H. Niikura, H. Pepin, J. C. Kieffer, P. B. Corkum, D. M. Villeneuve, “Tomographic imaging of molecular orbitals”, Nature, Vol. 432, (2004), pp. 867-871.
28. J. A. Stratton, Electromagnetic Theory (McGraw-Hill Book Company, 1941), p. 195.
29. J. D. Jackson, Classical Electrodynamics, 2^{nd} Edition (John Wiley & Sons, New York, (1975), pp. 17-22.
30. H. A. Haus, J. R. Melcher, “Electromagnetic Fields and Energy,” Department of Electrical Engineering and Computer Science, Massachusetts Institute of Technology, (1985), Sec. 5.3.
31. NIST Computational Chemistry Comparison and Benchmark Data Base, NIST Standard Reference Database Number 101, Release 14, Sept., (2006), Editor R. D. Johnson III, http://srdata.nist.gov/cccbdb.
32. D. R. Lide, CRC Handbook of Chemistry and Physics, 79th Edition, CRC Press, Boca Raton, Fla., (1998-9), pp. 9-63.
33. D. R. Lide, CRC Handbook of Chemistry and Physics, 79th Edition, CRC Press, Boca Raton, Fla., (1998-9), pp. 5-1 to 5-60.

The equation numbers and sections referenced herein infra. are those disclosed in R. Mills, The Grand Unified Theory of Classical Physics; June 2008 Edition, posted at http://www.blacklightpower.com/theory/bookdownload.shtml which is herein incorporated by reference in its entirety.

The following represents prophetic examples that support the foregoing various embodiments according to the present disclosure.

TABLE 7
The final values of r_{Atom.HO.AO}, E_{Coulomb} (mol.atom, msp³), and E(CₘₒₗC2sp³) calculated
using the values of E_{T}(C^{BO}-C, C2sp³) given in Tables 4 and 5.

| Atom | | | | |
|---|---|---|---|---|
| Hybridization | | | | |
| Designation | E_{T}(C^{BO}-C, C2sp³) | E_{T}(C^{BO}-C, C2sp³) | E_{T}(C^{BO}-C, C2sp³) | E_{T}(C^{BO}-C, C2sp³) |
| 1 | 0 | 0 | 0 | 0 |
| 2 | −0.36229 | 0 | 0 | 0 |
| 3 | −0.46459 | 0 | 0 | 0 |
| 4 | −0.56689 | 0 | 0 | 0 |
| 5 | −0.72457 | 0 | 0 | 0 |
| 6 | −0.85034 | 0 | 0 | 0 |
| 7 | −0.92918 | 0 | 0 | 0 |
| 8 | −0.54343 | −0.54343 | 0 | 0 |
| 9 | −0.18114 | −0.92918 | 0 | 0 |
| 10 | −1.13379 | 0 | 0 | 0 |
| 11 | −1.14485 | 0 | 0 | 0 |
| 12 | −0.46459 | −0.82688 | 0 | 0 |
| 13 | −1.34946 | 0 | 0 | 0 |
| 14 | −1.3725 | 0 | 0 | 0 |
| 15 | −0.46459 | −0.92918 | 0 | 0 |
| 16 | −0.72457 | −0.72457 | 0 | 0 |
| 17 | −0.5669 | −0.92918 | 0 | 0 |
| 18 | −0.82688 | −0.72457 | 0 | 0 |
| 19 | −1.56513 | 0 | 0 | 0 |
| 20 | −0.64574 | −0.92918 | 0 | 0 |
| 21 | −1.57711 | 0 | 0 | 0 |
| 22 | −0.72457 | −0.92918 | 0 | 0 |
| 23 | −0.85035 | −0.85035 | 0 | 0 |
| 24 | −1.79278 | 0 | 0 | 0 |
| 25 | −1.13379 | −0.72457 | 0 | 0 |
| 26 | −0.92918 | −0.92918 | 0 | 0 |
| 27 | −0.56690 | −0.54343 | −0.85034 | 0 |
| 28 | −2.02043 | 0 | 0 | 0 |
| 29 | −1.13379 | −0.92918 | 0 | 0 |
| 30 | −0.56690 | −0.56690 | −0.92918 | 0 |
| 31 | −0.85035 | −0.85035 | −0.46459 | 0 |
| 32 | −0.85035 | −0.42517 | −0.92918 | 0 |
| 33 | −0.5669 | −0.72457 | −0.92918 | 0 |
| 34 | −1.13379 | −1.13379 | 0 | 0 |
| 35 | −1.34946 | −0.92918 | 0 | 0 |
| 36 | −0.46459 | −0.92918 | −0.92918 | 0 |
| 37 | −0.64574 | −0.85034 | −0.85034 | 0 |
| 38 | −0.85035 | −0.5669 | −0.92918 | 0 |
| 39 | −0.72457 | −0.72457 | −0.92918 | 0 |
| 40 | −0.75586 | −0.75586 | −0.92918 | 0 |
| 41 | −0.74804 | −0.85034 | −0.85034 | 0 |
| 42 | −0.82688 | −0.72457 | −0.92918 | 0 |
| 43 | −0.72457 | −0.92918 | −0.92918 | 0 |
| 44 | −0.92918 | −0.72457 | −0.92918 | 0 |
| 45 | −0.54343 | −0.54343 | −0.5669 | −0.92918 |
| 46 | −0.92918 | −0.85034 | −0.85034 | 0 |
| 47 | −0.42517 | −0.42517 | −0.85035 | −0.92918 |
| 48 | −0.82688 | −0.92918 | −0.92918 | 0 |
| 49 | −0.92918 | −0.92918 | −0.92918 | 0 |
| 50 | −0.85035 | −0.54343 | −0.5669 | −0.92918 |
| 51 | −1.34946 | −0.64574 | −0.92918 | 0 |
| 52 | −0.85034 | −0.54343 | −0.60631 | −0.92918 |
| 53 | −1.1338 | −0.92918 | −0.92918 | 0 |
| 54 | −0.46459 | −0.85035 | −0.85035 | −0.92918 |
| 55 | −0.82688 | −1.34946 | −0.92918 | 0 |
| 56 | −0.92918 | −1.34946 | −0.92918 | 0 |
| 57 | −1.13379 | −1.13379 | −1.13379 | 0 |
| 58 | −1.79278 | −0.92918 | −0.92918 | 0 |

| Atom | | | E_{Coulomb}(mol.atom, msp³) | E(Cₘₒₗ2sp³) |
|---|---|---|---|---|
| Hybridization | | r_{Atom.HO.AO} | (eV) | (eV) |
| Designation | E_{T}(C^{BO}-C, C2sp³) | Final | Final | Final |
| 1 | 0 | 0.91771 | −14.82575 | −14.63489 |
| 2 | 0 | 0.89582 | −15.18804 | −14.99717 |
| 3 | 0 | 0.88983 | −15.29034 | −15.09948 |
| 4 | 0 | 0.88392 | −15.39265 | −15.20178 |
| 5 | 0 | 0.87495 | −15.55033 | −15.35946 |
| 6 | 0 | 0.86793 | −15.6761 | −15.48523 |
| 7 | 0 | 0.86359 | −15.75493 | −15.56407 |
| 8 | 0 | 0.85503 | −15.91261 | −15.72175 |
| 9 | 0 | 0.85377 | −15.93607 | −15.74521 |
| 10 | 0 | 0.85252 | −15.95955 | −15.76868 |
| 11 | 0 | 0.85193 | −15.9706 | −15.77974 |
| 12 | 0 | 0.84418 | −16.11722 | −15.92636 |
| 13 | 0 | 0.84115 | −16.17521 | −15.98435 |
| 14 | 0 | 0.83995 | −16.19826 | −16.00739 |
| 15 | 0 | 0.83885 | −16.21952 | −16.02866 |
| 16 | 0 | 0.836 | −16.2749 | −16.08404 |
| 17 | 0 | 0.8336 | −16.32183 | −16.13097 |
| 18 | 0 | 0.83078 | −16.37721 | −16.18634 |
| 19 | 0 | 0.83008 | −16.39089 | −16.20002 |
| 20 | 0 | 0.82959 | −16.40067 | −16.20981 |
| 21 | 0 | 0.82948 | −16.40286 | −16.212 |
| 22 | 0 | 0.82562 | −16.47951 | −16.28865 |
| 23 | 0 | 0.82327 | −16.52645 | −16.33559 |
| 24 | 0 | 0.81871 | −16.61853 | −16.42767 |
| 25 | 0 | 0.81549 | −16.68411 | −16.49325 |
| 26 | 0 | 0.81549 | −16.68412 | −16.49325 |
| 27 | 0 | 0.81052 | −16.78642 | −16.59556 |
| 28 | 0 | 0.80765 | −16.84619 | −16.65532 |
| 29 | 0 | 0.80561 | −16.88872 | −16.69786 |
| 30 | 0 | 0.80561 | −16.88873 | −16.69786 |
| 31 | 0 | 0.80076 | −16.99104 | −16.80018 |
| 32 | 0 | 0.79891 | −17.03045 | −16.83959 |
| 33 | 0 | 0.78916 | −17.04641 | −16.85554 |
| 34 | 0 | 0.79597 | −17.09334 | −16.90248 |
| 35 | 0 | 0.79546 | −17.1044 | −16.91353 |
| 36 | 0 | 0.79340 | −17.14871 | −16.95784 |
| 37 | 0 | 0.79232 | −17.17217 | −16.98131 |
| 38 | 0 | 0.79232 | −17.17218 | −16.98132 |
| 39 | 0 | 0.79085 | −17.20408 | −17.01322 |
| 40 | 0 | 0.78798 | 17.26666 | 17.07580 |
| 41 | 0 | 0.78762 | 17.27448 | 17.08362 |
| 42 | 0 | 0.78617 | −17.30638 | −17.11552 |
| 43 | 0 | 0.78155 | −17.40868 | −17.21782 |
| 44 | 0 | 0.78155 | −17.40869 | −17.21783 |
| 45 | 0 | 0.78155 | −17.40869 | −17.21783 |
| 46 | 0 | 0.77945 | −17.45561 | −17.26475 |
| 47 | 0 | 0.77945 | −17.45563 | −17.26476 |
| 48 | 0 | 0.77699 | −17.51099 | −17.32013 |
| 49 | 0 | 0.77247 | −17.6133 | −17.42244 |
| 50 | 0 | 0.76801 | −17.71561 | −17.52475 |
| 51 | 0 | 0.76652 | −17.75013 | −17.55927 |
| 52 | 0 | 0.76631 | −17.75502 | −17.56415 |
| 53 | 0 | 0.7636 | −17.81791 | −17.62705 |
| 54 | 0 | 0.75924 | −17.92022 | −17.72936 |
| 55 | 0 | 0.75877 | −17.93128 | −17.74041 |
| 56 | 0 | 0.75447 | −18.03358 | −17.84272 |
| 57 | 0 | 0.74646 | −18.22712 | −18.03626 |
| 58 | 0 | 0.73637 | −18.47690 | −18.28604 |

TABLE 8
The final values of r_{Atom.HO.AO}, E_{Coulomb} (mol.atom, msp³), and E(CₘₒₗC2sp³) calculated
for heterocyclic groups using the values of E_{T}(C^{BO}-C, C2sp³) given in Tables 4 and 5.

| Atom | | | | |
|---|---|---|---|---|
| Hybridization | | | | |
| Designation | E_{T}(C^{BO}-C, C2sp³) | E_{T}(C^{BO}-C, C2sp³) | E_{T}(C^{BO}-C, C2sp³) | E_{T}(C^{BO}-C, C2sp³) |
| 1 | 0 | 0 | 0 | 0 |
| 2 | −0.56690 | 0 | 0 | 0 |
| 3 | −0.72457 | 0 | 0 | 0 |
| 4 | −0.92918 | 0 | 0 | 0 |
| 5 | −0.54343 | −0.54343 | 0 | 0 |
| 6 | −1.13379 | 0 | 0 | 0 |
| 7 | −0.60631 | −0.60631 | 0 | 0 |
| 8 | −1.34946 | 0 | 0 | 0 |
| 9 | −0.46459 | −0.92918 | 0 | 0 |
| 10 | −0.72457 | −0.72457 | 0 | 0 |
| 11 | 0.00000 | −0.92918 | −0.56690 | 0 |
| 12 | −0.92918 | −0.60631 | 0 | 0 |
| 13 | 0 | −1.13379 | −0.46459 | 0 |
| 14 | −0.92918 | −0.72457 | 0 | 0 |
| 15 | −0.85035 | −0.85035 | 0 | 0 |
| 16 | −0.82688 | 0 | 0 | 0 |
| 17 | −0.92918 | −0.92918 | 0 | 0 |
| 18 | −1.13379 | −0.72457 | 0 | 0 |
| 19 | −0.92918 | −0.56690 | −0.46459 | 0 |
| 20 | −1.13379 | −0.92918 | 0 | 0 |
| 21 | −0.85035 | −0.85035 | −0.46459 | 0 |
| 22 | 0 | −1.34946 | −0.82688 | 0 |
| 23 | −0.85034 | −0.85034 | −0.56690 | 0 |
| 24 | −1.13379 | −1.13380 | 0 | 0 |
| 25 | −1.34946 | −0.92918 | 0 | 0 |
| 26 | −0.85035 | −0.54343 | 0.00000 | −0.92918 |
| 27 | −0.85035 | −0.56690 | −0.92918 | 0 |
| 28 | −0.56690 | −0.92918 | −0.92918 | 0 |
| 29 | −0.46459 | −1.13380 | −0.92918 | 0 |
| 30 | −0.54343 | −0.54343 | −0.56690 | −0.92918 |
| 31 | −0.85034 | −0.28345 | −0.54343 | −0.92918 |
| 32 | −0.92918 | −0.92918 | −0.92918 | 0 |
| 33 | −0.85034 | −0.54343 | −0.56690 | −0.92918 |
| 34 | −0.85034 | −0.54343 | −0.60631 | −0.92918 |
| 35 | −1.13379 | −0.92918 | −0.92918 | 0 |
| 36 | −1.13379 | −1.13380 | −0.72457 | 0 |
| 37 | −0.46459 | −0.85035 | −0.85035 | −0.92918 |
| 38 | −0.92918 | −1.34946 | −0.82688 | 0 |
| 39 | −0.85034 | −0.54343 | −0.60631 | −1.13379 |
| 40 | −1.13380 | −1.13379 | −0.92918 | 0 |
| 41 | −1.13379 | −1.13379 | −1.13379 | 0 |

| Atom | | | E_{Coulomb} (mol.atom, msp³) | |
|---|---|---|---|---|
| Hybridization | | r_{Atom.HO.AO} | (eV) | E(Cₘₒₗ 2sp³) (eV) |
| Designation | E_{T}(C^{BO}-C, 2sp³) | Final | Final | Final |
| 1 | 0 | 0.91771 | −14.82575 | −14.63489 |
| 2 | 0 | 0.88392 | −15.39265 | −15.20178 |
| 3 | 0 | 0.87495 | −15.55033 | −15.35946 |
| 4 | 0 | 0.86359 | −15.75493 | −15.56407 |
| 5 | 0 | 0.85503 | −15.91261 | −15.72175 |
| 6 | 0 | 0.85252 | −15.95954 | −15.76868 |
| 7 | 0 | 0.84833 | −16.03838 | −15.84752 |
| 8 | 0 | 0.84115 | −16.17521 | |
| 9 | 0 | 0.83885 | −16.21953 | −16.02866 |
| 10 | 0 | 0.83600 | −16.27490 | −16.08404 |
| 11 | 0 | 0.83360 | −16.32183 | −16.13097 |
| 12 | 0 | 0.83159 | −16.36125 | −16.17038 |
| 13 | 0 | 0.82840 | −16.42413 | −16.23327 |
| 14 | 0 | 0.82562 | −16.47951 | −16.28864 |
| 15 | 0 | 0.82327 | −16.52644 | −16.33558 |
| 16 | 0 | 0.82053 | −16.58181 | −16.39095 |
| 17 | 0 | 0.81549 | −16.68411 | −16.49325 |
| 18 | 0 | 0.81549 | −16.68412 | −16.49325 |
| 19 | 0 | 0.81052 | −16.78642 | −16.59556 |
| 20 | 0 | 0.80561 | −16.88873 | −16.69786 |
| 21 | 0 | 0.80076 | −16.99103 | −16.80017 |
| 22 | 0 | 0.80024 | −17.00209 | −16.81123 |
| 23 | 0 | 0.79597 | −17.09334 | −16.90247 |
| 24 | 0 | 0.79597 | −17.09334 | −16.90248 |
| 25 | 0 | 0.79546 | −17.10440 | −16.91353 |
| 26 | 0 | 0.79340 | −17.14871 | −16.95785 |
| 27 | 0 | 0.79232 | −17.17218 | −16.98132 |
| 28 | 0 | 0.78870 | −17.25101 | −17.06015 |
| 29 | 0 | 0.78405 | −17.35332 | −17.16246 |
| 30 | 0 | 0.78155 | −17.40869 | −17.21783 |
| 31 | 0 | 0.78050 | −17.43216 | −17.24130 |
| 32 | 0 | 0.77247 | −17.61330 | −17.42243 |
| 33 | 0 | 0.76801 | −17.71560 | −17.52474 |
| 34 | 0 | 0.76631 | −17.75502 | −17.56416 |
| 35 | 0 | 0.76360 | −17.81791 | −17.62704 |
| 36 | 0 | 0.76360 | −17.81791 | −17.62705 |
| 37 | 0 | 0.75924 | −17.92022 | −17.72935 |
| 38 | 0 | 0.75878 | −17.93127 | −17.74041 |
| 39 | 0 | 0.75758 | −17.95963 | −17.76877 |
| 40 | 0 | 0.75493 | −18.02252 | −17.83166 |
| 41 | 0 | 0.74646 | −18.22713 | −18.03627 |

Halobenzenes

Halobenzenes have the formula C₆H₆₋ₘXₘX═F, Cl, Br, I and comprise the benzene molecule with at least one hydrogen atom replaced by a halogen atom corresponding to a C—X functional group. The aromatic C^{3e}═C and C—H functional groups are equivalent to those of benzene given in Aromatic and Heterocyclic Compounds section. The hybridization factors of the aryl C—X functional groups are equivalent to those of the corresponding alkyl halides as given in Tables 15.30, 15.36, 15.42, and 15.48, and are solved using the same principles as those used to solve the alkyl halide functional groups as given in the corresponding sections. In each case, the 2s and 2p AOs of each C hybridize to form a single 2sp³ shell as an energy minimum, and the sharing of electrons between the C2sp³ HO and X AO to form a MO permits each participating hybridized orbital to decrease in radius and energy. Therefore, the MO is energy matched to the C2sp³ HO such that E(AO/HO) in Eq. (15.51) is −14.63489 eV. E_{T}(atom-atom,msp³.AO) of each C—X functional group given in Table 12 that achieves matching of the energies of the AOs and HOs within the functional groups of the MOs are those of alkanes and alkenes given in Tables 4 and 5. To further match energies within each MO that bridges the halogen AO and aromatic carbon C2sp³ HO, ΔE_{H}_{₂}_{MO} (AO/HO) in Eq. (15.51) is E_{T}(atom-atom,msp³.AO) of the alkene C═C function group, −2.26759 eV given by Eq. (14.247), plus the maximum possible contribution of E_{T}(atom-atom,msp³.AO) of the C—X functional group to minimize the energy of the MO as given in Table 12. Eᵢₙᵢₜᵢₐₗ(c₄ AO/HO) is −14.63489 eV (Eq. (15.25)), except for C—I due to the low ionization potential of the I AO. In order to achieve an energy minimum with energy matching within iodo-aryl molecules, Eᵢₙᵢₜᵢₐₗ(c₄ AO/HO) of the C—I functional group is −15.76868 eV (Eq. (14.246)), and E_{T}(atom-atom,msp³.AO) is −1.65376 eV given by the linear combination of −0.72457 eV (Eq. (14.151)) and −0.92918 eV (Eq. (14.513)), respectively.

The small differences between energies of ortho, meta, and para-dichlorobenzene is due to differences in the energies of vibration in the transition state that contribute to E_{osc}. Two types of C—Cl functional groups can be identified based on symmetry that determine the parameter R in Eq. (15.57). One corresponds to the special case of 1,3,5 substitution and the other corresponds to other cases of single or multiple substitutions of Cl for H. P-dichlorobenzene is representative of the bonding with R=a. 1,2,3-trichlorbenzene is the particular case wherein R=b. Also, beyond the binding of three chlorides E_{mag} is subtracted for each additional Cl due to the formation of an unpaired electrons on each C—Cl bond.

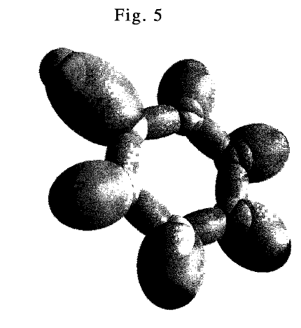

The symbols of the functional groups of halobenzenes are given in Table 9. The geometrical (Eqs. (15.1-15.5) and (15.51)), intercept (Eqs. (15.80-15.87)), and energy (Eqs. (15.6-15.11), (15.17-15.65), and (15.165-15.166)) parameters of halobenzenes are given in Tables 10, 11, and 12, respectively. The total energy of each halobenzene given in Table 13 was calculated as the sum over the integer multiple of each E_{D}(Group) of Table 12 corresponding to functional-group composition of the molecule. For each set of unpaired electrons created by bond breakage, the C2sp³ HO magnetic energy E_{mag} that is subtracted from the weighted sum of the E_{D}(Group) (eV) values based on composition is given by Eq. (15.67). The bond angle parameters of halobenzenes determined using Eqs. (15.88-15.117) are given in Table 14. The color scale, translucent view of the charge-density of chlorobenzene comprising the concentric shells of atoms with the outer shell bridged by one or more H₂-type ellipsoidal MOs or joined with one or more hydrogen MOs is shown in FIG. 5.

TABLE 9
The symbols of functional groups of halobenzenes.

| Functional Group | Group Symbol |
|---|---|
| CC (aromatic bond) | C^{3e}═C |
| CH (aromatic) | CH (i) |
| F—C (F to aromatic bond) | C—F |
| Cl—C (Cl to aromatic bond) | C—Cl (a) |
| Cl—C (Cl to aromatic bond of 1,3,5- | C—Cl (b) |
| trichlorbenzene) | |
| Br—C (Br to aromatic bond) | C—Br |
| I—C (I to aromatic bond) | C—I |

TABLE 10
The geometrical bond parameters of halobenzenes and experimental values [1].

| | C^{3e}═C | CH (i) | C—F | C—Cl (a) | C—Cl (b) | C—Br | C—I |
|---|---|---|---|---|---|---|---|
| Parameter | Group | Group | Group | Group | Group | Group | Group |
| a (a₀) | 1.47348 | 1.60061 | 1.60007 | 2.20799 | 2.20799 | 2.30810 | 2.50486 |
| c′ (a₀) | 1.31468 | 1.03299 | 1.26494 | 1.64782 | 1.64782 | 1.76512 | 1.95501 |
| Bond Length | 1.39140 | 1.09327 | 1.33875 | 1.74397 | 1.74397 | 1.86812 | 2.06909 |
| 2c′ (Å) | | | | | | | |
| Exp. Bond Length | 1.400 | 1.083 | 1.356 [54] | 1.737 | 1.737 | 1.8674 [55] | 2.08 [56] |
| (Å) | (chlorobenzene) | (chlorobenzene) | (fluorobenzene) | (chlorobenzene) | (chlorobenzene) | (bromobenzene) | (iodobenzene) |
| b, c (a₀) | 0.66540 | 1.22265 | 0.97987 | 1.46967 | 1.46967 | 1.48718 | 1.56597 |
| e | 0.89223 | 0.64537 | 0.79055 | 0.74630 | 0.74630 | 0.76475 | 0.78049 |

TABLE 11
The MO to HO intercept geometrical bond parameters of halobenzenes.
E_{T} is E_{T}(atom - atom, msp³.AO).

| | | E_{T} | E_{T} | E_{T} | E_{T} | Final Total Energy | | |
|---|---|---|---|---|---|---|---|---|
| | | (eV) | (eV) | (eV) | (eV) | C2sp³ | rᵢₙᵢₜᵢₐₗ | r_{final} |
| Bond | Atom | Bond 1 | Bond 2 | Bond 3 | Bond 4 | (eV) | (a₀) | (a₀) |
| C—H (C_{b}H) | C_{b} | −0.85035 | −0.85035 | −0.56690 | 0 | −153.88327 | 0.91771 | 0.79597 |
| C^{3e}═HC_{b}^{3e}═C | C_{b} | −0.85035 | −0.85035 | −0.56690 | 0 | −153.88327 | 0.91771 | 0.79597 |
| (C^{3e}═)₂Cₐ—F | Cₐ | −1.03149 | −0.85035 | −0.85035 | 0 | −154.34787 | 0.91771 | 0.77491 |
| (C^{3e}═)₂Cₐ—F | F | −1.03149 | 0 | 0 | 0 | | 0.78069 | 0.85802 |
| (C^{3e}═)₂Cₐ—Cl | Cₐ | −0.36229 | −0.85035 | −0.85035 | 0 | −153.67867 | 0.91771 | 0.80561 |
| (C^{3e}═)₂Cₐ—Cl | Cl | −0.36229 | 0 | 0 | 0 | | 1.05158 | 0.89582 |
| C_{b}^{3e}═(Cl)Cₐ^{3e}═C_{b} | C_{b} | −0.36229 | −0.85035 | −0.85035 | 0 | −153.67867 | 0.91771 | 0.80561 |
| (C_{b} bound to Cl) | | | | | | | | |
| (C^{3e}═)₂Cₐ—Br | Cₐ | −0.18114 | −0.85035 | −0.85035 | 0 | −153.49753 | 0.91771 | 0.81435 |
| (C^{3e}═)₂Cₐ—Br | Br | −0.18114 | 0 | 0 | 0 | | 1.15169 | 0.90664 |
| (C^{3e}═)₂Cₐ—I | Cₐ | −0.82688 | −0.85035 | −0.85035 | 0 | −154.14326 | 0.91771 | 0.78405 |
| (C^{3e}═)₂Cₐ—I | I | −0.82688 | 0 | 0 | 0 | | 1.30183 | 0.86923 |

| | | E(C2sp³) | | | | | |
|---|---|---|---|---|---|---|---|
| | E_{Coulomb}(C2sp³)(eV) | (eV) | θ′ | θ₁ | θ₂ | d₁ | d₂ |
| Bond | Final | Final | (°) | (°) | (°) | (a₀) | (a₀) |
| C—H (C_{b}H) | −17.09334 | −16.90248 | 74.42 | 105.58 | 38.84 | 1.24678 | 0.21379 |
| C^{3e}═HC_{b}^{3e}═C | −17.09334 | −16.90248 | 134.24 | 45.76 | 58.98 | 0.75935 | 0.55533 |
| (C^{3e}═)₂Cₐ—F | −17.55793 | −17.36707 | 106.58 | 73.42 | 49.28 | 1.04378 | 0.22116 |
| (C^{3e}═)₂Cₐ—F | −15.85724 | | 112.35 | 67.65 | 54.08 | 0.93865 | 0.32629 |
| (C^{3e}═)₂Cₐ—Cl | −16.88873 | −16.69786 | 73.32 | 106.68 | 31.67 | 1.87911 | 0.23129 |
| (C^{3e}═)₂Cₐ—Cl | 15.18804 | | 82.92 | 97.08 | 37.22 | 1.75824 | 0.11042 |
| C_{b}^{3e}═Cl)Cₐ^{3e}═C_{b} | −16.88873 | −16.69786 | 134.65 | 45.35 | 59.47 | 0.74854 | 0.56614 |
| (C_{b} bound to Cl) | | | | | | | |
| (C^{3e}═)₂Cₐ—Br | −16.70759 | −16.51672 | 76.64 | 103.36 | 32.19 | 1.95326 | 0.18814 |
| (C^{3e}═)₂Cₐ—Br | −15.00689 | | 85.73 | 94.27 | 37.44 | 1.83258 | 0.06746 |
| (C^{3e}═)₂Cₐ—I | −17.35332 | −17.16246 | 71.42 | 108.58 | 28.33 | 2.20480 | 0.24979 |
| (C^{3e}═)₂Cₐ—I | −15.65263 | | 80.69 | 99.31 | 33.21 | 2.09565 | 0.14064 |

TABLE 12
The energy parameters (eV) of functional groups of halobenzenes.

| | C^{3e}═C | CH (i) | C—F | C—Cl (a) | C—Cl (b) | C—Br | C—I |
|---|---|---|---|---|---|---|---|
| Parameters | Group | Group | Group | Group | Group | Group | Group |
| f₁ | 0.75 | 1 | 1 | 1 | 1 | 1 | 1 |
| n₁ | 2 | 1 | 1 | 1 | 1 | 2 | 2 |
| n₂ | 0 | 0 | 0 | 0 | 0 | 0 | 0 |
| n₃ | 0 | 0 | 0 | 0 | 0 | 0 | 0 |
| C₁ | 0.5 | 0.75 | 0.5 | 0.5 | 0.5 | 0.5 | 0.5 |
| C₂ | 0.85252 | 1 | 1 | 0.81317 | 0.81317 | 0.74081 | 0.65537 |
| c₁ | 1 | 1 | 1 | 1 | 1 | 1 | 1 |
| c₂ | 0.85252 | 0.91771 | 0.77087 | 1 | 1 | 1 | 1 |
| c₃ | 0 | 1 | 0 | 0 | 0 | 0 | 0 |
| c₄ | 3 | 1 | 2 | 2 | 2 | 2 | 2 |
| c₅ | 0 | 1 | 0 | 0 | 0 | 0 | 0 |
| C₁ₒ | 0.5 | 0.75 | 1 | 0.5 | 0.5 | 0.5 | 0.5 |
| C₂ₒ | 0.85252 | 1 | 0.5 | 0.81317 | 0.81317 | 0.74081 | 0.65537 |
| Vₑ (eV) | −101.12679 | −37.10024 | −35.58388 | −31.85648 | −31.85648 | −31.06557 | −29.13543 |
| Vₚ (eV) | 20.69825 | 13.17125 | 10.75610 | 8.25686 | 8.25686 | 7.70816 | 6.95946 |
| T (eV) | 34.31559 | 11.58941 | 11.11948 | 7.21391 | 7.21391 | 6.72969 | 5.81578 |
| Vₘ (eV) | −17.15779 | −5.79470 | −5.55974 | −3.60695 | −3.60695 | −3.36484 | −2.90789 |
| E(AO/HO) (eV) | 0 | −14.63489 | −14.63489 | −14.63489 | −14.63489 | −2.99216 | −2.26759 |
| ΔE_{H}_{₂}_{MO}(AO/HO) (eV) | 0 | −1.13379 | −2.26759 | −2.99216 | −2.99216 | −14.63489 | −14.63489 |
| E_{T}(AO/HO) (eV) | 0 | −13.50110 | −12.36730 | −11.64273 | −11.64273 | −11.64273 | −12.36730 |
| E_{T}(H₂MO) (eV) | −63.27075 | −31.63539 | −31.63535 | −31.63539 | −31.63539 | −31.63530 | −31.63538 |
| E_{T}(atom - atom, msp³.AO) (eV) | −2.26759 | −0.56690 | −2.06297 | −0.72457 | −0.72457 | −0.36229 | 1.65376 |
| E_{T}(MO) (eV) | −65.53833 | −32.20226 | −33.69834 | −32.35994 | −32.35994 | −31.99766 | −33.28912 |
| ω(10¹⁵ rad/s) | 49.7272 | 26.4826 | 14.4431 | 8.03459 | 14.7956 | 7.17533 | 12.0764 |
| E_{K} (eV) | 32.73133 | 17.43132 | 9.50672 | 5.28851 | 9.73870 | 4.72293 | 7.94889 |
| Ē_{D} (eV) | −0.35806 | −0.26130 | −0.20555 | −0.14722 | −0.19978 | −0.13757 | −0.18568 |
| Ē_{Kvib} (eV) | 0.19649 [49] | 0.35532 | 0.10911 [11] | 0.08059 [12] | 0.08059 [12] | 0.08332 [15] | 0.06608 [16] |
| | | Eq. (13.458) | | | | | |
| Ē_{osc} (eV) | −0.25982 | −0.08364 | −0.15100 | −0.10693 | −0.15949 | −0.09591 | −0.15264 |
| E_{mag} (eV) | 0.14803 | 0.14803 | 0.14803 | 0.14803 | 0.14803 | 0.14803 | 0.14803 |
| E_{T}(Group) (eV) | −49.54347 | −32.28590 | −33.84934 | −32.46687 | −32.51943 | −32.09357 | −33.44176 |
| Eᵢₙᵢₜᵢₐₗ(c₄ AO/HO) (eV) | −14.63489 | −14.63489 | −14.63489 | −14.63489 | −14.63489 | −14.63489 | −15.76868 |
| Eᵢₙᵢₜᵢₐₗ(c₅ AO/HO) (eV) | 0 | −13.59844 | 0 | 0 | 0 | 0 | 0 |
| E_{D}(Group) (eV) | 5.63881 | 3.90454 | 4.57956 | 3.19709 | 3.24965 | 2.82379 | 1.90439 |

TABLE 13
The total bond energies of halobenzenes calculated using the functional group
composition and the energies of Table 15.234 compared to the experimental values
[3]. The magnetic energy E_{mag} that is subtracted from the weighted
sum of the E_{D}(Group) (eV) values based on composition is given by (15.58).

| | | | | C—F | C—Cl (a) | C—Cl (b) | C—Br |
|---|---|---|---|---|---|---|---|
| Formula | Name | C^{3e}═C | CH (i) | Group | Group | Group | Group |
| C₆H₅Cl | Fluorobenzene | 6 | 5 | 1 | 0 | 0 | 0 |
| C₆H₅Cl | Chlorobenzene | 6 | 5 | | 1 | 0 | |
| C₆H₄Cl₂ | m-dichlorobenzene | 6 | 4 | | 2 | 0 | |
| C₆H₃Cl₃ | 1,2,3-trichlorobenzene | 6 | 3 | | 3 | 0 | |
| C₆H₃Cl₃ | 1,3,5-trichlorbenzene | 6 | 3 | | 0 | 3 | |
| C₆Cl₆ | Hexachlorobenzene | 6 | 0 | | 6 | 0 | |
| C₆H₅Br | Bromobenzene | 6 | 5 | 0 | 0 | 0 | 1 |
| C₆H₅I | Iodobenzene | 6 | 5 | 0 | 0 | 0 | 0 |

| | | | | Calculated | Experimental | |
|---|---|---|---|---|---|---|
| | | C—I | | Total Bond | Total Bond | |
| Formula | Name | Group | E_{mag} | Energy (eV) | Energy (eV) | Relative Error |
| C₆H₅Cl | Fluorobenzene | 0 | 0 | 57.93510 | 57.887 | −0.00083 |
| C₆H₅Cl | Chlorobenzene | | 0 | 56.55263 | 56.581 | 0.00051 |
| C₆H₄Cl₂ | m-dichlorobenzene | | 0 | 55.84518 | 55.852 | 0.00012 |
| C₆H₃Cl₃ | 1,2,3-trichlorobenzene | | 0 | 55.13773 | 55.077 | −0.00111 |
| C₆H₃Cl₃ | 1,3,5-trichlorbenzene | | 0 | 55.29542 | 55.255 | −0.00073 |
| C₆Cl₆ | Hexachlorobenzene | | 3 | 52.57130 | 52.477 | −0.00179 |
| C₆H₅Br | Bromobenzene | 0 | 0 | 56.17932 | 56.391^{a} | 0.00376 |
| C₆H₅I | Iodobenzene | 1 | 0 | 55.25993 | 55.261 | 0.00001 |

^{a}Liquid.

TABLE 14
The bond angle parameters of halobenzenes and experimental values [1].
E_{T} is E_{T}(atom - atom, msp³.AO).

| | | | 2c′ | | Atom 1 | | Atom 2 | | |
|---|---|---|---|---|---|---|---|---|---|
| | 2c′ | 2c′ | Terminal | | Hybridization | | Hybridization | | |
| Atoms of | Bond 1 | Bond 2 | Atoms | E_{Coulombic} | Designation | E_{Coulombic} | Designation | c₂ | c₂ |
| Angle | (a₀) | (a₀) | (a₀) | Atom 1 | (Table 7) | Atom 2 | (Table 7) | Atom 1 | Atom 2 |
| ∠CCC | 2.62936 | 2.62936 | 4.5585 | −17.17218 | 38 | −17.17218 | 38 | 0.79232 | 0.79232 |
| (aromatic) | | | | | | | | | |
| ∠CCH | | | | | | | | | |
| ∠CCX | | | | | | | | | |
| (aromatic) | | | | | | | | | |

| Atoms of | | | | | E_{T} | θᵥ | θ₁ | θ₂ | Cal. θ | Exp. θ |
|---|---|---|---|---|---|---|---|---|---|---|
| Angle | C₁ | C₂ | c₁ | c₂′ | (eV) | (°) | (°) | (°) | (°) | (°) |
| ∠CCC | 1 | 1 | 1 | 0.79232 | −1.85836 | | | | 120.19 | 120 |
| (aromatic) | | | | | | | | | | (∠CC(H)C chlorobenzene) |
| | | | | | | | | | | 121.7 |
| | | | | | | | | | | (∠CC(Cl)C chlorobenzene) |
| | | | | | | | | | | 120 [50-52] |
| | | | | | | | | | | (benzene) |
| ∠CCH | | | | | | | 120.19 | | 119.91 | 120 [50-52] |
| ∠CCX | | | | | | | | | | (benzene) |
| (aromatic) | | | | | | | | | | |

Adenine

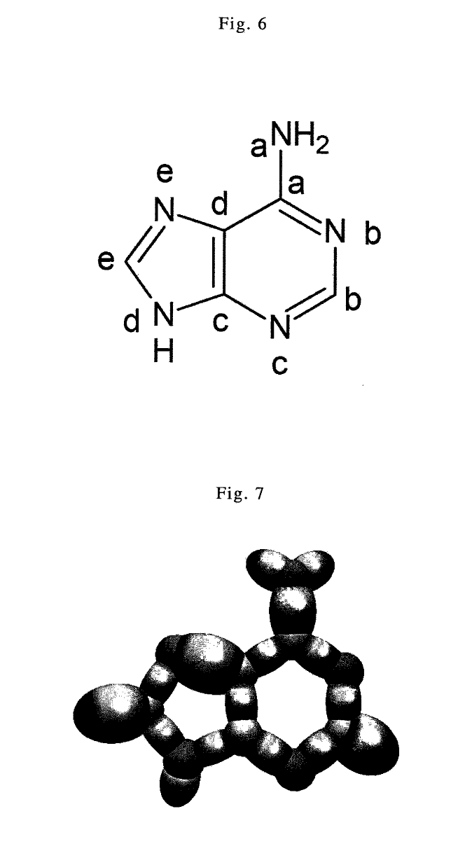

Adenine having the formula C₅H₅N₅ comprises a pyrimidine moiety with an aniline-type moiety and a conjugated five-membered ring, which comprises imidazole except that one of the double bonds is part of the aromatic ring. The structure is shown in FIG. 6. The aromatic C^{3e}═C, C—H, and C^{3e}═N functional groups of the pyrimidine moiety are equivalent to those of pyrimidine as given in the corresponding section. The CH, NH, C_{d}—Nₑ, and Nₑ═Cₑ groups of the imidazole-type ring are equivalent to the corresponding groups of imidazole as given in the corresponding section. The C—N—C functional group of the imidazole-type ring is equivalent to the corresponding group of indole having the same structure with the C—N—C group bonding to aryl and alkenyl groups. The NH₂ and Cₐ—Nₐ functional groups of the aniline-type moiety are equivalent to those of aniline as given in the corresponding section except that ΔE_{H}_{₂}_{MO} (AO/HO) of the Cₐ—Nₐ group is equal to twice E_{T}(atom-atom, msp³.AO), and to meet the equipotential condition of the union of the C—N H₂-type-ellipsoidal-MO with these orbitals, the hybridization factor c₂ of Eq. (15.60) for the C—N-bond MO given by Eqs. (15.77), (15.79), and (15.162) is

$$\begin{matrix}{c}_{2} ( arylC 2 {sp}^{3} HO to N ) = \frac{E ( N )}{E ( C , 2 {sp}^{3} )} {c}_{2} ( arylC 2 {sp}^{3} HO ) \\ = \frac{- 14.53414 eV}{- 15.95955 eV} ( 0.8252 ) \\ = 0.77638\end{matrix} \qquad ( 15.173 )$$

The symbols of the functional groups of adenine are given in Table 15. The geometrical (Eqs. (15.1-15.5) and (15.51)), intercept (Eqs. (15.80-15.87)), and energy (Eqs. (15.6-15.11) and (15.17-15.65)) parameters of adenine are given in Tables 16, 17, and 18, respectively. The total energy of adenine given in Table 19 was calculated as the sum over the integer multiple of each E_{D} (Group) of Table 18 corresponding to functional-group composition of the molecule. The bond angle parameters of adenine determined using Eqs. (15.88-15.117) are given in Table 20. The color scale, charge-density of adenine comprising atoms with the outer shell bridged by one or more H₂-type ellipsoidal MOs or joined with one or more hydrogen MOs is shown in FIG. 7.

TABLE 15
The symbols of functional groups of adenine.

| Functional Group | Group Symbol |
|---|---|
| CC (aromatic bond) | C^{3e}═C |
| CH (aromatic) | CH (i) |
| C_{b,c}^{3e}═N_{c} C_{a,b}^{3e}═N_{b} | C^{3e}═N |
| Cₐ—Nₐ | C—N (a) |
| NH₂ group | NH₂ |
| Nₑ═Cₑ double bond | N═C |
| C_{d}—Nₑ | C—N (b) |
| N_{d}H group | NH |
| CH | CH (ii) |
| C_{c}—N_{d}—Cₑ | C—N—C |

TABLE 16
The geometrical bond parameters of adenine and experimental values [1].

| | C^{3e}═C | CH (i) | C^{3e}═N | C—N (a) | NH₂ |
|---|---|---|---|---|---|
| Parameter | Group | Group | Group | Group | Group |
| a (a₀) | 1.47348 | 1.60061 | 1.47169 | 1.61032 | 1.24428 |
| c′ (a₀) | 1.31468 | 1.03299 | 1.27073 | 1.26898 | 0.94134 |
| Bond Length | 1.39140 | 1.09327 | 1.34489 | 1.34303 | 0.99627 |
| 2c′ (Å) | | | | | |
| Exp. Bond Length | 1.393 | 1.084 | 1.340 | 1.34 [64] | 0.998 |
| (Å) | (pyrimidine) | (pyridine) | (pyrimidine) | (adenine) | (aniline) |
| b, c (a₀) | 0.66540 | 1.22265 | 0.74237 | 0.99137 | 0.81370 |
| e | 0.89223 | 0.64537 | 0.86345 | 0.78803 | 0.75653 |

| | N═C | C—N (b) | NH | CH (ii) | C—N—C |
|---|---|---|---|---|---|
| Parameter | Group | Group | Group | Group | Group |
| a (a₀) | 1.44926 | 1.82450 | 1.24428 | 1.53380 | 1.44394 |
| c′ (a₀) | 1.30383 | 1.35074 | 0.94134 | 1.01120 | 1.30144 |
| Bond Length | 1.37991 | 1.42956 | 0.996270 | 1.07021 | 1.37738 |
| 2c′ (Å) | | | | | |
| Exp. Bond Length | | | 0.996 | 1.076 | 1.370 |
| (Å) | | | (pyrrole) | (pyrrole) | (pyrrole) |
| b, c (a₀) | 0.63276 | 1.22650 | 0.81370 | 1.15326 | 0.62548 |
| e | 0.89965 | 0.74033 | 0.75653 | 0.65928 | 0.90131 |

TABLE 17
The MO to HO intercept geometrical bond parameters of adenine. R₁ is an alkyl group and R,
R′, R″ are H or alkyl groups. E_{T} is E_{T}(atom - atom, msp³.AO).

| | | | | | | Final Total | | |
|---|---|---|---|---|---|---|---|---|
| | | E_{T} | E_{T} | E_{T} | E_{T} | Energy | | |
| | | (eV) | (eV) | (eV) | (eV) | C2sp³ | rᵢₙᵢₜᵢₐₗ | r_{final} |
| Bond | Atom | Bond 1 | Bond 2 | Bond 3 | Bond 4 | (eV) | (a₀) | (a₀) |
| C_{d}(N_{b})CₐNₐH—H | Nₐ | −0.56690 | 0 | 0 | 0 | | 0.93084 | 0.88392 |
| C_{d}(N_{b})Cₐ—NₐH₂ | Cₐ | −0.56690 | −0.54343 | −0.85035 | 0 | −153.57636 | 0.91771 | 0.81052 |
| C_{d}(N_{b})Cₐ—NₐH₂ | Nₐ | −0.56690 | 0 | 0 | 0 | | 0.93084 | 0.88392 |
| C—H (C_{b}H) | C_{b} | −0.54343 | −0.54343 | −0.56690 | 0 | −153.26945 | 0.91771 | 0.82562 |
| C—H (CₑH) | Cₑ | −0.92918 | −0.60631 | 0 | 0 | −153.15119 | 0.91771 | 0.83159 |
| N—H (N_{d}H) | N | −0.60631 | −0.60631 | 0 | 0 | | 0.93084 | 0.84833 |
| C_{d}(NH₂)Cₐ^{3e}═N_{b}C_{b} | Cₐ | −0.85035 | −0.54343 | −0.56690 | 0 | −153.57636 | 0.91771 | 0.81052 |
| C_{d}(NH₂)Cₐ^{3e}═N_{b}C_{b} | N_{b} | −0.54343 | −0.54343 | 0 | 0 | | 0.93084 | 0.85503 |
| N_{b}C_{b}^{3e}═N_{c}C_{c} | N_{c} | | | | | | | |
| N_{b}C_{b}^{3e}═N_{c}C_{c} | C_{b} | −0.54343 | −0.54343 | −0.56690 | 0 | −153.26945 | 0.91771 | 0.82562 |
| CₐN_{b}^{3e}═C_{b}N_{c} | | | | | | | | |
| C_{d}(N_{d}H)C_{c}^{3e}═N_{c}C_{b} | C_{c} | −0.85035 | −0.54343 | −0.60631 | 0 | −153.61578 | 0.91771 | 0.80863 |
| N_{b}(NₐH₂)Cₐ^{3e}═C_{d}(Nₑ)C_{c} | Cₐ | −0.85035 | −0.54343 | −0.56690 | 0 | −153.57636 | 0.91771 | 0.81052 |
| N_{b}(NₐH₂)Cₐ^{3e}═C_{d}(Nₑ)C_{c} | C_{d} | −0.85035 | −0.85035 | −0.46459 | 0 | −153.78097 | 0.91771 | 0.80076 |
| Cₐ(Nₑ)C_{d}^{3e}═C_{c}(N_{d}H)N_{c} | | | | | | | | |
| Cₐ(Nₑ)C_{d}^{3e}═C_{c}(N_{d}H)N_{c} | C_{c} | −0.85035 | −0.54343 | −0.60631 | 0 | −153.61578 | 0.91771 | 0.80863 |
| C_{d}(N_{c})C_{c}—N_{d}H | C_{c} | −0.85035 | −0.54343 | −0.60631 | 0 | −153.61578 | 0.91771 | 0.80863 |
| Cₑ(H)N_{d}—C_{c}(N_{c})C_{d} | N_{d} | −0.60631 | −0.60631 | 0 | 0 | | 0.93084 | 0.84833 |
| Nₑ(H)Cₑ—N_{d}(H)C_{c} | | | | | | | | |
| Nₑ(H)Cₑ—N_{d}(H)C_{c} | Cₑ | −0.60631 | −0.92918 | 0 | 0 | −153.15119 | 0.91771 | 0.83159 |
| C_{d}Nₑ═Cₑ(H)N_{d}H | Cₑ | −0.92918 | −0.60631 | 0 | 0 | −153.15119 | 0.91771 | 0.83159 |
| C_{d}Nₑ═Cₑ(H)N_{d}H | Nₑ | −0.92918 | −0.46459 | 0 | 0 | | 0.93084 | 0.83885 |
| Cₐ(C_{c})C_{d}—NₑCₑ | Nₑ | −0.46459 | −0.92918 | 0 | 0 | | 0.93084 | 0.83885 |
| Cₐ(C_{c})C_{d}—NₑCₑ | C_{d} | −0.46459 | −0.85035 | −0.85035 | 0 | −153.78097 | 0.91771 | 0.80076 |

| | E_{Coulomb}(C2sp [symbol] | E(C2sp³) | | | | | |
|---|---|---|---|---|---|---|---|
| | (eV) | (eV) | θ′ | θ₁ | θ₂ | d₁ | d₂ |
| Bond | Final | Final | (°) | (°) | (°) | (a₀) | (a₀) |
| C_{d}(N_{b})CₐNₐH—H | −15.39265 | | 121.74 | 58.26 | 67.49 | 0.47634 | 0.46500 |
| C_{d}(N_{b})Cₐ—NₐH₂ | −16.78642 | −16.59556 | 108.27 | 71.73 | 50.93 | 1.01493 | 0.25406 |
| C_{d}(N_{b})Cₐ—NₐH₂ | −15.39265 | | 113.13 | 66.87 | 55.08 | 0.92180 | 0.34719 |
| C—H (C_{b}H) | −16.47951 | −16.28864 | 78.27 | 101.73 | 41.39 | 1.20084 | 0.16785 |
| C—H (CₑH) | −16.36125 | −16.17038 | 86.28 | 93.72 | 46.02 | 1.06512 | 0.05392 |
| N—H (N_{d}H) | −16.03838 | | 119.52 | 60.48 | 65.13 | 0.52338 | 0.41796 |
| C_{d}(NH₂)Cₐ^{3e}═N_{b}C_{b} | −16.78642 | −16.59556 | 128.54 | 51.46 | 58.65 | 0.76572 | 0.50501 |
| C_{d}(NH₂)Cₐ^{3e}═N_{b}C_{b} | −15.91261 | | 130.61 | 49.39 | 60.97 | 0.71418 | 0.55656 |
| N_{b}C_{b}^{3e}═N_{c}C_{c} | | | | | | | |
| N_{b}C_{b}^{3e}═N_{c}C_{c} | −16.47951 | −16.28865 | 129.26 | 50.74 | 59.44 | 0.74824 | 0.52249 |
| CₐN_{b}^{3e}═C_{b}N_{c} | | | | | | | |
| C_{d}(N_{d}H)C_{c}^{3e}═N_{c}C_{b} | −16.82584 | −16.63498 | 128.45 | 51.55 | 58.55 | 0.76792 | 0.50281 |
| N_{b}(NₐH₂)Cₐ^{3e}═C_{d}(Nₑ)C_{c} | −16.78642 | −16.59556 | 134.85 | 45.15 | 59.72 | 0.74304 | 0.57165 |
| N_{b}(NₐH₂)Cₐ^{3e}═C_{d}(Nₑ)C_{c} | −16.99103 | −16.80017 | 134.44 | 45.56 | 59.22 | 0.75398 | 0.56071 |
| Cₐ(Nₑ)C_{d}^{3e}═C_{c}(N_{d}H)N_{c} | | | | | | | |
| Cₐ(Nₑ)C_{d}^{3e}═C_{c}(N_{d}H)N_{c} | −16.82584 | −16.63498 | 134.77 | 45.23 | 59.62 | 0.74516 | 0.56952 |
| C_{d}(N_{c})C_{c}—N_{d}H | −16.82584 | −16.63498 | 137.54 | 42.46 | 60.78 | 0.70488 | 0.59656 |
| Cₑ(H)N_{d}—C_{c}(N_{c})C_{d} | −16.03838 | | 139.04 | 40.96 | 62.76 | 0.66083 | 0.64061 |
| Nₑ(H)Cₑ—N_{d}(H)C_{c} | | | | | | | |
| Nₑ(H)Cₑ—N_{d}(H)C_{c} | −16.36125 | −16.17039 | 138.42 | 41.58 | 61.93 | 0.67940 | 0.62203 |
| C_{d}Nₑ═Cₑ(H)N_{d}H | −16.36125 | −16.17039 | 137.93 | 42.07 | 61.72 | 0.68657 | 0.61726 |
| C_{d}Nₑ═Cₑ(H)N_{d}H | −16.21952 | | 138.20 | 41.80 | 62.08 | 0.67849 | 0.62534 |
| Cₐ(C_{c})C_{d}—NₑCₑ | −16.21952 | | 91.32 | 88.68 | 43.14 | 1.33135 | 0.01939 |
| Cₐ(C_{c})C_{d}—NₑCₑ | −16.99103 | −16.80017 | 87.71 | 92.29 | 40.72 | 1.38280 | 0.03206 |

[symbol]

indicates data missing or illegible when filed

TABLE 18
The energy parameters (eV) of functional groups of adenine.

| | C^{3e}═C | CH (i) | C^{3e}═N | C—N (a) | NH₂ |
|---|---|---|---|---|---|
| Parameters | Group | Group | Group | Group | Group |
| f₁ | 0.75 | 1 | 0.75 | 1 | 1 |
| n₁ | 2 | 1 | 2 | 1 | 2 |
| n₂ | 0 | 0 | 0 | 0 | 0 |
| n₃ | 0 | 0 | 0 | 0 | 1 |
| C₁ | 0.5 | 0.75 | 0.5 | 0.5 | 0.75 |
| C₂ | 0.85252 | 1 | 0.91140 | 1 | 0.93613 |
| c₁ | 1 | 1 | 1 | 1 | 0.75 |
| c₂ | 0.85252 | 0.91771 | 0.91140 | 0.84665 | 0.92171 |
| c₃ | 0 | 1 | 0 | 0 | 0 |
| c₄ | 3 | 1 | 3 | 2 | 1 |
| c₅ | 0 | 1 | 0 | 0 | 2 |
| C₁ₒ | 0.5 | 0.75 | 0.5 | 0.5 | 1.5 |
| C₂ₒ | 0.85252 | 1 | 0.91140 | 1 | 1 |
| Vₑ (eV) | −101.12679 | −37.10024 | −102.01431 | −35.50149 | −78.97795 |
| Vₚ (eV) | 20.69825 | 13.17125 | 21.41410 | 10.72181 | 28.90735 |
| T (eV) | 34.31559 | 11.58941 | 34.65890 | 11.02312 | 31.73641 |
| Vₘ (eV) | −17.15779 | −5.79470 | −17.32945 | −5.51156 | −15.86820 |
| E (AO/HO) (eV) | 0 | −14.63489 | 0 | −14.63489 | −14.53414 |
| ΔE_{H}₂MO (AO/HO) (eV) | 0 | −1.13379 | 0 | −2.26759 | 0 |
| E_{T} (AO/HO) (eV) | 0 | −13.50110 | 0 | −12.36730 | −14.53414 |
| E (n₃ AO/HO) (eV) | 0 | 0 | 0 | 0 | −14.53414 |
| E_{T} (H₂MO) (eV) | −63.27075 | −31.63539 | −63.27076 | −31.63543 | −48.73654 |
| E_{T} (atom-atom, msp³.AO) (eV) | −2.26759 | −0.56690 | −1.44915 | −1.13379 | 0 |
| E_{T} (MO) (eV) | −65.53833 | −32.20226 | −64.71988 | −32.76916 | −48.73660 |
| ω (10¹⁵ rad/s) | 49.7272 | 26.4826 | 43.6311 | 14.3055 | 68.9812 |
| E_{K} (eV) | 32.73133 | 17.43132 | 28.71875 | 9.41610 | 45.40465 |
| Ē_{D} (eV) | −0.35806 | −0.26130 | −0.33540 | −0.19893 | −0.42172 |
| Ē_{Kvib} (eV) | 0.19649 [49] | 0.35532 | 0.19649 [49] | 0.15498 [57] | 0.40929 [22] |
| | | Eq. (13.458) | | | |
| Ē_{osc} (eV) | −0.25982 | −0.08364 | −0.23715 | −0.12144 | −0.21708 |
| E_{mag} (eV) | 0.14803 | 0.14803 | 0.09457 | 0.14803 | 0.14803 |
| E_{T} (Group) (eV) | −49.54347 | −32.28590 | −48.82472 | −32.89060 | −49.17075 |
| Eᵢₙᵢₜᵢₐₗ (c₄ AO/HO) (eV) | −14.63489 | −14.63489 | −14.63489 | −14.63489 | −14.53414 |
| Eᵢₙᵢₜᵢₐₗ (c₅ AO/HO) (eV) | 0 | −13.59844 | 0 | 0 | −13.59844 |
| E_{D} (Group) (eV) | 5.63881 | 3.90454 | 4.92005 | 3.62082 | 7.43973 |
| | N═C | C—N (b) | NH | CH (ii) | C—N—C |
| Parameters | Group | Group | Group | Group | Group |
| f₁ | 1 | 1 | 1 | 1 | 1 |
| n₁ | 2 | 1 | 1 | 1 | 2 |
| n₂ | 0 | 0 | 0 | 0 | 0 |
| n₃ | 0 | 0 | 0 | 0 | 0 |
| C₁ | 0.5 | 0.5 | 0.75 | 0.75 | 0.5 |
| C₂ | 0.85252 | 1 | 0.93613 | 1 | 0.85252 |
| c₁ | 1 | 1 | 0.75 | 1 | 1 |
| c₂ | 0.84665 | 0.84665 | 0.92171 | 0.91771 | 0.84665 |
| c₃ | 0 | 0 | 1 | 1 | 0 |
| c₄ | 4 | 2 | 1 | 1 | 4 |
| c₅ | 0 | 0 | 1 | 1 | 0 |
| C₁ₒ | 0.5 | 0.5 | 0.75 | 0.75 | 0.5 |
| C₂ₒ | 0.85252 | 1 | 1 | 1 | 0.85252 |
| Vₑ (eV) | −103.92756 | −32.44864 | −39.48897 | −39.09538 | −104.73877 |
| Vₚ (eV) | 20.87050 | 10.07285 | 14.45367 | 13.45505 | 20.90891 |
| T (eV) | 35.85539 | 8.89248 | 15.86820 | 12.74462 | 36.26840 |
| Vₘ (eV) | −17.92770 | −4.44624 | −7.93410 | −6.37231 | −18.13420 |
| E (AO/HO) (eV) | 0 | −14.63489 | −14.53414 | −14.63489 | 0 |
| ΔE_{H}₂MO (AO/HO) (eV) | −1.85836 | −0.92918 | 0 | −2.26758 | −2.42526 |
| E_{T} (AO/HO) (eV) | 1.85836 | −13.70571 | −14.53414 | −12.36731 | 2.42526 |
| E (n₃ (AO/HO) (eV) | 0 | 0 | 0 | 0 | 0 |
| E_{T} (H₂MO) (eV) | −63.27100 | −31.63527 | −31.63534 | −31.63533 | −63.27040 |
| E_{T} (atom-atom, msp³.AO) (eV) | −1.85836 | −0.92918 | 0 | 0 | −2.42526 |
| E_{T} (MO) (eV) | −65.12910 | −32.56455 | −31.63537 | −31.63537 | −65.69600 |
| ω (10¹⁵ rad/s) | 15.4704 | 21.5213 | 48.7771 | 28.9084 | 54.5632 |
| E_{K} (eV) | 10.18290 | 14.16571 | 32.10594 | 19.02803 | 35.91442 |
| Ē_{D} (eV) | −0.20558 | −0.24248 | −0.35462 | −0.27301 | −0.38945 |
| Ē_{Kvib} (eV) | 0.20768 [61] | 0.12944 [23] | 0.40696 [24] | 0.39427 [59] | 0.11159 [12] |
| Ē_{osc} (eV) | −0.10174 | −0.17775 | −0.15115 | −0.07587 | −0.33365 |
| E_{mag} (eV) | 0.14803 | 0.14803 | 0.14803 | 0.14803 | 0.14803 |
| E_{T} (Group) (eV) | −65.33259 | −32.74230 | −31.78651 | −31.71124 | −66.36330 |
| Eᵢₙᵢₜᵢₐₗ (c₄ AO/HO) (eV) | −14.63489 | −14.63489 | −14.53414 | −14.63489 | −14.63489 |
| Eᵢₙᵢₜᵢₐₗ (c₅ AO/HO) (eV) | 0 | 0 | −13.59844 | −13.59844 | 0 |
| E_{D} (Group) (eV) | 6.79303 | 3.47253 | 3.51208 | 3.32988 | 7.82374 |

TABLE 19
The total bond energies of adenine calculated using the functional group
composition and the energies of Table 18 compared to the experimental values [3].

| | | | | C^{3e}═N | C—N (a) | NH₂ | | |
|---|---|---|---|---|---|---|---|---|
| Formula | Name | C^{3e}═C | CH (i) | Group | Group | Group | N═C | C—N (b) |
| C₅H₅N₅ | Adenine | 2 | 1 | 4 | 1 | 1 | 1 | 1 |

| | | | | | Calculated | Experimental | |
|---|---|---|---|---|---|---|---|
| | | | | | Total Bond | Total Bond | |
| Formula | Name | NH | CH (ii) | C—N—C | Energy (eV) | Energy (eV) | Relative Error |
| C₅H₅N₅ | Adenine | 1 | 1 | 1 | 70.85416 | 70.79811 | −0.00079 |

TABLE 20
The bond angle parameters of adenine and experimental values [65]. In the calculation of θᵥ, the
parameters from the preceding angle were used. E_{T} is E_{T} (atom-atom, msp³.AO).

| | | | 2c′ | | Atom 1 | | Atom 2 | | |
|---|---|---|---|---|---|---|---|---|---|
| | 2c′ | 2c′ | Terminal | | Hybridization | | Hybridization | | |
| Atoms of | Bond 1 | Bond 2 | Atoms | E_{Coulombic} | Designation | E_{Coulombic} | Designation | c₂ | c₂ |
| Angle | (a₀) | (a₀) | (a₀) | Atom 1 | (Table 8) | Atom 2 | (Table 8) | Atom 1 | Atom 2 |
| ∠HNH | 1.88268 | 1.88268 | 3.1559 | −14.53414 | N | H | H | 0.93613 | 1 |
| | | | | | | | | Eq. | |
| | | | | | | | | (13.248) | |
| ∠CₐNH | 2.53797 | 1.88268 | 3.8123 | −16.78642 | 19 | −14.53414 | N | 0.81052 | 0.77638 |
| | | | | | | | | Eq. | Eq. |
| | | | | | | | | (15.71) | (15.173) |
| ∠N_{b}C_{b}N_{c} | 2.54147 | 2.54147 | 4.5826 | −15.55033 | 3 | −15.55033 | 3 | 0.87495 | 0.87495 |
| ∠H_{b}C_{b}N_{b} | | | | | | | | | |
| ∠H_{b}C_{b}N_{c} | | | | | | | | | |
| ∠HₑCₑNₑ | 2.02241 | 2.60766 | 4.0661 | −16.36125 | 12 | −14.53414 | N | 0.83159 | 0.84665 |
| | | | | | | | | | Eq. |
| | | | | | | | | | (15.171) |
| ∠NₑCₑN_{d} | 2.60766 | 2.60287 | 4.3359 | −16.21952 | 9 | −16.03838 | 7 | 0.83885 | 0.84833 |
| ∠N_{c}C_{c}N_{d} | 2.54147 | 2.60287 | 4.6260 | −14.53414 | N | −14.53414 | N | 0.91140 | 0.84665 |
| | | | | | | | | Eq. | Eq. |
| | | | | | | | | (15.135) | (15.171) |
| ∠HₑCₑN_{d} | | | | | | | | | |
| ∠H_{d}N_{d}Cₑ | 1.88268 | 2.60287 | 4.0166 | −14.53414 | N | −15.95955 | 6 | 0.84665 | 0.85252 |
| | | | | | | | | Eq. | Eq. |
| | | | | | | | | (15.171) | (15.162) |
| ∠C_{c}N_{d}Cₑ | 2.60287 | 2.60287 | 4.1952 | −17.95963 | 39 | −17.95963 | 39 | 0.75758 | 0.75758 |
| ∠H_{d}N_{d}C_{c} | | | | | | | | | |
| ∠NₐCₐC_{d} | 2.53797 | 2.62936 | 4.5387 | −14.53414 | N | −16.52644 | 15 | 0.91140 | 0.82327 |
| | | | | | | C_{d} | | Eq. | |
| | | | | | | | | (15.135) | |
| ∠N_{b}CₐC_{d} | 2.54147 | 2.62936 | 4.4272 | −14.53414 | N | −16.99103 | 21 | 0.91140 | 0.80076 |
| | | | | | | C_{d} | | Eq. | |
| | | | | | | | | (15.135) | |
| ∠N_{b}CₐNₐ | | | | | | | | | |
| ∠NₑC_{d}C_{c} | 2.70148 | 2.62936 | 4.3818 | −14.53414 | N | −15.95955 | 6 | 0.84665 | 0.85252 |
| | | | | | | C_{c} | | Eq. | |
| | | | | | | | | (15.171) | |
| ∠N_{d}C_{c}C_{d} | 2.60287 | 2.62936 | 4.1952 | −14.53414 | N | −16.99103 | 21 | 0.84665 | 0.80076 |
| | | | | | | C_{d} | | Eq. | |
| | | | | | | | | (15.171) | |
| ∠N_{c}C_{c}C_{d} | 2.54147 | 2.62936 | 4.6043 | −14.53414 | N | −16.52644 | 15 | 0.84665 | 0.82327 |
| | | | | | | C_{d} | | Eq. | |
| | | | | | | | | (15.171) | |
| ∠NₑC_{d}Cₐ | 2.70148 | 2.62936 | 4.8580 | −14.53414 | N | −16.78642 | 1 | 0.91140 | 0.81052 |
| | | | | | | Cₐ | | Eq. | |
| | | | | | | | | (15.135) | |
| ∠C_{d}NₑCₑ | 2.70148 | 2.60766 | 4.2661 | −17.92022 | 37 | −17.92022 | 37 | 0.75924 | 0.75924 |
| ∠C_{b}N_{c}C_{c} | 2.54147 | 2.54147 | 4.1952 | −17.95963 | 39 | −17.95963 | 39 | 0.75758 | 0.75758 |
| ∠CₐN_{b}C_{b} | 2.54147 | 2.54147 | 4.3704 | −17.71560 | 33 | −17.40869 | 30 | 0.76801 | 0.78155 |
| ∠CₐC_{d}C_{c} | 2.62936 | 2.62936 | 4.4721 | −17.71560 | 33 | −17.14871 | 26 | 0.76801 | 0.79340 |

| Atoms of | | | | | E_{T} | θᵥ | θ₁ | θ₂ | Cal. θ | Exp. θ |
|---|---|---|---|---|---|---|---|---|---|---|
| Angle | C₁ | C₂ | c₁ | c₂′ | (eV) | (°) | (°) | (°) | (°) | (°) |
| ∠HNH | 1 | 1 | 0.75 | 1.06823 | 0 | | | | 113.89 | 113.9 [1] |
| | | | | | | | | | | (aniline) |
| ∠CₐNH | 0.75 | 1 | 0.75 | 0.95787 | 0 | | | | 118.42 | 118 |
| ∠N_{b}C_{b}N_{c} | 1 | 1 | 1 | 0.87495 | −1.44915 | | | | 128.73 | 128.9 |
| ∠H_{b}C_{b}N_{b} | | | | | | | | 128.73 | 115.64 | 115 |
| ∠H_{b}C_{b}N_{c} | | | | | | | | | Eq. | 116 |
| | | | | | | | | | (15.109) | |
| ∠HₑCₑNₑ | 0.75 | 1 | 0.75 | 1.01811 | 0 | | | | 122.35 | 126 |
| ∠NₑCₑN_{d} | 1 | 1 | 1 | 0.84359 | −1.44915 | | | | 112.64 | 114.4 |
| ∠N_{c}C_{c}N_{d} | 1 | 1 | 1 | 0.87902 | −1.44915 | | | | 128.11 | 127.8 |
| ∠HₑCₑN_{d} | | | | | | | 122.35 | 112.64 | 125.02 | 119 |
| ∠H_{d}N_{d}Cₑ | 0.75 | 1 | 0.75 | 1.00693 | 0 | | | | 126.39 | 127 |
| ∠C_{c}N_{d}Cₑ | 1 | 1 | 1 | 0.75758 | −1.85836 | | | | 107.39 | 106.1 |
| ∠H_{d}N_{d}C_{c} | | | | | | | 126.39 | 107.39 | 126.22 | 127 |
| ∠NₐCₐC_{d} | 1 | 1 | 1 | 0.86734 | −1.44915 | | | | 122.88 | 122.1 |
| ∠N_{b}CₐC_{d} | 1 | 1 | 1 | 0.85608 | −1.44915 | | | | 117.77 | 118.2 |
| ∠N_{b}CₐNₐ | | | | | | | 122.88 | 117.77 | 119.35 | 119.4 |
| ∠NₑC_{d}C_{c} | 1 | 1 | 1 | 0.84958 | −1.44915 | | | | 110.56 | 110.4 |
| ∠N_{d}C_{c}C_{d} | 1 | 1 | 1 | 0.82371 | −1.44915 | | | | 106.60 | 105.9 |
| ∠N_{c}C_{c}C_{d} | 1 | 1 | 1 | 0.83496 | −1.65376 | | | | 125.85 | 126.4 |
| ∠NₑC_{d}Cₐ | 1 | 1 | 1 | 0.86096 | −1.65376 | | | | 131.37 | 132.8 |
| ∠C_{d}NₑCₑ | 1 | 1 | 1 | 0.75924 | −1.85836 | | | | 106.93 | 103.3 |
| ∠C_{b}N_{c}C_{c} | 1 | 1 | 1 | 0.75758 | −1.85836 | | | | 111.25 | 111.3 |
| ∠CₐN_{b}C_{b} | 1 | 1 | 1 | 0.77478 | −1.85836 | | | | 118.59 | 118.6 |
| ∠CₐC_{d}C_{c} | 1 | 1 | 1 | 0.78071 | −1.85836 | | | | 116.52 | 116.7 |

Thymine

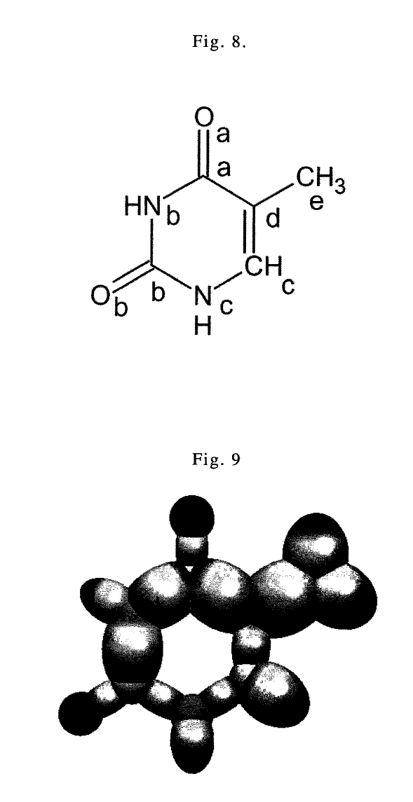

Thymine having the formula C₅H₆N₂O₂ is a pyrimidine with carbonyl substitutions at positions Cₐ and C_{b} and a methyl substitution at position C_{d} further comprising a vinyl group as shown in FIG. 8. Each C═O, adjacent C—N, and NH functional group is equivalent to the corresponding group of alkyl amides. The methyl-vinyl moiety is equivalent to the CH₃, —C(C)═C, CH, and C═C functional groups of alkenes. Thymine further comprises N_{b}H and C_{b}—N_{c}—C_{c} groups that are equivalent to the corresponding groups of imidazole as given in the corresponding section. The Cₐ—C_{d} bond comprises another functional group that is equivalent to the Cₐ—C_{d} group of guanine.

The symbols of the functional groups of thymine are given in Table 21. The geometrical (Eqs. (15.1-15.5) and (15.51)), intercept (Eqs. (15.80-15.87)), and energy (Eqs. (15.6-15.11) and (15.17-15.65)) parameters of thymine are given in Tables 22, 23, and 24, respectively. The total energy of thymine given in Table 25 was calculated as the sum over the integer multiple of each E_{D}(Group) of Table 24 corresponding to functional-group composition of the molecule. The bond angle parameters of thymine determined using Eqs. (15.88-15.117) are given in Table 26. The color scale, charge-density of thymine comprising atoms with the outer shell bridged by one or more H₂-type ellipsoidal MOs or joined with one or more hydrogen MOs is shown in FIG. 9.

TABLE 21
The symbols of functional groups of thymine.

| Functional Group | Group Symbol |
|---|---|
| Cₐ═O C_{b}═O (alkyl amide) | C═O |
| Cₐ—N_{b} C_{b}—N_{b} amide | C—N |
| N_{b}H amide group | NH (i) |
| CH₃ group | C—H (CH₃) |
| C_{c}═C_{d} double bond | C═C |
| C_{d}—Cₑ | C—C (i) |
| Cₐ—C_{d} | C—C (ii) |
| C_{b}—N_{c}—C_{c} | C—N—C |
| N_{c}H group | NH (ii) |
| C_{c}H | CH |

TABLE 22
The geometrical bond parameters of thymine and experimental values [1].

| | C═O | C—N | NH (i) | C—H (CH₃) | C═C |
|---|---|---|---|---|---|
| Parameter | Group | Group | Group | Group | Group |
| a (a₀) | 1.29907 | 1.75370 | 1.28620 | 1.64920 | 1.47228 |
| c′ (a₀) | 1.13977 | 1.32427 | 0.95706 | 1.04856 | 1.26661 |
| Bond Length 2c′ (Å) | 1.20628 | 1.40155 | 1.01291 | 1.10974 | 1.34052 |
| Exp. Bond Length | 1.220 | 1.380 | | 1.107 | 1.34 [64] |
| (Å) | (acetamide) | (acetamide) | | (C—H propane) | (thymine) |
| | 1.225 | | | 1.117 | 1.342 |
| | (N-methylacetamide) | | | (C—H butane) | (2-methylpropene) |
| | | | | | 1.346 |
| | | | | | (2-butene) |
| | | | | | 1.349 |
| | | | | | (1,3-butadiene) |
| b, c (a₀) | 0.62331 | 1.14968 | 0.85927 | 1.27295 | 0.75055 |
| e | 0.87737 | 0.75513 | 0.74410 | 0.63580 | 0.86030 |

| | C—C (i) | C—C (ii) | C—N—C | NH (ii) | CH |
|---|---|---|---|---|---|
| Parameter | Group | Group | Group | Group | Group |
| a (a₀) | 2.04740 | 1.88599 | 1.43222 | 1.24428 | 1.53380 |
| c′ (a₀) | 1.43087 | 1.37331 | 1.29614 | 0.94134 | 1.01120 |
| Bond Length 2c′ (Å) | 1.51437 | 1.45345 | 1.37178 | 0.996270 | 1.07021 |
| Exp. Bond Length | | 1.43 [64] | 1.370 | 0.996 | 1.076 |
| (Å) | | (thymine) | (pyrrole) | (pyrrole) | (pyrrole) |
| b, c (a₀) | 1.46439 | 1.29266 | 0.60931 | 0.81370 | 1.15326 |
| e | 0.69887 | 0.72817 | 0.90499 | 0.75653 | 0.65928 |

TABLE 23
The MO to HO intercept geometrical bond parameters of thymine. R₁ is an alkyl group
and R, R′, R″ are H or alkyl groups. E_{T} is E_{T}(atom - atom, msp³.AO).

| | | | | | | Final Total | | |
|---|---|---|---|---|---|---|---|---|
| | | E_{T} | E_{T} | E_{T} | E_{T} | Energy | | |
| | | (eV) | (eV) | (eV) | (eV) | C2sp³ | rᵢₙᵢₜᵢₐₗ | r_{final} |
| Bond | Atom | Bond 1 | Bond 2 | Bond 3 | Bond 4 | (eV) | (a₀) | (a₀) |
| N_{b}(C_{d})Cₐ═O | Oₐ | −1.34946 | 0 | 0 | 0 | | 1.00000 | 0.84115 |
| N_{b}(C_{d})Cₐ═O | Cₐ | −1.34946 | −0.82688 | 0 | 0 | −153.79203 | 0.91771 | 0.80024 |
| N—H (N_{b}H) | N_{b} | −0.82688 | −0.82688 | 0 | 0 | | 0.93084 | 0.82562 |
| C_{d}(O)Cₐ—N_{b}H(C_{b}) | N_{b} | −0.82688 | −0.82688 | 0 | 0 | | 0.93084 | 0.82562 |
| C_{d}(O)Cₐ—N_{b}H(C_{b}) | Cₐ | −0.82688 | −1.34946 | 0 | 0 | −153.79203 | 0.91771 | 0.80024 |
| CₐN_{b}H—C_{b}(O)N_{c}H | N_{b} | −0.82688 | −0.82688 | 0 | 0 | | 0.93084 | 0.82562 |
| CₐN_{b}H—C_{b}(O)N_{c}H | C_{b} | −0.82688 | −1.34946 | −0.82688 | 0 | −154.61891 | 0.91771 | 0.76313 |
| (HN_{c})(HN_{b})C_{b}═O | O_{b} | −1.34946 | 0 | 0 | 0 | | 1.00000 | 0.84115 |
| (HN_{c})(HN_{b})C_{b}═O | C_{b} | −1.34946 | −0.82688 | −0.92918 | 0 | −154.72121 | 0.91771 | 0.75878 |
| N—H (N_{c}H) | N_{c} | −0.92918 | −0.92918 | 0 | 0 | | 0.93084 | 0.81549 |
| N_{b}(O)C_{b}—N_{c}HC_{c} | N_{c} | −0.92918 | −0.92918 | 0 | 0 | | 0.93084 | 0.81549 |
| N_{b}(O)C_{b}—N_{c}HC_{c} | C_{b} | −0.92918 | −1.34946 | −0.82688 | 0 | −154.72121 | 0.91771 | 0.75878 |
| C_{b}HN_{c}—HC_{c}C_{d} | N_{c} | −0.92918 | −0.92918 | 0 | 0 | | 0.93084 | 0.81549 |
| C_{b}HN_{c}—HC_{c}C_{d} | C_{c} | −0.92918 | −1.13379 | 0 | 0 | −153.67866 | 0.91771 | 0.80561 |
| C—H (C_{c}H) | C_{c} | −1.13380 | −0.92918 | 0 | 0 | −153.67867 | 0.91771 | 0.80561 |
| N_{c}HC_{c}═C_{d}Cₐ(Cₑ) | C_{c} | −1.13380 | −0.92918 | −0.72457 | 0 | −154.40324 | 0.91771 | 0.77247 |
| N_{c}HC_{c}═C_{d}Cₐ(Cₑ) | C_{d} | −1.13380 | 0 | −0.72457 | 0 | −153.47406 | 0.91771 | 0.81549 |
| C—H (CH₃) | Cₑ | −0.72457 | 0 | 0 | 0 | −152.34026 | 0.91771 | 0.87495 |
| (Cₐ)C_{c}C_{d}—CₑH₃ | Cₑ | −0.72457 | 0 | 0 | 0 | −152.34026 | 0.91771 | 0.87495 |
| (Cₐ)C_{c}C_{d}—CₑH₃ | C_{d} | −0.72457 | −1.13379 | 0 | 0 | −153.47406 | 0.91771 | 0.81549 |
| (Cₑ)C_{c}C_{d}—Cₐ(O)N_{b} | Cₐ | 0 | −1.34946 | −0.82688 | 0 | −153.79203 | 0.91771 | 0.80024 |
| (Cₑ)C_{c}C_{d}—Cₐ(O)N_{b} | C_{d} | 0 | −1.13379 | −0.72457 | 0 | −153.47406 | 0.91771 | 0.81549 |

| | E_{Coulomb}(C2sp [symbol] | E(C2sp³) | | | | | |
|---|---|---|---|---|---|---|---|
| | (eV) | (eV) | θ′ | θ₁ | θ₂ | d₁ | d₂ |
| Bond | Final | Final | (°) | (°) | (°) | (a₀) | (a₀) |
| N_{b}(C_{d})Cₐ═O | −16.17521 | | 137.27 | 42.73 | 66.31 | 0.52193 | 0.61784 |
| N_{b}(C_{d})Cₐ═O | −17.00209 | −16.81123 | 135.55 | 44.45 | 64.05 | 0.56855 | 0.57122 |
| N—H (N_{b}H) | −16.47951 | | 118.03 | 61.97 | 63.59 | 0.55339 | 0.38795 |
| C_{d}(O)Cₐ—N_{b}H(C_{b}) | −16.47951 | | 96.62 | 83.38 | 45.51 | 1.22903 | 0.09524 |
| C_{d}(O)Cₐ—N_{b}H(C_{b}) | −17.00209 | −16.81123 | 94.42 | 85.58 | 43.95 | 1.26264 | 0.06164 |
| CₐN_{b}H—C_{b}(O)N_{c}H | −16.47951 | | 96.62 | 83.38 | 45.51 | 1.22903 | 0.09524 |
| CₐN_{b}H—C_{b}(O)N_{c}H | −17.82897 | −17.63811 | 90.94 | 89.06 | 41.58 | 1.31179 | 0.01249 |
| (HN_{c})(HN_{b})C_{b}═O | −16.17521 | | 137.27 | 42.73 | 66.31 | 0.52193 | 0.61784 |
| (HN_{c})(HN_{b})C_{b}═O | −17.93127 | −17.74041 | 133.67 | 46.33 | 61.70 | 0.61582 | 0.52395 |
| N—H (N_{c}H) | −16.68411 | | 117.34 | 62.66 | 62.90 | 0.56678 | 0.37456 |
| N_{b}(O)C_{b}—N_{c}HC_{c} | −16.68411 | | 138.92 | 41.08 | 61.59 | 0.68147 | 0.61467 |
| N_{b}(O)C_{b}—N_{c}HC_{c} | −17.93127 | −17.74041 | 136.68 | 43.32 | 58.70 | 0.74414 | 0.55200 |
| C_{b}HN_{c}—HC_{c}C_{d} | −16.68411 | | 138.92 | 41.08 | 61.59 | 0.68147 | 0.61467 |
| C_{b}HN_{c}—HC_{c}C_{d} | −16.88873 | −16.69786 | 138.54 | 41.46 | 61.09 | 0.69238 | 0.60376 |
| C—H (C_{c}H) | −16.88873 | −16.69786 | 83.35 | 96.65 | 43.94 | 1.10452 | 0.09331 |
| N_{c}HC_{c}═C_{d}Cₐ(Cₑ) | −17.61330 | −17.42244 | 125.92 | 54.08 | 56.46 | 0.81345 | 0.45316 |
| N_{c}HC_{c}═C_{d}Cₐ(Cₑ) | −16.68412 | −16.49326 | 128.10 | 51.90 | 58.77 | 0.76344 | 0.50317 |
| C—H (CH₃) | −15.55033 | −15.35946 | 78.85 | 101.15 | 42.40 | 1.21777 | 0.16921 |
| (Cₐ)C_{c}C_{d}—CₑH₃ | −15.55033 | −15.35946 | 73.62 | 106.38 | 34.98 | 1.67762 | 0.24675 |
| (Cₐ)C_{c}C_{d}—CₑH₃ | −16.68412 | −16.49325 | 65.99 | 114.01 | 30.58 | 1.76270 | 0.33183 |
| (Cₑ)C_{c}C_{d}—Cₐ(O)N_{b} | −17.00209 | −16.81123 | 81.54 | 98.46 | 37.76 | 1.49107 | 0.11776 |
| (Cₑ)C_{c}C_{d}—Cₐ(O)N_{b} | −16.68412 | −16.49325 | 92.72 | 87.28 | 45.17 | 1.32975 | 0.04357 |

[symbol]

indicates data missing or illegible when filed

TABLE 24
The energy parameters (eV) of functional groups of thymine.

| | C═O | C—N | NH (i) | C═C | CH₃ |
|---|---|---|---|---|---|
| Parameters | Group | Group | Group | Group | Group |
| n₁ | 2 | 1 | 1 | 2 | 3 |
| n₂ | 0 | 0 | 0 | 0 | 2 |
| n₃ | 0 | 0 | 0 | 0 | 0 |
| C₁ | 0.5 | 0.5 | 0.75 | 0.5 | 0.75 |
| C₂ | 1 | 1 | 0.93613 | 0.91771 | 1 |
| c₁ | 1 | 1 | 0.75 | 1 | 1 |
| c₂ | 0.85395 | 0.91140 | 1 | 0.91771 | 0.91771 |
| c₃ | 2 | 0 | 1 | 0 | 0 |
| c₄ | 4 | 2 | 1 | 4 | 1 |
| c₅ | 0 | 0 | 1 | 0 | 3 |
| C₁ₒ | 0.5 | 0.5 | 0.75 | 0.5 | 0.75 |
| C₂ₒ | 1 | 1 | 1 | 0.91771 | 1 |
| Vₑ (eV) | −111.25473 | −36.88558 | −40.92593 | −102.08992 | −107.32728 |
| Vₚ (eV) | 23.87467 | 10.27417 | 14.21618 | 21.48386 | 38.92728 |
| T (eV) | 42.82081 | 10.51650 | 15.90963 | 34.67062 | 32.53914 |
| Vₘ (eV) | −21.41040 | −5.25825 | −7.95482 | −17.33531 | −16.26957 |
| E(AO/HO) (eV) | 0 | −14.63489 | −14.53414 | 0 | −15.56407 |
| ΔE_{H}_{₂}_{MO} (AO/HO) (eV) | −2.69893 | −4.35268 | −1.65376 | 0 | 0 |
| E_{T}(AO/HO) (eV) | 2.69893 | −10.28221 | −12.88038 | 0 | −15.56407 |
| E(n₃ AO/HO) (eV) | 0 | 0 | 0 | 0 | 0 |
| E_{T}(H₂MO) (eV) | −63.27074 | −31.63537 | −31.63531 | −63.27075 | −67.69451 |
| E_{T}(atom - atom, msp³.AO) (eV) | −2.69893 | −1.65376 | 0 | −2.26759 | 0 |
| E_{T}(MO) (eV) | −65.96966 | −33.28912 | −31.63537 | −65.53833 | −67.69450 |
| ω(10¹⁵ rad/s) | 59.4034 | 12.5874 | 44.9494 | 43.0680 | 24.9286 |
| E_{K} (eV) | 39.10034 | 8.28526 | 29.58649 | 28.34813 | 16.40846 |
| Ē_{D} (eV) | −0.40804 | −0.18957 | −0.34043 | −0.34517 | −0.25352 |
| Ē_{Kvib} (eV) | 0.21077 [12] | 0.17358 [33] | 0.40696 [24] | 0.17897 [6] | 0.35532 |
| | | | | | Eq. (13.458) |
| Ē_{osc} (eV) | −0.30266 | −0.10278 | −0.13695 | −0.25568 | −0.22757 |
| E_{mag} (eV) | 0.11441 | 0.14803 | 0.14185 | 0.14803 | 0.14803 |
| E_{T}(Group) (eV) | −66.57498 | −33.39190 | −31.77232 | −66.04969 | −67.92207 |
| Eᵢₙᵢₜᵢₐₗ(c₄AO/HO) (eV) | −14.63489 | −14.63489 | −14.53414 | −14.63489 | −14.63489 |
| Eᵢₙᵢₜᵢₐₗ(c₅AO/HO) (eV) | 0 | 0 | −13.59844 | 0 | −13.59844 |
| E_{D}(Group) (eV) | 7.80660 | 4.12212 | 3.49788 | 7.51014 | 12.49186 |
| | C—C (i) | C—C (ii) | C—N—C | NH (ii) | CH |
| Parameters | Group | Group | Group | Group | Group |
| n₁ | 1 | 1 | 2 | 1 | 1 |
| n₂ | 0 | 0 | 0 | 0 | 0 |
| n₃ | 0 | 0 | 0 | 0 | 0 |
| C₁ | 0.5 | 0.5 | 0.5 | 0.75 | 0.75 |
| C₂ | 1 | 1 | 0.85252 | 0.93613 | 1 |
| c₁ | 1 | 1 | 1 | 0.75 | 1 |
| c₂ | 0.91771 | 0.91771 | 0.84665 | 0.92171 | 0.91771 |
| c₃ | 1 | 0 | 0 | 1 | 1 |
| c₄ | 2 | 2 | 4 | 1 | 1 |
| c₅ | 0 | 0 | 0 | 1 | 1 |
| C₁ₒ | 0.5 | 0.5 | 0.5 | 0.75 | 0.75 |
| C₂ₒ | 1 | 1 | 0.85252 | 1 | 1 |
| Vₑ (eV) | −30.19634 | −33.63376 | −106.58684 | −39.48897 | −39.09538 |
| Vₚ (eV) | 9.50874 | 9.90728 | 20.99432 | 14.45367 | 13.45505 |
| T (eV) | 7.37432 | 8.91674 | 37.21047 | 15.86820 | 12.74462 |
| Vₘ (eV) | −3.68716 | −4.45837 | −18.60523 | −7.93410 | −6.37231 |
| E(AO/HO) (eV) | −14.63489 | −14.63489 | 0 | −14.53414 | −14.63489 |
| ΔE_{H}_{₂}_{MO}(AO/HO) (eV) | 0 | −2.26759 | −3.71673 | 0 | −2.26758 |
| E_{T}(AO/HO) (eV) | −14.63489 | −12.36730 | 3.71673 | −14.53414 | −12.36731 |
| E(n₃ AO/HO) (eV) | 0 | 0 | 0 | 0 | 0 |
| E_{T}(H₂MO) (eV) | −31.63534 | −31.63541 | −63.27056 | −31.63534 | −31.63533 |
| E_{T}(atom-atom,msp³ · AO) (eV) | −1.44915 | 0.00000 | −3.71673 | 0 | 0 |
| E_{T}(MO) (eV) | −33.08452 | −31.63537 | −66.98746 | −31.63537 | −31.63537 |
| ω(10¹⁵ rad/s) | 9.97851 | 19.8904 | 15.7474 | 48.7771 | 28.9084 |
| E_{K} (eV) | 6.56803 | 13.09221 | 10.36521 | 32.10594 | 19.02803 |
| Ē_{D} (eV) | −0.16774 | −0.22646 | −0.21333 | −0.35462 | −0.27301 |
| Ē_{Kvib} (eV) | 0.15895 [7] | 0.14667 [66] | 0.11159 [12] | 0.40696 [24] | 0.39427 [59] |
| Ē_{osc} (eV) | −0.08827 | −0.15312 | −0.15754 | −0.15115 | −0.07587 |
| E_{mag} (eV) | 0.14803 | 0.14803 | 0.14803 | 0.14803 | 0.14803 |
| E_{T}(Group) (eV) | −33.17279 | −31.64046 | −67.30254 | −31.78651 | −31.71124 |
| Eᵢₙᵢₜᵢₐₗ(c₄ AO/HO) (eV) | −14.63489 | −14.63489 | −14.63489 | −14.53414 | −14.63489 |
| Eᵢₙᵢₜᵢₐₗ(c₅ AO/HO) (eV) | 0 | 0 | 0 | −13.59844 | −13.59844 |
| E_{D}(Group) (eV) | 3.75498 | 2.37068 | 8.76298 | 3.51208 | 3.32988 |

TABLE 25
The total gaseous bond energies of thymine calculated using the functional group composition
and the energies of Table 24 compared to the experimental values [3].

| | | C═O | C—N | NH (i) | C═C | CH₃ | C—C (i) | C—C (ii) |
|---|---|---|---|---|---|---|---|---|
| Formula | Name | Group | Group | Group | Group | Group | Group | Group |
| C₅H₆N₂O₂ | Thymine | 2 | 2 | 1 | 1 | 1 | 1 | 1 |

| | | | | | Calculated | Experimental | |
|---|---|---|---|---|---|---|---|
| | | C—N—C | NH (ii) | CH | Total Bond | Total Bond | |
| Formula | Name | Group | Group | Group | Energy (eV) | Energy (eV) | Relative Error |
| C₅H₆N₂O₂ | Thymine | 1 | 1 | 1 | 69.08792 | 69.06438 | −0.00034 |

TABLE 26
The bond angle parameters of thymine and experimental values [64]. In the calculation of θᵥ, the
parameters from the preceding angle were used. E_{T} is E_{T} (atom-atom, msp³.AO).

| | | | 2c′ | | Atom 1 | | Atom 2 | | |
|---|---|---|---|---|---|---|---|---|---|
| | 2c′ | 2c′ | Terminal | | Hybridization | | Hybridization | | |
| Atoms of | Bond 1 | Bond 2 | Atoms | E_{Coulombic} | Designation | E_{Coulombic} | Designation | c₂ | c₂ |
| Angle | (a₀) | (a₀) | (a₀) | Atom 1 | (Table 8) | Atom 2 | (Table 8) | Atom 1 | Atom 2 |
| ∠N_{b}CₐC_{d} | 2.64855 | 2.74663 | 4.5277 | −14.53414 | N | −16.68412 | 18 | 0.91140 | 0.81549 |
| | | | | | | C_{d} | | Eq. (15.135) | |
| ∠N_{b}CₐO | 2.64855 | 2.27954 | 4.2661 | −16.47951 | 14 | −16.17521 | 8 | 0.82562 | 0.84115 |
| ∠OCₐC_{d} | | | | | | | | | |
| ∠C_{b}N_{b}Cₐ | 2.64855 | 2.64855 | 4.6904 | −17.40869 | 30 | −16.58181 | 16 | 0.78155 | 0.82053 |
| ∠N_{b}C_{b}N_{c} | 2.64855 | 2.59228 | 4.4497 | −16.47951 | 14 | −16.68411 | 17 | 0.82562 | 0.81549 |
| ∠H_{b}N_{b}Cₐ | 1.88268 | 2.64855 | 3.9158 | −14.53414 | N | −14.82575 | 1 | 0.93613 | 0.91771 |
| | | | | | | Cₐ | | Eq. (13.248) | |
| ∠C_{b}N_{b}H_{b} | | | | | | | | | |
| ∠C_{b}N_{c}C_{c} | 2.59228 | 2.59228 | 4.4944 | −17.93127 | 38 | −16.88873 | 20 | 0.75878 | 0.80561 |
| ∠N_{c}C_{b}O_{b} | 2.59228 | 2.27954 | 4.2661 | −16.68411 | 18 | −16.17521 | 8 | 0.81549 | 0.84115 |
| ∠N_{b}C_{b}O_{b} | | | | | | | | | |
| ∠N_{c}C_{c}C_{d} | 2.59228 | 2.53321 | 4.5387 | −14.53414 | N | −16.68412 | 18 | 0.84665 | 0.81549 |
| | | | | | | | | Eq. (15.171) | |
| ∠H_{c}N_{c}C_{c} | 1.88268 | 2.59228 | 3.8644 | −14.53414 | N | −16.68412 | 18 | 0.84665 | 0.81549 |
| | | | | | | | | Eq. (15.171) | |
| ∠H_{c}N_{c}C_{b} | | | | | | | | | |
| ∠H_{c}C_{c}C_{d} | 2.02241 | 2.53321 | 3.9833 | −15.95955 | 6 | −15.95955 | 6 | 0.85252 | 0.85252 |
| ∠H_{c}C_{c}N_{c} | | | | | | | | | |
| ∠CₐC_{d}C_{c} | 2.74663 | 2.53321 | 4.5387 | −17.00209 | 22 | −17.61330 | 32 | 0.80024 | 0.77247 |
| ∠CₑC_{d}C_{c} | 2.86175 | 2.53321 | 4.7117 | −16.47951 | 14 | −17.40869 | 30 | 0.82562 | 0.78155 |
| ∠CₑC_{d}Cₐ | | | | | | | | | |
| Methyl | 2.09711 | 2.09711 | 3.4252 | −15.75493 | 4 | H | H | 0.86359 | 1 |
| ∠HCₑH | | | | Cₑ | | | | | |

| Atoms of | | | | | E_{T} | θᵥ | θ₁ | θ₂ | Cal. θ | Exp. θ |
|---|---|---|---|---|---|---|---|---|---|---|
| Angle | C₁ | C₂ | c₁ | c₂′ | (eV) | (°) | (°) | (°) | (°) | (°) |
| ∠N_{b}CₐC_{d} | 1 | 1 | 1 | 0.86345 | −1.44915 | | | | 114.10 | 115.7 |
| ∠N_{b}CₐO | 1 | 1 | 1 | 0.83339 | −1.44915 | | | | 119.73 | 119.5 |
| ∠OCₐC_{d} | | | | | | | 114.10 | 119.73 | 126.17 | 124.8 |
| ∠C_{b}N_{b}Cₐ | 1 | 1 | 1 | 0.80104 | −1.85836 | | | | 124.62 | 126.1 |
| ∠N_{b}C_{b}N_{c} | 1 | 1 | 1 | 0.82056 | −1.65376 | | | | 116.21 | 115.1 |
| ∠H_{b}N_{b}Cₐ | 0.75 | 1 | 0.75 | 0.98033 | 0 | | | | 118.60 | |
| ∠C_{b}N_{b}H_{b} | | | | | | | 124.62 | 118.60 | 116.78 | |
| ∠C_{b}N_{c}C_{c} | 1 | 1 | 1 | 0.78219 | −1.85836 | | | | 120.20 | 120.7 |
| ∠N_{c}C_{b}O_{b} | 1 | 1 | 1 | 0.82832 | −1.44915 | | | | 122.12 | 123.7 |
| ∠N_{b}C_{b}O_{b} | | | | | | | 116.21 | 122.12 | 121.67 | 121.2 |
| ∠N_{c}C_{c}C_{d} | 1 | 1 | 1 | 0.83107 | −1.65376 | | | | 124.63 | 122.9 |
| ∠H_{c}N_{c}C_{c} | 0.75 | 1 | 0.75 | 0.96320 | 0 | | | | 118.58 | |
| ∠H_{c}N_{c}C_{b} | | | | | | | 120.20 | 118.58 | 121.23 | |
| ∠H_{c}C_{c}C_{d} | 0.75 | 1 | 0.75 | 1.00000 | 0 | | | | 121.54 | |
| ∠H_{c}C_{c}N_{c} | | | | | | | 124.63 | 121.54 | 113.84 | |
| ∠CₐC_{d}C_{c} | 1 | 1 | 1 | 0.78636 | −1.85836 | | | | 118.49 | 118.5 |
| ∠CₑC_{d}C_{c} | 1 | 1 | 1 | 0.80359 | −1.85836 | | | | 121.58 | 123.3 |
| ∠CₑC_{d}Cₐ | | | | | | | 118.49 | 121.58 | 119.93 | 118.2 |
| Methyl | 1 | 1 | 0.75 | 1.15796 | 0 | | | | 109.50 | |
| ∠HCₑH | | | | | | | | | | |

Guanine

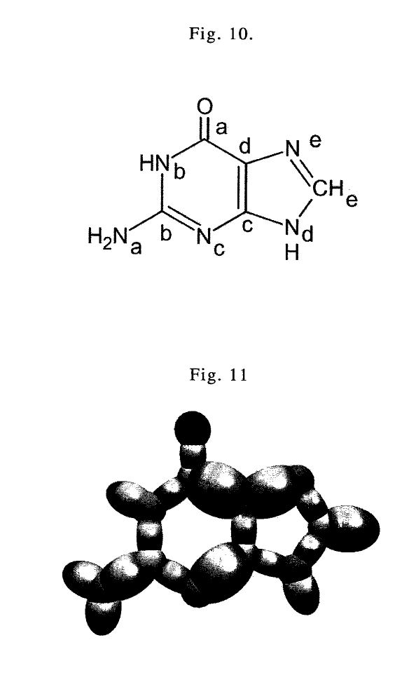

Guanine having the formula C₅H₅N₅O is a purine with a carbonyl substitution at position Cₐ, a primary amine moiety is at position C_{b} as shown in FIG. 10. The carbonyl functional group is equivalent to that of alkyl amides and the NH₂ and C_{b}—Nₐ functional groups of the primary amine moiety are equivalent to the NH₂ and Cₐ-Nₐ functional groups of adenine. Guanine further comprises an imidazole moiety wherein the CH, N_{d}H, C_{d}═C_{c}, C_{d}—Nₑ, Nₑ═Cₑ, and C_{c}—N_{d}—Cₑ groups of the imidazole-type ring are equivalent to the corresponding groups of imidazole as given in the corresponding section. The six-membered ring also comprises the groups Cₐ—N_{b}—C_{b}, N_{b}H, N_{c}═C_{c}, and C_{c}—N_{d} that are equivalent to the corresponding imidazole and adenine functional groups. The Cₐ-C_{d} bond comprises another functional group that is the C₆₀-single-bond functional group except that E_{T}(atom-atom, msp³.AO)═O in order to match the energies of the single and double-bonded moieties within the molecule.

The symbols of the functional groups of guanine are given in Table 27. The geometrical (Eqs. (15.1-15.5) and (15.51)), intercept (Eqs. (15.80-15.87)), and energy (Eqs. (15.6-15.11) and (15.17-15.65)) parameters of guanine are given in Tables 28, 29, and 30, respectively. The total energy of guanine given in Table 31 was calculated as the sum over the integer multiple of each E_{D}(Group) of Table 30 corresponding to functional-group composition of the molecule. The bond angle parameters of guanine determined using Eqs. (15.88-15.117) are given in Table 32. The color scale, charge-density of guanine comprising atoms with the outer shell bridged by one or more H₂-type ellipsoidal MOs or joined with one or more hydrogen MOs is shown in FIG. 11.

TABLE 27
The symbols of functional groups of guanine.

| Functional Group | Group Symbol |
|---|---|
| Cₐ═O (alkyl amide) | C═O |
| C_{b}—Nₐ | C—N (a) |
| NH₂ group | NH₂ |
| C_{c}═C_{d} double bond | C═C |
| Cₐ—C_{d} | C—C |
| Nₑ═Cₑ N_{c}═C_{b} double bond | N═C |
| C_{d}—Nₑ C_{c}—N_{c} | C—N (b) |
| C_{c}—N_{d}—Cₑ Cₐ—N_{b}—C_{b} | C—N—C |
| N_{d}H N_{b}H group | NH |
| CₑH | CH |

TABLE 28
The geometrical bond parameters of guanine and experimental values [1].

| | C═O | C—N (a) | NH₂ | C═C | C—C |
|---|---|---|---|---|---|
| Parameter | Group | Group | Group | Group | Group |
| a (a₀) | 1.29907 | 1.61032 | 1.24428 | 1.45103 | 1.88599 |
| c′ (a₀) | 1.13977 | 1.26898 | 0.94134 | 1.30463 | 1.37331 |
| Bond Length 2c′ (Å) | 1.20628 | 1.34303 | 0.99627 | 1.38076 | 1.45345 |
| Exp. Bond Length | 1.220 | 1.34 [64] | 0.998 | 1.382 | 1.42 [64] |
| (Å) | (acetamide) | (guanine) | (aniline) | (pyrrole) | (guanine) |
| | 1.225 | | | | |
| | (N-methylacetamide) | | | | |
| b, c (a₀) | 0.62331 | 0.99137 | 0.81370 | 0.63517 | 1.29266 |
| e | 0.87737 | 0.78803 | 0.75653 | 0.89910 | 0.72817 |

| | N═C | C—N (b) | C—N—C | NH | CH |
|---|---|---|---|---|---|
| Parameter | Group | Group | Group | Group | Group |
| a (a₀) | 1.44926 | 1.82450 | 1.43222 | 1.24428 | 1.53380 |
| c′ (a₀) | 1.30383 | 1.35074 | 1.29614 | 0.94134 | 1.01120 |
| Bond Length 2c′ (Å) | 1.37991 | 1.42956 | 1.37178 | 0.996270 | 1.07021 |
| Exp. Bond Length | | | 1.370 | 0.996 | 1.076 |
| (Å) | | | (pyrrole) | (pyrrole) | (pyrrole) |
| b, c (a₀) | 0.63276 | 1.22650 | 0.60931 | 0.81370 | 1.15326 |
| e | 0.89965 | 0.74033 | 0.90499 | 0.75653 | 0.65928 |

TABLE 29
The MO to HO intercept geometrical bond parameters of guanine. R₁ is an alkyl group and
R, R′, R″ are H or alkyl groups. E_{T} is E_{T} (atom-atom, msp³.AO).

| | | | | | | Final Total | | |
|---|---|---|---|---|---|---|---|---|
| | | E_{T} | E_{T} | E_{T} | E_{T} | Energy | | |
| | | (eV) | (eV) | (eV) | (eV) | C2sp³ | rᵢₙᵢₜᵢₐₗ | r_{final} |
| Bond | Atom | Bond 1 | Bond 2 | Bond 3 | Bond 4 | (eV) | (a₀) | (a₀) |
| N_{b}(C_{d})Cₐ═O | O | −1.34946 | 0 | 0 | 0 | | 1.00000 | 0.84115 |
| N_{b}(C_{d})Cₐ═O | Cₐ | −1.34946 | −0.92918 | 0 | 0 | −153.89433 | 0.91771 | 0.79546 |
| N—H (N_{b}H) | N_{b} | −0.92918 | −0.92918 | 0 | 0 | | 0.93084 | 0.81549 |
| C_{d}(O)Cₐ—N_{b}H(C_{b}) | N_{b} | −0.92918 | −0.92918 | 0 | 0 | | 0.93084 | 0.81549 |
| C_{d}(O)Cₐ—N_{b}H(C_{b}) | Cₐ | −1.34946 | −0.92918 | 0 | 0 | −153.89433 | 0.91771 | 0.79546 |
| C_{d}(O)CₐN_{b}H—C_{b}N_{c}(NₐH₂) | N_{b} | −0.92918 | −0.92918 | 0 | 0 | | 0.93084 | 0.81549 |
| C_{d}(O)CₐN_{b}H—C_{b}N_{c}(NₐH₂) | C_{b} | −0.56690 | −0.92918 | −0.92918 | 0 | −154.04095 | 0.91771 | 0.78870 |
| N_{c}(N_{b})C_{b}NₐH—H | Nₐ | −0.56690 | 0 | 0 | 0 | | 0.93084 | 0.88392 |
| HN_{b}C_{b}—NₐH₂(N_{c}) | Nₐ | −0.56690 | 0 | 0 | 0 | | 0.93084 | 0.88392 |
| HN_{b}C_{b}—NₐH₂(N_{c}) | C_{b} | −0.56690 | −0.92918 | −0.92918 | 0 | −154.04095 | 0.91771 | 0.78870 |
| HN_{b}C_{b}═N_{c}C_{c}(NₐH₂) | N_{c} | −0.92918 | −0.46459 | 0 | 0 | | 0.93084 | 0.83885 |
| HN_{b}C_{b}═N_{c}C_{c}(NₐH₂) | C_{b} | −0.92918 | −0.92918 | −0.56690 | 0 | −154.04095 | 0.91771 | 0.78870 |
| C_{b}N_{c}—C_{c}C_{d}(N_{d}H) | N_{c} | −0.46459 | −0.92918 | 0 | 0 | | | 0.93084 |
| C_{b}N_{c}—C_{c}C_{d}(N_{d}H) | C_{c} | −0.46459 | −1.13380 | −0.92918 | 0 | −154.14326 | 0.91771 | 0.78405 |
| N_{c}(N_{d}H)C_{c}═C_{d}Nₑ(Cₐ) | C_{c} | −1.13380 | −0.92918 | −0.46459 | 0 | −154.14326 | 0.91771 | 0.78405 |
| N_{c}(N_{d}H)C_{c}═C_{d}Nₑ(Cₐ) | C_{d} | −1.13380 | −0.46459 | 0 | 0 | −153.21408 | 0.91771 | 0.82840 |
| N—H (N_{d}H) | N_{d} | −0.92918 | −0.92918 | 0 | 0 | | 0.93084 | 0.81549 |
| (N_{c})C_{d}C_{c}—N_{d}H(Cₑ) | N_{d} | −0.92918 | −0.92918 | 0 | 0 | | 0.93084 | 0.81549 |
| (N_{c})C_{d}C_{c}—N_{d}H(Cₑ) | C_{c} | −1.13379 | −0.92918 | −0.46459 | 0 | −154.14326 | 0.91771 | 0.78405 |
| C—H (CₑH) | Cₑ | −0.92918 | −0.92918 | 0 | 0 | −153.47405 | 0.91771 | 0.81549 |
| C_{c}HN_{d}H—CₑH(Nₑ) | N_{d} | −0.92918 | −0.92918 | 0 | 0 | | 0.93084 | 0.81549 |
| C_{c}HN_{d}H—CₑH(Nₑ) | Cₑ | −0.92918 | −0.92918 | 0 | 0 | −153.47405 | 0.91771 | 0.81549 |
| N_{d}(H)Cₑ═NₑC_{d} | Nₑ | −0.92918 | −0.46459 | 0 | 0 | | 0.93084 | 0.83885 |
| N_{d}(H)Cₑ═NₑC_{d} | Cₑ | −0.92918 | −0.92918 | 0 | 0 | −153.47405 | 0.91771 | 0.81549 |
| CₑNₑ—C_{d}Cₐ(C_{c}) | Nₑ | −0.46459 | −0.92918 | 0 | 0 | | 0.93084 | 0.83885 |
| CₑNₑ—C_{d}Cₐ(C_{c}) | C_{d} | −0.46459 | −1.13380 | 0 | 0 | −153.21408 | 0.91771 | 0.82840 |
| (Nₑ)C_{c}C_{d}—Cₐ(O)N_{b} | Cₐ | 0.00000 | −1.34946 | −0.92918 | 0 | −153.89433 | 0.91771 | 0.79546 |
| (Nₑ)C_{c}C_{d}—Cₐ(O)N_{b} | C_{d} | 0.00000 | −1.13379 | −0.46459 | 0 | −153.21407 | 0.91771 | 0.82840 |

| | E_{Coulomb} | E(C2sp³) | | | | | |
|---|---|---|---|---|---|---|---|
| | (C2sp³)(eV) | (eV) | θ′ | θ₁ | θ₂ | d₁ | d₂ |
| Bond | Final | Final | (°) | (°) | (°) | (a₀) | (a₀) |
| N_{b}(C_{d})Cₐ═O | −16.17521 | | 137.27 | 42.73 | 66.31 | 0.52193 | 0.61784 |
| N_{b}(C_{d})Cₐ═O | −17.10440 | −16.91353 | 135.34 | 44.66 | 63.78 | 0.57401 | 0.56576 |
| N—H (N_{b}H) | −16.68411 | | 117.34 | 62.66 | 62.90 | 0.56678 | 0.37456 |
| C_{d}(O)Cₐ—N_{b}H(C_{b}) | −16.68411 | | 138.92 | 41.08 | 61.59 | 0.68147 | 0.61467 |
| C_{d}(O)Cₐ—N_{b}H(C_{b}) | −17.10440 | −16.91353 | 138.15 | 41.85 | 60.58 | 0.70361 | 0.59253 |
| C_{d}(O)CₐN_{b}H—C_{b}N_{c}(NₐH₂) | −16.68411 | | 138.92 | 41.08 | 61.59 | 0.68147 | 0.61467 |
| C_{d}(O)CₐN_{b}H—C_{b}N_{c}(NₐH₂) | −17.25101 | −17.06015 | 137.89 | 42.11 | 60.23 | 0.71108 | 0.58506 |
| N_{c}(N_{b})C_{b}NₐH—H | −15.39265 | | 121.74 | 58.26 | 67.49 | 0.47634 | 0.46500 |
| HN_{b}C_{b}—NₐH₂(N_{c}) | −15.39265 | | 113.13 | 66.87 | 55.08 | 0.92180 | 0.34719 |
| HN_{b}C_{b}—NₐH₂(N_{c}) | −17.25101 | −17.06015 | 106.68 | 73.32 | 49.65 | 1.04263 | 0.22636 |
| HN_{b}C_{b}═N_{c}C_{c}(NₐH₂) | −16.21952 | | 138.20 | 41.80 | 62.08 | 0.67849 | 0.62534 |
| HN_{b}C_{b}═N_{c}C_{c}(NₐH₂) | −17.25101 | −17.06015 | 136.24 | 43.76 | 59.56 | 0.73424 | 0.56959 |
| C_{b}N_{c}—C_{c}C_{d}(N_{d}H) | 0.83885 | −16.21953 | 91.32 | 88.68 | 43.14 | 1.33135 | 0.01939 |
| C_{b}N_{c}—C_{c}C_{d}(N_{d}H) | −17.35332 | −17.16246 | 86.00 | 94.00 | 39.62 | 1.40538 | 0.05464 |
| N_{c}(N_{d}H)C_{c}═C_{d}Nₑ(Cₐ) | −17.35332 | −17.16246 | 135.87 | 44.13 | 59.25 | 0.74183 | 0.56280 |
| N_{c}(N_{d}H)C_{c}═C_{d}Nₑ(Cₐ) | −16.42414 | −16.23327 | 137.64 | 42.36 | 61.49 | 0.69250 | 0.61213 |
| N—H (N_{d}H) | −16.68411 | | 117.34 | 62.66 | 62.90 | 0.56678 | 0.37456 |
| (N_{c})C_{d}C_{c}—N_{d}H(Cₑ) | −16.68411 | | 138.92 | 41.08 | 61.59 | 0.68147 | 0.61467 |
| (N_{c})C_{d}C_{c}—N_{d}H(Cₑ) | −17.35332 | −17.16245 | 137.70 | 42.30 | 59.99 | 0.71622 | 0.57992 |
| C—H (CₑH) | −16.68411 | −16.49325 | 84.49 | 95.51 | 44.47 | 1.08953 | 0.07833 |
| C_{c}HN_{d}H—CₑH(Nₑ) | −16.68411 | | 138.92 | 41.08 | 61.59 | 0.68147 | 0.61467 |
| C_{c}HN_{d}H—CₑH(Nₑ) | −16.68411 | −16.49325 | 138.92 | 41.08 | 61.59 | 0.68147 | 0.61467 |
| N_{d}(H)Cₑ═NₑC_{d} | −16.21952 | | 138.20 | 41.80 | 62.08 | 0.67849 | 0.62534 |
| N_{d}(H)Cₑ═NₑC_{d} | −16.68411 | −16.49325 | 137.31 | 42.69 | 60.92 | 0.70446 | 0.59938 |
| CₑNₑ—C_{d}Cₐ(C_{c}) | −16.21953 | | 91.32 | 88.68 | 43.14 | 1.33135 | 0.01939 |
| CₑNₑ—C_{d}Cₐ(C_{c}) | −16.42414 | −16.23327 | 90.36 | 89.64 | 42.49 | 1.34547 | 0.00527 |
| (Nₑ)C_{c}C_{d}—Cₐ(O)N_{b} | −17.10440 | −16.91353 | 81.01 | 98.99 | 37.43 | 1.49764 | 0.12433 |
| (Nₑ)C_{c}C_{d}—Cₐ(O)N_{b} | −16.42413 | −16.23327 | 92.72 | 87.28 | 45.17 | 1.32975 | 0.04357 |

TABLE 30
The energy parameters (eV) of functional groups of guanine.

| | C═O | C—N (a) | NH₂ | C═C | C—C |
|---|---|---|---|---|---|
| Parameters | Group | Group | Group | Group | Group |
| n₁ | 2 | 1 | 2 | 2 | 1 |
| n₂ | 0 | 0 | 0 | 0 | 0 |
| n₃ | 0 | 0 | 1 | 0 | 0 |
| C₁ | 0.5 | 0.5 | 0.75 | 0.5 | 0.5 |
| C₂ | 1 | 1 | 0.93613 | 0.85252 | 1 |
| c₁ | 1 | 1 | 0.75 | 1 | 1 |
| c₂ | 0.85395 | 0.84665 | 0.92171 | 0.85252 | 0.91771 |
| c₃ | 2 | 0 | 0 | 0 | 0 |
| c₄ | 4 | 2 | 1 | 4 | 2 |
| c₅ | 0 | 0 | 2 | 0 | 0 |
| C₁ₒ | 0.5 | 0.5 | 1.5 | 0.5 | 0.5 |
| C₂ₒ | 1 | 1 | 1 | 0.85252 | 1 |
| Vₑ (eV) | −111.25473 | −35.50149 | −78.97795 | −104.37986 | −33.63376 |
| Vₚ (eV) | 23.87467 | 10.72181 | 28.90735 | 20.85777 | 9.90728 |
| T (eV) | 42.82081 | 11.02312 | 31.73641 | 35.96751 | 8.91674 |
| Vₘ (eV) | −21.41040 | −5.51156 | −15.86820 | −17.98376 | −4.45837 |
| E (AO/HO) (eV) | 0 | −14.63489 | −14.53414 | 0 | −14.63489 |
| ΔE_{H}₂MO (AO/HO) (eV) | −2.69893 | −2.26759 | 0 | −2.26759 | −2.26759 |
| E_{T} (AO/HO) (eV) | 2.69893 | −12.36730 | −14.53414 | 2.26759 | −12.36730 |
| E(n₃ AO/HO) (eV) | 0 | 0 | −14.53414 | 0 | 0 |
| E_{T} (H₂MO) (eV) | −63.27074 | −31.63543 | −48.73654 | −63.27075 | −31.63541 |
| E_{T} (atom-atom, msp³.AO) (eV) | −2.69893 | −1.13379 | 0 | −2.26759 | 0.00000 |
| E_{T} (MO) (eV) | −65.96966 | −32.76916 | −48.73660 | −65.53833 | −31.63537 |
| ω (10¹⁵ rad/s) | 59.4034 | 14.3055 | 68.9812 | 15.4421 | 19.8904 |
| E_{K} (eV) | 39.10034 | 9.41610 | 45.40465 | 10.16428 | 13.09221 |
| Ē_{D} (eV) | −0.40804 | −0.19893 | −0.42172 | −0.20668 | −0.22646 |
| Ē_{Kvib} (eV) | 0.21077 [12] | 0.15498 [57] | 0.40929 [22] | 0.17897 [6] | 0.14667 [66] |
| Ē_{osc} (eV) | −0.30266 | −0.12144 | −0.21708 | −0.11720 | −0.15312 |
| E_{mag} (eV) | 0.11441 | 0.14803 | 0.14803 | 0.14803 | 0.14803 |
| E_{T} (Group) (eV) | −66.57498 | −32.89060 | −49.17075 | −65.77272 | −31.64046 |
| Eᵢₙᵢₜᵢₐₗ (c₄ AO/HO) (eV) | −14.63489 | −14.63489 | −14.53414 | −14.63489 | −14.63489 |
| Eᵢₙᵢₜᵢₐₗ (c₅ AO/HO) (eV) | 0 | 0 | −13.59844 | 0 | 0 |
| E_{D} (Group) (eV) | 7.80660 | 3.62082 | 7.43973 | 7.23317 | 2.37068 |
| | N═C | C—N (b) | C—N—C | NH | CH |
| Parameters | Group | Group | Group | Group | Group |
| n₁ | 2 | 1 | 2 | 1 | 1 |
| n₂ | 0 | 0 | 0 | 0 | 0 |
| n₃ | 0 | 0 | 0 | 0 | 0 |
| C₁ | 0.5 | 0.5 | 0.5 | 0.75 | 0.75 |
| C₂ | 0.85252 | 1 | 0.85252 | 0.93613 | 1 |
| c₁ | 1 | 1 | 1 | 0.75 | 1 |
| c₂ | 0.84665 | 0.84665 | 0.84665 | 0.92171 | 0.91771 |
| c₃ | 0 | 0 | 0 | 1 | 1 |
| c₄ | 4 | 2 | 4 | 1 | 1 |
| c₅ | 0 | 0 | 0 | 1 | 1 |
| C₁ₒ | 0.5 | 0.5 | 0.5 | 0.75 | 0.75 |
| C₂ₒ | 0.85252 | 1 | 0.85252 | 1 | 1 |
| Vₑ (eV) | −103.92756 | −32.44864 | −106.58684 | −39.48897 | −39.09538 |
| Vₚ (eV) | 20.87050 | 10.07285 | 20.99432 | 14.45367 | 13.45505 |
| T (eV) | 35.85539 | 8.89248 | 37.21047 | 15.86820 | 12.74462 |
| Vₘ (eV) | −17.92770 | −4.44624 | −18.60523 | −7.93410 | −6.37231 |
| E (AO/HO) (eV) | 0 | −14.63489 | 0 | −14.53414 | −14.63489 |
| ΔE_{H}₂MO (AO/HO) (eV) | −1.85836 | −0.92918 | −3.71673 | 0 | −2.26758 |
| E_{T} (AO/HO) (eV) | 1.85836 | −13.70571 | 3.71673 | −14.53414 | −12.36731 |
| E (n₃ AO/HO) (eV) | 0 | 0 | 0 | 0 | 0 |
| E_{T} (H₂MO) (eV) | −63.27100 | −31.63527 | −63.27056 | −31.63534 | −31.63533 |
| E_{T} (atom-atom, msp³.AO) (eV) | −1.85836 | −0.92918 | −3.71673 | 0 | 0 |
| E_{T} (MO) (eV) | −65.12910 | −32.56455 | −66.98746 | −31.63537 | −31.63537 |
| ω (10¹⁵ rad/s) | 15.4704 | 21.5213 | 15.7474 | 48.7771 | 28.9084 |
| E_{K} (eV) | 10.18290 | 14.16571 | 10.36521 | 32.10594 | 19.02803 |
| Ē_{D} (eV) | −0.20558 | −0.24248 | −0.21333 | −0.35462 | −0.27301 |
| Ē_{Kvib} (eV) | 0.20768 [61] | 0.12944 [23] | 0.11159 [12] | 0.40696 [24] | 0.39427 [59] |
| Ē_{osc} (eV) | −0.10174 | −0.17775 | −0.15754 | −0.15115 | −0.07587 |
| E_{mag} (eV) | 0.14803 | 0.14803 | 0.14803 | 0.14803 | 0.14803 |
| E_{T} (Group) (eV) | −65.33259 | −32.74230 | −67.30254 | −31.78651 | −31.71124 |
| Eᵢₙᵢₜᵢₐₗ (c₄ AO/HO) (eV) | −14.63489 | −14.63489 | −14.63489 | −14.53414 | −14.63489 |
| Eᵢₙᵢₜᵢₐₗ (c₅ AO/HO) (eV) | 0 | 0 | 0 | −13.59844 | −13.59844 |
| E_{D} (Group) (eV) | 6.79303 | 3.47253 | 8.76298 | 3.51208 | 3.32988 |

TABLE 31
The total gaseous bond energies of guanine calculated using the functional group
composition and the energies of Table 30 compared to the experimental values [3].

| | | C═O | C—N (a) | NH₂ | C═C | C—C | N═C | C—N (b) |
|---|---|---|---|---|---|---|---|---|
| Formula | Name | Group | Group | Group | Group | Group | Group | Group |
| C₅H₅N₅O | Guanine | 1 | 1 | 1 | 1 | 1 | 2 | 2 |

| | | | | | Calculated | Experimental | |
|---|---|---|---|---|---|---|---|
| | | C—N—C | NH | CH | Total Bond | Total Bond | |
| Formula | Name | Group | Group | Group | Energy (eV) | Energy (eV) | Relative Error |
| C₅H₅N₅O | Guanine | 2 | 2 | 1 | 76.88212 | 77.41849^{a} | 0.00693 |

^{a}Crystal.

TABLE 32
The bond angle parameters of guanine and experimental values [64]. In the calculation of θᵥ, the
parameters from the preceding angle were used. E_{T} is E_{T} (atom-atom, msp³.AO).

| | | | 2c′ | | Atom 1 | | Atom 2 | |
|---|---|---|---|---|---|---|---|---|
| | 2c′ | 2c′ | Terminal | | Hybridization | | Hybridization | |
| Atoms of | Bond 1 | Bond 2 | Atoms | E_{Coulombic} | Designation | E_{Coulombic} | Designation | c₂ |
| Angle | (a₀) | (a₀) | (a₀) | Atom 1 | (Table 8) | Atom 2 | (Table 8) | Atom 1 |
| ∠N_{b}CₐC_{d} | 2.59228 | 2.74663 | 4.3359 | −14.53414 | N | −16.42413 | 13 | 0.84665 |
| | | | | | | C_{d} | | Eq. (15.171) |
| ∠N_{b}CₐO | 2.59228 | 2.27954 | 4.2426 | −16.68411 | 18 | −16.17521 | 8 | 0.81549 |
| ∠OCₐC_{d} | | | | | | | | |
| ∠C_{b}N_{b}Cₐ | 2.59228 | 2.59228 | 4.5826 | −17.25101 | 28 | −17.10440 | 25 | 0.78870 |
| ∠N_{b}C_{b}N_{c} | 2.59228 | 2.60766 | 4.5166 | −15.75493 | 4 | −15.75493 | 4 | 0.86359 |
| ∠H_{b}N_{b}Cₐ | 1.88268 | 2.64855 | 3.9158 | −14.53414 | N | −14.82575 | 1 | 0.93613 |
| | | | | | | Cₐ | | Eq. (13.248) |
| ∠C_{b}N_{b}H_{b} | | | | | | | | |
| ∠N_{b}C_{b}Nₐ | 2.59228 | 2.53797 | 4.3818 | −16.68411 | 18 | −15.39265 | 2 | 0.81549 |
| ∠NₐC_{b}N_{c} | 2.53797 | 2.60766 | 4.4721 | −15.39265 | 2 | −16.21952 | 9 | 0.88392 |
| ∠HNₐC_{b} | 1.88268 | 2.53797 | 3.8987 | −14.53414 | N | −16.32183 | 11 | 0.93613 |
| | | | | | | | | Eq. (13.248) |
| ∠HNₐH | 1.88268 | 1.88268 | 3.1559 | −14.53414 | N | H | H | 0.93613 |
| | | | | | | | | Eq. (13.248) |
| ∠C_{b}N_{c}C_{c} | 2.60766 | 2.70148 | 4.4721 | −17.25101 | 28 | −17.35332 | 29 | 0.78870 |
| ∠N_{c}C_{c}N_{d} | 2.70148 | 2.59228 | 4.7117 | −14.53414 | N | −14.53414 | N | 0.84665 |
| | | | | | | | | Eq. (15.171) |
| ∠N_{c}C_{c}C_{d} | 2.70148 | 2.60925 | 4.7539 | −14.53414 | N | −15.95955 | 6 | 0.84665 |
| | | | | | | | | Eq. (15.171) |
| ∠CₐC_{d}C_{c} | 2.74663 | 2.60925 | 4.6476 | −17.10440 | 25 | −16.88873 | 20 | 0.79546 |
| ∠C_{c}N_{d}Cₑ | 2.59228 | 2.59228 | 4.2071 | −17.95963 | 39 | −17.95963 | 39 | 0.75758 |
| ∠N_{d}C_{c}C_{d} | 2.59228 | 2.60925 | 4.1473 | −14.53414 | N | −17.35332 | 29 | 0.84665 |
| | | | | | | | | Eq. (15.171) |
| ∠NₑCₑN_{d} | 2.60766 | 2.60287 | 4.3359 | −16.21952 | 9 | −16.03838 | 7 | 0.83885 |
| ∠CₑN_{d}H | 2.59228 | 1.88268 | 4.0166 | −14.53414 | N | −15.95954 | 6 | 0.84665 |
| | | | | | | | | Eq. (15.171) |
| ∠C_{c}N_{d}H | | | | | | | | |
| ∠HCₑNₑ | 2.02241 | 2.60766 | 4.1312 | −16.68411 | 18 | −14.53414 | N | 0.81549 |
| ∠N_{d}CₑH | | | | | | | | |
| ∠C_{d}NₑCₑ | 2.70148 | 2.60766 | 4.2661 | −17.92022 | 37 | −17.92022 | 37 | 0.75924 |
| ∠NₑC_{d}C_{c} | 2.70148 | 2.60925 | 4.2895 | −14.53414 | N | −16.42414 | 13 | 0.84665 |
| | | | | | | | | Eq. (15.171) |
| ∠CₐC_{d}Nₑ | 2.74663 | 2.70148 | 4.9396 | −17.10440 | 25 | −14.53414 | N | 0.79546 |

| Atoms of | c₂ | | | | | E_{T} | θᵥ | θ₁ | θ₂ | Cal. θ | Exp. θ |
|---|---|---|---|---|---|---|---|---|---|---|---|
| Angle | Atom 2 | C₁ | C₂ | c₁ | c₂′ | (eV) | (°) | (°) | (°) | (°) | (°) |
| ∠N_{b}CₐC_{d} | 0.82840 | 1 | 1 | 1 | 0.83753 | −1.44915 | | | | 108.57 | 110.8 |
| ∠N_{b}CₐO | 0.84115 | 1 | 1 | 1 | 0.82832 | −1.44915 | | | | 120.98 | 120.4 |
| ∠OCₐC_{d} | | | | | | | | 108.57 | 120.98 | 130.44 | 128.8 |
| ∠C_{b}N_{b}Cₐ | 0.79546 | 1 | 1 | 1 | 0.79208 | −1.85836 | | | | 124.23 | 125.6 |
| ∠N_{b}C_{b}N_{c} | 0.86359 | 1 | 1 | 1 | 0.86359 | −1.44915 | | | | 120.59 | 123.3 |
| ∠H_{b}N_{b}Cₐ | 0.91771 | 0.75 | 1 | 0.75 | 0.98033 | 0 | | | | 118.60 | |
| ∠C_{b}N_{b}H_{b} | | | | | | | | 124.23 | 118.60 | 117.17 | |
| ∠N_{b}C_{b}Nₐ | 0.88392 | 1 | 1 | 1 | 0.84971 | −1.44915 | | | | 117.32 | 115.8 |
| ∠NₐC_{b}N_{c} | 0.83885 | 1 | 1 | 1 | 0.86138 | −1.44915 | | | | 120.71 | 120.9 |
| ∠HNₐC_{b} | 0.83360 | 0.75 | 1 | 0.75 | 0.98458 | 0 | | | | 123.07 | 118 [65] |
| ∠HNₐH | 1 | 1 | 1 | 0.75 | 1.06823 | 0 | | | | 113.89 | 113.9 [1] |
| | | | | | | | | | | | (aniline) |
| ∠C_{b}N_{c}C_{c} | 0.78405 | 1 | 1 | 1 | 0.78637 | −1.85836 | | | | 114.77 | 112.6 |
| ∠N_{c}C_{c}N_{d} | 0.84665 | 1 | 1 | 1 | 0.84665 | −1.65376 | | | | 125.75 | 125.8 |
| | Eq. (15.171) | | | | | | | | | | |
| ∠N_{c}C_{c}C_{d} | 0.85252 | 1 | 1 | 1 | 0.84958 | −1.65376 | | | | 127.05 | 128.3 |
| ∠CₐC_{d}C_{c} | 0.80561 | 1 | 1 | 1 | 0.80054 | −1.85836 | | | | 120.38 | 119.4 |
| ∠C_{c}N_{d}Cₑ | 0.75758 | 1 | 1 | 1 | 0.75758 | −1.85836 | | | | 108.48 | 108.2 |
| ∠N_{d}C_{c}C_{d} | 0.78405 | 1 | 1 | 1 | 0.81535 | −1.44915 | | | | 105.75 | 105.9 |
| ∠NₑCₑN_{d} | 0.84833 | 1 | 1 | 1 | 0.84359 | −1.44915 | | | | 112.64 | 110.0 |
| ∠CₑN_{d}H | 0.85252 | 0.75 | 1 | 0.75 | 1.00693 | 0 | | | | 126.96 | 127 [65] |
| ∠C_{c}N_{d}H | | | | | | | | 108.48 | 126.96 | 124.56 | 127 |
| ∠HCₑNₑ | 0.84665 | 0.75 | 1 | 0.75 | 1.03820 | 0 | | | | 125.85 | 126 [65] |
| | Eq. (15.171) | | | | | | | | | | |
| ∠N_{d}CₑH | | | | | | | | 112.64 | 125.85 | 121.52 | 119 [65] |
| ∠C_{d}NₑCₑ | 0.75924 | 1 | 1 | 1 | 0.75924 | −1.85836 | | | | 106.93 | 108.0° |
| ∠NₑC_{d}C_{c} | 0.82840 | 1 | 1 | 1 | 0.83753 | −1.44915 | | | | 107.73 | 107.9 |
| ∠CₐC_{d}Nₑ | 0.84665 | 1 | 1 | 1 | 0.82105 | −1.85836 | | | | 130.10 | 133.6 |
| | Eq. (15.171) | | | | | | | | | | |

Cytosine

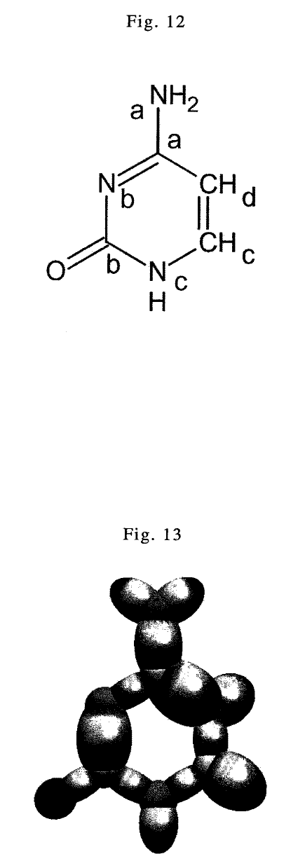

Cytosine having the formula C₄H₅N₃O is a pyrimidine with a carbonyl substitution at position C_{b}, and a primary amine moiety is at position Cₐ as shown in FIG. 12. The carbonyl and adjacent C_{b}—N_{b} functional groups are equivalent to the corresponding groups of alkyl amides. The NH₂ and Cₐ—Nₐ functional groups of the primary amine moiety are equivalent to the NH₂ and Cₐ—Nₐ functional groups of adenine. The vinyl moiety, HC_{c}═C_{d}H, comprises C═C and CH functional groups that are equivalent to the corresponding alkene groups. Cytosine further comprises N_{b}═Cₐ, N_{c}H, and C_{b}—N_{c}—C_{c} groups that are equivalent to the corresponding groups of imidazole as given in the corresponding section. The Cₐ—C_{d} bond comprises another functional group that is equivalent to the Cₐ—C_{d} group of guanine and thymine except that E_{T}(atom-atom,msp³.AO) is equivalent to the contribution of a C2sp³ HO of an alkane, −0.92918 eV (Eq. (14.513)), in order to match the energies of the single and double-bonded moieties within the molecule.

The symbols of the functional groups of cytosine are given in Table 33. The geometrical (Eqs. (15.1-15.5) and (15.51)), intercept (Eqs. (15.80-15.87)), and energy (Eqs. (15.6-15.11) and (15.17-15.65)) parameters of cytosine are given in Tables 34, 35, and 36, respectively. The total energy of cytosine given in Table 37 was calculated as the sum over the integer multiple of each E_{D}(Group) of Table 36 corresponding to functional-group composition of the molecule. The bond angle parameters of cytosine determined using Eqs. (15.88-15.117) are given in Table 38. The color scale, charge-density of cytosine comprising atoms with the outer shell bridged by one or more H₂-type ellipsoidal MOs or joined with one or more hydrogen MOs is shown in FIG. 13.

TABLE 33
The symbols of functional groups of cytosine.

| Functional Group | Group Symbol |
|---|---|
| Cₐ—Nₐ | C—N (a) |
| NH₂ group | NH₂ |
| N_{b}═Cₐ double bond | N═C |
| C_{b}═O (alkyl amide) | C═O |
| C_{b}—N_{b} amide | C—N (b) |
| C_{c}═C_{d} double bond | C═C |
| C_{c}H C_{d}H | CH |
| Cₐ—C_{d} | C—C |
| C_{b}—N_{c}—C_{c} | C—N—C |
| N_{c}H group | NH |

TABLE 34
The geometrical bond parameters of cytosine and experimental values [1].

| | C—N (a) | NH₂ | N═C | C═O | C—N (b) |
|---|---|---|---|---|---|
| Parameter | Group | Group | Group | Group | Group |
| a (a₀) | 1.61032 | 1.24428 | 1.44926 | 1.29907 | 1.75370 |
| c′ (a₀) | 1.26898 | 0.94134 | 1.30383 | 1.13977 | 1.32427 |
| Bond Length 2c′ (Å) | 1.34303 | 0.99627 | 1.37991 | 1.20628 | 1.40155 |
| Exp. Bond Length | 1.34 [64] | 0.998 | | 1.220 | 1.380 |
| (Å) | (adenine) | (aniline) | | (acetamide) | (acetamide) |
| | | | | 1.225 | |
| | | | | (N-methylacetamide) | |
| b, c (a₀) | 0.99137 | 0.81370 | 0.63276 | 0.62331 | 1.14968 |
| e | 0.78803 | 0.75653 | 0.89965 | 0.87737 | 0.75513 |

| | C═C | CH | C—C | C—N—C | NH |
|---|---|---|---|---|---|
| Parameter | Group | Group | Group | Group | Group |
| a (a₀) | 1.47228 | 1.53380 | 1.88599 | 1.43222 | 1.24428 |
| c′ (a₀) | 1.26661 | 1.01120 | 1.37331 | 1.29614 | 0.94134 |
| Bond Length 2c′ (Å) | 1.34052 | 1.07021 | 1.45345 | 1.37178 | 0.996270 |
| Exp. Bond Length | 1.34 [64] | 1.076 | 1.43 [64] | 1.370 | 0.996 |
| (Å) | (cytosine) | (pyrrole) | (cytosine) | (pyrrole) | (pyrrole) |
| | 1.342 | | | | |
| | (2-methylpropene) | | | | |
| | 1.346 | | | | |
| | (2-butene) | | | | |
| | 1.349 | | | | |
| | (1,3-butadiene) | | | | |
| b, c (a₀) | 0.75055 | 1.15326 | 1.29266 | 0.60931 | 0.81370 |
| e | 0.86030 | 0.65928 | 0.72817 | 0.90499 | 0.75653 |

TABLE 35
The MO to HO intercept geometrical bond parameters of cytosine.
R₁ is an alkyl group and R, R′, R″ are H or alkyl
groups. E_{T} is E_{T} (atom-atom, msp³.AO).

| | | | | | | Final Total | | |
|---|---|---|---|---|---|---|---|---|
| | | E_{T} | E_{T} | E_{T} | E_{T} | Energy | | |
| | | (eV) | (eV) | (eV) | (eV) | C2sp³ | rᵢₙᵢₜᵢₐₗ | r_{final} |
| Bond | Atom | Bond 1 | Bond 2 | Bond 3 | Bond 4 | (eV) | (a₀) | (a₀) |
| C_{d}(N_{b})CₐNₐH—H | Nₐ | −0.56690 | 0 | 0 | 0 | | 0.93084 | 0.88392 |
| C_{d}(N_{b})Cₐ—NₐH₂ | Nₐ | −0.56690 | 0 | 0 | 0 | | 0.93084 | 0.88392 |
| C_{d}(N_{b})Cₐ—NₐH₂ | Cₐ | −0.56690 | −0.92918 | −0.46459 | 0 | −153.57636 | 0.91771 | 0.81052 |
| C_{d}(Nₐ)Cₐ═N_{b}C_{b} | N_{b} | −0.92918 | −0.82688 | 0 | 0 | | 0.93084 | 0.82053 |
| C_{d}(Nₐ)Cₐ═N_{b}C_{b} | Cₐ | −0.92918 | −0.56690 | −0.46459 | 0 | −153.57636 | 0.91771 | 0.81052 |
| CₐN_{b}—C_{b}(O)N_{c} | N_{b} | −0.82688 | −0.92918 | 0 | 0 | | 0.93084 | 0.82053 |
| CₐN_{b}—C_{b}(O)N_{c} | C_{b} | −0.82688 | −1.34946 | −0.92918 | 0 | −154.72121 | 0.91771 | 0.75878 |
| N_{b}(N_{c})C_{b}═O | Oₐ | −1.34946 | 0 | 0 | 0 | | 1.00000 | 0.84115 |
| N_{b}(N_{c})C_{b}═O | C_{b} | −1.34946 | −0.82688 | −0.92918 | 0 | −154.72121 | 0.91771 | 0.75878 |
| N—H (N_{c}H) | N_{c} | −0.92918 | −0.92918 | 0 | 0 | | 0.93084 | 0.81549 |
| C—H (C_{c}H) | C_{c} | −1.13380 | −0.92918 | 0 | 0 | −153.67867 | 0.91771 | 0.80561 |
| C—H (C_{d}H) | C_{d} | −1.13380 | −0.46459 | 0 | 0 | −153.21408 | 0.91771 | 0.82840 |
| N_{b}(O)C_{b}—N_{c}HC_{c} | N_{c} | −0.92918 | −0.92918 | 0 | 0 | | 0.93084 | 0.81549 |
| N_{b}(O)C_{b}—N_{c}HC_{c} | C_{b} | −0.92918 | −1.34946 | −0.82688 | 0 | −154.72121 | 0.91771 | 0.75878 |
| C_{b}HN_{c}—C_{c}HC_{d} | N_{c} | −0.92918 | −0.92918 | 0 | 0 | | 0.93084 | 0.81549 |
| C_{b}HN_{c}—C_{c}HC_{d} | C_{d} | −0.92918 | −1.13379 | 0 | 0 | −153.67866 | 0.91771 | 0.80561 |
| N_{c}HC_{c}═C_{d}HCₐ | C_{c} | −1.13380 | −0.92918 | 0.00000 | 0 | −153.67867 | 0.91771 | 0.80561 |
| N_{c}HC_{c}═C_{d}HCₐ | C_{d} | −1.13380 | −0.46459 | 0.00000 | 0 | −153.21408 | 0.91771 | 0.82840 |
| HC_{c}C_{d}—Cₐ(Nₐ)N_{b} | Cₐ | −0.46459 | −0.56690 | −0.92918 | 0 | −153.57636 | 0.91771 | 0.81052 |
| HC_{c}C_{d}—Cₐ(Nₐ)N_{b} | C_{d} | −0.46459 | −1.13379 | 0 | 0 | −153.21407 | 0.91771 | 0.82840 |

| | | E (C2sp³) | | | | | |
|---|---|---|---|---|---|---|---|
| | E_{Coulomb} (C2sp³)(eV) | (eV) | θ′ | θ₁ | θ₂ | d₁ | d₂ |
| Bond | Final | Final | (°) | (°) | (°) | (a₀) | (a₀) |
| C_{d}(N_{b})CₐNₐH—H | −15.39265 | | 121.74 | 58.26 | 67.49 | 0.47634 | 0.46500 |
| C_{d}(N_{b})Cₐ—NₐH₂ | −15.39265 | | 113.13 | 66.87 | 55.08 | 0.92180 | 0.34719 |
| C_{d}(N_{b})Cₐ—NₐH₂ | −16.78642 | −16.59556 | 108.27 | 71.73 | 50.93 | 1.01493 | 0.25406 |
| C_{d}(Nₐ)Cₐ═N_{b}C_{b} | −16.58181 | | 137.50 | 42.50 | 61.17 | 0.69886 | 0.60497 |
| C_{d}(Nₐ)Cₐ═N_{b}C_{b} | −16.78642 | −16.59556 | 137.11 | 42.89 | 60.67 | 0.70998 | 0.59385 |
| CₐN_{b}—C_{b}(O)N_{c} | −16.58181 | | 96.19 | 83.81 | 45.20 | 1.23578 | 0.08850 |
| CₐN_{b}—C_{b}(O)N_{c} | −17.93127 | −17.74041 | 90.51 | 89.49 | 41.30 | 1.31755 | 0.00672 |
| N_{b}(N_{c})C_{b}═O | −16.17521 | | 137.27 | 42.73 | 66.31 | 0.52193 | 0.61784 |
| N_{b}(N_{c})C_{b}═O | −17.93127 | −17.74041 | 133.67 | 46.33 | 61.70 | 0.61582 | 0.52395 |
| N—H (N_{c}H) | −16.68411 | | 117.34 | 62.66 | 62.90 | 0.56678 | 0.37456 |
| C—H (C_{c}H) | −16.88873 | −16.69786 | 83.35 | 96.65 | 43.94 | 1.10452 | 0.09331 |
| C—H (C_{d}H) | −16.42414 | −16.23327 | 85.93 | 94.07 | 45.77 | 1.06995 | 0.05875 |
| N_{b}(O)C_{b}—N_{c}HC_{c} | −16.68411 | | 138.92 | 41.08 | 61.59 | 0.68147 | 0.61467 |
| N_{b}(O)C_{b}—N_{c}HC_{c} | −17.93127 | −17.74041 | 136.68 | 43.32 | 58.70 | 0.74414 | 0.55200 |
| C_{b}HN_{c}—C_{c}HC_{d} | −16.68411 | | 138.92 | 41.08 | 61.59 | 0.68147 | 0.61467 |
| C_{b}HN_{c}—C_{c}HC_{d} | −16.88873 | −16.69786 | 138.54 | 41.46 | 61.09 | 0.69238 | 0.60376 |
| N_{c}HC_{c}═C_{d}HCₐ | −16.88873 | −16.69786 | 127.61 | 52.39 | 58.24 | 0.77492 | 0.49168 |
| N_{c}HC_{c}═C_{d}HCₐ | −16.42414 | −16.23327 | 128.72 | 51.28 | 59.45 | 0.74844 | 0.51817 |
| HC_{c}C_{d}—Cₐ(Nₐ)N_{b} | −16.78642 | −16.59556 | 82.65 | 97.35 | 38.45 | 1.47695 | 0.10364 |
| HC_{c}C_{d}—Cₐ(Nₐ)N_{b} | −16.42414 | −16.23327 | 84.52 | 95.48 | 39.64 | 1.45240 | 0.07908 |

TABLE 36
The energy parameters (eV) of functional groups of cytosine.

| | C—N (a) | NH₂ | N═C | C═O | C—N (b) |
|---|---|---|---|---|---|
| Parameters | Group | Group | Group | Group | Group |
| n₁ | 1 | 2 | 2 | 2 | 1 |
| n₂ | 0 | 0 | 0 | 0 | 0 |
| n₃ | 0 | 1 | 0 | 0 | 0 |
| C₁ | 0.5 | 0.75 | 0.5 | 0.5 | 0.5 |
| C₂ | 1 | 0.93613 | 0.85252 | 1 | 1 |
| c₁ | 1 | 0.75 | 1 | 1 | 1 |
| c₂ | 0.84665 | 0.92171 | 0.84665 | 0.85395 | 0.91140 |
| c₃ | 0 | 0 | 0 | 2 | 0 |
| c₄ | 2 | 1 | 4 | 4 | 2 |
| c₅ | 0 | 2 | 0 | 0 | 0 |
| C₁ₒ | 0.5 | 1.5 | 0.5 | 0.5 | 0.5 |
| C₂ₒ | 1 | 1 | 0.85252 | 1 | 1 |
| Vₑ (eV) | −35.50149 | −78.97795 | −103.92756 | −111.25473 | −36.88558 |
| Vₚ (eV) | 10.72181 | 28.90735 | 20.87050 | 23.87467 | 10.27417 |
| T (eV) | 11.02312 | 31.73641 | 35.85539 | 42.82081 | 10.51650 |
| Vₘ (eV) | −5.51156 | −15.86820 | −17.92770 | −21.41040 | −5.25825 |
| E (AO/HO) (eV) | −14.63489 | −14.53414 | 0 | 0 | −14.63489 |
| ΔE_{H}₂_{MO} (AO/HO) (eV) | −2.26759 | 0 | −1.85836 | −2.69893 | −4.35268 |
| E_{T} (AO/HO) (eV) | −12.36730 | −14.53414 | 1.85836 | 2.69893 | −10.28221 |
| E (n₃ AO/HO) (eV) | 0 | −14.53414 | 0 | 0 | 0 |
| E_{T} (H₂MO) (eV) | −31.63543 | −48.73654 | −63.27100 | −63.27074 | −31.63537 |
| E_{T} (atom-atom, msp³.AO) (eV) | −1.13379 | 0 | −1.85836 | −2.69893 | −1.65376 |
| E_{T} (Mo) (eV) | −32.76916 | −48.73660 | −65.12910 | −65.96966 | −33.28912 |
| ω (10¹⁵ rad/s) | 14.3055 | 68.9812 | 15.4704 | 59.4034 | 12.5874 |
| E_{K} (eV) | 9.41610 | 45.40465 | 10.18290 | 39.10034 | 8.28526 |
| Ē_{D} (eV) | −0.19893 | −0.42172 | −0.20558 | −0.40804 | −0.18957 |
| Ē_{Kvib} (eV) | 0.15498 [57] | 0.40929 [22] | 0.20768 [61] | 0.21077 [12] | 0.17358 [33] |
| Ē_{osc} (eV) | −0.12144 | −0.21708 | −0.10174 | −0.30266 | −0.10278 |
| E_{mag} (eV) | 0.14803 | 0.14803 | 0.14803 | 0.11441 | 0.14803 |
| E_{T} (Group) (eV) | −32.89060 | −49.17075 | −65.33259 | −66.57498 | −33.39190 |
| Eᵢₙᵢₜᵢₐₗ (c₄ AO/HO) (eV) | −14.63489 | −14.53414 | −14.63489 | −14.63489 | −14.63489 |
| Eᵢₙᵢₜᵢₐₗ (c₅ AO/HO) (eV) | 0 | −13.59844 | 0 | 0 | 0 |
| E_{D} (Group) (eV) | 3.62082 | 7.43973 | 6.79303 | 7.80660 | 4.12212 |
| | C═C | CH | C—C | C—N—C | NH |
| Parameters | Group | Group | Group | Group | Group |
| n₁ | 2 | 1 | 1 | 2 | 1 |
| n₂ | 0 | 0 | 0 | 0 | 0 |
| n₃ | 0 | 0 | 0 | 0 | 0 |
| C₁ | 0.5 | 0.75 | 0.5 | 0.5 | 0.75 |
| C₂ | 0.91771 | 1 | 1 | 0.85252 | 0.93613 |
| c₁ | 1 | 1 | 1 | 1 | 0.75 |
| c₂ | 0.91771 | 0.91771 | 0.91771 | 0.84665 | 0.92171 |
| c₃ | 0 | 1 | 0 | 0 | 1 |
| c₄ | 4 | 1 | 2 | 4 | 1 |
| c₅ | 0 | 1 | 0 | 0 | 1 |
| C₁ₒ | 0.5 | 0.75 | 0.5 | 0.5 | 0.75 |
| C₂ₒ | 0.91771 | 1 | 1 | 0.85252 | 1 |
| Vₑ (eV) | −102.08992 | −39.09538 | −33.63376 | −106.58684 | −39.48897 |
| Vₚ (eV) | 21.48386 | 13.45505 | 9.90728 | 20.99432 | 14.45367 |
| T (eV) | 34.67062 | 12.74462 | 8.91674 | 37.21047 | 15.86820 |
| Vₘ (eV) | −17.33531 | −6.37231 | −4.45837 | −18.60523 | −7.93410 |
| E (AO/HO) (eV) | 0 | −14.63489 | −14.63489 | 0 | −14.53414 |
| ΔE_{H}_{₂}_{MO} (AO/HO) (eV) | 0 | −2.26758 | −2.26759 | −3.71673 | 0 |
| E_{T} (AO/HO) (eV) | 0 | −12.36731 | −12.36730 | 3.71673 | −14.53414 |
| E (n₃ AO/HO) (eV) | 0 | 0 | 0 | 0 | 0 |
| E_{T} (H₂MO) (eV) | −63.27075 | −31.63533 | −31.63541 | −63.27056 | −31.63534 |
| E_{T} (atom-atom, msp³.AO) (eV) | −2.26759 | 0 | −0.92918 | −3.71673 | 0 |
| E_{T} (MO) (eV) | −65.53833 | −31.63537 | −32.56455 | −66.98746 | −31.63537 |
| ω (10¹⁵ rad/s) | 43.0680 | 28.9084 | 19.8904 | 15.7474 | 48.7771 |
| E_{K} (eV) | 28.34813 | 19.02803 | 13.09221 | 10.36521 | 32.10594 |
| Ē_{D} (eV) | −0.34517 | −0.27301 | −0.23311 | −0.21333 | −0.35462 |
| Ē_{Kvib} (eV) | 0.17897 [6] | 0.39427 [59] | 0.14667 [66] | 0.11159 [12] | 0.40696 [24] |
| Ē_{osc} (eV) | −0.25568 | −0.07587 | −0.15977 | −0.15754 | −0.15115 |
| E_{mag} (eV) | 0.14803 | 0.14803 | 0.14803 | 0.14803 | 0.14803 |
| E_{T} (Group) (eV) | −66.04969 | −31.71124 | −32.57629 | −67.30254 | −31.78651 |
| Eᵢₙᵢₜᵢₐₗ (c₄ AO/HO) (eV) | −14.63489 | −14.63489 | −14.63489 | −14.63489 | −14.53414 |
| Eᵢₙᵢₜᵢₐₗ (c₅ AO/HO) (eV) | 0 | −13.59844 | 0 | 0 | −13.59844 |
| E_{D} (Group) (eV) | 7.51014 | 3.32988 | 3.30651 | 8.76298 | 3.51208 |

TABLE 37
The total gaseous bond energies of cytosine calculated using the functional
group composition and the energies of Table 36 compared to the
experimental values [3].

| | | C—N (a) | NH₂ | N═C | C═O | C—N (b) | C═C | CH |
|---|---|---|---|---|---|---|---|---|
| Formula | Name | Group | Group | Group | Group | Group | Group | Group |
| C₄H₅N₃O | Cytosine | 1 | 1 | 1 | 1 | 1 | 1 | 2 |

| | | | | | Calculated | Experimental | |
|---|---|---|---|---|---|---|---|
| | | C—C | C—N—C | NH | Total Bond | Total Bond | |
| Formula | Name | Group | Group | Group | Energy (eV) | Energy (eV) | Relative Error |
| C₄H₅N₃O | Cytosine | 1 | 1 | 1 | 59.53378 | 60.58056 | 0.01728 |

^{a}Crystal.

TABLE 38
The bond angle parameters of cytosine and experimental values [64]. In the calculation of θᵥ, the parameters from the
preceding angle were used. E_{T} is E_{T} (atom-atom, msp³.AO).

| | | | | | Atom 1 | | Atom 2 | |
|---|---|---|---|---|---|---|---|---|
| | 2c′ | 2c′ | 2c′ | | Hybridization | | Hybridization | |
| Atoms of | Bond 1 | Bond 2 | Terminal | E_{Coulombic} | Designation | E_{Coulombic} | Designation | c₂ |
| Angle | (a₀) | (a₀) | Atoms (a₀) | Atom 1 | (Table 8) | Atom 2 | (Table 8) | Atom 1 |
| ∠HNH | 1.88268 | 1.88268 | 3.1559 | −14.53414 | N | H | H | 0.93613 |
| | | | | | | | | Eq. (13.248) |
| ∠CₐNH | 2.53797 | 1.88268 | 3.8123 | −16.78642 | 19 | −14.53414 | N | 0.81052 |
| | | | | | | | | Eq. (15.71) |
| ∠N_{b}CₐC_{d} | 2.60766 | 2.74663 | 4.6476 | −14.53414 | N | −16.42414 | 13 | 0.84665 |
| | | | | | | | | Eq. (15.171) |
| ∠N_{b}CₐNₐ | 2.60766 | 2.53797 | 4.4272 | −15.39265 | 2 | −16.58181 | 16 | 0.88392 |
| ∠C_{d}CₐNₐ | | | | | | | | |
| ∠C_{b}N_{b}Cₐ | 2.64855 | 2.60766 | 4.4944 | −17.93127 | 38 | −16.78642 | 19 | 0.75878 |
| ∠N_{b}C_{b}N_{c} | 2.64855 | 2.59228 | 4.4721 | −16.58181 | 16 | −16.68411 | 17 | 0.82053 |
| ∠N_{c}C_{b}O | 2.59228 | 2.27954 | 4.2426 | −16.68411 | 17 | −16.17521 | 8 | 0.81549 |
| ∠N_{b}C_{b}O | | | | | | | | |
| ∠C_{b}N_{c}C_{c} | 2.59228 | 2.59228 | 4.4944 | −17.93127 | 38 | −16.88873 | 20 | 0.75878 |
| ∠N_{c}C_{c}C_{d} | 2.59228 | 2.53321 | 4.4272 | −14.53414 | N | −15.95955 | 6 | 0.84665 |
| | | | | | | | | Eq. (15.171) |
| ∠H_{c}N_{c}C_{c} | 1.88268 | 2.59228 | 3.8644 | −14.53414 | N | −16.68411 | 17 | 0.84665 |
| | | | | | | | | Eq. (15.171) |
| ∠H_{c}N_{c}C_{b} | | | | | | | | |
| ∠CₐC_{d}C_{c} | 2.74663 | 2.53321 | 4.5166 | −16.78642 | 19 | −17.81791 | 36 | 0.81052 |
| ∠H_{c}C_{c}C_{d} | 2.02241 | 2.53321 | 3.9833 | −15.95955 | 6 | −15.95955 | 6 | 0.85252 |
| ∠H_{c}C_{c}N_{c} | | | | | | | | |
| ∠H_{d}C_{d}C_{c} | 2.02241 | 2.53321 | 3.9833 | −15.95955 | 6 | −15.95955 | 6 | 0.85252 |
| ∠H_{d}C_{d}Cₐ | | | | | | | | |

| Atoms of | c₂ | | | | | E_{T} | θᵥ | θ₁ | θ₂ | Cal. θ | Exp. θ |
|---|---|---|---|---|---|---|---|---|---|---|---|
| Angle | Atom 2 | C₁ | C₂ | c₁ | c₂′ | (eV) | (°) | (°) | (°) | (°) | (°) |
| ∠HNH | 1 | 1 | 1 | 0.75 | 1.06823 | 0 | | | | 113.89 | 113.9 [1] |
| | | | | | | | | | | | (aniline) |
| ∠CₐNH | 0.77638 | 0.75 | 1 | 0.75 | 0.95787 | 0 | | | | 118.42 | 118 [65] |
| | Eq. (15.173) | | | | | | | | | | |
| ∠N_{b}CₐC_{d} | 0.82840 | 1 | 1 | 1 | 0.83753 | −1.65376 | | | | 120.43 | 121.4 |
| ∠N_{b}CₐNₐ | 0.82053 | 1 | 1 | 1 | 0.85222 | −1.44915 | | | | 118.71 | 117.5 |
| ∠C_{d}CₐNₐ | | | | | | | | 120.43 | 118.71 | 120.85 | 121.1 |
| ∠C_{b}N_{b}Cₐ | 0.81052 | 1 | 1 | 1 | 0.78465 | −1.85836 | | | | 117.53 | 120.3 |
| ∠N_{b}C_{b}N_{c} | 0.81549 | 1 | 1 | 1 | 0.81801 | −1.65376 | | | | 117.15 | 118.9 |
| ∠N_{c}C_{b}O | 0.84115 | 1 | 1 | 1 | 0.82832 | −1.44915 | | | | 120.98 | 119.8 |
| ∠N_{b}C_{b}O | | | | | | | | 117.15 | 120.98 | 121.87 | 121.3 |
| ∠C_{b}N_{c}C_{c} | 0.80561 | 1 | 1 | 1 | 0.78219 | −1.85836 | | | | 120.20 | 121.7 |
| ∠N_{c}C_{c}C_{d} | 0.85252 | 1 | 1 | 1 | 0.84958 | −1.44915 | | | | 119.48 | 121.4 |
| ∠H_{c}N_{c}C_{c} | 0.81549 | 0.75 | 1 | 0.75 | 0.96320 | 0 | | | | 118.58 | |
| ∠H_{c}N_{c}C_{b} | | | | | | | | 120.20 | 118.58 | 121.23 | |
| ∠CₐC_{d}C_{c} | 0.76360 | 1 | 1 | 1 | 0.78706 | −1.85836 | | | | 117.56 | 116.4 |
| ∠H_{c}C_{c}C_{d} | 0.85252 | 0.75 | 1 | 0.75 | 1.00000 | 0 | | | | 121.54 | |
| ∠H_{c}C_{c}N_{c} | | | | | | | | 119.48 | 121.54 | 118.99 | |
| ∠H_{d}C_{d}C_{c} | 0.85252 | 0.75 | 1 | 0.75 | 1.00000 | 0 | | | | 121.54 | |
| ∠H_{d}C_{d}Cₐ | | | | | | | | 117.56 | 121.54 | 120.90 | |

Alkyl Phosphines (CₙH₂ₙ₊₁ )₃P, n=1,2,3,4,5 . . . ∞)

The alkyl phosphines, (CₙH₂ₙ₊₁)₃P, comprise a P—C functional group. The alkyl portion of the alkyl phosphine may comprise at least two terminal methyl groups (CH₃) at each end of each chain, and may comprise methylene (CH₂), and methylyne (CH) functional groups as well as C bound by carbon-carbon single bonds. The methyl and methylene functional groups are equivalent to those of straight-chain alkanes. Six types of C—C bonds can be identified. The n-alkane C—C bond is the same as that of straight-chain alkanes. In addition, the C—C bonds within isopropyl ((CH₃)₂CH) and t-butyl ((CH₃)₃C) groups and the isopropyl to isopropyl, isopropyl to t-butyl, and t-butyl to t-butyl C—C bonds comprise functional groups. The branched-chain-alkane groups in alkyl phosphines are equivalent to those in branched-chain alkanes. The P—C group may further join the P3sp³ HO to an aryl HO.

As in the case of carbon, the bonding in the phosphorous atom involves sp³ hybridized orbitals formed, in this case, from the 3p and 3s electrons of the outer shells with five P3sp³ HOs rather than four C2sp³ HOs. The P—C bond forms between P3sp³ and C2sp³ HOs to yield phosphines. The semimajor axis a of the P—C functional group is solved using Eq. (15.51). Using the semimajor axis and the relationships between the prolate spheroidal axes, the geometric and energy parameters of the MO are calculated using Eqs. (15.1-15.117) in the same manner as the organic functional groups given in Organic Molecular Functional Groups and Molecules section.

The energy of phosphorous is less than the Coulombic energy between the electron and proton of H given by Eq. (1.231). A minimum energy is achieved while matching the potential, kinetic, and orbital energy relationships given in the Hydroxyl Radical (OH) section with hybridization of the phosphorous atom such that in Eqs. (15.51) and (15.61), the sum of the energies of the H₂-type ellipsoidal MOs is matched to that of the P3sp³ shell as in the case of the corresponding carbon and silicon molecules.

The P electron configuration is [Ne]3s²3p³ corresponding to the ground state ⁴S_{3/2}, and the 3sp³ hybridized orbital arrangement after Eq. (13.422) is

$$\frac{↑ ↓}{0 , 0} {\frac{↑}{1 , - 1} \frac{↑}{1 , 0}}^{3 {sp}^{3} state} \frac{↑}{1 , 1} \qquad ( 15.174 )$$

where the quantum numbers (l, mₗ) are below each electron. The total energy of the state is given by the sum over the five electrons. The sum E_{T}(P,3sp³) of experimental energies [38] of P, P⁺, P²⁺, P³⁺, and P⁴⁺ is

$$\begin{matrix}{E}_{T} ( P , 3 {sp}^{3} ) = 65.0251 eV + 51.4439 eV + \\ 30.2027 eV + 19.7695 eV + \\ 10.48669 eV \\ = 176.92789 eV\end{matrix} \qquad ( 15.175 )$$

By considering that the central field decreases by an integer for each successive electron of the shell, the radius r₃ₛₚ_{³} of the P3sp³ shell may be calculated from the Coulombic energy using Eq. (15.13):

$$\begin{matrix}{r}_{3 {sp}^{3}} = {\sum }_{n = 10}^{14} \frac{( Z - n ) {e}^{2}}{8 {πɛ}_{0} ( e 176.92789 eV )} \\ = \frac{15 {e}^{2}}{8 π {ɛ}_{0} ( e 176.92789 eV )} \\ = 1.15350 {a}_{0}\end{matrix} \qquad ( 15.176 )$$

where Z=15 for phosphorous. Using Eq. (15.14), the Coulombic energy E_{Coulomb}(P,3sp³) of
the outer electron of the P3sp³ shell is

$$\begin{matrix}{E}_{Coulomb} ( P , 3 {sp}^{3} ) = \frac{- {e}^{2}}{8 {πɛ}_{0} {r}_{3 {sp}^{3}}} \\ = \frac{- {e}^{2}}{8 {πɛ}_{0} 1.15350 {a}_{0}} \\ = - 11.79519 eV\end{matrix} \qquad ( 15.177 )$$

During hybridization, the spin-paired 3s electrons are promoted to P3sp³ shell as paired electrons at the radius r₃ₛₚ_{³} of the P3sp³ shell. The energy for the promotion is the difference in the magnetic energy given by Eq. (15.15) at the initial radius of the 3s electrons and the final radius of the P3sp³ electrons. From Eq. (10.255) with Z=15, the radius R₁₂ of P3s shell is

r₁₂=1.09443a₀ (15.178)

Using Eqs. (15.15) and (15.178), the unpairing energy is

$$\begin{matrix}E ( magnetic ) = \frac{2 {πμ}_{0} {e}^{2} {ℏ}^{2}}{{m}_{e}^{2}} ( \frac{1}{{( {r}_{12} )}^{3}} - \frac{1}{{( {r}_{3 {sp}^{3}} )}^{3}} ) \\ = 8 {πμ}_{o} {μ}_{B}^{2} ( \frac{1}{{( 1.09443 {a}_{0} )}^{3}} - \frac{1}{{( 1.15350 {a}_{0} )}^{3}} ) \\ = 0.01273 eV\end{matrix} \qquad ( 15.179 )$$

Using Eqs. (15.177) and (15.179), the energy E(P,3sp³) of the outer electron of the P3sp³ shell is

$$\begin{matrix}E ( P , 3 {sp}^{3} ) = \frac{- {e}^{2}}{8 {πɛ}_{0} {r}_{3 {sp}^{3}}} + \frac{2 {πμ}_{0} {e}^{2} {ℏ}^{2}}{{m}_{e}^{2}} ( \frac{1}{{( {r}_{12} )}^{3}} - \frac{1}{{( {r}_{3 {sp}^{3}} )}^{3}} ) \\ = - 11.79519 eV + 0.01273 eV \\ = - 11.78246 eV\end{matrix} \qquad ( 15.180 )$$

For the P—C functional group, hybridization of the 2s and 2p AOs of each C and the 3s and 3p AOs of each P to form single 2sp³ and 3sp³ shells, respectively, forms an energy minimum, and the sharing of electrons between the C2sp³ and P3sp³ HOs to form a MO permits each participating orbital to decrease in radius and energy. In branched-chain alkyl phosphines, the energy of phosphorous is less than the Coulombic energy between the electron and proton of H given by Eq. (1.231). Thus, c₂ in Eq. (15.61) is one, and the energy matching condition is determined by the C₂ parameter. Then, the C2sp³ HO has an energy of E(C,2sp³)=−14.63489 eV (Eq. (15.25)), and the P3sp³ HO has an energy of E(P,3sp³)=−11.78246 eV (Eq. (15.180)). To meet the equipotential condition of the union of the P—C H₂-type-ellipsoidal-MO with these orbitals, the hybridization factor C₂ of Eq. (15.61) for the P—C-bond MO given by Eqs. (15.77), (15.79), and (13.430) is

$$\begin{matrix}{C}_{2} ( C 2 {sp}^{3} HO to P 3 {sp}^{3} HO ) = \frac{E ( P , 3 {sp}^{3} )}{E ( C , 2 {sp}^{3} )} {c}_{2} ( C 2 {sp}^{3} HO ) \\ = \frac{- 11.78246 eV}{- 14.63489 eV} ( 0.91771 ) \\ = 0.73885\end{matrix} \qquad ( 15.181 )$$

The energy of the P—C-bond MO is the sum of the component energies of the H₂-type ellipsoidal MO given in Eq. (15.51) with E(AO/HO)=E(P,3sp³) given by Eq. (15.180), and E_{T}(atom-atom,msp³.AO) is one half −0.72457 eV given by Eq. (14.151) in order to match the energies of the carbon and phosphorous HOs.

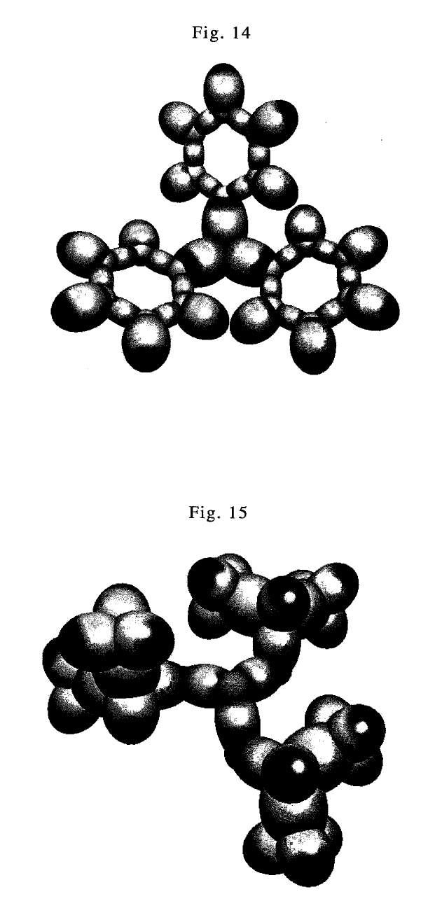

The symbols of the functional groups of branched-chain alkyl phosphines are given in Table 39. The geometrical (Eqs. (15.1-15.5) and (15.51)), intercept (Eqs. (15.80-15.87)), and energy (Eqs. (15.6-15.11) and (15.17-15.65)) parameters of alkyl phosphines are given in Tables 40, 41, and 42, respectively. The total energy of each alkyl phosphine given in Table 43 was calculated as the sum over the integer multiple of each E_{D}(Group) of Table 42 corresponding to functional-group composition of the molecule. The bond angle parameters of alkyl phosphines determined using Eqs. (15.88-15.117) are given in Table 44. The color scale, charge-density of exemplary alkyl phosphine, triphenylphosphine, comprising atoms with the outer shell bridged by one or more H₂-type ellipsoidal MOs or joined with one or more hydrogen MOs is shown in FIG. 14.

TABLE 39
The symbols of functional groups of alkyl phosphines.

| Functional Group | Group Symbol |
|---|---|
| P—C | P—C |
| CH₃ group | C—H (CH₃) |
| CH₂ group | C—H (CH₂) |
| CH | C—H (i) |
| CC bond (n-C) | C—C (a) |
| CC bond (iso-C) | C—C (b) |
| CC bond (tert-C) | C—C (c) |
| CC (iso to iso-C) | C—C (d) |
| CC (t to t-C) | C—C (e) |
| CC (t to iso-C) | C—C (f) |
| CC (aromatic bond) | C^{3e}═C |
| CH (aromatic) | CH (ii) |

TABLE 40
The geometrical bond parameters of alkyl phosphines and experimental values [1].

| | P—C | C—H(CH₃) | C—H(CH₂) | C—H (i) | C—C (a) | C—C (b) |
|---|---|---|---|---|---|---|
| Parameter | Group | Group | Group | Group | Group | Group |
| a (a₀) | 2.29513 | 1.64920 | 1.67122 | 1.67465 | 2.12499 | 2.12499 |
| c′ (a₀) | 1.76249 | 1.04856 | 1.05553 | 1.05661 | 1.45744 | 1.45744 |
| Bond Length 2c′ (Å) | 1.86534 | 1.10974 | 1.11713 | 1.11827 | 1.54280 | 1.54280 |
| Exp. Bond Length | 1.847 | 1.107 | 1.107 | 1.122 | 1.532 | 1.532 |
| (Å) | ((CH₃)₂PCH₃) | (C—H | (C—H | (isobutane) | (propane) | (propane) |
| | 1.858 | propane) | propane) | | 1.531 | 1.531 |
| | (H₂PCH₃) | 1.117 | 1.117 | | (butane) | (butane) |
| | | (C—H | (C—H | | | |
| | | butane) | butane) | | | |
| b, c (a₀) | 1.47012 | 1.27295 | 1.29569 | 1.29924 | 1.54616 | 1.54616 |
| e | 0.76793 | 0.63580 | 0.63159 | 0.63095 | 0.68600 | 0.68600 |
| a (a₀) | 2.29513 | 1.64920 | 1.67122 | 1.67465 | 2.12499 | 2.12499 |
| c′ (a₀) | 1.76249 | 1.04856 | 1.05553 | 1.05661 | 1.45744 | 1.45744 |
| Bond Length 2c′ (Å) | 1.86534 | 1.10974 | 1.11713 | 1.11827 | 1.54280 | 1.54280 |
| Exp. Bond Length | 1.847 | 1.107 | 1.107 | 1.122 | 1.532 | 1.532 |
| (Å) | ((CH₃)₂PCH₃) | (C—H | (C—H | (isobutane) | (propane) | (propane) |
| | 1.858 | propane) | propane) | | 1.531 | 1.531 |
| | (H₂PCH₃) | 1.117 | 1.117 | | (butane) | (butane) |
| | | (C—H | (C—H | | | |
| | | butane) | butane) | | | |
| b, c (a₀) | 1.47012 | 1.27295 | 1.29569 | 1.29924 | 1.54616 | 1.54616 |
| e | 0.76793 | 0.63580 | 0.63159 | 0.63095 | 0.68600 | 0.68600 |

| | C—C (c) | C—C (d) | C—C (e) | C—C (f) | C^{3e}═C | CH (ii) |
|---|---|---|---|---|---|---|
| Parameter | Group | Group | Group | Group | Group | Group |
| a (a₀) | 2.10725 | 2.12499 | 2.10725 | 2.10725 | 1.47348 | 1.60061 |
| c′ (a₀) | 1.45164 | 1.45744 | 1.45164 | 1.45164 | 1.31468 | 1.03299 |
| Bond Length 2c′ (Å) | 1.53635 | 1.54280 | 1.53635 | 1.53635 | 1.39140 | 1.09327 |
| Exp. Bond Length | 1.532 | 1.532 | 1.532 | 1.532 | 1.399 | 1.101 |
| (Å) | (propane) | (propane) | (propane) | (propane) | (benzene) | (benzene) |
| | 1.531 | 1.531 | 1.531 | 1.531 | | |
| | (butane) | (butane) | (butane) | (butane) | | |
| b, c (a₀) | 1.52750 | 1.54616 | 1.52750 | 1.52750 | 0.66540 | 1.22265 |
| e | 0.68888 | 0.68600 | 0.68888 | 0.68888 | 0.89223 | 0.64537 |
| a (a₀) | 2.10725 | 2.12499 | 2.10725 | 2.10725 | 1.47348 | 1.60061 |
| c′ (a₀) | 1.45164 | 1.45744 | 1.45164 | 1.45164 | 1.31468 | 1.03299 |
| Bond Length 2c′ (Å) | 1.53635 | 1.54280 | 1.53635 | 1.53635 | 1.39140 | 1.09327 |
| Exp. Bond Length | 1.532 | 1.532 | 1.532 | 1.532 | 1.399 | 1.101 |
| (Å) | (propane) | (propane) | (propane) | (propane) | (benzene) | (benzene) |
| | 1.531 | 1.531 | 1.531 | 1.531 | | |
| | (butane) | (butane) | (butane) | (butane) | | |
| b, c (a₀) | 1.52750 | 1.54616 | 1.52750 | 1.52750 | 0.66540 | 1.22265 |
| e | 0.68888 | 0.68600 | 0.68888 | 0.68888 | 0.89223 | 0.64537 |

TABLE 41
The MO to HO intercept geometrical bond parameters of alkyl phosphines. R₁ is an alkyl group and R, R′, R″ are H or
alkyl groups. E_{T} is E_{T} (atom-atom, msp³.AO).

| | | | | | | Final Total | | |
|---|---|---|---|---|---|---|---|---|
| | | E_{T} | E_{T} | E_{T} | E_{T} | Energy | | |
| | | (eV) | (eV) | (eV) | (eV) | C2sp³ | rᵢₙᵢₜᵢₐₗ | r_{final} |
| Bond | Atom | Bond 1 | Bond 2 | Bond 3 | Bond 4 | (eV) | (a₀) | (a₀) |
| C—H (CH₃) | C | −0.36229 | 0 | 0 | 0 | −151.97798 | 0.91771 | 0.89582 |
| (CH₃)₂P—CH₃ | C | −0.18114 | 0 | 0 | 0 | | 0.91771 | 0.90664 |
| (CH₃)₂P—CH₃ | P | −0.18114 | −0.18114 | −0.18114 | 0 | | 1.15350 | 0.88527 |
| C—H (CH₃) | C | −0.92918 | 0 | 0 | 0 | −152.54487 | 0.91771 | 0.86359 |
| C—H (CH₂) | C | −0.92918 | −0.92918 | 0 | 0 | −153.47406 | 0.91771 | 0.81549 |
| C—H (CH) | C | −0.92918 | −0.92918 | −0.92918 | 0 | −154.40324 | 0.91771 | 0.77247 |
| H₃CₐC_{b}H₂CH₂—(C—C (a)) | Cₐ | −0.92918 | 0 | 0 | 0 | −152.54487 | 0.91771 | 0.86359 |
| H₃CₐC_{b}H₂CH₂—(C—C (a)) | C_{b} | −0.92918 | −0.92918 | 0 | 0 | −153.47406 | 0.91771 | 0.81549 |
| R—H₂CₐC_{b}(H₂C_{c}—R′)HCH₂—(C—C (b)) | C_{b} | −0.92918 | −0.92918 | −0.92918 | 0 | −154.40324 | 0.91771 | 0.77247 |
| R—H₂Cₐ(R′—H₂C_{d})C_{b}(R″—H₂C_{c})CH₂—(C—C (c)) | C_{b} | −0.92918 | −0.72457 | −0.72457 | −0.72457 | −154.71860 | 0.91771 | 0.75889 |
| isoCₐC_{b}(H₂C_{c}—R′)HCH₂—(C—C (d)) | C_{b} | −0.92918 | −0.92918 | −0.92918 | 0 | −154.40324 | 0.91771 | 0.77247 |
| tertCₐ(R′—H₂C_{d})C_{b}(R″—H₂C_{c})CH₂—(C—C (e)) | C_{b} | −0.72457 | −0.72457 | −0.72457 | −0.72457 | −154.51399 | 0.91771 | 0.76765 |
| tertCₐC_{b}(H₂C_{c}—R′)HCH₂—(C—C (f)) | C_{b} | −0.72457 | −0.92918 | −0.92918 | 0 | −154.19863 | 0.91771 | 0.78155 |
| isoCₐ(R′—H₂C_{d})C_{b}(R″—H₂C_{c})CH₂—(C—C (f)) | C_{b} | −0.72457 | −0.72457 | −0.72457 | −0.72457 | −154.51399 | 0.91771 | 0.76765 |

| | E_{Coulomb} | E (C2sp³) | | | | | |
|---|---|---|---|---|---|---|---|
| | (eV) | (eV) | θ′ | θ₁ | θ₂ | d₁ | d₂ |
| Bond | Final | Final | (°) | (°) | (°) | (a₀) | (a₀) |
| C—H (CH₃) | −15.18804 | −14.99717 | 81.24 | 98.76 | 44.07 | 1.18494 | 0.13638 |
| (CH₃)₂P—CH₃ | −15.00689 | −14.81603 | 87.12 | 92.88 | 38.02 | 1.80811 | 0.04562 |
| (CH₃)₂P—CH₃ | −15.36918 | | 85.24 | 94.76 | 36.88 | 1.83594 | 0.07345 |
| C—H (CH₃) | −15.75493 | −15.56407 | 77.49 | 102.51 | 41.48 | 1.23564 | 0.18708 |
| C—H (CH₂) | −16.68412 | −16.49325 | 68.47 | 111.53 | 35.84 | 1.35486 | 0.29933 |
| C—H (CH) | −17.61330 | −17.42244 | 61.10 | 118.90 | 31.37 | 1.42988 | 0.37326 |
| H₃CₐC_{b}H₂CH₂—(C—C (a)) | −15.75493 | −15.56407 | 63.82 | 116.18 | 30.08 | 1.83879 | 0.38106 |
| H₃CₐC_{b}H₂CH₂—(C—C (a)) | −16.68412 | −16.49325 | 56.41 | 123.59 | 26.06 | 1.90890 | 0.45117 |
| R—H₂CₐC_{b}(H₂C_{c}—R′)HCH₂—(C—C (b)) | −17.61330 | −17.42244 | 48.30 | 131.70 | 21.90 | 1.97162 | 0.51388 |
| R—H₂Cₐ(R′—H₂C_{d})C_{b}(R″—H₂C_{c})CH₂—(C—C (c)) | −17.92866 | −17.73779 | 48.21 | 131.79 | 21.74 | 1.95734 | 0.50570 |
| isoCₐC_{b}(H₂C_{c}—R′)HCH₂—(C—C (d)) | −17.61330 | −17.42244 | 48.30 | 131.70 | 21.90 | 1.97162 | 0.51388 |
| tertCₐ(R′—H₂C_{d})C_{b}(R″—H₂C_{c})CH₂—(C—C (e)) | −17.92866 | −17.73779 | 50.04 | 129.96 | 22.66 | 1.94462 | 0.49298 |
| tertCₐC_{b}(H₂C_{c}—R′)HCH₂—(C—C (f)) | −17.40869 | −17.21783 | 52.78 | 127.22 | 24.04 | 1.92443 | 0.47279 |
| isoCₐ(R′—H₂C_{d})C_{b}(R″—H₂C_{c})CH₂—(C—C (f)) | −17.92866 | −17.73779 | 50.04 | 129.96 | 22.66 | 1.94462 | 0.49298 |

TABLE 42
The energy parameters (eV) of functional groups of alkyl phosphines.

| | P—C | CH₃ | CH₂ | CH (i) | C—C (a) |
|---|---|---|---|---|---|
| Parameters | Group | Group | Group | Group | Group |
| f₁ | 1 | 1 | 1 | 1 | 1 |
| n₁ | 1 | 3 | 2 | 1 | 1 |
| n₂ | 0 | 2 | 1 | 0 | 0 |
| n₃ | 0 | 0 | 0 | 0 | 0 |
| C₁ | 0.5 | 0.75 | 0.75 | 0.75 | 0.5 |
| C₂ | 0.73885 | 1 | 1 | 1 | 1 |
| c₁ | 1 | 1 | 1 | 1 | 1 |
| c₂ | 1 | 0.91771 | 0.91771 | 0.91771 | 0.91771 |
| c₃ | 0 | 0 | 1 | 1 | 0 |
| c₄ | 2 | 1 | 1 | 1 | 2 |
| c₅ | 0 | 3 | 2 | 1 | 0 |
| C₁ₒ | 0.5 | 0.75 | 0.75 | 0.75 | 0.5 |
| C₂ₒ | 0.73885 | 1 | 1 | 1 | 1 |
| Vₑ (eV) | −31.34959 | −107.32728 | −70.41425 | −35.12015 | −28.79214 |
| Vₚ (eV) | 7.71965 | 38.92728 | 25.78002 | 12.87680 | 9.33352 |
| T (eV) | 6.82959 | 32.53914 | 21.06675 | 10.48582 | 6.77464 |
| Vₘ (eV) | −3.41479 | −16.26957 | −10.53337 | −5.24291 | −3.38732 |
| E (AO/HO) (eV) | −11.78246 | −15.56407 | −15.56407 | −14.63489 | −15.56407 |
| ΔE_{H}_{₂}_{MO} (AO/HO) (eV) | −0.36229 | 0 | 0 | 0 | 0 |
| E_{T} (AO/HO) (eV) | −11.42017 | −15.56407 | −15.56407 | −14.63489 | −15.56407 |
| E_{T} (H₂MO) (eV) | −31.63532 | −67.69451 | −49.66493 | −31.63533 | −31.63537 |
| E_{T} (atom-atom, msp³.AO) (eV) | −0.36229 | 0 | 0 | 0 | −1.85836 |
| E_{T} (Mo) (eV) | −31.99766 | −67.69450 | −49.66493 | −31.63537 | −33.49373 |
| ω (10¹⁵ rad/s) | 7.22663 | 24.9286 | 24.2751 | 24.1759 | 9.43699 |
| E_{K} (eV) | 4.75669 | 16.40846 | 15.97831 | 15.91299 | 6.21159 |
| Ē_{D} (eV) | −0.13806 | −0.25352 | −0.25017 | −0.24966 | −0.16515 |
| Ē_{Kvib} (eV) | 0.17606 [67] | 0.35532 | 0.35532 | 0.35532 | 0.12312 [2] |
| | | (Eq. (13.458)) | (Eq. (13.458)) | (Eq. (13.458)) | |
| Ē_{osc} (eV) | −0.05003 | −0.22757 | −0.14502 | −0.07200 | −0.10359 |
| E_{mag} (eV) | 0.14803 | 0.14803 | 0.14803 | 0.14803 | 0.14803 |
| E_{T} (Group) (eV) | −32.04769 | −67.92207 | −49.80996 | −31.70737 | −33.59732 |
| Eᵢₙᵢₜᵢₐₗ (c₄ AO/HO) (eV) | −14.63489 | −14.63489 | −14.63489 | −14.63489 | −14.63489 |
| Eᵢₙᵢₜᵢₐₗ (c₅ AO/HO) (eV) | 0 | −13.59844 | −13.59844 | −13.59844 | 0 |
| E_{D} (Group) (eV) | 2.77791 | 12.49186 | 7.83016 | 3.32601 | 4.32754 |

| | C—C (b) | C—C (c) | C—C (d) | C—C (e) | C—C (f) | C^{3e}═C | CH (ii) |
|---|---|---|---|---|---|---|---|
| Parameters | Group | Group | Group | Group | Group | Group | Group |
| f₁ | 1 | 1 | 1 | 1 | 1 | 0.75 | 1 |
| n₁ | 1 | 1 | 1 | 1 | 1 | 2 | 1 |
| n₂ | 0 | 0 | 0 | 0 | 0 | 0 | 0 |
| n₃ | 0 | 0 | 0 | 0 | 0 | 0 | 0 |
| C₁ | 0.5 | 0.5 | 0.5 | 0.5 | 0.5 | 0.5 | 0.75 |
| C₂ | 1 | 1 | 1 | 1 | 1 | 0.85252 | 1 |
| c₁ | 1 | 1 | 1 | 1 | 1 | 1 | 1 |
| c₂ | 0.91771 | 0.91771 | 0.91771 | 0.91771 | 0.91771 | 0.85252 | 0.91771 |
| c₃ | 0 | 0 | 1 | 1 | 0 | 0 | 1 |
| c₄ | 2 | 2 | 2 | 2 | 2 | 3 | 1 |
| c₅ | 0 | 0 | 0 | 0 | 0 | 0 | 1 |
| C₁ₒ | 0.5 | 0.5 | 0.5 | 0.5 | 0.5 | 0.5 | 0.75 |
| C₂ₒ | 1 | 1 | 1 | 1 | 1 | 0.85252 | 1 |
| Vₑ (eV) | −28.79214 | −29.10112 | −28.79214 | −29.10112 | −29.10112 | −101.12679 | −37.10024 |
| Vₚ (eV) | 9.33352 | 9.37273 | 9.33352 | 9.37273 | 9.37273 | 20.69825 | 13.17125 |
| T (eV) | 6.77464 | 6.90500 | 6.77464 | 6.90500 | 6.90500 | 34.31559 | 11.58941 |
| Vₘ (eV) | −3.38732 | −3.45250 | −3.38732 | −3.45250 | −3.45250 | −17.15779 | −5.79470 |
| E (AO/HO) (eV) | −15.56407 | −15.35946 | −15.56407 | −15.35946 | −15.35946 | 0 | −14.63489 |
| ΔE_{H}_{₂}_{MO} (AO/HO) (eV) | 0 | 0 | 0 | 0 | 0 | 0 | −1.13379 |
| E_{T} (AO/HO) (eV) | −15.56407 | −15.35946 | −15.56407 | −15.35946 | −15.35946 | 0 | −13.50110 |
| E_{T} (H₂MO) (eV) | −31.63537 | −31.63535 | −31.63537 | −31.63535 | −31.63535 | −63.27075 | −31.63539 |
| E_{T} (atom-atom, msp³.AO) (eV) | −1.85836 | −1.44915 | −1.85836 | −1.44915 | −1.44915 | −2.26759 | −0.56690 |
| E_{T} (MO) (eV) | −33.49373 | −33.08452 | −33.49373 | −33.08452 | −33.08452 | −65.53833 | −32.20226 |
| ω (10¹⁵ rad/s) | 9.43699 | 15.4846 | 9.43699 | 9.55643 | 9.55643 | 49.7272 | 26.4826 |
| E_{K} (eV) | 6.21159 | 10.19220 | 6.21159 | 6.29021 | 6.29021 | 32.73133 | 17.43132 |
| Ē_{D} (eV) | −0.16515 | −0.20896 | −0.16515 | −0.16416 | −0.16416 | −0.35806 | −0.26130 |
| Ē_{Kvib} (eV) | 0.17978 [4] | 0.09944 [5] | 0.12312 [2] | 0.12312 [2] | 0.12312 [2] | 0.19649 [49] | 0.35532 |
| | | | | | | | Eq. (13.458) |
| Ē_{osc} (eV) | −0.07526 | −0.15924 | −0.10359 | −0.10260 | −0.10260 | −0.25982 | −0.08364 |
| E_{mag} (eV) | 0.14803 | 0.14803 | 0.14803 | 0.14803 | 0.14803 | 0.14803 | 0.14803 |
| E_{T} (Group) (eV) | −33.49373 | −33.24376 | −33.59732 | −33.18712 | −33.18712 | −49.54347 | −32.28590 |
| Eᵢₙᵢₜᵢₐₗ (c₄ AO/HO) (eV) | −14.63489 | −14.63489 | −14.63489 | −14.63489 | −14.63489 | −14.63489 | −14.63489 |
| Eᵢₙᵢₜᵢₐₗ (c₅ AO/HO) (eV) | 0 | 0 | 0 | 0 | 0 | 0 | −13.59844 |
| E_{D} (Group) (eV) | 4.29921 | 3.97398 | 4.17951 | 3.62128 | 3.91734 | 5.63881 | 3.90454 |

TABLE 43
The total bond energies of alkyl phosphines calculated using the functional group
composition and the energies of Table 42 compared to the experimental values [68].

| Formula | Name | P—C | CH₃ | CH₂ | CH (i) | C—C (a) | C—C (b) | C—C (c) | C—C (d) |
|---|---|---|---|---|---|---|---|---|---|
| C₃H₉P | Trimethylphosphine | 3 | 3 | 0 | 0 | 0 | 0 | 0 | 0 |
| C₆H₁₅P | Triethylphosphine | 3 | 3 | 3 | 0 | 3 | 0 | 0 | 0 |
| C₁₈H₁₅P | Triphenylphosphine | 3 | 0 | 0 | 0 | 0 | 0 | 0 | 0 |

| | | | | | | Calculated | Experimental | |
|---|---|---|---|---|---|---|---|---|
| | | | | | | Total Bond | Total Bond | Relative |
| Formula | Name | C—C (e) | C—C (f) | C3e═C | CH (ii) | Energy (eV) | Energy (eV) | Error |
| C₃H₉P | Trimethylphosphine | 0 | 0 | 0 | 0 | 45.80930 | 46.87333 | 0.02270 |
| C₆H₁₅P | Triethylphosphine | 0 | 0 | 0 | 0 | 82.28240 | 82.24869 | −0.00041 |
| C₁₈H₁₅P | Triphenylphosphine | 0 | 0 | 18 | 15 | 168.40033 | 167.46591 | −0.00558 |

TABLE 44
The bond angle parameters of alkyl phosphines and experimental values [1].
In the calculation of θᵥ, the parameters from the preceding angle
were used. E_{T} is E_{T} (atom-atom, msp³.AO).

| | | | | | Atom 1 | | Atom 2 | |
|---|---|---|---|---|---|---|---|---|
| | | | 2c′ | E_{Coulombic} | Hybridization | | Hybridization | |
| Atoms of | 2c′ | 2c′ | Terminal | or E | Designation | E_{Coulombic} | Designation | c₂ |
| Angle | Bond 1 (a₀) | Bond 2 (a₀) | Atoms (a₀) | Atom 1 | (Table 7) | Atom 2 | (Table 7) | Atom 1 |
| Methyl | 2.09711 | 2.09711 | 3.4252 | −15.75493 | 7 | H | H | 0.86359 |
| ∠HCₐH | | | | | | | | |
| ∠HₐCₐP | | | | | | | | |
| ∠CₐPC_{b} | 3.52498 | 3.52498 | 5.3479 | −15.93607 | 9 | −15.93607 | 9 | 0.85377 |
| Methylene | 2.11106 | 2.11106 | 3.4252 | −15.75493 | 7 | H | H | 0.86359 |
| ∠HCₐH | | | | | | | | |
| ∠CₐC_{b}C_{c} | | | | | | | | |
| ∠CₐC_{b}H | | | | | | | | |
| Methyl | 2.09711 | 2.09711 | 3.4252 | −15.75493 | 7 | H | H | 0.86359 |
| ∠HCₐH | | | | | | | | |
| ∠CₐC_{b}C_{c} | | | | | | | | |
| ∠CₐC_{b}H | | | | | | | | |
| ∠C_{b}CₐC_{c} | 2.91547 | 2.91547 | 4.7958 | −16.68412 | 26 | −16.68412 | 26 | 0.81549 |
| iso Cₐ | | | | C_{b} | | C_{c} | | |
| ∠C_{b}CₐH | 2.91547 | 2.11323 | 4.1633 | −15.55033 | 5 | −14.82575 | 1 | 0.87495 |
| iso Cₐ | | | | Cₐ | | C_{b} | | |
| ∠CₐC_{b}H | 2.91547 | 2.09711 | 4.1633 | −15.55033 | 5 | −14.82575 | 1 | 0.87495 |
| iso Cₐ | | | | C_{b} | | Cₐ | | |
| ∠C_{b}CₐC_{b} | 2.90327 | 2.90327 | 4.7958 | −16.68412 | 26 | −16.68412 | 26 | 0.81549 |
| tert Cₐ | | | | C_{b} | | C_{b} | | |
| ∠C_{b}CₐC_{d} | | | | | | | | |

| Atoms of | c₂ | | | | | E_{T} | θᵥ | θ₁ | θ₂ | Cal. θ | Exp. θ |
|---|---|---|---|---|---|---|---|---|---|---|---|
| Angle | Atom 2 | C₁ | C₂ | c₁ | c₂′ | (eV) | (°) | (°) | (°) | (°) | (°) |
| Methyl | 1 | 1 | 1 | 0.75 | 1.15796 | 0 | | | | 109.50 | |
| ∠HCₐH | | | | | | | | | | | |
| ∠HₐCₐP | | | | | | | 70.56 | | | 109.44 | 110.7 |
| | | | | | | | | | | | (trimethyl |
| | | | | | | | | | | | phosphine) |
| ∠CₐPC_{b} | 0.85377 | 1 | 1 | 1 | 0.85377 | −1.85836 | | | | 98.68 | 98.6 |
| | | | | | | | | | | | (trimethyl |
| | | | | | | | | | | | phosphine) |
| Methylene | 1 | 1 | 1 | 0.75 | 1.15796 | 0 | | | | 108.44 | 107 |
| ∠HCₐH | | | | | | | | | | | (propane) |
| ∠CₐC_{b}C_{c} | | | | | | | 69.51 | | | 110.49 | 112 |
| | | | | | | | | | | | (propane) |
| | | | | | | | | | | | 113.8 |
| | | | | | | | | | | | (butane) |
| | | | | | | | | | | | 110.8 |
| | | | | | | | | | | | (isobutane) |
| ∠CₐC_{b}H | | | | | | | 69.51 | | | 110.49 | 111.0 |
| | | | | | | | | | | | (butane) |
| | | | | | | | | | | | 111.4 |
| | | | | | | | | | | | (isobutane) |
| Methyl | 1 | 1 | 1 | 0.75 | 1.15796 | 0 | | | | 109.50 | |
| ∠HCₐH | | | | | | | | | | | |
| ∠CₐC_{b}C_{c} | | | | | | | 70.56 | | | 109.44 | |
| ∠CₐC_{b}H | | | | | | | 70.56 | | | 109.44 | |
| ∠C_{b}CₐC_{c} | 0.81549 | 1 | 1 | 1 | 0.81549 | −1.85836 | | | | 110.67 | 110.8 |
| iso Cₐ | | | | | | | | | | | (isobutane) |
| ∠C_{b}CₐH | 0.91771 | 0.75 | 1 | 0.75 | 1.04887 | 0 | | | | 110.76 | |
| iso Cₐ | | | | | | | | | | | |
| ∠CₐC_{b}H | 0.91771 | 0.75 | 1 | 0.75 | 1.04887 | 0 | | | | 111.27 | 111.4 |
| iso Cₐ | | | | | | | | | | | (isobutane) |
| ∠C_{b}CₐC_{b} | 0.81549 | 1 | 1 | 1 | 0.81549 | −1.85836 | | | | 111.37 | 110.8 |
| tert Cₐ | | | | | | | | | | | (isobutane) |
| ∠C_{b}CₐC_{d} | | | | | | | 72.50 | | | 107.50 | |

Alkyl Phosphites (CₙH₂ₙ₊₁O)₃P, n=1,2,3,4,5 . . . ∞)

The alkyl phosphites, (CₙH₂ₙ₊₁O)₃P, comprise P—O and C—O functional groups. The alkyl portion of the alkyl phosphite may comprise at least two terminal methyl groups (CH₃) at each end of each chain, and may comprise methylene (CH₂), and methylyne (CH) functional groups as well as C bound by carbon-carbon single bonds. The methyl and methylene functional groups are equivalent to those of straight-chain alkanes. Six types of C—C bonds can be identified. The n-alkane C—C bond is the same as that of straight-chain alkanes. In addition, the C—C bonds within isopropyl ((CH₃)₂CH) and t-butyl ((CH₃)₃C) groups and the isopropyl to isopropyl, isopropyl to t-butyl, and t-butyl to t-butyl C—C bonds comprise functional groups. The branched-chain-alkane groups in alkyl phosphites are equivalent to those in branched-chain alkanes.

The ether portion comprises two types of C—O functional groups, one for methyl or t-butyl groups corresponding to the C, and the other for general alkyl groups that are equivalent to those in the Ethers section. The P—O bond forms between the P3sp³ HO and an O2p AO to yield phosphites. The semimajor axis a of the P—O functional group is solved using Eq. (15.51). Using the semimajor axis and the relationships between the prolate spheroidal axes, the geometric and energy parameters of the MO are calculated using Eqs. (15.1-15.117) in the same manner as the organic functional groups given in Organic Molecular Functional Groups and Molecules section.

For the P—O functional group, hybridization the 3s and 3p AOs of each to form a single 3sp³ shell forms an energy minimum, and the sharing of electrons between the O2p AOs and P3sp³ HOs to form a MO permits each participating orbital to decrease in radius and energy. The O AO has an energy of E(O)=—13.61805 eV, and the P3sp³ HO has an energy of E(P,3sp³)=−11.78246 eV (Eq. (15.180)). In branched-chain alkyl phosphites, the energy matching condition is determined by the c₂ and C₂ parameters of Eq. (15.51) given by Eqs. (15.77), (15.79), and (13.430):

$$\begin{matrix}{c}_{2} and {C}_{2} ( O 2 p AO to P 3 {sp}^{3} HO ) = \frac{E ( P , 3 {sp}^{3} )}{E ( O , 2 p )} {c}_{2} ( C 2 {sp}^{3} HO ) \\ = \frac{- 11.78246 eV}{- 13.61805 eV} ( 0.91771 ) \\ = 0.79401\end{matrix} \qquad ( 15.182 )$$

The energy of the P—O-bond MO is the sum of the component energies of the H₂-type ellipsoidal MO given in Eq. (15.51) with E (AO/HO) being E (P,3sp³) given by Eq. (23.180), and E_{T}(atom-atom,msp³.AO) is equivalent to that of single bond, −1.44914 eV, given by twice Eq. (14.151) in order to match the energies of the oxygen AO with the phosphorous and carbon HOs.

The symbols of the functional groups of branched-chain alkyl phosphites are given in Table 45. The geometrical (Eqs. (15.1-15.5) and (15.51)), intercept (Eqs. (15.80-15.87)), and energy (Eqs. (15.6-15.11) and (15.17-15.65)) parameters of alkyl phosphites are given in Tables 46, 47, and 48, respectively. The total energy of each alkyl phosphite given in Table 49 was calculated as the sum over the integer multiple of each E_{D}(Group) of Table 48 corresponding to functional-group composition of the molecule. The bond angle parameters of alkyl phosphites determined using Eqs. (15.88-15.117) are given in Table 50. The color scale, charge-density of exemplary alkyl phosphite, tri-isopropyl phosphite, comprising atoms with the outer shell bridged by one or more H₂-type ellipsoidal MOs or joined with one or more hydrogen MOs is shown in FIG. 15.

TABLE 45
The symbols of functional groups of alkyl phosphites.

| Functional Group | Group Symbol |
|---|---|
| P—O | P—O |
| C—O (CH₃—O- and (CH₃)₃C—O—) | C—O (i) |
| C—O (alkyl) | C—O (ii) |
| CH₂ group | C—H (CH₂) |
| CH | C—H |
| CC bond (n-C) | C—C (a) |
| CC bond (iso-C) | C—C (b) |
| CC bond (tert-C) | C—C (c) |
| CC (iso to iso-C) | C—C (d) |
| CC (t to t-C) | C—C (e) |
| CC (t to iso-C) | C—C (f) |

TABLE 46
The geometrical bond parameters of alkyl phosphites and experimental values [1].

| | P—O | C—O (i) | C—O (ii) | C—H(CH₃) | C—H(CH₂) | C—H |
|---|---|---|---|---|---|---|
| Parameter | Group | Group | Group | Group | Group | Group |
| a (a₀) | 1.84714 | 1.80717 | 1.79473 | 1.64920 | 1.67122 | 1.67465 |
| c′ (a₀) | 1.52523 | 1.34431 | 1.33968 | 1.04856 | 1.05553 | 1.05661 |
| Bond Length 2c′ (Å) | 1.61423 | 1.42276 | 1.41785 | 1.10974 | 1.11713 | 1.11827 |
| Exp. Bond Length | 1.631 [69] | 1.416 | 1.418 | 1.107 | 1.107 | 1.122 |
| (Å) | (MHP) | (dimethyl | (ethyl methyl | (C—H | (C—H | (isobutane) |
| | 1.60 [64] | ether) | ether (avg.)) | propane) | propane) | |
| | (DNA) | | | 1.117 | 1.117 | |
| | | | | (C—H | (C—H | |
| | | | | butane) | butane) | |
| b, c (a₀) | 1.04192 | 1.20776 | 1.19429 | 1.27295 | 1.29569 | 1.29924 |
| e | 0.82573 | 0.74388 | 0.74645 | 0.63580 | 0.63159 | 0.63095 |
| | C—C (a) | C—C (b) | C—C (c) | C—C (d) | C—C (e) | C—C (f) |
| Parameter | Group | Group | Group | Group | Group | Group |
| a (a₀) | 2.12499 | 2.12499 | 2.10725 | 2.12499 | 2.10725 | 2.10725 |
| c′ (a₀) | 1.45744 | 1.45744 | 1.45164 | 1.45744 | 1.45164 | 1.45164 |
| Bond Length 2c′ (Å) | 1.54280 | 1.54280 | 1.53635 | 1.54280 | 1.53635 | 1.53635 |
| Exp. Bond Length | 1.532 | 1.532 | 1.532 | 1.532 | 1.532 | 1.532 |
| (Å) | (propane) | (propane) | (propane) | (propane) | (propane) | (propane) |
| | 1.531 | 1.531 | 1.531 | 1.531 | 1.531 | 1.531 |
| | (butane) | (butane) | (butane) | (butane) | (butane) | (butane) |
| b, c (a₀) | 1.54616 | 1.54616 | 1.52750 | 1.54616 | 1.52750 | 1.52750 |
| e | 0.68600 | 0.68600 | 0.68888 | 0.68600 | 0.68888 | 0.68888 |

TABLE 47
The MO to HO intercept geometrical bond parameters of alkyl phosphites.
R, R′, R″ are H or alkyl groups. E_{T} is E_{T} (atom-atom, msp³.AO).

| | | | | | | Final Total | | |
|---|---|---|---|---|---|---|---|---|
| | | E_{T} | E_{T} | E_{T} | E_{T} | Energy | | |
| | | (eV) | (eV) | (eV) | (eV) | C2sp³ | rᵢₙᵢₜᵢₐₗ | r_{final} |
| Bond | Atom | Bond 1 | Bond 2 | Bond 3 | Bond 4 | (eV) | (a₀) | (a₀) |
| (CH₃O)₂P—OCH₃ | O | −0.72457 | −0.72457 | 0 | 0 | | 1.00000 | 0.83600 |
| (CH₃O)₂P—OC(CH₃)₃ | | | | | | | | |
| (C—O (i)) | | | | | | | | |
| (CH₃O)₂P—OCH₃ | P | −0.72457 | −0.72457 | −0.72457 | 0 | | 1.15350 | 0.80037 |
| (CH₃O)₂P—OC(CH₃)₃ | | | | | | | | |
| (CH₃O)₂P—OCH₂R | | | | | | | | |
| (C—O (i)) and (C—O (ii)) | | | | | | | | |
| (CH₃O)₂P—OCH₂R | O | −0.72457 | −0.82688 | 0 | 0 | | 1.00000 | 0.83078 |
| (C—O (ii)) | | | | | | | | |
| C—H (OCₐH₃) | Cₐ | −0.72457 | 0 | 0 | 0 | −152.34026 | 0.91771 | 0.87495 |
| (CH₃O)₂PO—CₐH₃ | Cₐ | −0.72457 | 0 | 0 | 0 | −152.34026 | 0.91771 | 0.87495 |
| (CH₃O)₂PO—Cₐ(CH₃)₃ | Cₐ | −0.72457 | −0.72457 | −0.72457 | −0.72457 | −154.51399 | 0.91771 | 0.76765 |
| (C—O (i)) | | | | | | | | |
| (H₃CO)₂PO—CₐH₃ | O | −0.72457 | −0.72457 | 0 | 0 | | 1.00000 | 0.83600 |
| (CH₃)₃Cₐ—OP(OC_{b}H₃)₂ | | | | | | | | |
| (C—O (i)) | | | | | | | | |
| —H₂Cₐ—OP(OCH₃)₂ | Cₐ | −0.82688 | −0.92918 | 0 | 0 | −153.37175 | 0.91771 | 0.82053 |
| (C—O (ii)) | | | | | | | | |
| (CH₃O)₂PO—CₐH(CH₃)₂ | Cₐ | −0.82688 | −0.92918 | −0.92918 | 0 | −154.30093 | 0.91771 | 0.77699 |
| (C—O (ii)) | | | | | | | | |
| —H₂Cₐ—OP(OCH₃)₂ | O | −0.72457 | −0.82688 | 0 | 0 | | 1.00000 | 0.83078 |
| (H₃C)₂HCₐ—OP(OCH₃)₂ | | | | | | | | |
| (C—O (ii)) | | | | | | | | |
| C—H (CH₃) | C | −0.92918 | 0 | 0 | 0 | −152.54487 | 0.91771 | 0.86359 |
| C—H (CH₂) | C | −0.92918 | −0.92918 | 0 | 0 | −153.47406 | 0.91771 | 0.81549 |
| C—H (CH) | C | −0.92918 | −0.92918 | −0.92918 | 0 | −154.40324 | 0.91771 | 0.77247 |
| H₃CₐC_{b}H₂CH₂—(C—C (a)) | Cₐ | −0.92918 | 0 | 0 | 0 | −152.54487 | 0.91771 | 0.86359 |
| H₃CₐC_{b}H₂CH₂—(C—C (a)) | C_{b} | −0.92918 | −0.92918 | 0 | 0 | −153.47406 | 0.91771 | 0.81549 |
| R—H₂CₐC_{b}(H₂C_{c}—R′)HCH₂—(C—C (b)) | C_{b} | −0.92918 | −0.92918 | −0.92918 | 0 | −154.40324 | 0.91771 | 0.77247 |
| R—H₂Cₐ(R′—H₂C_{d})C_{b}(R″—H₂C_{c})CH₂—(C—C (c)) | C_{b} | −0.92918 | −0.72457 | −0.72457 | −0.72457 | −154.71860 | 0.91771 | 0.75889 |
| isoCₐC_{b}(H₂C_{c}—R′)HCH₂—(C—C (d)) | C_{b} | −0.92918 | −0.92918 | −0.92918 | 0 | −154.40324 | 0.91771 | 0.77247 |
| tertCₐ(R′—H₂C_{d})C_{b}(R″—H₂C_{c})CH₂—(C—C (e)) | C_{b} | −0.72457 | −0.72457 | −0.72457 | −0.72457 | −154.51399 | 0.91771 | 0.76765 |
| tertCₐC_{b}(H₂C_{c}—R′)HCH₂—(C—C (f)) | C_{b} | −0.72457 | −0.92918 | −0.92918 | 0 | −154.19863 | 0.91771 | 0.78155 |
| isoCₐ(R′—H₂C_{d})C_{b}(R″—H₂C_{c})CH₂—(C—C (f)) | C_{b} | −0.72457 | −0.72457 | −0.72457 | −0.72457 | −154.51399 | 0.91771 | 0.76765 |

| | | E (C2sp³) | | | | | |
|---|---|---|---|---|---|---|---|
| | E_{Coulomb} (eV) | (eV) | θ′ | θ₁ | θ₂ | d₁ | d₂ |
| Bond | Final | Final | (°) | (°) | (°) | (a₀) | (a₀) |
| (CH₃O)₂P—OCH₃ | −16.27489 | | 111.08 | 68.92 | 48.48 | 1.22455 | 0.30068 |
| (CH₃O)₂P—OC(CH₃)₃ | | | | | | | |
| (C—O (i)) | | | | | | | |
| (CH₃O)₂P—OCH₃ | −16.99947 | | 108.77 | 71.23 | 46.66 | 1.26770 | 0.25753 |
| (CH₃O)₂P—OC(CH₃)₃ | | | | | | | |
| (CH₃O)₂P—OCH₂R | | | | | | | |
| (C—O (i)) and (C—O (ii)) | | | | | | | |
| (CH₃O)₂P—OCH₂R | −16.37720 | | 110.75 | 69.25 | 48.21 | 1.23087 | 0.29436 |
| (C—O (ii)) | | | | | | | |
| C—H (OCₐH₃) | −15.55033 | −15.35946 | 78.85 | 101.15 | 42.40 | 1.21777 | 0.16921 |
| (CH₃O)₂PO—CₐH₃ | −15.55033 | −15.35946 | 95.98 | 84.02 | 46.10 | 1.25319 | 0.09112 |
| (CH₃O)₂PO—Cₐ(CH₃)₃ | −17.72405 | | 86.03 | 93.97 | 39.35 | 1.39744 | 0.05313 |
| (C—O (i)) | | | | | | | |
| (H₃CO)₂PO—CₐH₃ | −16.27490 | | 92.66 | 87.34 | 43.74 | 1.30555 | 0.03876 |
| (CH₃)₃Cₐ—OP(OC_{b}H₃)₂ | | | | | | | |
| (C—O (i)) | | | | | | | |
| —H₂Cₐ—OP(OCH₃)₂ | −16.58181 | −16.39095 | 92.41 | 87.59 | 43.35 | 1.30512 | 0.03456 |
| (C—O (ii)) | | | | | | | |
| (CH₃O)₂PO—CₐH(CH₃)₂ | −17.51099 | −17.32013 | 88.25 | 91.75 | 40.56 | 1.36345 | 0.02377 |
| (C—O (ii)) | | | | | | | |
| —H₂Cₐ—OP(OCH₃)₂ | −16.37720 | | 93.33 | 86.67 | 43.98 | 1.29138 | 0.04829 |
| (H₃C)₂HCₐ—OP(OCH₃)₂ | | | | | | | |
| (C—O (ii)) | | | | | | | |
| C—H (CH₃) | −15.75493 | −15.56407 | 77.49 | 102.51 | 41.48 | 1.23564 | 0.18708 |
| C—H (CH₂) | −16.68412 | −16.49325 | 68.47 | 111.53 | 35.84 | 1.35486 | 0.29933 |
| C—H (CH) | −17.61330 | −17.42244 | 61.10 | 118.90 | 31.37 | 1.42988 | 0.37326 |
| H₃CₐC_{b}H₂CH₂—(C—C (a)) | −15.75493 | −15.56407 | 63.82 | 116.18 | 30.08 | 1.83879 | 0.38106 |
| H₃CₐC_{b}H₂CH₂—(C—C (a)) | −16.68412 | −16.49325 | 56.41 | 123.59 | 26.06 | 1.90890 | 0.45117 |
| R—H₂CₐC_{b}(H₂C_{c}—R′)HCH₂—(C—C (b)) | −17.61330 | −17.42244 | 48.30 | 131.70 | 21.90 | 1.97162 | 0.51388 |
| R—H₂Cₐ(R′—H₂C_{d})C_{b}(R″—H₂C_{c})CH₂—(C—C (c)) | −17.92866 | −17.73779 | 48.21 | 131.79 | 21.74 | 1.95734 | 0.50570 |
| isoCₐC_{b}(H₂C_{c}—R′)HCH₂—(C—C (d)) | −17.61330 | −17.42244 | 48.30 | 131.70 | 21.90 | 1.97162 | 0.51388 |
| tertCₐ(R′—H₂C_{d})C_{b}(R″—H₂C_{c})CH₂—(C—C (e)) | −17.92866 | −17.73779 | 50.04 | 129.96 | 22.66 | 1.94462 | 0.49298 |
| tertCₐC_{b}(H₂C_{c}—R′)HCH₂—(C—C (f)) | −17.40869 | −17.21783 | 52.78 | 127.22 | 24.04 | 1.92443 | 0.47279 |
| isoCₐ(R′—H₂C_{d})C_{b}(R″—H₂C_{c})CH₂—(C—C (f)) | −17.92866 | −17.73779 | 50.04 | 129.96 | 22.66 | 1.94462 | 0.49298 |

TABLE 48
The energy parameters (eV) of functional groups of alkyl phosphites.

| | P—O | C—O (i) | C—O (ii) | CH₃ | CH₂ | CH (i) |
|---|---|---|---|---|---|---|
| Parameters | Group | Group | Group | Group | Group | Group |
| n₁ | 1 | 1 | 1 | 3 | 2 | 1 |
| n₂ | 0 | 0 | 0 | 2 | 1 | 0 |
| n₃ | 0 | 0 | 0 | 0 | 0 | 0 |
| C₁ | 0.5 | 0.5 | 0.5 | 0.75 | 0.75 | 0.75 |
| C₂ | 1 | 1 | 1 | 1 | 1 | 1 |
| c₁ | 1 | 1 | 1 | 1 | 1 | 1 |
| c₂ | 0.79401 | 0.85395 | 0.85395 | 0.91771 | 0.91771 | 0.91771 |
| c₃ | 0 | 0 | 0 | 0 | 1 | 1 |
| c₄ | 2 | 2 | 2 | 1 | 1 | 1 |
| c₅ | 0 | 0 | 0 | 3 | 2 | 1 |
| C₁ₒ | 0.5 | 0.5 | 0.5 | 0.75 | 0.75 | 0.75 |
| C₂ₒ | 0.79401 | 1 | 1 | 1 | 1 | 1 |
| Vₑ (eV) | −33.27738 | −33.15757 | −33.47304 | −107.32728 | −70.41425 | −35.12015 |
| Vₚ (eV) | 8.92049 | 10.12103 | 10.15605 | 38.92728 | 25.78002 | 12.87680 |
| T (eV) | 9.00781 | 9.17389 | 9.32537 | 32.53914 | 21.06675 | 10.48582 |
| Vₘ (eV) | −4.50391 | −4.58695 | −4.66268 | −16.26957 | −10.53337 | −5.24291 |
| E (AO/HO) (eV) | −11.78246 | −14.63489 | −14.63489 | −15.56407 | −15.56407 | −14.63489 |
| ΔE _{H}_{₂}_{MO} (AO/HO) (eV) | 0 | −1.44915 | −1.65376 | 0 | 0 | 0 |
| E_{T} (AO/HO) (eV) | −11.78246 | −13.18574 | −12.98113 | −15.56407 | −15.56407 | −14.63489 |
| E_{T} (H₂MO) (eV) | −31.63544 | −31.63533 | −31.63544 | −67.69451 | −49.66493 | −31.63533 |
| E_{T} (atom-atom, msp³.AO) (eV) | −1.44914 | −1.44915 | −1.65376 | 0 | 0 | 0 |
| E_{T} (MO) (eV) | −33.08451 | −33.08452 | −33.28912 | −67.69450 | −49.66493 | −31.63537 |
| ω (10¹⁵ rad/s) | 10.3761 | 12.0329 | 12.1583 | 24.9286 | 24.2751 | 24.1759 |
| E_{K} (eV) | 6.82973 | 7.92028 | 8.00277 | 16.40846 | 15.97831 | 15.91299 |
| Ē_{D} (eV) | −0.17105 | −0.18420 | −0.18631 | −0.25352 | −0.25017 | −0.24966 |
| Ē_{Kvib} (eV) | 0.10477 | 0.13663 | 0.16118 | 0.35532 | 0.35532 | 0.35532 |
| | [70] | [21] | [4] | (Eq. | (Eq. | (Eq. |
| | | | | (13.458)) | (13.458)) | (13.458)) |
| Ē_{osc} (eV) | −0.11867 | −0.11589 | −0.10572 | −0.22757 | −0.14502 | −0.07200 |
| E_{mag} (eV) | 0.14803 | 0.14803 | 0.14803 | 0.14803 | 0.14803 | 0.14803 |
| E_{T} (Group) (eV) | −33.20318 | −33.20040 | −33.39484 | −67.92207 | −49.80996 | −31.70737 |
| Eᵢₙᵢₜᵢₐₗ (c₄ AO/HO) (eV) | −14.63489 | −14.63489 | −14.63489 | −14.63489 | −14.63489 | −14.63489 |
| Eᵢₙᵢₜᵢₐₗ (c₅ AO/HO) (eV) | 0 | 0 | 0 | −13.59844 | −13.59844 | −13.59844 |
| E_{D} (Group) (eV) | 3.93340 | 3.93062 | 4.12506 | 12.49186 | 7.83016 | 3.32601 |
| | C—C (a) | C—C (b) | C—C (c) | C—C (d) | C—C (e) | C—C (f) |
| Parameters | Group | Group | Group | Group | Group | Group |
| n₁ | 1 | 1 | 1 | 1 | 1 | 1 |
| n₂ | 0 | 0 | 0 | 0 | 0 | 0 |
| n₃ | 0 | 0 | 0 | 0 | 0 | 0 |
| C₁ | 0.5 | 0.5 | 0.5 | 0.5 | 0.5 | 0.5 |
| C₂ | 1 | 1 | 1 | 1 | 1 | 1 |
| c₁ | 1 | 1 | 1 | 1 | 1 | 1 |
| c₂ | 0.91771 | 0.91771 | 0.91771 | 0.91771 | 0.91771 | 0.91771 |
| c₃ | 0 | 0 | 0 | 1 | 1 | 0 |
| c₄ | 2 | 2 | 2 | 2 | 2 | 2 |
| c₅ | 0 | 0 | 0 | 0 | 0 | 0 |
| C₁ₒ | 0.5 | 0.5 | 0.5 | 0.5 | 0.5 | 0.5 |
| C₂ₒ | 1 | 1 | 1 | 1 | 1 | 1 |
| Vₑ (eV) | −28.79214 | −28.79214 | −29.10112 | −28.79214 | −29.10112 | −29.10112 |
| Vₚ (eV) | 9.33352 | 9.33352 | 9.37273 | 9.33352 | 9.37273 | 9.37273 |
| T (eV) | 6.77464 | 6.77464 | 6.90500 | 6.77464 | 6.90500 | 6.90500 |
| Vₘ (eV) | −3.38732 | −3.38732 | −3.45250 | −3.38732 | −3.45250 | −3.45250 |
| E (AO/HO) (eV) | −15.56407 | −15.56407 | −15.35946 | −15.56407 | −15.35946 | −15.35946 |
| ΔE_{H}_{₂}_{MO} (AO/HO) (eV) | 0 | 0 | 0 | 0 | 0 | 0 |
| E_{T} (AO/HO) (eV) | −15.56407 | −15.56407 | −15.35946 | −15.56407 | −15.35946 | −15.35946 |
| E_{T} (H₂MO) (eV) | −31.63537 | −31.63537 | −31.63535 | −31.63537 | −31.63535 | −31.63535 |
| E_{T} (atom-atom, msp³.AO) (eV) | −1.85836 | −1.85836 | −1.44915 | −1.85836 | −1.44915 | −1.44915 |
| E_{T} (MO) (eV) | −33.49373 | −33.49373 | −33.08452 | −33.49373 | −33.08452 | −33.08452 |
| ω (10¹⁵ rad/s) | 9.43699 | 9.43699 | 15.4846 | 9.43699 | 9.55643 | 9.55643 |
| E_{K} (eV) | 6.21159 | 6.21159 | 10.19220 | 6.21159 | 6.29021 | 6.29021 |
| Ē_{D} (eV) | −0.16515 | −0.16515 | −0.20896 | −0.16515 | −0.16416 | −0.16416 |
| Ē_{Kvib} (eV) | 0.12312 | 0.17978 | 0.09944 | 0.12312 | 0.12312 | 0.12312 |
| | [2] | [4] | [5] | [2] | [2] | [2] |
| Ē_{osc} (eV) | −0.10359 | −0.07526 | −0.15924 | −0.10359 | −0.10260 | −0.10260 |
| E_{mag} (eV) | 0.14803 | 0.14803 | 0.14803 | 0.14803 | 0.14803 | 0.14803 |
| E_{T} (Group) (eV) | −33.59732 | −33.49373 | −33.24376 | −33.59732 | −33.18712 | −33.18712 |
| Eᵢₙᵢₜᵢₐₗ (c₄ AO/HO) (eV) | −14.63489 | −14.63489 | −14.63489 | −14.63489 | −14.63489 | −14.63489 |
| Eᵢₙᵢₜᵢₐₗ (c₅ AO/HO) (eV) | 0 | 0 | 0 | 0 | 0 | 0 |
| E_{D} (Group) (eV) | 4.32754 | 4.29921 | 3.97398 | 4.17951 | 3.62128 | 3.91734 |

TABLE 49
The total bond energies of alkyl phosphites calculated using the functional group composition
and the energies of Table 48 compared to the experimental values [68].

| | | | | C—O | | | | C—C | C—C |
|---|---|---|---|---|---|---|---|---|---|
| Formula | Name | P—O | C—O (i) | (ii) | CH₃ | CH₂ | CH (i) | (a) | (b) |
| C₃H₉O₃P | Trimethyl phosphite | 3 | 3 | 0 | 3 | 0 | 0 | 0 | 0 |
| C₆H₁₅O₃P | Triethyl phosphite | 3 | 0 | 3 | 3 | 3 | 0 | 3 | 0 |
| C₉H₂₁O₃P | Tri-isopropyl phosphite | 3 | 0 | 3 | 6 | 0 | 3 | 0 | 6 |

| | | | | | | Calculated | Experimental | |
|---|---|---|---|---|---|---|---|---|
| | | C—C | C—C | C—C | C—C | Total Bond | Total Bond | Relative |
| Formula | Name | (c) | (d) | (e) | (f) | Energy (eV) | Energy (eV) | Error |
| C₃H₉O₃P | Trimethyl phosphite | 0 | 0 | 0 | 0 | 61.06764 | 60.94329 | −0.00204 |
| C₆H₁₅O₃P | Triethyl phosphite | 0 | 0 | 0 | 0 | 98.12406 | 97.97947 | −0.00148 |
| C₉H₂₁O₃P | Tri-isopropyl phosphite | 0 | 0 | 0 | 0 | 134.89983 | 135.00698 | 0.00079 |

TABLE 50
The bond angle parameters of alkyl phosphites and experimental values [1]. In the calculation of θᵥ,
the parameters from the preceding angle were used. E_{T} is E_{T} (atom-atom,msp³.AO).

| | | | 2c′ | | Atom 1 | | Atom 2 | |
|---|---|---|---|---|---|---|---|---|
| | 2c′ | 2c′ | Terminal | E_{Coulombic} | Hybridization | | Hybridization | |
| Atoms of | Bond 1 | Bond 2 | Atoms | or E | Designation | E_{Coulombic} | Designation | c₂ |
| Angle | (a₀) | (a₀) | (a₀) | Atom 1 | (Table 7) | Atom 2 | (Table 7) | Atom 1 |
| ∠OPO | 3.05046 | 3.05046 | 4.5826 | −16.27489 | 16 | −16.27489 | 16 | 0.83600 |
| ∠POC | 3.05046 | 2.68862 | 4.9768 | −11.78246 | Psp³ | −15.75493 | 7 | 0.73885 |
| | | | | | | | | Eq. |
| | | | | | | | | (23.181) |
| ∠C_{b}CₐO | 2.91547 | 2.67935 | 4.5607 | −16.68412 | 26 | −13.61806 | O | 0.81549 |
| Methylene | 2.11106 | 2.11106 | 3.4252 | −15.75493 | 7 | H | H | 0.86359 |
| ∠HCₐH | | | | | | | | |
| ∠CₐC_{b}C_{c} | | | | | | | | |
| ∠CₐC_{b}H | | | | | | | | |
| Methyl | 2.09711 | 2.09711 | 3.4252 | −15.75493 | 7 | H | H | 0.86359 |
| ∠HCₐH | | | | | | | | |
| ∠CₐC_{b}C_{c} | | | | | | | | |
| ∠CₐC_{b}H | | | | | | | | |
| ∠C_{b}CₐC_{c} | 2.91547 | 2.91547 | 4.7958 | −16.68412 | 26 | −16.68412 | 26 | 0.81549 |
| iso Cₐ | | | | C_{b} | | C_{c} | | |
| ∠C_{b}CₐH | 2.91547 | 2.11323 | 4.1633 | −15.55033 | 5 | −14.82575 | 1 | 0.87495 |
| iso Cₐ | | | | Cₐ | | C_{b} | | |
| ∠CₐC_{b}H | 2.91547 | 2.09711 | 4.1633 | −15.55033 | 5 | −14.82575 | 1 | 0.87495 |
| iso Cₐ | | | | C_{b} | | Cₐ | | |
| ∠C_{b}CₐC_{b} | 2.90327 | 2.90327 | 4.7958 | −16.68412 | 26 | −16.68412 | 26 | 0.81549 |
| tert Cₐ | | | | C_{b} | | C_{b} | | |
| ∠C_{b}CₐC_{d} | | | | | | | | |

| Atoms of | c₂ | | | | | E_{T} | θᵥ | θ₁ | θ₂ | Cal. θ | Exp. θ |
|---|---|---|---|---|---|---|---|---|---|---|---|
| Angle | Atom 2 | C₁ | C₂ | c₁ | c₂′ | (eV) | (°) | (°) | (°) | (°) | (°) |
| ∠OPO | 0.83600 | 1 | 1 | 1 | 0.83600 | −1.65376 | | | | 97.38 | 96 [71] |
| | | | | | | | | | | | (triethyl |
| | | | | | | | | | | | phosphite) |
| ∠POC | 0.86359 | 1 | 0.73885 | 1 | 0.80122 | −0.72457 | | | | 120.13 | 120 [71] |
| | | | | | | | | | | | (triethyl |
| | | | | | | | | | | | phosphite) |
| ∠C_{b}CₐO | 0.85395 | 1 | 1 | 1 | 0.83472 | −1.65376 | | | | 109.13 | 109.4 |
| | (Eq. | | | | | | | | | | (ethyl methyl |
| | (15.133)) | | | | | | | | | | ether) |
| Methylene | 1 | 1 | 1 | 0.75 | 1.15796 | 0 | | | | 108.44 | 107 |
| ∠HCₐH | | | | | | | | | | | (propane) |
| ∠CₐC_{b}C_{c} | | | | | | | 69.51 | | | 110.49 | 112 |
| | | | | | | | | | | | (propane) |
| | | | | | | | | | | | 113.8 |
| | | | | | | | | | | | (butane) |
| | | | | | | | | | | | 110.8 |
| | | | | | | | | | | | (isobutane) |
| ∠CₐC_{b}H | | | | | | | 69.51 | | | 110.49 | 111.0 |
| | | | | | | | | | | | (butane) |
| | | | | | | | | | | | 111.4 |
| | | | | | | | | | | | (isobutane) |
| Methyl | 1 | 1 | 1 | 0.75 | 1.15796 | 0 | | | | 109.50 | |
| ∠HCₐH | | | | | | | | | | | |
| ∠CₐC_{b}C_{c} | | | | | | | 70.56 | | | 109.44 | |
| ∠CₐC_{b}H | | | | | | | 70.56 | | | 109.44 | |
| ∠C_{b}CₐC_{c} | 0.81549 | 1 | 1 | 1 | 0.81549 | −1.85836 | | | | 110.67 | 110.8 |
| iso Cₐ | | | | | | | | | | | (isobutane) |
| ∠C_{b}CₐH | 0.91771 | 0.75 | 1 | 0.75 | 1.04887 | 0 | | | | 110.76 | |
| iso Cₐ | | | | | | | | | | | |
| ∠CₐC_{b}H | 0.91771 | 0.75 | 1 | 0.75 | 1.04887 | 0 | | | | 111.27 | 111.4 |
| iso Cₐ | | | | | | | | | | | (isobutane) |
| ∠C_{b}CₐC_{b} | 0.81549 | 1 | 1 | 1 | 0.81549 | −1.85836 | | | | 111.37 | 110.8 |
| tert Cₐ | | | | | | | | | | | (isobutane) |
| ∠C_{b}CₐC_{d} | | | | | | | 72.50 | | | 107.50 | |

Alkyl Phosphine Oxides (CₙH₂ₙ₊₁)₃P═O, n=1,2,3,4,5 . . . ∞)

The alkyl phosphine oxides, (CₙH₂ₙ₊₁)₃P═O, comprise P—C and P═O functional groups. The alkyl portion of the alkyl phosphine oxide may comprise at least two terminal methyl groups (CH₃) at each end of each chain, and may comprise methylene (CH₂), and methylyne (CH) functional groups as well as C bound by carbon-carbon single bonds. The methyl and methylene functional groups are equivalent to those of straight-chain alkanes. Six types of C—C bonds can be identified. The n-alkane C—C bond is the same as that of straight-chain alkanes. In addition, the C—C bonds within isopropyl ((CH₃)₂CH) and t-butyl ((CH₃)₃C) groups and the isopropyl to isopropyl, isopropyl to t-butyl, and t-butyl to t-butyl C—C bonds comprise functional groups. The branched-chain-alkane groups in alkyl phosphine oxides are equivalent to those in branched-chain alkanes.

The P—C functional group is equivalent to that of alkyl phosphines. The P═O bond forms between the P3sp³ HO and an O2p AO to yield phosphine oxides. The semimajor axis a of the P═O functional group is solved using Eq. (15.51). Using the semimajor axis and the relationships between the prolate spheroidal axes, the geometric and energy parameters of the MO are calculated using Eqs. (15.1-15.117) in the same manner as the organic functional groups given in Organic Molecular Functional Groups and Molecules section.

For the P═O functional group, hybridization the 3s and 3p AOs of each P to form a single 3sp³ shells forms an energy minimum, and the sharing of electrons between the O2p AOs and P3sp³ HOs to form a MO permits each participating orbital to decrease in radius and energy. In branched-chain alkyl phosphine oxides, the energy of phosphorous is less than the Coulombic energy between the electron and proton of H given by Eq. (1.231). The energy matching condition is determined by the c₂ parameter given by Eq. (15.182). The energy of the P═O— bond MO is the sum of the component energies of the H₂-type ellipsoidal MO given in Eq. (15.51) with E(AO/HO) being twice E(P,3sp³) given by Eq. (15.180) corresponding to the double bond, and E_{T}(atom-atom, msp³.AO) is equivalent to that of an alkene double bond, −2.26758 eV, given by Eq. (14.247) in order to match the energies of the carbon and phosphorous HOs and the oxygen AO.

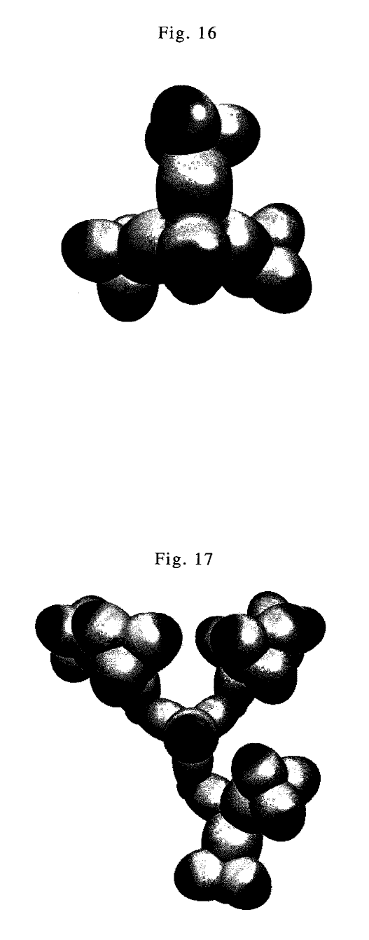

The symbols of the functional groups of branched-chain alkyl phosphine oxides are given in Table 51. The geometrical (Eqs. (15.1-15.5) and (15.51)), intercept (Eqs. (15.80-15.87)), and energy (Eqs. (15.6-15.11) and (15.17-15.65)) parameters of alkyl phosphine oxides are given in Tables 52, 53, and 54, respectively. The total energy of each alkyl phosphine oxide given in Table 55 was calculated as the sum over the integer multiple of each E_{D}(Group) of Table 54 corresponding to functional-group composition of the molecule. The bond angle parameters of alkyl phosphine oxides determined using Eqs. (15.88-15.117) are given in Table 56. The color scale, charge-density of exemplary alkyl phosphine oxide, trimethylphosphine oxide, comprising atoms with the outer shell bridged by one or more H₂-type ellipsoidal MOs or joined with one or more hydrogen MOs is shown in FIG. 16.

TABLE 51
The symbols of functional groups of alkyl phosphine oxides.

| Functional Group | Group Symbol |
|---|---|
| P═O | P═O |
| P—C | P—C |
| CH₃ group | C—H (CH₃) |
| CH₂ group | C—H (CH₂) |
| CH | C—H (i) |
| CC bond (n-C) | C—C (a) |
| CC bond (iso-C) | C—C (b) |
| CC bond (tert-C) | C—C (c) |
| CC (iso to iso-C) | C—C (d) |
| CC (t to t-C) | C—C (e) |
| CC (t to iso-C) | C—C (f) |
| CC (aromatic bond) | C^{3e}═C |
| CH (aromatic) | CH (ii) |

TABLE 52
The geometrical bond parameters of alkyl phosphine oxides and experimental values [1].

| | P═O | P—C | C—H (CH₃) | C—H (CH₂) | C—H (i) | C—C (a) |
|---|---|---|---|---|---|---|
| Parameter | Group | Group | Group | Group | Group | Group |
| a (a₀) | 1.91663 | 2.29513 | 1.64920 | 1.67122 | 1.67465 | 2.12499 |
| c′ (a₀) | 1.38442 | 1.76249 | 1.04856 | 1.05553 | 1.05661 | 1.45744 |
| Bond Length | 1.46521E−10 | 1.86534 | 1.10974 | 1.11713 | 1.11827 | 1.54280 |
| 2c′ (Å) | | | | | | |
| Exp. Bond | 1.48 [64] | 1.847 | 1.107 | 1.107 | 1.122 | 1.532 |
| Length | (DNA) | ((CH3)₂PCH₃) | (C—H propane) | (C—H propane) | (isobutane) | (propane) |
| (Å) | 1.4759 | 1.858 | 1.117 | 1.117 | | 1.531 |
| | (PO) | (H₂PCH₃) | (C—H butane) | (C—H butane) | | (butane) |
| b, c (a₀) | 1.32546 | 1.47012 | 1.27295 | 1.29569 | 1.29924 | 1.54616 |
| e | 0.72232 | 0.76793 | 0.63580 | 0.63159 | 0.63095 | 0.68600 |

| | C—C (b) | C—C (c) | C—C (d) | C—C (e) | C—C (f) | C^{3e}═C | CH (ii) |
|---|---|---|---|---|---|---|---|
| Parameter | Group | Group | Group | Group | Group | Group | Group |
| a (a₀) | 2.12499 | 2.10725 | 2.12499 | 2.10725 | 2.10725 | 1.47348 | 1.60061 |
| c′ (a₀) | 1.45744 | 1.45164 | 1.45744 | 1.45164 | 1.45164 | 1.31468 | 1.03299 |
| Bond Length | 1.54280 | 1.53635 | 1.54280 | 1.53635 | 1.53635 | 1.39140 | 1.09327 |
| 2c′ (Å) | | | | | | | |
| Exp. Bond | 1.532 | 1.532 | 1.532 | 1.532 | 1.532 | 1.399 | 1.101 |
| Length | (propane) | (propane) | (propane) | (propane) | (propane) | (benzene) | (benzene) |
| (Å) | 1.531 | 1.531 | 1.531 | 1.531 | 1.531 | | |
| | (butane) | (butane) | (butane) | (butane) | (butane) | | |
| b, c (a₀) | 1.54616 | 1.52750 | 1.54616 | 1.52750 | 1.52750 | 0.66540 | 1.22265 |
| e | 0.68600 | 0.68888 | 0.68600 | 0.68888 | 0.68888 | 0.89223 | 0.64537 |

TABLE 53
The MO to HO intercept geometrical bond parameters of alkyl phosphine oxides. R, R′, R″ are H or alkyl groups. E_{T} is
E_{T} (atom-atom, msp³.AO).

| | | E_{T} | E_{T} | E_{T} | E_{T} | Final Total Energy | | |
|---|---|---|---|---|---|---|---|---|
| | | (eV) | (eV) | (eV) | (eV) | C2sp³ | rᵢₙᵢₜᵢₐₗ | r_{final} |
| Bond | Atom | Bond 1 | Bond 2 | Bond 3 | Bond 4 | (eV) | (a₀) | (a₀) |
| (CH₃)₃P═O | O | −1.13379 | 0 | 0 | 0 | | 1.00000 | 0.85252 |
| (CH₃)₃P═O | P | −1.13379 | −0.18114 | −0.18114 | −0.18114 | | 1.15350 | 0.82445 |
| (CH₃)₂(O)P—CH₃ | C | −0.18114 | 0 | 0 | 0 | | 0.91771 | 0.90664 |
| (CH₃)₂(O)P—CH₃ | P | −0.18114 | −0.18114 | −0.18114 | −1.13379 | | 1.15350 | 0.82445 |
| C—H(CH₃) | C | −0.92918 | 0 | 0 | 0 | −152.54487 | 0.91771 | 0.86359 |
| C—H(CH₂) | C | −0.92918 | −0.92918 | 0 | 0 | −153.47406 | 0.91771 | 0.81549 |
| C—H(CH) | C | −0.92918 | −0.92918 | −0.92918 | 0 | −154.40324 | 0.91771 | 0.77247 |
| H₃CₐC_{b}H₂CH₂—(C—C (a)) | Cₐ | −0.92918 | 0 | 0 | 0 | −152.54487 | 0.91771 | 0.86359 |
| H₃CₐC_{b}H₂CH₂—(C—C (a)) | C_{b} | −0.92918 | −0.92918 | 0 | 0 | −153.47406 | 0.91771 | 0.81549 |
| R—H₂CₐC_{b}(H₂C_{c}—R′)HCH₂—(C—C (b)) | C_{b} | −0.92918 | −0.92918 | −0.92918 | 0 | −154.40324 | 0.91771 | 0.77247 |
| R—H₂Cₐ(R′—H₂C_{d})C_{b}(R″—H₂C_{c})CH₂—(C—C (c)) | C_{b} | −0.92918 | −0.72457 | −0.72457 | −0.72457 | −154.71860 | 0.91771 | 0.75889 |
| isoCₐC_{b}(H₂C_{c}—R′)HCH₂—(C—C (d)) | C_{b} | −0.92918 | −0.92918 | −0.92918 | 0 | −154.40324 | 0.91771 | 0.77247 |
| tertCₐ(R′—H₂C_{d})C_{b}(R″—H₂C_{c})CH₂—(C—C (e)) | C_{b} | −0.72457 | −0.72457 | −0.72457 | −0.72457 | −154.51399 | 0.91771 | 0.76765 |
| tertCₐC_{b}(H₂C_{c}—R′)HCH₂—(C—C (f)) | C_{b} | −0.72457 | −0.92918 | −0.92918 | 0 | −154.19863 | 0.91771 | 0.78155 |
| isoCₐ(R′—H₂C_{d})C_{b}(R″—H₂C_{c})CH₂—(C—C (f)) | C_{b} | −0.72457 | −0.72457 | −0.72457 | −0.72457 | −154.51399 | 0.91771 | 0.76765 |

| | E_{Coulomb} (eV) | E (C2sp³) (eV) | θ′ | θ₁ | θ₂ | d₁ | d₂ |
|---|---|---|---|---|---|---|---|
| Bond | Final | Final | (°) | (°) | (°) | (a₀) | (a₀) |
| (CH₃)₃P═O | −15.95954 | | 84.02 | 95.98 | 39.77 | 1.47318 | 0.08876 |
| (CH₃)₃P═O | −16.50297 | | 81.09 | 98.91 | 37.92 | 1.51205 | 0.12762 |
| (CH₃)₂(O)P—CH₃ | −15.00689 | −14.81603 | 87.12 | 92.88 | 38.02 | 1.80811 | 0.04562 |
| (CH₃)₂(O)P—CH₃ | −16.50297 | | 79.33 | 100.67 | 33.44 | 1.91514 | 0.15265 |
| C—H(CH₃) | −15.75493 | −15.56407 | 77.49 | 102.51 | 41.48 | 1.23564 | 0.18708 |
| C—H(CH₂) | −16.68412 | −16.49325 | 68.47 | 111.53 | 35.84 | 1.35486 | 0.29933 |
| C—H(CH) | −17.61330 | −17.42244 | 61.10 | 118.90 | 31.37 | 1.42988 | 0.37326 |
| H₃CₐC_{b}H₂CH₂—(C—C (a)) | −15.75493 | −15.56407 | 63.82 | 116.18 | 30.08 | 1.83879 | 0.38106 |
| H₃CₐC_{b}H₂CH₂—(C—C (a)) | −16.68412 | −16.49325 | 56.41 | 123.59 | 26.06 | 1.90890 | 0.45117 |
| R—H₂CₐC_{b}(H₂C_{c}—R′)HCH₂—(C—C (b)) | −17.61330 | −17.42244 | 48.30 | 131.70 | 21.90 | 1.97162 | 0.51388 |
| R—H₂Cₐ(R′—H₂C_{d})C_{b}(R″—H₂C_{c})CH₂—(C—C (c)) | −17.92866 | −17.73779 | 48.21 | 131.79 | 21.74 | 1.95734 | 0.50570 |
| isoCₐC_{b}(H₂C_{c}—R′)HCH₂—(C—C (d)) | −17.61330 | −17.42244 | 48.30 | 131.70 | 21.90 | 1.97162 | 0.51388 |
| tertCₐ(R′—H₂C_{d})C_{b}(R″—H₂C_{c})CH₂—(C—C (e)) | −17.92866 | −17.73779 | 50.04 | 129.96 | 22.66 | 1.94462 | 0.49298 |
| tertCₐC_{b}(H₂C_{c}—R′)HCH₂—(C—C (f)) | −17.40869 | −17.21783 | 52.78 | 127.22 | 24.04 | 1.92443 | 0.47279 |
| isoCₐ(R′—H₂C_{d})C_{b}(R″—H₂C_{c})CH₂—(C—C (f)) | −17.92866 | −17.73779 | 50.04 | 129.96 | 22.66 | 1.94462 | 0.49298 |

TABLE 54
The energy parameters (eV) of functional groups of alkyl phosphine oxides.

| | P═O | P—C | CH₃ | CH₂ | CH (i) | C—C (a) | C—C (b) |
|---|---|---|---|---|---|---|---|
| Parameters | Group | Group | Group | Group | Group | Group | Group |
| f₁ | 1 | 1 | 1 | 1 | 1 | 1 | 1 |
| n₁ | 2 | 1 | 3 | 2 | 1 | 1 | 1 |
| n₂ | 0 | 0 | 2 | 1 | 0 | 0 | 0 |
| n₃ | 0 | 0 | 0 | 0 | 0 | 0 | 0 |
| C₁ | 0.5 | 0.5 | 0.75 | 0.75 | 0.75 | 0.5 | 0.5 |
| C₂ | 1 | 0.73885 | 1 | 1 | 1 | 1 | 1 |
| c₁ | 1 | 1 | 1 | 1 | 1 | 1 | 1 |
| c₂ | 0.79401 | 1 | 0.91771 | 0.91771 | 0.91771 | 0.91771 | 0.91771 |
| c₃ | 0 | 0 | 0 | 1 | 1 | 0 | 0 |
| c₄ | 4 | 2 | 1 | 1 | 1 | 2 | 2 |
| c₅ | 0 | 0 | 3 | 2 | 1 | 0 | 0 |
| C₁ₒ | 0.5 | 0.5 | 0.75 | 0.75 | 0.75 | 0.5 | 0.5 |
| C₂ₒ | 1 | 0.73885 | 1 | 1 | 1 | 1 | 1 |
| Vₑ (eV) | −56.96374 | −31.34959 | −107.32728 | −70.41425 | −35.12015 | −28.79214 | −28.79214 |
| Vₚ (eV) | 9.82777 | 7.71965 | 38.92728 | 25.78002 | 12.87680 | 9.33352 | 9.33352 |
| T (eV) | 14.86039 | 6.82959 | 32.53914 | 21.06675 | 10.48582 | 6.77464 | 6.77464 |
| Vₘ (eV) | −7.43020 | −3.41479 | −16.26957 | −10.53337 | −5.24291 | −3.38732 | −3.38732 |
| E (AO/HO) (eV) | −23.56492 | −11.78246 | −15.56407 | −15.56407 | −14.63489 | −15.56407 | −15.56407 |
| ΔE_{H}_{₂}_{MO} (AO/HO) (eV) | 0 | −0.36229 | 0 | 0 | 0 | 0 | 0 |
| E_{T} (AO/HO) (eV) | −23.56492 | −11.42017 | −15.56407 | −15.56407 | −14.63489 | −15.56407 | −15.56407 |
| E_{T} (H₂MO) (eV) | −63.27069 | −31.63532 | −67.69451 | −49.66493 | −31.63533 | −31.63537 | −31.63537 |
| E_{T} (atom-atom, msp³.AO) (eV) | −2.26758 | −0.36229 | 0 | 0 | 0 | −1.85836 | −1.85836 |
| E_{T} (MO) (eV) | −65.53832 | −31.99766 | −67.69450 | −49.66493 | −31.63537 | −33.49373 | −33.49373 |
| ω (10¹⁵ rad/s) | 11.0170 | 7.22663 | 24.9286 | 24.2751 | 24.1759 | 9.43699 | 9.43699 |
| E_{K} (eV) | 7.25157 | 4.75669 | 16.40846 | 15.97831 | 15.91299 | 6.21159 | 6.21159 |
| Ē_{D} (eV) | −0.17458 | −0.13806 | −0.25352 | −0.25017 | −0.24966 | −0.16515 | −0.16515 |
| Ē_{Kvib} (eV) | 0.15292 | 0.17606 | 0.35532 | 0.35532 | 0.35532 | 0.12312 | 0.17978 |
| | [24] | [67] | (Eq. | (Eq. | (Eq. | [2] | [4] |
| | | | (13.458)) | (13.458)) | (13.458)) | | |
| Ē_{osc} (eV) | −0.09812 | −0.05003 | −0.22757 | −0.14502 | −0.07200 | −0.10359 | −0.07526 |
| E_{mag} (eV) | 0.14803 | 0.14803 | 0.14803 | 0.14803 | 0.14803 | 0.14803 | 0.14803 |
| E_{T} (Group) (eV) | −65.73455 | −32.04769 | −67.92207 | −49.80996 | −31.70737 | −33.59732 | −33.49373 |
| Eᵢₙᵢₜᵢₐₗ (c₄ AO/HO) (eV) | −14.63489 | −14.63489 | −14.63489 | −14.63489 | −14.63489 | −14.63489 | −14.63489 |
| Eᵢₙᵢₜᵢₐₗ (c₅ AO/HO) (eV) | 0 | 0 | −13.59844 | −13.59844 | −13.59844 | 0 | 0 |
| E_{D} (Group) (eV) | 7.19500 | 2.77791 | 12.49186 | 7.83016 | 3.32601 | 4.32754 | 4.29921 |

| | C—C (c) | C—C (d) | C—C (e) | C—C (f) | C^{3e}═C | CH (ii) |
|---|---|---|---|---|---|---|
| Parameters | Group | Group | Group | Group | Group | Group |
| f₁ | 1 | 1 | 1 | 1 | 0.75 | 1 |
| n₁ | 1 | 1 | 1 | 1 | 2 | 1 |
| n₂ | 0 | 0 | 0 | 0 | 0 | 0 |
| n₃ | 0 | 0 | 0 | 0 | 0 | 0 |
| C₁ | 0.5 | 0.5 | 0.5 | 0.5 | 0.5 | 0.75 |
| C₂ | 1 | 1 | 1 | 1 | 0.85252 | 1 |
| c₁ | 1 | 1 | 1 | 1 | 1 | 1 |
| c₂ | 0.91771 | 0.91771 | 0.91771 | 0.91771 | 0.85252 | 0.91771 |
| c₃ | 0 | 1 | 1 | 0 | 0 | 1 |
| c₄ | 2 | 2 | 2 | 2 | 3 | 1 |
| c₅ | 0 | 0 | 0 | 0 | 0 | 1 |
| C₁ₒ | 0.5 | 0.5 | 0.5 | 0.5 | 0.5 | 0.75 |
| C₂ₒ | 1 | 1 | 1 | 1 | 0.85252 | 1 |
| Vₑ (eV) | −29.10112 | −28.79214 | −29.10112 | −29.10112 | −101.12679 | −37.10024 |
| Vₚ (eV) | 9.37273 | 9.33352 | 9.37273 | 9.37273 | 20.69825 | 13.17125 |
| T (eV) | 6.90500 | 6.77464 | 6.90500 | 6.90500 | 34.31559 | 11.58941 |
| Vₘ (eV) | −3.45250 | −3.38732 | −3.45250 | −3.45250 | −17.15779 | −5.79470 |
| E (AO/HO) (eV) | −15.35946 | −15.56407 | −15.35946 | −15.35946 | 0 | −14.63489 |
| ΔE_{H}_{₂}_{MO} (AO/HO) (eV) | 0 | 0 | 0 | 0 | 0 | −1.13379 |
| E_{T} (AO/HO) (eV) | −15.35946 | −15.56407 | −15.35946 | −15.35946 | 0 | −13.50110 |
| E_{T} (H₂MO) (eV) | −31.63535 | −31.63537 | −31.63535 | −31.63535 | −63.27075 | −31.63539 |
| E_{T} (atom-atom, msp³.AO) (eV) | −1.44915 | −1.85836 | −1.44915 | −1.44915 | −2.26759 | −0.56690 |
| E_{T} (MO) (eV) | −33.08452 | −33.49373 | −33.08452 | −33.08452 | −65.53833 | −32.20226 |
| ω (10¹⁵ rad/s) | 15.4846 | 9.43699 | 9.55643 | 9.55643 | 49.7272 | 26.4826 |
| E_{K} (eV) | 10.19220 | 6.21159 | 6.29021 | 6.29021 | 32.73133 | 17.43132 |
| Ē_{D} (eV) | −0.20896 | −0.16515 | −0.16416 | −0.16416 | −0.35806 | −0.26130 |
| Ē_{Kvib} (eV) | 0.09944 | 0.12312 | 0.12312 | 0.12312 | 0.19649 | 0.35532 |
| | [5] | [2] | [2] | [2] | [49] | Eq. (13.458) |
| Ē_{osc} (eV) | −0.15924 | −0.10359 | −0.10260 | −0.10260 | −0.25982 | −0.08364 |
| E_{mag} (eV) | 0.14803 | 0.14803 | 0.14803 | 0.14803 | 0.14803 | 0.14803 |
| E_{T} (Group) (eV) | −33.24376 | −33.59732 | −33.18712 | −33.18712 | −49.54347 | −32.28590 |
| Eᵢₙᵢₜᵢₐₗ (c₄ AO/HO) (eV) | −14.63489 | −14.63489 | −14.63489 | −14.63489 | −14.63489 | −14.63489 |
| Eᵢₙᵢₜᵢₐₗ (c₅ AO/HO) (eV) | 0 | 0 | 0 | 0 | 0 | −13.59844 |
| E_{D} (Group) (eV) | 3.97398 | 4.17951 | 3.62128 | 3.91734 | 5.63881 | 3.90454 |

TABLE 55
The total bond energies of alkyl phosphine oxides calculated using the functional group composition and the energies of
Table 54 compared to the experimental values [68].

| | | | | | | | C—C | C—C | C—C |
|---|---|---|---|---|---|---|---|---|---|
| Formula | Name | P═O | P—C | CH₃ | CH₂ | CH (i) | (a) | (b) | (c) |
| C₃H₉PO | Trimethylphosphine oxide | 1 | 3 | 3 | 0 | 0 | 0 | 0 | 0 |

| | | | | | | | Calculated | | |
|---|---|---|---|---|---|---|---|---|---|
| | | | | | | | Total Bond | Experimental | |
| | | C—C | C—C | C—C | | | Energy | Total Bond | Relative |
| Formula | Name | (d) | (e) | (f) | C^{3e}═C | CH (ii) | (eV) | Energy (eV) | Error |
| C₃H₉PO | Trimethylphosphine oxide | 0 | 0 | 0 | 0 | 0 | 53.00430 | 52.91192 | −0.00175 |

TABLE 56
The bond angle parameters of alkyl phosphine oxides and experimental values [1]. In the calculation of θᵥ,
the parameters from the preceding angle were used. E_{T} is E_{T} (atom-atom, msp³.AO).

| | | | 2c′ | | Atom 1 | | Atom 2 | | |
|---|---|---|---|---|---|---|---|---|---|
| | 2c′ | 2c′ | Terminal | E_{Coulombic} | Hybridization | | Hybridization | | |
| Atoms of | Bond 1 | Bond 2 | Atoms | or E | Designation | E_{Coulombic} | Designation | c₂ | c₂ |
| Angle | (a₀) | (a₀) | (a₀) | Atom 1 | (Table 7) | Atom 2 | (Table 7) | Atom 1 | Atom 2 |
| Methyl | 2.09711 | 2.09711 | 3.4252 | −15.75493 | 7 | H | H | 0.86359 | 1 |
| ∠HCₐH | | | | | | | | | |
| ∠HₐCₐP | | | | | | | | | |
| ∠CₐPC_{b} | 3.52498 | 3.52498 | 5.4955 | −15.75493 | 7 | −15.75493 | 7 | 0.86359 | 0.86359 |
| ∠CₐPO | 3.52498 | 2.76885 | 5.3104 | −15.95954 | 10 | −15.95954 | 10 | 0.85252 | 0.85252 |
| Methylene | 2.11106 | 2.11106 | 3.4252 | −15.75493 | 7 | H | H | 0.86359 | 1 |
| ∠HCₐH | | | | | | | | | |
| ∠CₐC_{b}C_{c} | | | | | | | | | |
| ∠CₐC_{b}H | | | | | | | | | |
| Methyl | 2.09711 | 2.09711 | 3.4252 | −15.75493 | 7 | H | H | 0.86359 | 1 |
| ∠HCₐH | | | | | | | | | |
| ∠CₐC_{b}C_{c} | | | | | | | | | |
| ∠CₐC_{b}H | | | | | | | | | |
| ∠C_{b}CₐC_{c} | 2.91547 | 2.91547 | 4.7958 | −16.68412 | 26 | −16.68412 | 26 | 0.81549 | 0.81549 |
| iso Cₐ | | | | C_{b} | | C_{c} | | | |
| ∠C_{b}CₐH | 2.91547 | 2.11323 | 4.1633 | −15.55033 | 5 | −14.82575 | 1 | 0.87495 | 0.91771 |
| iso Cₐ | | | | Cₐ | | C_{b} | | | |
| ∠CₐC_{b}H | 2.91547 | 2.09711 | 4.1633 | −15.55033 | 5 | −14.82575 | 1 | 0.87495 | 0.91771 |
| iso Cₐ | | | | C_{b} | | Cₐ | | | |
| ∠C_{b}CₐC_{b} | 2.90327 | 2.90327 | 4.7958 | −16.68412 | 26 | −16.68412 | 26 | 0.81549 | 0.81549 |
| tert Cₐ | | | | C_{b} | | C_{b} | | | |
| ∠C_{b}CₐC_{d} | | | | | | | | | |

| | | | | | E_{T} | θᵥ | θ₁ | θ₂ | Cal. θ | Exp. θ |
|---|---|---|---|---|---|---|---|---|---|---|
| Atoms of Angle | C₁ | C₂ | c₁ | c₂′ | (eV) | (°) | (°) | (°) | (°) | (°) |
| Methyl | 1 | 1 | 0.75 | 1.15796 | 0 | | | | 109.50 | |
| ∠HCₐH | | | | | | | | | | |
| ∠HₐCₐP | | | | | | 70.56 | | | 109.44 | 110.7 |
| | | | | | | | | | | (trimethyl |
| | | | | | | | | | | phosphine) |
| ∠CₐPC_{b} | 1 | 1 | 1 | 0.86359 | −1.85836 | | | | 102.43 | 104.31 [72] |
| | | | | | | | | | | (Ph₂P(O)CH₂OH) |
| ∠CₐPO | 1 | 1 | 1 | 0.85252 | −1.85836 | | | | 114.54 | 114.03 [72] |
| | | | | | | | | | | (Ph₂P(O)CH₂OH) |
| Methylene | 1 | 1 | 0.75 | 1.15796 | 0 | | | | 108.44 | 107 |
| ∠HCₐH | | | | | | | | | | (propane) |
| ∠CₐC_{b}C_{c} | | | | | | 69.51 | | | 110.49 | 112 |
| | | | | | | | | | | (propane) |
| | | | | | | | | | | 113.8 |
| | | | | | | | | | | (butane) |
| | | | | | | | | | | 110.8 |
| | | | | | | | | | | (isobutane) |
| ∠CₐC_{b}H | | | | | | 69.51 | | | 110.49 | 111.0 |
| | | | | | | | | | | (butane) |
| | | | | | | | | | | 111.4 |
| | | | | | | | | | | (isobutane) |
| Methyl | 1 | 1 | 0.75 | 1.15796 | 0 | | | | 109.50 | |
| ∠HCₐH | | | | | | | | | | |
| ∠CₐC_{b}C_{c} | | | | | | 70.56 | | | 109.44 | |
| ∠CₐC_{b}H | | | | | | 70.56 | | | 109.44 | |
| ∠C_{b}CₐC_{c} | 1 | 1 | 1 | 0.81549 | −1.85836 | | | | 110.67 | 110.8 |
| iso Cₐ | | | | | | | | | | (isobutane) |
| ∠C_{b}CₐH | 0.75 | 1 | 0.75 | 1.04887 | 0 | | | | 110.76 | |
| iso Cₐ | | | | | | | | | | |
| ∠CₐC_{b}H | 0.75 | 1 | 0.75 | 1.04887 | 0 | | | | 111.27 | 111.4 |
| iso Cₐ | | | | | | | | | | (isobutane) |
| ∠C_{b}CₐC_{b} | 1 | 1 | 1 | 0.81549 | −1.85836 | | | | 111.37 | 110.8 |
| tert Cₐ | | | | | | | | | | (isobutane) |
| ∠C_{b}CₐC_{d} | | | | | | 72.50 | | | 107.50 | |

Alkyl Phosphates ((CₙH₂ₙ₊₁O)₃P═O, n=1,2,3,4,5 . . . ∞)

The alkyl phosphates, (CₙH₂ₙ₊₁O)₃P═O, comprise P═O, P—O, and C—O functional groups. The P═O functional group is equivalent to that of alkyl phosphine oxides. The P—O and C—O functional groups are equivalent to those of alkyl phosphites. The alkyl portion of the alkyl phosphate may comprise at least two terminal methyl groups (CH₃) at each end of each chain, and may comprise methylene (CH₂), and methylyne (CH) functional groups as well as C bound by carbon-carbon single bonds. The methyl and methylene functional groups are equivalent to those of straight-chain alkanes. Six types of C—C bonds can be identified. The n-alkane C—C bond is the same as that of straight-chain alkanes. In addition, the C—C bonds within isopropyl ((CH₃)₂CH) and t-butyl ((CH₃)₃C) groups and the isopropyl to isopropyl, isopropyl to t-butyl, and t-butyl to t-butyl C—C bonds comprise functional groups. The branched-chain-alkane groups in alkyl phosphates are equivalent to those in branched-chain alkanes.

The symbols of the functional groups of branched-chain alkyl phosphates are given in Table 57. The geometrical (Eqs. (15.1-15.5) and (15.51)), intercept (Eqs. (15.80-15.87)), and energy (Eqs. (15.6-15.11) and (15.17-15.65)) parameters of alkyl phosphates are given in Tables 58, 59, and 60, respectively. The total energy of each alkyl phosphate given in Table 61 was calculated as the sum over the integer multiple of each E_{D}(Group) of Table 60 corresponding to functional-group composition of the molecule. The bond angle parameters of alkyl phosphates determined using Eqs. (15.88-15.117) are given in Table 63. The color scale, charge-density of exemplary alkyl phosphate, tri-isopropyl phosphate, comprising of atoms with the outer shell bridged by one or more H₂-type ellipsoidal MOs or joined with one or more hydrogen MOs is shown in FIG. 17.

TABLE 57
The symbols of functional groups of alkyl phosphates.

| Functional Group | Group Symbol |
|---|---|
| P═O | P═O |
| P—O | P—O |
| C—O (CH₃—O— and (CH₃)₃C—O—) | C—O (i) |
| C—O (alkyl) | C—O (ii) |
| CH₂ group | C—H (CH₂) |
| CH | C—H |
| CC bond (n-C) | C—C (a) |
| CC bond (iso-C) | C—C (b) |
| CC bond (tert-C) | C—C (c) |
| CC (iso to iso-C) | C—C (d) |
| CC (t to t-C) | C—C (e) |
| CC (t to iso-C) | C—C (f) |

TABLE 58
The geometrical bond parameters of alkyl phosphates and experimental values [1].

| | P═O | P—O | C—O (i) | C—O (ii) | C—H (CH₃) | C—H (CH₂) |
|---|---|---|---|---|---|---|
| Parameter | Group | Group | Group | Group | Group | Group |
| a (a₀) | 1.91663 | 1.84714 | 1.80717 | 1.79473 | 1.64920 | 1.67122 |
| c′ (a₀) | 1.38442 | 1.52523 | 1.34431 | 1.33968 | 1.04856 | 1.05553 |
| Bond Length | 1.46521E−10 | 1.61423 | 1.42276 | 1.41785 | 1.10974 | 1.11713 |
| 2c′ (Å) | | | | | | |
| Exp. Bond | 1.48 [64] | 1.631 [69] | 1.416 | 1.418 | 1.107 | 1.107 |
| Length | (DNA) | (MHP) | (dimethyl ether) | (ethyl methyl | (C—H propane) | (C—H propane) |
| (Å) | 1.4759 | 1.60 [64] | | ether (avg.)) | 1.117 | 1.117 |
| | (PO) | (DNA) | | | (C—H butane) | (C—H butane) |
| b, c (a₀) | 1.32546 | 1.04192 | 1.20776 | 1.19429 | 1.27295 | 1.29569 |
| e | 0.72232 | 0.82573 | 0.74388 | 0.74645 | 0.63580 | 0.63159 |

| | C—H | C—C (a) | C—C (b) | C—C (c) | C—C (d) | C—C (e) | C—C (f) |
|---|---|---|---|---|---|---|---|
| Parameter | Group | Group | Group | Group | Group | Group | Group |
| a (a₀) | 1.67465 | 2.12499 | 2.12499 | 2.10725 | 2.12499 | 2.10725 | 2.10725 |
| c′ (a₀) | 1.05661 | 1.45744 | 1.45744 | 1.45164 | 1.45744 | 1.45164 | 1.45164 |
| Bond Length | 1.11827 | 1.54280 | 1.54280 | 1.53635 | 1.54280 | 1.53635 | 1.53635 |
| 2c′ (Å) | | | | | | | |
| Exp. Bond | 1.122 | 1.532 | 1.532 | 1.532 | 1.532 | 1.532 | 1.532 |
| Length | (isobutane) | (propane) | (propane) | (propane) | (propane) | (propane) | (propane) |
| (Å) | | 1.531 | 1.531 | 1.531 | 1.531 | 1.531 | 1.531 |
| | | (butane) | (butane) | (butane) | (butane) | (butane) | (butane) |
| b, c (a₀) | 1.29924 | 1.54616 | 1.54616 | 1.52750 | 1.54616 | 1.52750 | 1.52750 |
| e | 0.63095 | 0.68600 | 0.68600 | 0.68888 | 0.68600 | 0.68888 | 0.68888 |

TABLE 59
The MO to HO intercept geometrical bond parameters of alkyl phosphates. R, R′, R″ are H or alkyl groups. E_{T} is E_{T}
(atom-atom, msp³.A O).

| | | E_{T} | E_{T} | E_{T} |
|---|---|---|---|---|
| | | (eV) | (eV) | (eV) |
| Bond | Atom | Bond 1 | Bond 2 | Bond 3 |
| (CH₃)₃P═O | O | −1.13379 | 0 | 0 |
| (CH₃O)₃P═O | P | −1.13379 | −0.72457 | −0.72457 |
| (CH₃O)₂(O)P—OCH₃(CH₃O)₂(O)P—OC(CH₃)₃(C—O (i)) | O | −0.72457 | −0.72457 | 0 |
| (CH₃O)₂(O)P—OCH₃(CH₃O)₂(O)P—OC(CH₃)₃(CH₃O)₂(O)P—OCH₂R(C—O (i)) | P | −0.72457 | −0.72457 | −0.72457 |
| and (C—O (ii)) | | | | |
| (CH₃O)₂(O)P—OCH₂R(C—O (ii)) | O | −0.72457 | −0.82688 | 0 |
| C—H (OCₐH₃) | Cₐ | −0.72457 | 0 | 0 |
| (CH₃O)₂(O)PO—CₐH₃ | Cₐ | −0.72457 | 0 | 0 |
| (CH₃O)₂(O)PO—Cₐ(CH₃)₃(C—O (i)) | Cₐ | −0.72457 | −0.72457 | −0.72457 |
| (H₃CO)₂(O)PO—CₐH_{3(CH}₃)₃Cₐ—OP(O)(OC_{b}H₃)₂(C—O (i)) | O | −0.72457 | −0.72457 | 0 |
| —H₂Cₐ—OP(O)(OCH₃)₂(C—O (ii)) | Cₐ | −0.82688 | −0.92918 | 0 |
| (CH₃O)₂(O)PO—CₐH(CH₃)₂(C—O (ii)) | Cₐ | −0.82688 | −0.92918 | −0.92918 |
| —H₂Cₐ—OP(O)(OCH₃)₂(H₃C)₂HCₐ—OP(O)(OCH₃)₂(C—O (ii)) | O | −0.72457 | −0.82688 | 0 |
| C—H (CH₃) | C | −0.92918 | 0 | 0 |
| C—H (CH₂) | C | −0.92918 | −0.92918 | 0 |
| C—H (CH) | C | −0.92918 | −0.92918 | −0.92918 |
| H₃CₐC_{b}H₂CH₂—(C—C (a)) | Cₐ | −0.92918 | 0 | 0 |
| H₃CₐC_{b}H₂CH₂—(C—C (a)) | C_{b} | −0.92918 | −0.92918 | 0 |
| R—H₂CₐC_{b}(H₂C_{c}—R′)HCH₂—(C—C (b)) | C_{b} | −0.92918 | −0.92918 | −0.92918 |
| R—H₂Cₐ(R′—H₂C_{d})C_{b}(R″—H₂C_{c})CH₂—(C—C (c)) | C_{b} | −0.92918 | −0.72457 | −0.72457 |
| isoCₐC_{b}(H₂C_{c}—R′)HCH₂—(C—C (d)) | C_{b} | −0.92918 | −0.92918 | −0.92918 |
| tertCₐ(R′—H₂C_{d})C_{b}(R″—H₂C_{c})CH₂—(C—C (e)) | C_{b} | −0.72457 | −0.72457 | −0.72457 |
| tertCₐC_{b}(H₂C_{c}—R′)HCH₂—(C—C (f)) | C_{b} | −0.72457 | −0.92918 | −0.92918 |
| isoCₐ(R′—H₂C_{d})C_{b}(R″—H₂C_{c})CH₂—(C—C (f)) | C_{b} | −0.72457 | −0.72457 | −0.72457 |

| | | Final Total | | |
|---|---|---|---|---|
| | E_{T} | Energy | | |
| | (eV) | C2sp³ | rᵢₙᵢₜᵢₐₗ | r_{final} |
| Bond | Bond 4 | (eV) | (a₀) | (a₀) |
| (CH₃)₃P═O | 0 | | 1.00000 | 0.85252 |
| (CH₃O)₃P═O | −0.72457 | | 1.15350 | 0.75032 |
| (CH₃O)₂(O)P—OCH₃(CH₃O)₂(O)P—OC(CH₃)₃(C—O (i)) | 0 | | 1.00000 | 0.83600 |
| (CH₃O)₂(O)P—OCH_{3(CH}₃O)₂(O)P—OC(CH₃)₃(CH₃O)₂(O)P—OCH₂R(C—O (i)) | −1.13379 | | 1.15350 | 0.75032 |
| and (C—O (ii)) | | | | |
| (CH₃O)₂(O)P—OCH₂R(C—O (ii)) | 0 | | 1.00000 | 0.83078 |
| C—H (OCₐH₃) | 0 | −152.34026 | 0.91771 | 0.87495 |
| (CH₃O)₂(O)PO—CₐH₃ | 0 | −152.34026 | 0.91771 | 0.87495 |
| (CH₃O)₂(O)PO—Cₐ(CH₃)₃(C—O (i)) | −0.72457 | −154.51399 | 0.91771 | 0.76765 |
| (H₃CO)₂(O)PO—CₐH₃(CH₃)₃Cₐ—OP(O)(OC_{b}H₃)₂(C—O (i)) | 0 | | 1.00000 | 0.83600 |
| —H₂Cₐ—OP(O)(OCH₃)₂(C—O (ii)) | 0 | −153.37175 | 0.91771 | 0.82053 |
| (CH₃O)₂(O)PO—CₐH(CH₃)₂(C—O (ii)) | 0 | −154.30093 | 0.91771 | 0.77699 |
| —H₂Cₐ—OP(O)(OCH₃)₂(H₃C)₂HCₐ—OP(O)(OCH₃)₂(C—O (ii)) | 0 | | 1.00000 | 0.83078 |
| C—H (CH₃) | 0 | −152.54487 | 0.91771 | 0.86359 |
| C—H (CH₂) | 0 | −153.47406 | 0.91771 | 0.81549 |
| C—H (CH) | 0 | −154.40324 | 0.91771 | 0.77247 |
| H₃CₐC_{b}H₂CH₂—(C—C (a)) | 0 | −152.54487 | 0.91771 | 0.86359 |
| H₃CₐC_{b}H₂CH₂—(C—C (a)) | 0 | −153.47406 | 0.91771 | 0.81549 |
| R—H₂CₐC_{b}(H₂C_{c}—R′)HCH₂—(C—C (b)) | 0 | −154.40324 | 0.91771 | 0.77247 |
| R—H₂Cₐ(R′—H₂C_{d})C_{b}(R″—H₂C_{c})CH₂—(C—C (c)) | −0.72457 | −154.71860 | 0.91771 | 0.75889 |
| isoCₐC_{b}(H₂C_{c}—R′)HCH₂—(C—C (d)) | 0 | −154.40324 | 0.91771 | 0.77247 |
| tertCₐ(R′—H₂C_{d})C_{b}(R″—H₂C_{c})CH₂—(C—C (e)) | −0.72457 | −154.51399 | 0.91771 | 0.76765 |
| tertCₐC_{b}(H₂C_{c}—R′)HCH₂—(C—C (f)) | 0 | −154.19863 | 0.91771 | 0.78155 |
| isoCₐ(R′—H₂C_{d})C_{b}(R″—H₂C_{c})CH₂—(C—C (f)) | −0.72457 | −154.51399 | 0.91771 | 0.76765 |

| | E_{Coulomb} | | θ′ |
|---|---|---|---|
| Bond | (eV) Final | E (C2sp³) (eV) Final | (°) |
| (CH₃)₃P═O | −15.95954 | | 84.02 |
| (CH₃O)₃P═O | −18.13326 | | 72.13 |
| (CH₃O)₂(O)P—OCH₃(CH₃O)₂(O)P—OC(CH₃)₃(C—O (i)) | −16.27489 | | 111.08 |
| (CH₃O)₂(O)P—OCH₃(CH₃O)₂(O)P—OC(CH₃)₃(CH₃O)₂(O)P—OCH₂R(C—O (i)) | −18.13326 | | 105.22 |
| and (C—O (ii)) | | | |
| (CH₃O)₂(O)P—OCH₂R(C—O (ii)) | −16.37720 | | 110.75 |
| C—H (OCₐH₃) | −15.55033 | −15.35946 | 78.85 |
| (CH₃O)₂(O)PO—CₐH₃ | −15.55033 | −15.35946 | 95.98 |
| (CH₃O)₂(O)PO—Cₐ(CH₃)₃(C—O (i)) | −17.72405 | | 86.03 |
| (H₃CO)₂(O)PO—CₐH₃(CH₃)₃Cₐ—OP(O)(OC_{b}H₃)₂(C—O (i)) | −16.27490 | | 92.66 |
| —H₂Cₐ—OP(O)(OCH₃)₂(C—O (ii)) | −16.58181 | −16.39095 | 92.41 |
| (CH₃O)₂(O)PO—CₐH(CH₃)₂(C—O (ii)) | −17.51099 | −17.32013 | 88.25 |
| —H₂Cₐ—OP(O)(OCH₃)₂(H₃C)₂HCₐ—OP(O)(OCH₃)₂(C—O (ii)) | −16.37720 | | 93.33 |
| C—H (CH₃) | −15.75493 | −15.56407 | 77.49 |
| C—H (CH₂) | −16.68412 | −16.49325 | 68.47 |
| C—H (CH) | −17.61330 | −17.42244 | 61.10 |
| H₃CₐC_{b}H₂CH₂—(C—C (a)) | −15.75493 | −15.56407 | 63.82 |
| H₃CₐC_{b}H₂CH₂—(C—C (a)) | −16.68412 | −16.49325 | 56.41 |
| R—H₂CₐC_{b}(H₂C_{c}—R′)HCH₂—(C—C (b)) | −17.61330 | −17.42244 | 48.30 |
| R—H₂Cₐ(R′—H₂C_{d})C_{b}(R″—H₂C_{c})CH₂—(C—C (c)) | −17.92866 | −17.73779 | 48.21 |
| isoCₐC_{b}(H₂C_{c}—R′)HCH₂—(C—C (d)) | −17.61330 | −17.42244 | 48.30 |
| tertCₐ(R′—H₂C_{d})C_{b}(R″—H₂C_{c})CH₂—(C—C (e)) | −17.92866 | −17.73779 | 50.04 |
| tertCₐC_{b}(H₂C_{c}—R′)HCH₂—(C—C (f)) | −17.40869 | −17.21783 | 52.78 |
| isoCₐ(R′—H₂C_{d})C_{b}(R″—H₂C_{c})CH₂—(C—C (f)) | −17.92866 | −17.73779 | 50.04 |

| | θ₁ | θ₂ | d₁ | d₂ |
|---|---|---|---|---|
| Bond | (°) | (°) | (a₀) | (a₀) |
| (CH₃)₃P═O | 95.98 | 39.77 | 1.47318 | 0.08876 |
| (CH₃O)₃P═O | 107.87 | 32.60 | 1.61466 | 0.23024 |
| (CH₃O)₂(O)P—OCH₃(CH₃O)₂(O)P—OC(CH₃)₃(C—O (i)) | 68.92 | 48.48 | 1.22455 | 0.30068 |
| (CH₃O)₂(O)P—OCH₃(CH₃O)₂(O)P—OC(CH₃)₃(CH₃O)₂(O)P—OCH₂R(C—O (i)) | 74.78 | 44.02 | 1.32831 | 0.19692 |
| and (C—O (ii)) | | | | |
| (CH₃O)₂(O)P—OCH₂R(C—O (ii)) | 69.25 | 48.21 | 1.23087 | 0.29436 |
| C—H (OCₐH₃) | 101.15 | 42.40 | 1.21777 | 0.16921 |
| (CH₃O)₂(O)PO—CₐH₃ | 84.02 | 46.10 | 1.25319 | 0.09112 |
| (CH₃O)₂(O)PO—Cₐ(CH₃)₃(C—O (i)) | 93.97 | 39.35 | 1.39744 | 0.05313 |
| (H₃CO)₂(O)PO—CₐH₃(CH₃)₃Cₐ—OP(O)(OC_{b}H₃)₂(C—O (i)) | 87.34 | 43.74 | 1.30555 | 0.03876 |
| —H₂Cₐ—OP(O)(OCH₃)₂(C—O (ii)) | 87.59 | 43.35 | 1.30512 | 0.03456 |
| (CH₃O)₂(O)PO—CₐH(CH₃)₂(C—O (ii)) | 91.75 | 40.56 | 1.36345 | 0.02377 |
| —H₂Cₐ—OP(O)(OCH₃)₂(H₃C)₂HCₐ—OP(O)(OCH₃)₂(C—O (ii)) | 86.67 | 43.98 | 1.29138 | 0.04829 |
| C—H (CH₃) | 102.51 | 41.48 | 1.23564 | 0.18708 |
| C—H (CH₂) | 111.53 | 35.84 | 1.35486 | 0.29933 |
| C—H (CH) | 118.90 | 31.37 | 1.42988 | 0.37326 |
| H₃CₐC_{b}H₂CH₂—(C—C (a)) | 116.18 | 30.08 | 1.83879 | 0.38106 |
| H₃CₐC_{b}H₂CH₂—(C—C (a)) | 123.59 | 26.06 | 1.90890 | 0.45117 |
| R—H₂CₐC_{b}(H₂C_{c}—R′)HCH₂—(C—C (b)) | 131.70 | 21.90 | 1.97162 | 0.51388 |
| R—H₂Cₐ(R′—H₂C_{d})C_{b}(R″—H₂C_{c})CH₂—(C—C (c)) | 131.79 | 21.74 | 1.95734 | 0.50570 |
| isoCₐC_{b}(H₂C_{c}—R′)HCH₂—(C—C (d)) | 131.70 | 21.90 | 1.97162 | 0.51388 |
| tertCₐ(R′—H₂C_{d})C_{b}(R″—H₂C_{c})CH₂—(C—C (e)) | 129.96 | 22.66 | 1.94462 | 0.49298 |
| tertCₐC_{b}(H₂C_{c}—R′)HCH₂—(C—C (f)) | 127.22 | 24.04 | 1.92443 | 0.47279 |
| isoCₐ(R′—H₂C_{d})C_{b}(R″—H₂C_{c})CH₂—(C—C (f)) | 129.96 | 22.66 | 1.94462 | 0.49298 |

TABLE 60
The energy parameters (eV) of functional groups of alkyl phosphates.

| | P═O | P—O | C—O (i) | C—O (ii) | CH₃ | CH₂ | CH (i) |
|---|---|---|---|---|---|---|---|
| Parameters | Group | Group | Group | Group | Group | Group | Group |
| n₁ | 2 | 1 | 1 | 1 | 3 | 2 | 1 |
| n₂ | 0 | 0 | 0 | 0 | 2 | 1 | 0 |
| n₃ | 0 | 0 | 0 | 0 | 0 | 0 | 0 |
| C₁ | 0.5 | 0.5 | 0.5 | 0.5 | 0.75 | 0.75 | 0.75 |
| C₂ | 1 | 1 | 1 | 1 | 1 | 1 | 1 |
| c₁ | 1 | 1 | 1 | 1 | 1 | 1 | 1 |
| c₂ | 0.79401 | 0.79401 | 0.85395 | 0.85395 | 0.91771 | 0.91771 | 0.91771 |
| c₃ | 0 | 0 | 0 | 0 | 0 | 1 | 1 |
| c₄ | 4 | 2 | 2 | 2 | 1 | 1 | 1 |
| c₅ | 0 | 0 | 0 | 0 | 3 | 2 | 1 |
| C₁ₒ | 0.5 | 0.5 | 0.5 | 0.5 | 0.75 | 0.75 | 0.75 |
| C₂ₒ | 1 | 0.79401 | 1 | 1 | 1 | 1 | 1 |
| Vₑ (eV) | −56.96374 | −33.27738 | −33.15757 | −33.47304 | −107.32728 | −70.41425 | −35.12015 |
| Vₚ (eV) | 9.82777 | 8.92049 | 10.12103 | 10.15605 | 38.92728 | 25.78002 | 12.87680 |
| T (eV) | 14.86039 | 9.00781 | 9.17389 | 9.32537 | 32.53914 | 21.06675 | 10.48582 |
| Vₘ (eV) | −7.43020 | −4.50391 | −4.58695 | −4.66268 | −16.26957 | −10.53337 | −5.24291 |
| E (AO/HO) (eV) | −23.56492 | −11.78246 | −14.63489 | −14.63489 | −15.56407 | −15.56407 | −14.63489 |
| ΔE_{H}_{₂}_{MO} (AO/HO) (eV) | 0 | 0 | −1.44915 | −1.65376 | 0 | 0 | 0 |
| E_{T} (AO/HO) (eV) | −23.56492 | −11.78246 | −13.18574 | −12.98113 | −15.56407 | −15.56407 | −14.63489 |
| E_{T} (H₂MO) (eV) | −63.27069 | −31.63544 | −31.63533 | −31.63544 | −67.69451 | −49.66493 | −31.63533 |
| E_{T} (atom-atom, msp³.AO) (eV) | −2.26758 | −1.44914 | −1.44915 | −1.65376 | 0 | 0 | 0 |
| E_{T} (MO) (eV) | −65.53832 | −33.08451 | −33.08452 | −33.28912 | −67.69450 | −49.66493 | −31.63537 |
| ω (10¹⁵ rad/s) | 11.0170 | 10.3761 | 12.0329 | 12.1583 | 24.9286 | 24.2751 | 24.1759 |
| E_{K} (eV) | 7.25157 | 6.82973 | 7.92028 | 8.00277 | 16.40846 | 15.97831 | 15.91299 |
| Ē_{D} (eV) | −0.17458 | −0.17105 | −0.18420 | −0.18631 | −0.25352 | −0.25017 | −0.24966 |
| Ē_{Kvib} (eV) | 0.15292 | 0.10477 | 0.13663 | 0.16118 | 0.35532 | 0.35532 | 0.35532 |
| | [24] | [70] | [21] | [4] | (Eq. | (Eq. | (Eq. |
| | | | | | (13.458)) | (13.458)) | (13.458)) |
| Ē_{osc} (eV) | −0.09812 | −0.11867 | −0.11589 | −0.10572 | −0.22757 | −0.14502 | −0.07200 |
| E_{mag} (eV) | 0.14803 | 0.14803 | 0.14803 | 0.14803 | 0.14803 | 0.14803 | 0.14803 |
| E_{T} (Group) (eV) | −65.73455 | −33.20318 | −33.20040 | −33.39484 | −67.92207 | −49.80996 | −31.70737 |
| Eᵢₙᵢₜᵢₐₗ (c₄ AO/HO) (eV) | −14.63489 | −14.63489 | −14.63489 | −14.63489 | −14.63489 | −14.63489 | −14.63489 |
| Eᵢₙᵢₜᵢₐₗ (c₅ AO/HO) (eV) | 0 | 0 | 0 | 0 | −13.59844 | −13.59844 | −13.59844 |
| E_{D} (Group) (eV) | 7.19500 | 3.93340 | 3.93062 | 4.12506 | 12.49186 | 7.83016 | 3.32601 |

| | C—C (a) | C—C (b) | C—C (c) | C—C (d) | C—C (e) | C—C (f) |
|---|---|---|---|---|---|---|
| Parameters | Group | Group | Group | Group | Group | Group |
| n₁ | 1 | 1 | 1 | 1 | 1 | 1 |
| n₂ | 0 | 0 | 0 | 0 | 0 | 0 |
| n₃ | 0 | 0 | 0 | 0 | 0 | 0 |
| C₁ | 0.5 | 0.5 | 0.5 | 0.5 | 0.5 | 0.5 |
| C₂ | 1 | 1 | 1 | 1 | 1 | 1 |
| c₁ | 1 | 1 | 1 | 1 | 1 | 1 |
| c₂ | 0.91771 | 0.91771 | 0.91771 | 0.91771 | 0.91771 | 0.91771 |
| c₃ | 0 | 0 | 0 | 1 | 1 | 0 |
| c₄ | 2 | 2 | 2 | 2 | 2 | 2 |
| c₅ | 0 | 0 | 0 | 0 | 0 | 0 |
| C₁ₒ | 0.5 | 0.5 | 0.5 | 0.5 | 0.5 | 0.5 |
| C₂ₒ | 1 | 1 | 1 | 1 | 1 | 1 |
| Vₑ (eV) | −28.79214 | −28.79214 | −29.10112 | −28.79214 | −29.10112 | −29.10112 |
| Vₚ (eV) | 9.33352 | 9.33352 | 9.37273 | 9.33352 | 9.37273 | 9.37273 |
| T (eV) | 6.77464 | 6.77464 | 6.90500 | 6.77464 | 6.90500 | 6.90500 |
| Vₘ (eV) | −3.38732 | −3.38732 | −3.45250 | −3.38732 | −3.45250 | −3.45250 |
| E (AO/HO) (eV) | −15.56407 | −15.56407 | −15.35946 | −15.56407 | −15.35946 | −15.35946 |
| ΔE_{H}_{₂}_{MO} (AO/HO) (eV) | 0 | 0 | 0 | 0 | 0 | 0 |
| E_{T} (AO/HO) (eV) | −15.56407 | −15.56407 | −15.35946 | −15.56407 | −15.35946 | −15.35946 |
| E_{T} (H₂MO) (eV) | −31.63537 | −31.63537 | −31.63535 | −31.63537 | −31.63535 | −31.63535 |
| E_{T} (atom-atom, msp³.AO) (eV) | −1.85836 | −1.85836 | −1.44915 | −1.85836 | −1.44915 | −1.44915 |
| E_{T} (MO) (eV) | −33.49373 | −33.49373 | −33.08452 | −33.49373 | −33.08452 | −33.08452 |
| ω (10¹⁵ rad/s) | 9.43699 | 9.43699 | 15.4846 | 9.43699 | 9.55643 | 9.55643 |
| E_{K} (eV) | 6.21159 | 6.21159 | 10.19220 | 6.21159 | 6.29021 | 6.29021 |
| Ē_{D} (eV) | −0.16515 | −0.16515 | −0.20896 | −0.16515 | −0.16416 | −0.16416 |
| Ē_{Kvib} (eV) | 0.12312 | 0.17978 | 0.09944 | 0.12312 | 0.12312 | 0.12312 |
| | [2] | [4] | [5] | [2] | [2] | [2] |
| Ē_{osc} (eV) | −0.10359 | −0.07526 | −0.15924 | −0.10359 | −0.10260 | −0.10260 |
| E_{mag} (eV) | 0.14803 | 0.14803 | 0.14803 | 0.14803 | 0.14803 | 0.14803 |
| E_{T} (Group) (eV) | −33.59732 | −33.49373 | −33.24376 | −33.59732 | −33.18712 | −33.18712 |
| Eᵢₙᵢₜᵢₐₗ (c₄ AO/HO) (eV) | −14.63489 | −14.63489 | −14.63489 | −14.63489 | −14.63489 | −14.63489 |
| Eᵢₙᵢₜᵢₐₗ (c₅ AO/HO) (eV) | 0 | 0 | 0 | 0 | 0 | 0 |
| E_{D} (Group) (eV) | 4.32754 | 4.29921 | 3.97398 | 4.17951 | 3.62128 | 3.91734 |

TABLE 61
The total bond energies of alkyl phosphates calculated using the functional group composition
and the energies of Table 60 compared to the experimental values [68].

| | | | | | C—O | | | | C—C |
|---|---|---|---|---|---|---|---|---|---|
| Formula | Name | P═O | P—O | C—O (i) | (ii) | CH₃ | CH₂ | CH (i) | (a) |
| C₆H₁₅O₄P | Triethyl phosphate | 1 | 3 | 0 | 3 | 3 | 3 | 0 | 3 |
| C₉H₂₁O₄P | Tri-n-propyl | 1 | 3 | 0 | 3 | 3 | 6 | 0 | 6 |
| | phosphate | | | | | | | | |
| C₉H₂₁O₄P | Tri-isopropyl | 1 | 3 | 0 | 3 | 6 | 0 | 3 | 0 |
| | phosphate | | | | | | | | |
| C₉H₂₇O₄P | Tri-n-butyl | 1 | 3 | 0 | 3 | 3 | 9 | 0 | 9 |
| | phosphate | | | | | | | | |

| | | | | | | | Calculated | | |
|---|---|---|---|---|---|---|---|---|---|
| | | | | | | | Total Bond | Experimental | |
| | | C—C | C—C | C—C | C—C | C—C | Energy | Total Bond | Relative |
| Formula | Name | (b) | (c) | (d) | (e) | (f) | (eV) | Energy (eV) | Error |
| C₆H₁₅O₄P | Triethyl phosphate | 0 | 0 | 0 | 0 | 0 | 105.31906 | 104.40400 | −0.00876 |
| C₉H₂₁O₄P | Tri-n-propyl | 0 | 0 | 0 | 0 | 0 | 141.79216 | 140.86778 | −0.00656 |
| | phosphate | | | | | | | | |
| C₉H₂₁O₄P | Tri-isopropyl | 6 | 0 | 0 | 0 | 0 | 142.09483 | 141.42283 | −0.00475 |
| | phosphate | | | | | | | | |
| C₉H₂₇O₄P | Tri-n-butyl phosphate | 0 | 0 | 0 | 0 | 0 | 178.26526 | 178.07742 | −0.00105 |

TABLE 62
The bond angle parameters of alkyl phosphates and experimental values [1]. In the calculation of θᵥ, the parameters from
the preceding angle were used. E_{T} is E_{T}(atom-atom,msp³.AO).

| | | | 2c′ | | Atom 1 | | Atom 2 | | |
|---|---|---|---|---|---|---|---|---|---|
| | 2c′ | 2c′ | Terminal | E_{Coulombic} | Hybridization | | Hybridization | | |
| Atoms of | Bond 1 | Bond 2 | Atoms | or E | Designation | E_{Coulombic} | Designation | c₂ | c₂ |
| Angle | (a₀) | (a₀) | (a₀) | Atom 1 | (Table 7) | Atom 2 | (Table 7) | Atom 1 | Atom 2 |
| ∠POC | 3.05046 | 2.67935 | 4.9904 | −11.78246 | Psp³ | −15.75493 | 7 | 0.73885 | 0.86359 |
| | | | | | | | | Eq. | |
| | | | | | | | | (15.181) | |
| ∠OₐPOₐ | 3.05046 | 3.05046 | 4.7539 | −15.95954 | 10 | −15.95954 | 10 | 0.85252 | 0.85252 |
| ∠OₐPO_{b} | 3.05046 | 2.76885 | 4.7539 | −15.95954 | 10 | −15.95954 | 10 | 0.85252 | 0.85252 |
| ∠C_{b}CₐO(Cₐ—O | 2.91547 | 2.67935 | 4.5607 | −16.68412 | 26 | −13.61806 | O | 0.81549 | 0.85395 |
| (ii)) | | | | | | | | | (Eq. |
| | | | | | | | | | (15.133)) |
| Methylene | 2.11106 | 2.11106 | 3.4252 | −15.75493 | 7 | H | H | 0.86359 | 1 |
| ∠HCₐH | | | | | | | | | |
| ∠CₐC_{b}C_{c} | | | | | | | | | |
| ∠CₐC_{b}H | | | | | | | | | |
| Methyl | 2.09711 | 2.09711 | 3.4252 | −15.75493 | 7 | H | H | 0.86359 | 1 |
| ∠HCₐH | | | | | | | | | |
| ∠CₐC_{b}C_{c} | | | | | | | | | |
| ∠CₐC_{b}H | | | | | | | | | |
| ∠C_{b}CₐC_{c} | 2.91547 | 2.91547 | 4.7958 | −16.68412 | 26 | −16.68412 | 26 | 0.81549 | 0.81549 |
| iso Cₐ | | | | C_{b} | | C_{c} | | | |
| ∠C_{b}CₐH | 2.91547 | 2.11323 | 4.1633 | −15.55033 | 5 | −14.82575 | 1 | 0.87495 | 0.91771 |
| iso Cₐ | | | | Cₐ | | C_{b} | | | |
| ∠CₐC_{b}H | 2.91547 | 2.09711 | 4.1633 | −15.55033 | 5 | −14.82575 | 1 | 0.87495 | 0.91771 |
| iso Cₐ | | | | C_{b} | | Cₐ | | | |
| ∠C_{b}CₐC_{b} | 2.90327 | 2.90327 | 4.7958 | −16.68412 | 26 | −16.68412 | 26 | 0.81549 | 0.81549 |
| tert Cₐ | | | | C_{b} | | C_{b} | | | |
| ∠C_{b}CₐC_{d} | | | | | | | | | |

| Atoms of | | | | | E_{T} | θᵥ | θ₁ | θ₂ | Cal. θ | Exp. θ |
|---|---|---|---|---|---|---|---|---|---|---|
| Angle | C₁ | C₂ | c₁ | c₂′ | (eV) | (°) | (°) | (°) | (°) | (°) |
| ∠POC | 1 | 0.73885 | 1 | 0.80122 | −0.72457 | | | | 121.00 | 122.2 [69] |
| | | | | | | | | | | (MHPO) |
| ∠OₐPOₐ | 1 | 1 | 1 | 0.85252 | −1.65376 | | | | 102.38 | 101.4 [64] |
| | | | | | | | | | | (DNA) |
| ∠OₐPO_{b} | 1 | 1 | 1 | 0.85395 | −1.65376 | | | | 109.46 | 109.7 [64] |
| | | | | | | | | | | (DNA) |
| ∠C_{b}CₐO(Cₐ—O | 1 | 1 | 1 | 0.83472 | −1.65376 | | | | 109.13 | 109.4 |
| (ii)) | | | | | | | | | | (ethyl methyl |
| | | | | | | | | | | ether) |
| Methylene | 1 | 1 | 0.75 | 1.15796 | 0 | | | | 108.44 | 107 |
| ∠HCₐH | | | | | | | | | | (propane) |
| ∠CₐC_{b}C_{c} | | | | | | 69.51 | | | 110.49 | 112 |
| | | | | | | | | | | (propane) |
| | | | | | | | | | | 113.8 |
| | | | | | | | | | | (butane) |
| | | | | | | | | | | 110.8 |
| | | | | | | | | | | (isobutane) |
| ∠CₐC_{b}H | | | | | | 69.51 | | | 110.49 | 111.0 |
| | | | | | | | | | | (butane) |
| | | | | | | | | | | 111.4 |
| | | | | | | | | | | (isobutane) |
| Methyl | 1 | 1 | 0.75 | 1.15796 | 0 | | | | 109.50 | |
| ∠HCₐH | | | | | | | | | | |
| ∠CₐC_{b}C_{c} | | | | | | 70.56 | | | 109.44 | |
| ∠CₐC_{b}H | | | | | | 70.56 | | | 109.44 | |
| ∠C_{b}CₐC_{c} | 1 | 1 | 1 | 0.81549 | −1.85836 | | | | 110.67 | 110.8 |
| iso Cₐ | | | | | | | | | | (isobutane) |
| ∠C_{b}CₐH | 0.75 | 1 | 0.75 | 1.04887 | 0 | | | | 110.76 | |
| iso Cₐ | | | | | | | | | | |
| ∠CₐC_{b}H | 0.75 | 1 | 0.75 | 1.04887 | 0 | | | | 111.27 | 111.4 |
| iso Cₐ | | | | | | | | | | (isobutane) |
| ∠C_{b}CₐC_{b} | 1 | 1 | 1 | 0.81549 | −1.85836 | | | | 111.37 | 110.8 |
| tert Cₐ | | | | | | | | | | (isobutane) |
| ∠C_{b}CₐC_{d} | | | | | | 72.50 | | | 107.50 | |

Organic and Related Ions (RCO₂⁻, ROSO₃⁻, NO₃⁻, (RO)₂PO₂⁻(RO)₃SiO⁻, (R)₂Si(O⁻)₂, RNH₃⁺, R₂NH₂⁺)

Proteins comprising amino acids with amino and carboxylic acid groups are charged at physiological pH. Deoxyribonucleic acid (DNA), the genetic material of living organisms also comprises negatively charged phosphate groups. Thus, the bonding of organic ions is considered next. The molecular ions also comprise functional groups that have an additional electron or are deficient by an electron in the cases of monovalent molecular anions and cations, respectively. The molecular chemical bond typically comprises an even integer number of paired electrons, but with an excess of deficiency, the bonding may involve and odd number of electrons, and the electrons may be distributed over multiple bonds, solved as a linear combination of standard bonds. As given in the Benzene Molecule section and other sections on aromatic molecules such as naphthalene, toluene, chlorobenzene, phenol, aniline, nitrobenzene, benzoic acid, pyridine, pyrimidine, pyrazine, quinoline, isoquinoline, indole, and adenine, the paired electrons of MOs may be distributed over a linear combination of bonds such that the bonding between two atoms involves less than an integer multiple of two electrons. Specifically, the results of the derivation of the parameters of the benzene molecule given in the Benzene Molecule (C₆H₆) section was generalized to any aromatic functional group of aromatic and heterocyclic compounds in the Aromatic and Heterocyclic Compounds section. Ethylene serves as a basis element for the C^{3e}═C bonding of the aromatic bond wherein each of the C^{3e}═C aromatic bonds comprises (0.75)(4)=3 electrons according to Eq. (15.161). Thus, in these aromatic cases, three electrons can be assigned to a given bond between two atoms wherein the electrons of the linear combination of bonded atoms are paired and comprise an integer multiple of two.

In graphite, the minimum energy structure with equivalent carbon atoms wherein each carbon forms bonds with three other such carbons requires a redistribution of charge within an aromatic system of bonds. Considering that each carbon contributes four bonding electrons, the sum of electrons of a vertex-atom group is four from the vertex atom plus two from each of the two atoms bonded to the vertex atom where the latter also contribute two each to the juxtaposed group. These eight electrons are distributed equivalently over the three bonds of the group such that the electron number assignable to each bond is 8/3. Thus, the C^{8/2e}═C functional group of graphite comprises the aromatic bond with the exception that the electron-number per bond is 8/3.

As given in the Bridging Bonds of Boranes section and the Bridging Bonds of Organoaluminum Hydrides section, other examples of electron deficient bonding involving two paired electrons centered on three atoms are three-center bonds as opposed to the typical single bond, a two-center bond. The B2sp³ HOs comprise four orbitals containing three electrons as given by Eq. (23.1) that can form three-center as well as two-center bonds. The designation for a three-center bond involving two B2sp³ HOs and a H1s AO is B—H—B, and the designation for a three-center bond involving three B2sp³ HOs is B—B—B. In the aluminum case, each Al—H—Al-bond MO and Al—C—Al-bond MO comprises the corresponding single bond and forms with further sharing of electrons between each Al3sp³ HO and each H1s AO and C2sp³ HO, respectively. Thus, the geometrical and energy parameters of the three-center bond are equivalent to those of the corresponding two-center bonds except that the bond energy is increased in the former case since the donation of electron density from the unoccupied Al3sp³ HO to each Al—H—Al-bond MO and Al—C—Al-bond MO permits the participating orbital to decrease in size and energy.

To match the energies of the AOs and MOs of the ionic functional group with the others within the molecular ion, the bonding in organic ions comprises a standard bond that serves as basis element and retains the same geometrical characteristics as that standard bond. In the case of organic oxyanions, the A-O⁻ (A=C, S, N, P, Si) bond is intermediate between a single and double bond, and the latter serves as a basis element. Similar to the case of the C^{3e}═C aromatic bond wherein ethylene is the basis element, the A=O-bond functional group serves as the basis element for the A-O⁻ functional group of the oxyanion of carboxylates, sulfates, nitrates, phosphates, silanolates, and siloxanolates. This oxyanion group designated by A^{3e}=O⁻ comprises (0.75)(4)=3 electrons after Eq. (15.161). Thus, the energy parameters of the A^{3e}=O⁻ function group are given by the factor of (0.75)(4)=3 times those of the corresponding A=O functional group, and the geometric parameters are the same. The C═O, S═O, N═O₂, P═O, and Si═O basis elements are given in the Carboxylic Acids, Sulfates, Alkyl Nitrates, Phosphates, and Silicon Oxides, Silicic Acids, Silanols, Siloxanes and Disiloxanes sections, respectively. A convenient means to obtain the final group energy parameters of E_{T}(Group) and E_{D}(Group) is by using Eqs. (15.165-15.166) with f₁=0.75:

$$\begin{matrix}{E}_{{T}^{( Group )}} = {f}_{1} ( \begin{matrix}\begin{matrix}\begin{matrix}E ( basis energies ) + \\ {E}_{T} ( atom - atom , {msp}^{3} \cdot AO ) -\end{matrix} \\ 31.63536831 eV\end{matrix} \\ \sqrt{\frac{2 ℏ \frac{\frac{{C}_{1 o} {C}_{2 o} {e}^{2}}{4 {πɛ}_{o} {R}^{3}}}{{m}_{e}}}{{m}_{e} {c}^{2}}} + {n}_{1} {\overline{E}}_{Kvib} + {c}_{3} \frac{8 {πμ}_{o} {μ}_{B}^{2}}{{r}^{3}}\end{matrix} ) & ( 15.183 ) \\ {E}_{{D}^{( Group )}} = - ( \begin{matrix}{f}_{1} ( \begin{matrix}\begin{matrix}\begin{matrix}E ( basis energies ) + \\ {E}_{T} ( atom - atom , {msp}^{3} \cdot AO ) -\end{matrix} \\ 31.63536831 eV\end{matrix} \\ \sqrt{\frac{2 ℏ \sqrt{\frac{\frac{{C}_{1 o} {C}_{2 o} {e}^{2}}{4 {πɛ}_{o} {R}^{3}}}{{m}_{e}}}}{{m}_{e} {c}^{2}}} + \\ {n}_{1} {\overline{E}}_{Kvib} + {c}_{3} \frac{8 {πμ}_{o} {μ}_{B}^{2}}{{r}^{3}}\end{matrix} ) - \\ ( \begin{matrix}{c}_{4} {E}_{initial} ( AO / HO ) + \\ {c}_{5} {E}_{initial} ( {c}_{5} AO / HO )\end{matrix} )\end{matrix} ) & ( 15.184 )\end{matrix}$$

where c₄ is (0.75)(4)=3 when c₅=0 and otherwise c₄ is (0.75)(2)=1.5 and c₅ is (0.75)(2)=1.5.

The nature of the bonding of the amino functional group of protonated amines is similar to that in H₃⁺. As given in the Triatomic Molecular Hydrogen-type Ion (H₃⁺) section, H₃⁺ comprises two indistinguishable spin-paired electrons bound by three protons. The ellipsoidal molecular orbital (MO) satisfies the boundary constraints as shown in the Nature of the Chemical Bond of Hydrogen-Type Molecules section. Since the protons are indistinguishable, ellipsoidal MOs about each pair of protons taken one at a time are indistinguishable. H₃⁺ is then given by a superposition or linear combinations of three equivalent ellipsoidal MOs that form a equilateral triangle where the points of contact between the prolate spheroids are equivalent in energy and charge density. The due to the equivalence of the H₂-type ellipsoidal MOs and the linear superposition of their energies, the energy components defined previously for the H₂ molecule, Eqs. (11.207-11.212) apply in the case of the corresponding H₃⁺ molecular ion. And, each molecular energy component is given by the integral of corresponding force in Eq. (13.5). Each energy component is the total for the two equivalent electrons with the exception that the total charge of the two electrons is normalized over the three basis set H₂-type ellipsoidal MOs. Thus, the energies (Eqs. (13.12-13.17)) are those given for in the Energies of Hydrogen-Type Molecules section with the electron charge, where it appears, multiplied by a factor of 3/2, and the three sets of equivalent proton-proton pairs give rise to a factor of three times the proton-proton repulsion energy given by Eq. (11.208).

With the protonation of the imidogen (NH) functional group, the minimum energy structure with equivalent hydrogen atoms comprises two protons bound to N by two paired electrons, one from H and one from N with the MO matched to the N2p AO. These two electrons are distributed equivalently over the two H—N bonds of the group such that the electron number assignable to each bond is 2/2. Thus, the NH₂⁺ functional group has the imidogen energy parameters with the exception that each energy term is multiplied by the factor 2 due to the two bonds with electron-number per bond of 2/2 and has the same geometric parameters as the NH functional group given in the Secondary Amines section. A convenient means to obtain the final group energy parameters of E_{T}(Group) and E_{D}(Group) is by using Eqs. (15.165-15.166) (Eqs. (15.183-15.184)) with f₁=2 and c₄ and c₅ multiplied by two.

With the protonation of the amidogen (NH₂) functional group, the minimum energy structure with equivalent hydrogen atoms comprises three protons bound to N by four paired electrons, two from 2 H and two from N with the MO matched to the N2p AO. These four electrons are distributed equivalently over the three H—N bonds of the group such that the electron number assignable to each bond is 4/3. Thus, the NH₃⁺ functional group has the amidogen energy parameters with the exception that each energy term is multiplied by the factor 3/2 due to the three bonds with electron-number per bond of 4/3 and has the same geometric parameters as the NH₂ functional group given in the Primary Amines section. A convenient means to obtain the final group energy parameters of E_{T}(Group,) and E_{D}(Group) is by using Eqs. (15.165-15.166) (Eqs. (15.183-15.184)) with f₁=3/2 and c₄ and c₅ multiplied by 3/2.

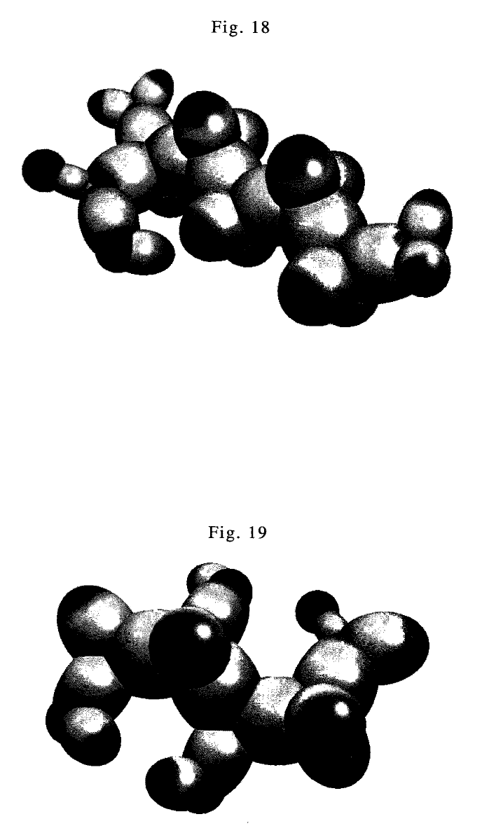

The symbols of the functional groups of organic and related ions are given in Table 63. The geometrical (Eqs. (15.1-15.5) and (15.51)), intercept (Eqs. (15.80-15.87)), and energy (Eqs. (15.6-15.11) and (15.17-15.65)) parameters are given in Tables 64, 65, and 66, respectively. Due to its charge, the bond angles of the organic and related ions that minimize the total energy are those that maximize the separation of the groups. For ions having three bonds to the central atom, the angles are 120°, and ions having four bonds are tetrahedral. The color scale, charge-density of exemplary organic ion, protonated lysine, comprising atoms with the outer shell bridged by one or more H₂-type ellipsoidal MOs or joined with one or more hydrogen MOs is shown in FIG. 18.

TABLE 63
The symbols of functional groups of organic and related ions.

| Functional Group | Group Symbol |
|---|---|
| (O)C—O⁻ (alkyl carboxylate) | C—O⁻ |
| (RO)(O)₂S—O⁻ (alkyl sulfate) | S—O⁻ |
| (O)₂N—O⁻ (nitrate) | N—O⁻ |
| (RO)₂(O)P—O⁻ (alkyl phosphate) | P—O⁻ |
| (RO)₃Si—O⁻ (alkyl siloxanolate) | Si—O⁻ |
| (R)₂Si(—O⁻)₂ (alkyl silanolate) | |
| NH₂⁺ group | NH₂⁺ |
| NH₃⁺ group | NH₃⁺ |

TABLE 64
The geometrical bond parameters of organic and related ions and experimental values of
corresponding basis elements [1].

| | C—O⁻ | S—O⁻ | N—O⁻ | P—O⁻ | Si—O⁻ | NH₂⁺ | NH₃⁺ |
|---|---|---|---|---|---|---|---|
| Parameter | Group | Group | Group | Group | Group | Group | Group |
| a (a₀) | 1.29907 | 1.98517 | 1.29538 | 1.91663 | 2.24744 | 1.26224 | 1.28083 |
| c′ (a₀) | 1.13977 | 1.40896 | 1.13815 | 1.38442 | 1.41056 | 0.94811 | 0.95506 |
| Bond Length | 1.20628 | 1.49118 | 1.20456 | 1.46521 | 1.49287 | 1.00343 | 1.0108 |
| 2c′ (Å) | | | | | | | |
| Exp. Bond | 1.214 | 1.485 | 1.205 | 1.48 [64] | 1.509 | 1.00 | 1.010 |
| Length | (acetic acid) | (dimethyl | (methyl | (DNA) | (silicon | (dimethylamine) | (methylamine) |
| (Å) | | sulfoxide) | nitrate) | | oxide) | | |
| | | | 1.2 | | [73] | | |
| | | | (HNO₂) | | | | |
| b, c (a₀) | 0.62331 | 1.39847 | 0.61857 | 1.32546 | 1.74966 | 0.83327 | 0.85345 |
| e | 0.87737 | 0.70974 | 0.87862 | 0.72232 | 0.62763 | 0.75113 | 0.74566 |

TABLE 65
The MO to HO intercept geometrical bond parameters of organic and related ions. E_{T} is E_{T}(atom-atom,msp³.AO).

| | | | | | | Final Total | | |
|---|---|---|---|---|---|---|---|---|
| | | E_{T} | E_{T} | E_{T} | E_{T} | Energy | | |
| | | (eV) | (eV) | (eV) | (eV) | C2sp³ | rᵢₙᵢₜᵢₐₗ | r_{final} |
| Bond | Atom | Bond 1 | Bond 2 | Bond 3 | Bond 4 | (eV) | (a₀) | (a₀) |
| RH₂C_{b}Cₐ(O)—O⁻ | O | −1.01210 | 0 | 0 | 0 | | 1.00000 | 0.85907 |
| RH₂C_{b}Cₐ(O)—O⁻ | Cₐ | −1.01210 | −0.92918 | −0.92918 | 0 | −154.48615 | 0.91771 | 0.76885 |
| (RO)₂(O)S—O⁻ | S | 0 | −0.46459 | −0.46459 | 0 | | 1.32010 | 0.86359 |
| (RO)₂(O)S—O⁻ | O | 0 | 0 | 0 | 0 | | 1.00000 | 0.91771 |
| O₂N—O⁻ | O | −0.69689 | 0 | 0 | 0 | | 1.00000 | 0.87651 |
| O₂N—O⁻ | N | −0.92918 | −0.92918 | −0.69689 | 0 | | 0.93084 | 0.78280 |
| (RO)₂(O)P—O⁻ | P | −0.72457 | −0.72457 | −1.13379 | −0.85034 | | 1.15350 | 0.74515 |
| (RO)₂(O)P—O⁻ | O | −0.85034 | 0 | 0 | 0 | | 1.00000 | 0.86793 |
| (RO)₃Si—O⁻ | Si | −1.55205 | −0.62217 | −0.62217 | −0.62217 | | 1.31926 | 0.99082 |
| (RO)₃Si—O⁻ | O | −1.55205 | 0 | 0 | 0 | | 1.00000 | 0.89688 |
| —H₂CₐNH(R_{alkyl})—H⁺ | N | −0.56690 | −0.56690 | 0 | 0 | | 0.93084 | 0.85252 |
| —H₂CₐN(H₂)—H⁺ | N | −0.72457 | 0 | 0 | 0 | | 0.93084 | 0.87495 |

| | E_{Coulomb} (C2sp³) | E(C2sp³) | | | | | |
|---|---|---|---|---|---|---|---|
| | (eV) | (eV) | θ′ | θ₁ | θ₂ | d₁ | d₂ |
| Bond | Final | Final | (°) | (°) | (°) | (a₀) | (a₀) |
| RH₂C_{b}Cₐ(O)—O⁻ | −15.83785 | | 137.99 | 42.01 | 67.29 | 0.50150 | 0.63827 |
| RH₂C_{b}Cₐ(O)—O⁻ | −17.69621 | −17.50535 | 134.14 | 45.86 | 62.28 | 0.60433 | 0.53544 |
| (RO)₂(O)S—O⁻ | −15.75493 | | 78.56 | 101.44 | 37.25 | 1.58026 | 0.17130 |
| (RO)₂(O)S—O⁻ | −14.82575 | | 84.06 | 95.94 | 40.75 | 1.50400 | 0.09504 |
| O₂N—O⁻ | −15.52264 | | 135.13 | 44.87 | 63.23 | 0.58339 | 0.55475 |
| O₂N—O⁻ | −17.38100 | | 138.99 | 41.01 | 68.41 | 0.47673 | 0.66142 |
| (RO)₂(O)P—O⁻ | −18.25903 | | 71.42 | 108.58 | 32.20 | 1.62182 | 0.23739 |
| (RO)₂(O)P—O⁻ | −15.67609 | | 85.55 | 94.45 | 40.76 | 1.45184 | 0.06742 |
| (RO)₃Si—O⁻ | −13.73181 | | 53.34 | 126.66 | 27.02 | 2.00216 | 0.59160 |
| (RO)₃Si—O⁻ | −15.17010 | | 34.26 | 145.74 | 16.77 | 2.15183 | 0.74128 |
| —H₂CₐNH(R_{alkyl})—H⁺ | −15.95954 | | 118.18 | 61.82 | 64.40 | 0.54546 | 0.40264 |
| —H₂CₐN(H₂)—H⁺ | −15.55033 | | 118.00 | 62.00 | 64.85 | 0.54432 | 0.41075 |

TABLE 66
The energy parameters (eV) of functional groups of organic and related ions.

| | C—O⁻ | S—O⁻ | N—O⁻ | P—O⁻ | Si—O⁻ | NH₂⁺ | NH₃⁺ |
|---|---|---|---|---|---|---|---|
| Parameters | Group | Group | Group | Group | Group | Group | Group |
| f₁ | 0.75 | 0.75 | 0.75 | 0.75 | 0.75 | 2 | 3/2 |
| n₁ | 2 | 2 | 2 | 2 | 2 | 1 | 2 |
| n₂ | 0 | 0 | 0 | 0 | 0 | 0 | 0 |
| n₃ | 0 | 0 | 0 | 0 | 0 | 0 | 1 |
| C₁ | 0.5 | 0.5 | 0.5 | 0.5 | 0.75 | 0.75 | 0.75 |
| C₂ | 1 | 1 | 1 | 1 | 0.75304 | 0.93613 | 0.93613 |
| c₁ | 1 | 1 | 1 | 1 | 1 | 0.75 | 0.75 |
| c₂ | 0.85395 | 1.20632 | 0.85987 | 0.78899 | 1 | 0.93383 | 0.94627 |
| c₃ | 2 | 0 | 0 | 0 | 0 | 1 | 0 |
| c₄ | 4 | 4 | 4 | 4 | 2 | 1 | 1 |
| c₅ | 0 | 1 | 0 | 0 | 2 | 1 | 2 |
| C₁ₒ | 0.5 | 0.5 | 0.5 | 0.5 | 0.75 | 0.75 | 1.5 |
| C₂ₒ | 1 | 1 | 1 | 1 | 0.75304 | 1 | 1 |
| Vₑ (eV) | −111.25473 | −82.63003 | −112.63415 | −56.96374 | −56.90923 | −39.21967 | −77.89897 |
| Vₚ (eV) | 23.87467 | 19.31325 | 23.90868 | 9.82777 | 19.29141 | 14.35050 | 28.49191 |
| T (eV) | 42.82081 | 20.81183 | 43.47534 | 14.86039 | 12.66092 | 15.53581 | 30.40957 |
| Vₘ (eV) | −21.41040 | −10.40592 | −21.73767 | −7.43020 | −6.33046 | −7.76790 | −15.20478 |
| E(AO/HO) (eV) | 0 | −11.52126 | 0 | −11.78246 | −20.50975 | −14.53414 | −14.53414 |
| ΔE_{H}_{₂}_{MO}(AO/HO) (eV) | −2.69893 | −1.16125 | −3.71673 | 0 | 0 | 0 | 0 |
| E(n₃ AO/HO) (eV) | 0 | 0 | 0 | 0 | 0 | 0 | −14.53414 |
| E_{T}(AO/HO) (eV) | 2.69893 | −10.36001 | 3.71673 | −11.78246 | −20.50975 | −14.53414 | −14.53414 |
| E_{T}(H₂MO) (eV) | −63.27074 | −63.27088 | −63.27107 | −63.27069 | −51.79710 | −31.63541 | −48.73642 |
| E_{T}(atom-atom,msp³.AO) (eV) | −2.69893 | 0 | −3.71673 | −2.26758 | −4.13881 | 0 | 0 |
| E_{T}(MO) (eV) | −65.96966 | −63.27074 | −66.98746 | −65.53832 | −55.93591 | −31.63537 | 48.73660 |
| ω(10¹⁵ rad/s) | 59.4034 | 17.6762 | 19.8278 | 11.0170 | 9.22130 | 47.0696 | 64.2189 |
| E_{K} (eV) | 39.10034 | 11.63476 | 13.05099 | 7.25157 | 6.06962 | 30.98202 | 42.27003 |
| Ē_{D} (eV) | −0.40804 | −0.21348 | −0.23938 | −0.17458 | −0.13632 | −0.34836 | −0.40690 |
| Ē_{Kvib} (eV) | 0.21077 [12] | 0.12832 [43] | 0.19342 [45] | 0.12337 [74] | 0.15393 [24] | 0.40696 [24] | 0.40929 [22] |
| Ē_{osc} (eV) | −0.30266 | −0.14932 | −0.14267 | −0.11289 | −0.05935 | −0.14488 | −0.20226 |
| E_{mag} (eV) | 0.11441 | 0.11441 | 0.11441 | 0.14803 | 0.04983 | 0.14803 | 0.14803 |
| E_{T}(Group) (eV) | −49.93123 | −47.67703 | −50.45460 | −49.32308 | −42.04096 | −63.56050 | −73.71167 |
| Eᵢₙᵢₜᵢₐₗ(c₄ AO/HO) (eV) | −14.63489 | −14.63489 | −14.63489 | −14.63489 | −10.25487 | −14.53414 | −14.53414 |
| Eᵢₙᵢₜᵢₐₗ(c₅ AO/HO) (eV) | 0 | −1.16125 | 0 | 0 | −13.61805 | −13.59844 | −13.59844 |
| E_{D}(Group) (eV) | 6.02656 | 2.90142 | 6.54994 | 5.41841 | 6.23157 | 7.01164 | 11.11514 |

Monosaccharides of DNA and RNA

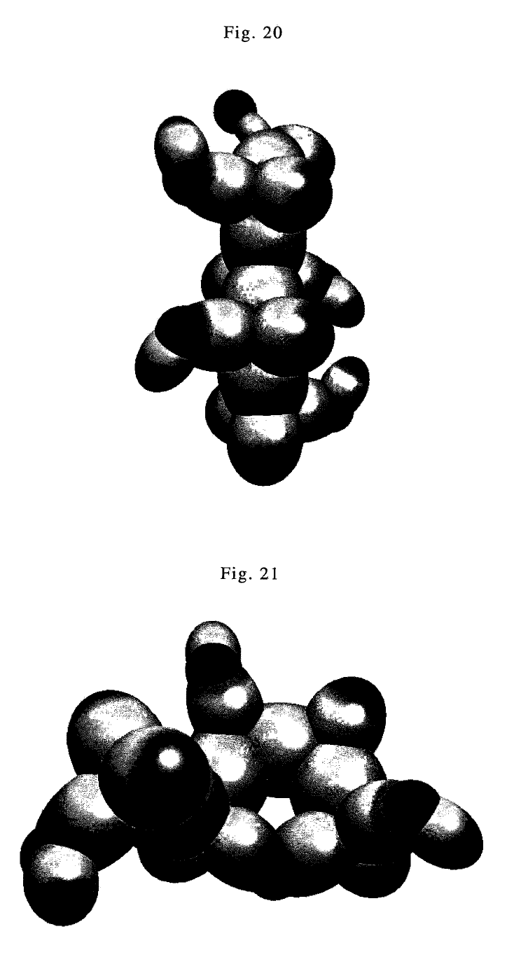

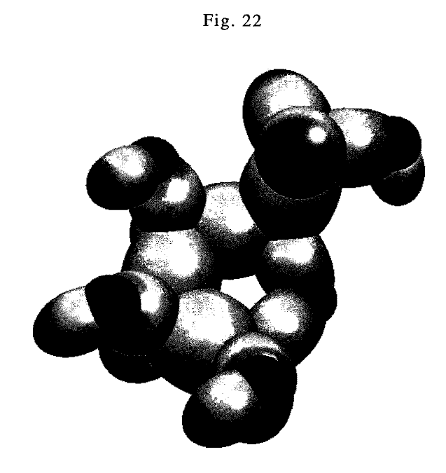

The simple sugar moiety of DNA and RNA comprises the alpha forms of 2-deoxy-D-ribose and D-ribose, respectively. The sugars comprise the alkyl CH₂, CH, and C—C functional groups and the alkyl alcohol C—O and OH functional groups given in the Alcohols section. In addition, the alpha form of the sugars comprise the C—O ether functional group given in the Ethers section, and the open-chain forms further comprise the carbon to carbonyl C—C, the methylyne carbon of the aldehyde carbonyl CH, and the aldehyde carbonyl C═O functional groups given in the Aldehydes section. The total energy of each sugar given in Tables 67-70 was calculated as the sum over the integer multiple of each E_{D}(Group) corresponding to the functional-group composition wherein the group identity and energy E_{D}(Group) are given in each table. The color scale, charge-density of the monosaccharides, 2-deoxy-D-ribose, D-ribose, Alpha-2-deoxy-D-ribose and alpha-D-ribose, each comprising atoms with the outer shell bridged by one or more H₂-type ellipsoidal MOs or joined with one or more hydrogen MOs are shown in FIGS. 19-22.

TABLE 67
The total gaseous bond energy of 2-deoxy-D-ribose (C₅H₁₀O₄) calculated
using the functional group composition and the energies given supra.

| | | CH | | | C—C(O) | C═O |
|---|---|---|---|---|---|---|
| | CH₂ | (alkyl) | CH(HC═O) | C—C(n-C) | (aldehyde) | (aldehyde) |
| Formula | Group | Group | Group | Group | Group | Group |
| Energies E_{D}(Group) | 7.83016 | 3.32601 | 3.47404 | 4.32754 | 4.41461 | 7.80660 |
| of Functional Groups | | | | | | |
| (eV) | | | | | | |
| Composition | 2 | 2 | 1 | 3 | 1 | 1 |

| | | | Calculated | Experimental | |
|---|---|---|---|---|---|
| | C—O(C—OH) | OH | Total Bond | Total Bond | Relative |
| Formula | Group | Group | Energy (eV) | Energy (eV) | Error |
| Energies E_{D}(Group) | 4.34572 | 4.41035 | | | |
| of Functional Groups | | | | | |
| (eV) | | | | | |
| Composition | 3 | 3 | 77.25842 | | |

TABLE 68
The total gaseous bond energy of D-ribose (C₅H₁₀O₅) calculated using the
functional group composition and the energies given supra. compared to the
experimental values [3].

| | | CH | | | C—C(O) | C═O |
|---|---|---|---|---|---|---|
| | CH₂ | (alkyl) | CH(HC═O) | C—C(n-C) | (aldehyde) | (aldehyde) |
| Formula | Group | Group | Group | Group | Group | Group |
| Energies E_{D}(Group) | 7.83016 | 3.32601 | 3.47404 | 4.32754 | 4.41461 | 7.80660 |
| of Functional Groups | | | | | | |
| (eV) | | | | | | |
| Composition | 1 | 3 | 1 | 3 | 1 | 1 |

| | | | Calculated | Experimental | |
|---|---|---|---|---|---|
| | C—O(C—OH) | OH | Total Bond | Total Bond | Relative |
| Formula | Group | Group | Energy (eV) | Energy (eV) | Error |
| Energies E_{D}(Group) | 4.34572 | 4.41035 | | | |
| of Functional Groups | | | | | |
| (eV) | | | | | |
| Composition | 4 | 4 | 81.51034 | 83.498^{a} | 0.02381 |

^{a}Crystal.

TABLE 69
The total gaseous bond energy of alpha-2-deoxy-D-ribose (C₅H₁₀O₄) calculated
using the functional group composition and the energies given supra.

| | | | | | | | Calculated | | |
|---|---|---|---|---|---|---|---|---|---|
| | | | | C—O | | | Total | | |
| | | CH | | (alkyl | | | Bond | Experimental | |
| | CH₂ | (alkyl) | C—C(n-C) | ether) | C—O(C—OH) | OH | Energy | Total Bond | Relative |
| Formula | Group | Group | Group | Group | Group | Group | (eV) | Energy (eV) | Error |
| Energies | 7.83016 | 3.32601 | 4.32754 | 4.12506 | 4.34572 | 4.41035 | | | |
| E_{D}(Group) | | | | | | | | | |
| of Functional | | | | | | | | | |
| Groups (eV) | | | | | | | | | |
| Composition | 2 | 3 | 4 | 2 | 3 | 3 | 77.46684 | | |

TABLE 70
The total gaseous bond energy of alpha-D-ribose (C₅H₁₀O₅) calculated
using the functional group composition and the energies given supra.

| | | | | | | | Calculated | | |
|---|---|---|---|---|---|---|---|---|---|
| | | | | C—O | | | Total | | |
| | | CH | | (alkyl | | | Bond | Experimental | |
| | CH₂ | (alkyl) | C—C(n-C) | ether) | C—O(C—OH) | OH | Energy | Total Bond | Relative |
| Formula | Group | Group | Group | Group | Group | Group | (eV) | Energy (eV) | Error |
| Energies | 7.83016 | 3.32601 | 4.32754 | 4.12506 | 4.34572 | 4.41035 | | | |
| E_{D}(Group) | | | | | | | | | |
| of Functional | | | | | | | | | |
| Groups (eV) | | | | | | | | | |
| Composition | 1 | 4 | 4 | 2 | 4 | 4 | 82.31088 | | |

Nucleotide Bonds of DNA and RNA

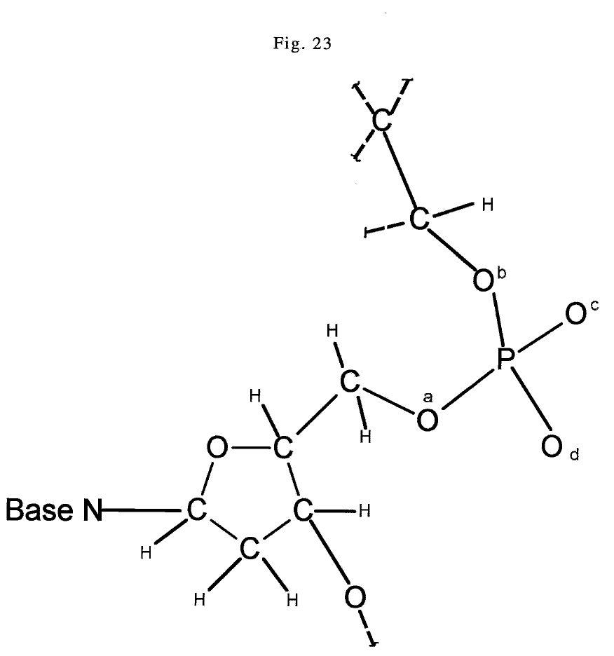

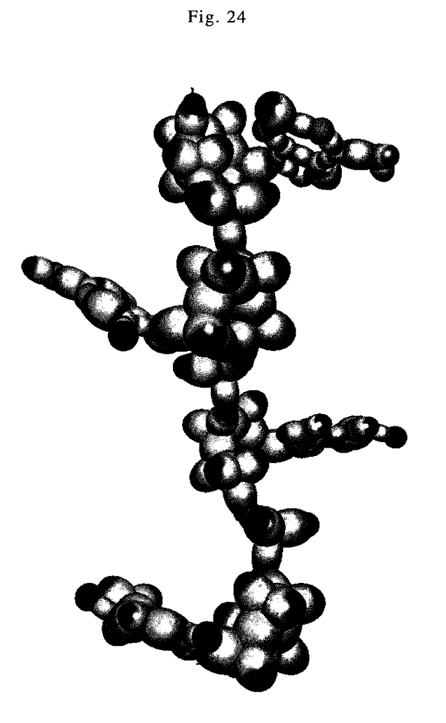

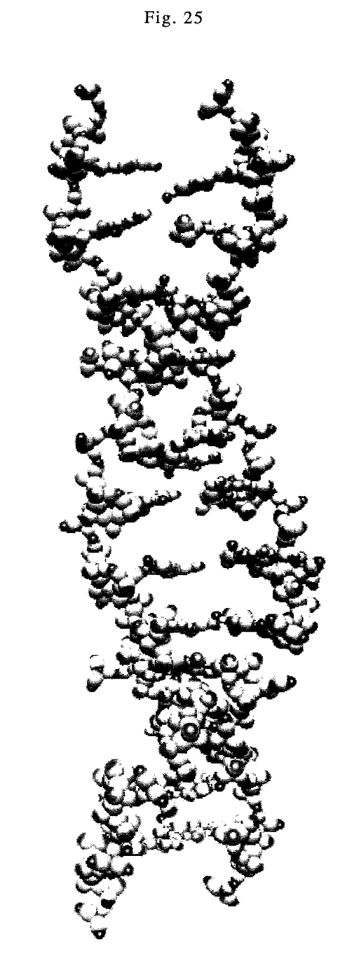

DNA and RNA comprise a backbone of alpha-2-deoxy-D-ribose and alpha-D-ribose, respectively, with a charged phosphate moiety at the 3′ and 5′ positions of two consecutive ribose units in the chain and a base bound at the 1′ position wherein the ribose H of each of the corresponding 3′ or 5′ O—H and 1′ C—H bonds is replaced by P and the base N, respectively. For the base, the H of the N—H at the pyrimidine 1 position or the purine 9 position is replaced by the sugar C. The basic repeating unit of DNA or RNA is a nucleotide that comprises a monosaccharide, a phosphate moiety and a base. The structure of the nucleotide bond is shown in FIG. 23 with the designation of the corresponding atoms. The phosphate moiety comprises the P═O, P═O, and C—O functional groups given in the Phosphates section as well as the P—O⁻ group given in the Organic and Related Ions section. The nucleoside bond (sugar C to base N) comprises the tertiary amine C—N functional group given in the corresponding section. The bases, adenine, guanine, thymine, and cytosine are equivalent to those given in the corresponding sections. The symbols of the functional groups of the nucleotide bond are given in Table 71. The geometrical (Eqs. (15.1-15.5) and (15.51)), intercept (Eqs. (15.80-15.87)), and energy (Eqs. (15.6-15.11) and (15.17-15.65)) parameters are given in Tables 72, 73, and 74, respectively. The functional group composition and the corresponding energy E_{D}(Group) of each group of the nucleotide bond of DNA and RNA are given in Table 75. The bond angle parameters of the nucleoside bond determined using Eqs. (15.88-15.117) are given in Table 15.388. The color scale rendering of the charge-density of the exemplary tetra-nucleotide, (deoxy)adenosine 3′-monophosphate-5′-(deoxy)thymidine 3′-monophosphate-5′-(deoxy)guanosine 3′-monophosphate-5′-(deoxy)cytidine monophosphate (ATGC) comprising atoms with the outer shell bridged by one or more H₂-type ellipsoidal MOs or joined with one or more hydrogen MOs is shown in FIG. 24. FIG. 25 shows the color scale rendering of the charge-density of the exemplary DNA fragment

ACTGACTGACTG
TGACTGACTGAC

wherein each complementary strand comprises a dodeca-nucleotide of the form (base (1)—deoxyribose) monophosphate—(base(2)—deoxyribose) monophosphate—with the phosphates bridging the 3′ and 5′ ribose carbons with the opposite order for the complementary stands.

TABLE 71
The symbols of functional groups of the nucleotide bond.

| Functional Group | Group Symbol |
|---|---|
| C—N | C—N |
| C—O (alkyl) | C—O |
| P═O | P═O |
| P—O | P—O |
| (RO)₂(O)P—O⁻ (alkyl phosphate) | P—O⁻ |

TABLE 72
The geometrical bond parameters of the nucleotide bond and experimental values [1].

| | C—N | C—O | P═O | P—O | P—O⁻ |
|---|---|---|---|---|---|
| Parameter | Group | Group | Group | Group | Group |
| a (a₀) | 1.96313 | 1.79473 | 1.91663 | 1.84714 | 1.91663 |
| c′ (a₀) | 1.40112 | 1.33968 | 1.38442 | 1.52523 | 1.38442 |
| Bond Length | 1.48288 | 1.41785 | 1.46521E−10 | 1.61423 | 1.46521 |
| 2c′ (Å) | | | | | |
| Exp. Bond Length | 1.458 | 1.418 | 1.48 [64] | 1.631 [69] | 1.48 [64] |
| (Å) | (trimethylamine) | (ethyl methyl | (DNA) | (MHP) | (DNA) |
| | | ether (avg.)) | 1.4759 | 1.60 [64] | |
| | | | (PO) | (DNA) | |
| b, c (a₀) | 1.37505 | 1.19429 | 1.32546 | 1.04192 | 1.32546 |
| e | 0.71372 | 0.74645 | 0.72232 | 0.82573 | 0.72232 |

TABLE 73
The MO to HO intercept geometrical bond parameters of the nucleotide bond. E_{T} is E_{T}(atom-atom, msp³.AO).

| | | | | | | Final Total | | |
|---|---|---|---|---|---|---|---|---|
| | | E_{T} | E_{T} | E_{T} | E_{T} | Energy | | |
| | | (eV) | (eV) | (eV) | (eV) | C2sp³ | rᵢₙᵢₜᵢₐₗ | r_{final} |
| Bond | Atom | Bond 1 | Bond 2 | Bond 3 | Bond 4 | (eV) | (a₀) | (a₀) |
| Cₑ(H)N_{d}—C_{c}(N_{c})C_{d}Nₑ(H)Cₑ—N_{d}(H)C_{c} | N_{d} | −0.60631 | −0.60631 | −0.46459 | 0 | | 0.93084 | 0.82445 |
| (adenine nucleoside) | | | | | | | | |
| Cₑ(H)N_{d}—C_{c}(N_{c})C_{d}Nₑ(H)Cₑ—N_{d}(H)C_{c} | N_{d} | −0.92918 | −0.92918 | −0.46459 | 0 | | 0.93084 | 0.79340 |
| (guanine nucleoside) | | | | | | | | |
| N_{b}(O)C_{b}—N_{c}HC_{c}C_{b}HN_{c}—HC_{c}C_{d} | N_{c} | −0.92918 | −0.92918 | −0.46459 | 0 | | −0.93084 | −0.79340 |
| (thymine nucleoside) | | | | | | | | |
| N_{b}(O)C_{b}—N_{c}HC_{c}C_{b}HN_{c}—HC_{c}C_{d} | N_{c} | −0.92918 | −0.92918 | −0.46459 | 0 | | −0.93084 | −0.79340 |
| (cytosine nucleoside) | | | | | | | | |
| N_{d}—C ribose | N_{d} | −0.46459 | −0.60631 | −0.60631 | 0 | | 0.93084 | 0.82445 |
| (adenine nucleoside) | | | | | | | | |
| N_{d}—C ribose | C ribose | −0.46459 | −0.92918 | −0.82688 | 0 | −153.83634 | −0.91771 | −0.79816 |
| (adenine nucleoside) | | | | | | | | |
| N_{d}—C ribose | N_{d} | −0.46459 | −0.92918 | −0.92918 | 0 | | 0.93084 | 0.79340 |
| (guanine nucleoside) | | | | | | | | |
| N_{d}—C ribose | C ribose | −0.46459 | −0.92918 | −0.82688 | 0 | −153.83634 | −0.91771 | −0.79816 |
| (guanine nucleoside) | | | | | | | | |
| N_{c}—C ribose | N_{c} | −0.46459 | −0.92918 | −0.92918 | 0 | | 0.93084 | 0.79340 |
| (thymine nucleoside) | | | | | | | | |
| N_{c}—C ribose | C ribose | −0.46459 | −0.92918 | −0.82688 | 0 | −153.83634 | −0.91771 | −0.79816 |
| (thymine nucleoside) | | | | | | | | |
| N_{c}—C ribose | N_{c} | −0.46459 | −0.92918 | −0.92918 | 0 | | 0.93084 | 0.79340 |
| (cytosine nucleoside) | | | | | | | | |
| N_{c}—C ribose | C ribose | −0.46459 | −0.92918 | −0.82688 | 0 | −153.83634 | −0.91771 | −0.79816 |
| (cytosine nucleoside) | | | | | | | | |

| | E_{Coulomb}(C2sp³) | E(C2sp³) | | | | | |
|---|---|---|---|---|---|---|---|
| | (eV) | (eV) | θ′ | θ₁ | θ₂ | d₁ | d₂ |
| Bond | Final | Final | (°) | (°) | (°) | (a₀) | (a₀) |
| Cₑ(H)N_{d}—C_{c}(N_{c})C_{d}Nₑ(H)Cₑ—N_{d}(H)C_{c} | −16.50297 | | 138.15 | 41.85 | 61.57 | 0.68733 | 0.61411 |
| (adenine nucleoside) | | | | | | | |
| Cₑ(H)N_{d}—C_{c}(N_{c})C_{d}Nₑ(H)Cₑ—N_{d}(H)C_{c} | −17.14871 | | 138.07 | 41.93 | 60.47 | 0.70588 | 0.59026 |
| (guanine nucleoside) | | | | | | | |
| N_{b}(O)C_{b}—N_{c}HC_{c}C_{b}HN_{c}—HC_{c}C_{d} | −17.14871 | | 138.07 | 41.93 | 60.47 | 0.70588 | 0.59026 |
| (thymine nucleoside) | | | | | | | |
| N_{b}(O)C_{b}—N_{c}HC_{c}C_{b}HN_{c}—HC_{c}C_{d} | −17.14871 | | 138.07 | 41.93 | 60.47 | 0.70588 | 0.59026 |
| (cytosine nucleoside) | | | | | | | |
| N_{d}—C ribose | −16.50297 | | 76.37 | 103.63 | 35.64 | 1.59544 | 0.19432 |
| (adenine nucleoside) | | | | | | | |
| N_{d}—C ribose | −17.04640 | −16.85554 | 73.17 | 106.83 | 33.75 | 1.63226 | 0.23114 |
| (adenine nucleoside) | | | | | | | |
| N_{d}—C ribose | −17.14871 | | 72.56 | 107.44 | 33.40 | 1.63893 | 0.23782 |
| (guanine nucleoside) | | | | | | | |
| N_{d}—C ribose | −17.04640 | −16.85554 | 73.17 | 106.83 | 33.75 | 1.63226 | 0.23114 |
| (guanine nucleoside) | | | | | | | |
| N_{c}—C ribose | −17.14871 | | 72.56 | 107.44 | 33.40 | 1.63893 | 0.23782 |
| (thymine nucleoside) | | | | | | | |
| N_{c}—C ribose | −17.04640 | −16.85554 | 73.17 | 106.83 | 33.75 | 1.63226 | 0.23114 |
| (thymine nucleoside) | | | | | | | |
| N_{c}—C ribose | −17.14871 | | 72.56 | 107.44 | 33.40 | 1.63893 | 0.23782 |
| (cytosine nucleoside) | | | | | | | |
| N_{c}—C ribose | −17.04640 | −16.85554 | 73.17 | 106.83 | 33.75 | 1.63226 | 0.23114 |
| (cytosine nucleoside) | | | | | | | |

TABLE 74
The energy parameters (eV) of functional groups of the nucleotide bond.

| | C—N | C—O | P═O | P—O | P—O⁻ |
|---|---|---|---|---|---|
| Parameters | Group | Group | Group | Group | Group |
| n₁ | 1 | 1 | 2 | 1 | 2 |
| n₂ | 0 | 0 | 0 | 0 | 0 |
| n₃ | 0 | 0 | 0 | 0 | 0 |
| C₁ | 0.5 | 0.5 | 0.5 | 0.5 | 0.5 |
| C₂ | 1 | 1 | 1 | 1 | 1 |
| c₁ | 1 | 1 | 1 | 1 | 1 |
| c₂ | 0.91140 | 0.85395 | 0.79401 | 0.79401 | 0.78899 |
| c₃ | 0 | 0 | 0 | 0 | 0 |
| c₄ | 2 | 2 | 4 | 2 | 4 |
| c₅ | 0 | 0 | 0 | 0 | 0 |
| C₁ₒ | 0.5 | 0.5 | 0.5 | 0.5 | 0.5 |
| C₂ₒ | 1 | 1 | 1 | 0.79401 | 1 |
| Vₑ (eV) | −31.67393 | −33.47304 | −56.96374 | −33.27738 | −56.96374 |
| Vₚ (eV) | 9.71067 | 10.15605 | 9.82777 | 8.92049 | 9.82777 |
| T (eV) | 8.06719 | 9.32537 | 14.86039 | 9.00781 | 14.86039 |
| Vₘ (eV) | −4.03359 | −4.66268 | −7.43020 | −4.50391 | −7.43020 |
| E(AO/HO) (eV) | −14.63489 | −14.63489 | −23.56492 | −11.78246 | −11.78246 |
| ΔE_{H}_{₂}^{MO}(AO/HO) (eV) | −0.92918 | −1.65376 | 0 | 0 | 0 |
| E_{T}(AO/HO) (eV) | −13.70571 | −12.98113 | −23.56492 | −11.78246 | −11.78246 |
| E_{T}(H₂MO) (eV) | −31.63537 | −31.63544 | −63.27069 | −31.63544 | −63.27069 |
| E_{T}(atom-atom,msp³.AO) (eV) | −0.92918 | −1.65376 | −2.26758 | −1.44914 | −2.26758 |
| E_{T}(MO) (eV) | −32.56455 | −33.28912 | −65.53832 | −33.08451 | −65.53832 |
| ω(10¹⁵ rad/s) | 18.1298 | 12.1583 | 11.0170 | 10.3761 | 11.0170 |
| E_{K} (eV) | 11.93333 | 8.00277 | 7.25157 | 6.82973 | 7.25157 |
| Ē_{D} (eV) | −0.22255 | −0.18631 | −0.17458 | −0.17105 | −0.17458 |
| Ē_{Kvib} (eV) | 0.12944 [23] | 0.16118 [4] | 0.15292 [24] | 0.10477 [70] | 0.12337 [74] |
| Ē_{osc} (eV) | −0.15783 | −0.10572 | −0.09812 | −0.11867 | −0.11289 |
| E_{mag} (eV) | 0.14803 | 0.14803 | 0.14803 | 0.14803 | 0.14803 |
| E_{T}(Group) (eV) | −32.72238 | −33.39484 | −65.73455 | −33.20318 | −49.32308 |
| Eᵢₙᵢₜᵢₐₗ(c₄ AO/HO) (eV) | −14.63489 | −14.63489 | −14.63489 | −14.63489 | −14.63489 |
| Eᵢₙᵢₜᵢₐₗ(c₅ AO/HO) (eV) | 0 | 0 | 0 | 0 | 0 |
| E_{D}(Group) (eV) | 3.45260 | 4.12506 | 7.19500 | 3.93340 | 5.41841 |

TABLE 75
The functional group composition and the energy E_{D}(Group) of each group of the nucleotide bond.

| | C—N | C—O | P═O | P—O | P—O⁻ |
|---|---|---|---|---|---|
| | (3° amine) | (alkyl ether) | (phosphate) | (phosphate) | (organic ions) |
| Formula | Group | Group | Group | Group | Group |
| Energies E_{D}(Group) | 3.45260 | 4.12506 | 7.19500 | 3.93340 | 5.41841 |
| of Functional Groups (eV) | | | | | |
| Composition | 1 | 2 | 1 | 2 | 1 |

TABLE 76
The bond angle parameters of the nucleotide bond and experimental values [1]. In the calculation of θᵥ, the parameters
from the preceding angle were used. E_{T} is E_{T} (atom-atom, msp³.AO).

| | | | 2c′ | | Atom 1 | | Atom 2 | | |
|---|---|---|---|---|---|---|---|---|---|
| | 2c′ | 2c′ | Terminal | | Hybridization | | Hybridization | | |
| Atoms of | Bond 1 | Bond 2 | Atoms | E_{Coulombic} | Designation | E_{Coulombic} | Designation | c₂ | c₂ |
| Angle | (a₀) | (a₀) | (a₀) | Atom 1 | (Table 7) | Atom 2 | (Table 7) | Atom 1 | Atom 2 |
| ∠(P)OCN | 2.67935 | 2.80224 | 4.5277 | −16.47951 | 22 | −16.47951 | 22 | 0.82562 | 0.82562 |
| ∠POC | 3.05046 | 2.67935 | 4.9904 | −11.78246 | Psp³ | −15.75493 | 7 | 0.73885 | 0.86359 |
| | | | | | | | | Eq. | |
| | | | | | | | | (15.181) | |
| ∠OₐPO_{b} | 3.05046 | 3.05046 | 4.7539 | −15.95954 | 10 | −15.95954 | 10 | 0.85252 | 0.85252 |
| ∠O_{b}PO_{c} | 3.05046 | 2.76885 | 4.7539 | −15.95954 | 10 | −15.95954 | 10 | 0.85252 | 0.85252 |
| ∠O_{c}PO_{d} | 2.76885 | 2.76885 | 4.7539 | −15.95954 | 10 | −15.95954 | 10 | 0.85252 | 0.85252 |
| ∠CₐOC_{b}(Cₐ—O (i))(C_{b}—O (ii)) | 2.68862 | 2.67935 | 4.4385 | −17.51099 | 48 | −17.51099 | 48 | 0.77699 | 0.77699 |
| ∠C_{b}CₐO(Cₐ—O (ii)) | 2.91547 | 2.67935 | 4.5607 | −16.68412 | 26 | −13.61806 | O | 0.81549 | 0.85395 |
| | | | | | | | | | (Eq. |
| | | | | | | | | | (15.133)) |
| ∠CₐOH(Cₐ—O (ii)) | 2.67024 | 1.83616 | 3.6515 | −14.82575 | 1 | −14.82575 | 1 | 1 | 0.91771 |
| ∠C_{b}CₐO(Cₐ—O (ii)) | 2.91547 | 2.67024 | 4.5826 | −16.68412 | 26 | −13.61806 | O | 0.81549 | 0.85395 |
| | | | | | | | | | (Eq. |
| | | | | | | | | | (15.114)) |
| ∠CNC | 2.80224 | 2.80224 | 4.6043 | −17.14871 | 36 | −17.14871 | 36 | 0.79340 | 0.79340 |
| (3° amine) | | | | | | | | | |
| Methylene | 2.11106 | 2.11106 | 3.4252 | −15.75493 | 7 | H | H | 0.86359 | 1 |
| ∠HCₐH | | | | | | | | | |
| ∠CₐC_{b}C_{c} | | | | | | | | | |
| ∠CₐC_{b}H | | | | | | | | | |
| Methyl | 2.09711 | 2.09711 | 3.4252 | −15.75493 | 7 | H | H | 0.86359 | 1 |
| ∠HCₐH | | | | | | | | | |
| ∠CₐC_{b}C_{c} | | | | | | | | | |
| ∠CₐC_{b}H | | | | | | | | | |
| ∠C_{b}CₐC_{c} | 2.91547 | 2.91547 | 4.7958 | −16.68412 | 26 | −16.68412 | 26 | 0.81549 | 0.81549 |
| iso Cₐ | | | | C_{b} | | C_{c} | | | |
| ∠C_{b}CₐH | 2.91547 | 2.11323 | 4.1633 | −15.55033 | 5 | −14.82575 | 1 | 0.87495 | 0.91771 |
| iso Cₐ | | | | Cₐ | | C_{b} | | | |
| ∠CₐC_{b}H | 2.91547 | 2.09711 | 4.1633 | −15.55033 | 5 | −14.82575 | 1 | 0.87495 | 0.91771 |
| iso Cₐ | | | | C_{b} | | Cₐ | | | |

| Atoms of | | | | | E_{T} | θᵥ | θ₁ | θ₂ | Cal. θ | Exp. θ |
|---|---|---|---|---|---|---|---|---|---|---|
| Angle | C₁ | C₂ | c₁ | c₂′ | (eV) | (°) | (°) | (°) | (°) | (°) |
| ∠(P)OCN | 1 | 1 | 1 | 0.82562 | −1.65376 | | | | 111.36 | 111.3 [64] |
| ∠POC | 1 | 0.73885 | 1 | 0.80122 | −0.72457 | | | | 121.00 | 121.3 [64] |
| ∠OₐPO_{b} | 1 | 1 | 1 | 0.85252 | −1.65376 | | | | 102.38 | 101.4 [64] |
| ∠O_{b}PO_{c} | 1 | 1 | 1 | 0.85395 | −1.65376 | | | | 109.46 | 109.7 [64] |
| ∠O_{c}PO_{d} | 1 | 1 | 1 | 0.85252 | −1.65376 | | | | 118.29 | 116.0 [64] |
| ∠CₐOC_{b}(Cₐ—O (i))(C_{b}—O (ii)) | 1 | 1 | 1 | 0.77699 | −1.85836 | | | | 111.55 | 111.9 |
| | | | | | | | | | | (ethyl methyl ether) |
| ∠C_{b}CₐO(Cₐ—O (ii)) | 1 | 1 | 1 | 0.83472 | −1.65376 | | | | 109.13 | 109.4 |
| | | | | | | | | | | (ethyl methyl ether) |
| ∠CₐOH(Cₐ—O (ii)) | 0.75 | 1 | 0.75 | 0.91771 | 0 | | | | 106.78 | 105 |
| | | | | | | | | | | (ethanol) |
| ∠C_{b}CₐO(Cₐ—O (ii)) | 1 | 1 | 1 | 0.83472 | −1.65376 | | | | 110.17 | 107.8 |
| | | | | | | | | | | (ethanol) |
| ∠CNC | 1 | 1 | 1 | 0.79340 | −1.85836 | | | | 110.48 | 110.9 |
| (3° amine) | | | | | | | | | | (trimethyl amine) |
| Methylene | 1 | 1 | 0.75 | 1.15796 | 0 | | | | 108.44 | 107 |
| ∠HCₐH | | | | | | | | | | (propane) |
| ∠CₐC_{b}C_{c} | | | | | | 69.51 | | | 110.49 | 112 |
| | | | | | | | | | | (propane) |
| | | | | | | | | | | 113.8 |
| | | | | | | | | | | (butane) |
| | | | | | | | | | | 110.8 |
| | | | | | | | | | | (isobutane) |
| ∠CₐC_{b}H | | | | | | 69.51 | | | 110.49 | 111.0 |
| | | | | | | | | | | (butane) |
| | | | | | | | | | | 111.4 |
| | | | | | | | | | | (isobutane) |
| Methyl | 1 | 1 | 0.75 | 1.15796 | 0 | | | | 109.50 | |
| ∠HCₐH | | | | | | | | | | |
| ∠CₐC_{b}C_{c} | | | | | | 70.56 | | | 109.44 | |
| ∠CₐC_{b}H | | | | | | 70.56 | | | 109.44 | |
| ∠C_{b}CₐC_{c} | 1 | 1 | 1 | 0.81549 | −1.85836 | | | | 110.67 | 110.8 |
| iso Cₐ | | | | | | | | | | (isobutane) |
| ∠C_{b}CₐH | 0.75 | 1 | 0.75 | 1.04887 | 0 | | | | 110.76 | |
| iso Cₐ | | | | | | | | | | |
| ∠CₐC_{b}H | 0.75 | 1 | 0.75 | 1.04887 | 0 | | | | 111.27 | 111.4 |
| iso Cₐ | | | | | | | | | | (isobutane) |

TABLE 77
The total bond energy of aspartic acid (C₄H₇NO₄) calculated using
the functional group composition and the energies given supra. compared
to the experimental values [3].

| | | | C—C | C—C(O) | C═O | |
|---|---|---|---|---|---|---|
| | CH₂ | CH | (iso-C) | (alkyl carboxylic | (alkyl carboxylic | C—O((O)C—O) |
| Formula | Group | Group | Group | acid) Group | acid) Group | Group |
| Energies E_{D}(Group) of | 7.83016 | 3.32601 | 4.29921 | 4.43110 | 7.80660 | 4.41925 |
| Functional Groups (eV) | | | | | | |
| Composition | 1 | 1 | 1 | 2 | 2 | 2 |

| | | | | Calculated | Experimental | |
|---|---|---|---|---|---|---|
| | OH | NH₂ | C—N | Total Bond | Total Bond | Relative |
| Formula | Group | Group | (1° amine) | Energy (eV) | Energy (eV) | Error |
| Energies E_{D}(Group) of | 4.41035 | 7.41010 | 3.98101 | | | |
| Functional Groups (eV) | | | | | | |
| Composition | 2 | 1 | 1 | 68.98109 | 70.843^{a} | 0.02628 |

^{a}Crystal.

TABLE 78
The total bond energy of glutamic acid (C₅H₉NO₄) calculated using
the functional group composition and the energies
given supra. compared to the experimental values [3].

| | Formula | | | | | | |
|---|---|---|---|---|---|---|---|
| | | | | | C—C(O) | C═O | |
| | | | C—C | C—C | (alkyl | (alkyl | |
| | CH₂ | CH | (n-C) | (iso-C) | carboxylic acid) | carboxylic acid) | C—O((O)C—O) |
| | Group | Group | Group | Group | Group | Group | Group |
| Energies E_{D} (Group) of | 7.83016 | 3.32601 | 4.32754 | 4.29921 | 4.43110 | 7.80660 | 4.41925 |
| Functional Groups (eV) | | | | | | | |
| Composition | 2 | 1 | 1 | 1 | 2 | 2 | 2 |

| | Formula | | | | | |
|---|---|---|---|---|---|---|
| | | | | Calculated | Experimental | |
| | OH | NH₂ | C—N | Total Bond | Total Bond | |
| | Group | Group | (1° amine) | Energy (eV) | Energy (eV) | Relative Error |
| Energies E_{D} (Group) of | 4.41035 | 7.41010 | 3.98101 | | | |
| Functional Groups (eV) | | | | | | |
| Composition | 2 | 1 | 1 | 81.13879 | 83.167^{a} | 0.02438 |

^{a}Crystal.

TABLE 79
The total bond energy of cysteine (C₃H₇NO₄S) calculated using the functional
group composition and the energies given supra. compared to the experimental values [3].
79

| | Formula | | | | | |
|---|---|---|---|---|---|---|
| | | | | C—C(O) | C═O | |
| | | | | (alkyl | (alkyl | |
| | | | C—C | carboxylic | carboxylic | |
| | CH₂ | CH | (iso-C) | acid) | acid) | C—O((O)C—O) |
| | Group | Group | Group | Group | Group | Group |
| Energies E_{D} (Group) of | 7.83016 | 3.32601 | 4.29921 | 4.43110 | 7.80660 | 4.41925 |
| Functional Groups (eV) | | | | | | |
| Composition | 1 | 1 | 1 | 1 | 1 | 1 |

| | Formula | | | | | | | |
|---|---|---|---|---|---|---|---|---|
| | | | | | C—S | Calculated | Experimental | |
| | OH | NH₂ | C—N | SH | (thiol) | Total Bond | Total Bond | Relative |
| | Group | Group | (1° amine) | Group | Group | Energy (eV) | Energy (eV) | Error |
| Energies E_{D} (Group) | 4.41035 | 7.41010 | 3.98101 | 3.77430 | 3.33648 | | | |
| of Functional | | | | | | | | |
| Groups (eV) | | | | | | | | |
| Composition | 1 | 1 | 1 | 1 | 1 | 55.02457 | 56.571^{a} | 0.02733 |

^{a}Crystal

TABLE 80
The total bond energy of lysine (C₆H₁₄N₂O₂) calculated using the functional group
composition and the energies given supra. compared to the experimental values [3].

| | Formula | | | | | | |
|---|---|---|---|---|---|---|---|
| | | | | | C—C(O) | C═O | |
| | | | | | (alkyl | (alkyl | |
| | | | C—C | C—C | carboxylic | carboxylic | |
| | CH₂ | CH | (n-C) | (iso-C) | acid) | acid) | C—O((O)C—O) |
| | Group | Group | Group | Group | Group | Group | Group |
| Energies E_{D} (Group) of | 7.83016 | 3.32601 | 4.32754 | 4.29921 | 4.43110 | 7.80660 | 4.41925 |
| Functional Groups (eV) | | | | | | | |
| Composition | 4 | 1 | 3 | 1 | 1 | 1 | 1 |

| | Formula | | | | | |
|---|---|---|---|---|---|---|
| | | | | Calculated | Experimental | |
| | OH | NH₂ | C—N | Total Bond | Total Bond | Relative |
| | Group | Group | (1° amine) | Energy (eV) | Energy (eV) | Error |
| Energies E_{D} (Group) of Functional | 4.41035 | 7.41010 | 3.98101 | | | |
| Groups (eV) | | | | | | |
| Composition | 1 | 2 | 2 | 95.77799 | 98.194^{a} | 0.02461 |

^{a}Crystal.

Amino Acids (H₂N—CH(R)—COOH)

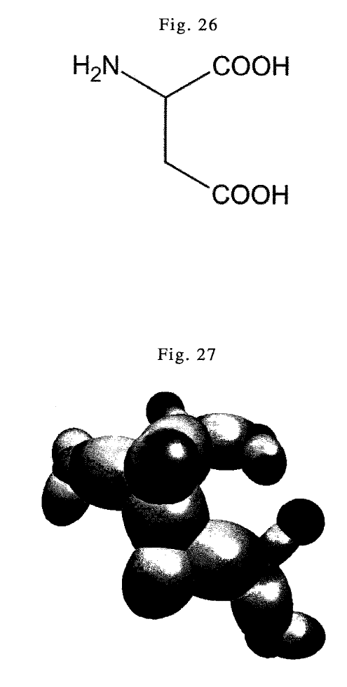

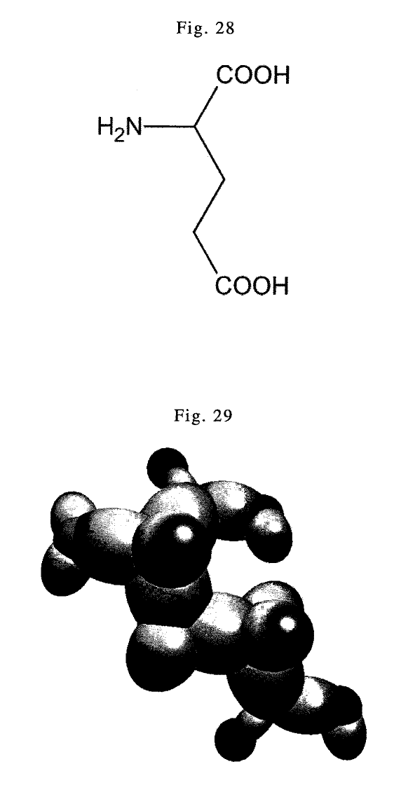

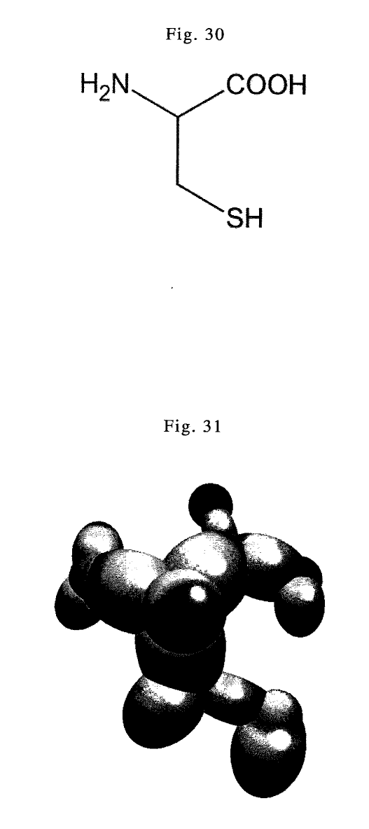

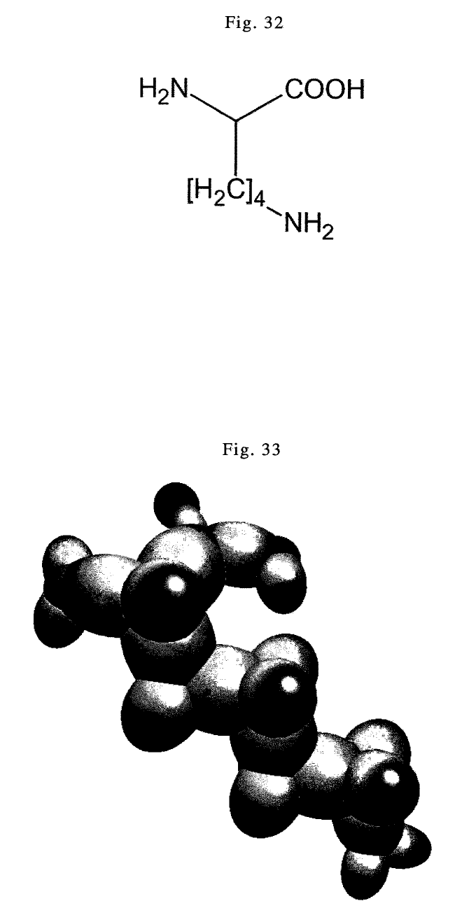

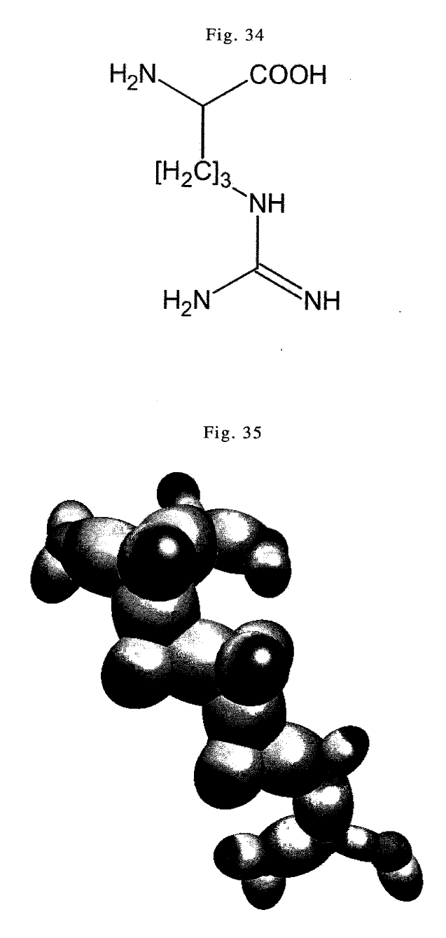

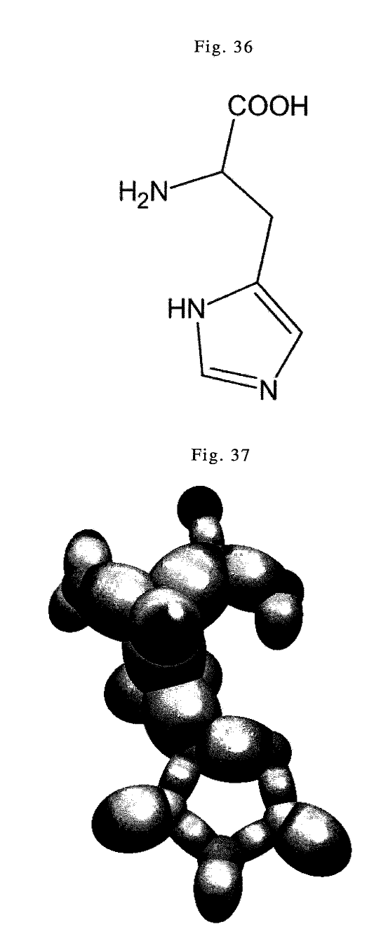

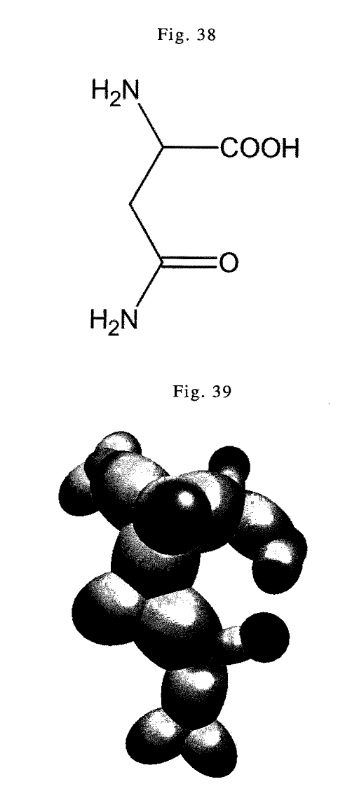

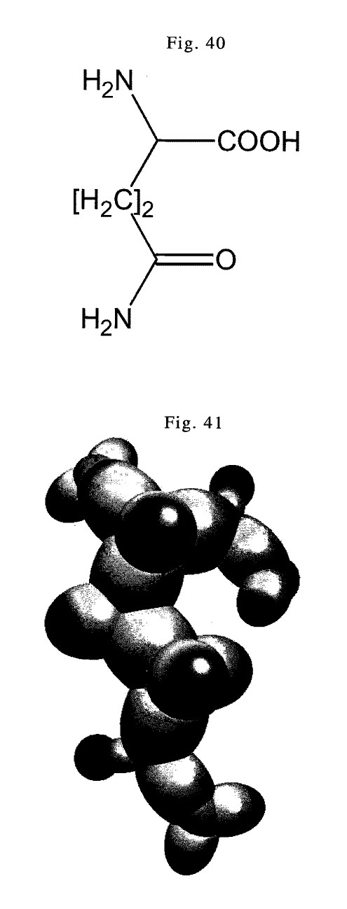

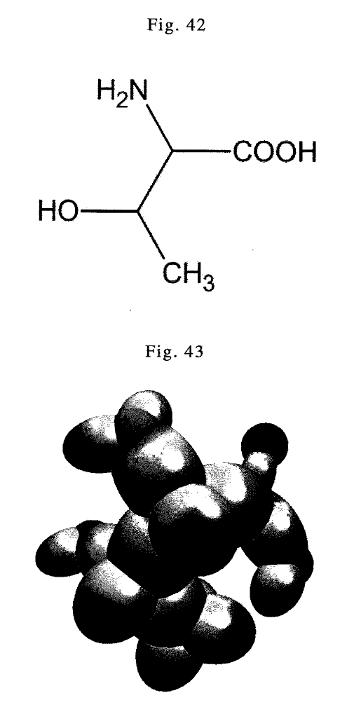

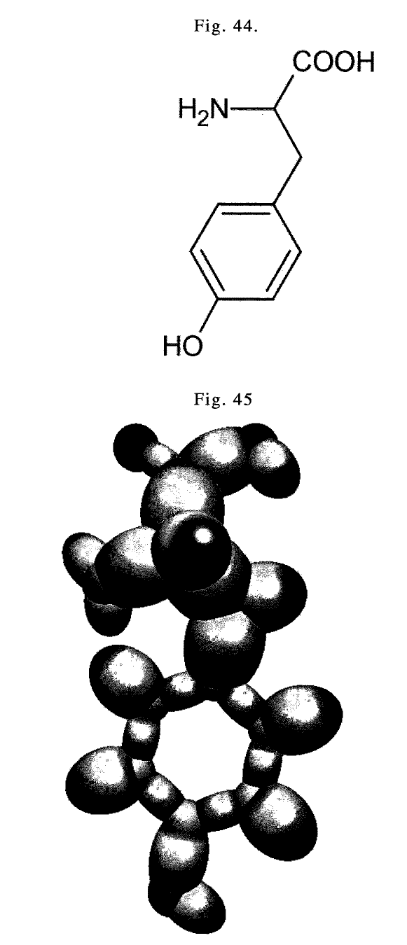

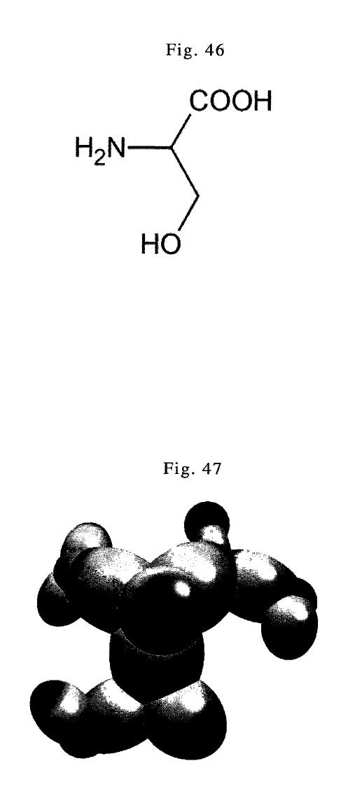

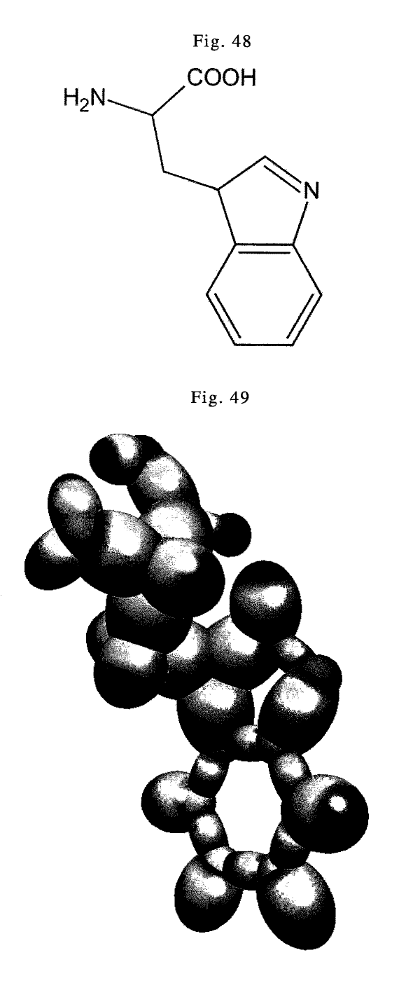

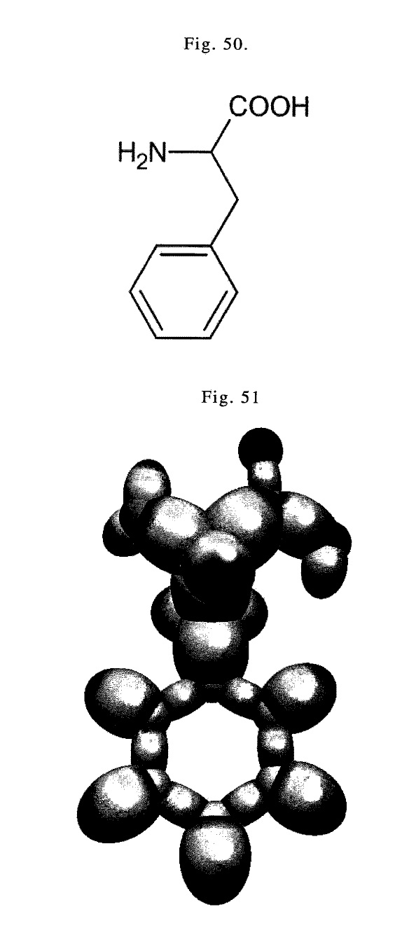

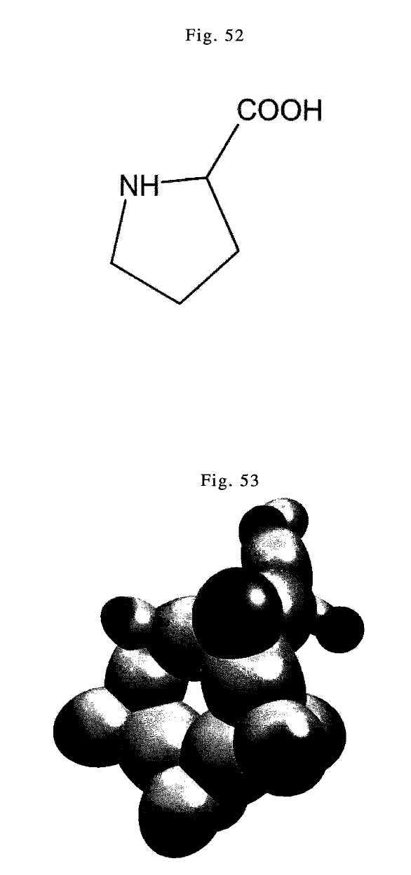

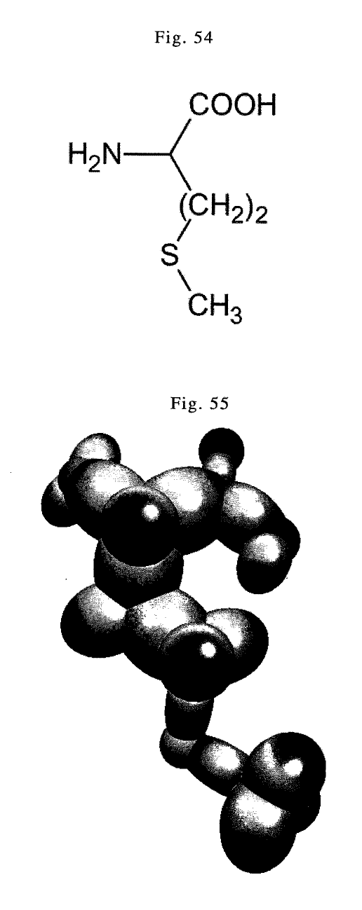

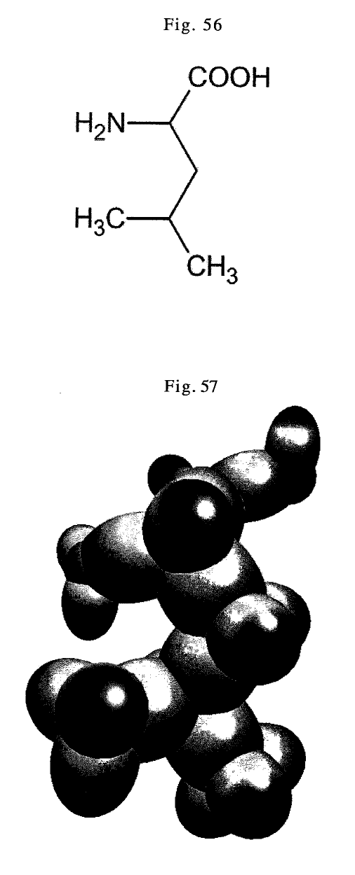

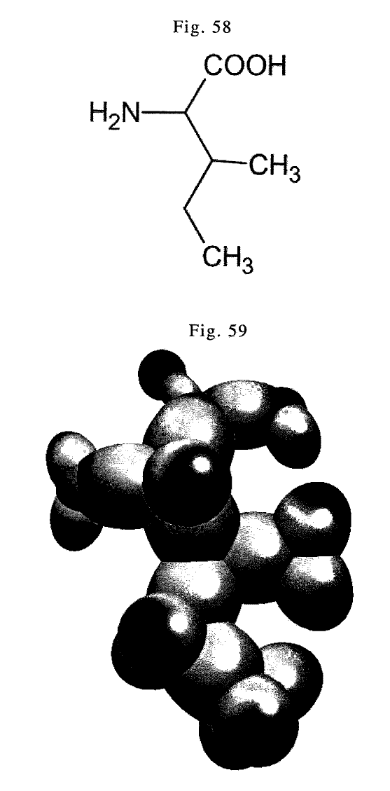

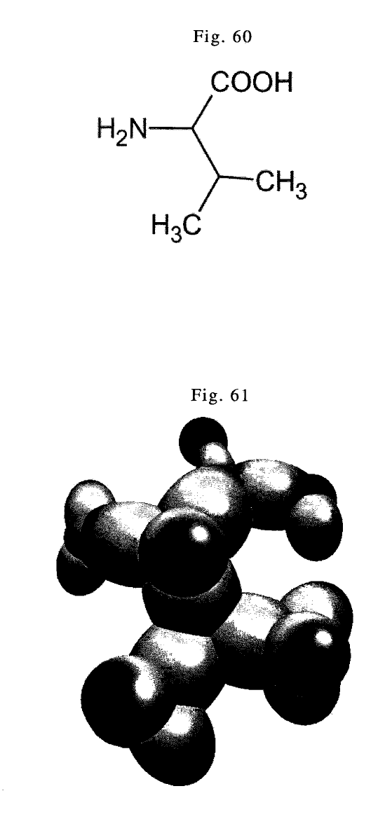

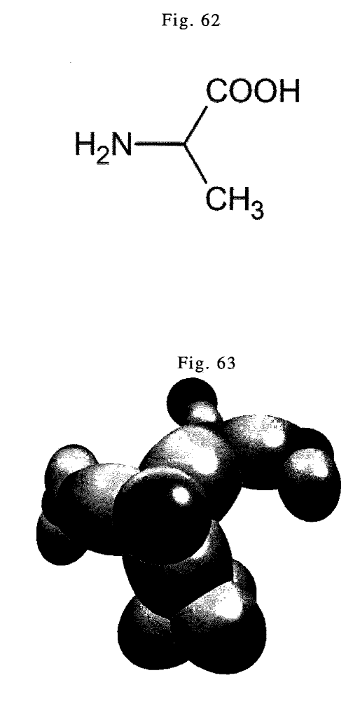

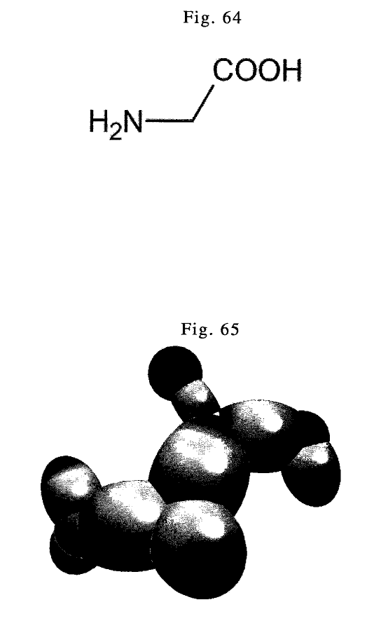

The amino acids, H₂NCH(R)COOH, each have a primary amine moiety comprised of NH₂ and C—N functional groups, an alkyl carboxylic acid moiety comprised of a C═O functional group, and the single bond of carbon to the carbonyl carbon atom, C—C(O), is also a functional group. The carboxylic acid moiety further comprises a C—OH moiety that comprises C—O and OH functional groups. The alpha carbon comprises a methylyne (CH) functional group bound to a side chain R group by an isopropyl C—C bond functional group. These groups common to all amino acids are given in the Primary Amines section, the Carboxylic Acids section, and the Branched Alkanes section, respectively. The R group is unique for each amino acid and determines its characteristic hydrophilic, hydrophobic, acidic, and basic properties. These characteristic functional groups are given in the prior organic functional group sections. The total energy of each amino acid given in Tables 77-96 was calculated as the sum over the integer multiple of each E_{D}(Group) corresponding to the functional-group composition of the amino acid wherein the group identity and energy Group, E_{D}(Group) are given in each table. The structure and the color scale, charge-density of the amino acids, each comprising atoms with the outer shell bridged by one or more H₂-type ellipsoidal MOs or joined with one or more hydrogen MOs are shown in FIGS. 26-65.

TABLE 81
The total bond energy of arginine (C₆H₁₄N₂O₂) calculated using the functional
group composition and the energies given supra. compared to the experimental values [3].

| | Formula | | | | | | | | |
|---|---|---|---|---|---|---|---|---|---|
| | | | | | C—C(O) | C═O | | | |
| | | | | | (alkyl | (alkyl | | | |
| | | | C—C | C—C | carboxylic | carboxylic | | | |
| | CH₂ | CH | (n-C) | (iso-C) | acid) | acid) | C—O((O)C—O) | OH | NH₂ |
| | Group | Group | Group | Group | Group | Group | Group | Group | Group |
| Energies of | 7.83016 | 3.32601 | 4.32754 | 4.29921 | 4.43110 | 7.80660 | 4.41925 | 4.41035 | 7.41010 |
| Functional Groups | | | | | | | | | |
| (eV) | | | | | | | | | |
| Composition | 3 | 1 | 2 | 1 | 1 | 1 | 1 | 1 | 1 |

| | Formula | | | | | | | | |
|---|---|---|---|---|---|---|---|---|---|
| | | N═C | NH | C—N | C—N((O)C—N | | Calculated | | |
| | C—N | (N_{b}═C_{c} | (heterocyclic | (N alkyl | alkyl | NH₂ | Total Bond | Experimental | |
| | (1° | imidazole) | imidazole) | amide) | amide) | (amide) | Energy | Total Bond | Relative |
| | amine) | Group | Group | Group | Group | Group | (eV) | Energy (eV) | Error |
| Energies of | 3.98101 | 6.79303 | 3.51208 | 3.40044 | 4.12212 | 7.37901 | | | |
| Functional | | | | | | | | | |
| Groups (eV) | | | | | | | | | |
| Composition | 1 | 1 | 2 | 1 | 2 | 1 | 105.07007 | 107.420^{a} | 0.02188 |

^{a}Crystal.

TABLE 82
The total bond energy of histidine (C₆H₉N₃O₂) calculated using the functional group
composition and the energies given supra. compared to the experimental values [3].

| | Formula | | | | | | | | | | |
|---|---|---|---|---|---|---|---|---|---|---|---|
| | | | | C—C(O) | C═O | | | | | | |
| | | | | (alkyl | (alkyl | | | | | | |
| | | | C—C | carboxylic | carboxylic | | | | C—N | | CH |
| | CH₂ | CH | (iso-C) | acid) | acid) | C—O((O)C—O) | OH | NH₂ | (1° | C—C(—C(C)═C) | (imidazole) |
| | Group | Group | Group | Group | Group | Group | Group | Group | amine) | Group | Group |
| Energies | 7.83016 | 3.32601 | 4.29921 | 4.43110 | 7.80660 | 4.41925 | 4.41035 | 7.41010 | 3.98101 | 3.75498 | 3.32988 |
| E_{D} (Group) | | | | | | | | | | | |
| of | | | | | | | | | | | |
| Functional | | | | | | | | | | | |
| Groups (eV) | | | | | | | | | | | |
| Composition | 1 | 1 | 1 | 1 | 1 | 1 | 1 | 1 | 1 | 1 | 2 |

Formula

| | C═C | N═C | C—N | NH | C—N—C | Calculated | | |
|---|---|---|---|---|---|---|---|---|
| | (Cₐ═C_{b} | (N_{b}═C_{c} | (C_{b}—N_{b} | (heterocyclic | (Cₐ—Nₐ—C_{c} | Total Bond | Experimental | |
| | imidazole) | imidazole) | imidazole) | imidazole) | imidazole) | Energy | Total Bond | Relative |
| | Group | Group | Group | Group | Group | (eV) | Energy (eV) | Error |
| Energies | 7.23317 | 6.79303 | 3.47253 | 3.51208 | 8.76298 | | | |
| E_{D} (Group) of | | | | | | | | |
| Functional | | | | | | | | |
| Groups (eV) | | | | | | | | |
| Composition | 1 | 1 | 1 | 1 | 1 | 88.10232 | 89.599^{a} | 0.01671 |

^{a}Crystal.

TABLE 83
The total bond energy of asparagine (C₄H₈N₂O₂) calculated using the functional group
composition and the energies given supra. compared to the experimental values [3].

| | Formula | | | | | | | |
|---|---|---|---|---|---|---|---|---|
| | | | | C—C(O) | C═O | | | |
| | | | | (alkyl | (alkyl | | | |
| | | | C—C | carboxylic | carboxylic | | | |
| | CH₂ | CH | (iso-C) | acid) | acid) | C—O((O)C—O) | OH | NH₂ |
| | Group | Group | Group | Group | Group | Group | Group | Group |
| Energies E_{D} (Group) | 7.83016 | 3.32601 | 4.29921 | 4.43110 | 7.80660 | 4.41925 | 4.41035 | 7.41010 |
| of Functional Groups | | | | | | | | |
| (eV) | | | | | | | | |
| Composition | 1 | 1 | 1 | 1 | 2 | 1 | 1 | 1 |

| | Formula | | | | | | |
|---|---|---|---|---|---|---|---|
| | | C—C(O) | | | | | |
| | | (alkyl | C—N((O)C—N | NH₂ | Calculated | Experimental | |
| | C—N | amide) | alkyl amide) | (amide) | Total Bond | Total Bond | Relative |
| | (1° amine) | Group | Group | Group | Energy (eV) | Energy (eV) | Error |
| Energies E_{D} (Group) | 3.98101 | 4.35263 | 4.12212 | 7.37901 | | | |
| of Functional Groups | | | | | | | |
| (eV) | | | | | | | |
| Composition | 1 | 1 | 1 | 1 | 71.57414 | 73.513^{a} | 0.02637 |

^{a}Crystal.

TABLE 84
The total bond energy of glutamine (C₅H₁₀N₂O₂) calculated using the functional group
composition and the energies given supra. compared to the experimental values [3].

| | Formula | | | | | | | |
|---|---|---|---|---|---|---|---|---|
| | | | | | C—C(O) | C═O | | |
| | | | | | (alkyl | (alkyl | | |
| | | | C—C | C—C | carboxylic | carboxylic | | |
| | CH₂ | CH | (n-C) | (iso-C) | acid) | acid) | C—O((O)C—O) | OH |
| | Group | Group | Group | Group | Group | Group | Group | Group |
| Energies E_{D} (Group) | 7.83016 | 3.32601 | 4.32754 | 4.29921 | 4.43110 | 7.80660 | 4.41925 | 4.41035 |
| of Functional Groups | | | | | | | | |
| (eV) | | | | | | | | |
| Composition | 2 | 1 | 1 | 1 | 1 | 2 | 1 | 1 |

| | Formula | | | | | | | |
|---|---|---|---|---|---|---|---|---|
| | | | C—C(O) | C—N((O)C—N | | | | |
| | | | (alkyl | alkyl | NH₂ | Calculated | Experimental | |
| | NH₂ | C—N | amide) | amide) | (amide) | Total Bond | Total Bond | Relative |
| | Group | (1° amine) | Group | Group | Group | Energy (eV) | Energy (eV) | Error |
| Energies | 7.41010 | 3.98101 | 4.35263 | 4.12212 | 7.37901 | | | |
| E_{D} (Group) of | | | | | | | | |
| Functional | | | | | | | | |
| Groups (eV) | | | | | | | | |
| Composition | 1 | 1 | 1 | 1 | 1 | 83.73184 | 85.843^{a} | 0.02459 |

^{a}Crystal.

TABLE 85
The total bond energy of threonine (C₄H₉NO₃) calculated using the functional group
composition and the energies given supra. compared to the experimental values [3].

| | Formula | | | | | | |
|---|---|---|---|---|---|---|---|
| | | | | C—C(O) | C═O | | |
| | | | | (alkyl | (alkyl | | |
| | | | C—C | carboxylic | carboxylic | | |
| | CH₃ | CH | (iso-C) | acid) | acid) | C—O((O)C—O) | OH |
| | Group | Group | Group | Group | Group | Group | Group |
| Energies E_{D} (Group) of | 12.49186 | 3.32601 | 4.29921 | 4.43110 | 7.80660 | 4.41925 | 4.41035 |
| Functional Groups (eV) | | | | | | | |
| Composition | 1 | 2 | 2 | 1 | 1 | 1 | 2 |

| | Formula | | | | | |
|---|---|---|---|---|---|---|
| | | | C—O | Calculated | Experimental | |
| | NH₂ | C—N | (alkyl alcohol) | Total Bond | Total Bond | |
| | Group | (1° amine) | Group | Energy (eV) | Energy (eV) | Relative Error |
| Energies | 7.41010 | 3.98101 | 4.34572 | | | |
| E_{D} (Group) of | | | | | | |
| Functional | | | | | | |
| Groups (eV) | | | | | | |
| Composition | 1 | 1 | 1 | 68.95678 | 71.058^{a} | 0.02956 |

^{a}Crystal.

TABLE 86
The total bond energy of tyrosine (C₉H₁₁NO₃) calculated using the functional group
composition and the energies given supra. compared to the experimental values [3].

| | Formula | | | | | | | |
|---|---|---|---|---|---|---|---|---|
| | | | | C—C(O) | C═O | | | |
| | | | | (alkyl | (alkyl | | | |
| | | | C—C | carboxylic | carboxylic | | | |
| | CH₂ | CH | (iso-C) | acid) | acid) | C—O((O)C—O) | OH | NH₂ |
| | Group | Group | Group | Group | Group | Group | Group | Group |
| Energies E_{D} (Group) of | 7.83016 | 3.32601 | 4.29921 | 4.43110 | 7.80660 | 4.41925 | 4.41035 | 7.41010 |
| Functional Groups (eV) | | | | | | | | |
| Composition | 1 | 1 | 1 | 1 | 1 | 1 | 2 | 1 |

| | Formula | | | | | | | |
|---|---|---|---|---|---|---|---|---|
| | | C^{3e}═C | CH | C—C | C—O | | | |
| | C—N | (CC aromatic | (CH | (C alkyl to | (Aryl C—O | Calculated | Experimental | |
| | (1° | bond) | aromatic) | aryl toluene) | phenol) | Total Bond | Total Bond | Relative |
| | amine) | Group | Group | Group | Group | Energy (eV) | Energy (eV) | Error |
| Energies | 3.98101 | 5.63881 | 3.90454 | 3.63685 | 3.99228 | | | |
| E_{D} (Group) of | | | | | | | | |
| Functional | | | | | | | | |
| Groups (eV) | | | | | | | | |
| Composition | 1 | 6 | 4 | 1 | 1 | 109.40427 | 111.450^{a} | 0.01835 |

^{a}Crystal.

TABLE 87
The total bond energy of serine (C₃H₇NO₃) calculated using the functional group
composition and the energies given supra. compared to the experimental values [3].

| | Formula | | | | | | |
|---|---|---|---|---|---|---|---|
| | | | | C—C(O) | C═O | | |
| | | | | (alkyl | (alkyl | | |
| | | | C—C | carboxylic | carboxylic | | |
| | CH₂ | CH | (iso-C) | acid) | acid) | C—O((O)C—O) | OH |
| | Group | Group | Group | Group | Group | Group | Group |
| Energies E_{D} (Group) of | 7.83016 | 3.32601 | 4.29921 | 4.43110 | 7.80660 | 4.41925 | 4.41035 |
| Functional Groups (eV) | | | | | | | |
| Composition | 1 | 1 | 1 | 1 | 1 | 1 | 2 |

| | Formula | | | | | |
|---|---|---|---|---|---|---|
| | | | C—O | Calculated | Experimental | |
| | NH₂ | C—N | (alkyl alcohol) | Total Bond | Total Bond | |
| | Group | (1° amine) | Group | Energy (eV) | Energy (eV) | Relative Error |
| Energies | 7.41010 | 3.98101 | 4.34572 | | | |
| E_{D} (Group) of | | | | | | |
| Functional | | | | | | |
| Groups (eV) | | | | | | |
| Composition | 1 | 1 | 1 | 56.66986 | 58.339^{a} | 0.02861 |

^{a}Crystal.

TABLE 88
The total bond energy of tryptophan (C₁₁H₁₂N₂O₂) calculated using the functional group
composition and the energies given supra. compared to the experimental values [3].

| | Formula | | | | | |
|---|---|---|---|---|---|---|
| | | | | C—C(O) | C═O | |
| | | | C—C | (alkyl carboxylic | (alkyl carboxylic | |
| | CH₂ | CH | (iso-C) | acid) | acid) | C—O((O)C—O) |
| | Group | Group | Group | Group | Group | Group |
| Energies E_{D} (Group) of | 7.83016 | 3.32601 | 4.29921 | 4.43110 | 7.80660 | 4.41925 |
| Functional Groups (eV) | | | | | | |
| Composition | 1 | 1 | 2 | 1 | 1 | 1 |

| | Formula | | | | | | |
|---|---|---|---|---|---|---|---|
| | | | | C^{3e}═C | | | |
| | | | | (CC aromatic | CH | C—C(C_{b}—C_{d} | C═C(C_{d}═Cₑ |
| | OH | NH₂ | C—N | bond) | (CH aromatic) | indole) | indole) |
| | Group | Group | (1° amine) | Group | Group | Group | Group |
| Energies | 4.41035 | 7.41010 | 3.98101 | 5.63881 | 3.90454 | 3.47253 | 6.79303 |
| E_{D} (Group) | | | | | | | |
| of | | | | | | | |
| Functional | | | | | | | |
| Groups (eV) | | | | | | | |
| Composition | 2 | 1 | 1 | 6 | 4 | 1 | 1 |

| | Formula | | | | | | |
|---|---|---|---|---|---|---|---|
| | | | | C—C | | | |
| | CH | C—N—C | NH | (C alkyl to | Calculated | Experimental | |
| | (CH indole) | (indole) | (indole) | aryl toluene) | Total Bond | Total Bond | Relative |
| | Group | Group | Group | Group | Energy (eV) | Energy (eV) | Error |
| Energies | | | 3.63685 | 3.63685 | | | |
| E_{D} (Group) of | | | | | | | |
| Functional | | | | | | | |
| Groups (eV) | | | | | | | |
| Composition | 1 | 1 | 1 | 1 | 126.74291 | 128.084^{a} | 0.01047 |

^{a}Crystal.

TABLE 89
The total bond energy of phenylalanine (C₉H₁₁NO₂) calculated using the functional group
composition and the energies given supra. compared to the experimental values [3].

| | Formula | | | | | | | |
|---|---|---|---|---|---|---|---|---|
| | | | | C—C(O) | C═O | | | |
| | | | | (alkyl | (alkyl | | | |
| | | | C—C | carboxylic | carboxylic | | | |
| | CH₂ | CH | (iso-C) | acid) | acid) | C—O((O)C—O) | OH | NH₂ |
| | Group | Group | Group | Group | Group | Group | Group | Group |
| Energies E_{D} (Group) of | 7.83016 | 3.32601 | 4.29921 | 4.43110 | 7.80660 | 4.41925 | 4.41035 | 7.41010 |
| Functional Groups (eV) | | | | | | | | |
| Composition | 1 | 1 | 1 | 1 | 1 | 1 | 2 | 1 |

| | Formula | | | | | | |
|---|---|---|---|---|---|---|---|
| | | | CH | C—C | | | |
| | | C^{3e}═C | (CH | (C alkyl to | Calculated | Experimental | |
| | C—N | (CC aromatic bond) | aromatic) | aryl toluene) | Total Bond | Total Bond | Relative |
| | (1° amine) | Group | Group | Group | Energy (eV) | Energy (eV) | Error |
| Energies E_{D} (Group) | 3.98101 | 5.63881 | 3.90454 | 3.63685 | | | |
| of Functional | | | | | | | |
| Groups (eV) | | | | | | | |
| Composition | 1 | 6 | 5 | 1 | 104.90618 | 105.009 | 0.00098 |

TABLE 90
The total bond energy of proline (C₅H₉NO₂) calculated using the functional group
composition and the energies given supra. compared to the experimental values [3].

| | Formula | | | | | | |
|---|---|---|---|---|---|---|---|
| | | | | | C—C(O) | C═O | |
| | | | | | (alkyl | (alkyl | |
| | | | C—C | C—C | carboxylic | carboxylic | |
| | CH₂ | CH | (n-C) | (iso-C) | acid) | acid) | C—O((O)C—O) |
| | Group | Group | Group | Group | Group | Group | Group |
| Energies E_{D} (Group) of | 7.83016 | 3.32601 | 4.32754 | 4.29921 | 4.43110 | 7.80660 | 4.41925 |
| Functional Groups (eV) | | | | | | | |
| Composition | 3 | 1 | 2 | 1 | 1 | 1 | 1 |

| | Formula | | | | | |
|---|---|---|---|---|---|---|
| | | | | Calculated | Experimental | |
| | OH | NH | C—N | Total Bond | Total Bond | |
| | Group | (2° amine) | (2° amine) | Energy (eV) | Energy (eV) | Relative Error |
| Energies E_{D} (Group) of | 4.41035 | 3.50582 | 3.71218 | | | |
| Functional Groups (eV) | | | | | | |
| Composition | 1 | 1 | 2 | 71.76826 | 71.332 | −0.00611 |

TABLE 91
The total bond energy of methionine (C₅H₁₁NO₂S) calculated using the functional group
composition and the energies given supra. compared to the experimental values [3].

| | Formula | | | | | | | |
|---|---|---|---|---|---|---|---|---|
| | | | | | | C—C(O) | C═O | |
| | | | | | | (alkyl | (alkyl | |
| | | | | C—C | C—C | carboxylic | carboxylic | |
| | CH₃ | CH₂ | CH | (n-C) | (iso-C) | acid) | acid) | C—O((O)C—O) |
| | Group | Group | Group | Group | Group | Group | Group | Group |
| Energies E_{D} (Group) of | 12.49186 | 7.83016 | 3.32601 | 4.32754 | 4.29921 | 4.43110 | 7.80660 | 4.41925 |
| Functional Groups (eV) | | | | | | | | |
| Composition | 1 | 2 | 1 | 1 | 1 | 1 | 1 | 1 |

| | Formula | | | | | | |
|---|---|---|---|---|---|---|---|
| | | | | C—S | Calculated | Experimental | |
| | OH | NH₂ | C—N | (alkyl | Total Bond | Total Bond | Relative |
| | Group | Group | (1° amine) | sulfide) | Energy (eV) | Energy (eV) | Error |
| Energies E_{D} (Group) of | 4.41035 | 7.41010 | 3.98101 | 3.33648 | | | |
| Functional Groups (eV) | | | | | | | |
| Composition | 1 | 1 | 1 | 2 | 79.23631 | 79.214 | −0.00028 |

TABLE 92
The total bond energy of leucine (C₆H₁₃NO₂) calculated using the functional group
composition and the energies given supra. compared to the experimental values [3].

| | Formula | | | | | | |
|---|---|---|---|---|---|---|---|
| | | | | | C—C(O) | C═O | |
| | | | | C—C | (alkyl carboxylic | (alkyl carboxylic | |
| | CH₃ | CH₂ | CH | (iso-C) | acid) | acid) | C—O((O)C—O) |
| | Group | Group | Group | Group | Group | Group | Group |
| Energies E_{D} (Group) of | 12.49186 | 7.83016 | 3.32601 | 4.29921 | 4.43110 | 7.80660 | 4.41925 |
| Functional Groups (eV) | | | | | | | |
| Composition | 2 | 1 | 2 | 4 | 1 | 1 | 1 |

Formula

| | | | | Calculated | Experimental | |
|---|---|---|---|---|---|---|
| | OH | NH₂ | C—N | Total Bond | Total Bond | |
| | Group | Group | (1° amine) | Energy (eV) | Energy (eV) | Relative Error |
| Energies E_{D} (Group) of | 4.41035 | 7.41010 | 3.98101 | | | |
| Functional Groups (eV) | | | | | | |
| Composition | 1 | 1 | 1 | 89.12115 | 89.047 | −0.00083 |

TABLE 93
The total bond energy of isoleucine (C₆H₁₃NO₂) calculated using the
functional group composition and the energies given supra. compared to the experimental values [3].

| | | | | | | C—C(O) | | C═O |
|---|---|---|---|---|---|---|---|---|
| | | | | | | (alkyl | | (alkyl |
| | | | | C—C | C—C | carboxylic | C—C | carboxylic |
| | CH₃ | CH₂ | CH | (n-C) | (iso-C) | acid) | (iso to iso-C) | acid) |
| Formula | Group | Group | Group | Group | Group | Group | Group | Group |
| Energies E_{D}(Group) of | 12.49186 | 7.83016 | 3.32601 | 4.32754 | 4.29921 | 4.43110 | 4.17951 | 7.80660 |
| Functional Groups (eV) | | | | | | | | |
| Composition | 2 | 1 | 2 | 1 | 2 | 1 | 1 | 1 |

| | | | | | Calculated | Experimental | |
|---|---|---|---|---|---|---|---|
| | C—O((O)C—O) | OH | NH₂ | C—N | Total Bond | Total Bond | Relative |
| Formula | Group | Group | Group | (1° amine) | Energy (eV) | Energy (eV) | Error |
| Energies E_{D}(Group) of | 4.41925 | 4.41035 | 7.41010 | 3.98101 | | | |
| Functional Groups (eV) | | | | | | | |
| Composition | 1 | 1 | 1 | 1 | 89.02978 | 90.612 | 0.01746 |

^{a}Crystal.

TABLE 94
The total bond energy of valine (C₅H₁₁NO₂) calculated using the functional group
composition and the energies given supra. compared to the experimental values [3].

| | | | | | C—C(O) | C═O |
|---|---|---|---|---|---|---|
| | | | C—C | C—C | (alkyl carboxylic | (alkyl carboxylic |
| | CH₃ | CH | (iso-C) | (iso to iso-C) | acid) | acid) |
| Formula | Group | Group | Group | Group | Group | Group |
| Energies E_{D}(Group) of | 12.49186 | 3.32601 | 4.29921 | 4.17951 | 4.43110 | 7.80660 |
| Functional Groups (eV) | | | | | | |
| Composition | 2 | 2 | 2 | 1 | 1 | 1 |

| | | | | | Calculated | Experimental | |
|---|---|---|---|---|---|---|---|
| | C—O((O)C—O) | OH | NH₂ | C—N | Total Bond | Total Bond | Relative |
| Formula | Group | Group | Group | (1° amine) | Energy (eV) | Energy (eV) | Error |
| Energies E_{D}(Group) of | 4.41925 | 4.41035 | 7.41010 | 3.98101 | | | |
| Functional Groups (eV) | | | | | | | |
| Composition | 1 | 1 | 1 | 1 | 76.87208 | 76.772 | −0.00130 |

TABLE 95
The total bond energy of alanine (C₃H₇NO₂) calculated using the functional group
composition and the energies given supra. compared to the experimental values [3].

| | | | | C—C(O) | C═O | |
|---|---|---|---|---|---|---|
| | | | C—C | (alkyl carboxylic | (alkyl carboxylic | |
| | CH₃ | CH | (iso-C) | acid) | acid) | C—O((O)C—O) |
| Formula | Group | Group | Group | Group | Group | Group |
| Energies E_{D}(Group) of | 12.49186 | 3.32601 | 4.29921 | 4.43110 | 7.80660 | 4.41925 |
| Functional Groups (eV) | | | | | | |
| Composition | 1 | 1 | 1 | 1 | 1 | 1 |

| | | | | Calculated | Experimental | |
|---|---|---|---|---|---|---|
| | OH | NH₂ | C—N | Total Bond | Total Bond | |
| Formula | Group | Group | (1° amine) | Energy (eV) | Energy (eV) | Relative Error |
| Energies E_{D}(Group) of | 4.41035 | 7.41010 | 3.98101 | | | |
| Functional Groups (eV) | | | | | | |
| Composition | 1 | 1 | 1 | 52.57549 | 52.991 | 0.00785 |

TABLE 96
The total bond energy of glycine (C₂H₅NO₂) calculated using the functional group
composition and the energies given supra. compared to the experimental values [3].

| | | C—C(O) | C═O | | |
|---|---|---|---|---|---|
| | | (alkyl carboxylic | (alkyl carboxylic | | |
| | CH₂ | acid) | acid) | C—O((O)C—O) | OH |
| Formula | Group | Group | Group | Group | Group |
| Energies E_{D}(Group) of | 7.83016 | 4.43110 | 7.80660 | 4.41925 | 4.41035 |
| Functional Groups (eV) | | | | | |
| Composition | 1 | 1 | 1 | 1 | 1 |

| | | | Calculated | Experimental | |
|---|---|---|---|---|---|
| | NH₂ | C—N | Total Bond | Total Bond | Relative |
| Formula | Group | (1° amine) | Energy (eV) | Energy (eV) | Error |
| Energies E_{D}(Group) of | 7.41010 | 3.98101 | | | |
| Functional Groups (eV) | | | | | |
| Composition | 1 | 1 | 40.28857 | 40.280 | −0.00021 |

Polypeptides (—[HN—CH(R)—C(O)]ₙ—)

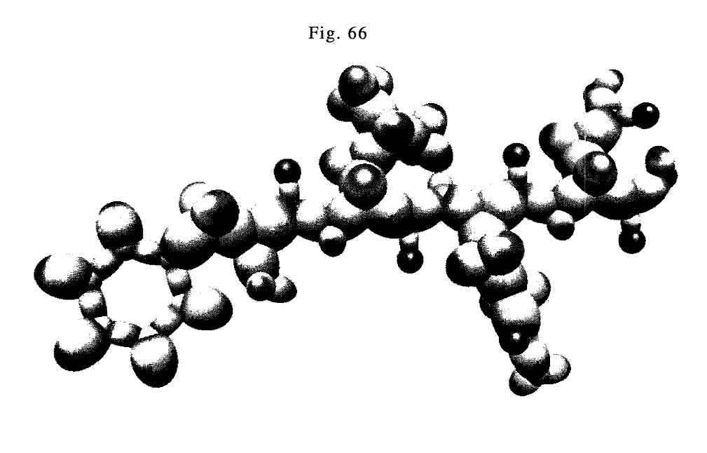

The amino acids can be polymerized by reaction of the OH group from the carboxylic acid moiety of one amino acid with H from the alpha-carbon NH₂ of another amino acid to form H₂O and an amide bond as part of a polyamide chain of a polypeptide or protein. Each amide bond that forms by the condensation of two amino acids is called a peptide bond. It comprises a C═O functional group, and the single bond of carbon to the carbonyl carbon atom, C—C(O), is also a functional group. The peptide bond further comprises a C—NH(R) moiety that comprises NH and C—N functional groups where R is the characteristic side chain of each amino acid that is unchanged in terms of its functional group composition upon the formation of the peptide bond. From the N-Alkyl and N,N-Dialkyl-Amides section, the functional group composition and the corresponding energy E_{D}(Group) of each group of the peptide bond is given in Table 97. The color scale, charge-density of the exemplary polypeptide, phenylalanine-leucine-glutamine-asparic acid (phe-leu-gln-asp) comprising the atoms with the outer shell bridged by one or more H₂-type ellipsoidal MOs or joined with one or more hydrogen MOs is shown in FIG. 66.

TABLE 97
The functional group composition and the energy
E_{D} (Group) of each group of the peptide bond.

| | Formula | | | |
|---|---|---|---|---|
| | C—C(O) | C—N((O)C—N | C—N | NH |
| | (alkyl | alkyl | (N alkyl | (N alkyl |
| | amide) | amide) | amide) | amide) |
| | Group | Group | Group | Group |
| Energies E_{D} (Group) | 4.35263 | 4.12212 | 3.40044 | 3.49788 |
| of Functional Groups | | | | |
| (eV) | | | | |
| Composition | 1 | 1 | 1 | 1 |

Summary Tables of Organic Molecules

The bond energies, calculated using closed-form equations having integers and fundamental constants only for classes of molecules whose designation is based on the main functional group, are given in the following tables with the experimental values.

TABLE 98
Summary results of n-alkanes.

| | | Calculated | Experimental | |
|---|---|---|---|---|
| | | Total Bond | Total Bond | Relative |
| Formula | Name | Energy (eV) | Energy (eV) | Error |
| C₃H₈ | propane | 41.46896 | 41.434 | −0.00085 |
| C₄H₁₀ | butane | 53.62666 | 53.61 | −0.00036 |
| C₅H₁₂ | pentane | 65.78436 | 65.77 | −0.00017 |
| C₆H₁₄ | hexane | 77.94206 | 77.93 | −0.00019 |
| C₇H₁₆ | heptane | 90.09976 | 90.09 | −0.00013 |
| C₈H₁₈ | octane | 102.25746 | 102.25 | −0.00006 |
| C₉H₂₀ | nonane | 114.41516 | 114.40 | −0.00012 |
| C₁₀H₂₂ | decane | 126.57286 | 126.57 | −0.00003 |
| C₁₁H₂₄ | undecane | 138.73056 | 138.736 | 0.00004 |
| C₁₂H₂₆ | dodecane | 150.88826 | 150.88 | −0.00008 |
| C₁₈H₃₈ | octadecane | 223.83446 | 223.85 | 0.00008 |

TABLE 99
Summary results of branched alkanes.

| | | | Experi- | |
|---|---|---|---|---|
| | | Calculated | mental | |
| | | Total | Total | |
| | | Bond | Bond | |
| | | Energy | Energy | Relative |
| Formula | Name | (eV) | (eV) | Error |
| C₄H₁₀ | isobutane | 53.69922 | 53.695 | −0.00007 |
| C₅H₁₂ | isopentane | 65.85692 | 65.843 | −0.00021 |
| C₅H₁₂ | neopentane | 65.86336 | 65.992 | 0.00195 |
| C₆H₁₄ | 2-methylpentane | 78.01462 | 78.007 | −0.00010 |
| C₆H₁₄ | 3-methylpentane | 78.01462 | 77.979 | −0.00046 |
| C₆H₁₄ | 2,2-dimethylbutane | 78.02106 | 78.124 | 0.00132 |
| C₆H₁₄ | 2,3-dimethylbutane | 77.99581 | 78.043 | 0.00061 |
| C₇H₁₆ | 2-methylhexane | 90.17232 | 90.160 | −0.00014 |
| C₇H₁₆ | 3-methylhexane | 90.17232 | 90.127 | −0.00051 |
| C₇H₁₆ | 3-ethylpentane | 90.17232 | 90.108 | −0.00072 |
| C₇H₁₆ | 2,2-dimethylpentane | 90.17876 | 90.276 | 0.00107 |
| C₇H₁₆ | 2,2,3-trimethylbutane | 90.22301 | 90.262 | 0.00044 |
| C₇H₁₆ | 2,4-dimethylpentane | 90.24488 | 90.233 | −0.00013 |
| C₇H₁₆ | 3,3-dimethylpentane | 90.17876 | 90.227 | 0.00054 |
| C₈H₁₈ | 2-methylheptane | 102.33002 | 102.322 | −0.00008 |
| C₈H₁₈ | 3-methylheptane | 102.33002 | 102.293 | −0.00036 |
| C₈H₁₈ | 4-methylheptane | 102.33002 | 102.286 | −0.00043 |
| C₈H₁₈ | 3-ethylhexane | 102.33002 | 102.274 | −0.00055 |
| C₈H₁₈ | 2,2-dimethylhexane | 102.33646 | 102.417 | 0.00079 |
| C₈H₁₈ | 2,3-dimethylhexane | 102.31121 | 102.306 | −0.00005 |
| C₈H₁₈ | 2,4-dimethylhexane | 102.40258 | 102.362 | −0.00040 |
| C₈H₁₈ | 2,5-dimethylhexane | 102.40258 | 102.396 | −0.00006 |
| C₈H₁₈ | 3,3-dimethylhexane | 102.33646 | 102.369 | 0.00032 |
| C₈H₁₈ | 3,4-dimethylhexane | 102.31121 | 102.296 | −0.00015 |
| C₈H₁₈ | 3-ethyl-2-methylpentane | 102.31121 | 102.277 | −0.00033 |
| C₈H₁₈ | 3-ethyl-3-methylpentane | 102.33646 | 102.317 | −0.00019 |
| C₈H₁₈ | 2,2,3-trimethylpentane | 102.38071 | 102.370 | −0.00010 |
| C₈H₁₈ | 2,2,4-trimethylpentane | 102.40902 | 102.412 | 0.00003 |
| C₈H₁₈ | 2,3,3-trimethylpentane | 102.38071 | 102.332 | −0.00048 |
| C₈H₁₈ | 2,3,4-trimethylpentane | 102.29240 | 102.342 | 0.00049 |
| C₈H₁₈ | 2,2,3,3-tetramethylbutane | 102.41632 | 102.433 | 0.00016 |
| C₉H₂₀ | 2,3,5-trimethylhexane | 114.54147 | 114.551 | 0.00008 |
| C₉H₂₀ | 3,3-diethylpentane | 114.49416 | 114.455 | −0.00034 |
| C₉H₂₀ | 2,2,3,3-tetramethylpentane | 114.57402 | 114.494 | −0.00070 |
| C₉H₂₀ | 2,2,3,4-tetramethylpentane | 114.51960 | 114.492 | −0.00024 |
| C₉H₂₀ | 2,2,4,4-tetramethylpentane | 114.57316 | 114.541 | −0.00028 |
| C₉H₂₀ | 2,3,3,4-tetramethylpentane | 114.58266 | 114.484 | −0.00086 |
| C₁₀H₂₂ | 2-methylnonane | 126.64542 | 126.680 | 0.00027 |
| C₁₀H₂₂ | 5-methylnonane | 126.64542 | 126.663 | 0.00014 |

TABLE 100
Summary results of alkenes.

| | | Calculated | Experimental | |
|---|---|---|---|---|
| | | Total Bond | Total Bond | Relative |
| Formula | Name | Energy (eV) | Energy (eV) | Error |
| C₃H₆ | propene | 35.56033 | 35.63207 | 0.00201 |
| C₄H₈ | 1-butene | 47.71803 | 47.78477 | 0.00140 |
| C₄H₈ | trans-2-butene | 47.93116 | 47.90395 | −0.00057 |
| C₄H₈ | isobutene | 47.90314 | 47.96096 | 0.00121 |
| C₅H₁₀ | 1-pentene | 59.87573 | 59.95094 | 0.00125 |
| C₅H₁₀ | trans-2-pentene | 60.08886 | 60.06287 | −0.00043 |
| C₅H₁₀ | 2-methyl-1-butene | 60.06084 | 60.09707 | 0.00060 |
| C₅H₁₀ | 2-methyl-2-butene | 60.21433 | 60.16444 | −0.00083 |
| C₅H₁₀ | 3-methyl-1-butene | 59.97662 | 60.01727 | 0.00068 |
| C₆H₁₂ | 1-hexene | 72.03343 | 72.12954 | 0.00133 |
| C₆H₁₂ | trans-2-hexene | 72.24656 | 72.23733 | −0.00013 |
| C₆H₁₂ | trans-3-hexene | 72.24656 | 72.24251 | −0.00006 |
| C₆H₁₂ | 2-methyl-1-pentene | 72.21854 | 72.29433 | 0.00105 |
| C₆H₁₂ | 2-methyl-2-pentene | 72.37203 | 72.37206 | 0.00000 |
| C₆H₁₂ | 3-methyl-1-pentene | 72.13432 | 72.19173 | 0.00080 |
| C₆H₁₂ | 4-methyl-1-pentene | 72.10599 | 72.21038 | 0.00145 |
| C₆H₁₂ | 3-methyl-trans-2-pentene | 72.37203 | 72.33268 | −0.00054 |
| C₆H₁₂ | 4-methyl-trans-2-pentene | 72.34745 | 72.31610 | −0.00043 |
| C₆H₁₂ | 2-ethyl-1-butene | 72.21854 | 72.25909 | 0.00056 |
| C₆H₁₂ | 2,3-dimethyl-1-butene | 72.31943 | 72.32543 | 0.00008 |
| C₆H₁₂ | 3,3-dimethyl-1-butene | 72.31796 | 72.30366 | −0.00020 |
| C₆H₁₂ | 2,3-dimethyl-2-butene | 72.49750 | 72.38450 | −0.00156 |
| C₇H₁₄ | 1-heptene | 84.19113 | 84.27084 | 0.00095 |
| C₇H₁₄ | 5-methyl-1-hexene | 84.26369 | 84.30608 | 0.00050 |
| C₇H₁₄ | trans-3-methyl-3-hexene | 84.52973 | 84.42112 | −0.00129 |
| C₇H₁₄ | 2,4-dimethyl-1-pentene | 84.44880 | 84.49367 | 0.00053 |
| C₇H₁₄ | 4,4-dimethyl-1-pentene | 84.27012 | 84.47087 | 0.00238 |
| C₇H₁₄ | 2,4-dimethyl-2-pentene | 84.63062 | 84.54445 | −0.00102 |
| C₇H₁₄ | trans-4,4-dimethyl-2-pentene | 84.54076 | 84.54549 | 0.00006 |
| C₇H₁₄ | 2-ethyl-3-methyl-1-butene | 84.47713 | 84.44910 | −0.00033 |
| C₇H₁₄ | 2,3,3-trimethyl-1-butene | 84.51274 | 84.51129 | −0.00002 |
| C₈H₁₆ | 1-octene | 96.34883 | 96.41421 | 0.00068 |
| C₈H₁₆ | trans-2,2-dimethyl-3-hexene | 96.69846 | 96.68782 | −0.00011 |
| C₈H₁₆ | 3-ethyl-2-methyl-1-pentene | 96.63483 | 96.61113 | −0.00025 |
| C₈H₁₆ | 2,4,4-trimethyl-1-pentene | 96.61293 | 96.71684 | 0.00107 |
| C₈H₁₆ | 2,4,4-trimethyl-2-pentene | 96.67590 | 96.65880 | −0.00018 |
| C₁₀H₂₀ | 1-decene | 120.66423 | 120.74240 | 0.00065 |
| C₁₂H₂₄ | 1-dodecene | 144.97963 | 145.07163 | 0.00063 |
| C₁₆H₃₂ | 1-hexadecene | 193.61043 | 193.71766 | 0.00055 |

TABLE 101
Summary results of alkynes.

| | | Calculated | Experimental | |
|---|---|---|---|---|
| | | Total Bond | Total Bond | Relative |
| Formula | Name | Energy (eV) | Energy (eV) | Error |
| C₃H₄ | propyne | 29.42932 | 29.40432 | −0.00085 |
| C₄H₆ | 1-butyne | 41.58702 | 41.55495 | −0.00077 |
| C₄H₆ | 2-butyne | 41.72765 | 41.75705 | 0.00070 |
| C₉H₁₆ | 1-nonyne | 102.37552 | 102.35367 | −0.00021 |

TABLE 102
Summary results of alkyl fluorides.

| | | Calculated | Experimental | |
|---|---|---|---|---|
| | | Total Bond | Total Bond | Relative |
| Formula | Name | Energy (eV) | Energy (eV) | Error |
| CF₄ | tetrafluoromethane | 21.07992 | 21.016 | −0.00303 |
| CHF₃ | trifluoromethane | 19.28398 | 19.362 | 0.00405 |
| CH₂F₂ | difluoromethane | 18.22209 | 18.280 | 0.00314 |
| C₃H₇F | 1-fluoropropane | 41.86745 | 41.885 | 0.00041 |
| C₃H₇F | 2-fluoropropane | 41.96834 | 41.963 | −0.00012 |

TABLE 103
Summary results of alkyl chlorides.

| | | Calculated | Experimental | |
|---|---|---|---|---|
| | | Total Bond | Total Bond | Relative |
| Formula | Name | Energy (eV) | Energy (eV) | Error |
| CCl₄ | tetrachloromethane | 13.43181 | 13.448 | 0.00123 |
| CHCl₃ | trichloromethane | 14.49146 | 14.523 | 0.00217 |
| CH₂Cl₂ | dichloromethane | 15.37248 | 15.450 | 0.00499 |
| CH₃Cl | chloromethane | 16.26302 | 16.312 | 0.00299 |
| C₂H₅Cl | chloroethane | 28.61064 | 28.571 | −0.00138 |
| C₃H₇Cl | 1-chloropropane | 40.76834 | 40.723 | −0.00112 |
| C₃H₇Cl | 2-chloropropane | 40.86923 | 40.858 | −0.00028 |
| C₄H₉Cl | 1-chlorobutane | 52.92604 | 52.903 | −0.00044 |
| C₄H₉Cl | 2-chlorobutane | 53.02693 | 52.972 | −0.00104 |
| C₄H₉Cl | 1-chloro-2- | 52.99860 | 52.953 | −0.00085 |
| | methylpropane | | | |
| C₄H₉Cl | 2-chloro-2- | 53.21057 | 53.191 | −0.00037 |
| | methylpropane | | | |
| C₅H₁₁Cl | 1-chloropentane | 65.08374 | 65.061 | −0.00034 |
| C₅H₁₁Cl | 1-chloro-3- | 65.15630 | 65.111 | −0.00069 |
| | methylbutane | | | |
| C₅H₁₁Cl | 2-chloro-2- | 65.36827 | 65.344 | −0.00037 |
| | methylbutane | | | |
| C₅H₁₁Cl | 2-chloro-3- | 65.16582 | 65.167 | 0.00002 |
| | methylbutane | | | |
| C₆H₁₃Cl | 2-chlorohexane | 77.34233 | 77.313 | −0.00038 |
| C₈H₁₇Cl | 1-chlorooctane | 101.55684 | 101.564 | 0.00007 |
| C₁₂H₂₅Cl | 1-chlorododecane | 150.18764 | 150.202 | 0.00009 |
| C₁₈H₃₇Cl | 1-chlorooctadecane | 223.13384 | 223.175 | 0.00018 |

TABLE 104
Summary results of alkyl bromides.

| | | Calculated | Experimental | |
|---|---|---|---|---|
| | | Total Bond | Total Bond | Relative |
| Formula | Name | Energy (eV) | Energy (eV) | Error |
| CBr₄ | tetrabromomethane | 11.25929 | 11.196 | −0.00566 |
| CHBr₃ | tribromomethane | 12.87698 | 12.919 | 0.00323 |
| CH₃Br | bromomethane | 15.67551 | 15.732 | 0.00360 |
| C₂H₅Br | bromoethane | 28.03939 | 27.953 | −0.00308 |
| C₃H₇Br | 1-bromopropane | 40.19709 | 40.160 | −0.00093 |
| C₃H₇Br | 2-bromopropane | 40.29798 | 40.288 | −0.00024 |
| C₅H₁₀Br₂ | 2,3-dibromo-2- | 63.53958 | 63.477 | −0.00098 |
| | methylbutane | | | |
| C₆H₁₃Br | 1-bromohexane | 76.67019 | 76.634 | −0.00047 |
| C₇H₁₅Br | 1-bromoheptane | 88.82789 | 88.783 | −0.00051 |
| C₈H₁₇Br | 1-bromooctane | 100.98559 | 100.952 | −0.00033 |
| C₁₂H₂₅Br | 1-bromododecane | 149.61639 | 149.573 | −0.00029 |
| C₁₆H₃₃Br | 1-bromohexadecane | 198.24719 | 198.192 | −0.00028 |

TABLE 105
Summary results of alkyl iodides.

| | | Calculated | Experimental | |
|---|---|---|---|---|
| | | Total Bond | Total Bond | Relative |
| Formula | Name | Energy (eV) | Energy (eV) | Error |
| CHI₃ | triiodomethane | 10.35888 | 10.405 | 0.00444 |
| CH₂I₂ | diiodomethane | 12.94614 | 12.921 | −0.00195 |
| CH₃I | iodomethane | 15.20294 | 15.163 | −0.00263 |
| C₂H₅I | iodoethane | 27.36064 | 27.343 | −0.00066 |
| C₃H₇I | 1-iodopropane | 39.51834 | 39.516 | −0.00006 |
| C₃H₇I | 2-iodopropane | 39.61923 | 39.623 | 0.00009 |
| C₄H₉I | 2-iodo-2- | 51.96057 | 51.899 | −0.00119 |
| | methylpropane | | | |

TABLE 106
Summary results of alkene halides.

| | | Calculated | Experimental | |
|---|---|---|---|---|
| | | Total Bond | Total Bond | Relative |
| Formula | Name | Energy (eV) | Energy (eV) | Error |
| C₂H₃Cl | chloroethene | 22.46700 | 22.505 | 0.00170 |
| C₃H₅Cl | 2-chloropropene | 35.02984 | 35.05482 | 0.00071 |

TABLE 107
Summary results of alcohols.

| | | Calculated | Experimental | |
|---|---|---|---|---|
| | | Total Bond | Total Bond | Relative |
| Formula | Name | Energy (eV) | Energy (eV) | Error |
| CH₄O | methanol | 21.11038 | 21.131 | 0.00097 |
| C₂H₆O | ethanol | 33.40563 | 33.428 | 0.00066 |
| C₃H₈O | 1-propanol | 45.56333 | 45.584 | 0.00046 |
| C₃H₈O | 2-propanol | 45.72088 | 45.766 | 0.00098 |
| C₄H₁₀O | 1-butanol | 57.72103 | 57.736 | 0.00026 |
| C₄H₁₀O | 2-butanol | 57.87858 | 57.922 | 0.00074 |
| C₄H₁₀O | 2-methyl-1- | 57.79359 | 57.828 | 0.00060 |
| | propananol | | | |
| C₄H₁₀O | 2-methyl-2- | 58.15359 | 58.126 | −0.00048 |
| | propananol | | | |
| C₅H₁₂O | 1-pentanol | 69.87873 | 69.887 | 0.00011 |
| C₅H₁₂O | 2-pentanol | 70.03628 | 70.057 | 0.00029 |
| C₅H₁₂O | 3-pentanol | 70.03628 | 70.097 | 0.00087 |
| C₅H₁₂O | 2-methyl-1- | 69.95129 | 69.957 | 0.00008 |
| | butananol | | | |
| C₅H₁₂O | 3-methyl-1- | 69.95129 | 69.950 | −0.00002 |
| | butananol | | | |
| C₅H₁₂O | 2-methyl-2- | 70.31129 | 70.246 | −0.00092 |
| | butananol | | | |
| C₅H₁₂O | 3-methyl-2- | 69.96081 | 70.083 | 0.00174 |
| | butananol | | | |
| C₆H₁₄O | 1-hexanol | 82.03643 | 82.054 | 0.00021 |
| C₆H₁₄O | 2-hexanol | 82.19398 | 82.236 | 0.00052 |
| C₇H₁₆O | 1-heptanol | 94.19413 | 94.214 | 0.00021 |
| C₈H₁₈O | 1-octanol | 106.35183 | 106.358 | 0.00006 |
| C₈H₁₈O | 2-ethyl-1-hexananol | 106.42439 | 106.459 | 0.00032 |
| C₉H₂₀O | 1-nonanol | 118.50953 | 118.521 | 0.00010 |
| C₁₀H₂₂O | 1-decanol | 130.66723 | 130.676 | 0.00007 |
| C₁₂H₂₆O | 1-dodecanol | 154.98263 | 154.984 | 0.00001 |
| C₁₆H₃₄O | 1-hexadecanol | 203.61343 | 203.603 | −0.00005 |

TABLE 108
Summary results of ethers.

| | | Calculated | Experimental | |
|---|---|---|---|---|
| | | Total Bond | Total Bond | Relative |
| Formula | Name | Energy (eV) | Energy (eV) | Error |
| C₂H₆O | dimethyl ether | 32.84496 | 32.902 | 0.00174 |
| C₃H₈O | ethyl methyl ether | 45.19710 | 45.183 | −0.00030 |
| C₄H₁₀O | diethyl ether | 57.54924 | 57.500 | −0.00086 |
| C₄H₁₀O | methyl propyl ether | 57.35480 | 57.355 | 0.00000 |
| C₄H₁₀O | isopropyl methyl ether | 57.45569 | 57.499 | 0.00075 |
| C₆H₁₄O | dipropyl ether | 81.86464 | 81.817 | −0.00059 |
| C₆H₁₄O | diisopropyl ether | 82.06642 | 82.088 | 0.00026 |
| C₆H₁₄O | t-butyl ethyl ether | 82.10276 | 82.033 | −0.00085 |
| C₇H₁₆O | t-butyl isopropyl ether | 94.36135 | 94.438 | 0.00081 |
| C₈H₁₈O | dibutyl ether | 106.18004 | 106.122 | −0.00055 |
| C₈H₁₈O | di-sec-butyl ether | 106.38182 | 106.410 | 0.00027 |
| C₈H₁₈O | di-t-butyl ether | 106.36022 | 106.425 | 0.00061 |
| C₈H₁₈O | t-butyl isobutyl ether | 106.65628 | 106.497 | −0.00218 |

TABLE 109
Summary results of 1° amines.

| | | Calculated | Experimental | |
|---|---|---|---|---|
| | | Total Bond | Total Bond | Relative |
| Formula | Name | Energy (eV) | Energy (eV) | Error |
| CH₅N | methylamine | 23.88297 | 23.857 | −0.00110 |
| C₂H₇N | ethylamine | 36.04067 | 36.062 | 0.00060 |
| C₃H₉N | propylamine | 48.19837 | 48.243 | 0.00092 |
| C₄H₁₁N | butylamine | 60.35607 | 60.415 | 0.00098 |
| C₄H₁₁N | sec-butylamine | 60.45696 | 60.547 | 0.00148 |
| C₄H₁₁N | t-butylamine | 60.78863 | 60.717 | −0.00118 |
| C₄H₁₁N | isobutylamine | 60.42863 | 60.486 | 0.00094 |

TABLE 110
Summary results of 2° amines.

| | | Calculated | Experimental | |
|---|---|---|---|---|
| | | Total Bond | Total Bond | Relative |
| Formula | Name | Energy (eV) | Energy (eV) | Error |
| C₂H₇N | dimethylamine | 35.76895 | 35.765 | −0.00012 |
| C₄H₁₁N | diethylamine | 60.22930 | 60.211 | −0.00030 |
| C₆H₁₅N | dipropylamine | 84.54470 | 84.558 | 0.00016 |
| C₆H₁₅N | diisopropylamine | 84.74648 | 84.846 | 0.00117 |
| C₈H₁₉N | dibutylamine | 108.86010 | 108.872 | 0.00011 |
| C₈H₁₉N | diisobutylamine | 109.00522 | 109.106 | 0.00092 |

TABLE 111
Summary results of 3° amines.

| | | Calculated | Experimental | |
|---|---|---|---|---|
| | | Total Bond | Total Bond | Relative |
| Formula | Name | Energy (eV) | Energy (eV) | Error |
| C₃H₉N | trimethylamine | 47.83338 | 47.761 | −0.00152 |
| C₆H₁₅N | triethylamine | 84.30648 | 84.316 | 0.00012 |
| C₉H₂₁N | tripropylamine | 120.77958 | 120.864 | 0.00070 |

TABLE 112
Summary results of aldehydes.

| | | Calculated | Experimental | |
|---|---|---|---|---|
| | | Total Bond | Total Bond | Relative |
| Formula | Name | Energy (eV) | Energy (eV) | Error |
| CH₂O | formaldehyde | 15.64628 | 15.655 | 0.00056 |
| C₂H₄O | acetaldehyde | 28.18711 | 28.198 | 0.00039 |
| C₃H₆O | propanal | 40.34481 | 40.345 | 0.00000 |
| C₄H₈O | butanal | 52.50251 | 52.491 | −0.00022 |
| C₄H₈O | isobutanal | 52.60340 | 52.604 | 0.00001 |
| C₅H₁₀O | pentanal | 64.66021 | 64.682 | 0.00034 |
| C₇H₁₄O | heptanal | 88.97561 | 88.942 | −0.00038 |
| C₈H₁₆O | octanal | 101.13331 | 101.179 | 0.00045 |
| C₈H₁₆O | 2-ethylhexanal | 101.23420 | 101.259 | 0.00025 |

TABLE 113
Summary results of ketones.

| | | Calculated | Experimental | |
|---|---|---|---|---|
| | | Total Bond | Total Bond | Relative |
| Formula | Name | Energy (eV) | Energy (eV) | Error |
| C₃H₆O | acetone | 40.68472 | 40.672 | −0.00031 |
| C₄H₈O | 2-butanone | 52.84242 | 52.84 | −0.00005 |
| C₅H₁₀O | 2-pentanone | 65.00012 | 64.997 | −0.00005 |
| C₅H₁₀O | 3-pentanone | 65.00012 | 64.988 | −0.00005 |
| C₅H₁₀O | 3-methyl-2-butanone | 65.10101 | 65.036 | −0.00099 |
| C₆H₁₂O | 2-hexanone | 77.15782 | 77.152 | −0.00008 |
| C₆H₁₂O | 3-hexanone | 77.15782 | 77.138 | −0.00025 |
| C₆H₁₂O | 2-methyl-3-pentanone | 77.25871 | 77.225 | −0.00043 |
| C₆H₁₂O | 3,3-dimethyl-2- | 77.29432 | 77.273 | −0.00028 |
| | butanone | | | |
| C₇H₁₄O | 3-heptanone | 89.31552 | 89.287 | −0.00032 |
| C₇H₁₄O | 4-heptanone | 89.31552 | 89.299 | −0.00018 |
| C₇H₁₄O | 2,2-dimethyl-3- | 89.45202 | 89.458 | 0.00007 |
| | pentanone | | | |
| C₇H₁₄O | 2,4-dimethyl-3- | 89.51730 | 89.434 | −0.00093 |
| | pentanone | | | |
| C₈H₁₆O | 2,2,4-trimethyl-3- | 101.71061 | 101.660 | −0.00049 |
| | pentanone | | | |
| C₉H₁₈O | 2-nonanone | 113.63092 | 113.632 | 0.00001 |
| C₉H₁₈O | 5-nonanone | 113.63092 | 113.675 | 0.00039 |
| C₉H₁₈O | 2,6-dimethyl-4- | 113.77604 | 113.807 | 0.00027 |
| | heptanone | | | |

TABLE 114
Summary results of carboxylic acids.

| | | Calculated | Experimental | |
|---|---|---|---|---|
| | | Total Bond | Total Bond | Relative |
| Formula | Name | Energy (eV) | Energy (eV) | Error |
| CH₂O₂ | formic acid | 21.01945 | 21.036 | 0.00079 |
| C₂H₄O₂ | acetic acid | 33.55916 | 33.537 | −0.00066 |
| C₃H₆O₂ | propanoic acid | 45.71686 | 45.727 | 0.00022 |
| C₄H₈O₂ | butanoic acid | 57.87456 | 57.883 | 0.00015 |
| C₅H₁₀O₂ | pentanoic acid | 70.03226 | 69.995 | −0.00053 |
| C₅H₁₀O₂ | 3-methylbutanoic | 70.10482 | 70.183 | 0.00111 |
| | acid | | | |
| C₅H₁₀O₂ | 2,2- | 70.31679 | 69.989 | −0.00468 |
| | dimethylpropanoic | | | |
| | acid | | | |
| C₆H₁₂O₂ | hexanoic acid | 82.18996 | 82.149 | −0.00050 |
| C₇H₁₄O₂ | heptanoic acid | 94.34766 | 94.347 | 0.00000 |
| C₈H₁₆O₂ | octanoic acid | 106.50536 | 106.481 | −0.00022 |
| C₉H₁₈O₂ | nonanoic acid | 118.66306 | 118.666 | 0.00003 |
| C₁₀H₂₀O₂ | decanoic acid | 130.82076 | 130.795 | −0.00020 |
| C₁₂H₂₄O₂ | dodecanoic acid | 155.13616 | 155.176 | 0.00026 |
| C₁₄H₂₈O₂ | tetradecanoic acid | 179.45156 | 179.605 | 0.00085 |
| C₁₅H₃₀O₂ | pentadecanoic acid | 191.60926 | 191.606 | −0.00002 |
| C₁₆H₃₂O₂ | hexadecanoic acid | 203.76696 | 203.948 | 0.00089 |
| C₁₈H₃₆O₂ | stearic acid | 228.08236 | 228.298 | 0.00094 |
| C₂₀H₄₀O₂ | eicosanoic acid | 252.39776 | 252.514 | 0.00046 |

TABLE 115
Summary results of carboxylic acid esters.

| | | Calculated | Experimental | |
|---|---|---|---|---|
| | | Total Bond | Total Bond | Relative |
| Formula | Name | Energy (eV) | Energy (eV) | Error |
| C₂H₄O₂ | methyl formate | 32.71076 | 32.762 | 0.00156 |
| C₃H₆O₂ | methyl acetate | 45.24849 | 45.288 | 0.00087 |
| C₆H₁₂O₂ | methyl pentanoate | 81.72159 | 81.726 | 0.00005 |
| C₇H₁₄O₂ | methyl hexanoate | 93.87929 | 93.891 | 0.00012 |
| C₈H₁₆O₂ | methyl heptanoate | 106.03699 | 106.079 | 0.00040 |
| C₉H₁₈O₂ | methyl octanoate | 118.19469 | 118.217 | 0.00018 |
| C₁₀H₂₀O₂ | methyl nonanoate | 130.35239 | 130.373 | 0.00016 |
| C₁₁H₂₂O₂ | methyl decanoate | 142.51009 | 142.523 | 0.00009 |
| C₁₂H₂₄O₂ | methyl undecanoate | 154.66779 | 154.677 | 0.00006 |
| C₁₃H₂₆O₂ | methyl dodecanoate | 166.82549 | 166.842 | 0.00010 |
| C₁₄H₂₈O₂ | methyl tridecanoate | 178.98319 | 179.000 | 0.00009 |
| C₁₅H₃₀O₂ | methyl | 191.14089 | 191.170 | 0.00015 |
| | tetradecanoate | | | |
| C₁₆H₃₂O₂ | methyl | 203.29859 | 203.356 | 0.00028 |
| | pentadecanoate | | | |
| C₄H₈O₂ | propyl formate | 57.76366 | 57.746 | −0.00030 |
| C₄H₈O₂ | ethyl acetate | 57.63888 | 57.548 | −0.00157 |
| C₅H₁₀O₂ | isopropyl acetate | 69.89747 | 69.889 | −0.00013 |
| C₅H₁₀O₂ | ethyl propanoate | 69.79658 | 69.700 | −0.00139 |
| C₆H₁₂O₂ | butyl acetate | 81.95428 | 81.873 | −0.00099 |
| C₆H₁₂O₂ | t-butyl acetate | 82.23881 | 82.197 | −0.00051 |
| C₆H₁₂O₂ | methyl 2,2- | 82.00612 | 81.935 | −0.00087 |
| | dimethylpropanoate | | | |
| C₇H₁₄O₂ | ethyl pentanoate | 94.11198 | 94.033 | −0.00084 |
| C₇H₁₄O₂ | ethyl | 94.18454 | 94.252 | 0.00072 |
| | 3-methylbutanoate | | | |
| C₇H₁₄O₂ | ethyl 2,2- | 94.39651 | 94.345 | −0.00054 |
| | dimethylpropanoate | | | |
| C₈H₁₆O₂ | isobutyl | 106.44313 | 106.363 | −0.00075 |
| | isobutanoate | | | |
| C₈H₁₆O₂ | propyl pentanoate | 106.26968 | 106.267 | −0.00003 |
| C₈H₁₆O₂ | isopropyl pentanoate | 106.37057 | 106.384 | 0.00013 |
| C₉H₁₈O₂ | butyl pentanoate | 118.42738 | 118.489 | 0.00052 |
| C₉H₁₈O₂ | sec-butyl pentanoate | 118.52827 | 118.624 | 0.00081 |
| C₉H₁₈O₂ | isobutyl pentanoate | 118.49994 | 118.576 | 0.00064 |

TABLE 116
Summary results of amides.

| | | Calculated | Experimental | |
|---|---|---|---|---|
| | | Total Bond | Total Bond | Relative |
| Formula | Name | Energy (eV) | Energy (eV) | Error |
| CH₃NO | formamide | 23.68712 | 23.697 | 0.00041 |
| C₂H₅NO | acetamide | 36.15222 | 36.103 | −0.00135 |
| C₃H₇NO | propanamide | 48.30992 | 48.264 | −0.00094 |
| C₄H₉NO | butanamide | 60.46762 | 60.449 | −0.00030 |
| C₄H₉NO | 2- | 60.51509 | 60.455 | −0.00099 |
| | methylpropanamide | | | |
| C₅H₁₁NO | pentanamide | 72.62532 | 72.481 | −0.00200 |
| C₅H₁₁NO | 2,2- | 72.67890 | 72.718 | 0.00054 |
| | dimethyl- | | | |
| | propanamide | | | |
| C₆H₁₃NO | hexanamide | 84.78302 | 84.780 | −0.00004 |
| C₈H₁₇NO | octanamide | 109.09842 | 109.071 | −0.00025 |

TABLE 117
Summary results of N-alkyl and N,N-dialkyl amides.

| | | Calculated | Experimental | |
|---|---|---|---|---|
| | | Total Bond | Total Bond | Relative |
| Formula | Name | Energy (eV) | Energy (eV) | Error |
| C₃H₇NO | N,N- | 47.679454 | 47.574 | 0.00221 |
| | dimethylformamide | | | |
| C₄H₉NO | N,N- | 60.14455 | 59.890 | −0.00426 |
| | dimethylacetamide | | | |
| C₆H₁₃NO | N-butylacetamide | 84.63649 | 84.590 | −0.00055 |

TABLE 118
Summary results of urea.

| | | Calculated | Experimental | |
|---|---|---|---|---|
| | | Total Bond | Total Bond | Relative |
| Formula | Name | Energy (eV) | Energy (eV) | Error |
| CH₄N₂O | urea | 31.35919 | 31.393 | 0.00108 |

TABLE 119
Summary results of acid halide.

| | | Calculated | Experimental | |
|---|---|---|---|---|
| | | Total Bond | Total Bond | Relative |
| Formula | Name | Energy (eV) | Energy (eV) | Error |
| C₂H₃ClO | acetyl chloride | 28.02174 | 27.990 | −0.00115 |

TABLE 120
Summary results of acid anhydrides.

| | | Calculated | Experimental | |
|---|---|---|---|---|
| | | Total Bond | Total Bond | Relative |
| Formula | Name | Energy (eV) | Energy (eV) | Error |
| C₄H₆O₃ | acetic anhydride | 56.94096 | 56.948 | 0.00013 |
| C₆H₁₀O₃ | propanoic anhydride | 81.25636 | 81.401 | 0.00177 |

TABLE 121
Summary results of nitriles.

| | | Calculated | Experimental | |
|---|---|---|---|---|
| | | Total Bond | Total Bond | Relative |
| Formula | Name | Energy (eV) | Energy (eV) | Error |
| C₂H₃N | acetonitrile | 25.72060 | 25.77 | 0.00174 |
| C₃H₅N | propanenitrile | 37.87830 | 37.94 | 0.00171 |
| C₄H₇N | butanenitrile | 50.03600 | 50.08 | 0.00082 |
| C₄H₇N | 2-methyl- | 50.13689 | 50.18 | 0.00092 |
| | propanenitrile | | | |
| C₅H₉N | pentanenitrile | 62.19370 | 62.26 | 0.00111 |
| C₅H₉N | 2,2-dimethyl- | 62.47823 | 62.40 | −0.00132 |
| | propanenitrile | | | |
| C₇H₁₃N | heptanenitrile | 86.50910 | 86.59 | 0.00089 |
| C₈H₁₅N | octanenitrile | 98.66680 | 98.73 | 0.00069 |
| C₁₀H₁₉N | decanenitrile | 122.98220 | 123.05 | 0.00057 |
| C₁₄H₂₇N | tetradecanenitrile | 171.61300 | 171.70 | 0.00052 |

TABLE 122
Summary results of thiols.

| | | Calculated | Experimental | |
|---|---|---|---|---|
| | | Total Bond | Total Bond | Relative |
| Formula | Name | Energy (eV) | Energy (eV) | Error |
| HS | hydrogen sulfide | 3.77430 | 3.653 | −0.03320 |
| H₂S | dihydrogen sulfide | 7.56058 | 7.605 | 0.00582 |
| CH₄S | methanethiol | 19.60264 | 19.575 | −0.00141 |
| C₂H₆S | ethanethiol | 31.76034 | 31.762 | 0.00005 |
| C₃H₈S | 1-propanethiol | 43.91804 | 43.933 | 0.00035 |
| C₃H₈S | 2-propanethiol | 44.01893 | 44.020 | 0.00003 |
| C₄H₁₀S | 1-butanethiol | 56.07574 | 56.089 | 0.00024 |
| C₄H₁₀S | 2-butanethiol | 56.17663 | 56.181 | 0.00009 |
| C₄H₁₀S | 2-methyl-1- | 56.14830 | 56.186 | 0.00066 |
| | propanethiol | | | |
| C₄H₁₀S | 2-methyl-2- | 56.36027 | 56.313 | −0.00084 |
| | propanethiol | | | |
| C₅H₁₂S | 2-methyl-1- | 68.30600 | 68.314 | 0.00012 |
| | butanethiol | | | |
| C₅H₁₂S | 1-pentanethiol | 68.23344 | 68.264 | 0.00044 |
| C₅H₁₂S | 2-methyl-2- | 68.51797 | 68.441 | −0.00113 |
| | butanethiol | | | |
| C₅H₁₂S | 3-methyl-2- | 68.31552 | 68.381 | 0.00095 |
| | butanethiol | | | |
| C₅H₁₂S | 2,2-dimethyl-1- | 68.16441 | 68.461 | 0.00433 |
| | propanethiol | | | |
| C₆H₁₄S | 1-hexanethiol | 80.39114 | 80.416 | 0.00031 |
| C₆H₁₄S | 2-methyl-2- | 80.67567 | 80.607 | −0.00085 |
| | pentanethiol | | | |
| C₇H₁₆S | 1-heptanethiol | 92.54884 | 92.570 | 0.00023 |
| C₁₀H₂₂S | 1-decanethiol | 129.02194 | 129.048 | 0.00020 |

TABLE 123
Summary results of sulfides.

| | | Calculated | Experimental | |
|---|---|---|---|---|
| | | Total Bond | Total Bond | Relative |
| Formula | Name | Energy (eV) | Energy (eV) | Error |
| C₂H₆S | dimethyl sulfide | 31.65668 | 31.672 | 0.00048 |
| C₃H₈S | ethyl methyl sulfide | 43.81438 | 43.848 | 0.00078 |
| C₄H₁₀S | diethyl sulfide | 55.97208 | 56.043 | 0.00126 |
| C₄H₁₀S | methyl propyl | 55.97208 | 56.029 | 0.00102 |
| | sulfide | | | |
| C₄H₁₀S | isopropyl methyl | 56.07297 | 56.115 | 0.00075 |
| | sulfide | | | |
| C₅H₁₂S | butyl methyl sulfide | 68.12978 | 68.185 | 0.00081 |
| C₅H₁₂S | t-butyl methyl | 68.28245 | 68.381 | 0.00144 |
| | sulfide | | | |
| C₅H₁₂S | ethyl propyl sulfide | 68.12978 | 68.210 | 0.00117 |
| C₅H₁₂S | ethyl isopropyl | 68.23067 | 68.350 | 0.00174 |
| | sulfide | | | |
| C₆H₁₄S | diisopropyl sulfide | 80.48926 | 80.542 | 0.00065 |
| C₆H₁₄S | butyl ethyl sulfide | 80.28748 | 80.395 | 0.00133 |
| C₆H₁₄S | methyl pentyl | 80.28748 | 80.332 | 0.00056 |
| | sulfide | | | |
| C₈H₁₈S | dibutyl sulfide | 104.60288 | 104.701 | 0.00094 |
| C₈H₁₈S | di-sec-butyl sulfide | 104.80466 | 104.701 | −0.00099 |
| C₈H₁₈S | di-t-butyl sulfide | 104.90822 | 104.920 | 0.00011 |
| C₈H₁₈S | diisobutyl sulfide | 104.74800 | 104.834 | 0.00082 |
| C₁₀H₂₂S | dipentyl sulfide | 128.91828 | 128.979 | 0.00047 |
| C₁₀H₂₂S | diisopentyl sulfide | 129.06340 | 129.151 | 0.00068 |

TABLE 124
Summary results of disulfides.

| | | Calculated | Experimental | |
|---|---|---|---|---|
| | | Total Bond | Total Bond | Relative |
| Formula | Name | Energy (eV) | Energy (eV) | Error |
| C₂H₆S₂ | dimethyl disulfide | 34.48127 | 34.413 | −0.00199 |
| C₄H₁₀S₂ | diethyl disulfide | 58.79667 | 58.873 | 0.00129 |
| C₆H₁₄S₂ | dipropyl disulfide | 83.11207 | 83.169 | 0.00068 |
| C₈H₁₈S₂ | di-t-butyl disulfide | 107.99653 | 107.919 | −0.00072 |

TABLE 125
Summary results of sulfoxides.

| | | Calculated | Experimental | |
|---|---|---|---|---|
| | | Total Bond | Total Bond | Relative |
| Formula | Name | Energy (eV) | Energy (eV) | Error |
| C₂H₆SO | dimethyl sulfoxide | 35.52450 | 35.435 | −0.00253 |
| C₄H₁₀SO | diethyl sulfoxide | 59.83990 | 59.891 | 0.00085 |
| C₆H₁₄SO | dipropyl sulfoxide | 84.15530 | 84.294 | 0.00165 |

TABLE 126
Summary results of sulfones.

| | | Calculated | Experimental | |
|---|---|---|---|---|
| | | Total Bond | Total Bond | Relative |
| Formula | Name | Energy (eV) | Energy (eV) | Error |
| C₂H₆SO₂ | dimethyl sulfone | 40.27588 | 40.316 | 0.00100 |

TABLE 127
Summary results of sulfites.

| | | Calculated | Experimental | |
|---|---|---|---|---|
| | | Total Bond | Total Bond | Relative |
| Formula | Name | Energy (eV) | Energy (eV) | Error |
| C₂H₆SO₃ | dimethyl sulfite | 43.95058 | 44.042 | 0.00207 |
| C₄H₁₀SO₃ | diethyl sulfite | 68.54939 | 68.648 | 0.00143 |
| C₈H₁₈SO₃ | dibutyl sulfite | 117.18019 | 117.191 | 0.00009 |

TABLE 128
Summary results of sulfates.

| | | Calculated | Experimental | |
|---|---|---|---|---|
| | | Total Bond | Total Bond | Relative |
| Formula | Name | Energy (eV) | Energy (eV) | Error |
| C₂H₆SO₄ | dimethyl sulfate | 48.70196 | 48.734 | 0.00067 |
| C₄H₁₀SO₄ | diethyl sulfate | 73.30077 | 73.346 | 0.00061 |
| C₆H₁₄SO₄ | dipropyl sulfate | 97.61617 | 97.609 | −0.00008 |

TABLE 129
Summary results of nitro alkanes.

| | | Calculated | Experimental | |
|---|---|---|---|---|
| | | Total Bond | Total Bond | Relative |
| Formula | Name | Energy (eV) | Energy (eV) | Error |
| CH₃NO₂ | nitromethane | 25.14934 | 25.107 | −0.00168 |
| C₂H₅NO₂ | nitroethane | 37.30704 | 37.292 | −0.00040 |
| C₃H₇NO₂ | 1-nitropropane | 49.46474 | 49.451 | −0.00028 |
| C₃H₇NO₂ | 2-nitropropane | 49.56563 | 49.602 | 0.00074 |
| C₄H₉NO₂ | 1-nitrobutane | 61.62244 | 61.601 | −0.00036 |
| C₄H₉NO₂ | 2-nitroisobutane | 61.90697 | 61.945 | 0.00061 |
| C₅H₁₁NO₂ | 1-nitropentane | 73.78014 | 73.759 | −0.00028 |

TABLE 130
Summary results of nitrite.

| | | Calculated | Experimental | |
|---|---|---|---|---|
| | | Total Bond | Total Bond | Relative |
| Formula | Name | Energy (eV) | Energy (eV) | Error |
| CH₃NO₂ | methyl nitrite | 24.92328 | 24.955 | 0.00126 |

TABLE 131
Summary results of nitrate.

| | | Calculated | Experimental | |
|---|---|---|---|---|
| | | Total Bond | Total Bond | Relative |
| Formula | Name | Energy (eV) | Energy (eV) | Error |
| CH₃NO₃ | methyl nitrate | 28.18536 | 28.117 | −0.00244 |
| C₂H₅NO₃ | ethyl nitrate | 40.34306 | 40.396 | 0.00131 |
| C₃H₇NO₃ | propyl nitrate | 52.50076 | 52.550 | 0.00093 |
| C₃H₇NO₃ | isopropyl nitrate | 52.60165 | 52.725 | 0.00233 |

TABLE 132
Summary results of conjugated alkenes.

| | | Calculated | Experimental | |
|---|---|---|---|---|
| | | Total Bond | Total Bond | Relative |
| Formula | Name | Energy (eV) | Energy (eV) | Error |
| C₅H₈ | cyclopentene | 54.83565 | 54.86117 | 0.00047 |
| C₄H₆ | 1,3 butadiene | 42.09159 | 42.12705 | 0.00084 |
| C₅H₈ | 1,3 pentadiene | 54.40776 | 54.42484 | 0.00031 |
| C₅H₈ | 1,4 pentadiene | 54.03745 | 54.11806 | 0.00149 |
| C₅H₆ | 1,3 cyclopentadiene | 49.27432 | 49.30294 | 0.00058 |

TABLE 133
Summary results of aromatics and heterocyclic aromatics.

| | | Calculated | Experimental | |
|---|---|---|---|---|
| | | Total Bond | Total Bond | Relative |
| Formula | Name | Energy (eV) | Energy (eV) | Error |
| C₆H₆ | benzene | 57.26008 | 57.26340 | 0.00006 |
| C₆H₅Cl | fluorobenzene | 57.93510 | 57.887 | −0.00083 |
| C₆H₅Cl | chlorobenzene | 56.55263 | 56.581 | 0.00051 |
| C₆H₄Cl₂ | m-dichlorobenzene | 55.84518 | 55.852 | 0.00012 |
| C₆H₃Cl₃ | 1,2,3- | 55.13773 | 55.077 | −0.00111 |
| | trichlorobenzene | | | |
| C₆H₃Cl₃ | 1,3,5- | 55.29542 | 55.255 | −0.00073 |
| | trichlorbenzene | | | |
| C₆Cl₆ | hexachlorobenzene | 52.57130 | 52.477 | −0.00179 |
| C₆H₅Br | bromobenzene | 56.17932 | 56.391^{a} | 0.00376 |
| C₆H₅I | iodobenzene | 55.25993 | 55.261 | 0.00001 |
| C₆H₅NO₂ | nitrobenzene | 65.18754 | 65.217 | 0.00046 |
| C₇H₈ | toluene | 69.48425 | 69.546 | 0.00088 |
| C₇H₆O₂ | benzoic acid | 73.76938 | 73.762 | −0.00009 |
| C₇H₅ClO₂ | 2-chlorobenzoic | 73.06193 | 73.082 | 0.00027 |
| | acid | | | |
| C₇H₅ClO₂ | 3-chlorobenzoic | 73.26820 | 73.261 | −0.00010 |
| | acid | | | |
| C₆H₇N | aniline | 64.43373 | 64.374 | −0.00093 |
| C₇H₉N | 2-methylaniline | 76.62345 | 76.643 | −0.00025 |
| C₇H₉N | 3-methylaniline | 76.62345 | 76.661 | 0.00050 |
| C₇H₉N | 4-methylaniline | 76.62345 | 76.654 | 0.00040 |
| C₆H₆N₂O₂ | 2-nitroaniline | 72.47476 | 72.424 | −0.00070 |
| C₆H₆N₂O₂ | 3-nitroaniline | 72.47476 | 72.481 | −0.00009 |
| C₆H₆N₂O₂ | 4-nitroaniline | 72.47476 | 72.476 | −0.00002 |
| C₇H₇NO₂ | aniline-2-carboxylic | 80.90857 | 80.941 | 0.00041 |
| | acid | | | |
| C₇H₇NO₂ | aniline-3-carboxylic | 80.90857 | 80.813 | −0.00118 |
| | acid | | | |
| C₇H₇NO₂ | aniline-4-carboxylic | 80.90857 | 80.949 | 0.00050 |
| | acid | | | |
| C₆H₆O | phenol | 61.75817 | 61.704 | −0.00087 |
| C₆H₄N₂O₅ | 2,4-dinitrophenol | 77.61308 | 77.642 | 0.00037 |
| C₆H₈O | anisole | 73.39006 | 73.355 | −0.00047 |
| C₁₀H₈ | naphthalene | 90.74658 | 90.79143 | 0.00049 |
| C₄H₅N | pyrrole | 44.81090 | 44.785 | −0.00057 |
| C₄H₄O | furan | 41.67782 | 41.692 | 0.00033 |
| C₄H₄S | thiophene | 40.42501 | 40.430 | 0.00013 |
| C₃H₄N₂ | imidazole | 39.76343 | 39.74106 | −0.00056 |
| C₅H₅N | pyridine | 51.91802 | 51.87927 | −0.00075 |
| C₄H₄N₂ | pyrimidine | 46.57597 | 46.51794 | −0.00125 |
| C₄H₄N₂ | pyrazine | 46.57597 | 46.51380 | 0.00095 |
| C₉H₇N | quinoline | 85.40453 | 85.48607 | 0.00178 |
| C₉H₇N | isoquinoline | 85.40453 | 85.44358 | 0.00046 |
| C₈H₇N | indole | 78.52215 | 78.514 | −0.00010 |

^{a}Liquid.

TABLE 134
Summary results of DNA bases.

| | | Calculated | Experimental | |
|---|---|---|---|---|
| | | Total Bond | Total Bond | Relative |
| Formula | Name | Energy (eV) | Energy (eV) | Error |
| C₅H₅N₅ | adenine | 70.85416 | 70.79811 | −0.00079 |
| C₅H₆N₂O₂ | thymine | 69.08792 | 69.06438 | −0.00034 |
| C₅H₅N₅O | guanine | 76.88212 | 77.41849 | −0.00055 |
| C₄H₅N₃O | cytosine | 59.53378 | 60.58056 | 0.01728 |

TABLE 135
Summary results of alkyl phosphines.

| | | Calculated | Experimental | |
|---|---|---|---|---|
| | | Total Bond | Total Bond | Relative |
| Formula | Name | Energy (eV) | Energy (eV) | Error |
| C₃H₉P | trimethylphosphine | 45.80930 | 46.87333 | 0.02270 |
| C₆H₁₅P | triethylphosphine | 82.28240 | 82.24869 | −0.00041 |
| C₁₈H₁₅P | triphenylphosphine | 168.40033 | 167.46591 | −0.00558 |

TABLE 136
Summary results of alkyl phosphites.

| | | Calculated | Experimental | |
|---|---|---|---|---|
| | | Total Bond | Total Bond | Relative |
| Formula | Name | Energy (eV) | Energy (eV) | Error |
| C₃H₉O₃P | trimethyl phosphite | 61.06764 | 60.94329 | −0.00204 |
| C₆H₁₅O₃P | triethyl phosphite | 98.12406 | 97.97947 | −0.00148 |
| C₉H₂₁O₃P | tri-isopropyl | 134.89983 | 135.00698 | 0.00079 |
| | phosphite | | | |

TABLE 137
Summary results of alkyl phosphine oxides.

| | | Calculated | Experimental | |
|---|---|---|---|---|
| | | Total Bond | Total Bond | Relative |
| Formula | Name | Energy (eV) | Energy (eV) | Error |
| C₃H₉PO | trimethylphosphine | 53.00430 | 52.91192 | −0.00175 |
| | oxide | | | |

TABLE 138
Summary results of alkyl phosphates.

| | | Calculated | Experimental | |
|---|---|---|---|---|
| | | Total Bond | Total Bond | Relative |
| Formula | Name | Energy (eV) | Energy (eV) | Error |
| C₆H₁₅O₄P | triethyl phosphate | 105.31906 | 104.40400 | −0.00876 |
| C₉H₂₁O₄P | tri-n-propyl | 141.79216 | 140.86778 | −0.00656 |
| | phosphate | | | |
| C₉H₂₁O₄P | tri-isopropyl | 142.09483 | 141.42283 | −0.00475 |
| | phosphate | | | |
| C₉H₂₇O₄P | tri-n-butyl | 178.26526 | 178.07742 | −0.00105 |
| | phosphate | | | |

TABLE 139
Summary results of monosaccharides of DNA and RNA.

| | | Calculated | Experimental | |
|---|---|---|---|---|
| | | Total Bond | Total Bond | Relative |
| Formula | Name | Energy (eV) | Energy (eV) | Error |
| C₅H₁₀O₄ | 2-deoxy-D-ribose | 77.25842 | | |
| C₅H₁₀O₅ | D-ribose | 81.51034 | 83.498^{a} | 0.02381 |
| C₅H₁₀O₄ | alpha-2-deoxy-D- | 77.46684 | | |
| | ribose | | | |
| C₅H₁₀O₅ | alpha-D-ribose | 82.31088 | | |

^{a}Crystal

TABLE 140
Summary results of amino acids.

| | | Calculated | Experimental | |
|---|---|---|---|---|
| | | Total Bond | Total Bond | Relative |
| Formula | Name | Energy (eV) | Energy (eV) | Error |
| C₄H₇NO₄ | aspartic acid | 68.98109 | 70.843^{a} | 0.02628 |
| C₅H₉NO₄ | glutamic acid | 81.13879 | 83.167^{a} | 0.02438 |
| C₃H₇NO₄S | cysteine | 55.02457 | 56.571^{a} | 0.02733 |
| C₆H₁₄N₂O₂ | lysine | 95.77799 | 98.194^{a} | 0.02461 |
| C₆H₁₄N₂O₂ | arginine | 105.07007 | 107.420^{a} | 0.02188 |
| C₆H₉N₃O₂ | histidine | 88.10232 | 89.599^{a} | 0.01671 |
| C₄H₈N₂O₂ | asparagine | 71.57414 | 73.513^{a} | 0.02637 |
| C₅H₁₀N₂O₂ | glutamine | 83.73184 | 85.843^{a} | 0.02459 |
| C₄H₉NO₃ | threonine | 68.95678 | 71.058^{a} | 0.02956 |
| C₉H₁₁NO₃ | tyrosine | 109.40427 | 111.450^{a} | 0.01835 |
| C₃H₇NO₃ | serine | 56.66986 | 58.339^{a} | 0.02861 |
| C₁₁H₁₂N₂O₂ | tryptophan | 126.74291 | 128.084^{a} | 0.01047 |
| C₉H₁₁NO₂ | phenylalanine | 104.90618 | 105.009 | 0.00098 |
| C₅H₉NO₂ | proline | 71.76826 | 71.332 | −0.00611 |
| C₅H₉NO₂ | methionine | 79.23631 | 79.214 | −0.00028 |
| C₆H₁₃NO₂ | leucine | 89.12115 | 89.047 | −0.00083 |
| C₆H₁₃NO₂ | isoleucine | 89.02978 | 90.612 | 0.01746 |
| C₆H₁₃NO₂ | valine | 76.87208 | 76.772 | −0.00130 |
| C₃H₇NO₂ | alanine | 52.57549 | 52.991 | 0.00785 |
| C₂H₅NO₂ | glycine | 40.28857 | 40.280 | −0.00021 |

^{a}Crystal

### REFERENCES

1. D. R. Lide, CRC Handbook of Chemistry and Physics, 86th Edition, CRC Press, Taylor & Francis, Boca Raton, (2005-6), pp. 9-19 to 9-45.
2. G. Herzberg, Molecular Spectra and Molecular Structure II. Infrared and Raman Spectra of Polyatomic Molecules, Van Nostrand Reinhold Company, New York, N.Y., (1945), p. 344.
3. D. R. Lide, CRC Handbook of Chemistry and Physics, 86th Edition, CRC Press, Taylor & Francis, Boca Raton, (2005-6), pp. 9-63; 5-18 to 5-42.
4. R. J. Fessenden, J. S. Fessenden, Organic Chemistry, Willard Grant Press. Boston, Mass., (1979), p. 320.
5. cyclohexane at http://webbook.nist.gov/.
6. G. Herzberg, Molecular Spectra and Molecular Structure II. Infrared and Raman Spectra of Polyatomic Molecules, Van Nostrand Reinhold Company, New York, N.Y., (1945), p. 326.
7. b1 2-methyl-1-propene at http://webbook.nist.gov/.
8. a1 2-methyl-1-propene at http://webbook.nist.gov/.
9. 2-butyne at http://webbook.nist.gov/.
10. trifluoromethane at http://webbook.nist.gov/.
11. fluoroethane at http://webbook.nist.gov/.
12. G. Herzberg, Molecular Spectra and Molecular Structure II. Infrared and Raman Spectra of Polyatomic Molecules, Krieger Publishing Company, Malabar, Fla., (1991), p. 195.
13. chloromethane at http://webbook.nist.gov/.
14. methyl bromide at http://webbook.nist.gov/.
15. tetrabromomethane at http://webbook.nist.gov/.
16. methyl iodide at http://webbook.nist.gov/.
17. K. P. Huber, G. Herzberg, Molecular Spectra and Molecular Structure, IV. Constants of Diatomic Molecules, Van Nostrand Reinhold Company, New York, (1979).
18. J. Crovisier, Molecular Database—Constants for molecules of astrophysical interest in the gas phase: photodissociation, microwave and infrared spectra, Ver. 4.2, Observatoire de Paris, Section de Meudon, Meudon, France, May 2002, pp. 34-37, available at http://wwwusr.obspm.fr/˜crovisie/.
19. methanol at http://webbook.nist.gov/.
20. D. Lin-Vien. N. B. Colthup, W. G. Fateley, J. G. Grasselli, The Handbook of Infrared and Raman Frequencies of Organic Molecules, Academic Press, Inc., Harcourt Brace Jovanovich, Boston, (1991), p. 46.
21. dimethyl ether at http://webbook.nist.gov/.
22. T. Amano, P. F. Bernath, R. W. McKellar, “Direct observation of the v₁ and v₃ fundamental bands of NH₂ by difference frequency laser spectroscopy,” J. Mol. Spectrosc., Vol. 94, (1982), pp. 100-113.
23. methylamine at http://webbook.nist.gov/.
24. D. R. Lide, CRC Handbook of Chemistry and Physics, 79th Edition, CRC Press, Boca Raton, Fla., (1998-9), pp. 9-80 to 9-86.
25. D. Lin-Vien. N. B. Colthup, W. G. Fateley, J. G. Grasselli, The Handbook of Infrared and Raman Frequencies of Organic Molecules, Academic Press, Inc., Harcourt Brace Jovanovich, Boston, (1991), p. 482.
26. acetaldehyde at http://webbook.nist.gov/.
27. acetone at http://webbook.nist.gov/.
28. 2-butanone at http://webbook.nist.gov/.
29. acetic acid at http://webbook.nist.gov/.
30. formic acid at http://webbook.nist.gov/.
31. D. Lin-Vien. N. B. Colthup, W. G. Fateley, J. G. Grasselli, The Handbook of Infrared and Raman Frequencies of Organic Molecules, Academic Press, Inc., Harcourt Brace Jovanovich, Boston, (1991), p. 138.
32. methyl formate at http://webbook.nist.gov/.
33. D. Lin-Vien. N. B. Colthup, W. G. Fateley, J. G. Grasselli, The Handbook of Infrared and Raman Frequencies of Organic Molecules, Academic Press, Inc., Harcourt Brace Jovanovich, Boston, (1991), p. 144.
34. D. Lin-Vien. N. B. Colthup, W. G. Fateley, J. G. Grasselli, The Handbook of Infrared and Raman Frequencies of Organic Molecules, Academic Press, Inc., Harcourt Brace Jovanovich, Boston, (1991), p. 147.
35. D. Lin-Vien. N. B. Colthup, W. G. Fateley, J. G. Grasselli, The Handbook of Infrared and Raman Frequencies of Organic Molecules, Academic Press, Inc., Harcourt Brace Jovanovich, Boston, (1991), p. 143.
36. H. J. Vledder, F. C. Mijlhoff, J. C. Leyte, C. Romers, “An electron diffraction investigation of the molecular structure of gaseous acetic anhydride,” Journal of Molecular Structure, Vol. 7, Issues 3-4, (1971), pp. 421-429.
37. acetonitrile at http://webbook.nist.gov/.
38. D. R. Lide, CRC Handbook of Chemistry and Physics, 86th Edition, CRC Press, Taylor & Francis, Boca Raton, (2005-6), pp. 10-202 to 10-204.
39. D. R. Lide, CRC Handbook of Chemistry and Physics, 86th Edition, CRC Press, Taylor & Francis, Boca Raton, (2005-6), p. 9-79.
40. D. R. Lide, CRC Handbook of Chemistry and Physics, 86th Edition, CRC Press, Taylor & Francis, Boca Raton, (2005-6), pp. 9-82 to 9-86.
41. thiirane at http://webbook.nist.gov/.
42. D. Lin-Vien. N. B. Colthup, W. G. Fateley, J. G. Grasselli, The Handbook of Infrared and Raman Frequencies of Organic Molecules, Academic Press, Inc., Harcourt Brace Jovanovich, Boston, (1991), p. 242.
43. D. Lin-Vien. N. B. Colthup, W. G. Fateley, J. G. Grasselli, The Handbook of Infrared and Raman Frequencies of Organic Molecules, Academic Press, Inc., Harcourt Brace Jovanovich, Boston, (1991), p. 241.
44. R. M. Ibberson, M. T. F. Telling, S. Parsons, “Structural determination and phase transition behavior of dimethyl sulfate,” Acta. Cryst., Vol. B62, (2006), pp. 280-286.
45. D. Lin-Vien. N. B. Colthup, W. G. Fateley, J. G. Grasselli, The Handbook of Infrared and Raman Frequencies of Organic Molecules, Academic Press, Inc., Harcourt Brace Jovanovich, Boston, (1991), p. 187.
46. D. Lin-Vien. N. B. Colthup, W. G. Fateley, J. G. Grasselli, The Handbook of Infrared and Raman Frequencies of Organic Molecules, Academic Press, Inc., Harcourt Brace Jovanovich, Boston, (1991), p. 480.
47. D. Lin-Vien. N. B. Colthup, W. G. Fateley, J. G. Grasselli, The Handbook of Infrared and Raman Frequencies of Organic Molecules, Academic Press, Inc., Harcourt Brace Jovanovich, Boston, (1991), p. 187.
48. 1,3-butadiene at http://webbook.nist.gov/.
49. G. Herzberg, Molecular Spectra and Molecular Structure II. Infrared and Raman Spectra of Polyatomic Molecules, Van Nostrand Reinhold Company, New York, N.Y., (1945), pp. 362-369.
50. W. I. F. David, R. M. Ibberson, G. A. Jeffrey, J. R. Ruble, “The structure analysis of deuterated benzene and deuterated nitromethane by pulsed-neutron powder diffraction: a comparison with single crystal neutron analysis,” Physica B (1992), 180 & 181, pp. 597-600.
51. G. A. Jeffrey, J. R. Ruble, R. K. McMullan, J. A. Pople, “The crystal structure of deuterated benzene,” Proceedings of the Royal Society of London. Series A, Mathematical and Physical Sciences, Vol. 414, No. 1846, (Nov. 9, 1987), pp. 47-57.
52. H. B. Burgi, S. C. Capelli, “Getting more out of crystal-structure analyses,” Helvetica Chimica Acta, Vol. 86, (2003), pp. 1625-1640.
53. D. Lin-Vien. N. B. Colthup, W. G. Fateley, J. G. Grasselli, The Handbook of Infrared and Raman Frequencies of Organic Molecules, Academic Press, Inc., Harcourt Brace Jovanovich, Boston, (1991), p. 481.
54. E. Csakvari, I. Hargittai, “Molecular structure of 2,6-difluorobenzamine and 2-fluorobenzamine from gas-phase electron diffraction,” J. Phys. Chem., Vol. 96, (1992), pp. 5837-5842.
55. E. Rosenthal, B. P. Dailey, “Microwave spectrum of bromobenzene, its structure, quadrupole coupling constants, and carbon-bromine bond,” Journal of Chemical Physics, Vol. 43, No. 6, (1965), pp. 2093-2110.
56. H. J. M. Bowen, Tables of Interatomic Distances and Configuration in Molecules and Ions, L. Sutton, Editor, Special Publication No. 11, The Chemical Society, Burlington House, London (1958).
57. R. Boese, D. Blaser, M. Nussbaumer, T. M. Krygowski, “Low temperature crystal and molecular structure of nitrobenzene,” Structural Chemistry, Vol. 3, No. 5, (1992), pp. 363-368.
58. G. A. Sim, J. M. Robertson, T. H. Goodwin, “The crystal and molecular structure of benzoic acid,” Acta Cryst., Vol. 8, (1955), pp. 157-164.
59. D. Lin-Vien. N. B. Colthup, W. G. Fateley, J. G. Grasselli, The Handbook of Infrared and Raman Frequencies of Organic Molecules, Academic Press, Inc., Harcourt Brace Jovanovich, Boston, (1991), p. 301.
60. D. Lin-Vien. N. B. Colthup, W. G. Fateley, J. G. Grasselli, The Handbook of Infrared and Raman Frequencies of Organic Molecules, Academic Press, Inc., Harcourt Brace Jovanovich, Boston, (1991), p. 303.
61. D. Lin-Vien. N. B. Colthup, W. G. Fateley, J. G. Grasselli, The Handbook of Infrared and Raman Frequencies of Organic Molecules, Academic Press, Inc., Harcourt Brace Jovanovich, Boston, (1991), p. 207.
62. S. Martinez-Carrera, “The crystal structure of Imidazole at −150° C.,” Acta. Cryst., Vol. 20, (1966), pp. 783-789.
63. D. Lin-Vien. N. B. Colthup, W. G. Fateley, J. G. Grasselli, The Handbook of Infrared and Raman Frequencies of Organic Molecules, Academic Press, Inc., Harcourt Brace Jovanovich, Boston, (1991), pp. 296-297.
64. S. Arnott, S. D. Dover, A. J. Wonacott, “Least-squares refinement of the crystal and molecular structures of DNA and RNA from X-ray data and standard bond lengths and angles,” Acta. Cryst., Vol. B-25, (1969), pp. 2192-2206.
65. H. Sternglanz, C. E. Bugg, “Conformations of N⁶-monosubstituted adenine derivatives crystal structure of N⁶-methyladenine,” Biochimica et Biophysica Acta, Vol. 308, (1973), pp. 1-8.
66. B. Chase, N. Herron, E. Holler, “Vibrational spectroscopy of C₆₀ and C₇₀ temperature-dependent studies,” J. Phys. Chem., Vol. 96, (1992), pp. 4262-4266.
67. D. Lin-Vien. N. B. Colthup, W. G. Fateley, J. G. Grasselli, The Handbook of Infrared and Raman Frequencies of Organic Molecules, Academic Press, Inc., Harcourt Brace Jovanovich, Boston, (1991), p. 272.
68. J. D. Cox, G. Pilcher, Thermochemistry of Organometallic Compounds, Academic Press, New York, (1970), pp. 478-485.
69. M. G. Newton, B. S. Campbell, “Preparation and crystal structures of trans-methyl meso-hydrobenzoin phosphite and phosphate,” JACS, Vol. 96, No. 25, (1974), pp. 7790-7797.
70. D. Lin-Vien. N. B. Colthup, W. G. Fateley, J. G. Grasselli, The Handbook of Infrared and Raman Frequencies of Organic Molecules, Academic Press, Inc., Harcourt Brace Jovanovich, Boston, (1991), p. 271.
71. J. C. J. Bart, G. Favini, R. Todeschini, “Conformational analysis of trimethylphoshite and its metal complexes,” Phosphorous and Sulfur, Gordon and Breach Scientific Publishers, Inc. USA, Vol. 17, (1983), pp. 205-220.
72. N. J. Goodwin, W. Henderson, B. K. Nicholson, “Hydrogen bonding in hydroxymethylphosphine chalcogenides,” Inorganica Chimica Acta, Vol. 335, (2002), pp. 113-118.
73. M. W. Chase, Jr., C. A. Davies, J. R. Downey, Jr., D. J. Frurip, R. A. McDonald, A. N. Syverud, JANAF Thermochemical Tables, Third Edition, Part II, Cr—Zr, J. Phys. Chem. Ref. Data, Vol. 14, Suppl. 1, (1985), p. 1728.
74. D. Lin-Vien. N. B. Colthup, W. G. Fateley, J. G. Grasselli, The Handbook of Infrared and Raman Frequencies of Organic Molecules, Academic Press, Inc., Harcourt Brace Jovanovich, Boston, (1991), p. 269.

Germanium Organometallic Functional Groups and Molecules

The branched-chain alkyl germanium molecules, GeCₙH₂ₙ₋₂, comprise at least one Ge bound by a carbon-germanium single bond comprising a C—Ge group, and the digermanium molecules further comprise a Ge—Ge functional group. Both comprise at least a terminal methyl group (CH₃) and may comprise methylene (CH₂), methylyne (CH), and C—C functional groups. The methyl and methylene functional groups are equivalent to those of straight-chain alkanes. Six types of C—C bonds can be identified. The n-alkane C—C bond is the same as that of straight-chain alkanes. In addition, the C—C bonds within isopropyl ((CH₃)₂CH) and t-butyl ((CH₃)₃C) groups and the isopropyl to isopropyl, isopropyl to t-butyl, and t-butyl to t-butyl C—C bonds comprise functional groups.

As in the cases of carbon, silicon, and tin, the bonding in the germanium atom involves four sp³ hybridized orbitals. For germanium, they are formed from the 4p and 4s electrons of the outer shells. Ge—C bonds form between a Ge4sp³ HO and a C3sp³ HO, and Ge—Ge bonds form between between Ge4sp³ HOs to yield germanes and digermanes, respectively. The geometrical parameters of each Ge—C and Ge—Ge functional group is solved using Eq. (15.51) and the relationships between the prolate spheroidal axes. Then, the sum of the energies of the H₂-type ellipsoidal MOs is matched to that of the Ge4sp³ shell as in the case of the corresponding carbon, silicon, and tin molecules. As in the case of the transition metals, the energy of each functional group is determined for the effect of the electron density donation from the each participating C3sp³ HO and Ge4sp³ HO to the corresponding MO that maximizes the bond energy.

The Ge electron configuration is [Ar]4s²3d¹⁰4p², and the orbital arrangement is

$$\frac{↑}{1} {\frac{↑}{0}}^{4 p state} \frac{ }{- 1} \qquad ( 23.201 )$$

corresponding to the ground state ³P₀. The energy of the germanium 4p shell is the negative of the ionization energy of the germanium atom [1] given by

E(Ge,4p shell)=−E(ionization; Ge)=−7.89943 eV (23.202)

The energy of germanium is less than the Coulombic energy between the electron and proton of H given by Eq. (1.231), but the atomic orbital may hybridize in order to achieve a bond at an energy minimum. After Eq. (13.422), the Ge4s atomic orbital (AO) combines with the Ge4p AOs to form a single Ge4sp³ hybridized orbital (HO) with the orbital arrangement

$$\frac{↑}{0 , 0} {\frac{↑}{1 , - 1} \frac{↑}{1 , 0}}^{4 {sp}^{3} state} \frac{↑}{1 , 1} \qquad ( 23.203 )$$

where the quantum numbers (l, mₗ) are below each electron. The total energy of the state is given by the sum over the four electrons. The sum E_{T}(Ge, 4sp³) of experimental energies [1] of Ge, Ge⁺, Ge²⁺, and Ge³⁺ is

$$\begin{matrix}{E}_{T} ( Ge , 4 {sp}^{3} ) = 45.7131 eV + 34.2241 eV + \\ 15.93461 eV + 7.89943 eV \\ = 103.77124 eV\end{matrix} \qquad ( 23.204 )$$

By considering that the central field decreases by an integer for each successive electron of the shell, the radius r₄ₛₚ_{³} of the Ge4sp³ shell may be calculated from the Coulombic energy using Eq. (15.13):

$$\begin{matrix}{r}_{4 {sp}^{3}} = {\sum }_{n = 28}^{31} \frac{( Z - n ) {e}^{2}}{8 {πɛ}_{0} ( e 103.77124 eV )} \\ = \frac{10 {e}^{2}}{8 {πɛ}_{0} ( e 103.77124 eV )} \\ = 1.31113 {a}_{0}\end{matrix} \qquad ( 23.205 )$$

where Z=32 for germanium. Using Eq. (15.14), the Coulombic energy E_{Coulomb} (Ge,4sp³) of the outer electron of the Ge4sp³ shell is

$$\begin{matrix}{E}_{Coulomb} ( Ge , 4 {sp}^{3} ) = \frac{- {e}^{2}}{8 {πɛ}_{0} {r}_{4 {sp}^{3}}} \\ = \frac{- {e}^{2}}{8 {πɛ}_{0} 1.31113 {a}_{0}} \\ = - 10.37712 eV\end{matrix} \qquad ( 23.206 )$$

During hybridization, the spin-paired 4s electrons are promoted to Ge4sp³ shell as unpaired electrons. The energy for the promotion is the magnetic energy given by Eq. (15.15) at the initial radius of the 4s electrons. From Eq. (10.102) with Z=32 and n=30, the radius r₃₀ of the Ge4s shell is

r₃₀=1.19265a₀ (23.207)

Using Eqs. (15.15) and (23.207), the unpairing energy is

$$E ( magnetic ) = \frac{2 {πμ}_{0} {e}^{2} {ℏ}^{2}}{{{m}_{e}^{2} ( {r}_{30} )}^{3}} = \frac{8 {πμ}_{o} {μ}_{B}^{2}}{{( 1.19265 {a}_{0} )}^{3}} = 0.06744 eV \qquad ( 23.208 )$$

Using Eqs. (23.206) and (23.208), the energy E (Ge,4sp³) of the outer electron of the Ge4sp³ shell is

$$\begin{matrix}E ( Ge , 4 {sp}^{3} ) = \frac{- {e}^{2}}{8 {πɛ}_{0} {r}_{4 {sp}^{3}}} + \frac{2 {πμ}_{0} {e}^{2} {ℏ}^{2}}{{{m}_{e}^{2} ( {r}_{30} )}^{3}} \\ = - 10.37712 eV + 0.06744 eV \\ = - 10.30968 eV\end{matrix} \qquad ( 23.209 )$$

Next, consider the formation of the Ge-L-bond MO of gernmanium compounds wherein L is a ligand including germanium and carbon and each gemanium atom has a Ge4sp³ electron with an energy given by Eq. (23.209). The total energy of the state of each germanium atom is given by the sum over the four electrons. The sum E_{T}(Ge_{Ge-L}, 4sp³) of energies of Ge4sp³ (Eq. (23.209)), Ge⁺, Ge²⁺, and Ge³⁺ is

$$\begin{matrix}{E}_{T} ( {Ge}_{Ge - L} , 4 {sp}^{3} ) = - ( \begin{matrix}45.7131 eV + 34.2241 eV + \\ 15.93461 eV + E ( Ge , 4 {sp}^{3} )\end{matrix} ) \\ = - ( \begin{matrix}45.7131 eV + 34.2241 eV + \\ 15.93461 eV + 10.30968 eV\end{matrix} ) \\ = - 106.18149 eV\end{matrix} \qquad ( 23.210 )$$

where E(Ge,4sp³) is the sum of the energy of Ge, −7.89943 eV, and the hybridization energy.

A minimum energy is achieved while matching the potential, kinetic, and orbital energy relationships given in the Hydroxyl Radical (OH) section with the donation of electron density from the participating Ge4sp³ HO to each Ge-L-bond MO. Consider the case wherein each Ge4sp³ HO donates an excess of 25% of its electron density to the Ge-L-bond MO to form an energy minimum. By considering this electron redistribution in the germanium molecule as well as the fact that the central field decreases by an integer for each successive electron of the shell, in general terms, the radius r_{Ge-L4sp}_{³} of the Ge4sp³ shell may be calculated from the Coulombic energy using Eq. (15.18):

$$\begin{matrix}{r}_{Ge - L 4 {sp}^{3}} = ( {\sum }_{n = 28}^{31} ( Z - n ) - 0.25 ) \frac{{e}^{2}}{8 π {ɛ}_{0} ( e 106.18149 eV )} \\ = \frac{9.75 {e}^{2}}{8 {πɛ}_{0} ( e 106.18149 eV )} \\ = 1.24934 {a}_{0}\end{matrix} \qquad ( 23.211 )$$

Using Eqs. (15.19) and (23.211), the Coulombic energy E_{Coulomb}(Ge_{Ge-L},4sp³) of the outer electron of the Ge4sp³ shell is

$$\begin{matrix}{E}_{Coulomb} ( {Ge}_{Ge - L} , 4 {sp}^{3} ) = \frac{- {e}^{2}}{8 {πɛ}_{0} {r}_{Ge - L 4 {sp}^{3}}} \\ = \frac{- {e}^{2}}{8 {πɛ}_{0} 1.24934 {a}_{0}} \\ = - 10.89041 eV\end{matrix} \qquad ( 23.212 )$$

During hybridization, the spin-paired 4s electrons are promoted to Ge4sp³ shell as unpaired electrons. The energy for the promotion is the magnetic energy given by Eq. (23.208). Using Eqs. (23.208) and (23.212), the energy E (Ge_{Ge-L},4sp³) of the outer electron of the Ge4sp³ shell is

$$\begin{matrix}E ( {Ge}_{Ge - L} , 4 {sp}^{3} ) = \frac{- {e}^{2}}{8 {πɛ}_{0} {r}_{Ge - L 4 {sp}^{3}}} + \frac{2 π {μ}_{0} {e}^{2} {ℏ}^{2}}{{{m}_{e}^{2} ( {r}_{30} )}^{3}} \\ = - 10.89041 eV + 0.06744 eV \\ = - 10.82297 eV\end{matrix} \qquad ( 23.213 )$$

Thus, E_{T}(Ge-L,4sp³), the energy change of each Ge4sp³ shell with the formation of the Ge-L-bond MO is given by the difference between Eq. (23.213) and Eq. (23.209):

$$\begin{matrix}{E}_{T} ( Ge - L , 4 {sp}^{3} ) = E ( {Ge}_{Ge - L} , 4 {sp}^{3} ) - E ( Ge , 4 {sp}^{3} ) \\ = - 10.82297 eV - ( - 10.30968 eV ) \\ = - 0.51329 eV\end{matrix} \qquad ( 23.214 )$$

Now, consider the formation of the Ge-L-bond MO of gernmanium compounds wherein L is a ligand including germanium and carbon. For the Ge-L functional groups, hybridization of the 4p and 4s AOs of Ge to form a single Ge4sp³ HO shell forms an energy minimum, and the sharing of electrons between the Ge4sp³ HO and L HO to form a MO permits each participating orbital to decrease in radius and energy. The C2sp³ HO has an energy of E(C,2sp³)=−14.63489 eV (Eq. (15.25)) and the Ge4sp³ HO has an enery of E(Ge,4sp³)=−10.30968 eV (Eq. (23.209)). To meet the equipotential condition of the union of the Ge-L H₂-type-ellipsoidal-MO with these orbitals, the hybridization factor C₂ of Eq. (15.61) for the Ge-L-bond MO given by Eq. (15.77) is

$$\begin{matrix}{C}_{2} ( Ge 4 {sp}^{3} HO to Ge 4 {sp}^{3} HO ) = {C}_{2} ( C 2 {sp}^{3} HO to Ge 4 {sp}^{3} HO ) \\ = \frac{E ( Ge , 4 {sp}^{3} HO )}{E ( C , 2 {sp}^{3} )} \\ = \frac{- 10.30968 eV}{- 14.63489 eV} \\ = 0.70446\end{matrix} \qquad ( 23.215 )$$

Since the energy of the MO is matched to that of the Ge4sp³ HO, E(AO/HO) in Eq. (15.61) is E(Ge,4sp³ HO) given by Eq. (23.209). In order to match the energies of the HOs within the molecule, E_{T}(atom-atom,msp³.AO) of the Ge-L-bond MO for the ligands carbon or germanium is

$$\frac{- 0.72457}{2} . \qquad ( Eq . ( 14.151 ) )$$

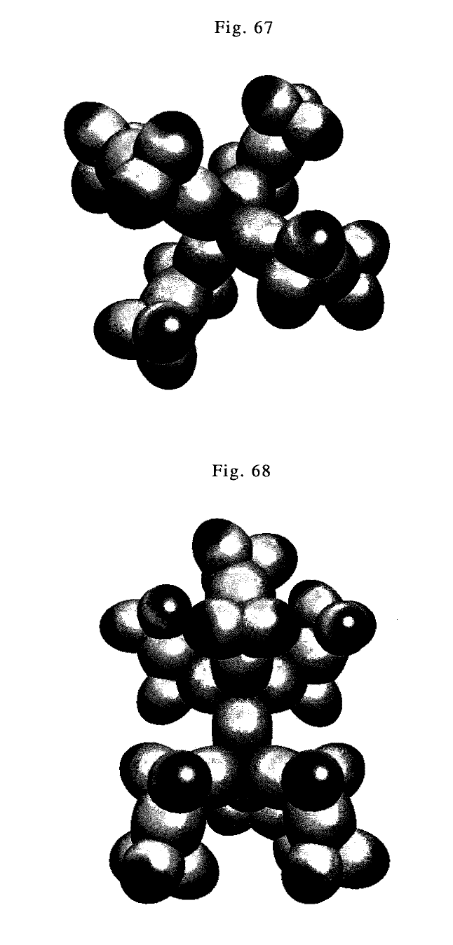

The symbols of the functional groups of germanium compounds are given in Table 141. The geometrical (Eqs. (15.1-15.5)), intercept (Eqs. (15.31-15.32) and (15.80-15.87)), and energy (Eqs. (15.61) and (23.28-23.33)) parameters of germanium compounds are given in Tables 142, 143, and 144, respectively. The total energy of each germanium compounds given in Table 145 was calculated as the sum over the integer multiple of each E_{D}(Group) of Table 144 corresponding to functional-group composition of the compound. The bond angle parameters of germanium compounds determined using Eqs. (15.88-15.117) are given in Table 146. The charge-densities of exemplary germanium and digermanium compounds, tetraethylgermanium (Ge(CH₂CH₃)₄) and hexaethyldigermanium ((C₂H₅)₃GeGe(C₂H₅)₃) comprising atoms with the outer shell bridged by one or more H₂-type ellipsoidal MOs or joined with one or more hydrogen MOs are shown in FIGS. 67 as 68, respectively.

TABLE 141
The symbols of functional groups of germanium compounds.

| Functional Group | Group Symbol |
|---|---|
| GeC group | Ge—C |
| GeGe group | Ge—Ge |
| CH₃ group | C—H (CH₃) |
| CH₂ alkyl group | C—H (CH₂) |
| CH alkyl | C—H |
| CC bond (n-C) | C—C (a) |
| CC bond (iso-C) | C—C (b) |
| CC bond (tert-C) | C—C (c) |
| CC (iso to iso-C) | C—C (d) |
| CC (t to t-C) | C—C (e) |
| CC (t to iso-C) | C—C (f) |

TABLE 142
The geometrical bond parameters of germanium compounds and
experimental values [3].

| | Ge—C | Ge—Ge | C—H (CH₃) | C—H (CH₂) | C—H |
|---|---|---|---|---|---|
| Parameter | Group | Group | Group | Group | Group |
| a (a₀) | 2.27367 | 2.27367 | 1.64920 | 1.67122 | 1.67465 |
| c′ (a₀) | 1.79654 | 1.79654 | 1.04856 | 1.05553 | 1.05661 |
| Bond Length | 1.90137 | 1.90137 | 1.10974 | 1.11713 | 1.11827 |
| 2c′ (Å) | | | | | |
| Exp. Bond | 1.945 | | 1.107 | 1.107 | 1.122 |
| Length | ((CH₃)₄Ge) | | (C—H | (C—H | (isobutane) |
| (Å) | 1.945 | | propane) | propane) | |
| | (CH₃GeH₃) | | 1.117 | 1.117 | |
| | 1.89 | | (C—H | (C—H | |
| | (CH₃GeCl₃₎ | | butane) | butane) | |
| b, c (a₀) | 1.39357 | 1.39357 | 1.27295 | 1.29569 | 1.29924 |
| e | 0.79015 | 0.79015 | 0.63580 | 0.63159 | 0.63095 |

| | C—C (a) | C—C (b) | C—C (c) | C—C (d) | C—C (e) | |
|---|---|---|---|---|---|---|
| Parameter | Group | Group | Group | Group | Group | C—C (f) Group |
| a (a₀) | 2.12499 | 2.12499 | 2.10725 | 2.12499 | 2.10725 | 2.10725 |
| c′ (a₀) | 1.45744 | 1.45744 | 1.45164 | 1.45744 | 1.45164 | 1.45164 |
| Bond Length | 1.54280 | 1.54280 | 1.53635 | 1.54280 | 1.53635 | 1.53635 |
| 2c′ (Å) | | | | | | |
| Exp. Bond | 1.532 | 1.532 | 1.532 | 1.532 | 1.532 | 1.532 |
| Length | (propane) | (propane) | (propane) | (propane) | (propane) | (propane) |
| (Å) | 1.531 | 1.531 | 1.531 | 1.531 | 1.531 | 1.531 |
| | (butane) | (butane) | (butane) | (butane) | (butane) | (butane) |
| b, c (a₀) | 1.54616 | 1.54616 | 1.52750 | 1.54616 | 1.52750 | 1.52750 |
| e | 0.68600 | 0.68600 | 0.68888 | 0.68600 | 0.68888 | 0.68888 |

TABLE 143
The MO to HO intercept geometrical bond parameters of germanium compounds. R, R′, R″ are H or
alkyl groups. E_{T} is E_{T} (atom-atom, msp³.AO).

| | | | | | | Final Total | | |
|---|---|---|---|---|---|---|---|---|
| | | E_{T} | E_{T} | E_{T} | E_{T} | Energy | | |
| | | (eV) | (eV) | (eV) | (eV) | Ge4sp³ | rᵢₙᵢₜᵢₐₗ | |
| Bond | Atom | Bond 1 | Bond 2 | Bond 3 | Bond 4 | C2sp³ (eV) | (a₀) | r_{final} (a₀) |
| C—H (CH₃) | C | −0.18114 | 0 | 0 | 0 | −151.79683 | 0.91771 | 0.90664 |
| (CH₃)₃Ge—CH₃ | Ge | −0.18114 | −0.18114 | −0.18114 | −0.18114 | | 1.31113 | 0.87495 |
| (CH₃)₃Ge—CH₃ | C | −0.18114 | 0 | 0 | 0 | | 0.91771 | 0.90664 |
| (CH₃)₃Ge—Ge(CH₃)₃ | Ge | −0.18114 | −0.18114 | −0.18114 | −0.18114 | | 1.31113 | 0.87495 |
| C—H (CH₃) | C | −0.92918 | 0 | 0 | 0 | −152.54487 | 0.91771 | 0.86359 |
| C—H (CH₂) (i) | C | −0.92918 | −0.92918 | 0 | 0 | −153.47406 | 0.91771 | 0.81549 |
| C—H (CH) (i) | C | −0.92918 | −0.92918 | −0.92918 | 0 | −154.40324 | 0.91771 | 0.77247 |
| H₃CₐC_{b}H₂CH₂—(C—C(a)) | Cₐ | −0.92918 | 0 | 0 | 0 | −152.54487 | 0.91771 | 0.86359 |
| H₃CₐC_{b}H₂CH₂—(C—C (a)) | C_{b} | −0.92918 | −0.92918 | 0 | 0 | −153.47406 | 0.91771 | 0.81549 |
| R—H₂CₐC_{b}(H₂C_{c}—R′)HCH₂—(C—C (b)) | C_{b} | −0.92918 | −0.92918 | −0.92918 | 0 | −154.40324 | 0.91771 | 0.77247 |
| R—H₂Cₐ(R′—H₂C_{d})C_{b}(R″—H₂C_{c})CH₂—(C—C (c)) | C_{b} | −0.92918 | −0.72457 | −0.72457 | −0.72457 | −154.71860 | 0.91771 | 0.75889 |
| isoCₐC_{b}(H₂C_{c}—R′)HCH₂—(C—C (d)) | C_{b} | −0.92918 | −0.92918 | −0.92918 | 0 | −154.40324 | 0.91771 | 0.77247 |
| tertCₐ(R′—H₂C_{d})C_{b}(R″—H₂C_{c})CH₂—(C—C (e)) | C_{b} | −0.72457 | −0.72457 | −0.72457 | −0.72457 | −154.51399 | 0.91771 | 0.76765 |
| tertCₐC_{b}(H₂C_{c}—R′)HCH₂—(C—C (f)) | C_{b} | −0.72457 | −0.92918 | −0.92918 | 0 | −154.19863 | 0.91771 | 0.78155 |
| isoCₐ(R′—H₂C_{d})C_{b}(R″—H₂C_{c})CH₂—(C—C (f)) | C_{b} | −0.72457 | −0.72457 | −0.72457 | −0.72457 | −154.51399 | 0.91771 | 0.76765 |

| | | E(Ge4sp³) | | | | | |
|---|---|---|---|---|---|---|---|
| | E_{Coulomb}(C2sp³) | E(C2sp³) | | | | | |
| | (eV) | (eV) | θ′ | θ₁ | θ₂ | d₁ | d₂ |
| Bond | Final | Final | (°) | (°) | (°) | (a₀) | (a₀) |
| C—H (CH₃) | −15.00689 | −14.81603 | 82.43 | 97.57 | 44.91 | 1.16793 | 0.11938 |
| (CH₃)₃Ge—CH₃ | −15.55033 | | 91.73 | 88.27 | 38.87 | 1.77020 | 0.02634 |
| (CH₃)₃Ge—CH₃ | −15.00689 | −14.81603 | 94.20 | 85.80 | 40.45 | 1.73010 | 0.06644 |
| (CH₃)₃Ge—Ge(CH₃)₃ | −15.55033 | | 91.73 | 88.27 | 38.87 | 1.77020 | 0.02634 |
| C—H (CH₃) | −15.75493 | −15.56407 | 77.49 | 102.51 | 41.48 | 1.23564 | 0.18708 |
| C—H (CH₂) (i) | −16.68412 | −16.49325 | 68.47 | 111.53 | 35.84 | 1.35486 | 0.29933 |
| C—H (CH) (i) | −17.61330 | −17.42244 | 61.10 | 118.90 | 31.37 | 1.42988 | 0.37326 |
| H₃CₐC_{b}H₂CH₂—(C—C (a)) | −15.75493 | −15.56407 | 63.82 | 116.18 | 30.08 | 1.83879 | 0.38106 |
| H₃CₐC_{b}H₂CH₂—(C—C (a)) | −16.68412 | −16.49325 | 56.41 | 123.59 | 26.06 | 1.90890 | 0.45117 |
| R—H₂CₐC_{b}(H₂C_{c}—R′)HCH₂—(C—C (b)) | −17.61330 | −17.42244 | 48.30 | 131.70 | 21.90 | 1.97162 | 0.51388 |
| R—H₂Cₐ(R′—H₂C_{d})C_{b}(R″—H₂C_{c})CH₂—(C—C (c)) | −17.92866 | −17.73779 | 48.21 | 131.79 | 21.74 | 1.95734 | 0.50570 |
| isoCₐC_{b}(H₂C_{c}—R′)HCH₂—(C—C (d)) | −17.61330 | −17.42244 | 48.30 | 131.70 | 21.90 | 1.97162 | 0.51388 |
| tertCₐ(R′—H₂C_{d}) C_{b}(R″—H₂C_{c})CH₂—(C—C (e)) | −17.92866 | −17.73779 | 50.04 | 129.96 | 22.66 | 1.94462 | 0.49298 |
| tertCₐC_{b}(H₂C_{c}—R′)HCH₂—(C—C (f)) | −17.40869 | −17.21783 | 52.78 | 127.22 | 24.04 | 1.92443 | 0.47279 |
| isoCₐ(R′—H₂C_{d})C_{b}(R″—H₂C_{c})CH₂—(C—C (f)) | −17.92866 | −17.73779 | 50.04 | 129.96 | 22.66 | 1.94462 | 0.49298 |

TABLE 144
The energy parameters (eV) of functional groups of germanium compounds.

| | | | | | | C—C |
|---|---|---|---|---|---|---|
| | Ge—C | Ge—Ge | CH₃ | CH₂ | CH | (a) |
| Parameters | Group | Group | Group | Group | Group | Group |
| n₁ | 1 | 1 | 3 | 2 | 1 | 1 |
| n₂ | 0 | 0 | 2 | 1 | 0 | 0 |
| n₃ | 0 | 0 | 0 | 0 | 0 | 0 |
| C₁ | 0.5 | 0.5 | 0.75 | 0.75 | 0.75 | 0.5 |
| C₂ | 0.70446 | 0.70446 | 1 | 1 | 1 | 1 |
| c₁ | 1 | 1 | 1 | 1 | 1 | 1 |
| c₂ | 1 | 1 | 0.91771 | 0.91771 | 0.91771 | 0.91771 |
| c₃ | 0 | 0 | 0 | 1 | 1 | 0 |
| c₄ | 2 | 2 | 1 | 1 | 1 | 2 |
| c₅ | 0 | 0 | 3 | 2 | 1 | 0 |
| C₁ₒ | 0.5 | 0.5 | 0.75 | 0.75 | 0.75 | 0.5 |
| C₂ₒ | 0.70446 | 0.70446 | 1 | 1 | 1 | 1 |
| Vₑ (eV) | −32.46926 | −32.46926 | −107.32728 | −70.41425 | −35.12015 | −28.79214 |
| Vₚ (eV) | 7.57336 | 7.57336 | 38.92728 | 25.78002 | 12.87680 | 9.33352 |
| T (eV) | 7.14028 | 7.14028 | 32.53914 | 21.06675 | 10.48582 | 6.77464 |
| Vₘ (eV) | −3.57014 | −3.57014 | −16.26957 | −10.53337 | −5.24291 | −3.38732 |
| E (AO/HO) (eV) | −10.30968 | −10.30968 | −15.56407 | −15.56407 | −14.63489 | −15.56407 |
| ΔE_{H}_{₂}_{MO} (AO/HO) (eV) | 0 | 0 | 0 | 0 | 0 | 0 |
| E_{T} (AO/HO) (eV) | −10.30968 | −10.30968 | −15.56407 | −15.56407 | −14.63489 | −15.56407 |
| E_{T} (H₂MO) (eV) | −31.63544 | −31.63544 | −67.69451 | −49.66493 | −31.63533 | −31.63537 |
| E_{T} (atom-atom, | −0.36229 | −0.36229 | 0 | 0 | 0 | −1.85836 |
| msp³.AO) (eV) | | | | | | |
| E_{T} (MO) (eV) | −31.99766 | −31.99766 | −67.69450 | −49.66493 | −31.63537 | −33.49373 |
| ω (10¹⁵ rad/s) | 14.9144 | 14.9144 | 24.9286 | 24.2751 | 24.1759 | 9.43699 |
| E_{K} (eV) | 9.81690 | 9.81690 | 16.40846 | 15.97831 | 15.91299 | 6.21159 |
| Ē_{D} (eV) | −0.19834 | −0.19834 | −0.25352 | −0.25017 | −0.24966 | −0.16515 |
| Ē_{Kvib} (eV) | 0.15312 [66] | 0.06335 [14] | 0.35532 | 0.35532 | 0.35532 | 0.12312 [6] |
| | | | Eq. | Eq. | Eq. | |
| | | | (13.458) | (13.458) | (13.458) | |
| Ē_{osc} (eV) | −0.12178 | −0.16666 | −0.22757 | −0.14502 | −0.07200 | −0.10359 |
| E_{mag} (eV) | 0.14803 | 0.14803 | 0.14803 | 0.14803 | 0.14803 | 0.14803 |
| E_{T} (Group) (eV) | −32.11943 | −32.16432 | −67.92207 | −49.80996 | −31.70737 | −33.59732 |
| Eᵢₙᵢₜᵢₐₗ (c₄ AO/HO) (eV) | −14.63489 | −14.63489 | −14.63489 | −14.63489 | −14.63489 | −14.63489 |
| Eᵢₙᵢₜᵢₐₗ (c₅ AO/HO) (eV) | 0 | 0 | −13.59844 | −13.59844 | −13.59844 | 0 |
| E_{D} (Group) (eV) | 2.84965 | 2.89454 | 12.49186 | 7.83016 | 3.32601 | 4.32754 |

| | C—C | C—C | C—C | C—C | C—C |
|---|---|---|---|---|---|
| | (b) | (c) | (d) | (e) | (f) |
| Parameters | Group | Group | Group | Group | Group |
| n₁ | 1 | 1 | 1 | 1 | 1 |
| n₂ | 0 | 0 | 0 | 0 | 0 |
| n₃ | 0 | 0 | 0 | 0 | 0 |
| C₁ | 0.5 | 0.5 | 0.5 | 0.5 | 0.5 |
| C₂ | 1 | 1 | 1 | 1 | 1 |
| c₁ | 1 | 1 | 1 | 1 | 1 |
| c₂ | 0.91771 | 0.91771 | 0.91771 | 0.91771 | 0.91771 |
| c₃ | 0 | 0 | 1 | 1 | 0 |
| c₄ | 2 | 2 | 2 | 2 | 2 |
| c₅ | 0 | 0 | 0 | 0 | 0 |
| C₁ₒ | 0.5 | 0.5 | 0.5 | 0.5 | 0.5 |
| C₂ₒ | 1 | 1 | 1 | 1 | 1 |
| Vₑ (eV) | −28.79214 | −29.10112 | −28.79214 | −29.10112 | −29.10112 |
| Vₚ (eV) | 9.33352 | 9.37273 | 9.33352 | 9.37273 | 9.37273 |
| T (eV) | 6.77464 | 6.90500 | 6.77464 | 6.90500 | 6.90500 |
| Vₘ (eV) | −3.38732 | −3.45250 | −3.38732 | −3.45250 | −3.45250 |
| E (AO/HO) (eV) | −15.56407 | −15.35946 | −15.56407 | −15.35946 | −15.35946 |
| ΔE_{H}_{₂}_{MO} (AO/HO) (eV) | 0 | 0 | 0 | 0 | 0 |
| E_{T} (AO/HO) (eV) | −15.56407 | −15.35946 | −15.56407 | −15.35946 | −15.35946 |
| E_{T} (H₂MO) (eV) | −31.63537 | −31.63535 | −31.63537 | −31.63535 | −31.63535 |
| E_{T} (atom-atom, | −1.85836 | −1.44915 | −1.85836 | −1.44915 | −1.44915 |
| msp³.AO) (eV) | | | | | |
| E_{T} (MO) (eV) | −33.49373 | −33.08452 | −33.49373 | −33.08452 | −33.08452 |
| ω (10¹⁵ rad/s) | 9.43699 | 15.4846 | 9.43699 | 9.55643 | 9.55643 |
| E_{K} (eV) | 6.21159 | 10.19220 | 6.21159 | 6.29021 | 6.29021 |
| Ē_{D} (eV) | −0.16515 | −0.20896 | −0.16515 | −0.16416 | −0.16416 |
| Ē_{Kvib} (eV) | 0.17978 [7] | 0.09944 [8] | 0.12312 [6] | 0.12312 [6] | 0.12312 [6] |
| Ē_{osc} (eV) | −0.07526 | −0.15924 | −0.10359 | −0.10260 | −0.10260 |
| E_{mag} (eV) | 0.14803 | 0.14803 | 0.14803 | 0.14803 | 0.14803 |
| E_{T} (Group) (eV) | −33.49373 | −33.24376 | −33.59732 | −33.18712 | −33.18712 |
| Eᵢₙᵢₜᵢₐₗ (c₄ AO/HO) (eV) | −14.63489 | −14.63489 | −14.63489 | −14.63489 | −14.63489 |
| Eᵢₙᵢₜᵢₐₗ (c₅ AO/HO) (eV) | 0 | 0 | 0 | 0 | 0 |
| E_{D} (Group) (eV) | 4.29921 | 3.97398 | 4.17951 | 3.62128 | 3.91734 |

TABLE 145
The total bond energies of gaseous-state germanium compounds calculated using the functional
group composition (separate functional groups designated in the first row) and the energies of
Table 144 compared to the gaseous-state experimental values [67] except where indicated.

| | | | | | | | | Calculated | Experimental | |
|---|---|---|---|---|---|---|---|---|---|---|
| | | | | | | | C—C | Total Bond | Total Bond | Relative |
| Formula | Name | Ge—C | Ge—Ge | CH₃ | CH₂ | CH | (a) | Energy (eV) | Energy (eV) | Error |
| C₈H₂₀Ge | Tetraethylgermanium | 4 | 0 | 4 | 4 | 0 | 4 | 109.99686 | 110.18166 | 0.00168 |
| C₁₂H₂₈Ge | Tetra-n-propylgermanium | 4 | 0 | 4 | 8 | 0 | 8 | 158.62766 | 158.63092 | 0.00002 |
| C₁₂H₃₀Ge₂ | Hexaethyldigermanium | 6 | 1 | 6 | 6 | 0 | 6 | 167.88982 | 167.89836 | 0.00005 |

^{a}Crystal.

TABLE 146
The bond angle parameters of germanium compounds and experimental values [3]. In the
calculation of θᵥ, the parameters from the preceding angle were used. E_{T} is E_{T} (atom-atom,
msp³.AO).

| | | | 2c′ | | Atom 1 | | Atom 2 | | |
|---|---|---|---|---|---|---|---|---|---|
| | 2c′ | 2c′ | Terminal | | Hybridization | | Hybridization | | |
| Atoms of | Bond 1 | Bond 2 | Atoms | E_{Coulombic} | Designation | E_{Coulombic} | Designation | c₂ | c₂ |
| Angle | (a₀) | (a₀) | (a₀) | Atom 1 | (Table 7) | Atom 2 | (Table 7) | Atom 1 | Atom 2 |
| Methyl | 2.09711 | 2.09711 | 3.4252 | −15.75493 | 7 | H | H | 0.86359 | 1 |
| ∠HCₐH | | | | | | | | | |
| ∠HₐCₐGe | | | | | | | | | |
| ∠CₐGeC_{b} | 3.59307 | 3.59307 | 5.7446 | −15.55033 | 5 | −15.55033 | 5 | 0.87495 | 0.87495 |
| Methylene | 2.11106 | 2.11106 | 3.4252 | −15.75493 | 7 | H | H | 0.86359 | 1 |
| ∠HCₐH | | | | | | | | | |
| ∠CₐC_{b}C_{c} | | | | | | | | | |
| ∠CₐC_{b}H | | | | | | | | | |
| Methyl | 2.09711 | 2.09711 | 3.4252 | −15.75493 | 7 | H | H | 0.86359 | 1 |
| ∠HCₐH | | | | | | | | | |
| ∠CₐC_{b}C_{c} | | | | | | | | | |
| ∠CₐC_{b}H | | | | | | | | | |
| ∠C_{b}CₐC_{c} | 2.91547 | 2.91547 | 4.7958 | −16.68412 | 26 | −16.68412 | 26 | 0.81549 | 0.81549 |
| iso Cₐ | | | | C_{b} | | C_{c} | | | |
| ∠C_{b}CₐH | 2.91547 | 2.11323 | 4.1633 | −15.55033 | 5 | −14.82575 | 1 | 0.87495 | 0.91771 |
| iso Cₐ | | | | Cₐ | | C_{b} | | | |
| ∠CₐC_{b}H | 2.91547 | 2.09711 | 4.1633 | −15.55033 | 5 | −14.82575 | 1 | 0.87495 | 0.91771 |
| iso Cₐ | | | | C_{b} | | Cₐ | | | |
| ∠C_{b}CₐC_{b} | 2.90327 | 2.90327 | 4.7958 | −16.68412 | 26 | −16.68412 | 26 | 0.81549 | 0.81549 |
| tert Cₐ | | | | C_{b} | | C_{b} | | | |
| ∠C_{b}CₐC_{d} | | | | | | | | | |

| Atoms of | | | | | E_{T} | θᵥ | θ₁ | θ₂ | Cal. θ | Exp. θ |
|---|---|---|---|---|---|---|---|---|---|---|
| Angle | C₁ | C₂ | c₁ | c₂′ | (eV) | (°) | (°) | (°) | (°) | (°) |
| Methyl | 1 | 1 | 0.75 | 1.15796 | 0 | | | | 109.50 | |
| ∠HCₐH | | | | | | | | | | |
| ∠HₐCₐGe | | | | | | 70.56 | | | 109.44 | 108 |
| | | | | | | | | | | (tetramethyl germanium) |
| ∠CₐGeC_{b} | 1 | 1 | 1 | 0.87495 | −1.85836 | | | | 106.14 | 109.5 |
| | | | | | | | | | | (tetramethyl germanium) |
| Methylene | 1 | 1 | 0.75 | 1.15796 | 0 | | | | 108.44 | 107 (propane) |
| ∠HCₐH | | | | | | | | | | |
| ∠CₐC_{b}C_{c} | | | | | | 69.51 | | | 110.49 | 112 (propane) |
| | | | | | | | | | | 113.8 (butane) |
| | | | | | | | | | | 110.8 (isobutane) |
| ∠CₐC_{b}H | | | | | | 69.51 | | | 110.49 | 111.0 (butane) |
| | | | | | | | | | | 111.4 (isobutane) |
| Methyl | 1 | 1 | 0.75 | 1.15796 | 0 | | | | 109.50 | |
| ∠HCₐH | | | | | | | | | | |
| ∠CₐC_{b}C_{c} | | | | | | 70.56 | | | 109.44 | |
| ∠CₐC_{b}H | | | | | | 70.56 | | | 109.44 | |
| ∠C_{b}CₐC_{c} | 1 | 1 | 1 | 0.81549 | −1.85836 | | | | 110.67 | 110.8 (isobutane) |
| iso Cₐ | | | | | | | | | | |
| ∠C_{b}CₐH | 0.75 | 1 | 0.75 | 1.04887 | 0 | | | | 110.76 | |
| iso Cₐ | | | | | | | | | | |
| ∠CₐC_{b}H | 0.75 | 1 | 0.75 | 1.04887 | 0 | | | | 111.27 | 111.4 (isobutane) |
| iso Cₐ | | | | | | | | | | |
| ∠C_{b}CₐC_{b} | 1 | 1 | 1 | 0.81549 | −1.85836 | | | | 111.37 | 110.8 (isobutane) |
| tert Cₐ | | | | | | | | | | |
| ∠C_{b}CₐC_{d} | | | | | | 72.50 | | | 107.50 | |

Tin Functional Groups and Molecules

As in the cases of carbon and tin, the bonding in the tin atom involves four sp³ hybridized orbitals formed from the 5 p and 5s electrons of the outer shells. Sn—X X=halide, oxide, Sn—H, and Sn—Sn bonds form between Sn5sp³ HOs and between a halide or oxide AO, a H1s AO, and a Sn5sp³ HO, respectively to yield tin halides and oxides, stannanes, and distannes, respectively. The geometrical parameters of each Sn—X X=halide, oxide , Sn—H , and Sn—Sn functional group is solved from the force balance equation of the electrons of the corresponding σ-MO and the relationships between the prolate spheroidal axes. Then, the sum of the energies of the H₂-type ellipsoidal MOs is matched to that of the Sn5sp³ shell as in the case of the corresponding carbon and tin molecules. As in the case of the transition metals, the energy of each functional group is determined for the effect of the electron density donation from the each participating Sn5sp³ HO and AO to the corresponding MO that maximizes the bond energy.

The branched-chain alkyl stannanes and distannes, SnₘCₙH₂₍ₘ₊ₙ₎₊₂, comprise at least a terminal methyl group (CH₃) and at least one Sn bound by a carbon-tin single bond comprising a C—Sn group, and may comprise methylene (CH₂), methylyne (CH), C—C, SnH_{n=1,2,3}, and Sn—Sn functional groups. The methyl and methylene functional groups are equivalent to those of straight-chain alkanes. Six types of C—C bonds can be identified. The n-alkane C—C bond is the same as that of straight-chain alkanes. In addition, the C—C bonds within isopropyl ((CH₃)₂CH) and t-butyl ((CH₃)₃C) groups and the isopropyl to isopropyl, isopropyl to t-butyl, and t-butyl to t-butyl C—C bonds comprise functional groups.

The Sn electron configuration is [Kr]5s² 4d¹⁰5 p², and the orbital arrangement is

$$\frac{↑}{1} {\frac{↑}{0}}^{5 p state} \frac{ }{- 1} \qquad ( 23.216 )$$

corresponding to the ground state ³P₀. The energy of the carbon 5p shell is the negative of the ionization energy of the tin atom [1] given by

E(Sn,5 p shell)=−E(ionization; Sn)=−7.34392 eV (23.217)

The energy of tin is less than the Coulombic energy between the electron and proton of H given by Eq. (1.231), but the atomic orbital may hybridize in order to achieve a bond at an energy minimum. After Eq. (13.422), the Sn5s atomic orbital (AO) combines with the Sn5 p AOs to form a single Sn5sp³ hybridized orbital (HO) with the orbital arrangement

$$\frac{↑}{0 , 0} {\frac{↑}{1 , - 1} \frac{↑}{1 , 0}}^{5 {sp}^{3} state} \frac{↑}{1 , 1} \qquad ( 23.218 )$$

where the quantum numbers (l, mₗ) are below each electron. The total energy of the state is given by the sum over the four electrons. The sum E_{T}(Sn,4sp³) of experimental energies [1] of Sn, Sn⁺, Sn²⁺, and Sn³⁺ is

$$\begin{matrix}{E}_{T} ( Sn , 5 {sp}^{3} ) = 40.73502 eV + 30.50260 eV + \\ 14.6322 eV + 7.3492 eV \\ = 93.21374 eV\end{matrix} \qquad ( 23.219 )$$

By considering that the central field decreases by an integer for each successive electron of the shell, the radius r₅ₛₚ_{³} of the Sn5sp³ shell may be calculated from the Coulombic energy using Eq. (15.13):

$$\begin{matrix}{r}_{5 {sp}^{3}} = {\sum }_{n = 46}^{49} \frac{( Z - n ) {e}^{2}}{8 {πɛ}_{0} ( e 93.21374 eV )} \\ = \frac{10 {e}^{2}}{8 {πɛ}_{0} ( e 93.21374 eV )} \\ = 1.45964 {a}_{0}\end{matrix} \qquad ( 23.220 )$$

where Z=50 for tin. Using Eq. (15.14), the Coulombic energy E_{Coulomb} (Sn,5sp³) of the outer electron of the Sn5sp³ shell is

$$\begin{matrix}{E}_{Coulomb} ( Sn , 5 {sp}^{3} ) = \frac{- {e}^{2}}{8 {πɛ}_{0} {r}_{5 {sp}^{3}}} \\ = \frac{- {e}^{2}}{8 {πɛ}_{0} 1.45964 {a}_{0}} \\ = - 9.321374 eV\end{matrix} \qquad ( 23.221 )$$

During hybridization, the spin-paired 5s electrons are promoted to Sn5sp³ shell as unpaired electrons. The energy for the promotion is the magnetic energy given by Eq. (15.15) at the initial radius of the 5s electrons. From Eq. (10.255) with Z=50, the radius r₄₈ of Sn5s shell is

r₄₈=1.33816a₀ (23.222)

Using Eqs. (15.15) and (23.206), the unpairing energy is

$$\begin{matrix}E ( magnetic ) = \frac{2 π {μ}_{0} {e}^{2} {ℏ}^{2}}{{{m}_{e}^{2} ( {r}_{48} )}^{3}} \\ = \frac{8 {πμ}_{o} {μ}_{B}^{2}}{{( 1.33816 {a}_{0} )}^{3}} \\ = 0.04775 eV\end{matrix} \qquad ( 23.223 )$$

Using Eqs. (23.203) and (23.207), the energy E (Sn,5sp³) of the outer electron of the Sn5sp³ shell is

$$\begin{matrix}E ( Sn , 5 {sp}^{3} ) = \frac{- {e}^{2}}{8 {πɛ}_{0} {r}_{5 {sp}^{3}}} + \frac{2 {πμ}_{0} {e}^{2} {ℏ}^{2}}{{{m}_{e}^{2} ( {r}_{48} )}^{3}} \\ = - 9.321374 eV + 0.04775 eV \\ = - 9.27363 eV\end{matrix} \qquad ( 23.244 )$$

Next, consider the formation of the Sn-L-bond MO of tin compounds wherein L is a ligand including tin and each tin atom has a Sn5sp³ electron with an energy given by Eq. (23.224). The total energy of the state of each tin atom is given by the sum over the four electrons. The sum E_{T}(Sn_{Sn-L},5sp³) of energies of Sn5sp³ (Eq. (23.224)), Sn⁺, Sn²⁺, and Sn³⁺ is

$$\begin{matrix}{E}_{T} ( {Sn}_{Sn - L} , 5 {sp}^{3} ) = - ( \begin{matrix}40.73502 eV + 30.50260 eV + \\ 14.6322 eV + E ( Sn , 5 {sp}^{3} )\end{matrix} ) \\ = - ( \begin{matrix}40.73502 eV + 30.50260 eV + \\ 14.6322 eV + 9.27363 eV\end{matrix} ) \\ = - 95.14345 eV\end{matrix} \qquad ( 23.225 )$$

where E (Sn,5sp³) is the sum of the energy of Sn, −7.34392 eV, and the hybridization energy.

A minimum energy is achieved while matching the potential, kinetic, and orbital energy relationships given in the Hydroxyl Radical (OH) section with the donation of electron density from the participating Sn5sp³ HO to each Sn-L-bond MO. As in the case of acetylene given in the Acetylene Molecule section, the energy of each Sn-L functional group is determined for the effect of the charge donation. For example, as in the case of the Si—Si-bond MO given in the Alkyl Silanes and Disilanes section, the sharing of electrons between two Sn5sp³ HOs to form a Sn—Sn-bond MO permits each participating orbital to decrease in size and energy. In order to further satisfy the potential, kinetic, and orbital energy relationships, each Sn5sp³ HO donates an excess of 25% of its electron density to the Sn—Sn-bond MO to form an energy minimum. By considering this electron redistribution in the distannane molecule as well as the fact that the central field decreases by an integer for each successive electron of the shell, in general terms, the radius r_{Sn-L5sp}_{³} of the Sn5sp³ shell may be calculated from the Coulombic energy using Eq. (15.18):

$$\begin{matrix}{r}_{Sn - L 5 {sp}^{3}} = ( {\sum }_{n = 46}^{49} ( Z - n ) - 0.25 ) \frac{{e}^{2}}{8 {πɛ}_{0} ( e 95.14345 eV )} \\ = \frac{9.75 {e}^{2}}{8 {πɛ}_{0} ( e 95.14345 eV )} \\ = 1.39428 {a}_{0}\end{matrix} \qquad ( 23.226 )$$

Using Eqs. (15.19) and (23.210), the Coulombic energy E_{Coulomb}(Sn_{sn-L},5sp³) of the outer electron of the Sn5sp³ shell is

$$\begin{matrix}{E}_{Coulomb} ( {Sn}_{Sn - L} , 5 {sp}^{3} ) = \frac{- {e}^{2}}{8 {πɛ}_{0} {r}_{Sn - L 5 {sp}^{3}}} \\ = \frac{- {e}^{2}}{8 {πɛ}_{0} 1.39428 {a}_{0}} \\ = - 9.75830 eV\end{matrix} \qquad ( 23.227 )$$

During hybridization, the spin-paired 5s electrons are promoted to Sn5sp³ shell as unpaired electrons. The energy for the promotion is the magnetic energy given by Eq. (23.223). Using Eqs. (23.223) and (23.227), the energy E(Sn_{Sn-L}, 5sp³) of the outer electron of the Si3sp³ shell is

$$\begin{matrix}E ( {Sn}_{Sn - L} , 5 {sp}^{3} ) = \frac{- {e}^{2}}{8 {πɛ}_{0} {r}_{Sn - L 5 {sp}^{3}}} + \frac{2 {πμ}_{0} {e}^{2} {ℏ}^{2}}{{{m}_{e}^{2} ( {r}_{48} )}^{3}} \\ = - 9.75830 eV + 0.04775 eV \\ = - 9.71056 eV\end{matrix} \qquad ( 23.228 )$$

Thus, E_{T}(Sn-L,5sp³), the energy change of each Sn5sp³ shell with the formation of the Sn-L-bond MO is given by the difference between Eq. (23.228) and Eq. (23.224):

E_{T}(Sn-L,5sp³)=E(Sn_{sn-L},5sp³)−E(Sn,5sp³)=−0.43693 eV (23.229)

Next, consider the formation of the Si-L-bond MO of additional functional groups wherein each tin atom contributes a Sn5sp³ electron having the sum E_{T}(Sn_{Sn-L},5Sp³) of energies of Sn5sp³ (Eq. (23.224)), Se⁺, Sn²⁺, and Sn³⁺ given by Eq. (23.209). Each Sn-L-bond MO of each functional group Si-L forms with the sharing of electrons between a Sn5sp³ HO and a AO or HO of L, and the donation of electron density from the Sn5sp³ HO to the Sn-L-bond MO permits the participating orbitals to decrease in size and energy. In order to further satisfy the potential, kinetic, and orbital energy relationships while forming an energy minimum, the permitted values of the excess fractional charge of its electron density that the Sn5sp³ HO donates to the Si-L-bond MO given by Eq. (15.18) is s (0.25); s=1,2,3,4 and linear combinations thereof. By considering this electron redistribution in the tin molecule as well as the fact that the central field decreases by an integer for each successive electron of the shell, the radius r_{Sn-L5sp}_{³} of the Sn5sp³ shell may be calculated from the Coulombic energy using Eq. (15.18):

$$\begin{matrix}{r}_{Sn - L 5 {sp}^{3}} = ( {\sum }_{n = 46}^{49} ( Z - n ) - s ( 0.25 ) ) \frac{{e}^{2}}{8 {πɛ}_{0} ( e 95.14345 eV )} \\ = \frac{( 10 - s ( 0.25 ) ) {e}^{2}}{8 {πɛ}_{0} ( e 95.14345 eV )}\end{matrix} \qquad ( 23.230 )$$

Using Eqs. (15.19) and (23.230), the Coulombic energy E_{Coulomb}(Sn_{sn-L},5sp³) of the outer electron of the Sn5sp³ shell is

$$\begin{matrix}{E}_{Coulomb} ( {Sn}_{Sn - L} , 5 {sp}^{3} ) = \frac{- {e}^{2}}{8 {πɛ}_{0} {r}_{Sn - L 5 {sp}^{3}}} \\ = \frac{- {e}^{2}}{8 {πɛ}_{0} \frac{( 10 - s ( 0.25 ) ) {e}^{2}}{8 {πɛ}_{0} ( e 95.14345 eV )}} \\ = \frac{95.14345 eV}{( 10 - s ( 0.25 ) )}\end{matrix} \qquad ( 23.231 )$$

During hybridization, the spin-paired 5s electrons are promoted to Sn5sp³ shell as unpaired electrons. The energy for the promotion is the magnetic energy given by Eq. (23.223). Using Eqs. (23.223) and (23.231), the energy E(Sn_{sn-L},5sp³) of the outer electron of the Si3sp³ shell is

$$\begin{matrix}E ( {Sn}_{Sn - L} , 5 {sp}^{3} ) = \frac{- {e}^{2}}{8 {πɛ}_{0} {r}_{Sn - L 5 {sp}^{3}}} + \frac{2 {πμ}_{0} {e}^{2} {ℏ}^{2}}{{{m}_{e}^{2} ( {r}_{48} )}^{3}} \\ = \frac{95.14345 eV}{( 10 - s ( 0.25 ) )} + 0.04775 eV\end{matrix} \qquad ( 23.232 )$$

Thus, E_{T}(Sn-L,5sp³), the energy change of each Sn5sp³ shell with the formation of the Sn-L-bond MO is given by the difference between Eq. (23.232) and Eq. (23.224):

$$\begin{matrix}{E}_{T} ( Sn - L , 5 {sp}^{3} ) = E ( {Sn}_{Sn - L} , 5 {sp}^{3} ) - E ( Sn , 5 {sp}^{3} ) \\ = - \frac{95.14345}{( 10 - s ( 0.25 ) )} eV + 0.04775 eV - \\ ( - 9.27363 eV )\end{matrix} \qquad ( 23.233 )$$

Using Eq. (15.28) for the case that the energy matching and energy minimum conditions of the MOs in the tin molecule are met by a linear combination of values of s (s₁ and s₂) in Eqs. (23.230-23.233), the energy E(Sn_{Sn-L},5sp³) of the outer electron of the Si3sp³ shell is

$$E ( {Sn}_{Sn - L} , 5 {sp}^{3} ) = \frac{\begin{matrix}\frac{95.14345 eV}{( 10 - {s}_{1} ( 0.25 ) )} + \frac{95.14345 eV}{( 10 - {s}_{2} ( 0.25 ) )} + \\ 2 ( 0.04775 eV )\end{matrix}}{2} \qquad ( 23.234 )$$

Using Eqs. (15.13) and (23.234), the radius corresponding to Eq. (23.234) is:

$$\begin{matrix}{r}_{5 {sp}^{3}} = \frac{{e}^{2}}{8 {πɛ}_{0} E ( {Sn}_{Sn - L} , 5 {sp}^{3} )} \\ = \frac{{e}^{2}}{8 {πɛ}_{0} ( e ( \frac{\begin{matrix}\frac{95.14345 eV}{( 10 - {s}_{1} ( 0.25 ) )} + \frac{95.14345 eV}{( 10 - {s}_{2} ( 0.25 ) )} + \\ 2 ( 0.04775 eV )\end{matrix}}{2} ) )}\end{matrix} \qquad ( 23.235 )$$

E_{T}(Sn-L,5sp³), the energy change of each Sn5sp³ shell with the formation of the Sn-L-bond MO is given by the difference between Eq. (23.235) and Eq. (23.224):

$$\begin{matrix}{E}_{T} ( Sn - L , 5 {sp}^{3} ) = E ( {Sn}_{Sn - L} , 5 {sp}^{3} ) - E ( Sn , 5 {sp}^{3} ) \\ = \frac{\begin{matrix}\frac{95.14345 eV}{( 10 - {s}_{1} ( 0.25 ) )} + \frac{95.14345 eV}{( 10 - {s}_{2} ( 0.25 ) )} + \\ 2 ( 0.04775 eV )\end{matrix}}{2} - \\ ( - 9.27363 eV )\end{matrix} \qquad ( 23.236 )$$

E_{T}(Sn-L,5sp³) is also given by Eq. (15.29). Bonding parameters for Sn-L-bond MO of tin functional groups due to charge donation from the HO to the MO are given in Table 147.

TABLE 147
The values of r_{Sn5sp}³, E_{Coulomb}(Sn_{Sn-L},5sp³), and E(Sn_{Sn-L},5sp³) and the resulting
E_{T}(Sn-L,5sp³) of the MO due to charge donation from the HO to the MO.

| MO | | | | E_{Coulomb}(Sn_{Sn-L},5sp³) | E(Sn_{Sn-L},5sp³) | |
|---|---|---|---|---|---|---|
| Bond | | | r_{Sn5sp}³(a₀) | (eV) | (eV) | E_{T}(Sn-L,5sp³) |
| Type | s1 | s2 | Final | Final | Final | (eV) |
| 0 | 0 | 0 | 1.45964 | −9.321374 | −9.27363 | 0 |
| I | 1 | 0 | 1.39428 | −9.75830 | −9.71056 | −0.43693 |
| II | 2 | 0 | 1.35853 | −10.01510 | −9.96735 | −0.69373 |
| III | 3 | 0 | 1.32278 | −10.28578 | −10.23803 | −0.96440 |
| IV | 4 | 0 | 1.28703 | −10.57149 | −10.52375 | −1.25012 |
| I + II | 1 | 2 | 1.37617 | −9.88670 | −9.83895 | −0.56533 |
| II + III | 2 | 3 | 1.34042 | −10.15044 | −10.10269 | −0.82906 |

The semimajor axis a solution given by Eq. (23.41) of the force balance equation, Eq. (23.39), for the σ-MO of the Sn-L-bond MO of SnLₙ is given in Table 149 with the force-equation parameters Z=50, nₑ, and L corresponding to the orbital and spin angular momentum terms of the 4s HO shell. The semimajor axis a of organometallic compounds, stannanes and distannes, are solved using Eq. (15.51).

For the Sn-L functional groups, hybridization of the 5p and 5s AOs of Sn to form a single Sn5sp³ HO shell forms an energy minimum, and the sharing of electrons between the Sn5sp³ HO and L AO to form a MO permits each participating orbital to decrease in radius and energy. The Cl AO has an energy of E(Cl)=−12.96764 eV, the Br AO has an energy of E(Br)=−11.8138 eV, the I AO has an energy of E(I)=−10.45126 eV, the O AO has an energy of E(O)=−13.61805 eV, the C2sp³ HO has an energy of E(C,2sp³)=−14.63489 eV (Eq. (15.25)), 13.605804 eV is the magnitude of the Coulombic energy between the electron and proton of H (Eq. (1.231)), the Coulomb energy of the Sn5sp³ HO is E_{Coulomb}(Sn,5sp³HO)=−9.32137 eV (Eq. (23.205)), and the Sn5sp³ HO has an energy of E(Sn,5sp³HO)=−9.27363 eV (Eq. (23.208)). To meet the equipotential condition of the union of the Sn-L H₂-type-ellipsoidal-MO with these orbitals, the hybridization factor(s), at least one of c₂ and C₂ of Eq. (15.61) for the Sn-L-bond MO given by Eq. (15.77) is

$$\begin{matrix}\begin{matrix}{c}_{2} ( ClAO to Sn 5 {sp}^{3} HO ) = {C}_{2} ( ClAO to Sn 5 {sp}^{3} HO ) \\ = \frac{E ( Sn , 5 {sp}^{3} )}{E ( ClAO )} \\ = \frac{- 9.27363 eV}{- 12.96764 eV} \\ = 0.71514\end{matrix} & ( 23.237 ) \\ \begin{matrix}{C}_{2} ( BrAO to Sn 5 {sp}^{3} HO ) = \frac{E ( Sn , 5 {sp}^{3} )}{E ( BrAO )} \\ = \frac{- 9.27363 eV}{- 11.8138 eV} \\ = 0.78498\end{matrix} & ( 23.238 ) \\ \begin{matrix}{c}_{2} ( IAO to Sn 5 {sp}^{3} HO ) = \frac{E ( Sn , Sn 5 {sp}^{3} )}{E ( IAO )} \\ = \frac{- 9.27363 eV}{- 10.45126 eV} \\ = 0.88732\end{matrix} & ( 23.239 ) \\ \begin{matrix}{c}_{2} ( O to Sn 5 {sp}^{3} HO ) = {C}_{2} ( O to Sn 5 {sp}^{3} HO ) \\ = \frac{E ( Sn , 5 {sp}^{3} )}{E ( O )} \\ = \frac{- 9.27363 eV}{- 13.61805 eV} \\ = 0.68098\end{matrix} & ( 23.240 ) \\ \begin{matrix}{c}_{2} ( HAO to Sn 5 {sp}^{3} HO ) = \frac{{E}_{Coulomb} ( Sn , 5 {sp}^{3} )}{E ( H )} \\ = \frac{- 9.32137 eV}{- 13.605804 eV} \\ = 0.68510\end{matrix} & ( 23.241 ) \\ \begin{matrix}{C}_{2} ( C 2 {sp}^{2} HO to Sn 5 {sp}^{3} HO ) = \frac{E ( Sn , 5 {sp}^{3} HO )}{E ( C , 2 {sp}^{3} )} \\ {c}_{2} ( C 2 {sp}^{3} HO ) \\ = \frac{- 9.27363 eV}{- 14.63489 eV} ( 0.91771 ) \\ = 0.58152\end{matrix} & ( 23.242 ) \\ \begin{matrix}{c}_{2} ( Sn 5 {sp}^{3} HO to Sn 5 {sp}^{3} HO ) = \frac{{E}_{Coulomb} ( Sn , 5 {sp}^{3} )}{E ( H )} \\ = \frac{- 9.32137 eV}{- 13.605804 eV} \\ = 0.68510\end{matrix} & ( 23.243 )\end{matrix}$$

where Eq. (15.71) was used in Eqs. (23.241) and (23.243) and Eqs. (15.76), (15.79), and (13.430) were used in Eq. (23.242). Since the energy of the MO is matched to that of the Sn5sp³ HO, E(AO/HO) in Eq. (15.61) is E(Sn,5sp³HO) given by Eq. (23.224) for single bonds and twice this value for double bonds. E_{T}(atom-atom, msp³.AO) of the Sn-L-bond MO is determined by considering that the bond involves up to an electron transfer from the tin atom to the ligand atom to form partial ionic character in the bond as in the case of the zwitterions such as H₂B⁺—F⁻ given in the Halido Boranes section. For the tin compounds, E_{T}(atom-atom,msp³.AO) is that which forms an energy minimum for the hybridization and other bond parameter. The general values of Table 147 are given by Eqs. (23.233) and (23.226), and the specific values for the tin functional groups are given in Table 151.

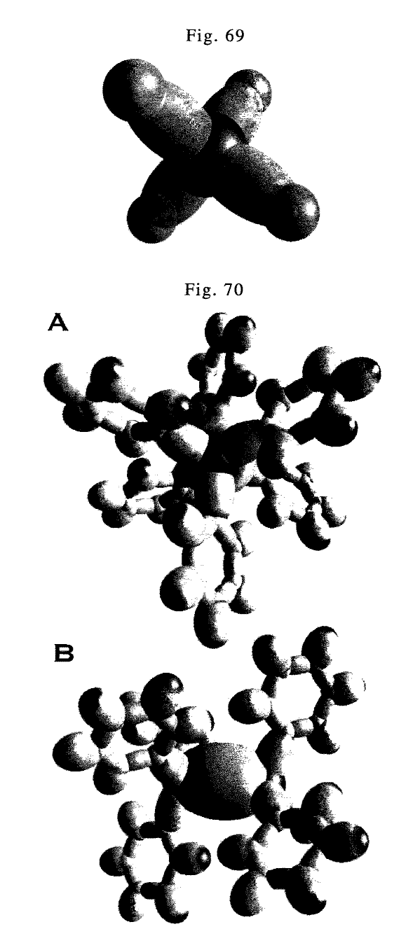

The symbols of the functional groups of tin compounds are given in Table 148. The geometrical (Eqs. (15.1-15.5) and (23.41)), intercept (Eqs. (15.31-15.32) and (15.80-15.87)), and energy (Eqs. (15.61) and (23.28-23.33)) parameters of tin compounds are given in Tables 149, 150, and 151, respectively. The total energy of each tin compounds given in Table 152 was calculated as the sum over the integer multiple of each E_{D}(Group) of Table 151 corresponding to functional-group composition of the compound. The bond angle parameters of tin compounds determined using Eqs. (15.88-15.117) are given in Table 153. The E_{T}(atom-atom, msp³.AO) term for SnCl₄ was calculated using Eqs. (23.230-23.277) with s=1 for the energies of E(Sn,5sp³). The charge-densities of exemplary tin coordinate and organometallic compounds, tin tetrachloride (SnCl₄) and hexaphenyldistannane ((C₆H₅)₃SnSn(C₆H₅)₃) comprising the concentric shells of atoms with the outer shell bridged by one or more H₂-type ellipsoidal MOs or joined with one or more hydrogen MOs are shown in FIGS. 69 and 70, respectively.

TABLE 148
The symbols of functional groups of tin compounds.

| Functional Group | Group Symbol |
|---|---|
| SnCl group | Sn—Cl |
| SnBr group | Sn—Br |
| SnI group | Sn—I |
| SnO group | Sn—O |
| SnH group | Sn—H |
| SnC group | Sn—C |
| SnSn group | Sn—Sn |
| CH₃ group | C—H (CH₃) |
| CH₂ alkyl group | C—H (CH₂) (i) |
| CH alkyl | C—H (i) |
| CC bond (n-C) | C—C (a) |
| CC bond (iso-C) | C—C (b) |
| CC bond (tert-C) | C—C (c) |
| CC (iso to iso-C) | C—C (d) |
| CC (t to t-C) | C—C (e) |
| CC (t to iso-C) | C—C (f) |
| CC double bond | C═C |
| C vinyl single bond to —C(C)═C | C—C (i) |
| C vinyl single bond to —C(H)═C | C—C (ii) |
| C vinyl single bond to —C(C)═CH₂ | C—C (iii) |
| CH₂ alkenyl group | C—H (CH₂) (ii) |
| CC (aromatic bond) | C^{3e}═C |
| CH (aromatic) | CH (ii) |
| Cₐ—C_{b} (CH₃ to aromatic bond) | C—C (iv) |
| C—C(O) | C—C(O) |
| C═O (aryl carboxylic acid) | C═O |
| (O)C—O | C—O |
| OH group | OH |

TABLE 149A
The geometrical bond parameters of tin compounds and experimental values [3].

| | Sn—Cl | Sn—Br | Sn—I | Sn—O | Sn—H | Sn—C | Sn—Sn |
|---|---|---|---|---|---|---|---|
| Parameter | Group | Group | Group | Group | Group | Group | Group |
| nₑ | 3 | 5 | 5 | 2 | 2 | | 6 |
| L | $\sqrt{\frac{3}{4}}$ | $3 \sqrt{\frac{3}{4}}$ | 0 | $2 \sqrt{\frac{3}{4}}$ | 0 | | 0 |
| a (a₀) | 2.51732 | 3.55196 | 3.50000 | 2.03464 | 2.00000 | 2.44449 | 4.00000 |
| c′ (a₀) | 2.16643 | 2.45626 | 2.64575 | 1.72853 | 1.63299 | 2.05027 | 2.79011 |
| Bond Length | 2.2928 | 2.59959 | 2.80014 | 1.82940 | 1.72829 | 2.16991 | 2.95293 |
| 2c′ (Å) | | | | | | | |
| Exp. Bond | 2.280 | 2.495 [68] | 2.7081 [69] | 1.8325 | 1.711 | 2.144 | 2.79 [70] |
| Length | (SnCl₄) | ((C₆H₅)₃SnBr) | ((C₆H₅)₃SnI) | (SnO) | (SnH₄) | (Sn(CH₃)₄) | ((CH₃)₃SnSn(CH₃)₃) |
| (Å) | | | | | | | |
| b, c (a₀) | 1.28199 | 2.56578 | 2.29129 | 1.07329 | 1.15470 | 1.33114 | 2.86623 |
| e | 0.86061 | 0.69152 | 0.75593 | 0.84955 | 0.81650 | 0.83873 | 0.69753 |
| | C—H (CH₃) | C—H (CH₂) (i) | C—H (i) | C—C (a) | C—C (b) | C—C (c) | C—C (d) |
| Parameter | Group | Group | Group | Group | Group | Group | Group |
| nₑ | | | | | | | |
| L | | | | | | | |
| a (a₀) | 1.64920 | 1.67122 | 1.67465 | 2.12499 | 2.12499 | 2.10725 | 2.12499 |
| c′ (a₀) | 1.04856 | 1.05553 | 1.05661 | 1.45744 | 1.45744 | 1.45164 | 1.45744 |
| Bond Length | 1.10974 | 1.11713 | 1.11827 | 1.54280 | 1.54280 | 1.53635 | 1.54280 |
| 2c′ (Å) | | | | | | | |
| | 1.107 | 1.107 | | 1.532 | 1.532 | 1.532 | 1.532 |
| Exp. Bond | (C—H propane) | (C—H propane) | | (propane) | (propane) | (propane) | (propane) |
| Length | 1.117 | 1.117 | 1.122 | 1.531 | 1.531 | 1.531 | 1.531 |
| (Å) | (C—H butane) | (C—H butane) | (isobutane) | (butane) | (butane) | (butane) | (butane) |
| b,c (a₀) | 1.27295 | 1.29569 | 1.29924 | 1.54616 | 1.54616 | 1.52750 | 1.54616 |
| e | 0.63580 | 0.63159 | 0.63095 | 0.68600 | 0.68600 | 0.68888 | 0.68600 |

TABLE 149B
The geometrical bond parameters of tin compounds and experimental values [3].

| | | | | | | | C—H (CH₂) |
|---|---|---|---|---|---|---|---|
| | C—C (e) | C—C (f) | C═C | C—C (i) | C—C (ii) | C—C (iii) | (ii) |
| Parameter | Group | Group | Group | Group | Group | Group | Group |
| a (a₀) | 2.10725 | 2.10725 | 1.47228 | 2.04740 | 2.04740 | 2.04740 | 1.64010 |
| c′ (a₀) | 1.45164 | 1.45164 | 1.26661 | 1.43087 | 1.43087 | 1.43087 | 1.04566 |
| Bond Length | 1.53635 | 1.53635 | 1.34052 | 1.51437 | 1.51437 | 1.51437 | 1.10668 |
| 2c′ (Å) | | | | | | | |
| Exp. Bond | 1.532 | 1.532 | 1.342 | | 1.508 | 1.508 | 1.10 |
| Length | (propane) | (propane) | (2-methylpropene) | | (2-butene) | (2- | (2- |
| (Å) | 1.531 | 1.531 | 1.346 | | | methylpropene) | methylpropene) |
| | (butane) | (butane) | (2-butene) | | | | 1.108 (avg.) |
| | | | 1.349 | | | | (1,3-butadiene) |
| | | | (1,3-butadiene) | | | | |
| b, c (a₀) | 1.52750 | 1.52750 | 0.75055 | 1.46439 | 1.46439 | 1.46439 | 1.26354 |
| e | 0.68888 | 0.68888 | 0.86030 | 0.69887 | 0.69887 | 0.69887 | 0.63756 |

| | C^{3e}═C | CH (ii) | C—C (iv) | C—C(O) | C═O | C—O | OH |
|---|---|---|---|---|---|---|---|
| Parameter | Group | Group | Group | Group | Group | Group | Group |
| a (a₀) | 1.47348 | 1.60061 | 2.06004 | 1.95111 | 1.29907 | 1.73490 | 1.26430 |
| c′ (a₀) | 1.31468 | 1.03299 | 1.43528 | 1.39682 | 1.13977 | 1.31716 | 0.91808 |
| Bond Length | 1.39140 | 1.09327 | 1.51904 | 1.47833 | 1.20628 | 1.39402 | 0.971651 |
| 2c′ (Å) | | | | | | | |
| Exp. Bond | 1.399 | 1.101 | 1.524 | 1.48 [71] | 1.214 | 1.393 | 0.972 |
| Length | (benzene) | (benzene) | (toluene) | (benzoic acid) | (acetic acid) | (methyl | (formic acid) |
| (Å) | | | | | | formate) | |
| b, c (a₀) | 0.66540 | 1.22265 | 1.47774 | 1.36225 | 0.62331 | 1.12915 | 0.86925 |
| e | 0.89223 | 0.64537 | 0.69673 | 0.71591 | 0.87737 | 0.75921 | 0.72615 |

TABLE 150
The MO to HO intercept geometrical bond parameters of tin compounds. R, R′, R″ are H or
alkyl groups. E_{T} is E_{T} (atom-atom, msp³.AO).

| | | | | | | Final | | |
|---|---|---|---|---|---|---|---|---|
| | | | | | | Total | | |
| | | | | | | Energy | | |
| | | E_{T} | E_{T} | E_{T} | E_{T} | Sn5sp³ | | |
| | | (eV) | (eV) | (eV) | (eV) | C2sp³ | rᵢₙᵢₜᵢₐₗ | r_{final} |
| Bond | Atom | Bond 1 | Bond 2 | Bond 3 | Bond 4 | (eV) | (a₀) | (a₀) |
| Sn—Cl (SnCl₄) | Sn | −0.69373 | −0.69373 | −0.69373 | −0.69373 | | 1.45964 | 1.12479 |
| Sn—Cl (SnCl₄) | Cl | −0.69373 | 0 | 0 | 0 | | 1.05158 | 0.99593 |
| Sn—Br (SnBr₄) | Sn | −1.25012 | −1.25012 | −1.25012 | −1.25012 | | 1.45964 | 0.95000 |
| Sn—Br (SnBr₄) | Br | −1.25012 | 0 | 0 | 0 | | 1.15169 | 1.04148 |
| Sn—I (SnI₄) | Sn | −0.62506 | −0.62506 | −0.62506 | −0.62506 | | 1.45964 | 1.15093 |
| Sn—I (SnI₄) | I | −0.62506 | 0 | 0 | 0 | | 1.30183 | 1.22837 |
| Sn—O (SnO) | Sn | −0.56533 | 0 | 0 | 0 | | 1.45964 | 1.37617 |
| Sn—O (SnO) | O | −0.56533 | 0 | 0 | 0 | | 1.00000 | 0.95928 |
| Sn—H (SnH₄) | Sn | −0.82906 | −0.82906 | −0.82906 | −0.82906 | | 1.45964 | 1.07661 |
| Sn—(CH₃)₄ | Sn | 0 | 0 | 0 | 0 | | 1.45964 | 0.91771 |
| Sn—(CH₃)₄ | C | 0 | 0 | 0 | 0 | | 0.91771 | 0.91771 |
| (CH₃)₃Sn—Sn(CH₃)₃ | Sn | −0.21846 | 0 | 0 | 0 | | 1.45964 | 1.42621 |
| C—H (CH₃) | C | −0.92918 | 0 | 0 | 0 | −152.54487 | 0.91771 | 0.86359 |
| C—H (CH₂) (i) | C | −0.92918 | −0.92918 | 0 | 0 | −153.47406 | 0.91771 | 0.81549 |
| C—H (CH) (i) | C | −0.92918 | −0.92918 | −0.92918 | 0 | −154.40324 | 0.91771 | 0.77247 |
| H₃CₐC_{b}H₂CH₂—(C—C (a)) | Cₐ | −0.92918 | 0 | 0 | 0 | −152.54487 | 0.91771 | 0.86359 |
| H₃CₐC_{b}H₂CH₂—(C—C (a)) | C_{b} | −0.92918 | −0.92918 | 0 | 0 | −153.47406 | 0.91771 | 0.81549 |
| R—H₂CₐC_{b}(H₂C_{c}—R′)HCH₂—(C—C (b)) | C_{b} | −0.92918 | −0.92918 | −0.92918 | 0 | −154.40324 | 0.91771 | 0.77247 |
| R—H₂Cₐ(R′—H₂C_{d})C_{b} | C_{b} | −0.92918 | −0.72457 | −0.72457 | −0.72457 | −154.71860 | 0.91771 | 0.75889 |
| (R″—H₂C_{c})CH₂—(C—C (c)) | | | | | | | | |
| isoCₐC_{b}(H₂C_{c}—R′)HCH₂—(C—C (d)) | C_{b} | −0.92918 | −0.92918 | −0.92918 | 0 | −154.40324 | 0.91771 | 0.77247 |
| tertCₐ(R′—H₂C_{d})C_{b} | C_{b} | −0.72457 | −0.72457 | −0.72457 | −0.72457 | −154.51399 | 0.91771 | 0.76765 |
| (R″—H₂C_{c})CH₂—(C—C (e)) | | | | | | | | |
| tertCₐC_{b}(H₂C_{c}—R′)HCH₂—(C—C (f)) | C_{b} | −0.72457 | −0.92918 | −0.92918 | 0 | −154.19863 | 0.91771 | 0.78155 |
| isoCₐ(R′—H₂C_{d})C_{b} | C_{b} | −0.72457 | −0.72457 | −0.72457 | −0.72457 | −154.51399 | 0.91771 | 0.76765 |
| (R″—H₂C_{c})CH₂—(C—C (f)) | | | | | | | | |
| C_{c}(H)Cₐ═Cₐ(H)C_{d} | Cₐ | −1.13380 | −0.92918 | 0 | 0 | −153.67867 | 0.91771 | 0.80561 |
| C_{c}(H)Cₐ═C_{b}H₂ | C_{b} | −1.13380 | 0 | 0 | 0 | −152.74949 | 0.91771 | 0.85252 |
| C_{c}(C_{d})Cₐ═C_{b}H,Cₑ | Cₐ | −1.13380 | −0.72457 | −0.72457 | 0 | −154.19863 | 0.91771 | 0.78155 |
| R₁C_{b}H₂—Cₐ(C)═C | Cₐ | −1.13380 | −0.72457 | −0.72457 | 0 | −154.19863 | 0.91771 | 0.78155 |
| (C—C (i)) | | | | | | | | |
| R₁C_{b}H₂—Cₐ(C)═C | C_{b} | −0.72457 | −0.92918 | 0 | 0 | −153.26945 | 0.91771 | 0.82562 |
| (C—C (i)) | | | | | | | | |
| R₁C_{b}H₂—Cₐ(C)═CH₂ | | | | | | | | |
| (C—C (iii)) | | | | | | | | |
| R₁C_{b}H₂—Cₐ(H)═C | Cₐ | −1.13380 | −0.92918 | 0 | 0 | −153.67866 | 0.91771 | 0.80561 |
| (C—C (ii)) | | | | | | | | |
| R₁C_{b}H₂—Cₐ(H)═C | C_{b} | −0.92918 | −0.92918 | 0 | 0 | −153.47405 | 0.91771 | 0.81549 |
| (C—C (i)) | | | | | | | | |
| C—H (CH₂) (ii) | C | −1.13380 | 0 | 0 | 0 | −152.74949 | 0.91771 | 0.85252 |
| C^{3e}═(Sn)Cₐ^{3e}═C | Cₐ | −0.85035 | −0.85035 | 0 | 0 | −153.31638 | 0.91771 | 0.82327 |
| C—H (CH) (ii) | C | −0.85035 | −0.85035 | −0.56690 | 0 | −153.88327 | 0.91771 | 0.79597 |
| C^{3e}═HC_{b}^{3e}═C | C_{b} | −0.85035 | −0.85035 | −0.56690 | 0 | −153.88327 | 0.91771 | 0.79597 |
| C—H (CₐH₃) | Cₐ | −0.56690 | 0 | 0 | 0 | −152.18259 | 0.91771 | 0.88392 |
| C—H (C_{c}H) | C_{c} | −0.85035 | −0.85035 | −0.56690 | 0 | −153.88327 | 0.91771 | 0.79597 |
| C^{3e}═HC_{c}^{3e}═C | C_{c} | −0.85035 | −0.85035 | −0.56690 | 0 | −153.88327 | 0.91771 | 0.79597 |
| C^{3e}═(H₃Cₐ)C_{b}^{3e}═C | C_{b} | | | | | | | |
| (C^{3e}═)₂C_{b}—CₐH₃ | Cₐ | −0.56690 | 0 | 0 | 0 | −152.18259 | 0.91771 | 0.88392 |
| (C^{3e}═)₂C_{b}—CₐH₃ | C_{b} | −0.56690 | −0.85035 | −0.85035 | 0 | −153.88328 | 0.91771 | 0.79597 |
| C^{3e}═HC_{b}^{3e}═C | C_{b} | −0.85035 | −0.85035 | −0.56690 | 0 | −153.88327 | 0.91771 | 0.79597 |
| C^{3e}═(HOOCₐ)C_{b}^{3e}═C_{c}(H) | C_{c} | | | | | | | |
| C^{3e}═(Cl)Cₐ^{3e}═C_{b}(H) | C_{b} | | | | | | | |
| C^{3e}═(H₂N)Cₐ^{3e}═C_{b}(H) | C_{b} | | | | | | | |
| C_{b}Cₐ(O)O—H | O | −0.92918 | 0 | 0 | 0 | | 1.00000 | 0.86359 |
| C_{b}Cₐ(O)—OH | O | −0.92918 | 0 | 0 | 0 | | 1.00000 | 0.86359 |
| C_{b}Cₐ(O)—OH | Cₐ | −0.92918 | −1.34946 | −0.64574 | 0 | −154.54007 | 0.91771 | 0.76652 |
| C_{b}Cₐ(OH)═O | O | −1.34946 | 0 | 0 | 0 | | 1.00000 | 0.84115 |
| C_{b}Cₐ(OH)═O | Cₐ | −1.34946 | −0.64574 | −0.92918 | 0 | −154.54007 | 0.91771 | 0.76652 |
| C_{b}—Cₐ(O)OH | Cₐ | −0.64574 | −1.34946 | −0.92918 | 0 | −154.54007 | 0.91771 | 0.76652 |
| C_{b}—Cₐ(O)OH | C_{b} | −0.64574 | −0.85035 | −0.85035 | 0 | −153.96212 | 0.91771 | 0.79232 |

| | | E(Sn5sp³) | | | | | |
|---|---|---|---|---|---|---|---|
| | E_{Coulomb}(C2sp³) | E(C2sp³) | | | | | |
| | (eV) | (eV) | θ′ | θ₁ | θ₂ | d₁ | d₂ |
| Bond | Final | Final | (°) | (°) | (°) | (a₀) | (a₀) |
| Sn—Cl (SnCl₄) | −12.09627 | | 119.18 | 60.82 | 50.00 | 1.61807 | 0.54836 |
| Sn—Cl (SnCl₄) | −13.66137 | | 113.59 | 66.41 | 45.39 | 1.76780 | 0.39862 |
| Sn—Br (SnBr₄) | −14.32185 | | | | | | |
| Sn—Br (SnBr₄) | −13.06392 | | | | | | |
| Sn—I (SnI₄) | −11.82161 | | 66.35 | 113.65 | 27.39 | 3.10753 | 0.46178 |
| Sn—I (SnI₄) | −11.07632 | | 72.99 | 107.01 | 30.84 | 3.00509 | 0.35933 |
| Sn—O (SnO) | −9.88670 | | 133.85 | 46.15 | 67.61 | 0.77508 | 0.41569 |
| Sn—O (SnO) | −14.18339 | | 118.84 | 61.16 | 51.53 | 1.26580 | 0.46831 |
| Sn—H (SnH₄) | −12.63763 | | 117.80 | 62.20 | 55.57 | 1.13092 | 0.50208 |
| Sn—(CH₃)₄ | −14.82575 | | 104.51 | 75.49 | 41.87 | 1.82034 | 0.22992 |
| Sn—(CH₃)₄ | −14.82575 | −14.63489 | 104.51 | 75.49 | 41.87 | 1.82034 | 0.22992 |
| (CH₃)₃Sn—Sn(CH₃)₃ | −9.53983 | | 50.89 | 129.11 | 22.71 | 3.68987 | 0.89976 |
| C—H (CH₃) | −15.75493 | −15.56407 | 77.49 | 102.51 | 41.48 | 1.23564 | 0.18708 |
| C—H (CH₂) (i) | −16.68412 | −16.49325 | 68.47 | 111.53 | 35.84 | 1.35486 | 0.29933 |
| C—H (CH) (i) | −17.61330 | −17.42244 | 61.10 | 118.90 | 31.37 | 1.42988 | 0.37326 |
| H₃CₐC_{b}H₂CH₂—(C—C (a)) | −15.75493 | −15.56407 | 63.82 | 116.18 | 30.08 | 1.83879 | 0.38106 |
| H₃CₐC_{b}H₂CH₂—(C—C (a)) | −16.68412 | −16.49325 | 56.41 | 123.59 | 26.06 | 1.90890 | 0.45117 |
| R—H₂CₐC_{b}(H₂C_{c}—R′)HCH₂—(C—C (b)) | −17.61330 | −17.42244 | 48.30 | 131.70 | 21.90 | 1.97162 | 0.51388 |
| R—H₂Cₐ(R′—H₂C_{d})C_{b}(R″—H₂C_{c}) | −17.92866 | −17.73779 | 48.21 | 131.79 | 21.74 | 1.95734 | 0.50570 |
| CH₂—(C—C (c)) | | | | | | | |
| isoCₐC_{b}(H₂C_{c}—R′)HCH₂—(C—C (d)) | −17.61330 | −17.42244 | 48.30 | 131.70 | 21.90 | 1.97162 | 0.51388 |
| tertCₐ(R′—H₂C_{d})C_{b}(R″—H₂C_{c}) | −17.92866 | −17.73779 | 50.04 | 129.96 | 22.66 | 1.94462 | 0.49298 |
| CH₂—(C—C (e)) | | | | | | | |
| tertCₐC_{b}(H₂C_{c}—R′)HCH₂—(C—C (f)) | −17.40869 | −17.21783 | 52.78 | 127.22 | 24.04 | 1.92443 | 0.47279 |
| isoCₐ(R′—H₂C_{d})C_{b}(R″—H₂C_{c}) | −17.92866 | −17.73779 | 50.04 | 129.96 | 22.66 | 1.94462 | 0.49298 |
| CH₂—(C—C (f)) | | | | | | | |
| C_{c}(H)Cₐ═Cₐ(H)C_{d} | −16.88873 | −16.69786 | 127.61 | 52.39 | 58.24 | 0.77492 | 0.49168 |
| C_{c}(H)Cₐ═C_{b}H₂ | −15.95955 | −15.76868 | 129.84 | 50.16 | 60.70 | 0.72040 | 0.54620 |
| C_{c}(C_{d})Cₐ═C_{b}H,Cₑ | −17.40869 | −17.21783 | 126.39 | 53.61 | 56.95 | 0.80289 | 0.46371 |
| R₁C_{b}H₂—Cₐ(C)═C | −17.40869 | −17.21783 | 60.88 | 119.12 | 27.79 | 1.81127 | 0.38039 |
| (C—C (i)) | | | | | | | |
| R₁C_{b}H₂—Cₐ(C)═C | −16.47951 | −16.28864 | 67.40 | 112.60 | 31.36 | 1.74821 | 0.31734 |
| (C—C (i)) | | | | | | | |
| R₁C_{b}H₂—Cₐ(C)═CH₂ | | | | | | | |
| (C—C (iii)) | | | | | | | |
| R₁C_{b}H₂—Cₐ(H)═C | −16.88873 | −16.69786 | 64.57 | 115.43 | 29.79 | 1.77684 | 0.34596 |
| (C—C (ii)) | | | | | | | |
| R₁C_{b}H₂—Cₐ(H)═C | −16.68411 | −16.49325 | 65.99 | 114.01 | 30.58 | 1.76270 | 0.33183 |
| (C—C (i)) | | | | | | | |
| C—H (CH₂) (ii) | −15.95955 | −15.76868 | 77.15 | 102.85 | 41.13 | 1.23531 | 0.18965 |
| C^{3e}═(Sn)Cₐ^{3e}═C | −16.52644 | −16.33558 | 135.37 | 44.63 | 60.36 | 0.72875 | 0.58594 |
| C—H (CH) (ii) | −17.09334 | −16.90248 | 74.42 | 105.58 | 38.84 | 1.24678 | 0.21379 |
| C^{3e}═HC_{b}^{3e}═C | −17.09334 | −16.90248 | 134.24 | 45.76 | 58.98 | 0.75935 | 0.55533 |
| C—H (CₐH₃) | −15.39265 | −15.20178 | 79.89 | 101.11 | 43.13 | 1.20367 | 0.15511 |
| C—H (C_{c}H) | −17.09334 | −16.90248 | 74.42 | 105.58 | 38.84 | 1.24678 | 0.21379 |
| C^{3e}═HC_{c}^{3e}═C | −17.09334 | −16.90248 | 134.24 | 45.76 | 58.98 | 0.75935 | 0.55533 |
| C^{3e}═(H₃Cₐ)C_{b}^{3e}═C | | | | | | | |
| (C^{3e}═)₂C_{b}—CₐH₃ | −15.39265 | −15.20178 | 73.38 | 106.62 | 34.97 | 1.68807 | 0.25279 |
| (C^{3e}═)₂C_{b}—CₐH₃ | −17.09334 | −16.90247 | 61.56 | 118.44 | 28.27 | 1.81430 | 0.37901 |
| C^{3e}═HC_{b}^{3e}═C | −17.09334 | −16.90248 | 134.24 | 45.76 | 58.98 | 0.75935 | 0.55533 |
| C^{3e}═(HOOCₐ)C_{b}^{3e}═C_{c}(H) | | | | | | | |
| C^{3e}═(Cl)Cₐ^{3e}═C_{b}(H) | | | | | | | |
| C^{3e}═(H₂N)Cₐ^{3e}═C_{b}(H) | | | | | | | |
| C_{b}Cₐ(O)O—H | −15.75493 | | 115.09 | 64.91 | 64.12 | 0.55182 | 0.36625 |
| C_{b}Cₐ(O)—OH | −15.75493 | | 101.32 | 78.68 | 48.58 | 1.14765 | 0.16950 |
| C_{b}Cₐ(O)—OH | −17.75013 | −17.55927 | 93.11 | 86.89 | 42.68 | 1.27551 | 0.04165 |
| C_{b}Cₐ(OH)═O | −16.17521 | | 137.27 | 42.73 | 66.31 | 0.52193 | 0.61784 |
| C_{b}Cₐ(OH)═O | −17.75013 | −17.55927 | 134.03 | 45.97 | 62.14 | 0.60699 | 0.53278 |
| C_{b}—Cₐ(O)OH | −17.75013 | −17.55927 | 70.34 | 109.66 | 32.00 | 1.65466 | 0.25784 |
| C_{b}—Cₐ(O)OH | −17.17218 | −16.98131 | 73.74 | 106.26 | 33.94 | 1.61863 | 0.22181 |

TABLE 151A
The energy parameters (eV) of functional groups of tin.

| | Sn—Cl | Sn—Br | Sn—I | Sn—O | Sn—H | Sn—C | Sn—Sn |
|---|---|---|---|---|---|---|---|
| Parameters | Group | Group | Group | Group | Group | Group | Group |
| n₁ | 1 | 1 | 1 | 2 | 1 | 1 | 1 |
| n₂ | 0 | 0 | 0 | 0 | 0 | 0 | 0 |
| n₃ | 0 | 0 | 0 | 0 | 0 | 0 | 0 |
| C₁ | 0.375 | 0.375 | 0.25 | 0.5 | 0.375 | 0.5 | 0.375 |
| C₂ | 0.71514 | 0.78498 | 1 | 0.68098 | 1 | 0.58152 | 0.68510 |
| c₁ | 1 | 1 | 1 | 1 | 1 | 1 | 1 |
| c₂ | 0.71514 | 1 | 0.88732 | 0.68098 | 0.68510 | 1 | 1 |
| c₃ | 0 | 0 | 0 | 0 | 0 | 0 | 0 |
| c₄ | 1 | 1 | 1 | 2 | 1 | 2 | 2 |
| c₅ | 1 | 1 | 1 | 2 | 1 | 0 | 0 |
| C₁ₒ | 0.375 | 0.375 | 0.25 | 0.5 | 0.375 | 0.5 | 0.375 |
| C₂ₒ | 0.71514 | 0.78498 | 1 | 0.68098 | 1 | 0.58152 | 0.68510 |
| Vₑ (eV) | −23.27710 | −18.85259 | −18.00852 | −53.79650 | −26.17110 | −32.30127 | −16.82311 |
| Vₚ (eV) | 6.28029 | 5.53925 | 5.14251 | 15.74264 | 8.33182 | 6.63612 | 4.87644 |
| T (eV) | 4.62339 | 2.65383 | 2.57265 | 13.22015 | 6.54278 | 6.60696 | 2.10289 |
| Vₘ (eV) | −2.31169 | −1.32691 | −1.28632 | −6.61007 | −3.27139 | −3.30348 | −1.05144 |
| E(AO/HO) (eV) | −9.27363 | −9.27363 | −9.27363 | −18.54725 | −9.27363 | −9.27363 | −9.27363 |
| ΔE_{H}₂MO (AO/HO) (eV) | 0 | 0 | 0 | 0 | 0 | 0 | 0 |
| E_{T} (AO/HO) (eV) | −9.27363 | −9.27363 | −9.27363 | −18.54725 | −9.27363 | −9.27363 | −9.27363 |
| E_{T} (H₂MO) (eV) | −23.95874 | −21.26006 | −20.85331 | −49.99104 | −23.84152 | −31.63530 | −20.16886 |
| E_{T} (atom-atom, | −1.38745 | −2.50024 | −1.25012 | −1.13065 | −1.65813 | 0 | −0.43693 |
| msp³.AO) (eV) | | | | | | | |
| E_{T} (MO) (eV) | −25.34619 | −23.76030 | −22.10343 | −51.12170 | −25.49965 | −31.63537 | −20.60579 |
| ω(10¹⁵ rad/s) | 14.7492 | 5.45759 | 3.15684 | 21.6951 | 8.95067 | 14.5150 | 2.61932 |
| E_{K} (eV) | 9.70820 | 3.59228 | 2.07789 | 14.28009 | 5.89149 | 9.55403 | 1.72408 |
| Ē_{D} (eV) | −0.15624 | −0.08909 | −0.06303 | −0.19109 | −0.12245 | −0.19345 | −0.05353 |
| Ē_{Kvib} (eV) | 0.04353 [14] | 0.03065 [14] | 0.02467 [14] | 0.10193 [14] | 0.22937 [72] | 0.14754 [72] | 0.02343 [73] |
| Ē_{osc} (eV) | −0.13447 | −0.07377 | −0.05070 | −0.14013 | −0.00776 | −0.11968 | −0.04181 |
| E_{mag} (eV) | 0.03679 | 0.03679 | 0.03679 | 0.03679 | 0.03679 | 0.14803 | 0.03679 |
| E_{T} (Group) (eV) | −25.48066 | −23.83407 | −22.15413 | −51.40195 | −25.50741 | −31.75505 | −20.64760 |
| Eᵢₙᵢₜᵢₐₗ (c₄ AO/HO) (eV) | −9.27363 | −9.27363 | −9.27363 | −9.27363 | −9.27363 | −14.63489 | −9.27363 |
| Eᵢₙᵢₜᵢₐₗ (c₅ AO/HO) (eV) | −12.96764 | −11.8138 | −10.45126 | −13.61806 | −13.59844 | 0 | 0 |
| E_{D} (Group) (eV) | 3.23939 | 2.74664 | 2.42924 | 5.61858 | 2.63534 | 2.48527 | 2.10034 |
| | | | | C—C | C—C | C—C | C—C |
| | CH₃ | CH₂ (i) | CH (i) | (a) | (b) | (c) | (d) |
| Parameters | Group | Group | Group | Group | Group | Group | Group |
| n₁ | 3 | 2 | 1 | 1 | 1 | 1 | 1 |
| n₂ | 2 | 1 | 0 | 0 | 0 | 0 | 0 |
| n₃ | 0 | 0 | 0 | 0 | 0 | 0 | 0 |
| C₁ | 0.75 | 0.75 | 0.75 | 0.5 | 0.5 | 0.5 | 0.5 |
| C₂ | 1 | 1 | 1 | 1 | 1 | 1 | 1 |
| c₁ | 1 | 1 | 1 | 1 | 1 | 1 | 1 |
| c₂ | 0.91771 | 0.91771 | 0.91771 | 0.91771 | 0.91771 | 0.91771 | 0.91771 |
| c₃ | 0 | 1 | 1 | 0 | 0 | 0 | 1 |
| c₄ | 1 | 1 | 1 | 2 | 2 | 2 | 2 |
| c₅ | 3 | 2 | 1 | 0 | 0 | 0 | 0 |
| C₁ₒ | 0.75 | 0.75 | 0.75 | 0.5 | 0.5 | 0.5 | 0.5 |
| C₂ₒ | 1 | 1 | 1 | 1 | 1 | 1 | 1 |
| Vₑ (eV) | −107.32728 | −70.41425 | −35.12015 | −28.79214 | −28.79214 | −29.10112 | −28.79214 |
| Vₚ (eV) | 38.92728 | 25.78002 | 12.87680 | 9.33352 | 9.33352 | 9.37273 | 9.33352 |
| T (eV) | 32.53914 | 21.06675 | 10.48582 | 6.77464 | 6.77464 | 6.90500 | 6.77464 |
| Vₘ (eV) | −16.26957 | −10.53337 | −5.24291 | −3.38732 | −3.38732 | −3.45250 | −3.38732 |
| E(AO/HO) (eV) | −15.56407 | −15.56407 | −14.63489 | −15.56407 | −15.56407 | −15.35946 | −15.56407 |
| ΔE_{H}₂ MO (AO/HO) (eV) | 0 | 0 | 0 | 0 | 0 | 0 | 0 |
| E_{T} (AO/HO) (eV) | −15.56407 | −15.56407 | −14.63489 | −15.56407 | −15.56407 | −15.35946 | −15.56407 |
| E_{T} (H₂MO) (eV) | −67.69451 | −49.66493 | −31.63533 | −31.63537 | −31.63537 | −31.63535 | −31.63537 |
| E_{T} (atom-atom, | 0 | 0 | 0 | −1.85836 | −1.85836 | −1.44915 | −1.85836 |
| msp³.AO) (eV) | | | | | | | |
| E_{T} (MO) (eV) | −67.69450 | −49.66493 | −31.63537 | −33.49373 | −33.49373 | −33.08452 | −33.49373 |
| ω(10¹⁵ rad/s) | 24.9286 | 24.2751 | 24.1759 | 9.43699 | 9.43699 | 15.4846 | 9.43699 |
| E_{K} (eV) | 16.40846 | 15.97831 | 15.91299 | 6.21159 | 6.21159 | 10.19220 | 6.21159 |
| Ē_{D} (eV) | −0.25352 | −0.25017 | −0.24966 | −0.16515 | −0.16515 | −0.20896 | −0.16515 |
| Ē_{Kvib} (eV) | 0.35532 | 0.35532 | 0.35532 | 0.12312 [6] | 0.17978 [7] | 0.09944 [8] | 0.12312 [6] |
| | Eq. | Eq. | Eq. | | | | |
| | (13.458) | (13.458) | (13.458) | | | | |
| Ē_{osc} (eV) | −0.22757 | −0.14502 | −0.07200 | −0.10359 | −0.07526 | −0.15924 | −0.10359 |
| E_{mag} (eV) | 0.14803 | 0.14803 | 0.14803 | 0.14803 | 0.14803 | 0.14803 | 0.14803 |
| E_{T} (Group) (eV) | −67.92207 | −49.80996 | −31.70737 | −33.59732 | −33.49373 | −33.24376 | −33.59732 |
| Eᵢₙᵢₜᵢₐₗ (c₄ AO/HO) (eV) | −14.63489 | −14.63489 | −14.63489 | −14.63489 | −14.63489 | −14.63489 | −14.63489 |
| Eᵢₙᵢₜᵢₐₗ (c₅ AO/HO) (eV) | −13.59844 | −13.59844 | −13.59844 | 0 | 0 | 0 | 0 |
| E_{D} (Group) (eV) | 12.49186 | 7.83016 | 3.32601 | 4.32754 | 4.29921 | 3.97398 | 4.17951 |

TABLE 151B
The energy parameters (eV) of functional groups of tin compounds.

| | C—C | | | | C—C | C—C | |
|---|---|---|---|---|---|---|---|
| | (e) | C—C (f) | C═C | C—C (i) | (ii) | (iii) | CH₂ (ii) |
| Parameters | Group | Group | Group | Group | Group | Group | Group |
| f₁ | 1 | 1 | 1 | 1 | 1 | 1 | 1 |
| n₁ | 1 | 1 | 2 | 1 | 1 | 1 | 2 |
| n₂ | 0 | 0 | 0 | 0 | 0 | 0 | 1 |
| n₃ | 0 | 0 | 0 | 0 | 0 | 0 | 0 |
| C₁ | 0.5 | 0.5 | 0.5 | 0.5 | 0.5 | 0.5 | 0.75 |
| C₂ | 1 | 1 | 0.91771 | 1 | 1 | 1 | 1 |
| c₁ | 1 | 1 | 1 | 1 | 1 | 1 | 1 |
| c₂ | 0.91771 | 0.91771 | 0.91771 | 0.91771 | 0.91771 | 0.91771 | 0.91771 |
| c₃ | 1 | 0 | 0 | 1 | 0 | 1 | 1 |
| c₄ | 2 | 2 | 4 | 2 | 2 | 2 | 1 |
| c₅ | 0 | 0 | 0 | 0 | 0 | 0 | 2 |
| C₁ₒ | 0.5 | 0.5 | 0.5 | 0.5 | 0.5 | 0.5 | 0.75 |
| C₂ₒ | 1 | 1 | 0.91771 | 1 | 1 | 1 | 1 |
| Vₑ (eV) | −29.10112 | −29.10112 | −102.08992 | −30.19634 | −30.19634 | −30.19634 | −72.03287 |
| Vₚ (eV) | 9.37273 | 9.37273 | 21.48386 | 9.50874 | 9.50874 | 9.50874 | 26.02344 |
| T (eV) | 6.90500 | 6.90500 | 34.67062 | 7.37432 | 7.37432 | 7.37432 | 21.95990 |
| Vₘ (eV) | −3.45250 | −3.45250 | −17.33531 | −3.68716 | −3.68716 | −3.68716 | −10.97995 |
| E (AO/HO) (eV) | −15.35946 | −15.35946 | 0 | −14.63489 | −14.63489 | −14.63489 | −14.63489 |
| ΔE_{H}_{₂}_{MO} (AO/HO) (eV) | 0 | 0 | 0 | 0 | 0 | 0 | 0 |
| E_{T} (AO/HO) (eV) | −15.35946 | −15.35946 | 0 | −14.63489 | −14.63489 | −14.63489 | −14.63489 |
| E_{T} (H₂MO) (eV) | −31.63535 | −31.63535 | −63.27075 | −31.63534 | −31.63534 | −31.63534 | −49.66437 |
| E_{T} (atom-atom, | −1.44915 | −1.44915 | −2.26759 | −1.44915 | −1.85836 | −1.44915 | 0 |
| msp³.AO) (eV) | | | | | | | |
| E_{T} (MO) (eV) | −33.08452 | −33.08452 | −65.53833 | −33.08452 | −33.49373 | −33.08452 | −49.66493 |
| ω (10¹⁵ rad/s) | 9.55643 | 9.55643 | 43.0680 | 9.97851 | 16.4962 | 9.97851 | 25.2077 |
| E_{K} (eV) | 6.29021 | 6.29021 | 28.34813 | 6.56803 | 10.85807 | 6.56803 | 16.59214 |
| Ē_{D} (eV) | −0.16416 | −0.16416 | −0.34517 | −0.16774 | −0.21834 | −0.16774 | −0.25493 |
| Ē_{Kvib} (eV) | 0.12312 [6] | 0.12312 [6] | 0.17897 [74] | 0.15895 [75] | 0.09931 [76] | 0.09931 [76] | 0.35532 |
| | | | | | | | Eq. |
| | | | | | | | (13.458) |
| Ē_{osc} (eV) | −0.10260 | −0.10260 | −0.25568 | −0.08827 | −0.16869 | −0.11809 | −0.07727 |
| E_{mag} (eV) | 0.14803 | 0.14803 | 0.14803 | 0.14803 | 0.14803 | 0.14803 | 0.14803 |
| E_{T} (Group) (eV) | −33.18712 | −33.18712 | −66.04969 | −33.17279 | −33.66242 | −33.20260 | −49.81948 |
| Eᵢₙᵢₜᵢₐₗ (c₄ AO/HO) (eV) | −14.63489 | −14.63489 | −14.63489 | −14.63489 | −14.63489 | −14.63489 | −14.63489 |
| Eᵢₙᵢₜᵢₐₗ (c₅ AO/HO) (eV) | 0 | 0 | 0 | 0 | 0 | 0 | −13.59844 |
| E_{D} (Group) (eV) | 3.62128 | 3.91734 | 7.51014 | 3.75498 | 4.39264 | 3.78480 | 7.83968 |

| | | | C—C | | | | |
|---|---|---|---|---|---|---|---|
| | C^{3e}═C | CH (ii) | (iv) | C—C(O) | C═O | C—O | OH |
| Parameters | Group | Group | Group | Group | Group | Group | Group |
| f₁ | 0.75 | 1 | 1 | 1 | 1 | 1 | 1 |
| n₁ | 2 | 1 | 1 | 1 | 2 | 1 | 1 |
| n₂ | 0 | 0 | 0 | 0 | 0 | 0 | 0 |
| n₃ | 0 | 0 | 0 | 0 | 0 | 0 | 0 |
| C₁ | 0.5 | 0.75 | 0.5 | 0.5 | 0.5 | 0.5 | 0.75 |
| C₂ | 0.85252 | 1 | 1 | 1 | 1 | 1 | 1 |
| c₁ | 1 | 1 | 1 | 1 | 1 | 1 | 0.75 |
| c₂ | 0.85252 | 0.91771 | 0.91771 | 0.91771 | 0.85395 | 0.85395 | 1 |
| c₃ | 0 | 1 | 0 | 0 | 2 | 0 | 1 |
| c₄ | 3 | 1 | 2 | 2 | 4 | 2 | 1 |
| c₅ | 0 | 1 | 0 | 0 | 0 | 0 | 1 |
| C₁ₒ | 0.5 | 0.75 | 0.5 | 0.5 | 0.5 | 0.5 | 0.75 |
| C₂ₒ | 0.85252 | 1 | 1 | 1 | 1 | 1 | 1 |
| Vₑ (eV) | −101.12679 | −37.10024 | −29.95792 | −32.15216 | −111.25473 | −35.08488 | −40.92709 |
| Vₚ (eV) | 20.69825 | 13.17125 | 9.47952 | 9.74055 | 23.87467 | 10.32968 | 14.81988 |
| T (eV) | 34.31559 | 11.58941 | 7.27120 | 8.23945 | 42.82081 | 10.11150 | 16.18567 |
| Vₘ (eV) | −17.15779 | −5.79470 | −3.63560 | −4.11973 | −21.41040 | −5.05575 | −8.09284 |
| E (AO/HO) (eV) | 0 | −14.63489 | −15.35946 | −14.63489 | 0 | −14.63489 | −13.6181 |
| ΔE_{H}_{₂}_{MO} (AO/HO) (eV) | 0 | −1.13379 | −0.56690 | −1.29147 | −2.69893 | −2.69893 | 0 |
| E_{T} (AO/HO) (eV) | 0 | −13.50110 | −14.79257 | −13.34342 | 2.69893 | −11.93596 | −13.6181 |
| E_{T} (H₂MO) (eV) | −63.27075 | −31.63539 | −31.63537 | −31.63530 | −63.27074 | −31.63541 | −31.63247 |
| E_{T} (atom-atom, | −2.26759 | −0.56690 | −1.13379 | −1.29147 | −2.69893 | −1.85836 | 0 |
| msp³.AO) (eV) | | | | | | | |
| E_{T} (MO) (eV) | −65.53833 | −32.20226 | −32.76916 | −32.92684 | −65.96966 | −33.49373 | −31.63537 |
| ω (10¹⁵ rad/s) | 49.7272 | 26.4826 | 16.2731 | 10.7262 | 59.4034 | 24.3637 | 44.1776 |
| E_{K} (eV) | 32.73133 | 17.43132 | 10.71127 | 7.06019 | 39.10034 | 16.03660 | 29.07844 |
| Ē_{D} (eV) | −0.35806 | −0.26130 | −0.21217 | −0.17309 | −0.40804 | −0.26535 | −0.33749 |
| Ē_{Kvib} (eV) | 0.19649 [30] | 0.35532 | 0.14940 [43] | 0.10502 [77] | 0.21077 [78] | 0.14010 [79] | 0.46311 [80-81] |
| | | Eq. | | | | | |
| | | (13.458) | | | | | |
| Ē_{osc} (eV) | −0.25982 | −0.08364 | −0.13747 | −0.12058 | −0.30266 | −0.19530 | −0.10594 |
| E_{mag} (eV) | 0.14803 | 0.14803 | 0.14803 | 0.14803 | 0.11441 | 0.14803 | 0.11441 |
| E_{T} (Group) (eV) | −49.54347 | −32.28590 | −32.90663 | −33.04742 | −66.57498 | −33.68903 | −31.74130 |
| Eᵢₙᵢₜᵢₐₗ (c₄ AO/HO) (eV) | −14.63489 | −14.63489 | −14.63489 | −14.63489 | −14.63489 | −14.63489 | −13.6181 |
| Eᵢₙₜᵢₐₗ (c₅ AO/HO) (eV) | 0 | −13.59844 | 0 | 0 | 0 | 0 | −13.59844 |
| E_{D} (Group) (eV) | 5.63881 | 3.90454 | 3.63685 | 3.77764 | 7.80660 | 4.41925 | 4.41035 |

TABLE 152
The total bond energies of gaseous-state tin compounds calculated using the functional
group composition (separate functional groups designated in the first row) and the energies of Tables 151
A and B compared to the gaseous-state experimental values except where indicated.

| | | | | | | | | | | CH₂ | CH | C—C | C—C | C—C | | C—C | CH₂ |
|---|---|---|---|---|---|---|---|---|---|---|---|---|---|---|---|---|---|
| Formula | Name | SnCl | SnBi | SnI | SnO | SnH | SnC | SnSn | CH₃ | (i) | (i) | (a) | (b) | (c) | C═C | (ii) | (ii) |
| SnCl₄ | Tin tetrachloride | 4 | 0 | 0 | 0 | 0 | 0 | 0 | 0 | 0 | 0 | 0 | 0 | 0 | 0 | 0 | 0 |
| CH₃Cl₃Sn | Methyltin trichloride | 3 | 0 | 0 | 0 | 0 | 1 | 0 | 1 | 0 | 0 | 0 | 0 | 0 | 0 | 0 | 0 |
| C₂H₆Cl₂Sn | Dimethyltin dichloride | 2 | 0 | 0 | 0 | 0 | 2 | 0 | 2 | 0 | 0 | 0 | 0 | 0 | 0 | 0 | 0 |
| C₃H₉ClSn | Trimethylin Chloride | 1 | 0 | 0 | 0 | 0 | 3 | 0 | 3 | 0 | 0 | 0 | 0 | 0 | 0 | 0 | 0 |
| SnBr₄ | Tin tetrabromide | 0 | 4 | 0 | 0 | 0 | 0 | 0 | 0 | 0 | 0 | 0 | 0 | 0 | 0 | 0 | 0 |
| C₃H₉BrSn | Trimethyltin bromide | 0 | 1 | 0 | 0 | 0 | 3 | 0 | 3 | 0 | 0 | 0 | 0 | 0 | 0 | 0 | 0 |
| C₁₂H₁₀Br₂Sn | Diphenyltin dibromide | 0 | 2 | 0 | 0 | 0 | 2 | 0 | 0 | 0 | 0 | 0 | 0 | 0 | 0 | 0 | 0 |
| C₁₂H₂₇BrSn | Tri-n-butyltin bromide | 0 | 1 | 0 | 0 | 0 | 3 | 0 | 3 | 9 | 0 | 9 | 0 | 0 | 0 | 0 | 0 |
| C₁₈H₁₅BrSn | Triphenyltin bromide | 0 | 1 | 0 | 0 | 0 | 3 | 0 | 0 | 0 | 0 | 0 | 0 | 0 | 0 | 0 | 0 |
| SnI₄ | Tin tetraiodide | 0 | 0 | 4 | 0 | 0 | 0 | 0 | 0 | 0 | 0 | 0 | 0 | 0 | 0 | 0 | 0 |
| C₃H₉ISn | Trimethyltin iodide | 0 | 0 | 1 | 0 | 0 | 3 | 0 | 3 | 0 | 0 | 0 | 0 | 0 | 0 | 0 | 0 |
| C₁₈H₁₅SnI | Triphenyltin iodide | 0 | 0 | 1 | 0 | 0 | 3 | 0 | 0 | 0 | 0 | 0 | 0 | 0 | 0 | 0 | 0 |
| SnO | Tin oxide | 0 | 0 | 0 | 1 | 0 | 0 | 0 | 0 | 0 | 0 | 0 | 0 | 0 | 0 | 0 | 0 |
| SnH₄ | Stannane | 0 | 0 | 0 | 0 | 4 | 0 | 0 | 0 | 0 | 0 | 0 | 0 | 0 | 0 | 0 | 0 |
| C₂H₈Sn | Dimethylstannane | 0 | 0 | 0 | 0 | 2 | 2 | 0 | 2 | 0 | 0 | 0 | 0 | 0 | 0 | 0 | 0 |
| C₃H₁₀Sn | Trimethylstannane | 0 | 0 | 0 | 0 | 1 | 3 | 0 | 3 | 0 | 0 | 0 | 0 | 0 | 0 | 0 | 0 |
| C₄H₁₂Sn | Diethylstannane | 0 | 0 | 0 | 0 | 2 | 2 | 0 | 2 | 2 | 0 | 2 | 0 | 0 | 0 | 0 | 0 |
| C₄H₁₂Sn | Tetramethyltin | 0 | 0 | 0 | 0 | 0 | 4 | 0 | 4 | 0 | 0 | 0 | 0 | 0 | 0 | 0 | 0 |
| C₅H₁₂Sn | Trimethylvinyltin | 0 | 0 | 0 | 0 | 0 | 4 | 0 | 3 | 0 | 1 | 0 | 0 | 0 | 1 | 0 | 1 |
| C₅H₁₄Sn | Trimethylethyltin | 0 | 0 | 0 | 0 | 0 | 4 | 0 | 4 | 1 | 0 | 1 | 0 | 0 | 0 | 0 | 0 |
| C₆H₁₆Sn | Trimethylisopropyltin | 0 | 0 | 0 | 0 | 0 | 4 | 0 | 5 | 0 | 1 | 0 | 2 | 0 | 0 | 0 | 0 |
| C₈H₁₂Sn | Tetravinyltin | 0 | 0 | 0 | 0 | 0 | 4 | 0 | 0 | 0 | 4 | 0 | 0 | 0 | 4 | 0 | 4 |
| C₆H₁₈Sn₂ | Hexamethyldistannane | 0 | 0 | 0 | 0 | 0 | 6 | 1 | 6 | 0 | 0 | 0 | 0 | 0 | 0 | 0 | 0 |
| C₇H₁₈Sn | Trimethyl-t-butyltin | 0 | 0 | 0 | 0 | 0 | 4 | 0 | 6 | 0 | 0 | 0 | 0 | 3 | 0 | 0 | 0 |
| C₉H₁₄Sn | Trimethylphenyltin | 0 | 0 | 0 | 0 | 0 | 4 | 0 | 3 | 0 | 0 | 0 | 0 | 0 | 0 | 0 | 0 |
| C₈H₁₈Sn | Triethylvinyltin | 0 | 0 | 0 | 0 | 0 | 4 | 0 | 3 | 3 | 1 | 3 | 0 | 0 | 1 | 0 | 1 |
| C₈H₂₀Sn | Tetraethyltin | 0 | 0 | 0 | 0 | 0 | 4 | 0 | 4 | 4 | 0 | 4 | 0 | 0 | 0 | 0 | 0 |
| C₁₀H₁₆Sn | Trimethylbenzyltin | 0 | 0 | 0 | 0 | 0 | 4 | 0 | 3 | 1 | 0 | 0 | 0 | 0 | 0 | 0 | 0 |
| C₁₀H₁₄O₂Sn | Trimethyltin benzoate | 0 | 0 | 0 | 0 | 0 | 4 | 0 | 3 | 0 | 0 | 0 | 0 | 0 | 0 | 0 | 0 |
| C₁₀H₂₀Sn | Tetra-allyltin | 0 | 0 | 0 | 0 | 0 | 4 | 0 | 0 | 4 | 4 | 0 | 0 | 0 | 4 | 0 | 4 |
| C₁₂H₂₈Sn | Tetra-n-propyltin | 0 | 0 | 0 | 0 | 0 | 4 | 0 | 4 | 8 | 0 | 8 | 0 | 0 | 0 | 0 | 0 |
| C₁₂H₂₈Sn | Tetraisopropyltin | 0 | 0 | 0 | 0 | 0 | 4 | 0 | 8 | 0 | 4 | 0 | 4 | 0 | 0 | 0 | 0 |
| C₁₂H₃₀Sn₂ | Hexaethyldistannane | 0 | 0 | 0 | 0 | 0 | 6 | 1 | 6 | 6 | 0 | 6 | 0 | 0 | 0 | 0 | 0 |
| C₁₉H₁₈Sn | Triphenylmethyltin | 0 | 0 | 0 | 0 | 0 | 4 | 0 | 1 | 0 | 0 | 0 | 0 | 0 | 0 | 0 | 0 |
| C₂₀H₂₀Sn | Triphenylethyltin | 0 | 0 | 0 | 0 | 0 | 4 | 0 | 1 | 1 | 0 | 1 | 0 | 0 | 0 | 0 | 0 |
| C₁₆H₃₆Sn | Tetra-n-butyltin | 0 | 0 | 0 | 0 | 0 | 4 | 0 | 4 | 12 | 0 | 12 | 0 | 0 | 0 | 0 | 0 |
| C₁₆H₃₆Sn | Tetraisobutyltin | 0 | 0 | 0 | 0 | 0 | 4 | 0 | 8 | 4 | 4 | 0 | 12 | 0 | 0 | 0 | 0 |
| C₂₁H₂₄Sn₂ | Triphenyl- | 0 | 0 | 0 | 0 | 0 | 6 | 1 | 3 | 0 | 0 | 0 | 0 | 0 | 0 | 0 | 0 |
| | trimethyldistannane | | | | | | | | | | | | | | | | |
| C₂₄H₂₀Sn | Tetraphenyltin | 0 | 0 | 0 | 0 | 0 | 4 | 0 | 0 | 0 | 0 | 0 | 0 | 0 | 0 | 0 | 0 |
| C₂₄H₄₄Sn | Tetracyclohexyltin | 0 | 0 | 0 | 0 | 0 | 4 | 0 | 0 | 20 | 4 | 24 | 0 | 0 | 0 | 0 | 0 |
| C₃₆H₃₀Sn₂ | Hexaphenyldistannane | 0 | 0 | 0 | 0 | 0 | 6 | 1 | 0 | 0 | 0 | 0 | 0 | 0 | 0 | 0 | 0 |

| | | | | | | | | | Calculated | Experimental | |
|---|---|---|---|---|---|---|---|---|---|---|---|
| | | | CH | C—C | | | | | Total Bond | Total Bond | Relative |
| Formula | Name | C^{3e}═C | (ii) | (iv) | C—C(O) | C═O | C—O | OH | Energy (eV) | Energy (eV) | Error |
| SnCl₄ | Tin tetrachloride | 0 | 0 | 0 | 0 | 0 | 0 | 0 | 12.95756 | 13.03704 [82] | 0.00610 |
| CH₃Cl₃Sn | Methyltin trichioride | 0 | 0 | 0 | 0 | 0 | 0 | 0 | 24.69530 | 25.69118^{a} [83] | 0.03876 |
| C₂H₆Cl₂Sn | Dimethyltin dichloride | 0 | 0 | 0 | 0 | 0 | 0 | 0 | 36.43304 | 37.12369 [84] | 0.01860 |
| C₃H₉ClSn | Trimethylin Chloride | 0 | 0 | 0 | 0 | 0 | 0 | 0 | 48.17077 | 49.00689 [84] | 0.01706 |
| SnBr₄ | Tin tetrabromide | 0 | 0 | 0 | 0 | 0 | 0 | 0 | 10.98655 | 11.01994 [82] | 0.00303 |
| C₃H₉BrSn | Trimethyltin bromide | 0 | 0 | 0 | 0 | 0 | 0 | 0 | 47.67802 | 48.35363 [84] | 0.01397 |
| C₁₂H₁₀Br₂Sn | Diphenyltin dibromide | 12 | 10 | 0 | 0 | 0 | 0 | 0 | 117.17489 | 117.36647^{a} [83] | 0.00163 |
| C₁₂H₂₇BrSn | Tri-n-butyltin bromide | 0 | 0 | 0 | 0 | 0 | 0 | 0 | 157.09732 | 157.26555^{a} [83] | 0.00107 |
| C₁₈H₁₅BrSn | Triphenyltin bromide | 18 | 15 | 0 | 0 | 0 | 0 | 0 | 170.26905 | 169.91511^{a} [83] | −0.00208 |
| SnI₄ | Tin tetraiodide | 0 | 0 | 0 | 0 | 0 | 0 | 0 | 9.71697 | 9.73306 [85] | 0.00165 |
| C₃H₉ISn | Trimethyltin iodide | 0 | 0 | 0 | 0 | 0 | 0 | 0 | 47.36062 | 47.69852 [84] | 0.00708 |
| C₁₈H₁₅SnI | Triphenyltin iodide | 18 | 15 | 0 | 0 | 0 | 0 | 0 | 169.95165 | 167.87948^{a} [84] | −0.01234 |
| SnO | Tin oxide | 0 | 0 | 0 | 0 | 0 | 0 | 0 | 5.61858 | 5.54770 [82] | −0.01278 |
| SnH₄ | Stannane | 0 | 0 | 0 | 0 | 0 | 0 | 0 | 10.54137 | 10.47181 [82] | −0.00664 |
| C₂H₈Sn | Dimethylstannane | 0 | 0 | 0 | 0 | 0 | 0 | 0 | 35.22494 | 35.14201 [84] | −0.00236 |
| C₃H₁₀Sn | Trimethylstannane | 0 | 0 | 0 | 0 | 0 | 0 | 0 | 47.56673 | 47.77353 [84] | 0.00433 |
| C₄H₁₂Sn | Diethylstannane | 0 | 0 | 0 | 0 | 0 | 0 | 0 | 59.54034 | 59.50337 [84] | −0.00062 |
| C₄H₁₂Sn | Tetramethyltin | 0 | 0 | 0 | 0 | 0 | 0 | 0 | 59.90851 | 60.13973 [82] | 0.00384 |
| C₅H₁₂Sn | Trimethylvinyltin | 0 | 0 | 0 | 0 | 0 | 0 | 0 | 66.09248 | 66.43260 [84] | 0.00526 |
| C₅H₁₄Sn | Trimethylethyltin | 0 | 0 | 0 | 0 | 0 | 0 | 0 | 72.06621 | 72.19922 [83] | 0.00184 |
| C₆H₁₆Sn | Trimethylisopropyltin | 0 | 0 | 0 | 0 | 0 | 0 | 0 | 84.32480 | 84.32346 [83] | −0.00002 |
| C₈H₁₂Sn | Tetravinyltin | 0 | 0 | 0 | 0 | 0 | 0 | 0 | 84.64438 | 86.53803^{a} [83] | 0.02188 |
| C₆H₁₈Sn₂ | Hexamethyldistannane | 0 | 0 | 0 | 0 | 0 | 0 | 0 | 91.96311 | 91.75569 [83] | −0.00226 |
| C₇H₁₈Sn | Trimethyl-t-butyltin | 0 | 0 | 0 | 0 | 0 | 0 | 0 | 96.81417 | 96.47805 [82] | −0.00348 |
| C₉H₁₄Sn | Trimethylphenyltin | 6 | 5 | 0 | 0 | 0 | 0 | 0 | 100.77219 | 100.42716 [83] | −0.00344 |
| C₈H₁₈Sn | Triethylvinyltin | 0 | 0 | 0 | 0 | 0 | 0 | 0 | 102.56558 | 102.83906^{a} [83] | −0.00266 |
| C₈H₂₀Sn | Tetraethyltin | 0 | 0 | 0 | 0 | 0 | 0 | 0 | 108.53931 | 108.43751 [83] | −0.00094 |
| C₁₀H₁₆Sn | Trimethylbenzyltin | 6 | 5 | 1 | 0 | 0 | 0 | 0 | 112.23920 | 112.61211 [83] | 0.00331 |
| C₁₀H₁₄O₂Sn | Trimethyltin benzoate | 6 | 4 | 0 | 1 | 1 | 1 | 1 | 117.28149 | 119.31199^{a} [83] | 0.01702 |
| C₁₀H₂₀Sn | Tetra-allyltin | 0 | 0 | 4 | 0 | 0 | 0 | 0 | 133.53558 | 139.20655^{a} [83] | 0.04074 |
| C₁₂H₂₈Sn | Tetra-n-propyltin | 0 | 0 | 0 | 0 | 0 | 0 | 0 | 157.17011 | 157.01253 [83] | −0.00100 |
| C₁₂H₂₈Sn | Tetraisopropyltin | 0 | 0 | 0 | 0 | 0 | 0 | 0 | 157.57367 | 156.9952 [83] | −0.00366 |
| C₁₂H₃₀Sn₂ | Hexaethyldistannane | 0 | 0 | 0 | 0 | 0 | 0 | 0 | 164.90931 | 164.76131^{a} [83] | −0.00090 |
| C₁₉H₁₈Sn | Triphenylmethyltin | 18 | 15 | 0 | 0 | 0 | 0 | 0 | 182.49954 | 180.97881^{a} [84] | −0.00840 |
| C₂₀H₂₀Sn | Triphenylethyltin | 18 | 15 | 0 | 0 | 0 | 0 | 0 | 194.65724 | 192.92526^{a} [84] | −0.00898 |
| C₁₆H₃₆Sn | Tetra-n-butyltin | 0 | 0 | 0 | 0 | 0 | 0 | 0 | 205.80091 | 205.60055 [83] | −0.00097 |
| C₁₆H₃₆Sn | Tetraisobutyltin | 0 | 0 | 0 | 0 | 0 | 0 | 0 | 206.09115 | 206.73234 [83] | 0.003.10 |
| C₂₁H₂₄Sn₂ | Triphenyl- | 18 | 15 | 0 | 0 | 0 | 0 | 0 | 214.55414 | 212.72973^{a} [84] | −0.00858 |
| | trimethyldistannane | | | | | | | | | | |
| C₂₄H₂₀Sn | Tetraphenyltin | 24 | 20 | 0 | 0 | 0 | 0 | 0 | 223.36322 | 221.61425 [83] | −0.00789 |
| C₂₄H₄₄Sn | Tetracyclohexyltin | 0 | 0 | 0 | 0 | 0 | 0 | 0 | 283.70927 | 284.57603 [83] | 0.00305 |
| C₃₆H₃₀Sn₂ | Hexaphenyldistannane | 36 | 30 | 0 | 0 | 0 | 0 | 0 | 337.14517 | 333.27041 [83] | −0.01163 |

^{a}Crystal.

TABLE 153
The bond angle parameters of tin compounds and experimental values [3]. In the calculation of θᵥ, the parameters from
the preceding angle were used. E_{T} is E_{T} (atom-atom, msp³.AO).

| | | | 2c′ | | Atom 1 | | Atom 2 | | |
|---|---|---|---|---|---|---|---|---|---|
| | 2c′ | 2c′ | Terminal | | Hybridization | | Hybridization | | |
| | Bond 1 | Bond 2 | Atoms | E_{Coulombic} | Designation | E_{Coulombic} | Designation | c₂ | c₂ |
| Atoms of Angle | (a₀) | (a₀) | (a₀) | Atom 1 | (Table 7) | Atom 2 | (Table 7) | Atom 1 | Atom 2 |
| ∠ClSnCl | 4.33286 | 4.33286 | 6.9892 | −12.96764 | Cl | −12.96764 | Cl | 0.71514 | 0.71514 |
| | | | | Cl | | Cl | | | |
| ∠HSnH | 3.26599 | 3.26599 | 5.3417 | −9.32137 | (Eq. 23.221) | H | H | 0.68510 | 1 |
| | | | | Sn | | | | | |
| ∠CSnC | 4.10053 | 4.10053 | 6.7082 | −14.82575 | 1 | −14.82575 | 1 | 0.91771 | 0.91771 |
| Methyl | 2.09711 | 2.09711 | 3.4252 | −15.75493 | 7 | H | H | 0.86359 | 1 |
| ∠HCₐH | | | | | | | | | |
| ∠HCₐSn | | | | | | | | | |
| ∠CₐC_{b}C_{c} | | | | | | | | | |
| Methylene | 2.11106 | 2.11106 | 3.4252 | −15.75493 | 7 | H | H | 0.86359 | 1 |
| ∠HCₐH | | | | | | | | | |
| ∠CₐC_{b}C_{c} | | | | | | | | | |
| ∠CₐC_{b}H | | | | | | | | | |
| Methyl | 2.09711 | 2.09711 | 3.4252 | −15.75493 | 7 | H | H | 0.86359 | 1 |
| ∠HCₐH | | | | | | | | | |
| ∠CₐC_{b}C_{c} | | | | | | | | | |
| ∠CₐC_{b}H | | | | | | | | | |
| ∠C_{b}CₐC_{c} | 2.91547 | 2.91547 | 4.7958 | −16.68412 | 26 | −16.68412 | 26 | 0.81549 | 0.81549 |
| iso Cₐ | | | | C_{b} | | C_{c} | | | |
| ∠C_{b}CₐH | 2.91547 | 2.11323 | 4.1633 | −15.55033 | 5 | −14.82575 | 1 | 0.87495 | 0.91771 |
| iso Cₐ | | | | Cₐ | | C_{b} | | | |
| ∠CₐC_{b}H | 2.91547 | 2.09711 | 4.1633 | −15.55033 | 5 | −14.82575 | 1 | 0.87495 | 0.91771 |
| iso Cₐ | | | | C_{b} | | Cₐ | | | |
| ∠C_{b}CₐC_{b} | 2.90327 | 2.90327 | 4.7958 | −16.68412 | 26 | −16.68412 | 26 | 0.81549 | 0.81549 |
| tert Cₐ | | | | C_{b} | | C_{b} | | | |
| ∠C_{b}CₐC_{d} | | | | | | | | | |
| ∠HCₐC_{c} | 2.11323 | 2.86175 | 4.2895 | −15.95954 | 10 | −14.82575 | 1 | 0.85252 | 0.91771 |
| (C_{c}(H)Cₐ═C_{b}) | | | | Cₐ | | C_{c} | | | |
| ∠C_{c}CₐC_{c} | 2.86175 | 2.86175 | 4.7958 | −16.68411 | 25 | −16.68411 | 25 | 0.81549 | 0.81549 |
| (C_{c}(C_{c})Cₐ═C_{b}) | | | | C_{c} | | C_{c} | | | |
| ∠C_{b}CₐC_{c} | 2.53321 | 2.86175 | 4.7539 | −16.88873 | 30 | −16.68411 | 25 | 0.80561 | 0.81549 |
| (C_{b}═CₐC_{c}) | | | | C_{b} | | C_{c} | | | |
| ∠HCₐC_{b} | | | | | | | | | |
| ∠HCₐH | 2.04578 | 2.04578 | 3.4756 | −15.95955 | 10 | H | H | 0.85252 | 1 |
| (H₂Cₐ═C_{b}C_{c}) | | | | | | | | | |
| ∠C_{b}CₐH | | | | | | | | | |
| (H₂Cₐ═C_{b}C_{c}) | | | | | | | | | |
| ∠CCC | 2.62936 | 2.62936 | 4.5585 | −17.17218 | 38 | −17.17218 | 38 | 0.79232 | 0.79232 |
| (aromatic) | | | | | | | | | |
| ∠CCH | | | | | | | | | |
| (aromatic) | | | | | | | | | |
| ∠CₐO_{b}H | 2.63431 | 1.83616 | 3.6405 | −14.82575 | 1 | −14.82575 | 1 | 1 | 0.91771 |
| ∠C_{b}CₐOₐ | 2.82796 | 2.27954 | 4.4721 | −17.17218 | 38 | −13.61806 | O | 0.79232 | 0.85395 |
| | | | | | | | | | (Eq. (15.133)) |
| ∠C_{b}CₐO_{b} | 2.82796 | 2.63431 | 4.6690 | −16.40067 | 20 | −13.61806 | O | 0.82959 | 0.85395 |
| | | | | | | | | | (Eq. (15.133)) |
| ∠OₐCₐO_{b} | 2.27954 | 2.63431 | 4.3818 | −16.17521 | 13 | −15.75493 | 7 | 0.84115 | 0.86359 |
| | | | | Oₐ | | O_{b} | | | |

| | | | | | E_{T} | θᵥ | θ₁ | θ₂ | Cal. θ | Exp. θ |
|---|---|---|---|---|---|---|---|---|---|---|
| Atoms of Angle | C₁ | C₂ | c₁ | c₂′ | (eV) | (°) | (°) | (°) | (°) | (°) |
| ∠ClSnCl | 0.75 | 0.71514 | 1 | 0.71514 | −0.87386 | | | | 107.52 | 109.5 |
| | | | | | | | | | | (tin |
| | | | | | | | | | | tetrachloride) |
| ∠HSnH | 0.75 | 1 | 1 | 0.68510 | −1.65813 | | | | 109.72 | 109.5 |
| | | | | | (Eq. 23.236) | | | | | (stannane) |
| ∠CSnC | 1 | 1 | 1 | 0.91771 | 0 | | | | 109.76 | 109.5 |
| | | | | | | | | | | (tetramethyltin) |
| Methyl | 1 | 1 | 0.75 | 1.15796 | 0 | | | | 109.50 | |
| ∠HCₐH | | | | | | | | | | |
| ∠HCₐSn | | | | | | 70.56 | | | 109.44 | |
| ∠CₐC_{b}C_{c} | | | | | | 70.56 | | | 109.44 | |
| Methylene | 1 | 1 | 0.75 | 1.15796 | 0 | | | | 108.44 | 107 |
| ∠HCₐH | | | | | | | | | | (propane) |
| ∠CₐC_{b}C_{c} | | | | | | 69.51 | | | 110.49 | 112 |
| | | | | | | | | | | (propane) |
| | | | | | | | | | | 113.8 |
| | | | | | | | | | | (butane) |
| | | | | | | | | | | 110.8 |
| | | | | | | | | | | (isobutane) |
| ∠CₐC_{b}H | | | | | | 69.51 | | | 110.49 | 111.0 |
| | | | | | | | | | | (butane) |
| | | | | | | | | | | 111.4 |
| | | | | | | | | | | (isobutane) |
| Methyl | 1 | 1 | 0.75 | 1.15796 | 0 | | | | 109.50 | |
| ∠HCₐH | | | | | | | | | | |
| ∠CₐC_{b}C_{c} | | | | | | 70.56 | | | 109.44 | |
| ∠CₐC_{b}H | | | | | | 70.56 | | | 109.44 | |
| ∠C_{b}CₐC_{c} | 1 | 1 | 1 | 0.81549 | −1.85836 | | | | 110.67 | 110.8 |
| iso Cₐ | | | | | | | | | | (isobutane) |
| ∠C_{b}CₐH | 0.75 | 1 | 0.75 | 1.04887 | 0 | | | | 110.76 | |
| iso Cₐ | | | | | | | | | | |
| ∠CₐC_{b}H | 0.75 | 1 | 0.75 | 1.04887 | 0 | | | | 111.27 | 111.4 |
| iso Cₐ | | | | | | | | | | (isobutane) |
| ∠C_{b}CₐC_{b} | 1 | 1 | 1 | 0.81549 | −1.85836 | | | | 111.37 | 110.8 |
| tert Cₐ | | | | | | | | | | (isobutane) |
| ∠C_{b}CₐC_{d} | | | | | | 72.50 | | | 107.50 | |
| ∠HCₐC_{c} | 0.75 | 1 | 0.75 | 1.07647 | 0 | | | | 118.36 | |
| (C_{c}(H)Cₐ═ | | | | | | | | | | |
| ∠C_{c}CₐC_{c} | 1 | 1 | 1 | 0.81549 | −1.85836 | | | | 113.84 | |
| (C_{c}(C_{c})Cₐ═ | | | | | | | | | | |
| ∠C_{b}CₐC_{c} | 1 | 1 | 1 | 0.81055 | −1.85836 | | | | 123.46 | 124.4 |
| (C_{b}═CₐC_{c}) | | | | | | | | | | (1,3,5- |
| | | | | | | | | | | hexatriene |
| | | | | | | | | | | CbCcCc) |
| | | | | | | | | | | 121.7 |
| | | | | | | | | | | (1,3,5- |
| | | | | | | | | | | hexatriene |
| | | | | | | | | | | CaCbCc) |
| | | | | | | | | | | 124.4 |
| | | | | | | | | | | (1,3-butadiene |
| | | | | | | | | | | CCC) |
| | | | | | | | | | | 125.3 |
| | | | | | | | | | | (2-butene |
| | | | | | | | | | | CbCaCc) |
| ∠HCₐC_{b} | | | | | | | 118.36 | 123.46 | 118.19 | |
| ∠HCₐH | 1 | 1 | 0.75 | 1.17300 | 0 | | | | 116.31 | 118.5 |
| (H₂Cₐ═C_{b}C | | | | | | | | | | (2- |
| | | | | | | | | | | methylpropene) |
| ∠C_{b}CₐH | | | | | | | 116.31 | | 121.85 | 121 |
| (H₂Cₐ═C_{b}C | | | | | | | | | | (2- |
| | | | | | | | | | | methylpropene) |
| ∠CCC | 1 | 1 | 1 | 0.79232 | −1.85836 | | | | 120.19 | 120 [34-36] |
| (aromatic) | | | | | | | | | | (benzene) |
| ∠CCH | | | | | | | 120.19 | | 119.91 | 120 [34-36] |
| (aromatic) | | | | | | | | | | (benzene) |
| ∠CₐO_{b}H | 0.75 | 1 | 0.75 | 0.91771 | 0 | | | | 107.71 | |
| ∠C_{b}CₐOₐ | 1 | 1 | 1 | 0.82313 | −1.65376 | | | | 121.86 | 122 [55] |
| | | | | | | | | | | (benzoic acid) |
| ∠C_{b}CₐO_{b} | 1 | 1 | 1 | 0.84177 | −1.65376 | | | | 117.43 | 118 [55] |
| | | | | | | | | | | (benzoic acid) |
| ∠OₐCₐO_{b} | 1 | 1 | 1 | 0.85237 | −1.44915 | | | | 126.03 | 122 [55] |
| | | | | | | | | | | (benzoic acid) |

Lead Organometallic Functional Groups and Molecules

The branched-chain alkyl lead molecules, PbCₙH₂ₙ₋₂, comprise at least one Pb bound by a carbon-lead single bond comprising a C—Pb group, at least a terminal methyl group (CH₃), and may comprise methylene (CH₂), methylyne (CH), and C—C functional groups. The methyl and methylene functional groups are equivalent to those of straight-chain alkanes. Six types of C—C bonds can be identified. The n-alkane C—C bond is the same as that of straight-chain alkanes. In addition, the C—C bonds within isopropyl ((CH₃)₂CH) and t-butyl ((CH₃)₃C) groups and the isopropyl to isopropyl, isopropyl to t-butyl, and t-butyl to t-butyl C—C bonds comprise functional groups.

As in the cases of carbon, silicon, tin, and germanium, the bonding in the lead atom involves four sp³ hybridized orbitals. For lead, they are formed from the 6p and 6s electrons of the outer shells. Pb—C bonds form between a Pb6sp³ HO and a C3sp³ HO to yield alkyl leads. The geometrical parameters of the Pb—C functional group is solved using Eq. (15.51) and the relationships between the prolate spheroidal axes. Then, the sum of the energies of the H₂-type ellipsoidal MOs is matched to that of the Pb6sp³ shell as in the case of the corresponding carbon, silicon, tin, germanium molecules. As in the case of the transition metals, the energy of each functional group is determined for the effect of the electron density donation from the each participating C3sp³ HO and Pb6sp³ HO to the corresponding MO that maximizes the bond energy.

The Pb electron configuration is [Xe]6s²4f¹⁴5d¹⁰6p², and the orbital arrangement is

$$\frac{↑}{1} {\frac{↑}{0}}^{6 p state} \frac{ }{- 1} \qquad ( 23.244 )$$

corresponding to the ground state ³P₀. The energy of the lead 6p shell is the negative of the ionization energy of the lead atom [1] given by

E(Pb,6p shell)=−E(ionization; Pb)=−7.41663 eV (23.245)

The energy of lead is less than the Coulombic energy between the electron and proton of H given by Eq. (1.231), but the atomic orbital may hybridize in order to achieve a bond at an energy minimum. After Eq. (13.422), the Pb6s atomic orbital (AO) combines with the Pb6p AOs to form a single Pb6sp³ hybridized orbital (HO) with the orbital arrangement

$$\frac{↑}{0 , 0} {\frac{↑}{1 , - 1} \frac{↑}{1 , 0}}^{6 {sp}^{3} state} \frac{↑}{1 , 1} \qquad ( 23.246 )$$

where the quantum numbers (l, mₗ) are below each electron. The total energy of the state is given by the sum over the four electrons. The sum E_{T}(Pb,6sp³) of experimental energies [1] of Pb, Pb⁺, Pb²⁺, and Pb³⁺ is

E_{T}(Pb,6sp³)=42.32 eV+31.9373 eV+15.03248 eV+7.41663 eV=96.70641 eV (23.247)

By considering that the central field decreases by an integer for each successive electron of the shell, the radius r₆ₛₚ_{³} of the Pb6sp³ shell may be calculated from the Coulombic energy using Eq. (15.13):

$$\begin{matrix}{r}_{6 {sp}^{3}} = {\sum }_{n = 78}^{81} \frac{( Z - n ) {e}^{2}}{8 {πɛ}_{0} ( e 96.70641 eV )} \\ = \frac{10 {e}^{2}}{8 {πɛ}_{0} ( e 96.70641 eV )} \\ = 1.40692 {a}_{0}\end{matrix} \qquad ( 23.248 )$$

where Z=82 for lead. Using Eq. (15.14), the Coulombic energy E_{Coulomb}(Pb,6sp³) of the outer electron of the Pb6sp³ shell is

$$\begin{matrix}{E}_{Coulomb} ( Pb , 6 {sp}^{3} ) = \frac{- {e}^{2}}{8 {πɛ}_{0} {r}_{6 {sp}^{3}}} \\ = \frac{- {e}^{2}}{8 {πɛ}_{0} 1.40692 {a}_{0 }} \\ = - 9.67064 eV\end{matrix} \qquad ( 23.249 )$$

During hybridization, the spin-paired 6s electrons are promoted to Pb6sp³ shell as unpaired electrons. The energy for the promotion is the magnetic energy given by Eq. (15.15) at the initial radius of the 6s electrons. From Eq. (10.102) with Z=82 and n=80, the radius r₈₀ of the Pb6s shell is

r₈₀=1.27805a₀ (23.250)

Using Eqs. (15.15) and (23.250), the unpairing energy is

$$\begin{matrix}E ( magnetic ) = \frac{2 {πμ}_{0} {e}^{2} {ℏ}^{2}}{{{m}_{e}^{2} ( {r}_{80} )}^{3}} \\ = \frac{8 {πμ}_{o} {μ}_{B}^{2}}{{( 1.27805 {a}_{0} )}^{3}} \\ = 0.05481 eV\end{matrix} \qquad ( 23.251 )$$

Using Eqs. (23.249) and (23.251), the energy E(Pb,6sp³) of the outer electron of the Pb6sp³ shell is

$$\begin{matrix}E ( Pb , 6 {sp}^{3} ) = \frac{- {e}^{2}}{8 {πɛ}_{0} {r}_{6 {sp}^{3}}} + \frac{2 {πμ}_{0} {e}^{2} {ℏ}^{2}}{{{m}_{e}^{2} ( {r}_{80} )}^{3 }} \\ = - 9.67064 eV + 0.05481 eV \\ = - 9.61584 eV\end{matrix} \qquad ( 23.252 )$$

Next, consider the formation of the Pb-L-bond MO of lead compounds wherein L is a ligand including carbon and each lead atom has a Pb6sp³ electron with an energy given by Eq. (23.252). The total energy of the state of each lead atom is given by the sum over the four electrons. The sum E_{T}(Pb_{Pb-L},6Sp³) of energies of Pb6sp³ (Eq. (23.252)), Pb⁺, Pb²⁺, and Pb³⁺ is

$$\begin{matrix}{E}_{T} ( {Pb}_{Pb - L} , 6 {sp}^{3} ) = - ( \begin{matrix}42.32 eV + 31.9373 eV + \\ 15.03248 eV + E ( Pb , 6 {sp}^{3} )\end{matrix} ) \\ = - ( \begin{matrix}42.32 eV + 31.9373 eV + \\ 15.03248 eV + 9.61584 eV\end{matrix} ) \\ = - 98.90562 eV\end{matrix} \qquad ( 23.253 )$$

where E(Pb,6sp³) is the sum of the energy of Pb, −7.41663 eV, and the hybridization energy.

A minimum energy is achieved while matching the potential, kinetic, and orbital energy relationships given in the Hydroxyl Radical (OH) section with the donation of electron density from the participating Pb6sp³ HO to each Pb-L-bond MO. Consider the case wherein each Pb6sp³ HO donates an excess of 25% of its electron density to the Pb-L-bond MO to form an energy minimum. By considering this electron redistribution in the lead molecule as well as the fact that the central field decreases by an integer for each successive electron of the shell, in general terms, the radius r_{Pb-L6sp}_{³} of the Pb6sp³ shell may be calculated from the Coulombic energy using Eq. (15.18):

$$\begin{matrix}{r}_{Pb - L 6 {sp}^{3}} = ( {\sum }_{n = 78}^{81} ( Z - n ) - 0.25 ) \frac{{e}^{2 }}{8 {πɛ}_{0} ( e 98.90562 eV )} \\ = \frac{9.75 {e}^{2}}{8 {πɛ}_{0} ( e 98.90562 eV )} \\ = 1.34124 {a}_{0}\end{matrix} \qquad ( 23.254 )$$

Using Eqs. (15.19) and (23.254), the Coulombic energy E_{Coulomb}(Pb_{pb-L},6sp³) of the outer electron of the Pb6sp³ shell is

$$\begin{matrix}{E}_{Coulomb} ( {Pb}_{Pb - L} , 6 {sp}^{3 } ) = \frac{- {e}^{2}}{8 π {ɛ}_{0} {r}_{Pb - L 6 {sp}^{3}}} \\ = \frac{- {e}^{2}}{8 {πɛ}_{0} 1.34124 {a}_{0}} \\ = - 10.14417 eV\end{matrix} \qquad ( 23.255 )$$

During hybridization, the spin-paired 6s electrons are promoted to Pb6sp³ shell as unpaired electrons. The energy for the promotion is the magnetic energy given by Eq. (23.251). Using Eqs. (23.251) and (23.255), the energy E (Pb_{Ph-L},6sp³) of the outer electron of the Pb6sp³ shell is

$$\begin{matrix}E ( {Pb}_{Pb - L} , 6 {sp}^{3} ) = \frac{- {e}^{2}}{8 {πɛ}_{0} {r}_{Pb - L 6 {sp}^{3}}} + \frac{2 {πμ}_{0} {e}^{2} {ℏ}^{2}}{{{m}_{e}^{2} ( {r}_{80} )}^{3}} \\ = - 10.14417 eV + 0.05481 eV \\ = - 10.08936 eV\end{matrix} \qquad ( 23.256 )$$

Thus, E_{T}(Pb-L,6sp³), the energy change of each Pb6sp³ shell with the formation of the Pb-L-bond MO is given by the difference between Eq. (23.256) and Eq. (23.252):

E_{T}(Pb-L,6sp³)=E(Pb_{Pb-L},6sp³)−E(Pb,6sp³)=−10.08936 eV−(−9.61584 eV)=−0.47352 eV (23.257)

Next, consider the formation of the Pb—C-bond MO by bonding with a carbon having a C2sp³ electron with an energy given by Eq. (14.146). The total energy of the state is given by the sum over the four electrons. The sum E_{T}(Cₑₜₕₐₙₑ,2sp³) of calculated energies of C2sp³, C⁺, C²⁺, and C³⁺ from Eqs. (10.123), (10.113-10.114), (10.68), and (10.48), respectively, is

$$\begin{matrix}{E}_{T} ( {C}_{ethane} , 2 {sp}^{3} ) = - ( \begin{matrix}64.3921 eV + 48.3125 eV + \\ 24.2762 eV + E ( C , 2 {sp}^{3} )\end{matrix} ) \\ = - ( \begin{matrix}64.3921 eV + 48.3125 eV + \\ 24.2762 eV + 14.63489 eV\end{matrix} ) \\ = - 151.61569 eV\end{matrix} \qquad ( 23.258 )$$

where E(C,2sp³) is the sum of the energy of C, −11.27671 eV, and the hybridization energy.

The sharing of electrons between the Pb6sp³ Ho and C2sp³ HOs to form a Pb—C-bond MO permits each participating hybridized orbital to decrease in radius and energy. A minimum energy is achieved while satisfying the potential, kinetic, and orbital energy relationships, when the Pb6sp³ HO donates, and the C2sp³ HO receives, excess electron density equivalent to an electron within the Pb—C-bond MO. By considering this electron redistribution in the alkyl lead molecule as well as the fact that the central field decreases by an integer for each successive electron of the shell, the radius r_{Pb-C2sp}_{³} of the C2sp³ shell of the Pb—C-bond MO may be calculated from the Coulombic energy using Eqs. (15.18) and (23.258):

$$\begin{matrix}{r}_{Pb - C 2 {sp}^{3}} = ( {\sum }_{n = 2}^{5} ( Z - n ) + 1 ) \frac{{e}^{2}}{8 {πɛ}_{0} ( e 151.61569 eV )} \\ = \frac{11 {e}^{2}}{8 {πɛ}_{0} ( e 151.61569 eV )} \\ = 0.98713 {a}_{0}\end{matrix} \qquad ( 23.259 )$$

Using Eqs. (15.19) and (23.259), the Coulombic energy E_{Coulomb}(C_{Pb—C},2sp³) of the outer electron of the C2sp³ shell is

$$\begin{matrix}{E}_{Coulomb } ( {C}_{Pb - C} , 2 {sp}^{3} ) = \frac{- {e}^{2}}{8 {πɛ}_{0} {r}_{Pb - C 2 {sp}^{3}}} \\ = \frac{- {e}^{2}}{8 {πɛ}_{0} 0.98713 {a}_{0}} \\ = - 13.78324 eV\end{matrix} \qquad ( 23.260 )$$

During hybridization, the spin-paired 2s electrons are promoted to C2sp³ shell as unpaired electrons. The energy for the promotion is the magnetic energy given by Eq. (14.145). Using Eqs. (14.145) and (23.260), the energy E(C_{Pb—C},2sp³) of the outer electron of the C2sp³ shell is

$$\begin{matrix}E ( {C}_{Pb - C} , 2 {sp}^{3} ) = \frac{- {e}^{2}}{8 {πɛ}_{0} {r}_{Pb - C 2 {sp}^{3}}} + \frac{2 {πμ}_{0} {e}^{2} {ℏ}^{2}}{{{m}_{e}^{2} ( {r}_{3} )}^{3 }} \\ = - 13.78324 eV + 0.19086 eV \\ = - 13.59238 eV\end{matrix} \qquad ( 23.261 )$$

Thus, E_{T}(Pb—C,2sp³), the energy change of each C2sp³ shell with the formation of the Pb—C-bond MO is given by the difference between Eq. (23.261) and Eq. (14.146):

$$\begin{matrix}{E}_{T} ( Pb - C , 2 {sp}^{3} ) = E ( {C}_{Pb - C} , 2 {sp}^{3} ) - E ( C , 2 {sp}^{3} ) \\ = - 13.59238 eV - ( - 14.63489 eV ) \\ = 1.04251 eV\end{matrix} \qquad ( 23.262 )$$

Now, consider the formation of the Pb-L-bond MO of lead compounds wherein L is a ligand including carbon. For the Pb-L functional groups, hybridization of the 6p and 6s AOs of Pb to form a single Pb6sp³ HO shell forms an energy minimum, and the sharing of electrons between the Pb6sp³ HO and L HO to form a MO permits each participating orbital to decrease in radius and energy. The C2sp³ HO has an energy of E(C,2sp³)=−14.63489 eV (Eq. (15.25)) and the Pb6sp³ HO has an energy of E(Pb,6sp³)=−9.61584 eV (Eq. (23.252)). To meet the equipotential condition of the union of the Pb-L H₂-type-ellipsoidal-MO with these orbitals, the hybridization factors c₂ and C₂ of Eq. (15.61) for the Pb-L-bond MO given by Eq. (15.77) are

$$\begin{matrix}{c}_{2} ( C 2 {sp}^{3} HO to Pb 6 {sp}^{3} HO ) = {C}_{2} ( C 2 {sp}^{3} HO to Pb 6 {sp}^{3} HO ) \\ = \frac{E ( Pb , 6 {sp}^{3} HO )}{E ( C , 2 {sp}^{3} )} \\ = \frac{- 9.61584 eV}{- 14.63489 eV} \\ = 0.65705\end{matrix} \qquad ( 23.263 )$$

Since the energy of the MO is matched to that of the Pb6sp³ HO, E (AO/HO) in Eq. (15.61) is E(Pb,6sp³HO) given by Eq. (23.252). In order to match the energies of the carbon and lead HOs within the molecule, E_{T}(atom-atom,msp³.AO) of the Pb-L-bond MO for the ligand carbon is one half E_{T}(Pb C,2sp³) (Eq. (23.262)).

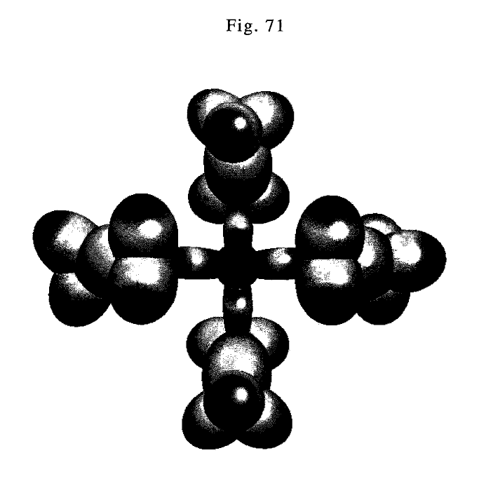

The symbols of the functional groups of lead compounds are given in Table 154. The geometrical (Eqs. (15.1-15.5)), intercept (Eqs. (15.31-15.32) and (15.80-15.87)), and energy (Eqs. (15.61) and (23.28-23.33)) parameters of lead compounds are given in Tables 155, 156, and 157, respectively. The total energy of each lead compounds given in Table 158 was calculated as the sum over the integer multiple of each E_{D}(Group) of Table 157 corresponding to functional-group composition of the compound. The bond angle parameters of lead compounds determined using Eqs. (15.88-15.117) are given in Table 159. The charge-densities of exemplary lead compound, tetraethyl lead (Pb(CH₂CH₃)₄) comprising atoms with the outer shell bridged by one or more H₂-type ellipsoidal MOs or joined with one or more hydrogen MOs are shown in FIG. 71.

TABLE 154
The symbols of functional groups of lead compounds.

| Functional Group | Group Symbol |
|---|---|
| PbC group | Pb—C |
| CH₃ group | C—H (CH₃) |
| CH₂ alkyl group | C—H (CH₂) |
| CH alkyl | C—H |
| CC bond (n-C) | C—C (a) |
| CC bond (iso-C) | C—C (b) |
| CC bond (tert-C) | C—C (c) |
| CC (iso to iso-C) | C—C (d) |
| CC (t to t-C) | C—C (e) |
| CC (t to iso-C) | C—C (f) |

TABLE 155
The geometrical bond parameters of lead compounds and experimental values [3].

| Param- | Pb—C | C—H(CH₃) | C—H(CH [symbol] | C—H | C—C (a) | C—C (b) | C—C (c) | C—C (d) | C—C (e) | C—C (f) |
|---|---|---|---|---|---|---|---|---|---|---|
| eter | Group | Group | Group | Group | Group | Group | Group | Group | Group | Group |
| a (a₀) | 2.21873 | 1.64920 | 1.67122 | 1.67465 | 2.12499 | 2.12499 | 2.10725 | 2.12499 | 2.10725 | 2.10725 |
| c′ (a₀) | 2.12189 | 1.04856 | 1.05553 | 1.05661 | 1.45744 | 1.45744 | 1.45164 | 1.45744 | 1.45164 | 1.45164 |
| Bond | 2.24571 | 1.10974 | 1.11713 | 1.11827 | 1.54280 | 1.54280 | 1.53635 | 1.54280 | 1.53635 | 1.53635 |
| Length | | | | | | | | | | |
| 2c′ (Å) | | | | | | | | | | |
| Exp. | 2.238 | 1.107 | 1.107 | 1.122 | 1.532 | 1.532 | 1.532 | 1.532 | 1.532 | 1.532 |
| Bond | ((CH₃)₄Pb) | (C—H | (C—H | (isobutane) | (propane) | (propane) | (propane) | (propane) | (propane) | (propane) |
| Length | | propane) | propane) | | 1.531 | 1.531 | 1.531 | 1.531 | 1.531 | 1.531 |
| (Å) | | 1.117 | 1.117 | | (butane) | (butane) | (butane) | (butane) | (butane) | (butane) |
| | | (C—H | (C—H | | | | | | | |
| | | butane) | butane) | | | | | | | |
| b, c (a₀) | 0.64834 | 1.27295 | 1.29569 | 1.29924 | 1.54616 | 1.54616 | 1.52750 | 1.54616 | 1.52750 | 1.52750 |
| e | 0.95635 | 0.63580 | 0.63159 | 0.63095 | 0.68600 | 0.68600 | 0.68888 | 0.68600 | 0.68888 | 0.68888 |

[symbol]

indicates data missing or illegible when filed

TABLE 156
The MO to HO intercept geometrical bond parameters of lead compounds. R, R′, R″ are H or alkyl groups. E_{T} is E_{T}
(atom-atom, msp³.AO).

| | | | | | | Final Total Energy | | |
|---|---|---|---|---|---|---|---|---|
| | | E_{T} | E_{T} | E_{T} | E_{T} | Pb6sp³ | | |
| | | (eV) | (eV) | (eV) | (eV) | C2sp³ | rᵢₙᵢₜᵢₐₗ | r_{final} |
| Bond | Atom | Bond 1 | Bond 2 | Bond 3 | Bond 4 | (eV) | (a₀) | (a₀) |
| C—H(CH₃) | C | 0.26063 | 0 | 0 | 0 | −151.35506 | 0.91771 | 0.93414 |
| (CH₃)₃Pb—CH₃ | Pb | 0.26063 | 0.26063 | 0.26063 | 0.26063 | | 1.40692 | 0.98713 |
| (CH₃)₃Pb—CH₃ | C | 0.26063 | 0 | 0 | 0 | | 0.91771 | 0.93414 |
| C—H(CH₃) | C | −0.92918 | 0 | 0 | 0 | −152.54487 | 0.91771 | 0.86359 |
| C—H(CH₂) (i) | C | −0.92918 | −0.92918 | 0 | 0 | −153.47406 | 0.91771 | 0.81549 |
| C—H(CH) (i) | C | −0.92918 | −0.92918 | −0.92918 | 0 | −154.40324 | 0.91771 | 0.77247 |
| H₃CₐC_{b}H₂CH₂—(C—C (a)) | Cₐ | −0.92918 | 0 | 0 | 0 | −152.54487 | 0.91771 | 0.86359 |
| H₃CₐC_{b}H₂CH₂—(C—C (a)) | C_{b} | −0.92918 | −0.92918 | 0 | 0 | −153.47406 | 0.91771 | 0.81549 |
| R—H₂CₐC_{b}(H₂C_{c}—R′)HCH₂—(C—C (b)) | C_{b} | −0.92918 | −0.92918 | −0.92918 | 0 | −154.40324 | 0.91771 | 0.77247 |
| R—H₂Cₐ(R′—H₂C_{d})C_{b}(R″—H₂C_{c})CH₂—(C—C (c)) | C_{b} | −0.92918 | −0.72457 | −0.72457 | −0.72457 | −154.71860 | 0.91771 | 0.75889 |
| isoCₐC_{b}(H₂C_{c}—R′)HCH₂—(C—C (d)) | C_{b} | −0.92918 | −0.92918 | −0.92918 | 0 | −154.40324 | 0.91771 | 0.77247 |
| tertCₐ(R′—H₂C_{d})C_{b}(R″—H₂C_{c})CH₂—(C—C (e)) | C_{b} | −0.72457 | −0.72457 | −0.72457 | −0.72457 | −154.51399 | 0.91771 | 0.76765 |
| tertCₐC_{b}(H₂C_{c}—R′)HCH₂—(C—C (f)) | C_{b} | −0.72457 | −0.92918 | −0.92918 | 0 | −154.19863 | 0.91771 | 0.78155 |
| isoCₐ(R′—H₂C_{d})C_{b}(R″—H₂C_{c})CH₂—(C—C (f)) | C_{b} | −0.72457 | −0.72457 | −0.72457 | −0.72457 | −154.51399 | 0.91771 | 0.76765 |

| | E_{Coulomb} (C2sp³) | E (Pb6sp³) | | | | | |
|---|---|---|---|---|---|---|---|
| | (eV) | E (C2sp³) (eV) | θ′ | | | | |
| Bond | Final | Final | (°) | θ₁ (°) | θ₂ (°) | d₁ (a₀) | d₂ (a₀) |
| C—H(CH₃) | −14.56512 | −14.37426 | 85.33 | 94.67 | 47.00 | 1.12468 | 0.07613 |
| (CH₃)₃Pb—CH₃ | −13.78324 | | 147.67 | 32.33 | 54.52 | 1.28781 | 0.83408 |
| (CH₃)₃Pb—CH₃ | −14.56512 | −14.37426 | 146.47 | 33.53 | 52.74 | 1.34322 | 0.77867 |
| C—H(CH₃) | −15.75493 | −15.56407 | 77.49 | 102.51 | 41.48 | 1.23564 | 0.18708 |
| C—H(CH₂) (i) | −16.68412 | −16.49325 | 68.47 | 111.53 | 35.84 | 1.35486 | 0.29933 |
| C—H(CH) (i) | −17.61330 | −17.42244 | 61.10 | 118.90 | 31.37 | 1.42988 | 0.37326 |
| H₃CₐC_{b}H₂CH₂—(C—C (a)) | −15.75493 | −15.56407 | 63.82 | 116.18 | 30.08 | 1.83879 | 0.38106 |
| H₃CₐC_{b}H₂CH₂—(C—C (a)) | −16.68412 | −16.49325 | 56.41 | 123.59 | 26.06 | 1.90890 | 0.45117 |
| R—H₂CₐC_{b}(H₂C_{c}—R′)HCH₂—(C—C (b)) | −17.61330 | −17.42244 | 48.30 | 131.70 | 21.90 | 1.97162 | 0.51388 |
| R—H₂Cₐ(R′—H₂C_{d})C_{b}(R″—H₂C_{c})CH₂—(C—C (c)) | −17.92866 | −17.73779 | 48.21 | 131.79 | 21.74 | 1.95734 | 0.50570 |
| isoCₐC_{b}(H₂C_{c}—R′)HCH₂—(C—C (d)) | −17.61330 | −17.42244 | 48.30 | 131.70 | 21.90 | 1.97162 | 0.51388 |
| tertCₐ(R′—H₂C_{d})C_{b}(R″—H₂C_{c})CH₂—(C—C (e)) | −17.92866 | −17.73779 | 50.04 | 129.96 | 22.66 | 1.94462 | 0.49298 |
| tertCₐC_{b}(H₂C_{c}—R′)HCH₂—(C—C (f)) | −17.40869 | −17.21783 | 52.78 | 127.22 | 24.04 | 1.92443 | 0.47279 |
| isoCₐ(R′—H₂C_{d})C_{b}(R″—H₂C_{c})CH₂—(C—C (f)) | −17.92866 | −17.73779 | 50.04 | 129.96 | 22.66 | 1.94462 | 0.49298 |

TABLE 157
The energy parameters (eV) of functional groups of lead compounds.

| | | | | | C—C | C—C | C—C | C—C | C—C | C—C |
|---|---|---|---|---|---|---|---|---|---|---|
| Para- | Pb—C | CH₃ | CH₂ | CH | (a) | (b) | (c) | (d) | (e) | (f) |
| meters | Group | Group | Group | Group | Group | Group | Group | Group | Group | Group |
| n₁ | 1 | 3 | 2 | 1 | 1 | 1 | 1 | 1 | 1 | 1 |
| n₂ | 0 | 2 | 1 | 0 | 0 | 0 | 0 | 0 | 0 | 0 |
| n₃ | 0 | 0 | 0 | 0 | 0 | 0 | 0 | 0 | 0 | 0 |
| C₁ | 0.375 | 0.75 | 0.75 | 0.75 | 0.5 | 0.5 | 0.5 | 0.5 | 0.5 | 0.5 |
| C₂ | 0.65705 | 1 | 1 | 1 | 1 | 1 | 1 | 1 | 1 | 1 |
| c₁ | 1 | 1 | 1 | 1 | 1 | 1 | 1 | 1 | 1 | 1 |
| c₂ | 0.65705 | 0.91771 | 0.91771 | 0.91771 | 0.91771 | 0.91771 | 0.91771 | 0.91771 | 0.91771 | 0.91771 |
| c₃ | 0 | 0 | 1 | 1 | 0 | 0 | 0 | 1 | 1 | 0 |
| c₄ | 2 | 1 | 1 | 1 | 2 | 2 | 2 | 2 | 2 | 2 |
| c₅ | 0 | 3 | 2 | 1 | 0 | 0 | 0 | 0 | 0 | 0 |
| C₁ₒ | 0.375 | 0.75 | 0.75 | 0.75 | 0.5 | 0.5 | 0.5 | 0.5 | 0.5 | 0.5 |
| C₂ₒ | 0.65705 | 1 | 1 | 1 | 1 | 1 | 1 | 1 | 1 | 1 |
| Vₑ (eV) | −32.04219 | −107.32728 | −70.41425 | −35.12015 | −28.79214 | −28.79214 | −29.10112 | −28.79214 | −29.10112 | −29.10112 |
| Vₚ (eV) | 6.41212 | 38.92728 | 25.78002 | 12.87680 | 9.33352 | 9.33352 | 9.37273 | 9.33352 | 9.37273 | 9.37273 |
| T (eV) | 7.22084 | 32.53914 | 21.06675 | 10.48582 | 6.77464 | 6.77464 | 6.90500 | 6.77464 | 6.90500 | 6.90500 |
| Vₘ (eV) | −3.61042 | −16.26957 | −10.53337 | −5.24291 | −3.38732 | −3.38732 | −3.45250 | −3.38732 | −3.45250 | −3.45250 |
| E | −9.61584 | −15.56407 | −15.56407 | −14.63489 | −15.56407 | −15.56407 | −15.35946 | −15.56407 | −15.35946 | −15.35946 |
| (AO/HO) | | | | | | | | | | |
| (eV) | | | | | | | | | | |
| ΔE_{H}_{₂}_{MO} | 0 | 0 | 0 | 0 | 0 | 0 | 0 | 0 | 0 | 0 |
| (AO/HO) | | | | | | | | | | |
| (eV) | | | | | | | | | | |
| E_{T} | −9.61584 | −15.56407 | −15.56407 | −14.63489 | −15.56407 | −15.56407 | −15.35946 | −15.56407 | −15.35946 | −15.35946 |
| (AO/HO) | | | | | | | | | | |
| (eV) | | | | | | | | | | |
| E_{T} | −31.63548 | −67.69451 | −49.66493 | −31.63533 | −31.63537 | −31.63537 | −31.63535 | −31.63537 | −31.63535 | −31.63535 |
| (H₂MO) | | | | | | | | | | |
| (eV) | | | | | | | | | | |
| E_{T} | 0.52125 | 0 | 0 | 0 | −1.85836 | −1.85836 | −1.44915 | −1.85836 | −1.44915 | −1.44915 |
| (atom- | | | | | | | | | | |
| atom, | | | | | | | | | | |
| msp³.AO) | | | | | | | | | | |
| (eV) | | | | | | | | | | |
| E_{T} (MO) | −31.11411 | −67.69450 | −49.66493 | −31.63537 | −33.49373 | −33.49373 | −33.08452 | −33.49373 | −33.08452 | −33.08452 |
| (eV) | | | | | | | | | | |
| ω | 6.20930 | 24.9286 | 24.2751 | 24.1759 | 9.43699 | 9.43699 | 15.4846 | 9.43699 | 9.55643 | 9.55643 |
| (10¹⁵ | | | | | | | | | | |
| rad/s) | | | | | | | | | | |
| E_{K} (eV) | 4.08707 | 16.40846 | 15.97831 | 15.91299 | 6.21159 | 6.21159 | 10.19220 | 6.21159 | 6.29021 | 6.29021 |
| Ē_{D} (eV) | −0.12444 | −0.25352 | −0.25017 | −0.24966 | −0.16515 | −0.16515 | −0.20896 | −0.16515 | −0.16416 | −0.16416 |
| Ē_{Kvib} | 0.14444 [66] | 0.35532 | 0.35532 | 0.35532 | 0.12312 [6] | 0.17978 [7] | 0.09944 [8] | 0.12312 [6] | 0.12312 [6] | 0.12312 [6] |
| (eV) | | Eq. | Eq. | Eq. | | | | | | |
| | | (13.458) | (13.458) | (13.458) | | | | | | |
| Ē_{osc} (eV) | −0.05222 | −0.22757 | −0.14502 | −0.07200 | −0.10359 | −0.07526 | −0.15924 | −0.10359 | −0.10260 | −0.10260 |
| E_{mag} (eV) | 0.14803 | 0.14803 | 0.14803 | 0.14803 | 0.14803 | 0.14803 | 0.14803 | 0.14803 | 0.14803 | 0.14803 |
| E_{T} | −31.16633 | −67.92207 | −49.80996 | −31.70737 | −33.59732 | −33.49373 | −33.24376 | −33.59732 | −33.18712 | −33.18712 |
| (Group) | | | | | | | | | | |
| (eV) | | | | | | | | | | |
| Eᵢₙᵢₜᵢₐₗ | −14.63489 | −14.63489 | −14.63489 | −14.63489 | −14.63489 | −14.63489 | −14.63489 | −14.63489 | −14.63489 | −14.63489 |
| (c₄ | | | | | | | | | | |
| AO/HO) | | | | | | | | | | |
| (eV) | | | | | | | | | | |
| Eᵢₙᵢₜᵢₐₗ | 0 | −13.59844 | −13.59844 | −13.59844 | 0 | 0 | 0 | 0 | 0 | 0 |
| (c₅ | | | | | | | | | | |
| AO/HO) | | | | | | | | | | |
| (eV) | | | | | | | | | | |
| E_{D} | 1.89655 | 12.49186 | 7.83016 | 3.32601 | 4.32754 | 4.29921 | 3.97398 | 4.17951 | 3.62128 | 3.91734 |
| (Group) | | | | | | | | | | |
| (eV) | | | | | | | | | | |

TABLE 158
The total bond energies of gaseous-state lead compounds calculated using the functional
group composition (separate functional groups designated in the first row) and the
energies of Table 157 compared to the gaseous-state experimental values [86]
except where indicated.

| | | | | | | | Calculated | | |
|---|---|---|---|---|---|---|---|---|---|
| | | | | | | | Total | | |
| | | | | | | | Bond | Experimental | |
| | | | | | | | Energy | Total Bond | Relative |
| Formula | Name | Pb—C | CH₃ | CH₂ | CH | C—C (a) | (eV) | Energy (eV) | Error |
| C₄H₁₂Pb | Tetramethyl-lead | 4 | 4 | 0 | 0 | 0 | 57.55366 | 57.43264 | −0.00211 |
| C₈H₂₀Pb | Tetraethyl-lead | 4 | 4 | 4 | 0 | 4 | 106.18446 | 105.49164 | −0.00657 |

^{a}Crystal.

TABLE 159
The bond angle parameters of lead compounds and experimental values [3]. In the calculation of θᵥ, the parameters
from the preceding angle were used. E_{T} is E_{T} (atom-atom, msp³.AO).

| | | | 2c′ | | Atom 1 | | Atom 2 | | |
|---|---|---|---|---|---|---|---|---|---|
| | 2c′ | 2c′ | Terminal | | Hybridization | | Hybridization | | |
| Atoms of | Bond 1 | Bond 2 | Atoms | E_{Coulombic} | Designation | E_{Coulombic} | Designation | c₂ | c₂ |
| Angle | (a₀) | (a₀) | (a₀) | Atom 1 | (Table 7) | Atom 2 | (Table 7) | Atom 1 | Atom 2 |
| Methyl | 2.09711 | 2.09711 | 3.4252 | −15.75493 | 7 | H | H | 0.86359 | 1 |
| ∠HCₐH | | | | | | | | | |
| ∠HₐCₐPb | | | | | | | | | |
| ∠CₐPbC_{b} | 4.24378 | 4.24378 | 6.9282 | −14.82575 | 1 | −14.82575 | 1 | 0.91771 | 0.91771 |
| Methylene | 2.11106 | 2.11106 | 3.4252 | −15.75493 | 7 | H | H | 0.86359 | 1 |
| ∠HCₐH | | | | | | | | | |
| ∠CₐC_{b}C_{c} | | | | | | | | | |
| ∠CₐC_{b}H | | | | | | | | | |
| Methyl | 2.09711 | 2.09711 | 3.4252 | −15.75493 | 7 | H | H | 0.86359 | 1 |
| ∠HCₐH | | | | | | | | | |
| ∠CₐC_{b}C_{c} | | | | | | | | | |
| ∠CₐC_{b}H | | | | | | | | | |
| ∠C_{b}CₐC_{c} | 2.91547 | 2.91547 | 4.7958 | −16.68412 | 26 | −16.68412 | 26 | 0.81549 | 0.81549 |
| iso Cₐ | | | | C_{b} | | C_{c} | | | |
| ∠C_{b}CₐH | 2.91547 | 2.11323 | 4.1633 | −15.55033 | 5 | −14.82575 | 1 | 0.87495 | 0.91771 |
| iso Cₐ | | | | Cₐ | | C_{b} | | | |
| ∠CₐC_{b}H | 2.91547 | 2.09711 | 4.1633 | −15.55033 | 5 | −14.82575 | 1 | 0.87495 | 0.91771 |
| iso Cₐ | | | | C_{b} | | Cₐ | | | |
| ∠C_{b}CₐC_{b} | 2.90327 | 2.90327 | 4.7958 | −16.68412 | 26 | −16.68412 | 26 | 0.81549 | 0.81549 |
| tert Cₐ | | | | C_{b} | | C_{b} | | | |
| ∠C_{b}CₐC_{d} | | | | | | | | | |

| Atoms of | | | | | E_{T} | θᵥ | θ₁ | θ₂ | Cal. θ | Exp. θ |
|---|---|---|---|---|---|---|---|---|---|---|
| Angle | C₁ | C₂ | c₁ | c₂′ | (eV) | (°) | (°) | (°) | (°) | (°) |
| Methyl | 1 | 1 | 0.75 | 1.15796 | 0 | | | | 109.50 | |
| ∠HCₐH | | | | | | | | | | |
| ∠HₐCₐPb | | | | | | 70.56 | | | 109.44 | |
| ∠CₐPbC_{b} | 1 | 1 | 1 | 0.91771 | −1.85836 | | | | 109.43 | 109.5 |
| | | | | | | | | | | (tetramethyllead) |
| Methylene | 1 | 1 | 0.75 | 1.15796 | 0 | | | | 108.44 | 107 |
| ∠HCₐH | | | | | | | | | | (propane) |
| ∠CₐC_{b}C_{c} | | | | | | 69.51 | | | 110.49 | 112 |
| | | | | | | | | | | (propane) |
| | | | | | | | | | | 113.8 |
| | | | | | | | | | | (butane) |
| | | | | | | | | | | 110.8 |
| | | | | | | | | | | (isobutane) |
| ∠CₐC_{b}H | | | | | | 69.51 | | | 110.49 | 111.0 |
| | | | | | | | | | | (butane) |
| | | | | | | | | | | 111.4 |
| | | | | | | | | | | (isobutane) |
| Methyl | 1 | 1 | 0.75 | 1.15796 | 0 | | | | 109.50 | |
| ∠HCₐH | | | | | | | | | | |
| ∠CₐC_{b}C_{c} | | | | | | 70.56 | | | 109.44 | |
| ∠CₐC_{b}H | | | | | | 70.56 | | | 109.44 | |
| ∠C_{b}CₐC_{c} | 1 | 1 | 1 | 0.81549 | −1.85836 | | | | 110.67 | 110.8 |
| iso Cₐ | | | | | | | | | | (isobutane) |
| ∠C_{b}CₐH | 0.75 | 1 | 0.75 | 1.04887 | 0 | | | | 110.76 | |
| iso Cₐ | | | | | | | | | | |
| ∠CₐC_{b}H | 0.75 | 1 | 0.75 | 1.04887 | 0 | | | | 111.27 | 111.4 |
| iso Cₐ | | | | | | | | | | (isobutane) |
| ∠C_{b}CₐC_{b} | 1 | 1 | 1 | 0.81549 | −1.85836 | | | | 111.37 | 110.8 |
| tert Cₐ | | | | | | | | | | (isobutane) |
| ∠C_{b}CₐC_{d} | | | | | | 72.50 | | | 107.50 | |

Alkyl Arsines ((CₙH₂ₙ₊₁)₃As, n=1,2,3,4,5 . . . ∞)

The alkyl arsines, (CₙH₂ₙ₊₁)₃As, comprise a As—C functional group. The alkyl portion of the alkyl arsine may comprise at least two terminal methyl groups (CH₃) at each end of each chain, and may comprise methylene (CH₂), and methylyne (CH) functional groups as well as C bound by carbon-carbon single bonds. The methyl and methylene functional groups are equivalent to those of straight-chain alkanes. Six types of C—C bonds can be identified. The n-alkane C—C bond is the same as that of straight-chain alkanes. In addition, the C—C bonds within isopropyl ((CH₃)₂CH) and t-butyl ((CH₃)₃C) groups and the isopropyl to isopropyl, isopropyl to t-butyl, and t-butyl to t-butyl C—C bonds comprise functional groups. The branched-chain-alkane groups in alkyl arsines are equivalent to those in branched-chain alkanes. The As—C group may further join the As4sp³ HO to an aryl HO.

As in the case of phosphorous, the bonding in the arsenic atom involves sp³ hybridized orbitals formed, in this case, from the 4p and 4s electrons of the outer shells. The As—C bond forms between As4sp³ and C2sp³ HOs to yield arsines. The semimajor axis a of the As—C functional group is solved using Eq. (15.51). Using the semimajor axis and the relationships between the prolate spheroidal axes, the geometric and energy parameters of the MO are calculated using Eqs. (15.1-15.117) in the same manner as the organic functional groups given in Organic Molecular Functional Groups and Molecules section.

The energy of arsenic is less than the Coulombic energy between the electron and proton of H given by Eq. (1.231). A minimum energy is achieved while matching the potential, kinetic, and orbital energy relationships given in the Hydroxyl Radical (OH) section with hybridization of the arsenic atom such that in Eqs. (15.51) and (15.61), the sum of the energies of the H₂-type ellipsoidal MOs is matched to that of the As4sp³ shell as in the case of the corresponding phosphine molecules.

The As electron configuration is [Ar]4s²3d¹⁰4p³ corresponding to the ground state ⁴S_{3/2}, and the 4sp³ hybridized orbital arrangement after Eq. (13.422) is

$$\frac{↑ ↓}{0 , 0} {\frac{↑}{1 , - 1} \frac{↑}{1 , 0}}^{4 {sp}^{3} state} \frac{↑}{1 , 1} \qquad ( 23.264 )$$

where the quantum numbers (l,mₗ) are below each electron. The total energy of the state is given by the sum over the five electrons. The sum E_{T}(As,4sp³) of experimental energies [1] of As, As⁺, As²⁺, As³⁺, and As⁴⁺ is

$$\begin{matrix}{E}_{T} ( As , 4 {sp}^{3} ) = 62.63 eV + 50.13 eV + 28.351 eV + \\ 18.5892 eV + 9.7886 eV \\ = 169.48880 eV\end{matrix} \qquad ( 23.265 )$$

By considering that the central field decreases by an integer for each successive electron of the shell, the radius r₄ₛₚ_{³} of the As4sp³ shell may be calculated from the Coulombic energy using Eq. (15.13):

$$\begin{matrix}{r}_{4 {sp}^{3}} = {\sum }_{n = 28}^{32} \frac{( Z - n ) {e}^{2}}{8 {πɛ}_{0} ( e 169.48880 eV )} \\ = \frac{15 {e}^{2}}{8 π {ɛ}_{0} ( e 169.48880 eV )} \\ = 1.20413 {a}_{0}\end{matrix} \qquad ( 23.266 )$$

where Z=33 for arsenic. Using Eq. (15.14), the Coulombic energy E_{Coulomb}(As,4sp³) of the outer electron of the As4sp³ shell is

$$\begin{matrix}{E}_{Coulomb} ( As , 4 {sp}^{3} ) = \frac{- {e}^{2}}{8 {πɛ}_{0} {r}_{4 {sp}^{3}}} \\ = \frac{- {e}^{2}}{8 {πɛ}_{0} 1.20413 {a}_{0}} \\ = - 11.29925 eV\end{matrix} \qquad ( 23.267 )$$

During hybridization, the spin-paired 4s electrons are promoted to As4sp³ shell as paired electrons at the radius r₄ₛₚ_{³} of the As4sp³ shell. The energy for the promotion is the difference in the magnetic energy given by Eq. (15.15) at the initial radius of the 4s electrons and the final radius of the As4sp³ electrons. From Eq. (10.102) with Z=33 and n=30, the radius r₃₀ of the As4s shell is

r₃₀=1.08564a₀ (23.268)

Using Eqs. (15.15) and (23.268), the unpairing energy is

$$\begin{matrix}E ( magnetic ) = \frac{2 π {μ}_{0} {e}^{2} {ℏ}^{2}}{{m}_{e}^{2}} ( \frac{1}{{( {r}_{30} )}^{3}} - \frac{1}{{( {r}_{4 {sp}^{3}} )}^{3}} ) \\ = 8 π {μ}_{o} {μ}_{B}^{2} ( \frac{1}{{( 1.08564 {a}_{0} )}^{3}} - \frac{1}{{( 1.20414 {a}_{0} )}^{3}} ) \\ = 0.02388 eV\end{matrix} \qquad ( 23.269 )$$

Using Eqs. (23.267) and (23.269), the energy E(As,4sp³) of the outer electron of the As4sp³ shell is

$$\begin{matrix}E ( As , 4 {sp}^{3} ) = \frac{- {e}^{2}}{8 π {ɛ}_{0} {r}_{4 {sp}^{3}}} + \frac{2 π {μ}_{0} {e}^{2} {ℏ}^{2}}{{m}_{e}^{2}} ( \frac{1}{{( {r}_{30} )}^{3}} - \frac{1}{{( {r}_{4 {sp}^{3}} )}^{3}} ) \\ = - 11.29925 eV + 0.02388 eV \\ = - 11.27537 eV\end{matrix} \qquad ( 23.270 )$$

For the As—C functional group, hybridization of the 2s and 2p AOs of each C and the 4s and 4p AOs of each As to form single 2sp³ and 4sp³ shells, respectively, forms an energy minimum, and the sharing of electrons between the C2sp³ and As4sp³ HOs to form a MO permits each participating orbital to decrease in radius and energy. In branched-chain alkyl arsines, the energy of arsenic is less than the Coulombic energy between the electron and proton of H given by Eq. (1.231). Thus, c₂ in Eq. (15.61) is one, and the energy matching condition is determined by the C₂ parameter. Then, the C2sp³ HO has an energy of E(C,2sp³)=−14.63489 eV (Eq. (15.25)), and the As4sp³ HO has an energy of E(As,4sp⁴)=−11.27537 eV (Eq. (23.270)). To meet the equipotential condition of the union of the As—C H₂-type-ellipsoidal-MO with these orbitals, the hybridization factor C₂ of Eq. (15.61) for the As—C-bond MO given by Eqs. (15.77), (15.79), and (13.430) is

$$\begin{matrix}{C}_{2} ( C 2 {sp}^{3} HO to As 4 {sp}^{3} HO ) = \frac{E ( As , 4 {sp}^{3} )}{E ( C , 2 {sp}^{3} )} {c}_{2} ( C 2 {sp}^{3} HO ) \\ = \frac{- 11.27537 eV}{- 14.63489 eV} ( 0.91771 ) \\ = 0.70705\end{matrix} \qquad ( 23.271 )$$

The energy of the As—C-bond MO is the sum of the component energies of the H₂-type ellipsoidal MO given in Eq. (15.51) with E(AO/HO=E(As,4sp³) given by Eq. (23.270), and E_{T}(atom-atom,msp³.AO) is zero in order to match the energies of the carbon and arsenic HOs.

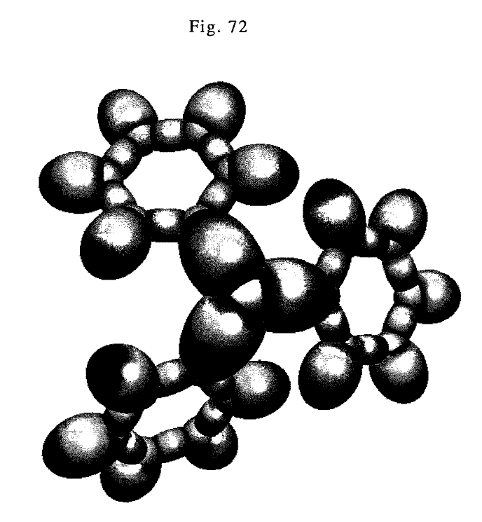

The symbols of the functional groups of branched-chain alkyl arsines are given in Table 160. The geometrical (Eqs. (15.1-15.5) and (15.51)), intercept (Eqs. (15.80-15.87)), and energy (Eqs. (15.6-15.11) and (15.17-15.65)) parameters of alkyl arsines are given in Tables 161, 162, and 163, respectively. The total energy of each alkyl arsine given in Table 164 was calculated as the sum over the integer multiple of each E_{D}(Group) of Table 163 corresponding to functional-group composition of the molecule. The bond angle parameters of alkyl arsines determined using Eqs. (15.88-15.117) are given in Table 165. The color scale, charge-density of exemplary alkyl arsine, triphenylarsine, comprising atoms with the outer shell bridged by one or more H₂-type ellipsoidal MOs or joined with one or more hydrogen MOs is shown in FIG. 72.

TABLE 160
The symbols of functional groups of alkyl arsines.

| Functional Group | Group Symbol |
|---|---|
| As—C | As—C |
| CH₃ group | C—H (CH₃) |
| CH₂ group | C—H (CH₂) |
| CH | C—H (i) |
| CC bond (n-C) | C—C (a) |
| CC bond (iso-C) | C—C (b) |
| CC bond (tert-C) | C—C (c) |
| CC (iso to iso-C) | C—C (d) |
| CC (t to t-C) | C—C (e) |
| CC (t to iso-C) | C—C (f) |
| CC (aromatic bond) | C^{3e}═C |
| CH (aromatic) | CH (ii) |

TABLE 161
The geometrical bond parameters of alkyl arsines and experimental values [3].

| | As—C | C—H(CH₃) | C—H(CH₂) | C—H (i) | C—C (a) | C—C (b) |
|---|---|---|---|---|---|---|
| Parameter | Group | Group | Group | Group | Group | Group |
| a (a₀) | 2.33431 | 1.64920 | 1.67122 | 1.67465 | 2.12499 | 2.12499 |
| c′ (a₀) | 1.81700 | 1.04856 | 1.05553 | 1.05661 | 1.45744 | 1.45744 |
| Bond Length | 1.92303 | 1.10974 | 1.11713 | 1.11827 | 1.54280 | 1.54280 |
| 2c′ (Å) | | | | | | |
| Exp. Bond | 1.979 | 1.107 | 1.107 | 1.122 | 1.532 | 1.532 |
| Length | ((CH₃)₂AsCH₃) | (C—H propane) | (C—H propane) | (isobutane) | (propane) | (propane) |
| (Å) | | 1.117 | 1.117 | | 1.531 | 1.531 |
| | | (C—H butane) | (C—H butane) | | (butane) | (butane) |
| b, c (a₀) | 1.46544 | 1.27295 | 1.29569 | 1.29924 | 1.54616 | 1.54616 |
| e | 0.77839 | 0.63580 | 0.63159 | 0.63095 | 0.68600 | 0.68600 |

| | C—C (c) | C—C (d) | C—C (e) | C—C (f) | C^{3e}═C | CH (ii) |
|---|---|---|---|---|---|---|
| Parameter | Group | Group | Group | Group | Group | Group |
| a (a₀) | 2.10725 | 2.12499 | 2.10725 | 2.10725 | 1.47348 | 1.60061 |
| c′ (a₀) | 1.45164 | 1.45744 | 1.45164 | 1.45164 | 1.31468 | 1.03299 |
| Bond Length | 1.53635 | 1.54280 | 1.53635 | 1.53635 | 1.39140 | 1.09327 |
| 2c′ (Å) | | | | | | |
| Exp. Bond | 1.532 | 1.532 | 1.532 | 1.532 | 1.399 | 1.101 |
| Length | (propane) | (propane) | (propane) | (propane) | (benzene) | (benzene) |
| (Å) | 1.531 | 1.531 | 1.531 | 1.531 | | |
| | (butane) | (butane) | (butane) | (butane) | | |
| b, c (a₀) | 1.52750 | 1.54616 | 1.52750 | 1.52750 | 0.66540 | 1.22265 |
| e | 0.68888 | 0.68600 | 0.68888 | 0.68888 | 0.89223 | 0.64537 |

TABLE 162
The MO to HO intercept geometrical bond parameters of alkyl arsines. R, R′, R″ are H or alkyl groups. E_{T} is E_{T}
(atom-atom, msp³.AO.

| | | E_{T} | E_{T} | E_{T} | E_{T} | Final Total Energy | | |
|---|---|---|---|---|---|---|---|---|
| | | (eV) | (eV) | (eV) | (eV) | C2sp³ | rᵢₙᵢₜᵢₐₗ | r_{final} |
| Bond | Atom | Bond 1 | Bond 2 | Bond 3 | Bond 4 | (eV) | (a₀) | (a₀) |
| C—H(CH₃) | C | 0 | 0 | 0 | 0 | −151.61569 | 0.91771 | 0.91771 |
| (CH₃)₂As—CH₃ | C | 0 | 0 | 0 | 0 | | 0.91771 | 0.91771 |
| (CH₃)₂As—CH₃ | As | 0 | 0 | 0 | 0 | | 0.91771 | 0.91771 |
| C—H(CH₃) | C | −0.92918 | 0 | 0 | 0 | −152.54487 | 0.91771 | 0.86359 |
| C—H(CH₂) | C | −0.92918 | −0.92918 | 0 | 0 | −153.47406 | 0.91771 | 0.81549 |
| C—H(CH) | C | −0.92918 | −0.92918 | −0.92918 | 0 | −154.40324 | 0.91771 | 0.77247 |
| H₃CₐC_{b}H₂CH₂—(C—C (a)) | Cₐ | −0.92918 | 0 | 0 | 0 | −152.54487 | 0.91771 | 0.86359 |
| H₃CₐC_{b}H₂CH₂—(C—C (a)) | C_{b} | −0.92918 | −0.92918 | 0 | 0 | −153.47406 | 0.91771 | 0.81549 |
| R—H₂CₐC_{b}(H₂C_{c}—R′)HCH₂—(C—C (b)) | C_{b} | −0.92918 | −0.92918 | −0.92918 | 0 | −154.40324 | 0.91771 | 0.77247 |
| R—H₂Cₐ(R′—H₂C_{d})C_{b}(R″—H₂C_{c})CH₂—(C—C (c)) | C_{b} | −0.92918 | −0.72457 | −0.72457 | −0.72457 | −154.71860 | 0.91771 | 0.75889 |
| isoCₐC_{b}(H₂C_{c}—R′)HCH₂—(C—C (d)) | C_{b} | −0.92918 | −0.92918 | −0.92918 | 0 | −154.40324 | 0.91771 | 0.77247 |
| tertCₐ(R′—H₂C_{d})C_{b}(R″—H₂C_{c})CH₂—(C—C (e)) | C_{b} | −0.72457 | −0.72457 | −0.72457 | −0.72457 | −154.51399 | 0.91771 | 0.76765 |
| tertCₐC_{b}(H₂C_{c}—R′)HCH₂—(C—C (f)) | C_{b} | −0.72457 | −0.92918 | −0.92918 | 0 | −154.19863 | 0.91771 | 0.78155 |
| isoCₐ(R′—H₂C_{d})C_{b}(R″—H₂C_{c})CH₂—(C—C (f)) | C_{b} | −0.72457 | −0.72457 | −0.72457 | −0.72457 | −154.51399 | 0.91771 | 0.76765 |

| | E_{Coulomb} (eV) | E (C2sp³) (eV) | θ′ | θ₁ | θ₂ | d₁ | d₂ |
|---|---|---|---|---|---|---|---|
| Bond | Final | Final | (°) | (°) | (°) | (a₀) | (a₀) |
| C—H(CH₃) | −14.82575 | −14.63489 | 83.62 | 96.38 | 45.76 | 1.15051 | 0.10195 |
| (CH₃)₂As—CH₃ | −14.82575 | −14.63489 | 89.82 | 90.18 | 38.77 | 1.81991 | 0.00291 |
| (CH₃)₂As—CH₃ | −14.82575 | | 89.82 | 90.18 | 38.77 | 1.81991 | 0.00291 |
| C—H(CH₃) | −15.75493 | −15.56407 | 77.49 | 102.51 | 41.48 | 1.23564 | 0.18708 |
| C—H(CH₂) | −16.68412 | −16.49325 | 68.47 | 111.53 | 35.84 | 1.35486 | 0.29933 |
| C—H(CH) | −17.61330 | −17.42244 | 61.10 | 118.90 | 31.37 | 1.42988 | 0.37326 |
| H₃CₐC_{b}H₂CH₂—(C—C (a)) | −15.75493 | −15.56407 | 63.82 | 116.18 | 30.08 | 1.83879 | 0.38106 |
| H₃CₐC_{b}H₂CH₂—(C—C (a)) | −16.68412 | −16.49325 | 56.41 | 123.59 | 26.06 | 1.90890 | 0.45117 |
| R—H₂CₐC_{b}(H₂C_{c}—R′)HCH₂—(C—C (b)) | −17.61330 | −17.42244 | 48.30 | 131.70 | 21.90 | 1.97162 | 0.51388 |
| R—H₂Cₐ(R′—H₂C_{d})C_{b}(R″—H₂C_{c})CH₂—(C—C (c)) | −17.92866 | −17.73779 | 48.21 | 131.79 | 21.74 | 1.95734 | 0.50570 |
| isoCₐC_{b}(H₂C_{c}—R′)HCH₂—(C—C (d)) | −17.61330 | −17.42244 | 48.30 | 131.70 | 21.90 | 1.97162 | 0.51388 |
| tertCₐ(R′—H₂C_{d})C_{b}(R″—H₂C_{c})CH₂—(C—C (e)) | −17.92866 | −17.73779 | 50.04 | 129.96 | 22.66 | 1.94462 | 0.49298 |
| tertCₐC_{b}(H₂C_{c}—R′)HCH₂—(C—C (f)) | −17.40869 | −17.21783 | 52.78 | 127.22 | 24.04 | 1.92443 | 0.47279 |
| isoCₐ(R′—H₂C_{d})C_{b}(R″—H₂C_{c})CH₂—(C—C (f)) | −17.92866 | −17.73779 | 50.04 | 129.96 | 22.66 | 1.94462 | 0.49298 |

TABLE 163
The energy parameters (eV) of functional groups of alkyl arsines.

| | As—C | CH₃ | CH₂ | CH (i) | C—C (a) | C—C (b) |
|---|---|---|---|---|---|---|
| Parameters | Group | Group | Group | Group | Group | Group |
| f₁ | 1 | 1 | 1 | 1 | 1 | 1 |
| n₁ | 1 | 3 | 2 | 1 | 1 | 1 |
| n₂ | 0 | 2 | 1 | 0 | 0 | 0 |
| n₃ | 0 | 0 | 0 | 0 | 0 | 0 |
| C₁ | 0.5 | 0.75 | 0.75 | 0.75 | 0.5 | 0.5 |
| C₂ | 0.70705 | 1 | 1 | 1 | 1 | 1 |
| c₁ | 1 | 1 | 1 | 1 | 1 | 1 |
| c₂ | 1 | 0.91771 | 0.91771 | 0.91771 | 0.91771 | 0.91771 |
| c₃ | 0 | 0 | 1 | 1 | 0 | 0 |
| c₄ | 2 | 1 | 1 | 1 | 2 | 2 |
| c₅ | 0 | 3 | 2 | 1 | 0 | 0 |
| C₁ₒ | 0.5 | 0.75 | 0.75 | 0.75 | 0.5 | 0.5 |
| C₂ₒ | 0.70705 | 1 | 1 | 1 | 1 | 1 |
| Vₑ (eV) | −31.18832 | −107.32728 | −70.41425 | −35.12015 | −28.79214 | −28.79214 |
| Vₚ (eV) | 7.48806 | 38.92728 | 25.78002 | 12.87680 | 9.33352 | 9.33352 |
| T (eV) | 6.68041 | 32.53914 | 21.06675 | 10.48582 | 6.77464 | 6.77464 |
| Vₘ (eV) | −3.34021 | −16.26957 | −10.53337 | −5.24291 | −3.38732 | −3.38732 |
| E (AO/HO) (eV) | −11.27537 | −15.56407 | −15.56407 | −14.63489 | −15.56407 | −15.56407 |
| ΔE_{H}_{₂}_{MO} (AO/HO) (eV) | 0 | 0 | 0 | 0 | 0 | 0 |
| E_{T} (AO/HO) (eV) | −11.27537 | −15.56407 | −15.56407 | −14.63489 | −15.56407 | −15.56407 |
| ET (H₂MO) (eV) | −31.63542 | −67.69451 | −49.66493 | −31.63533 | −31.63537 | −31.63537 |
| E_{T} (atom-atom, | 0 | 0 | 0 | 0 | −1.85836 | −1.85836 |
| msp³.AO) (eV) | | | | | | |
| E_{T} (MO) (eV) | −31.63537 | −67.69450 | −49.66493 | −31.63537 | −33.49373 | −33.49373 |
| ω (10¹⁵ rad/s) | 6.89218 | 24.9286 | 24.2751 | 24.1759 | 9.43699 | 9.43699 |
| E_{K} (eV) | 4.53655 | 16.40846 | 15.97831 | 15.91299 | 6.21159 | 6.21159 |
| Ē_{D} (eV) | −0.13330 | −0.25352 | −0.25017 | −0.24966 | −0.16515 | −0.16515 |
| Ē_{Kvib} (eV) | 0.15498 [66] | 0.35532 | 0.35532 | 0.35532 | 0.12312 [6] | 0.17978 [7] |
| | | (Eq. | (Eq. | (Eq. | | |
| | | (13.458)) | (13.458)) | (13.458)) | | |
| Ē_{osc} (eV) | −0.05581 | −0.22757 | −0.14502 | −0.07200 | −0.10359 | −0.07526 |
| E_{mag} (eV) | 0.14803 | 0.14803 | 0.14803 | 0.14803 | 0.14803 | 0.14803 |
| E_{T} (Group) (eV) | −31.69118 | −67.92207 | −49.80996 | −31.70737 | −33.59732 | −33.49373 |
| Eᵢₙᵢₜᵢₐₗ (c₄ AO/HO) (eV) | −14.63489 | −14.63489 | −14.63489 | −14.63489 | −14.63489 | −14.63489 |
| Eᵢₙᵢₜᵢₐₗ (c₅ AO/HO) (eV) | 0 | −13.59844 | −13.59844 | −13.59844 | 0 | 0 |
| E_{D} (Group) (eV) | 2.42140 | 12.49186 | 7.83016 | 3.32601 | 4.32754 | 4.29921 |
| | C—C (c) | C—C (d) | C—C (e) | C—C (f) | C^{3e}═C | CH (ii) |
| Parameters | Group | Group | Group | Group | Group | Group |
| f₁ | 1 | 1 | 1 | 1 | 0.75 | 1 |
| n₁ | 1 | 1 | 1 | 1 | 2 | 1 |
| n₂ | 0 | 0 | 0 | 0 | 0 | 0 |
| n₃ | 0 | 0 | 0 | 0 | 0 | 0 |
| C₁ | 0.5 | 0.5 | 0.5 | 0.5 | 0.5 | 0.75 |
| C₂ | 1 | 1 | 1 | 1 | 0.85252 | 1 |
| c₁ | 1 | 1 | 1 | 1 | 1 | 1 |
| c₂ | 0.91771 | 0.91771 | 0.91771 | 0.91771 | 0.85252 | 0.91771 |
| c₃ | 0 | 1 | 1 | 0 | 0 | 1 |
| c₄ | 2 | 2 | 2 | 2 | 3 | 1 |
| c₅ | 0 | 0 | 0 | 0 | 0 | 1 |
| C₁ₒ | 0.5 | 0.5 | 0.5 | 0.5 | 0.5 | 0.75 |
| C₂ₒ | 1 | 1 | 1 | 1 | 0.85252 | 1 |
| Vₑ (eV) | −29.10112 | −28.79214 | −29.10112 | −29.10112 | −101.12679 | −37.10024 |
| Vₚ (eV) | 9.37273 | 9.33352 | 9.37273 | 9.37273 | 20.69825 | 13.17125 |
| T (eV) | 6.90500 | 6.77464 | 6.90500 | 6.90500 | 34.31559 | 11.58941 |
| Vₘ (eV) | −3.45250 | −3.38732 | −3.45250 | −3.45250 | −17.15779 | −5.79470 |
| E (AO/HO) (eV) | −15.35946 | −15.56407 | −15.35946 | −15.35946 | 0 | −14.63489 |
| ΔE_{H}_{₂}_{MO} (AO/HO) (eV) | 0 | 0 | 0 | 0 | 0 | −1.13379 |
| E_{T} (AO/HO) (eV) | −15.35946 | −15.56407 | −15.35946 | −15.35946 | 0 | −13.50110 |
| E_{T} (H₂MO) (eV) | −31.63535 | −31.63537 | −31.63535 | −31.63535 | −63.27075 | −31.63539 |
| E_{T} (atom-atom, | −1.44915 | −1.85836 | −1.44915 | −1.44915 | −2.26759 | −0.56690 |
| msp³.AO) (eV) | | | | | | |
| E_{T} (MO) (eV) | −33.08452 | −33.49373 | −33.08452 | −33.08452 | −65.53833 | −32.20226 |
| ω (10¹⁵ rad/s) | 15.4846 | 9.43699 | 9.55643 | 9.55643 | 49.7272 | 26.4826 |
| E_{K} (eV) | 10.19220 | 6.21159 | 6.29021 | 6.29021 | 32.73133 | 17.43132 |
| Ē_{D} (eV) | −0.20896 | −0.16515 | −0.16416 | −0.16416 | −0.35806 | −0.26130 |
| Ē_{Kvib} (eV) | 0.09944 [8] | 0.12312 [6] | 0.12312 [6] | 0.12312 [6] | 0.19649 [30] | 0.35532 |
| | | | | | | Eq. (13.458) |
| Ē_{osc} (eV) | −0.15924 | −0.10359 | −0.10260 | −0.10260 | −0.25982 | −0.08364 |
| E_{mag} (eV) | 0.14803 | 0.14803 | 0.14803 | 0.14803 | 0.14803 | 0.14803 |
| E_{T} (Group) (eV) | −33.24376 | −33.59732 | −33.18712 | −33.18712 | −49.54347 | −32.28590 |
| Eᵢₙᵢₜᵢₐₗ (c₄ AO/HO) (eV) | −14.63489 | −14.63489 | −14.63489 | −14.63489 | −14.63489 | −14.63489 |
| Eᵢₙᵢₜᵢₐₗ (c₅ AO/HO) (eV) | 0 | 0 | 0 | 0 | 0 | −13.59844 |
| E_{D} (Group) (eV) | 3.97398 | 4.17951 | 3.62128 | 3.91734 | 5.63881 | 3.90454 |

TABLE 164
The total bond energies of alkyl arsines calculated using the functional group composition and
the energies of Table 163 compared to the experimental values [87].

| | | | | | | C—C | C—C | | C—C |
|---|---|---|---|---|---|---|---|---|---|
| Formula | Name | As—C | CH₃ | CH₂ | CH (i) | (a) | (b) | C—C (c) | (d) |
| C₃H₉As | Trimethylarsine | 3 | 3 | 0 | 0 | 0 | 0 | 0 | 0 |
| C₆H₁₅As | Triethylarsine | 3 | 3 | 3 | 0 | 3 | 0 | 0 | 0 |
| C₁₈H₁₅As | Triphenylarsine | 3 | 0 | 0 | 0 | 0 | 0 | 0 | 0 |

| | | | | | | Calculated | Experimental | |
|---|---|---|---|---|---|---|---|---|
| | | C—C | | | | Total Bond | Total Bond | Relative |
| Formula | Name | (e) | C—C (f) | C^{3e}═C | CH (ii) | Energy (eV) | Energy (eV) | Error |
| C₃H₉As | Trimethylarsine | 0 | 0 | 0 | 0 | 44.73978 | 45.63114 | 0.01953 |
| C₆H₁₅As | Triethylarsine | 0 | 0 | 0 | 0 | 81.21288 | 81.01084 | −0.00249 |
| C₁₈H₁₅As | Triphenylarsine | 0 | 0 | 18 | 15 | 167.33081 | 166.49257 | −0.00503 |

TABLE 165
The bond angle parameters of alkyl arsines and experimental values [3]. In the calculation of θᵥ, the
parameters from the preceding angle were used. E_{T} is E_{T}(atom-atom, msp³.AO).

| | | | 2c′ | | Atom 1 | | Atom 2 | | |
|---|---|---|---|---|---|---|---|---|---|
| | 2c′ | 2c′ | Terminal | E_{Coulombic} | Hybridization | | Hybridization | | |
| Atoms of | Bond 1 | Bond 2 | Atoms | or E | Designation | E_{Coulombic} | Designation | c₂ | c₂ |
| Angle | (a₀) | (a₀) | (a₀) | Atom 1 | (Table 7) | Atom 2 | (Table 7) | Atom 1 | Atom 2 |
| Methyl | 2.09711 | 2.09711 | 3.4252 | −15.75493 | 7 | H | H | 0.86359 | 1 |
| ∠HCₐH | | | | | | | | | |
| ∠HₐCₐAs | | | | | | | | | |
| ∠CₐAsC_{b} | 3.63400 | 3.63400 | 5.5136 | −15.75493 | 7 | −15.75493 | 7 | 0.86359 | 0.86359 |
| Methylene | 2.11106 | 2.11106 | 3.4252 | −15.75493 | 7 | H | H | 0.86359 | 1 |
| ∠HCₐH | | | | | | | | | |
| ∠CₐC_{b}C_{c} | | | | | | | | | |
| ∠CₐC_{b}H | | | | | | | | | |
| Methyl | 2.09711 | 2.09711 | 3.4252 | −15.75493 | 7 | H | H | 0.86359 | 1 |
| ∠HCₐH | | | | | | | | | |
| ∠CₐC_{b}C_{c} | | | | | | | | | |
| ∠CₐC_{b}H | | | | | | | | | |
| ∠C_{b}CₐC_{c} | 2.91547 | 2.91547 | 4.7958 | −16.68412 | 26 | −16.68412 | 26 | 0.81549 | 0.81549 |
| iso Cₐ | | | | C_{b} | | C_{c} | | | |
| ∠C_{b}CₐH | 2.91547 | 2.11323 | 4.1633 | −15.55033 | 5 | −14.82575 | 1 | 0.87495 | 0.91771 |
| iso Cₐ | | | | Cₐ | | C_{b} | | | |
| ∠CₐC_{b}H | 2.91547 | 2.09711 | 4.1633 | −15.55033 | 5 | −14.82575 | 1 | 0.87495 | 0.91771 |
| iso Cₐ | | | | C_{b} | | Cₐ | | | |
| ∠C_{b}CₐC_{b} | 2.90327 | 2.90327 | 4.7958 | −16.68412 | 26 | −16.68412 | 26 | 0.81549 | 0.81549 |
| tert Cₐ | | | | C_{b} | | C_{b} | | | |
| ∠C_{b}CₐC_{d} | | | | | | | | | |

| Atoms of | | | | | E_{T} | θᵥ | θ₁ | θ₂ | Cal. θ | Exp. θ |
|---|---|---|---|---|---|---|---|---|---|---|
| Angle | C₁ | C₂ | c₁ | c₂′ | (eV) | (°) | (°) | (°) | (°) | (°) |
| Methyl | 1 | 1 | 0.75 | 1.15796 | 0 | | | | 109.50 | |
| ∠HCₐH | | | | | | | | | | |
| ∠HₐCₐAs | | | | | | 70.56 | | | 109.44 | 111.4 |
| | | | | | | | | | | (trimethylarsine) |
| ∠CₐAsC_{b} | 1 | 1 | 1 | 0.86359 | −1.85836 | | | | 98.68 | 98.8 |
| | | | | | | | | | | (trimethylarsine) |
| Methylene | 1 | 1 | 0.75 | 1.15796 | 0 | | | | 108.44 | 107 |
| ∠HCₐH | | | | | | | | | | (propane) |
| ∠CₐC_{b}C_{c} | | | | | | 69.51 | | | 110.49 | 112 |
| | | | | | | | | | | (propane) |
| | | | | | | | | | | 113.8 |
| | | | | | | | | | | (butane) |
| | | | | | | | | | | 110.8 |
| | | | | | | | | | | (isobutane) |
| ∠CₐC_{b}H | | | | | | 69.51 | | | 110.49 | 111.0 |
| | | | | | | | | | | (butane) |
| | | | | | | | | | | 111.4 |
| | | | | | | | | | | (isobutane) |
| Methyl | 1 | 1 | 0.75 | 1.15796 | 0 | | | | 109.50 | |
| ∠HCₐH | | | | | | | | | | |
| ∠CₐC_{b}C_{c} | | | | | | 70.56 | | | 109.44 | |
| ∠CₐC_{b}H | | | | | | 70.56 | | | 109.44 | |
| ∠C_{b}CₐC_{c} | 1 | 1 | 1 | 0.81549 | −1.85836 | | | | 110.67 | 110.8 |
| iso Cₐ | | | | | | | | | | (isobutane) |
| ∠C_{b}CₐH | 0.75 | 1 | 0.75 | 1.04887 | 0 | | | | 110.76 | |
| iso Cₐ | | | | | | | | | | |
| ∠CₐC_{b}H | 0.75 | 1 | 0.75 | 1.04887 | 0 | | | | 111.27 | 111.4 |
| iso Cₐ | | | | | | | | | | (isobutane) |
| ∠C_{b}CₐC_{b} | 1 | 1 | 1 | 0.81549 | −1.85836 | | | | 111.37 | 110.8 |
| tert Cₐ | | | | | | | | | | (isobutane) |
| ∠C_{b}CₐC_{d} | | | | | | 72.50 | | | 107.50 | |

Alkyl Stibines (CₙH₂ₙ₊₁)₃Sb, n=1,2,3,4,5, . . . ∞)

The alkyl stibines, (CₙH₂ₙ₊₁)₃Sb, comprise a Sb—C functional group. The alkyl portion of the alkyl stibine may comprise at least two terminal methyl groups (CH₃) at each end of each chain, and may comprise methylene (CH₂), and methylyne (CH) functional groups as well as C bound by carbon-carbon single bonds. The methyl and methylene functional groups are equivalent to those of straight-chain alkanes. Six types of C—C bonds can be identified. The n-alkane C—C bond is the same as that of straight-chain alkanes. In addition, the C—C bonds within isopropyl ((CH₃)₂CH) and t-butyl ((CH₃)₃C) groups and the isopropyl to isopropyl, isopropyl to t-butyl, and t-butyl to t-butyl C—C bonds comprise functional groups. The branched-chain-alkane groups in alkyl stibines are equivalent to those in branched-chain alkanes. The Sb—C group may further join the Sb5sp³ HO to an aryl HO.

As in the case of phosphorous, the bonding in the antimony atom involves sp³ hybridized orbitals formed, in this case, from the 5p and 5s electrons of the outer shells. The Sb—C bond forms between Sb5sp³ and C2sp³ HOs to yield stibines. The semimajor axis a of the Sb—C functional group is solved using Eq. (15.51). Using the semimajor axis and the relationships between the prolate spheroidal axes, the geometric and energy parameters of the MO are calculated using Eqs. (15.1-15.117) in the same manner as the organic functional groups given in Organic Molecular Functional Groups and Molecules section.

The energy of antimony is less than the Coulombic energy between the electron and proton of H given by Eq. (1.231). A minimum energy is achieved while matching the potential, kinetic, and orbital energy relationships given in the Hydroxyl Radical (OH) section with hybridization of the antimony atom such that in Eqs. (15.51) and (15.61), the sum of the energies of the H₂-type ellipsoidal MOs is matched to that of the Sb5sp³ shell as in the case of the corresponding phosphine and arsine molecules.

The Sb electron configuration is [Kr]5s²4d¹⁰5p³ corresponding to the ground state ⁴S_{3/2}, and the 5sp³ hybridized orbital arrangement after Eq. (13.422) is

$$\frac{↑ ↓}{0 , 0} {\frac{↑}{1 , - 1} \frac{↑}{1 , 0}}^{5 {sp}^{3} state} \frac{↑}{1 , 1} \qquad ( 23.272 )$$

where the quantum numbers (l, mₗ) are below each electron. The total energy of the state is given by the sum over the five electrons. The sum E_{T}(Sb,5sp³) of experimental energies [1] of Sb, Sb⁺, Sb²⁺, Sb³⁺, and Sb⁴⁺ is

$$\begin{matrix}{E}_{T} ( Sb , 5 {sp}^{3} ) = 56.0 eV + 44.2 eV + 25.3 eV + \\ 16.63 eV + 8.60839 eV \\ = 150.73839 eV\end{matrix} \qquad ( 23.273 )$$

By considering that the central field decreases by an integer for each successive electron of the shell, the radius r₅ₛₚ_{³} of the Sb5sp³ shell may be calculated from the Coulombic energy using Eq. (15.13):

$$\begin{matrix}{r}_{5 {sp}^{3}} = {\sum }_{n = 46}^{50} \frac{( Z - n ) {e}^{2}}{8 {πɛ}_{0} ( e 150.73839 eV )} \\ = \frac{15 {e}^{2}}{8 π {ɛ}_{0} ( e 150.73839 eV )} \\ = 1.35392 {a}_{0}\end{matrix} \qquad ( 23.274 )$$

where Z=51 for antimony. Using Eq. (15.14), the Coulombic energy E_{Coulomb}(Sb,5sp³) of the outer electron of the Sb5sp³ shell is

$$\begin{matrix}{E}_{Coulomb} ( Sb , 5 {sp}^{3} ) = \frac{- {e}^{2}}{8 {πɛ}_{0} {r}_{5 {sp}^{3}}} \\ = \frac{- {e}^{2}}{8 {πɛ}_{0} 1.35392 {a}_{0}} \\ = - 10.04923 eV\end{matrix} \qquad ( 23.275 )$$

During hybridization, the spin-paired 5s electrons are promoted to Sb5sp³ shell as paired electrons at the radius r₅ₛₚ_{³} of the Sb5sp³ shell. The energy for the promotion is the difference in the magnetic energy given by Eq. (15.15) at the initial radius of the 5s electrons and the final radius of the Sb5sp³ electrons. From Eq. (10.102) with Z=51 and n=48, the radius r₄₈ of the Sb5s shell is

r₄₈=1.23129a₀ (23.276)

Using Eqs. (15.15) and (23.276), the unpairing energy is

$$\begin{matrix}E ( magnetic ) = \frac{2 π {μ}_{0} {e}^{2} {ℏ}^{2}}{{m}_{e}^{2}} ( \frac{1}{{( {r}_{48} )}^{3}} - \frac{1}{{( {r}_{5 {sp}^{3}} )}^{3}} ) \\ = 8 π {μ}_{0} {μ}_{B}^{2} ( \frac{1}{{( 1.23129 {a}_{0} )}^{3}} - \frac{1}{{( 1.35392 {a}_{0} )}^{3}} ) \\ = 0.01519 eV\end{matrix} \qquad ( 23.277 )$$

Using Eqs. (23.275) and (23.277), the energy E(Sb,5sp³) of the outer electron of the Sb5sp³ shell is

$$\begin{matrix}E ( Sb , 5 {sp}^{3 } ) = \frac{- {e}^{2}}{8 π {ɛ}_{0} {r}_{5 {sp}^{3}}} + \frac{2 {πμ}_{0} {e}^{2} {ℏ}^{2}}{{m}_{e}^{2}} \\ = - 10.04923 eV + 0.01519 eV \\ = - 10.03404 eV\end{matrix} \qquad ( 23.278 )$$

For the Sb—C functional group, hybridization of the 2s and 2p AOs of each C and the 5s and 5p AOs of each Sb to form single 2sp³ and 5sp³ shells, respectively, forms an energy minimum, and the sharing of electrons between the C2sp³ and Sb5sp³ HOs to form a MO permits each participating orbital to decrease in radius and energy. In branched-chain alkyl stibines, the energy of antimony is less than the Coulombic energy between the electron and proton of H given by Eq. (1.231). Thus, c₂ in Eq. (15.61) is one, and the energy matching condition is determined by the C₂ parameter. Then, the C2sp³ HO has an energy of E(C,2sp³)=−14.63489 eV (Eq. (15.25)), and the Sb5sp³ HO has an energy of E(Sb,5sp³)=−10.03404 eV (Eq. (23.278)). To meet the equipotential condition of the union of the Sb—C H₂-type-ellipsoidal-MO with these orbitals, the hybridization factor C₂ of Eq. (15.61) for the Sb—C-bond MO given by Eqs. (15.77), (15.79), and (13.430) is

$$\begin{matrix}{C}_{2} ( C 2 {sp}^{3} HO to Sb 5 {sp}^{3} HO ) = \frac{E ( Sb , 5 {sp}^{3} )}{E ( C , 2 {sp}^{3} )} {c}_{2} ( C 2 {sp}^{3} HO ) \\ = \frac{- 10.03404 eV}{- 14.63489 eV} ( 0.91771 ) \\ = 0.62921\end{matrix} \qquad ( 23.279 )$$

The energy of the Sb—C-bond MO is the sum of the component energies of the H₂-type ellipsoidal MO given in Eq. (15.51) with E(AO/HO=E(Sb,5sp³) given by Eq. (23.278), and E_{T}(atom-atom, msp³.AO) is zero in order to match the energies of the carbon and antimony HOs.

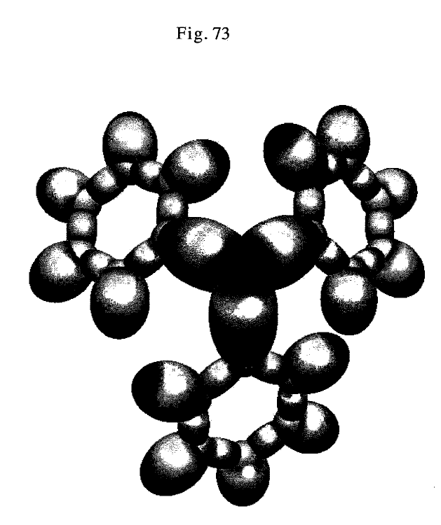

The symbols of the functional groups of branched-chain alkyl stibines are given in Table 166. The geometrical (Eqs. (15.1-15.5) and (15.51)), intercept (Eqs. (15.80-15.87)), and energy (Eqs. (15.6-15.11) and (15.17-15.65)) parameters of alkyl stibines are given in Tables 167, 168, and 169, respectively. The total energy of each alkyl stibine given in Table 170 was calculated as the sum over the integer multiple of each E_{D}(Group) of Table 169 corresponding to functional-group composition of the molecule. The bond angle parameters of alkyl stibines determined using Eqs. (15.88-15.117) are given in Table 171. The color scale, charge-density of exemplary alkyl stibine, triphenylstibine, comprising atoms with the outer shell bridged by one or more H₂-type ellipsoidal MOs or joined with one or more hydrogen MOs is shown in FIG. 73.

TABLE 166
The symbols of functional groups of alkyl stibines.

| Functional Group | Group Symbol |
|---|---|
| Sb—C | Sb—C |
| CH₃ group | C—H (CH₃) |
| CH₂ group | C—H (CH₂) |
| CH | C—H (i) |
| CC bond (n-C) | C—C (a) |
| CC bond (iso-C) | C—C (b) |
| CC bond (tert-C) | C—C (c) |
| CC (iso to iso-C) | C—C (d) |
| CC (t to t-C) | C—C (e) |
| CC (t to iso-C) | C—C (f) |
| CC (aromatic bond) | C^{3e}═C |
| CH (aromatic) | CH (ii) |

TABLE 167
The geometrical bond parameters of alkyl stibines and experimental values [3].

| | Sb—C | C—H (CH₃) | C—H (CH₂) | C—H (i) | C—C (a) | C—C (b) |
|---|---|---|---|---|---|---|
| Parameter | Group | Group | Group | Group | Group | Group |
| a (a₀) | 2.38997 | 1.64920 | 1.67122 | 1.67465 | 2.12499 | 2.12499 |
| c′ (a₀) | 1.94894 | 1.04856 | 1.05553 | 1.05661 | 1.45744 | 1.45744 |
| Bond Length | 2.06267 | 1.10974 | 1.11713 | 1.11827 | 1.54280 | 1.54280 |
| 2c′ (Å) | | | | | | |
| Exp. Bond | | 1.107 | 1.107 | 1.122 | 1.532 | 1.532 |
| Length | | (C—H propane) | (C—H propane) | (isobutane) | (propane) | (propane) |
| (Å) | | 1.117 | 1.117 | | 1.531 | 1.531 |
| | | (C—H butane) | (C—H butane) | | (butane) | (butane) |
| b, c (a₀) | 1.38332 | 1.27295 | 1.29569 | 1.29924 | 1.54616 | 1.54616 |
| e | 0.81547 | 0.63580 | 0.63159 | 0.63095 | 0.68600 | 0.68600 |

| | C—C (c) | C—C (d) | C—C (e) | C—C (f) | C^{3e}═C | CH (ii) |
|---|---|---|---|---|---|---|
| Parameter | Group | Group | Group | Group | Group | Group |
| a (a₀) | 2.10725 | 2.12499 | 2.10725 | 2.10725 | 1.47348 | 1.60061 |
| c′ (a₀) | 1.45164 | 1.45744 | 1.45164 | 1.45164 | 1.31468 | 1.03299 |
| Bond Length | 1.53635 | 1.54280 | 1.53635 | 1.53635 | 1.39140 | 1.09327 |
| 2c′ (Å) | | | | | | |
| Exp. Bond | 1.532 | 1.532 | 1.532 | 1.532 | 1.399 | 1.101 |
| Length | (propane) | (propane) | (propane) | (propane) | (benzene) | (benzene) |
| (Å) | 1.531 | 1.531 | 1.531 | 1.531 | | |
| | (butane) | (butane) | (butane) | (butane) | | |
| b, c (a₀) | 1.52750 | 1.54616 | 1.52750 | 1.52750 | 0.66540 | 1.22265 |
| e | 0.68888 | 0.68600 | 0.68888 | 0.68888 | 0.89223 | 0.64537 |

TABLE 168
The MO to HO intercept geometrical bond parameters of alkyl stibines. R, R′, R″ are H or alkyl groups.
E_{T} is E_{T} (atom-atom, msp³.AO).

| | | E_{T} | E_{T} | E_{T} | E_{T} | Final Total Energy | | |
|---|---|---|---|---|---|---|---|---|
| | | (eV) | (eV) | (eV) | (eV) | C2sp³ | rᵢₙᵢₜᵢₐₗ | r_{final} |
| Bond | Atom | Bond 1 | Bond 2 | Bond 3 | Bond 4 | (eV) | (a₀) | (a₀) |
| C—H(CH₃) | C | 0 | 0 | 0 | 0 | −151.61569 | 0.91771 | 0.91771 |
| (CH₃)₂Sb—CH₃ | C | 0 | 0 | 0 | 0 | | 0.91771 | 0.91771 |
| (CH₃)₂Sb—CH₃ | Sb | 0 | 0 | 0 | 0 | | 1.35392 | 0.91771 |
| C—H(CH₃) | C | −0.92918 | 0 | 0 | 0 | −152.54487 | 0.91771 | 0.86359 |
| C—H(CH₂) | C | −0.92918 | −0.92918 | 0 | 0 | −153.47406 | 0.91771 | 0.81549 |
| C—H(CH) | C | −0.92918 | −0.92918 | −0.92918 | 0 | −154.40324 | 0.91771 | 0.77247 |
| H₃CₐC_{b}H₂CH₂—(C—C (a)) | Cₐ | −0.92918 | 0 | 0 | 0 | −152.54487 | 0.91771 | 0.86359 |
| H₃CₐC_{b}H₂CH₂—(C—C (a)) | C_{b} | −0.92918 | −0.92918 | 0 | 0 | −153.47406 | 0.91771 | 0.81549 |
| R—H₂CₐC_{b}(H₂C_{c}—R′)HCH₂—(C—C (b)) | C_{b} | −0.92918 | −0.92918 | −0.92918 | 0 | −154.40324 | 0.91771 | 0.77247 |
| R—H₂Cₐ(R′—H₂C_{d})C_{b}(R″—H₂C_{c})CH₂—(C—C (c)) | C_{b} | −0.92918 | −0.72457 | −0.72457 | −0.72457 | −154.71860 | 0.91771 | 0.75889 |
| isoCₐC_{b}(H₂C_{c}—R′)HCH₂—(C—C (d)) | C_{b} | −0.92918 | −0.92918 | −0.92918 | 0 | −154.40324 | 0.91771 | 0.77247 |
| tertCₐ(R′—H₂C_{d})C_{b}(R″—H₂C_{c})CH₂—(C—C (e)) | C_{b} | −0.72457 | −0.72457 | −0.72457 | −0.72457 | −154.51399 | 0.91771 | 0.76765 |
| tertCₐC_{b}(H₂C_{c}—R′)HCH₂—(C—C (f)) | C_{b} | −0.72457 | −0.92918 | −0.92918 | 0 | −154.19863 | 0.91771 | 0.78155 |
| isoCₐ(R′—H₂C_{d})C_{b}(R″—H₂C_{c})CH₂—(C—C (f)) | C_{b} | −0.72457 | −0.72457 | −0.72457 | −0.72457 | −154.51399 | 0.91771 | 0.76765 |

| | E_{Coulomb} (eV) | E (C2sp³) (eV) | θ′ | θ₁ | θ₂ | d₁ | d₂ |
|---|---|---|---|---|---|---|---|
| Bond | Final | Final | (°) | (°) | (°) | (a₀) | (a₀) |
| C—H(CH₃) | −14.82575 | −14.63489 | 83.62 | 96.38 | 45.76 | 1.15051 | 0.10195 |
| (CH₃)₂Sb—CH₃ | −14.82575 | −14.63489 | 99.00 | 81.00 | 40.94 | 1.80541 | 0.14353 |
| (CH₃)₂Sb—CH₃ | −14.82575 | | 99.00 | 81.00 | 40.94 | 1.80541 | 0.14353 |
| C—H(CH₃) | −15.75493 | −15.56407 | 77.49 | 102.51 | 41.48 | 1.23564 | 0.18708 |
| C—H(CH₂) | −16.68412 | −16.49325 | 68.47 | 111.53 | 35.84 | 1.35486 | 0.29933 |
| C—H(CH) | −17.61330 | −17.42244 | 61.10 | 118.90 | 31.37 | 1.42988 | 0.37326 |
| H₃CₐC_{b}H₂CH₂—(C—C (a)) | −15.75493 | −15.56407 | 63.82 | 116.18 | 30.08 | 1.83879 | 0.38106 |
| H₃CₐC_{b}H₂CH₂—(C—C (a)) | −16.68412 | −16.49325 | 56.41 | 123.59 | 26.06 | 1.90890 | 0.45117 |
| R—H₂CₐC_{b}(H₂C_{c}—R′)HCH₂—(C—C (b)) | −17.61330 | −17.42244 | 48.30 | 131.70 | 21.90 | 1.97162 | 0.51388 |
| R—H₂Cₐ(R′—H₂C_{d})C_{b}(R″—H₂C_{c})CH₂(C—C (c)) | −17.92866 | −17.73779 | 48.21 | 131.79 | 21.74 | 1.95734 | 0.50570 |
| isoCₐC_{b}(H₂C_{c}—R′)HCH₂—(C—C (d)) | −17.61330 | −17.42244 | 48.30 | 131.70 | 21.90 | 1.97162 | 0.51388 |
| tertCₐ(R′—H₂C_{d})C_{b}(R″—H₂C_{c})CH₂—(C—C (e)) | −17.92866 | −17.73779 | 50.04 | 129.96 | 22.66 | 1.94462 | 0.49298 |
| tertCₐC_{b}(H₂C_{c}—R′)HCH₂—(C—C (f)) | −17.40869 | −17.21783 | 52.78 | 127.22 | 24.04 | 1.92443 | 0.47279 |
| isoCₐ(R′—H₂C_{d})C_{b}(R″—H₂C_{c})CH₂—(C—C (f)) | −17.92866 | −17.73779 | 50.04 | 129.96 | 22.66 | 1.94462 | 0.49298 |

TABLE 169
The energy parameters (eV) of functional groups of alkyl stibines.

| | Sb—C | CH₃ | CH₂ | CH (i) | C—C (a) | C—C (b) |
|---|---|---|---|---|---|---|
| Parameters | Group | Group | Group | Group | Group | Group |
| f₁ | 1 | 1 | 1 | 1 | 1 | 1 |
| n₁ | 1 | 3 | 2 | 1 | 1 | 1 |
| n₂ | 0 | 2 | 1 | 0 | 0 | 0 |
| n₃ | 0 | 0 | 0 | 0 | 0 | 0 |
| C₁ | 0.5 | 0.75 | 0.75 | 0.75 | 0.5 | 0.5 |
| C₂ | 0.62921 | 1 | 1 | 1 | 1 | 1 |
| c₁ | 1 | 1 | 1 | 1 | 1 | 1 |
| c₂ | 1 | 0.91771 | 0.91771 | 0.91771 | 0.91771 | 0.91771 |
| c₃ | 0 | 0 | 1 | 1 | 0 | 0 |
| c₄ | 2 | 1 | 1 | 1 | 2 | 2 |
| c₅ | 0 | 3 | 2 | 1 | 0 | 0 |
| C₁ₒ | 0.5 | 0.75 | 0.75 | 0.75 | 0.5 | 0.5 |
| C₂ₒ | 0.62921 | 1 | 1 | 1 | 1 | 1 |
| Vₑ (eV) | −31.92151 | −107.32728 | −70.41425 | −35.12015 | −28.79214 | −28.79214 |
| Vₚ (eV) | 6.98112 | 38.92728 | 25.78002 | 12.87680 | 9.33352 | 9.33352 |
| T (eV) | 6.67822 | 32.53914 | 21.06675 | 10.48582 | 6.77464 | 6.77464 |
| Vₘ (eV) | −3.33911 | −16.26957 | −10.53337 | −5.24291 | −3.38732 | −3.38732 |
| E (AO/HO) (eV) | −10.03404 | −15.56407 | −15.56407 | −14.63489 | −15.56407 | −15.56407 |
| ΔE_{H}_{₂}_{MO} (AO/HO) (eV) | 0 | 0 | 0 | 0 | 0 | 0 |
| E_{T} (AO/HO) (eV) | −10.03404 | −15.56407 | −15.56407 | −14.63489 | −15.56407 | −15.56407 |
| E_{T} (H₂MO) (eV) | −31.63532 | −67.69451 | −49.66493 | −31.63533 | −31.63537 | −31.63537 |
| E_{T} (atom-atom, msp³.AO) (eV) | 0 | 0 | 0 | 0 | −1.85836 | −1.85836 |
| E_{T} (MO) (eV) | −31.63537 | −67.69450 | −49.66493 | −31.63537 | −33.49373 | −33.49373 |
| ω (10¹⁵ rad/s) | 6.27593 | 24.9286 | 24.2751 | 24.1759 | 9.43699 | 9.43699 |
| E_{K} (eV) | 4.13093 | 16.40846 | 15.97831 | 15.91299 | 6.21159 | 6.21159 |
| Ē_{D} (eV) | −0.12720 | −0.25352 | −0.25017 | −0.24966 | −0.16515 | −0.16515 |
| Ē_{Kvib} (eV) | 0.14878 [66] | 0.35532 | 0.35532 | 0.35532 | 0.12312 [6] | 0.17978 [7] |
| | | (Eq. (13.458)) | (Eq. (13.458)) | (Eq. (13.458)) | | |
| Ē_{osc} (eV) | −0.05281 | −0.22757 | −0.14502 | −0.07200 | −0.10359 | −0.07526 |
| E_{mag} (eV) | 0.14803 | 0.14803 | 0.14803 | 0.14803 | 0.14803 | 0.14803 |
| E_{T} (Group) (eV) | −31.68818 | −67.92207 | −49.80996 | −31.70737 | −33.59732 | −33.49373 |
| Eᵢₙᵢₜᵢₐₗ (c₄ AO/HO) (eV) | −14.63489 | −14.63489 | −14.63489 | −14.63489 | −14.63489 | −14.63489 |
| Eᵢₙᵢₜᵢₐₗ (c₅ AO/HO) (eV) | 0 | −13.59844 | −13.59844 | −13.59844 | 0 | 0 |
| E_{D} (Group) (eV) | 2.41840 | 12.49186 | 7.83016 | 3.32601 | 4.32754 | 4.29921 |
| | C—C (c) | C—C (d) | C—C (e) | C—C (f) | C^{3e}═C | CH (ii) |
| Parameters | Group | Group | Group | Group | Group | Group |
| f₁ | 1 | 1 | 1 | 1 | 0.75 | 1 |
| n₁ | 1 | 1 | 1 | 1 | 2 | 1 |
| n₂ | 0 | 0 | 0 | 0 | 0 | 0 |
| n₃ | 0 | 0 | 0 | 0 | 0 | 0 |
| C₁ | 0.5 | 0.5 | 0.5 | 0.5 | 0.5 | 0.75 |
| C₂ | 1 | 1 | 1 | 1 | 0.85252 | 1 |
| c₁ | 1 | 1 | 1 | 1 | 1 | 1 |
| c₂ | 0.91771 | 0.91771 | 0.91771 | 0.91771 | 0.85252 | 0.91771 |
| c₃ | 0 | 1 | 1 | 0 | 0 | 1 |
| c₄ | 2 | 2 | 2 | 2 | 3 | 1 |
| c₅ | 0 | 0 | 0 | 0 | 0 | 1 |
| C₁₀ | 0.5 | 0.5 | 0.5 | 0.5 | 0.5 | 0.75 |
| C₂₀ | 1 | 1 | 1 | 1 | 0.85252 | 1 |
| Vₑ (eV) | −29.10112 | −28.79214 | −29.10112 | −29.10112 | −101.12679 | −37.10024 |
| Vₚ (eV) | 9.37273 | 9.33352 | 9.37273 | 9.37273 | 20.69825 | 13.17125 |
| T (eV) | 6.90500 | 6.77464 | 6.90500 | 6.90500 | 34.31559 | 11.58941 |
| Vₘ (eV) | −3.45250 | −3.38732 | −3.45250 | −3.45250 | −17.15779 | −5.79470 |
| E (AO/HO) (eV) | −15.35946 | −15.56407 | −15.35946 | −15.35946 | 0 | −14.63489 |
| ΔE_{H}_{₂}_{MO} (AO/HO) (eV) | 0 | 0 | 0 | 0 | 0 | −1.13379 |
| E_{T} (AO/HO) (eV) | −15.35946 | −15.56407 | −15.35946 | −15.35946 | 0 | −13.50110 |
| E_{T} (H₂MO) (eV) | −31.63535 | −31.63537 | −31.63535 | −31.63535 | −63.27075 | −31.63539 |
| E_{T} (atom-atom, msp³.AO) (eV) | −1.44915 | −1.85836 | −1.44915 | −1.44915 | −2.26759 | −0.56690 |
| E_{T} (MO) (eV) | −33.08452 | −33.49373 | −33.08452 | −33.08452 | −65.53833 | −32.20226 |
| ω (10¹⁵ rad/s) | 15.4846 | 9.43699 | 9.55643 | 9.55643 | 49.7272 | 26.4826 |
| E_{K} (eV) | 10.19220 | 6.21159 | 6.29021 | 6.29021 | 32.73133 | 17.43132 |
| Ē_{D} (eV) | −0.20896 | −0.16515 | −0.16416 | −0.16416 | −0.35806 | −0.26130 |
| Ē_{Kvib} (eV) | 0.09944 [8] | 0.12312 [6] | 0.12312 [6] | 0.12312 [6] | 0.19649 [30] | 0.35532 |
| | | | | | | Eq. (13.458) |
| Ē_{osc} (eV) | −0.15924 | −0.10359 | −0.10260 | −0.10260 | −0.25982 | −0.08364 |
| E_{mag} (eV) | 0.14803 | 0.14803 | 0.14803 | 0.14803 | 0.14803 | 0.14803 |
| E_{T} (Group) (eV) | −33.24376 | −33.59732 | −33.18712 | −33.18712 | −49.54347 | −32.28590 |
| Eᵢₙᵢₜᵢₐₗ (c₄ AO/HO) (eV) | −14.63489 | −14.63489 | −14.63489 | −14.63489 | −14.63489 | −14.63489 |
| Eᵢₙᵢₜᵢₐₗ (c₅ AO/HO) (eV) | 0 | 0 | 0 | 0 | 0 | −13.59844 |
| E_{D} (Group) (eV) | 3.97398 | 4.17951 | 3.62128 | 3.91734 | 5.63881 | 3.90454 |

TABLE 170
The total bond energies of alkyl stibines calculated using the functional group composition
and the energies of Table 169 compared to the experimental values [88].

| | | | | | | C—C | C—C | C—C | |
|---|---|---|---|---|---|---|---|---|---|
| Formula | Name | Sb—C | CH₃ | CH₂ | CH (i) | (a) | (b) | (c) | C—C (d) |
| C₃H₉Sb | Trimethylstibine | 3 | 3 | 0 | 0 | 0 | 0 | 0 | 0 |
| C₆H₁₅Sb | Triethylstibine | 3 | 3 | 3 | 0 | 3 | 0 | 0 | 0 |
| C₁₈H₁₅Sb | Triphenylstibine | 3 | 0 | 0 | 0 | 0 | 0 | 0 | 0 |

| | | | | | | Calculated | Experimental | |
|---|---|---|---|---|---|---|---|---|
| | | C—C | C—C | | | Total Bond | Total Bond | Relative |
| Formula | Name | (e) | (f) | C^{3e}═C | CH (ii) | Energy (eV) | Energy (eV) | Error |
| C₃H₉Sb | Trimethylstibine | 0 | 0 | 0 | 0 | 44.73078 | 45.02378 | 0.00651 |
| C₆H₁₅Sb | Triethylstibine | 0 | 0 | 0 | 0 | 81.20388 | 80.69402 | −0.00632 |
| C₁₈H₁₅Sb | Triphenylstibine | 0 | 0 | 18 | 15 | 167.32181 | 165.81583 | −0.00908 |

TABLE 171
The bond angle parameters of alkyl stibines and experimental values [3]. In the calculation of θᵥ, the parameters from
the preceding angle were used. E_{T} is E_{T} (atom-atom, msp³.AO).

| | | | 2c′ | | Atom 1 | | Atom 2 | | |
|---|---|---|---|---|---|---|---|---|---|
| | 2c′ | 2c′ | Terminal | E_{Coulombic} | Hybridization | | Hybridization | | |
| Atoms | Bond 1 | Bond 2 | Atoms | or E | Designation | E_{Coulombic} | Designation | c₂ | c₂ |
| of Angle | (a₀) | (a₀) | (a₀) | Atom 1 | (Table 7) | Atom 2 | (Table 7) | Atom 1 | Atom 2 |
| Methyl | 2.09711 | 2.09711 | 3.4252 | −15.75493 | 7 | H | H | 0.86359 | 1 |
| ∠HCₐH | | | | | | | | | |
| ∠HₐCₐSb | | | | | | | | | |
| ∠CₐSbC_{b} | 3.89789 | 3.89789 | 5.7446 | −15.55033 | 5 | −15.55033 | 5 | 0.87495 | 0.87495 |
| Methylene | 2.11106 | 2.11106 | 3.4252 | −15.75493 | 7 | H | H | 0.86359 | 1 |
| ∠HCₐH | | | | | | | | | |
| ∠CₐC_{b}C_{c} | | | | | | | | | |
| ∠CₐC_{b}H | | | | | | | | | |
| Methyl | 2.09711 | 2.09711 | 3.4252 | −15.75493 | 7 | H | H | 0.86359 | 1 |
| ∠HCₐH | | | | | | | | | |
| ∠CₐC_{b}C_{c} | | | | | | | | | |
| ∠CₐC_{b}H | | | | | | | | | |
| ∠C_{b}CₐC_{c} | 2.91547 | 2.91547 | 4.7958 | −16.68412 | 26 | −16.68412 | 26 | 0.81549 | 0.81549 |
| iso Cₐ | | | | C_{b} | | C_{c} | | | |
| ∠C_{b}CₐH | 2.91547 | 2.11323 | 4.1633 | −15.55033 | 5 | −14.82575 | 1 | 0.87495 | 0.91771 |
| iso Cₐ | | | | Cₐ | | C_{b} | | | |
| ∠CₐC_{b}H | 2.91547 | 2.09711 | 4.1633 | −15.55033 | 5 | −14.82575 | 1 | 0.87495 | 0.91771 |
| iso Cₐ | | | | C_{b} | | Cₐ | | | |
| ∠C_{b}CₐC_{b} | 2.90327 | 2.90327 | 4.7958 | −16.68412 | 26 | −16.68412 | 26 | 0.81549 | 0.81549 |
| tert Cₐ | | | | C_{b} | | C_{b} | | | |
| ∠C_{b}CₐC_{d} | | | | | | | | | |

| Atoms of | | | | | E_{T} | θᵥ | θ₁ | θ₂ | Cal. θ | Exp. θ |
|---|---|---|---|---|---|---|---|---|---|---|
| Angle | C₁ | C₂ | c₁ | c₂′ | (eV) | (°) | (°) | (°) | (°) | (°) |
| Methyl | 1 | 1 | 0.75 | 1.15796 | 0 | | | | 109.50 | |
| ∠HCₐH | | | | | | | | | | |
| ∠HₐCₐSb | | | | | | 70.56 | | | 109.44 | |
| ∠CₐSbC_{b} | 1 | 1 | 1 | 0.87495 | −1.85836 | | | | 94.93 | 94.2 |
| | | | | | | | | | | (trimethylstibine) |
| Methylene | 1 | 1 | 0.75 | 1.15796 | 0 | | | | 108.44 | 107 |
| ∠HCₐH | | | | | | | | | | (propane) |
| ∠CₐC_{b}C_{c} | | | | | | 69.51 | | | 110.49 | 112 |
| | | | | | | | | | | (propane) |
| | | | | | | | | | | 113.8 |
| | | | | | | | | | | (butane) |
| | | | | | | | | | | 110.8 |
| | | | | | | | | | | (isobutane) |
| ∠CₐC_{b}H | | | | | | 69.51 | | | 110.49 | 111.0 |
| | | | | | | | | | | (butane) |
| | | | | | | | | | | 111.4 |
| | | | | | | | | | | (isobutane) |
| Methyl | 1 | 1 | 0.75 | 1.15796 | 0 | | | | 109.50 | |
| ∠HCₐH | | | | | | | | | | |
| ∠CₐC_{b}C_{c} | | | | | | 70.56 | | | 109.44 | |
| ∠CₐC_{b}H | | | | | | 70.56 | | | 109.44 | |
| ∠C_{b}CₐC_{c} | 1 | 1 | 1 | 0.81549 | −1.85836 | | | | 110.67 | 110.8 |
| iso Cₐ | | | | | | | | | | (isobutane) |
| ∠C_{b}CₐH | 0.75 | 1 | 0.75 | 1.04887 | 0 | | | | 110.76 | |
| iso Cₐ | | | | | | | | | | |
| ∠CₐC_{b}H | 0.75 | 1 | 0.75 | 1.04887 | 0 | | | | 111.27 | 111.4 |
| iso Cₐ | | | | | | | | | | (isobutane) |
| ∠C_{b}CₐC_{b} | 1 | 1 | 1 | 0.81549 | −1.85836 | | | | 111.37 | 110.8 |
| tert Cₐ | | | | | | | | | | (isobutane) |
| ∠C_{b}CₐC_{d} | | | | | | 72.50 | | | 107.50 | |

Alkyl Bismuths ((CₙH₂ₙ₊₁)₃Bi, n=1,2,3,4,5 . . . ∞)

The alkyl bismuths, (CₙH₂ₙ₊₁)₃Bi, comprise a Bi—C functional group. The alkyl portion of the alkyl bismuth may comprise at least two terminal methyl groups (CH₃) at each end of each chain, and may comprise methylene (CH₂), and methylyne (CH) functional groups as well as C bound by carbon-carbon single bonds. The methyl and methylene functional groups are equivalent to those of straight-chain alkanes. Six types of C—C bonds can be identified. The n-alkane C—C bond is the same as that of straight-chain alkanes. In addition, the C—C bonds within isopropyl ((CH₃)₂CH) and t-butyl ((CH₃)₃C) groups and the isopropyl to isopropyl, isopropyl to t-butyl, and t-butyl to t-butyl C—C bonds comprise functional groups. The branched-chain-alkane groups in alkyl bismuths are equivalent to those in branched-chain alkanes. The Bi—C group may further join the Bi6sp³ HO to an aryl HO.

As in the case of phosphorous, arsenic, and antimony, the bonding in the bismuth atom involves sp³ hybridized orbitals formed, in this case, from the 6p and 6s electrons of the outer shells. The Bi—C bond forms between Bi6sp³ and C2sp³ HOs to yield bismuths. The semimajor axis a of the Bi—C functional group is solved using Eq. (15.51). Using the semimajor axis and the relationships between the prolate spheroidal axes, the geometric and energy parameters of the MO are calculated using Eqs. (15.1-15.117) in the same manner as the organic functional groups given in Organic Molecular Functional Groups and Molecules section.

The energy of bismuth is less than the Coulombic energy between the electron and proton of H given by Eq. (1.231). A minimum energy is achieved while matching the potential, kinetic, and orbital energy relationships given in the Hydroxyl Radical (OH) section with hybridization of the bismuth atom such that in Eqs. (15.51) and (15.61), the sum of the energies of the H₂-type ellipsoidal MOs is matched to that of the Bi6sp³ shell as in the case of the corresponding phosphines, arsines, and stibines.

The Bi electron configuration is [Xe]6s²4f¹⁴5d¹⁰6p³ corresponding to the ground state ⁴S_{3/2}, and the 6sp³ hybridized orbital arrangement after Eq. (13.422) is

$$\frac{↑ ↓}{0 , 0} {\frac{↑}{1 , - 1} \frac{↑}{1 , 0}}^{6 {sp}^{3} state} \frac{↑}{1 , 1} \qquad ( 23.280 )$$

where the quantum numbers (l, mₗ) are below each electron. The total energy of the state is given by the sum over the five electrons. The sum E_{T}(Bi,6sp³) of experimental energies [1] of Bi, Bi⁺, Bi²⁺, Bi³⁺, and Bi⁴⁺ is

$$\begin{matrix}{E}_{T} ( Bi , 6 {sp}^{3} ) = 56.0 eV + 45.3 eV + 25.56 eV + \\ 16.703 eV + 7.2855 eV \\ = 150.84850 eV\end{matrix} \qquad ( 23.281 )$$

By considering that the central field decreases by an integer for each successive electron of the shell, the radius r₆ₛₚ_{³} of the Bi6sp³ shell may be calculated from the Coulombic energy using Eq. (15.13):

$$\begin{matrix}{r}_{6 {sp}^{3}} = {\sum }_{n = 78}^{82} \frac{( Z - n ) {e}^{2}}{8 {πɛ}_{0} ( e 150.84850 eV )} \\ = \frac{15 {e}^{2}}{8 {πɛ}_{0} ( e 150.84850 eV )} \\ = 1.35293 {a}_{0}\end{matrix} \qquad ( 23.282 )$$

where Z=83 for bismuth. Using Eq. (15.14), the Coulombic energy E_{Coulomb}(Bi,6sp³) of the outer electron of the Bi6sp³ shell is

$$\begin{matrix}{E}_{Coulomb} ( Bi , 6 {sp}^{3} ) = \frac{- {e}^{2}}{8 {πɛ}_{0} {r}_{6 {sp}^{3}}} \\ = \frac{- {e}^{2}}{8 {πɛ}_{0} 1.35293 {a}_{0}} \\ = - 10.05657 eV\end{matrix} \qquad ( 23.283 )$$

During hybridization, the spin-paired 6s electrons are promoted to Bi6sp³ shell as paired electrons at the radius r₆ₛₚ_{³} of the Bi6sp³ shell. The energy for the promotion is the difference in the magnetic energy given by Eq. (15.15) at the initial radius of the 6s electrons and the final radius of the Bi6sp³ electrons. From Eq. (10.102) with Z=83 and n=80, the radius r₈₀ of the Bi6s shell is

r₈₀=1.20140a₀ (23.284)

Using Eqs. (15.15) and (23.284), the unpairing energy is

$$\begin{matrix}E ( magnetic ) = \frac{2 {πμ}_{0} {e}^{2} {ℏ}^{2}}{{m}_{e}^{2}} ( \frac{1}{{( {r}_{80} )}^{3}} - \frac{1}{{( {r}_{6 {sp}^{3}} )}^{3}} ) \\ = 8 {πμ}_{o} {μ}_{B}^{2} ( \frac{1}{{( 1.20140 {a}_{0} )}^{3}} - \frac{1}{{( 1.35293 {a}_{0} )}^{3}} ) \\ = 0.01978 eV\end{matrix} \qquad ( 23.285 )$$

Using Eqs. (23.283) and (23.285), the energy E(Bi,6sp³) of the outer electron of the Bi6sp³ shell is

$$\begin{matrix}E ( Bi , 6 {sp}^{3} ) = \frac{- {e}^{2}}{8 {πɛ}_{0} {r}_{6 {sp}^{3}}} + \frac{2 {πμ}_{0} {e}^{2} {ℏ}^{2}}{{m}_{e}^{2}} ( \frac{1}{{( {r}_{80} )}^{3}} - \frac{1}{{( {r}_{6 {sp}^{3}} )}^{3}} ) \\ = - 10.05657 eV + 0.01978 eV \\ = - 10.03679 eV\end{matrix} \qquad ( 23.286 )$$

Next, consider the formation of the Bi-L-bond MO of bismuth compounds wherein L is a very stable ligand and each bismuth atom has a Bi6sp³ electron with an energy given by Eq. (23.286). The total energy of the state of each bismuth atom is given by the sum over the five electrons. The sum E_{T}(Pb_{Pb-L},6sp³) of energies of Bi6sp³ (Eq. (23.286)), Bi⁺, Bi²⁺, Bi³⁺, and Bi⁴⁺ is

$$\begin{matrix}{E}_{T} ( {Bi}_{Bi - L} , 6 {sp}^{3} ) = - ( \begin{matrix}56.0 eV + 45.3 eV + 25.56 eV + \\ 16.703 eV + E ( Bi , 6 {sp}^{3} )\end{matrix} ) \\ = - ( \begin{matrix}56.0 eV + 45.3 eV + 25.56 eV + \\ 16.703 eV + 10.03679 eV\end{matrix} ) \\ = - 153.59979 eV\end{matrix} \qquad ( 23.287 )$$

where E (Bi,6sp³) is the sum of the energy of Bi, −7.2855 eV, and the hybridization energy.

A minimum energy is achieved while matching the potential, kinetic, and orbital energy relationships given in the Hydroxyl Radical (OH) section with the donation of electron density from the participating Bi6sp³ HO to each Bi-L-bond MO. Consider the case wherein each Bi6sp³ HO donates an excess of 25% of its electron density to the Pb-L-bond MO to form an energy minimum. By considering this electron redistribution in the bismuth molecule as well as the fact that the central field decreases by an integer for each successive electron of the shell, in general terms, the radius r_{Bi-Lsp}_{³} of the Bi6sp³ shell may be calculated from the Coulombic energy using Eq. (15.18):

$$\begin{matrix}{r}_{Bi - L 6 {sp}^{3}} = ( {\sum }_{n = 78}^{82} ( Z - n ) - 0.25 ) \frac{{e}^{2}}{8 {πɛ}_{0} ( e 153.59979 eV )} \\ = \frac{14.75 {e}^{2}}{8 {πɛ}_{0} ( e 153.59979 eV )} \\ = 1.30655 {a}_{0}\end{matrix} \qquad ( 23.288 )$$

Using Eqs. (15.19) and (23.288), the Coulombic energy E_{Coulomb}(Bi_{Bi-L},6sp³) of the outer electron of the Bi6sp³ shell is

$$\begin{matrix}{E}_{Coulomb} ( {Bi}_{Bi - L} , 6 {sp}^{3} ) = \frac{- {e}^{2}}{8 {πɛ}_{0} {r}_{Bi - L 6 {sp}^{3}}} \\ = \frac{- {e}^{2}}{8 {πɛ}_{0} 1.30655 {a}_{0}} \\ = - 10.41354 eV\end{matrix} \qquad ( 23.289 )$$

During hybridization, the spin-paired 6s electrons are promoted to Bi6sp³ shell as paired electrons at the radius r₆ₛₚ_{³} of the Bi6sp³ shell. The energy for the promotion is the difference in the magnetic energy given by Eq. (15.15) at the initial radius of the 6s electrons and the final radius of the Bi6sp³ electrons. Using Eqs. (23.285) and (23.289), the energy E(Bi_{Bi-L},6sp³) of the outer electron of the Bi6sp³ shell is

$$\begin{matrix}E ( {Bi}_{Bi - L} , 6 {sp}^{3} ) = \frac{- {e}^{2}}{8 {πɛ}_{0} {r}_{Bi - L 6 {sp}^{3}}} + \frac{2 {πμ}_{0} {e}^{2} {ℏ}^{2}}{{{m}_{e}^{2} ( {r}_{80} )}^{3}} \\ = - 10.41354 eV + 0.01978 eV \\ = - 10.39377 eV\end{matrix} \qquad ( 23.290 )$$

Thus, E_{T}(Bi-L,6sp³), the energy change of each Bi6sp³ shell with the formation of the Bi-L-bond MO is given by the difference between Eq. (23.290) and Eq. (23.286):

$$\begin{matrix}{E}_{T} ( Bi - L , 6 {sp}^{3} ) = E ( {Bi}_{Bi - L} , 6 {sp}^{3} ) - E ( Bi , 6 {sp}^{3} ) \\ = - 10.39377 eV - ( - 10.03679 eV ) \\ = - 0.35698 eV\end{matrix} \qquad ( 23.291 )$$

Next, consider the formation of the Bi—C-bond MO by bonding with a carbon having a C2sp³ electron with an energy given by Eq. (14.146). The total energy of the state is given by the sum over the five electrons. The sum E_{T}(Cₑₜₕₐₙₑ,2sp³) of calculated energies of C2sp³, C⁺, C²⁺, and C³⁺ from Eqs. (10.123), (10.113-10.114), (10.68), and (10.48), respectively, is

$$\begin{matrix}{E}_{T} ( {C}_{ethane} , 2 {sp}^{3} ) = - ( \begin{matrix}64.3921 eV + 48.3125 eV + \\ 24.2762 eV + E ( C , 2 {sp}^{3} )\end{matrix} ) \\ = - ( \begin{matrix}64.3921 eV + 48.3125 eV + \\ 24.2762 eV + 14.63489 eV\end{matrix} ) \\ = - 151.61569 eV\end{matrix} \qquad ( 23.292 )$$

where E(C,2sp³) is the sum of the energy of C, −11.27671 eV, and the hybridization energy.

The sharing of electrons between the Bi6sp³ Ho and C2sp³ HOs to form a Bi—C-bond MO permits each participating hybridized orbital to decrease in radius and energy. A minimum energy is achieved while satisfying the potential, kinetic, and orbital energy relationships, when the Bi6sp³ HO donates, and the C2sp³ HO receives, excess electron density equivalent to an electron within the Bi—C-bond MO. By considering this electron redistribution in the alkyl bismuth molecule as well as the fact that the central field decreases by an integer for each successive electron of the shell, the radius r_{Bi-C2sp}_{³} of the C2sp³ shell of the Bi—C-bond MO may be calculated from the Coulombic energy using Eqs. (15.18) and (23.292):

$$\begin{matrix}{r}_{Pb - C 2 {sp}^{3}} = ( {\sum }_{n = 2}^{5} ( Z - n ) + 1 ) \frac{{e}^{2}}{8 {πɛ}_{0} ( e 151.61569 eV )} \\ = \frac{11 {e}^{2}}{8 {πɛ}_{0} ( e 151.61569 eV )} \\ = 0.98713 {a}_{0}\end{matrix} \qquad ( 23.293 )$$

Using Eqs. (15.19) and (23.293), the Coulombic energy E_{Coulomb}(C_{Bi-C}2, sp³) of the outer electron of the C2sp³ shell is

$$\begin{matrix}{E}_{Coulomb} ( {C}_{Bi - C} , 2 {sp}^{3} ) = \frac{- {e}^{2}}{8 {πɛ}_{0} {r}_{Bi - C 2 {sp}^{3}}} \\ = \frac{- {e}^{2}}{8 {πɛ}_{0} 0.98713 {a}_{0}} \\ = - 13.78324 eV\end{matrix} \qquad ( 23.294 )$$

During hybridization, the spin-paired 2s electrons are promoted to C2sp³ shell as unpaired electrons. The energy for the promotion is the magnetic energy given by Eq. (14.145). Using Eqs. (14.145) and (23.294), the energy E(C_{Bi—C},2sp³) of the outer electron of the C2sp³ shell is

$$\begin{matrix}E ( {C}_{Bi - C} , 2 {sp}^{3} ) = \frac{- {e}^{2}}{8 {πɛ}_{0} {r}_{Bi - C 2 {sp}^{3}}} + \frac{2 {πμ}_{0} {e}^{2} {ℏ}^{2}}{{{m}_{e}^{2} ( {r}_{3} )}^{3}} \\ = - 13.78324 eV + 0.19086 eV \\ = - 13.59238 eV\end{matrix} \qquad ( 23.295 )$$

Thus, E_{T}(Bi—C,2sp³), the energy change of each C2sp³ shell with the formation of the Bi—C-bond MO is given by the difference between Eq. (23.295) and Eq. (14.146):

$$\begin{matrix}{E}_{T} ( Bi - C , 2 {sp}^{3} ) = E ( {C}_{Bi - C} , 2 {sp}^{3} ) - E ( C , 2 {sp}^{3} ) \\ = - 13.59238 eV - ( - 14.63489 eV ) \\ = 1.04251 eV\end{matrix} \qquad ( 23.296 )$$

Now, consider the formation of the Bi-L-bond MO of bismuth compounds wherein L is a ligand including carbon. For the Bi—C functional group, hybridization of the 2s and 2p AOs of each C and the 6s and 6p AOs of each Bi to form single 2sp³ and 6sp³ shells, respectively, forms an energy minimum, and the sharing of electrons between the C2sp³ and Bi6sp³ HOs to form a MO permits each participating orbital to decrease in radius and energy. In branched-chain alkyl bismuths, the energy of bismuth is less than the Coulombic energy between the electron and proton of H given by Eq. (1.231). Thus, the energy matching condition is determined by the c₂ and C₂ parameters in Eq. (15.61). Then, the C2sp³ HO has an energy of E(C,2sp³)=−14.63489 eV (Eq. (15.25)), and the Bi6sp³ HO has an energy of E(Bi,6sp³)=−10.03679 eV (Eq. (23.286)). To meet the equipotential condition of the union of the Bi—C H₂-type-ellipsoidal-MO with these orbitals, the hybridization factors c₂ and C₂ of Eq. (15.61) for the Bi—C-bond MO given by Eqs. (15.77) are

$$\begin{matrix}{c}_{2} ( C 2 {sp}^{3} HO to Bi 6 {sp}^{3} HO ) = {C}_{2} ( C 2 {sp}^{3} HO to Bi 6 {sp}^{3} HO ) \\ = \frac{E ( Bi , 6 {sp}^{3} )}{E ( C , 2 {sp}^{3} )} \\ = \frac{- 10.03679 eV}{- 14.63489 eV} \\ = 0.68581\end{matrix} \qquad ( 23.297 )$$

The energy of the Bi—C-bond MO is the sum of the component energies of the H₂-type ellipsoidal MO given in Eq. (15.51) with E(AO/HO)=E(Bi,6sp³) given by Eq. (23.286), and E_{T}(atom-atom,msp³.AO) is E_{T}(Bi—C,2sp³) (Eq. (23.296)) in order to match the energies of the carbon and bismuth HOs.

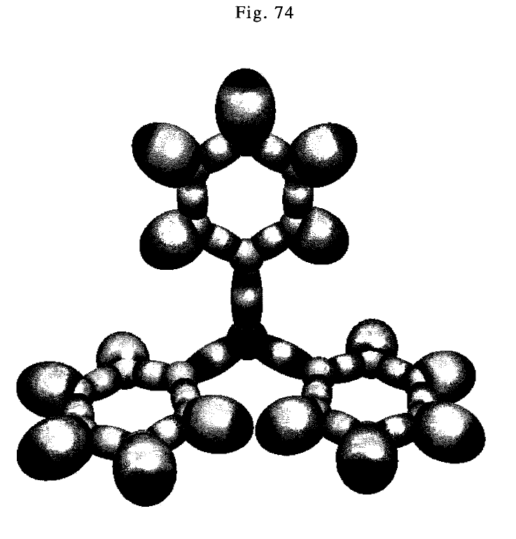

The symbols of the functional groups of branched-chain alkyl bismuths are given in Table 172. The geometrical (Eqs. (15.1-15.5) and (15.51)), intercept (Eqs. (15.80-15.87)), and energy (Eqs. (15.6-15.11) and (15.17-15.65)) parameters of alkyl bismuths are given in Tables 173, 174, and 175, respectively. The total energy of each alkyl bismuth given in Table 176 was calculated as the sum over the integer multiple of each E_{D}(Group) of Table 175 corresponding to functional-group composition of the molecule. The bond angle parameters of alkyl bismuths determined using Eqs. (15.88-15.117) are given in Table 177. The color scale, charge-density of exemplary alkyl bismuth, triphenylbismuth, comprising atoms with the outer shell bridged by one or more H₂-type ellipsoidal MOs or joined with one or more hydrogen MOs is shown in FIG. 74.

TABLE 172
The symbols of functional groups of alkyl bismuths.

| Functional Group | Group Symbol |
|---|---|
| Bi—C | Bi—C |
| CH₃ group | C—H (CH₃) |
| CH₂ group | C—H (CH₂) |
| CH | C—H (i) |
| CC bond (n-C) | C—C (a) |
| CC bond (iso-C) | C—C (b) |
| CC bond (tert-C) | C—C (c) |
| CC (iso to iso-C) | C—C (d) |
| CC (t to t-C) | C—C (e) |
| CC (t to iso-C) | C—C (f) |
| CC (aromatic bond) | C^{3e}═C |
| CH (aromatic) | CH (ii) |

TABLE 173
The geometrical bond parameters of alkyl bismuths and experimental values [3].

| | Bi—C | C—H(CH₃) | C—H(CH₂) | C—H (i) | C—C (a) | C—C (b) |
|---|---|---|---|---|---|---|
| Parameter | Group | Group | Group | Group | Group | Group |
| a (a₀) | 2.18901 | 1.64920 | 1.67122 | 1.67465 | 2.12499 | 2.12499 |
| c′ (a₀) | 2.06296 | 1.04856 | 1.05553 | 1.05661 | 1.45744 | 1.45744 |
| Bond Length 2c′ (Å) | 2.18334 | 1.10974 | 1.11713 | 1.11827 | 1.54280 | 1.54280 |
| Exp. Bond Length | 2.263 | 1.107 | 1.107 | 1.122 | 1.532 | 1.532 |
| (Å) | (Bi(CH₃)₃) | (C—H | (C—H | (isobutane) | (propane) | (propane) |
| | | propane) | propane) | | 1.531 | 1.531 |
| | | 1.117 | 1.117 | | (butane) | (butane) |
| | | (C—H | (C—H | | | |
| | | butane) | butane) | | | |
| b, c (a₀) | 0.73210 | 1.27295 | 1.29569 | 1.29924 | 1.54616 | 1.54616 |
| e | 0.94242 | 0.63580 | 0.63159 | 0.63095 | 0.68600 | 0.68600 |

| | C—C (c) | C—C (d) | C—C (e) | C—C (f) | C^{3e}═C | CH (ii) |
|---|---|---|---|---|---|---|
| Parameter | Group | Group | Group | Group | Group | Group |
| a (a₀) | 2.10725 | 2.12499 | 2.10725 | 2.10725 | 1.47348 | 1.60061 |
| c′ (a₀) | 1.45164 | 1.45744 | 1.45164 | 1.45164 | 1.31468 | 1.03299 |
| Bond Length 2c′ (Å) | 1.53635 | 1.54280 | 1.53635 | 1.53635 | 1.39140 | 1.09327 |
| Exp. Bond Length | 1.532 | 1.532 | 1.532 | 1.532 | 1.399 | 1.101 |
| (Å) | (propane) | (propane) | (propane) | (propane) | (benzene) | (benzene) |
| | 1.531 | 1.531 | 1.531 | 1.531 | | |
| | (butane) | (butane) | (butane) | (butane) | | |
| b, c (a₀) | 1.52750 | 1.54616 | 1.52750 | 1.52750 | 0.66540 | 1.22265 |
| e | 0.68888 | 0.68600 | 0.68888 | 0.68888 | 0.89223 | 0.64537 |

TABLE 174
The MO to HO intercept geometrical bond parameters of alkyl bismuths. R, R′, R″ are H or alkyl groups. E_{T} is E_{T}
(atom-atom, msp³.AO.

| | | | | | | Final | | |
|---|---|---|---|---|---|---|---|---|
| | | | | | | Total | | |
| | | E_{T} | E_{T} | E_{T} | E_{T} | Energy | | |
| | | (eV) | (eV) | (eV) | (eV) | C2sp³ | rᵢₙᵢₜᵢₐₗ | r_{final} |
| Bond | Atom | Bond 1 | Bond 2 | Bond 3 | Bond 4 | (eV) | (a₀) | (a₀) |
| C—H(CH₃) | C | 0.52125 | 0 | 0 | 0 | −151.09444 | 0.91771 | 0.95116 |
| (CH₃)₂Bi—CH₃ | C | 0.52125 | 0 | 0 | 0 | | 0.91771 | 0.95116 |
| (CH₃)₂Bi—CH₃ | Bi | 0.52125 | 0.52125 | 0.52125 | 0 | | 1.35293 | 1.02592 |
| C—H(CH₃) | C | −0.92918 | 0 | 0 | 0 | −152.54487 | 0.91771 | 0.86359 |
| C—H(CH₂) | C | −0.92918 | −0.92918 | 0 | 0 | −153.47406 | 0.91771 | 0.81549 |
| C—H(CH) | C | −0.92918 | −0.92918 | −0.92918 | 0 | −154.40324 | 0.91771 | 0.77247 |
| H₃CₐC_{b}H₂CH₂—(C—C (a)) | Cₐ | −0.92918 | 0 | 0 | 0 | −152.54487 | 0.91771 | 0.86359 |
| H₃CₐC_{b}H₂CH₂—(C—C (a)) | C_{b} | −0.92918 | −0.92918 | 0 | 0 | −153.47406 | 0.91771 | 0.81549 |
| R—H₂CₐC_{b}(H₂C_{c}—R′)HCH₂—(C—C (b)) | C_{b} | −0.92918 | −0.92918 | −0.92918 | 0 | −154.40324 | 0.91771 | 0.77247 |
| R—H₂Cₐ(R′—H₂C_{d})C_{b}(R″—H₂C_{c})CH₂—(C—C (c)) | C_{b} | −0.92918 | −0.72457 | −0.72457 | −0.72457 | −154.71860 | 0.91771 | 0.75889 |
| isoCₐC_{b}(H₂C_{c}—R′)HCH₂—(C—C (d)) | C_{b} | −0.92918 | −0.92918 | −0.92918 | 0 | −154.40324 | 0.91771 | 0.77247 |
| tertCₐ(R′—H₂C_{d})C_{b}(R″—H₂C_{c})CH₂—(C—C (e)) | C_{b} | −0.72457 | −0.72457 | −0.72457 | −0.72457 | −154.51399 | 0.91771 | 0.76765 |
| tertCₐC_{b}(H₂C_{c}—R′)HCH₂—(C—C (f)) | C_{b} | −0.72457 | −0.92918 | −0.92918 | 0 | −154.19863 | 0.91771 | 0.78155 |
| isoCₐ(R′—H₂C_{d})C_{b}(R″—H₂C_{c})CH₂—(C—C (f)) | C_{b} | −0.72457 | −0.72457 | −0.72457 | −0.72457 | −154.51399 | 0.91771 | 0.76765 |

| | E_{Coulomb} | E (C2sp³) | | | | | |
|---|---|---|---|---|---|---|---|
| | (eV) | (eV) | θ′ | θ₁ | θ₂ | d₁ | d₂ |
| Bond | Final | Final | (°) | (°) | (°) | (a₀) | (a₀) |
| C—H(CH₃) | −14.30450 | −14.11363 | 87.03 | 92.97 | 48.26 | 1.09791 | 0.04936 |
| (CH₃)₂Bi—CH₃ | −14.30450 | −14.11363 | 141.99 | 38.01 | 53.13 | 1.31349 | 0.74947 |
| (CH₃)₂Bi—CH₃ | −13.26199 | | 143.89 | 36.11 | 55.68 | 1.23415 | 0.82881 |
| C—H(CH₃) | −15.75493 | −15.56407 | 77.49 | 102.51 | 41.48 | 1.23564 | 0.18708 |
| C—H(CH₂) | −16.68412 | −16.49325 | 68.47 | 111.53 | 35.84 | 1.35486 | 0.29933 |
| C—H(CH) | −17.61330 | −17.42244 | 61.10 | 118.90 | 31.37 | 1.42988 | 0.37326 |
| H₃CₐC_{b}H₂CH₂—(C—C (a)) | −15.75493 | −15.56407 | 63.82 | 116.18 | 30.08 | 1.83879 | 0.38106 |
| H₃CₐC_{b}H₂CH₂—(C—C (a)) | −16.68412 | −16.49325 | 56.41 | 123.59 | 26.06 | 1.90890 | 0.45117 |
| R—H₂CₐC_{b}(H₂C_{c}—R′)HCH₂—(C—C (b)) | −17.61330 | −17.42244 | 48.30 | 131.70 | 21.90 | 1.97162 | 0.51388 |
| R—H₂Cₐ(R′—H₂C_{d})C_{b}(R″—H₂C_{c})CH₂—(C—C (c)) | −17.92866 | −17.73779 | 48.21 | 131.79 | 21.74 | 1.95734 | 0.50570 |
| isoCₐC_{b}(H₂C_{c}—R′)HCH₂—(C—C (d)) | −17.61330 | −17.42244 | 48.30 | 131.70 | 21.90 | 1.97162 | 0.51388 |
| tertCₐ(R′—H₂C_{d})C_{b}(R″—H₂C_{c})CH₂—(C—C (e)) | −17.92866 | −17.73779 | 50.04 | 129.96 | 22.66 | 1.94462 | 0.49298 |
| tertCₐC_{b}(H₂C_{c}—R′)HCH₂—(C—C (f)) | −17.40869 | −17.21783 | 52.78 | 127.22 | 24.04 | 1.92443 | 0.47279 |
| isoCₐ(R′—H₂C_{d})C_{b}(R″—H₂C_{c})CH₂—(C—C (f)) | −17.92866 | −17.73779 | 50.04 | 129.96 | 22.66 | 1.94462 | 0.49298 |

TABLE 175
The energy parameters (eV) of functional groups of alkyl bismuths.

| | Bi—C | CH₃ | CH₂ | CH (i) | C—C (a) | C—C (b) |
|---|---|---|---|---|---|---|
| Parameters | Group | Group | Group | Group | Group | Group |
| f₁ | 1 | 1 | 1 | 1 | 1 | 1 |
| n₁ | 1 | 3 | 2 | 1 | 1 | 1 |
| n₂ | 0 | 2 | 1 | 0 | 0 | 0 |
| n₃ | 0 | 0 | 0 | 0 | 0 | 0 |
| C₁ | 0.375 | 0.75 | 0.75 | 0.75 | 0.5 | 0.5 |
| C₂ | 0.68581 | 1 | 1 | 1 | 1 | 1 |
| c₁ | 1 | 1 | 1 | 1 | 1 | 1 |
| c₂ | 0.68581 | 0.91771 | 0.91771 | 0.91771 | 0.91771 | 0.91771 |
| c₃ | 0 | 0 | 1 | 1 | 0 | 0 |
| c₄ | 2 | 1 | 1 | 1 | 2 | 2 |
| c₅ | 0 | 3 | 2 | 1 | 0 | 0 |
| C₁ₒ | 0.375 | 0.75 | 0.75 | 0.75 | 0.5 | 0.5 |
| C₂ₒ | 0.68581 | 1 | 1 | 1 | 1 | 1 |
| Vₑ (eV) | −31.82881 | −107.32728 | −70.41425 | −35.12015 | −28.79214 | −28.79214 |
| Vₚ (eV) | 6.59529 | 38.92728 | 25.78002 | 12.87680 | 9.33352 | 9.33352 |
| T (eV) | 7.27014 | 32.53914 | 21.06675 | 10.48582 | 6.77464 | 6.77464 |
| Vₘ (eV) | −3.63507 | −16.26957 | −10.53337 | −5.24291 | −3.38732 | −3.38732 |
| E (AO/HO) (eV) | −10.03679 | −15.56407 | −15.56407 | −14.63489 | −15.56407 | −15.56407 |
| ΔE_{H}_{₂}_{MO} (AO/HO) (eV) | 0 | 0 | 0 | 0 | 0 | 0 |
| E_{T} (AO/HO) (eV) | −10.03679 | −15.56407 | −15.56407 | −14.63489 | −15.56407 | −15.56407 |
| E_{T} (H₂MO) (eV) | −31.63524 | −67.69451 | −49.66493 | −31.63533 | −31.63537 | −31.63537 |
| E_{T} (atom-atom, | 1.04251 | 0 | 0 | 0 | −1.85836 | −1.85836 |
| msp³.AO) (eV) | | | | | | |
| E_{T} (MO) (eV) | −30.59286 | −67.69450 | −49.66493 | −31.63537 | −33.49373 | −33.49373 |
| ω (10¹⁵ rad/s) | 33.4696 | 24.9286 | 24.2751 | 24.1759 | 9.43699 | 9.43699 |
| E_{K} (eV) | 22.03030 | 16.40846 | 15.97831 | 15.91299 | 6.21159 | 6.21159 |
| Ē_{D} (eV) | −0.28408 | −0.25352 | −0.25017 | −0.24966 | −0.16515 | −0.16515 |
| Ē_{Kvib} (eV) | 0.14878 [66] | 0.35532 | 0.35532 | 0.35532 | 0.12312 [6] | 0.17978 [7] |
| | | (Eq. | (Eq. | (Eq. | | |
| | | (13.458)) | (13.458)) | (13.458)) | | |
| Ē_{osc} (eV) | −0.20968 | −0.22757 | −0.14502 | −0.07200 | −0.10359 | −0.07526 |
| E_{mag} (eV) | 0.14803 | 0.14803 | 0.14803 | 0.14803 | 0.14803 | 0.14803 |
| E_{T} (Group) (eV) | −30.80254 | −67.92207 | −49.80996 | −31.70737 | −33.59732 | −33.49373 |
| Eᵢₙᵢₜᵢₐₗ (c₄ AO/HO) (eV) | −14.63489 | −14.63489 | −14.63489 | −14.63489 | −14.63489 | −14.63489 |
| Eᵢₙᵢₜᵢₐₗ (c₅ AO/HO) (eV) | 0 | −13.59844 | −13.59844 | −13.59844 | 0 | 0 |
| E_{D} (Group) (eV) | 1.53276 | 12.49186 | 7.83016 | 3.32601 | 4.32754 | 4.29921 |
| | C—C (c) | C—C (d) | C—C (e) | C—C (f) | C^{3e}═C | CH (ii) |
| Parameters | Group | Group | Group | Group | Group | Group |
| f₁ | 1 | 1 | 1 | 1 | 0.75 | 1 |
| n₁ | 1 | 1 | 1 | 1 | 2 | 1 |
| n₂ | 0 | 0 | 0 | 0 | 0 | 0 |
| n₃ | 0 | 0 | 0 | 0 | 0 | 0 |
| C₁ | 0.5 | 0.5 | 0.5 | 0.5 | 0.5 | 0.75 |
| C₂ | 1 | 1 | 1 | 1 | 0.85252 | 1 |
| c₁ | 1 | 1 | 1 | 1 | 1 | 1 |
| c₂ | 0.91771 | 0.91771 | 0.91771 | 0.91771 | 0.85252 | 0.91771 |
| c₃ | 0 | 1 | 1 | 0 | 0 | 1 |
| c₄ | 2 | 2 | 2 | 2 | 3 | 1 |
| c₅ | 0 | 0 | 0 | 0 | 0 | 1 |
| C₁ₒ | 0.5 | 0.5 | 0.5 | 0.5 | 0.5 | 0.75 |
| C₂ₒ | 1 | 1 | 1 | 1 | 0.85252 | 1 |
| Vₑ (eV) | −29.10112 | −28.79214 | −29.10112 | −29.10112 | −101.12679 | −37.10024 |
| Vₚ (eV) | 9.37273 | 9.33352 | 9.37273 | 9.37273 | 20.69825 | 13.17125 |
| T (eV) | 6.90500 | 6.77464 | 6.90500 | 6.90500 | 34.31559 | 11.58941 |
| Vₘ (eV) | −3.45250 | −3.38732 | −3.45250 | −3.45250 | −17.15779 | −5.79470 |
| E (AO/HO) (eV) | −15.35946 | −15.56407 | −15.35946 | −15.35946 | 0 | −14.63489 |
| ΔE_{H}_{₂}_{MO} (AO/HO) (eV) | 0 | 0 | 0 | 0 | 0 | −1.13379 |
| E_{T} (AO/HO) (eV) | −15.35946 | −15.56407 | −15.35946 | −15.35946 | 0 | 13.50110 |
| E_{T} (H₂MO) (eV) | −31.63535 | −31.63537 | −31.63535 | −31.63535 | −63.27075 | −31.63539 |
| E_{T} (atom-atom, | −1.44915 | −1.85836 | −1.44915 | −1.44915 | −2.26759 | −0.56690 |
| msp³.AO) (eV) | | | | | | |
| E_{T} (MO) (eV) | −33.08452 | −33.49373 | −33.08452 | −33.08452 | −65.53833 | −32.20226 |
| ω (10¹⁵ rad/s) | 15.4846 | 9.43699 | 9.55643 | 9.55643 | 49.7272 | 26.4826 |
| E_{K} (eV) | 10.19220 | 6.21159 | 6.29021 | 6.29021 | 32.73133 | 17.43132 |
| Ē_{D} (eV) | −0.20896 | −0.16515 | −0.16416 | −0.16416 | −0.35806 | −0.26130 |
| Ē_{Kvib} (eV) | 0.09944 [8] | 0.12312 [6] | 0.12312 [6] | 0.12312 [6] | 0.19649 [30] | 0.35532 |
| | | | | | | Eq. (13.458) |
| Ē_{osc} (eV) | −0.15924 | −0.10359 | −0.10260 | −0.10260 | −0.25982 | −0.08364 |
| E_{mag} (eV) | 0.14803 | 0.14803 | 0.14803 | 0.14803 | 0.14803 | 0.14803 |
| E_{T} (Group) (eV) | −33.24376 | −33.59732 | −33.18712 | −33.18712 | −49.54347 | −32.28590 |
| Eᵢₙᵢₜᵢₐₗ (c₄ AO/HO) (eV) | −14.63489 | −14.63489 | −14.63489 | −14.63489 | −14.63489 | −14.63489 |
| Eᵢₙᵢₜᵢₐₗ (c₅ AO/HO) (eV) | 0 | 0 | 0 | 0 | 0 | −13.59844 |
| E_{D} (Group) (eV) | 3.97398 | 4.17951 | 3.62128 | 3.91734 | 5.63881 | 3.90454 |

TABLE 176
The total bond energies of alkyl bismuths calculated using the functional group composition and
the energies of Table 175 compared to the experimental values [88].

| Formula | Name | Bi—C | CH₃ | CH₂ | CH (i) | C—C (a) | C—C (b) | C—C (c) | C—C (d) |
|---|---|---|---|---|---|---|---|---|---|
| C₃H₉Bi | Trimethylbismuth | 3 | 3 | 0 | 0 | 0 | 0 | 0 | 0 |
| C₆H₁₅Bi | Triethylbismuth | 3 | 3 | 3 | 0 | 3 | 0 | 0 | 0 |
| C₁₈H₁₅Bi | Triphenylbismuth | 3 | 0 | 0 | 0 | 0 | 0 | 0 | 0 |

| | | | | | | Calculated | Experimental | |
|---|---|---|---|---|---|---|---|---|
| | | | | | | Total Bond | Total Bond | Relative |
| Formula | Name | C—C (e) | C—C (f) | C^{3e}═C | CH (ii) | Energy (eV) | Energy (eV) | Error |
| C₃H₉Bi | Trimethylbismuth | 0 | 0 | 0 | 0 | 42.07387 | 42.79068 | 0.01675 |
| C₆H₁₅Bi | Triethylbismuth | 0 | 0 | 0 | 0 | 78.54697 | 78.39153 | −0.00198 |
| C₁₈H₁₅Bi | Triphenylbismuth | 0 | 0 | 18 | 15 | 164.66490 | 163.75184 | −0.00558 |

TABLE 177
The bond angle parameters of alkyl bismuths and experimental values [3]. In the calculation of θᵥ, the parameters from
the preceding angle were used. E_{T} is E_{T} (atom-atom,msp³.AO).

| | | | 2c′ | | Atom 1 | | Atom 2 | | | |
|---|---|---|---|---|---|---|---|---|---|---|
| | 2c′ | 2c′ | Terminal | E_{Coulombic} | Hybridization | | Hybridization | | | |
| Atoms of | Bond 1 | Bond 2 | Atoms | or E | Designation | E_{Coulombic} | Designation | c₂ | c₂ | |
| Angle | (a₀) | (a₀) | (a₀) | Atom 1 | (Table 7) | Atom 2 | (Table 7) | Atom 1 | Atom 2 | C₁ |
| Methyl | 2.09711 | 2.09711 | 3.4252 | −15.75493 | 7 | H | H | 0.86359 | 1 | 1 |
| ∠HCₐH | | | | | | | | | | |
| ∠HₐCₐBi | | | | | | | | | | |
| ∠CₐBiC_{b} | 4.12592 | 4.12592 | 6.1806 | −15.18804 | 2 | −15.18804 | 2 | 0.89582 | 0.89582 | 1 |
| Methylene | 2.11106 | 2.11106 | 3.4252 | −15.75493 | 7 | H | H | 0.86359 | 1 | 1 |
| ∠HCₐH | | | | | | | | | | |
| ∠CₐC_{b}C_{c} | | | | | | | | | | |
| ∠CₐC_{b}H | | | | | | | | | | |
| Methyl | 2.09711 | 2.09711 | 3.4252 | −15.75493 | 7 | H | H | 0.86359 | 1 | 1 |
| ∠HCₐH | | | | | | | | | | |
| ∠CₐC_{b}C_{c} | | | | | | | | | | |
| ∠CₐC_{b}H | | | | | | | | | | |
| ∠C_{b}CₐC_{c} | 2.91547 | 2.91547 | 4.7958 | −16.68412 | 26 | −16.68412 | 26 | 0.81549 | 0.81549 | 1 |
| iso Cₐ | | | | C_{b} | | C_{c} | | | | |
| ∠C_{b}CₐH | 2.91547 | 2.11323 | 4.1633 | −15.55033 | 5 | −14.82575 | 1 | 0.87495 | 0.91771 | 0.75 |
| iso Cₐ | | | | Cₐ | | C_{b} | | | | |
| ∠CₐC_{b}H | 2.91547 | 2.09711 | 4.1633 | −15.55033 | 5 | −14.82575 | 1 | 0.87495 | 0.91771 | 0.75 |
| iso Cₐ | | | | C_{b} | | Cₐ | | | | |
| ∠C_{b}CₐC_{b} | 2.90327 | 2.90327 | 4.7958 | −16.68412 | 26 | −16.68412 | 26 | 0.81549 | 0.81549 | 1 |
| tert Cₐ | | | | C_{b} | | C_{b} | | | | |
| ∠C_{b}CₐC_{d} | | | | | | | | | | |

| Atoms of | | | | E_{T} | θᵥ | θ₁ | θ₂ | Cal. θ | Exp. θ |
|---|---|---|---|---|---|---|---|---|---|
| Angle | C₂ | c₁ | c₂′ | (eV) | (°) | (°) | (°) | (°) | (°) |
| Methyl | 1 | 0.75 | 1.15796 | 0 | | | | 109.50 | |
| ∠HCₐH | | | | | | | | | |
| ∠HₐCₐBi | | | | | 70.56 | | | 109.44 | |
| ∠CₐBiC_{b} | 1 | 1 | 0.89582 | −1.85836 | | | | 97.01 | 97.1 |
| | | | | | | | | | (trimethylbismuth) |
| Methylene | 1 | 0.75 | 1.15796 | 0 | | | | 108.44 | 107 |
| ∠HCₐH | | | | | | | | | (propane) |
| ∠CₐC_{b}C_{c} | | | | | 69.51 | | | 110.49 | 112 |
| | | | | | | | | | (propane) |
| | | | | | | | | | 113.8 |
| | | | | | | | | | (butane) |
| | | | | | | | | | 110.8 |
| | | | | | | | | | (isobutane) |
| ∠CₐC_{b}H | | | | | 69.51 | | | 110.49 | 111.0 |
| | | | | | | | | | (butane) |
| | | | | | | | | | 111.4 |
| | | | | | | | | | (isobutane) |
| Methyl | 1 | 0.75 | 1.15796 | 0 | | | | 109.50 | |
| ∠HCₐH | | | | | | | | | |
| ∠CₐC_{b}C_{c} | | | | | 70.56 | | | 109.44 | |
| ∠CₐC_{b}H | | | | | 70.56 | | | 109.44 | |
| ∠C_{b}CₐC_{c} | 1 | 1 | 0.81549 | −1.85836 | | | | 110.67 | 110.8 |
| iso Cₐ | | | | | | | | | (isobutane) |
| ∠C_{b}CₐH | 1 | 0.75 | 1.04887 | 0 | | | | 110.76 | |
| iso Cₐ | | | | | | | | | |
| ∠CₐC_{b}H | 1 | 0.75 | 1.04887 | 0 | | | | 111.27 | 111.4 |
| iso Cₐ | | | | | | | | | (isobutane) |
| ∠C_{b}CₐC_{b} | 1 | 1 | 0.81549 | −1.85836 | | | | 111.37 | 110.8 |
| tert Cₐ | | | | | | | | | (isobutane) |
| ∠C_{b}CₐC_{d} | | | | | 72.50 | | | 107.50 | |

Summary Tables of Organometallic and Coordinate Molecules

The bond energies, calculated using closed-form equations having integers and fundamental constants only for classes of molecules whose designation is based on the main functional group, are given in the following tables with the experimental values.

TABLE 178
Summary results of organoaluminum compounds.

| | | Calculated | Experimental | |
|---|---|---|---|---|
| | | Total Bond | Total Bond | Relative |
| Formula | Name | Energy (eV) | Energy (eV) | Error |
| C₂H₇Al | dimethylaluminum hydride | 34.31171 | 34.37797^{a} | 0.00193 |
| | | | [11] | |
| C₃H₉Al | trimethyl aluminum | 47.10960 | 46.95319 | −0.00333 |
| C₄H₁₁Al | diethylaluminum hydride | 58.62711 | 60.10948^{b} | 0.02466 |
| C₆H₁₅Al | triethylaluminum hydride | 83.58270 | 83.58176 | −0.00001 |
| C₆H₁₅Al | di-n-propylaluminum hydride | 82.94251 | 84.40566^{b} | 0.01733 |
| C₉H₂₁Al | tri-n-propyl aluminum | 120.05580 | 121.06458^{b} | 0.00833 |
| C₈H₁₉Al | di-n-butylaluminum hydride | 107.25791 | 108.71051^{b} | 0.01336 |
| C₈H₁₉Al | di-isobutylaluminum hydride | 107.40303 | 108.77556^{b} | 0.01262 |
| C₁₂H₂₇Al | tri-n-butyl aluminum | 156.52890 | 157.42429^{b} | 0.00569 |
| C₁₂H₂₇Al | tri-isobutyl aluminum | 156.74658 | 157.58908^{b} | 0.00535 |

^{a}Estimated.
^{b}Crystal

TABLE 179
Summary results of scandium coordinate compounds.

| | | Calculated | Experimental | |
|---|---|---|---|---|
| | | Total Bond | Total Bond | Relative |
| Formula | Name | Energy (eV) | Energy (eV) | Error |
| ScF | scandium fluoride | 6.34474 | 6.16925 | −0.02845 |
| ScF₂ | scandium difluoride | 12.11937 | 12.19556 | 0.00625 |
| ScF₃ | scandium trifluoride | 19.28412 | 19.27994 | −0.00022 |
| ScCl | scandium chloride | 4.05515 | 4.00192 | −0.01330 |
| ScO | scandium oxide | 7.03426 | 7.08349 | 0.00695 |

TABLE 180
Summary results of titanium coordinate compounds.

| | | Calculated | Experimental | | |
|---|---|---|---|---|---|
| | | Total Bond | Total Bond | | Relative |
| Formula | Name | Energy (eV) | Energy (eV) | | Error |
| TiF | titanium fluoride | 6.44997 | 6.41871 | [21] | −0.00487 |
| TiF₂ | titanium difluoride | 13.77532 | 13.66390 | [21] | −0.00815 |
| TiF₃ | titanium trifluoride | 19.63961 | 19.64671 | [21] | 0.00036 |
| TiF₄ | titanium tetrafluoride | 24.66085 | 24.23470 | [21] | −0.01758 |
| TiCl | titanium chloride | 4.56209 | 4.56198 | [22] | −0.00003 |
| TiCl₂ | titanium dichoride | 10.02025 | 9.87408 | [22] | −0.01517 |
| TiCl₃ | titanium trichloride | 14.28674 | 14.22984 | [22] | −0.00400 |
| TiCl₄ | titanium tetrachloride | 17.94949 | 17.82402 | [22] | −0.00704 |
| TiBr | titanium bromide | 3.77936 | 3.78466 | [19] | 0.00140 |
| TiBr₂ | titanium dibromide | 8.91650 | 8.93012 | [19] | 0.00153 |
| TiBr₃ | titanium tribromide | 12.07765 | 12.02246 | [19] | −0.00459 |
| TiBr₄ | titanium tetrabromide | 14.90122 | 14.93239 | [19] | 0.00209 |
| TiI | titanium iodide | 3.16446 | 3.15504 | [20] | −0.00299 |
| TiI₂ | titanium diiodide | 7.35550 | 7.29291 | [20] | −0.00858 |
| TiI₃ | titanium triiodide | 9.74119 | 9.71935 | [20] | −0.00225 |
| TiI₄ | titanium tetraiodide | 12.10014 | 12.14569 | [20] | 0.00375 |
| TiO | titanium oxide | 7.02729 | 7.00341 | [23] | −0.00341 |
| TiO₂ | titanium dioxide | 13.23528 | 13.21050 | [23] | −0.00188 |
| TiOF | titanium fluoride oxide | 12.78285 | 12.77353 | [23] | −0.00073 |
| TiOF₂ | titanium difluoride oxide | 18.94807 | 18.66983 | [23] | −0.01490 |
| TiOCl | titanium chloride oxide | 11.10501 | 11.25669 | [23] | 0.01347 |
| TiOCl₂ | titanium dichloride oxide | 15.59238 | 15.54295 | [23] | −0.00318 |

TABLE 181
Summary results of vanadium coordinate compounds.

| | | Calculated | Experimental | | |
|---|---|---|---|---|---|
| | | Total Bond | Total Bond | | Relative |
| Formula | Name | Energy (eV) | Energy (eV) | | Error |
| VF₅ | vanadium pentafluoride | 24.06031 | 24.24139 | [15] | 0.00747 |
| VCl₄ | vanadium tetrachloride | 15.84635 | 15.80570 | [15] | −0.00257 |
| VN | vanadium nitride | 4.85655 | 4.81931 | [24] | −0.00775 |
| VO | vanadium oxide | 6.37803 | 6.60264 | [15] | 0.03402 |
| VO₂ | vanadium dioxide | 12.75606 | 12.89729 | [34] | 0.01095 |
| VOCl₃ | vanadium trichloride oxide | 18.26279 | 18.87469 | [15] | 0.03242 |
| V(CO)₆ | vanadium hexacarbonyl | 75.26791 | 75.63369 | [32] | 0.00484 |
| V(C₆H₆))₂ | dibenzene vanadium | 119.80633 | 121.20193^{a} | [33] | 0.01151 |

^{a}Liquid.

TABLE 182
Summary results of chromium coordinate compounds.

| | | Calculated | Experimental | | |
|---|---|---|---|---|---|
| | | Total Bond | Total Bond | | Relative |
| Formula | Name | Energy (eV) | Energy (eV) | | Error |
| CrF₂ | chromium difluoride | 10.91988 | 10.92685 | [15] | 0.00064 |
| CrCl₂ | chromium dichloride | 7.98449 | 7.96513 | [15] | −0.00243 |
| CrO | chromium oxide | 4.73854 | 4.75515 | [37] | 0.00349 |
| CrO₂ | chromium dioxide | 10.02583 | 10.04924 | [37] | 0.00233 |
| CrO₃ | chromium trioxide | 14.83000 | 14.85404 | [37] | 0.00162 |
| CrO₂Cl₂ | chromium dichloride dioxide | 17.46158 | 17.30608 | [15] | −0.00899 |
| Cr(CO)₆ | chromium hexacarbonyl | 74.22588 | 74.61872 | [44] | 0.00526 |
| Cr(C₆H₆)₂ | dibenzene chromium | 117.93345 | 117.97971 | [44] | 0.00039 |
| Cr((CH₃)₃C₆H₃)₂ | di-(1,2,4-trimethylbenzene) | 191.27849 | 192.42933^{a} | [44] | 0.00598 |
| | chromium | | | | |

^{a}Liquid.

TABLE 183
Summary results of manganese coordinate compounds.

| | | Calculated | Experimental | |
|---|---|---|---|---|
| | | Total Bond | Total Bond | Relative |
| Formula | Name | Energy (eV) | Energy (eV) | Error |
| MnF | manganese | 4.03858 | 3.97567 [15] | −0.01582 |
| | fluoride | | | |
| MnCl | manganese | 3.74528 | 3.73801 [15] | −0.00194 |
| | chloride | | | |
| Mn₂(CO)₁₀ | dimanganese | 123.78299 | 122.70895 [49] | −0.00875 |
| | decacarbonyl | | | |

TABLE 184
Summary results of iron coordinate compounds.

| | | Calculated | Experimental | | |
|---|---|---|---|---|---|
| | | Total Bond | Total Bond | | Relative |
| Formula | Name | Energy (eV) | Energy (eV) | | Error |
| FeF | iron fluoride | 4.65726 | 4.63464 | [15] | −0.00488 |
| FeF₂ | iron difluoride | 10.03188 | 9.98015 | [15] | −0.00518 |
| FeF₃ | iron trifluoride | 15.31508 | 15.25194 | [15] | −0.00414 |
| FeCl | iron chloride | 2.96772 | 2.97466 | [15] | 0.00233 |
| FeCl₂ | iron dichoride | 8.07880 | 8.28632 | [15] | 0.02504 |
| FeCl₃ | iron trichloride | 10.82348 | 10.70065 | [50] | −0.01148 |
| FeO | iron oxide | 4.09983 | 4.20895 | [15] | 0.02593 |
| Fe(CO)₅ | iron penta- | 61.75623 | 61.91846 | [29] | 0.00262 |
| | carbonyl | | | | |
| Fe(C₅H₅)₂ | bis-cylopenta- | 98.90760 | 98.95272 | [53] | 0.00046 |
| | dienyl iron | | | | |
| | (ferrocene) | | | | |

TABLE 185
Summary results of cobalt coordinate compounds.

| | | Calculated | Experimental | |
|---|---|---|---|---|
| | | Total Bond | Total Bond | Relative |
| Formula | Name | Energy (eV) | Energy (eV) | Error |
| CoF₂ | cobalt difluoride | 9.45115 | 9.75552 [54] | 0.03120 |
| CoCl | cobalt chloride | 3.66504 | 3.68049 [15] | 0.00420 |
| Col₂ | cobalt dichloride | 7.98467 | 7.92106 [15] | −0.00803 |
| CoCl₃ | cobalt trichloride | 9.83521 | 9.87205 [15] | 0.00373 |
| CoH(CO)₄ | cobalt tetra- | 50.33217 | 50.36087 [53] | 0.00057 |
| | carbonyl hydride | | | |

TABLE 186
Summary results of nickel coordinate compounds.

| | | Calculated | Experimental | |
|---|---|---|---|---|
| | | Total Bond | Total Bond | Relative |
| Formula | Name | Energy (eV) | Energy (eV) | Error |
| NiCl | nickel chloride | 3.84184 | 3.82934 [59] | −0.00327 |
| NiCl₂ | nickel dichloride | 7.76628 | 7.74066 [59] | −0.00331 |
| Ni(CO)₄ | nickel tetra- | 50.79297 | 50.77632 [55] | −0.00033 |
| | carbonyl | | | |
| Ni(C₅H₅)₂ | bis-cylopenta- | 97.73062 | 97.84649 [53] | 0.00118 |
| | dienyl nickel | | | |
| | (nickelocene) | | | |

TABLE 187
Summary results of copper coordinate compounds.

| | | Calculated | Experimental | |
|---|---|---|---|---|
| | | Total Bond | Total Bond | Relative |
| Formula | Name | Energy (eV) | Energy (eV) | Error |
| CuF | copper fluoride | 4.39399 | 4.44620 [63] | 0.01174 |
| CuF₂ | copper difluoride | 7.91246 | 7.89040 [63] | −0.00280 |
| CuCl | copper chloride | 3.91240 | 3.80870 [15] | −0.02723 |
| CuO | copper oxide | 2.93219 | 2.90931 [63] | −0.00787 |

TABLE 188
Summary results of zinc coordinate compounds.

| | | Calculated | Experimental | | |
|---|---|---|---|---|---|
| | | Total Bond | Total Bond | | Relative |
| Formula | Name | Energy (eV) | Energy (eV) | | Error |
| ZnCl | zinc chloride | 2.56175 | 2.56529 | [15] | 0.00138 |
| ZnCl₂ | zinc dichloride | 6.68749 | 6.63675 | [15] | −0.00764 |
| Zn(CH₃)₂ | dimethylzinc | 29.35815 | 29.21367 | [15] | −0.00495 |
| (CH₃CH₂)₂Zn | diethylzinc | 53.67355 | 53.00987 | [65] | −0.01252 |
| (CH₃CH₂CH₂)₂Zn | di-n-propylzinc | 77.98895 | 77.67464 | [65] | −0.00405 |
| (CH₃CH₂CH₂CH₂)₂Zn | di-n-butylzinc | 102.30435 | 101.95782 | [65] | −0.00340 |

TABLE 189
Summary results of germanium compounds.

| | | Calculated | Experimental | |
|---|---|---|---|---|
| | | Total Bond | Total Bond | Relative |
| Formula | Name | Energy (eV) | Energy (eV) | Error |
| C₈H₂₀Ge | tetraethylgermanium | 109.99686 | 110.18166 | 0.00168 |
| C₁₂H₂₈Ge | tetra-n-propyl- | 158.62766 | 158.63092 | 0.00002 |
| | germanium | | | |
| C₁₂H₃₀Ge₂ | hexaethyldi- | 167.88982 | 167.89836 | 0.00005 |
| | germanium | | | |

TABLE 190
Summary results of tin compounds.

| | | Calculated | Experimental | | |
|---|---|---|---|---|---|
| | | Total Bond | Total Bond | | Relative |
| Formula | Name | Energy (eV) | Energy (eV) | | Error |
| SnCl₄ | tin tetrachloride | 12.95756 | 13.03704 | [82] | 0.00610 |
| CH₃Cl₃Sn | methyltin trichloride | 24.69530 | 25.69118^{a} | [83] | 0.03876 |
| C₂H₆Cl₂Sn | dimethyltin dichloride | 36.43304 | 37.12369 | [84] | 0.01860 |
| C₃H₉ClSn | trimethylin chloride | 48.17077 | 49.00689 | [84] | 0.01706 |
| SnBr₄ | tin tetrabromide | 10.98655 | 11.01994 | [82] | 0.00303 |
| C₃H₉BrSn | trimethyltin bromide | 47.67802 | 48.35363 | [84] | 0.01397 |
| C₁₂H₁₀Br₂Sn | diphenyltin dibromide | 117.17489 | 117.36647^{a} | [83] | 0.00163 |
| C₁₂H₂₇BrSn | tri-n-butyltin bromide | 157.09732 | 157.26555^{a} | [83] | 0.00107 |
| C₁₈H₁₅BrSn | triphenyltin bromide | 170.26905 | 169.91511^{a} | [83] | −0.00208 |
| SnI₄ | tin tetraiodide | 9.71697 | 9.73306 | [85] | 0.00165 |
| C₃H₉ISn | trimethyltin iodide | 47.36062 | 47.69852 | [84] | 0.00708 |
| C₁₈H₁₅SnI | triphenyltin iodide | 169.95165 | 167.87948^{a} | [84] | −0.01234 |
| SnO | tin oxide | 5.61858 | 5.54770 | [82] | −0.01278 |
| SnH₄ | stannane | 10.54137 | 10.47181 | [82] | −0.00664 |
| C₂H₈Sn | dimethylstannane | 35.22494 | 35.14201 | [84] | −0.00236 |
| C₃H₁₀Sn | trimethylstannane | 47.56673 | 47.77353 | [84] | 0.00433 |
| C₄H₁₂Sn | diethylstannane | 59.54034 | 59.50337 | [84] | −0.00062 |
| C₄H₁₂Sn | tetramethyltin | 59.90851 | 60.13973 | [82] | 0.00384 |
| C₅H₁₂Sn | trimethylvinyltin | 66.08296 | 66.43260 | [84] | 0.00526 |
| C₅H₁₄Sn | trimethylethyltin | 72.06621 | 72.19922 | [83] | 0.00184 |
| C₆H₁₆Sn | trimethylisopropyltin | 84.32480 | 84.32346 | [83] | −0.00002 |
| C₈H₁₂Sn | tetravinyltin | 84.64438 | 86.53803^{a} | [83] | 0.02188 |
| C₆H₁₈Sn₂ | hexamethyldistannane | 91.96311 | 91.75569 | [83] | −0.00226 |
| C₇H₁₈Sn | trimethyl-t-butyltin | 96.81417 | 96.47805 | [82] | −0.00348 |
| C₉H₁₄Sn | trimethylphenyltin | 100.77219 | 100.42716 | [83] | −0.00344 |
| C₈H₁₈Sn | triethylvinyltin | 102.56558 | 102.83906^{a} | [83] | −0.00266 |
| C₈H₂₀Sn | tetraethyltin | 108.53931 | 108.43751 | [83] | −0.00094 |
| C₁₀H₁₆Sn | trimethylbenzyltin | 112.23920 | 112.61211 | [83] | 0.00331 |
| C₁₀H₁₄O₂Sn | trimethyltin benzoate | 117.28149 | 119.31199^{a} | [83] | 0.01702 |
| C₁₀H₂₀Sn | tetra-allyltin | 133.53558 | 139.20655^{a} | [83] | 0.04074 |
| C₁₂H₂₈Sn | tetra-n-propyltin | 157.17011 | 157.01253 | [83] | −0.00100 |
| C₁₂H₂₈Sn | tetraisopropyltin | 157.57367 | 156.9952 | [83] | −0.00366 |
| C₁₂H₃₀Sn₂ | hexaethyldistannane | 164.90931 | 164.76131^{a} | [83] | −0.00090 |
| C₁₉H₁₈Sn | triphenylmethyltin | 182.49954 | 180.97881^{a} | [84] | −0.00840 |
| C₂₀H₂₀Sn | triphenylethyltin | 194.65724 | 192.92526^{a} | [84] | −0.00898 |
| C₁₆H₃₆Sn | tetra-n-butyltin | 205.80091 | 205.60055 | [83] | −0.00097 |
| C₁₆H₃₆Sn | tetraisobutyltin | 206.09115 | 206.73234 | [83] | 0.00310 |
| C₂₁H₂₄Sn₂ | triphenyl-trimethyldistannane | 214.55414 | 212.72973^{a} | [84] | −0.00858 |
| C₂₄H₂₀Sn | tetraphenyltin | 223.36322 | 221.61425 | [83] | −0.00789 |
| C₂₄H₄₄Sn | tetracyclohexyltin | 283.70927 | 284.57603 | [83] | 0.00305 |
| C₃₆H₃₀Sn₂ | hexaphenyldistannane | 337.14517 | 333.27041 | [83] | −0.01163 |

TABLE 191
Summary results of lead compounds.

| | | Calculated | Experimental | |
|---|---|---|---|---|
| | | Total Bond | Total Bond | Relative |
| Formula | Name | Energy (eV) | Energy (eV) | Error |
| C₄H₁₂Pb | tetramethyl-lead | 57.55366 | 57.43264 | −0.00211 |
| C₈H₂₀Pb | tetraethyl-lead | 106.18446 | 105.49164 | −0.00657 |

TABLE 192
Summary results of alkyl arsines.

| | | Calculated | Experimental | |
|---|---|---|---|---|
| | | Total Bond | Total Bond | Relative |
| Formula | Name | Energy (eV) | Energy (eV) | Error |
| C₃H₉As | trimethylarsine | 44.73978 | 45.63114 | 0.01953 |
| C₆H₁₅As | triethylarsine | 81.21288 | 81.01084 | −0.00249 |
| C₁₈H₁₅As | triphenylarsine | 167.33081 | 166.49257 | −0.00503 |

TABLE 193
Summary results of alkyl stibines.

| | | Calculated | Experimental | |
|---|---|---|---|---|
| | | Total Bond | Total Bond | Relative |
| Formula | Name | Energy (eV) | Energy (eV) | Error |
| C₃H₉Sb | trimethylstibine | 44.73078 | 45.02378 | 0.00651 |
| C₆H₁₅Sb | triethylstibine | 81.20388 | 80.69402 | −0.00632 |
| C₁₈H₁₅Sb | triphenylstibine | 167.32181 | 165.81583 | −0.00908 |

TABLE 194
Summary results of alkyl bismuths.

| | | Calculated | Experimental | |
|---|---|---|---|---|
| | | Total Bond | Total Bond | Relative |
| Formula | Name | Energy (eV) | Energy (eV) | Error |
| C₃H₉Bi | trimethylbismuth | 42.07387 | 42.79068 | 0.01675 |
| C₆H₁₅Bi | triethylbismuth | 78.54697 | 78.39153 | −0.00198 |
| C₁₈H₁₅Bi | triphenylbismuth | 164.66490 | 163.75184 | −0.00558 |

### REFERENCES

1. D. R. Lide, CRC Handbook of Chemistry and Physics, 86th Edition, CRC Press, Taylor & Francis, Boca Raton, (2005-6), pp. 10-202 to 10-204.
2. B. G. Willis, K. F. Jensen, “An evaluation of density functional theory and ab initio predictions for bridge-bonded aluminum compounds,” J. Phys. Chem. A, Vol. 102, (1998), pp. 2613-2623.
3. D. R. Lide, CRC Handbook of Chemistry and Physics, 86th Edition, CRC Press, Taylor & Francis, Boca Raton, (2005-6), pp. 9-19 to 9-45.
4. T. Shinzawa, F. Uesugi, I. Nishiyama, K. Sugai, S. Kishida, H. Okabayashi, “New molecular compound precursor for aluminum chemical vapor deposition,” Applied Organometallic Chem., Vol. 14, (2000), pp. 14-24.
5. D. R. Lide, CRC Handbook of Chemistry and Physics, 86th Edition, CRC Press, Taylor & Francis, Boca Raton, (2005-6), p. 9-82.
6. G. Herzberg, Molecular Spectra and Molecular Structure II. Infrared and Raman Spectra of Polyatomic Molecules, Van Nostrand Reinhold Company, New York, N.Y., (1945), p. 344.
7. R. J. Fessenden, J. S. Fessenden, Organic Chemistry, Willard Grant Press. Boston, Mass., (1979), p. 320.
8. cyclohexane at http://webbook.nist.gov/.
9. D. R. Lide, CRC Handbook of Chemistry and Physics, 86th Ed., CRC Press, Taylor & Francis, Boca Raton, (2005-6), p. 9-54.
10. J. D. Cox, G. Pilcher, Thermochemistry of Organic and Organometallic Compounds, Academic Press, New York, (1970).
11. M. B. J. Smith, J. Organometal. Chem., Vol. 76, (1974), pp. 171-201.
12. NIST Atomic Spectra Database, www.physics.nist.gov/cgi-bin/AtData/display.ksh.
13. J. E. Huheey, Inorganic Chemistry Principles of Structure and Reactivity, 2^{nd} Ed., Harper & Row, New York, (1978), Chp. 9.
14. D. R. Lide, CRC Handbook of Chemistry and Physics, 86th Edition, CRC Press, Taylor & Francis, Boca Raton, (2005-6), p. 9-86.
15. J. Li, P. C. de Mello, K. Jug, “Extension of SINDO1 to transition metal compounds,” J. Comput. Chem., Vol. 13(1), (1992), pp. 85-92.
16. D. R. Lide, CRC Handbook of Chemistry and Physics, 86th Edition, CRC Press, Taylor & Francis, Boca Raton, (2005-6), p. 9-81.
17. G. Herzberg, Molecular Spectra and Molecular Structure II. Infrared and Raman Spectra of Polyatomic Molecules, Van Nostrand Reinhold Company, New York, N.Y., (1945), p. 567.
18. D. R. Lide, CRC Handbook of Chemistry and Physics, 86th Edition, CRC Press, Taylor & Francis, Boca Raton, (2005-6), p. 9-27.
19. M. W. Chase, Jr., C. A. Davies, J. R. Downey, Jr., D. J. Frurip, R. A. McDonald, A. N. Syverud, JANAF Thermochemical Tables, Third Edition, Part I, Al—Co, J. Phys. Chem. Ref. Data, Vol. 14, Suppl. 1, (1985), pp. 467, 509, 522, 535.
20. M. W. Chase, Jr., C. A. Davies, J. R. Downey, Jr., D. J. Frurip, R. A. McDonald, A. N. Syverud, JANAF Thermochemical Tables, Third Edition, Part II, Cr—Zr, J. Phys. Chem. Ref. Data, Vol. 14, Suppl. 1, (1985), pp. 1411, 1438, 1447, 1460.
21. M. W. Chase, Jr., C. A. Davies, J. R. Downey, Jr., D. J. Frurip, R. A. McDonald, A. N. Syverud, JANAF Thermochemical Tables, Third Edition, Part II, Cr—Zr, J. Phys. Chem. Ref. Data, Vol. 14, Suppl. 1, (1985), pp. 1096, 1153, 1174, 1192.
22. M. W. Chase, Jr., C. A. Davies, J. R. Downey, Jr., D. J. Frurip, R. A. McDonald, A. N. Syverud, JANAF Thermochemical Tables, Third Edition, Part I, Al—Co, J. Phys. Chem. Ref. Data, Vol. 14, Suppl. 1, (1985), pp. 808, 866, 887, 906.
23. M. W. Chase, Jr., C. A. Davies, J. R. Downey, Jr., D. J. Frurip, R. A. McDonald, A. N. Syverud, JANAF Thermochemical Tables, 3rd Edition, Part I, Al—Co & Part II, Cr—Zr, J. Phys. Chem. Ref. Data, Vol. 14, Suppl. 1, (1985), pp. 796, 843, 1082, 1132, 1738, 1762.
24. M. W. Chase, Jr., C. A. Davies, J. R. Downey, Jr., D. J. Frurip, R. A. McDonald, A. N. Syverud, JANAF Thermochemical Tables, Third Edition, Part II, Cr—Zr, J. Phys. Chem. Ref. Data, Vol. 14, Suppl. 1, (1985), p. 1616.
25. G. Herzberg, Molecular Spectra and Molecular Structure. I. Spectra of Diatomic Molecules, Krieger Publishing Company, Malabar, Fla., (1950), p. 578.
26. E. L. Muetterties, J. R. Bleeke, E. J. Wucherer, “Structural, stereochemical, and electronic features of arene-metal complexes,” Chem. Rev., Vol. 82, No. 5, (1982), pp. 499-525.
27. vanadium pentafluoride at http://webbook.nist.gov/.
28. vanadium oxytrichloride at http://webbook.nist.gov/.
29. M. W. Chase, Jr., C. A. Davies, J. R. Downey, Jr., D. J. Frurip, R. A. McDonald, A. N. Syverud, JANAF Thermochemical Tables, Third Edition, Part I, Al—Co & Part II, Cr—Zr, J. Phys. Chem. Ref. Data, Vol. 14, Suppl. 1, (1985), p. 698.
30. G. Herzberg, Molecular Spectra and Molecular Structure II. Infrared and Raman Spectra of Polyatomic Molecules, Van Nostrand Reinhold Company, New York, N.Y., (1945), pp. 362-369.
31. M. W. Chase, Jr., C. A. Davies, J. R. Downey, Jr., D. J. Frurip, R. A. McDonald, A. N. Syverud, JANAF Thermochemical Tables, Third Edition, Part II, Cr—Zr, J. Phys. Chem. Ref. Data, Vol. 14, Suppl. 1, (1985), p. 1763.
32. Wagman, D. D.; Evans, W. H.; Parker, V. B.; Halow, I.; Bailey, .S. M.; Schumm, R. L.; Nuttall, R. H. The NBS Tables of Chemical. Thermodynamic Properties, J. Phys. Chem. Ref. Data, Vol. 11, Suppl. 2 (1982)Wagman, D. D.; Evans, W. H.; Parker, V. B.; Halow, I.; Bailey, .S. M.; Schumm, R. L.; Nuttall, R. H. The NBS Tables of Chemical. Thermodynamic Properties, J. Phys. Chem. Ref. Data, Vol. 11, Suppl. 2 (1982)Wagman, D. D.; Evans, W. H.; Parker, V. B.; Halow, I.; Bailey, .S. M.; Schumm, R. L.; Nuttall, R. H. The NBS Tables of Chemical. Thermodynamic Properties, J. Phys. Chem. Ref. Data, Vol. 11, Suppl. 2 (1982)Wagman, D. D.; Evans, W. H.; Parker, V. B.; Halow, I.; Bailey, .S. .M.; Schumm, R. L.; Nuttall, R. H. The NBS Tables of Chemical. Thermodynamic Properties, J. Phys. Chem. Ref. Data, Vol. 11, Suppl. 2 (1982).
33. J. D. Cox, G. Pilcher, Thermochemistry of Organometallic Compounds, Academic Press, New York, (1970), p. 478.
34. W. I. F. David, R. M. Ibberson, G. A. Jeffrey, J. R. Ruble, “The structure analysis of deuterated benzene and deuterated nitromethane by pulsed-neutron powder diffraction: a comparison with single crystal neutron analysis,” Physica B (1992), 180 & 181, pp. 597-600.
35. G. A. Jeffrey, J. R. Ruble, R. K. McMullan, J. A. Pople, “The crystal structure of deuterated benzene,” Proceedings of the Royal Society of London. Series A, Mathematical and Physical Sciences, Vol. 414, No. 1846, (Nov. 9, 1987), pp. 47-57.
36. H. B. Burgi, S. C. Capelli, “Getting more out of crystal-structure analyses,” Hely. Chim. Acta, Vol. 86, (2003), pp. 1625-1640.
37. M. W. Chase, Jr., C. A. Davies, J. R. Downey, Jr., D. J. Frurip, R. A. McDonald, A. N. Syverud, JANAF Thermochemical Tables, Third Edition, Part II, Cr—Zr, J. Phys. Chem. Ref. Data, Vol. 14, Suppl. 1, (1985), pp. 968, 969, 970.
38. A. Jost, B. Rees, “Electronic structure of chromium hexacarbonyl at 78K. I. Neutron diffraction study, Acta. Cryst. Vol. B31 (1975), pp. 2649-2658.
39. J. A. Ibers, “The structure of dibenzene chromium,” J. Phys. Chem., Vol. 40, (1964), pp. 3129-3130.
40. B. B. Ebbinghaus, “Thermodynamics of gas phase chromium species: The chromium chlorides, oxychlorides, fluorides, oxyfluorides, hydroxides, oxyhydroxides, mixed oxyfluorochlorohydroxides, and volatility calculations in waste incineration processes,” Combustion and Flame, Vol. 101, (1995), pp. 311-338.
41. hexacarbonylnickel at http://webbook.nist.gov/.
42. CrCC at http://webbook.nist.gov/.
43. D. Lin-Vien. N. B. Colthup, W. G. Fateley, J. G. Grasselli, The Handbook of Infrared and Raman Frequencies of Organic Molecules, Academic Press, Inc., Harcourt Brace Jovanovich, Boston, (1991), p. 481.
44. J. D. Cox, G. Pilcher, Thermochemistry of Organometallic Compounds, Academic Press, New York, (1970), p. 489.
45. N. Vogt, “Equilibrium bond lengths, force constants and vibrational frequencies of MnF₂, FeF₂, CoF₂, NiF₂, and ZnF₂ from least-squares analysis of gas-phase electron diffraction data,” J Molecular Structure, Vol. 570, (2001), pp. 189-195.
46. L. F. Dahl, “The structure of dimanganese decacarbonyl, Mn₂(CO)₁₀,” Acta. Cryst., Vol. 16, (1963), pp. 419-426.
47. G. Herzberg, Molecular Spectra and Molecular Structure. I. Spectra of Diatomic Molecules, Krieger Publishing Company, Malabar, Fla, (1950), p. 550.
48. Mn₃ at http://webbook.nist.gov/.
49. J. D. Cox, G. Pilcher, Thermochemistry of Organometallic Compounds, Academic Press, New York, (1970), p. 491.
50. M. W. Chase, Jr., C. A. Davies, J. R. Downey, Jr., D. J. Frurip, R. A. McDonald, A. N. Syverud, JANAF Thermochemical Tables, Third Edition, Part I, Al—Co, J. Phys. Chem. Ref. Data, Vol. 14, Suppl. 1, (1985), pp. 822, 879.
51. M. W. Chase, Jr., C. A. Davies, J. R. Downey, Jr., D. J. Frurip, R. A. McDonald, A. N. Syverud, JANAF Thermochemical Tables, Third Edition, Part II, Cr—Zr, J. Phys. Chem. Ref. Data, Vol. 14, Suppl. 1, (1985), p. 1054.
52. M. W. Chase, Jr., C. A. Davies, J. R. Downey, Jr., D. J. Frurip, R. A. McDonald, A. N. Syverud, JANAF Thermochemical Tables, Third Edition, Part II, Cr—Zr, J. Phys. Chem. Ref. Data, Vol. 14, Suppl. 1, (1985), p. 1239.
53. J. D. Cox, G. Pilcher, Thermochemistry of Organometallic Compounds, Academic Press, New York, (1970), p. 493.
54. M. W. Chase, Jr., C. A. Davies, J. R. Downey, Jr., D. J. Frurip, R. A. McDonald, A. N. Syverud, JANAF Thermochemical Tables, Third Edition, Part II, Cr—Zr, J. Phys. Chem. Ref. Data, Vol. 14, Suppl. 1, (1985), p. 953.
55. M. W. Chase, Jr., C. A. Davies, J. R. Downey, Jr., D. J. Frurip, R. A. McDonald, A. N. Syverud, JANAF Thermochemical Tables, Third Edition, Part II, Cr—Zr, J. Phys. Chem. Ref. Data, Vol. 14, Suppl. 1, (1985), p. 695.
56. G. Herzberg, Molecular Spectra and Molecular Structure. I. Spectra of Diatomic Molecules, Krieger Publishing Company, Malabar, Fla., (1950), p. 522.
57. D. R. Lide, CRC Handbook of Chemistry and Physics, 86th Ed., CRC Press, Taylor & Francis, Boca Raton, (2005-6), p. 9-85.
58. Co(CO) at http://webbook.nist.gov/.
59. M. W. Chase, Jr., C. A. Davies, J. R. Downey, Jr., D. J. Frurip, R. A. McDonald, A. N. Syverud, JANAF Thermochemical Tables, Third Edition, Part II, Cr—Zr, J. Phys. Chem. Ref. Data, Vol. 14, Suppl. 1, (1985), pp. 794, 840.
60. P. Seiler, J. D. Dunitz, “The structure of nickelocene at room temperature and at 101 K,” Acta. Cryst., Vol. B36, (1980), pp. 2255-2260.
61. NIST Atomic Spectra Database, www.physics.nist.gov/cgi-bin/AtData/display.ksh.
62. D. R. Lide, CRC Handbook of Chemistry and Physics, 86th Edition, CRC Press, Taylor & Francis, Boca Raton, (2005-6), pp. 9-83 to 9-84.
63. M. W. Chase, Jr., C. A. Davies, J. R. Downey, Jr., D. J. Frurip, R. A. McDonald, A. N. Syverud, JANAF Thermochemical Tables, Third Edition, Part II, Cr—Zr, J. Phys. Chem. Ref. Data, Vol. 14, Suppl. 1, (1985), pp. 1013, 1017, 1020.
64. dimethylzinc at http://webbook.nist.gov/.
65. J. D. Cox, G. Pilcher, Thermochemistry of Organometallic Compounds, Academic Press, New York, (1970), pp. 446-447.
66. D. Lin-Vien. N. B. Colthup, W. G. Fateley, J. G. Grasselli, The Handbook of Infrared and Raman Frequencies of Organic Molecules, Academic Press, Inc., Harcourt Brace Jovanovich, Boston, (1991), p. 13.
67. J. D. Cox, G. Pilcher, Thermochemistry of Organic and Organometallic Compounds, Academic Press, New York, (1970), pp. 470-471.
68. H. Preut, “Structure of triphenyltin bromide,” Acta. Cryst., Vol. B35, (1979), pp. 744-746.
69. S. W. Ng, “Triphenyltin iodide,” Acta. Cryst., Vol. C51, (1995), pp. 629-631.
70. Von H. Preut, H.-J. Haupt, F. Huber, “Die Kristall-und molekularstruktur des hexaphenyl-distannans,” Zeitschrift für anorganische and allgemeine Chemie, Vol. 396, Issue 1, January, (1973), pp. 81-89.
71. G. A. Sim, J. M. Robertson, T. H. Goodwin, “The crystal and molecular structure of benzoic acid,” Acta Cryst., Vol. 8, (1955), pp. 157-164.
72. D. Lin-Vien. N. B. Colthup, W. G. Fateley, J. G. Grasselli, The Handbook of Infrared and Raman Frequencies of Organic Molecules, Academic Press, Inc., Harcourt Brace Jovanovich, Boston, (1991), pp 5,14.
73. J. F. Sanz, A. Marquez, “Molecular structure and vibrational analysis of distannane from ab initio second-order perturbation calculations. A theoretical approach to the tin-X bond (X═Cl, Si, Ge, Sn),” J. Phys. Chem., Vol. 93, (1989), pp. 7328-7333.
74. G. Herzberg, Molecular Spectra and Molecular Structure II. Infrared and Raman Spectra of Polyatomic Molecules, Van Nostrand Reinhold Company, New York, N.Y., (1945), p. 326.
75. b1 2-methyl-1-propene at http://webbook.nist.gov/.
76. a1 2-methyl-1-propene at http://webbook.nist.gov/.
77. acetic acid at http://webbook.nist.gov/.
78. G. Herzberg, Molecular Spectra and Molecular Structure II. Infrared and Raman Spectra of Polyatomic Molecules, Krieger Publishing Company, Malabar, Fla., (1991), p. 195.
79. D. Lin-Vien. N. B. Colthup, W. G. Fateley, J. G. Grasselli, The Handbook of Infrared and Raman Frequencies of Organic Molecules, Academic Press, Inc., Harcourt Brace Jovanovich, Boston, (1991), p. 138.
80. K. P. Huber, G. Herzberg, Molecular Spectra and Molecular Structure, IV. Constants of Diatomic Molecules, Van Nostrand Reinhold Company, New York, (1979).
81. J. Crovisier, Molecular Database—Constants for molecules of astrophysical interest in the gas phase: photodissociation, microwave and infrared spectra, Ver. 4.2, Observatoire de Paris, Section de Meudon, Meudon, France, May 2002, pp. 34-37, available at http://wwwusr.obspm.fr/˜crovisie/.
82. D. R. Lide, CRC Handbook of Chemistry and Physics, 86th Edition, CRC Press, Taylor & Francis, Boca Raton, (2005-6), pp. 5-8, 5-10, 5-14, 5-16, 5-28.
83. J. D. Cox, G. Pilcher, Thermochemistry of Organometallic Compounds, Academic Press, New York, (1970), pp. 472-477.
84. P. G. Harrison, Chemistry of Tin, Blackie, Glasgow, (1989), pp. 10-12.
85. O. Knacke, O. Kubaschewski, K. Hesselmann, Thermochemical Properties of Inorganic Substances, 2^{nd} Edition, Vol. II, Springer, N.Y. (1991), pp. 1888-1889.
86. J. D. Cox, G. Pilcher, Thermochemistry of Organometallic Compounds, Academic Press, New York, (1970), pp. 476-477.
87. J. D. Cox, G. Pilcher, Thermochemistry of Organometallic Compounds, Academic Press, New York, (1970), pp. 484-485.
88. J. D. Cox, G. Pilcher, Thermochemistry of Organometallic Compounds, Academic Press, New York, (1970), pp. 486-487.

What is claimed is:

1. A system for computing the nature of at least one chemical bond of a molecule, compound, or material comprising at least one atom other than hydrogen, the system comprising:
processing means for calculating the nature of a chemical bond; and
an output device in communication with the processing means, the output device being configured to display the nature of a chemical bond.

2. The system of claim 1, wherein the nature of a chemical bond comprises at least one of physical or Maxwellian solutions of charge, mass, and current density functions of said molecules, compounds, and materials.

3. The system of claim 1, wherein the solutions to the Maxwellian equations are solutions of charge, mass, and current density functions and the corresponding energy components of molecules, compounds, and materials comprising at least one from the group of amino acids and peptide bonds with charged functional groups for proteins of any size and complexity by addition of the units, bases, 2-deoxyribose, ribose, phosphate backbone with charged functional groups for DNA of any size and complexity by addition of the units, organic ions, halobenzenes, phosphines, phosphates, phosphine oxides, phosphates, organogermanium and digermanium, organolead, organoarsenic, organoantimony, organobismuth, and any portion of thereof.

4. The system of claim 1, wherein the output device is a display device that displays at least one of visual or graphical media associated with the nature of a chemical bond.

5. The system of claim 4, wherein the display device is static, dynamic, or a combination thereof.

6. The system of claim 5, wherein at least one of vibration and rotation information is displayed by the display device.

7. The system of claim 4, wherein the display device is a monitor, video projector, printer, or three-dimensional rendering device.

8. The system of claim 1, wherein the processing means is a computer.

9. The system of claim 8, wherein the computer comprises a central processing unit (CPU), one or more specialized processors, memory, a storage device and an input means.

10. The system of claim 9, wherein the storage device comprises a magnetic disk or an optical disk.

11. The system of claim 9, wherein the input means comprises a serial port, USB port, microphone input, camera input, a keyboard or a mouse.

12. The system of claim 1, wherein the processing means comprises a computer or other hardware system.

13. The system of claim 11, further comprising computer readable medium having program codes embodied therein.

14. The system of claim 13, wherein the computer readable medium is any available media which can be accessed by a computer.

15. The system of claim 14, wherein the computer readable media comprises at least one of RAM, ROM, EPROM, CD-ROM, DVD or other optical disk storage, magnetic disk storage or other magnetic storage devices, or any other medium which can embody the desired program code means and which can be accessed by a computer.

16. The system of claim 15, wherein the program codes comprises executable instructions and data which cause a computer to perform at least one function.

17. The system of claim 16, wherein the program code is Millsian programmed with an algorithm based on the physical solutions, and the computer is a PC.

18. The system of claim 1, wherein the functional groups comprising at least one of the group of those of alkanes, branched alkanes, alkenes, branched alkenes, alkynes, alkyl fluorides, alkyl chlorides, alkyl bromides, alkyl iodides, alkene halides, primary alcohols, secondary alcohols, tertiary alcohols, ethers, primary amines, secondary amines, tertiary amines, aldehydes, ketones, carboxylic acids, carboxylic esters, amides, N-alkyl amides, N,N-dialkyl amides, ureas, acid halides, acid anhydrides, nitriles, thiols, sulfides, disulfides, sulfoxides, sulfones, sulfites, sulfates, nitro alkanes, nitrites, nitrates, conjugated polyenes, aromatics, heterocyclic aromatics, substituted aromatics are superimposed to give the rendering.

19. The system of claim 18, wherein the functional groups and molecules comprise at least one of the group of halobenzenes, adenine, thymine, guanine, cytosine, alkyl phosphines, alkyl phosphites, alkyl phosphine oxides, alkyl phosphates, organic and related ions (RCO₂⁻, ROSO₃⁻, NO₃⁻, (RO)₂PO₂⁻, (RO)₃SiO⁻, (R)₂Si(O⁻)₂, RNH₃⁺, R₂NH₂⁺), monosaccharides of DNA and RNA: 2-deoxy-D-ribose, D-ribose, alpha-2-deoxy-D-ribose, alpha-D-ribose; amino acids: aspartic acid, glutamic acid, cysteine, lysine, arginine, histidine, asparagine, glutamine, threonine, tyrosine, serine, tryptophan, phenylalanine, proline, methionine, leucine, isoleucine, valine, alanine, glycine; polypeptides (—[HN—CH(R)—C(O)]ₙ—); tin, alkyl arsines, alkyl stibines, alkyl bismuths and germanium and lead organometallic functional groups and molecules.
